(19) United States
(12) Patent Application Publication
(10) Pub. No.: US 2018/0037817 A1
(43) Pub. Date: Feb. 8, 2018

(54) POLYMERIZABLE COMPOSITION AND OPTICALLY ANISOTROPIC BODY

(71) Applicant: DIC Corporation, Tokyo (JP)

(72) Inventors: Yasuhiro Kuwana, Kita-adachi-gun (JP); Masahiro Horiguchi, Kita-adachi-gun (JP); Toru Ishii, Kita-adachi-gun (JP); Sayaka Nose, Kitaadachi-gun (JP); Akihiro Koiso, Kita-adachi-gun (JP)

(73) Assignee: DIC Corporation, Tokyo (JP)

(21) Appl. No.: 15/543,760

(22) PCT Filed: Jan. 12, 2016
(86) PCT No.: PCT/JP2016/050663

§ 371 Date: Jul. 14, 2017

(30) Foreign Application Priority Data
Jan. 16, 2015 (JP) 2015-006302

(51) Int. Cl. C09K 19/32; C08F 220/34; G02F 1/13363; C09K 19/34

(52) U.S. Cl. CPC C09K 19/32; C09K 19/3477; C09K 19/3491; C09K 19/3405; C08F 220/34; G02F 1/13363

(57) ABSTRACT

The polymerizable composition prevents precipitation and the like of crystals and has high storage stability. A polymer compound is added to the polymerizable composition. In a case where a film-shaped polymer obtained by polymerizing the polymerizable composition is prepared, a tilt angle formed with an air interface is small, and glances of reflected light when a circularly polarizing plate is obtained by combining the polymer with a polarizing plate are removed. In addition, there is provided a polymer obtained by polymerizing the polymerizable composition, and an optically anisotropic body using the polymer. The polymerizable composition includes a reverse dispersible compound represented by General Formula (I), and a compound represented by General Formula (II).

### TECHNICAL FIELD

The present invention relates to a polymerizable composition including a compound having a polymerizable group, a polymerizable liquid crystal composition, and an optically anisotropic body using the polymerizable liquid crystal composition.

### BACKGROUND ART

A compound including a polymerizable group (polymerizable compound) is used in various optical materials. For example, it is possible to prepare a polymer having even alignment by arranging a polymerizable composition including the polymerizable compound in a liquid crystal state and causing polymerization. Such a polymer can be used in a polarizing plate or a retardation plate necessary for a display. In many cases, a polymerizable composition including two or more kinds of polymerizable compounds is used, in order to satisfy optical characteristics, a rate of polymerization, solubility, a melting point, a glass transition temperature, transparency of a polymer, mechanical strength, surface hardness, heat resistance, and light resistance required. At this time, it is necessary that the polymerizable compound to be used imparts excellent physical properties to the polymerizable composition without negatively affecting other characteristics.

In order to improve a viewing angle of a liquid crystal display, it is necessary that wavelength dispersibility of birefringence of a retardation film is decreased or reversed. Preferred examples of the polymerizable compound to be used for this object include a polymerizable compound which hardly causes occurrence of precipitation of crystals and has high storage stability in a case where the polymerizable compound is added to a polymerizable composition. In addition, with respect to a film-shaped polymer prepared by polymerizing the polymerizable composition containing the polymerizable compound, it is preferable that haze is slight, evenness of film thickness is high, unevenness of alignment hardly occurs, surface hardness is high, and adhesiveness is high. Further, it is preferable that a alignment angle with an air interface is small (a tilt angle is small), because phase difference characteristics of a composition can be exhibited to the maximum degree and angle dependency is also easily adjusted. Meanwhile, by controlling the tilt angle, it is also possible to improve viewing angle characteristics of a display. In a case where a retardation film is used for on-board equipment or mobile equipment, high durability with respect to ultraviolet light is required. Accordingly, in a case where the film-shaped polymer is irradiated with ultraviolet light, it is preferable that discoloration or peeling from a base material hardly occurs and alignment defects hardly occur.

In addition, as an antireflective film of an organic EL element, the use of a circularly polarizing plate prepared by combining the polymer and a polarizing plate with each other has also been investigated. In this case, it is necessary that quantity of reflected light is reduced or glances of the reflected light are removed (set to have an achromatic color) even when the reflected light slightly exists.

### CITATION LIST

### Patent Literature

[PTL 1] JP-A-2007-328053

### SUMMARY OF INVENTION

### Technical Problem

An object of the present invention is to provide a polymerizable composition having high storage stability in which precipitation of crystals or the like is prevented in a case where the polymerizable composition is added to a polymerizable composition, with respect to a film-shaped polymer obtained by polymerizing the polymerizable composition, a tilt angle formed with an air interface is small or controlled to be a suitable value, and with respect to a circularly polarizing plate prepared in combination with a polarizing plate, glances of reflected light are reduced. In addition, another object of the present invention is to provide a polymer obtained by polymerizing the polymerizable composition and an optically anisotropic body using the polymer.

### Solution to Problem

As a result of intensive studies to solve the problems described above, the inventors have reached the development of a compound represented by General Formula (I). That is, according to the aspect of the present invention, there is provided a polymerizable composition including: (a) a reverse dispersible compound represented by General Formula (I):

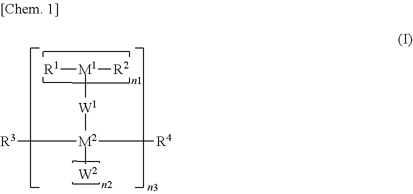

(in the formula, R¹, R², R³, and R⁴ each independently represent a hydrogen atom or a hydrocarbon group having 1 to 80 carbon atoms, the group may have a substituent, one or more of arbitrary carbon atoms may be substituted with a hetero atom, W¹ and W² each independently represent a single bond or a group including a conjugated system including 2 to 100π electrons, M¹ and M² each independently represent a group including a mesogenic group, n1 and n2 each independently represent 0 or 1, provided that when n1 or n2 is 0, the corresponding group is a hydrogen atom, n3 represents an integer of 1 to 1,000, W¹, W², M¹, and M² may each independently include a substituent L, L represents a fluorine atom, a chlorine atom, a bromine atom, an iodine atom, a pentafluorosulfuranyl group, a nitro group, a cyano group, an isocyano group, an amino group, a hydroxyl group, a mercapto group, a methylamino group, a dimethylamino group, a diethylamino group, a diisopropylamino group, a trimethylsilyl group, a dimethylsilyl group, a thioisocyano group, or a linear or branched alkyl group having 1 to 20 carbon atoms in which one —CH₂— or two or more of (—CH₂—)'s that are not adjacent to each other may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, and one or more of arbitrary hydrogen atoms in the alkyl group may be substituted with a fluorine atom, or L may represent a group represented by P^{L}—(S^{L}—X^{L})_{kL}— where P^{L} represents a polymerizable group, S^{L} represents a spacer group or a single bond, in a case where a plurality of S^{L} is present, these may be the same as each other or different from each other, X^{L} represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, in a case where a plurality of X^{L} is present, these may be the same as each other or different from each other (provided that P^{L}—(S^{L}—X^{L})_{kL}— does not include a —O—O— bond), in a case where a plurality of L is present in the compound, these may be the same as each other or different from each other, and kL represents an integer of 0 to 10, and M¹-W¹, W¹-M², and/or M²-W² may each independently form a conjugated system),

(b) a compound represented by General Formula (II):

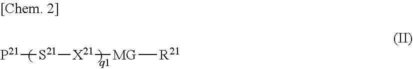

(in the formula, P²¹ represents a polymerizable functional group, S²¹ represents an alkylene group having 0 to 18 carbon atoms (hydrogen atoms in the alkylene group may be substituted with one or more halogen atoms or CN, one CH₂ group or two or more of (—CH₂—)'s that are not adjacent to each other present in this group may be each mutually independently substituted with —O—, —COO—, —OCO—, or —OCO—O—), X²¹ represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond (provided that P²¹—S²¹ and S²¹—X²¹ do not include a —O—O—, —O—NH—, or —O—S— group), q¹ represents 0 or 1, MG represents a mesogenic group, and R²¹ represents a hydrogen atom, a halogen atom, a cyano group, or a linear or a branched alkyl group having 1 to 12 carbon atoms, in which one —CH₂— or two or more of (—CH₂—)'s that are not adjacent to each other may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, or a General Formula (II-a):

[Chem. 3]

—(X²²—S²²)_{q2}—P²³ (II-a)

(in the formula, P²³ represents a reactive functional group, S²² represents a component which is the same as that defined in the description regarding S²¹, X²² represents a component which is the same as that defined in the description regarding X²¹ (provided that P²³—S²² and S²²—X²² do not include a —O—O—, —O—NH—, or —O—S— group), and q² represents 0 or 1),

(c) an initiator, if necessary, and
(d) a solvent, if necessary,
a polymerizable composition including the compounds, a resin, a resin additive, oil, a filter, an adhesive, a pressure-sensitive adhesive, fat, ink, a medicine, cosmetics, a detergent, a building material, a packaging material, a liquid crystal material, an organic EL material, an organic semiconductor material, an electronic material, a display element, an electronic device, communication equipment, an automobile part, an aircraft part, a machine part, an agricultural chemical, and a food each using the compounds, products using these, a polymerizable liquid crystal composition, a polymer obtained by polymerizing the polymerizable liquid crystal composition, and an optically anisotropic body using the polymer.

### Advantageous Effects of Invention

The polymerizable composition including the compounds having a specific structure of the present invention has high storage stability and is useful as a constituent member of a polymerizable composition. In addition, the optically anisotropic body using the polymerizable liquid crystal composition including the compounds of the present invention is useful for an optical material such as a retardation film, because a degree of unevenness is small, a tilt angle formed with an air interface is small or controlled to be a suitable value, glances of reflected light are reduced with respect to a circularly polarizing plate prepared in combination with a polarizing plate.

### DESCRIPTION OF EMBODIMENTS

The present invention provides a polymerizable composition formed of a reverse dispersible compound represent by General Formula (I) and a compound represented by General Formula (II), a resin, a resin additive, oil, a filter, an adhesive, a pressure-sensitive adhesive, fat, ink, a medicine, cosmetics, a detergent, a building material, a packaging material, a liquid crystal material, an organic EL material, an organic semiconductor material, an electronic material, a display element, an electronic device, communication equipment, an automobile part, an aircraft part, a machine part, an agricultural chemical, and a food using the composition, products using these, a polymerizable liquid crystal composition, a polymer obtained by polymerizing the polymerizable liquid crystal composition, and an optically anisotropic body using the polymer.

In a graph in which a horizontal axis indicates a wavelength γ of light incident to a retardation film and a vertical axis indicates a birefringence Δn, in a case where the birefringence Δn decreases, as the wavelength γ decreases, the film is generally called as a film showing “reverse wavelength dispersibility” or “reverse dispersibility” by persons skilled in the art. In the present invention, a compound configuring a retardation film showing reverse dispersibility is referred to as a reverse dispersible compound.

<<General Formula (I)>>

In the present invention, a reverse dispersible compound represented by General Formula (I) is included as an essential component.

<<R¹, R², R³, and R⁴>>

In General Formula (I), R¹, R², R³, and R⁴ each independently represent a hydrogen atom or a hydrocarbon group having 1 to 80 carbon atoms, the group may have a substituent, and one or more of arbitrary carbon atoms may be substituted with a hetero atom. In addition, R¹, R², R³, and R⁴ preferably each independently represent a hydrogen atom or a hydrocarbon group having 1 to 20 carbon atoms, the group may have a substituent, and one or more of arbitrary carbon atoms may be substituted with a hetero atom. More specifically, R¹, R², R³, and R⁴ each independently represent a hydrogen atom, a fluorine atom, a chlorine atom, a bromine atom, an iodine atom, a pentafluorosulfuranyl group, a cyano group, a nitro group, an isocyano group, a thioisocyano group, or a linear or branched alkyl group having 1 to 20 carbon atoms, in which one —CH₂— or two or more of (—CH₂—)'s that are not adjacent to each other may be each independently substituted with —O—, —S—, —CO—, —COO—, —OCO—, —CO—S—, —S—CO—, —O—CO—O—, —CO—NH—, —NH—CO—, —C═C—, or —C≡C— (one or more of arbitrary hydrogen atoms in the alkyl group may be substituted with a fluorine atom), or are preferably a group including a polymerizable group.

In General Formula (I), regarding R¹, R², R³, and R⁴, R¹ being present and at least one of R², R³, and R⁴ being present are preferably groups including a polymerizable group.

The group including a polymerizable group is preferably a group represented by General Formula (I-R).

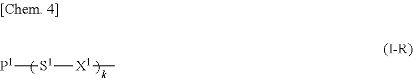

(In the formula, P¹ represents a polymerizable group, S¹ represents a spacer group or a single bond, in a case where a plurality of S¹ is present, these may be the same as each other or different from each other, X¹ represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, in a case where a plurality of X¹ is present in the compound, these may be the same as each other or different from each other (provided that P¹—(S¹—X¹)ₖ— does not include a —O—O— bond), and k represents an integer of 0 to 10.)

In General Formula (I-R), P¹ represents a polymerizable group and preferably represents a group selected from Formula (P-1) to Formula (P-20).

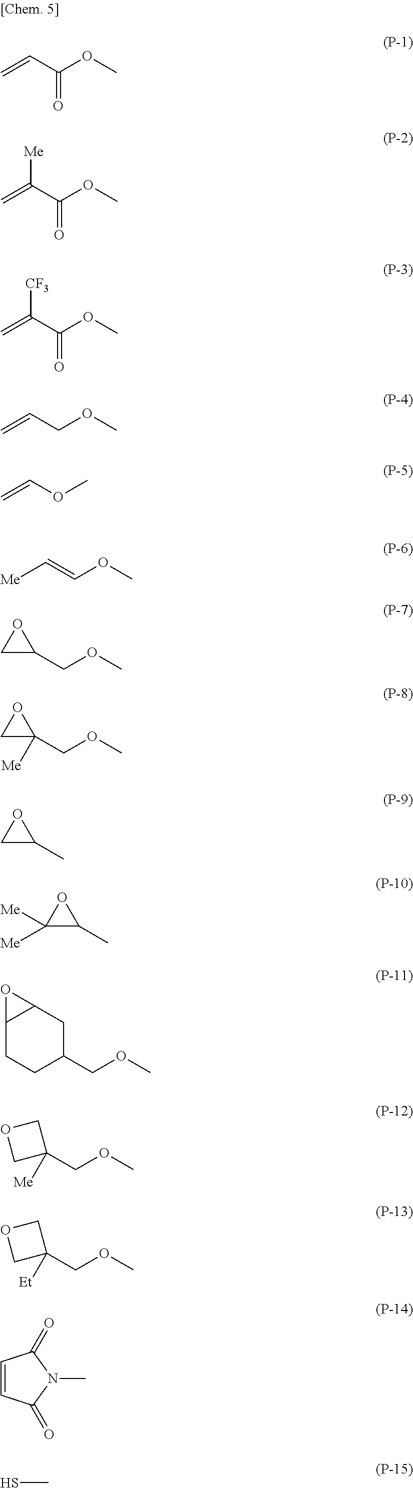

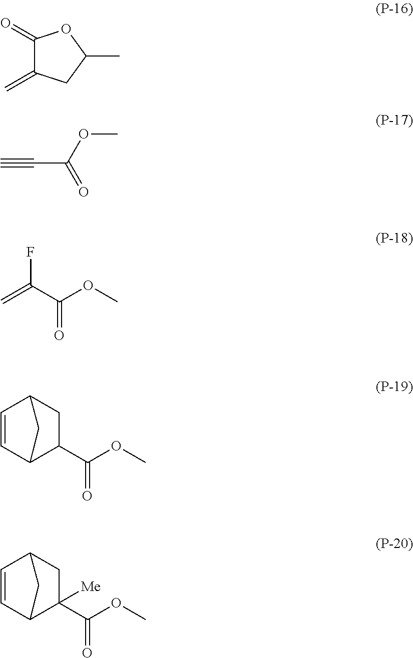

These polymerizable groups are polymerized by radical polymerization, radical addition polymerization, cation polymerization, and anion polymerization. Particularly, in a case of performing ultraviolet ray polymerization as a polymerization method, Formula (P-1), Formula (P-2), Formula (P-3), Formula (P-4), Formula (P-5), Formula (P-7), Formula (P-11), Formula (P-13), Formula (P-15), or Formula (P-18) is preferable, Formula (P-1), Formula (P-2), Formula (P-7), Formula (P-11), or Formula (P-13) is more preferable, Formula (P-1), Formula (P-2), or Formula (P-3) is even more preferable, and Formula (P-1) or Formula (P-2) is particularly preferable.

In General Formula (I-R), S¹ represents a spacer group or a single bond, and in a case where a plurality of S¹ is present, these may be the same as each other or different from each other. In addition, S¹, as a spacer group, preferably represents an alkylene group having 1 to 20 carbon atoms in which one —CH₂— or two or more of (—CH₂—)'s that are not adjacent to each other may be each independently substituted with —O—, —COO—, —OCO—, —OCO—O—, —CO—NH—, —NH—CO—, —CH═CH—, or —C≡C—. From viewpoints of availability of raw materials and ease of synthesis, in a case where a plurality of S¹ is present, these may be the same as each other or different from each other, S¹'s more preferably each independently represent an alkylene group having 1 to 10 carbon atoms in which one —CH₂— or two or more of (—CH₂—)'s that are not adjacent to each other may be each independently substituted with —O—, —COO—, or —OCO—, or a single bond, even more preferably each independently represent an alkylene group having 1 to 10 carbon atoms or a single bond. In a case where a plurality of S¹ is present, these may be the same as each other or different from each other, and S¹'s particularly preferably each independently represent an alkylene group having 1 to 8 carbon atoms.

In General Formula (I-R), X¹ represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, and in a case where a plurality of X¹ is present, these may be the same as each other or different from each other (provided that P¹—(S¹—X¹)ₖ— does not include a —O—O— bond). From viewpoints of availability of raw materials and ease of synthesis, in a case where a plurality of X¹ is present, these may be the same as each other or different from each other, X¹'s more preferably each independently represent —O—, —S—, —OCH₂—, —CH₂O—, —COO—, —OCO—, —CO—S—, —S—CO—, —O—CO—O—, —CO—NH—, —NH—CO—, —COO—CH₂CH₂—, —OCO—CH₂CH₂—, —CH₂CH₂—COO—, —CH₂CH₂—OCO—, or a single bond, even more preferably each independently represent —O—, —OCH₂—, —CH₂O—, —COO—, —OCO—, —COO—CH₂CH₂—, —OCO—CH₂CH₂—, —CH₂CH₂—COO—, —CH₂CH₂—OCO—, or a single bond. In a case where a plurality of X¹ is present, these may be the same as each other or different from each other, and X¹'s particularly preferably each independently represent —O—, —COO—, —OCO—, or a single bond.

In General Formula (I-R), k represents an integer of 0 to 10, preferably represents an integer of 0 to 5, more preferably represents an integer of 0 to 2, and particularly preferably represents 1.

In a case where R¹, R², R³, and R⁴ of General Formula (I) represent a group other than the group including a polymerizable group, R¹, R², R³, and R⁴ preferably represent a group selected from R⁵ (in the formula, R⁵ represents a hydrogen atom, a fluorine atom, a chlorine atom, a bromine atom, an iodine atom, a pentafluorosulfuranyl group, a nitro group, a cyano group, an isocyano group, an amino group, a hydroxyl group, a mercapto group, a methylamino group, a dimethylamino group, a diethylamino group, a diisopropylamino group, a trimethylsilyl group, a dimethylsilyl group, a thioisocyano group, or a linear or branched alkyl group having 1 to 20 carbon atoms, in which one —CH₂— or two or more of (—CH₂—)'s that are not adjacent to each other may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, and one or more of arbitrary hydrogen atoms in the alkyl group may be substituted with a fluorine atom).

From viewpoints of liquid crystal properties, reverse dispersibility, ease of synthesis, and storage stability, the group represented by R⁵ more preferably represents a hydrogen atom, a fluorine atom, a chlorine atom, a cyano group, or a linear or branched alkyl group having 1 to 20 carbon atoms, in which one —CH₂— or two or more of (—CH₂—)'s that are not adjacent to each other may be each independently substituted with —O—, —COO—, —OCO—, —O—CO—O—, —CO—NH—, or —NH—CO— and one or more of arbitrary hydrogen atoms may be substituted with a fluorine atom, even more preferably represents a hydrogen atom, a fluorine atom, a chlorine atom, or a linear alkyl group having 1 to 10 carbon atoms, in which one —CH₂— or two or more of (—CH₂—)'s that are not adjacent to each other may be each independently substituted with —O—, —COO—, —OCO—, or —O—CO—O— and one or more of arbitrary hydrogen atoms may be substituted with a fluorine atom, still more preferably represents a linear alkyl group having 1 to 10 carbon atoms, in which one —CH₂— or two or more of (—CH₂—)'s that are not adjacent to each other may be each independently substituted with —O—, and particularly preferably represents a linear alkyl group having 1 to 5 carbon atoms.

<<Substituent L>>

A compound represented by General Formula (I) may be unsubstituted or substituted with a substituent L. The substituent L represents a fluorine atom, a chlorine atom, a bromine atom, an iodine atom, a pentafluorosulfuranyl group, a nitro group, a cyano group, an isocyano group, an amino group, a hydroxyl group, a mercapto group, a methylamino group, a dimethylamino group, a diethylamino group, a diisopropylamino group, a trimethylsilyl group, a dimethylsilyl group, a thioisocyano group, or a linear or a branched alkyl group having 1 to 20 carbon atoms in which one —CH₂— or two or more of (—CH₂—)'s that are not adjacent to each other may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, and one or more of arbitrary hydrogen atoms in the alkyl group may be substituted with a fluorine atom, or L may represent a group represented by P^{L}—(S^{L}—X^{L})_{kL}— where P^{L} represents a polymerizable group, S^{L} represents a spacer group or a single bond, in a case where a plurality of SL is present, these may be the same as each other or different from each other, X^{L} represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, in a case where a plurality of X^{L} is present, these may be the same as each other or different from each other (provided that P^{L}—(S^{L}—X^{L})_{kL}— does not include a —O—O— bond), kL represents an integer of 0 to 10, kL is preferably 1, and in a case where a plurality of L is present in the compound, these may be the same as each other or different from each other. In addition, from viewpoints of availability of raw materials and ease of synthesis, in a case where a plurality of the substituents L are present, these may be the same as each other or different from each other, and the substituent L preferably represents a fluorine atom, a chlorine atom, a nitro group, a cyano group, or a linear or branched alkyl group having 1 to 20 carbon atoms, in which one —CH₂— or two or more of (—CH₂—)'s that are not adjacent to each other may be each independently substituted with —O—, —COO—, or —OCO— and one or more of arbitrary hydrogen atoms in the alkyl group may be substituted with a fluorine atom. In a case where a plurality of the substituents L are present, these may be the same as each other or different from each other, and the substituent L more preferably represents a fluorine atom, a chlorine atom, a nitro group, a cyano group, or a linear alkyl group having 1 to 12 carbon atoms, in which one —CH₂— or two or more of (—CH₂—)'s that are not adjacent to each other may be each independently substituted with —O—. In a case where a plurality of the substituents L are present, these may be the same as each other or different from each other, and the substituent L particularly preferably represents a fluorine atom, a cyano group, a methyl group, or a methoxy group.

<<W¹ and W²>

In General Formula (I), W¹ and W² each independently represent a group including a single bond or a conjugated system including 2 to 100π electrons. From viewpoints of availability of raw materials and ease of synthesis, W¹ and W² are preferably groups including a single bond or a carbon group or a hydrocarbon group including 2 to 80π electrons, in which one or more of arbitrary carbon atoms may be substituted with a hetero atom, and a single bond or an aromatic and/or nonaromatic hydrocarbon ring having 5 to 80 carbon atoms, which is not substituted or may be substituted with one or more of substituents L and in which one or more of arbitrary carbon atoms may be substituted with a hetero atom.

In General Formula (I), W¹ more preferably represents a group represented by General Formula (I-W1) and W² more preferably represents a group represented by General Formula (I-W2).

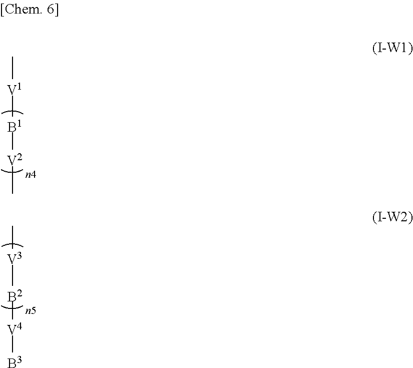

In the formula, V¹, V², V³, and V⁴ each independently represent a single bond or a divalent linking group, B¹, B², and B³ each independently represent a single bond or an aromatic and/or nonaromatic hydrocarbon ring having 5 to 80 carbon atoms which may be substituted, one or more of arbitrary carbon atoms of the carbon ring or the hydrocarbon ring may be substituted with a hetero atom, these groups may be unsubstituted or substituted with one or more of substituents L. In a case where B³ represents a single bond, a hydrogen atom or a group represented by the substituent L is bonded thereto, and n4 and n5 are integers of 0 to 10.)

In the formula, V¹, V², V³, and V⁴ preferably each independently represent a group selected from Formula (V-1) to Formula (V-15).

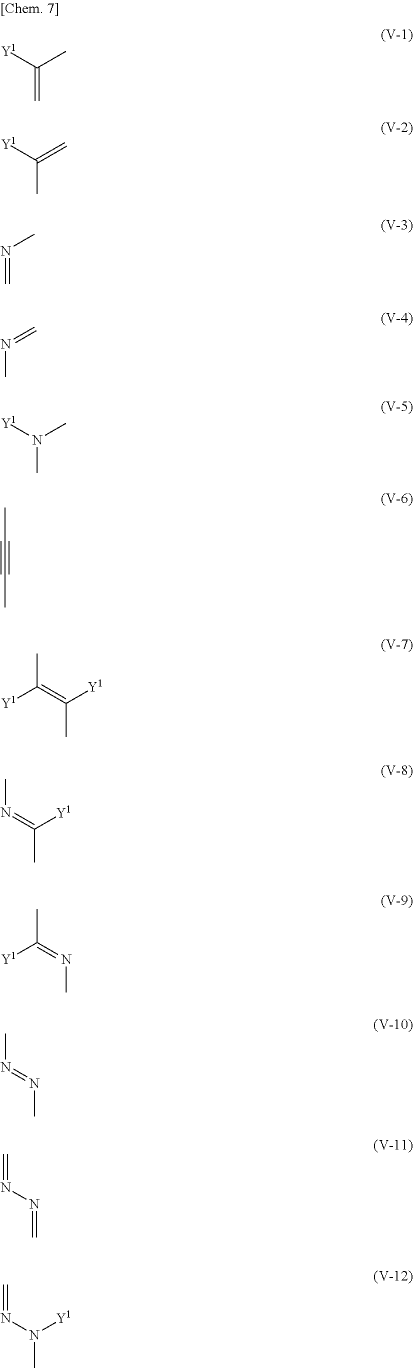

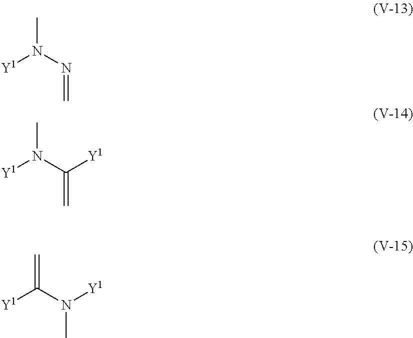

In the formulae, Y¹ represents a hydrogen atom, a fluorine atom, a chlorine atom, a bromine atom, an iodine atom, a pentafluorosulfuranyl group, a nitro group, a cyano group, an isocyano group, an amino group, a hydroxyl group, a mercapto group, a methylamino group, a dimethylamino group, a diethylamino group, a diisopropylamino group, a trimethylsilyl group, a dimethylsilyl group, a thioisocyano group, or a linear or branched alkyl group having 1 to 20 carbon atoms, in which one —CH₂— or two or more of (—CH₂—)'s that are not adjacent to each other may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, one or more of arbitrary hydrogen atoms in the alkyl group may be substituted with a fluorine atom, and in a case where a plurality of Y¹ is present, these may be the same as each other or different from each other. Alternatively, Y¹ may represent a group represented by P^{Y}—(S^{Y}—X^{Y})ⱼ—, P^{Y} represents a polymerizable group and preferably represents a group selected from Formula (P-1) to Formula (P-20), and the polymerizable groups are polymerized by radical polymerization, radical addition polymerization, cation polymerization, and anion polymerization. Particularly, in a case of performing ultraviolet ray polymerization as a polymerization method, Formula (P-1), Formula (P-2), Formula (P-3), Formula (P-4), Formula (P-5), Formula (P-7), Formula (P-11), Formula (P-13), Formula (P-15), or Formula (P-18) is preferable, Formula (P-1), Formula (P-2), Formula (P-7), Formula (P-11), or Formula (P-13) is more preferable, Formula (P-1), Formula (P-2), or Formula (P-3) is even more preferable, and Formula (P-1) or Formula (P-2) is particularly preferable. S^{Y} represents a spacer group or a single bond, and in a case where a plurality of S^{Y} is present, these may be the same as each other or different from each other. From viewpoints of liquid crystal properties, availability of raw materials, and ease of synthesis, in a case where a plurality of S^{Y} is present, these may be the same as each other or different from each other, and S^{Y}'s preferably each independently represent an alkylene group having 1 to 20 carbon atoms in which one —CH₂— or two or more of (—CH₂—)'s that are not adjacent to each other may be each independently substituted with —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF═S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, or —C≡C—. In a case where a plurality of S^{Y} is present, these may be the same as each other or different from each other, and S^{Y}'s more preferably each independently represent a linear alkylene group having 1 to 20 carbon atoms in which one —CH₂— or two or more of (—CH₂—)'s that are not adjacent to each other may be each independently substituted with —O—, —COO—, —OCO—, or —OCO—O—. In a case where a plurality of S^{Y} is present, these may be the same as each other or different from each other, and S^{Y}'s even more preferably each independently represent a linear alkylene group having 1 to 12 carbon atoms in which one —CH₂— or two or more of (—CH₂—)'s that are not adjacent to each other may be each independently substituted with —O—. From viewpoints of liquid crystal properties and solubility in a solvent, S^{Y} particularly preferably represents a linear alkylene group having 1 to 12 carbon atoms in which one —CH₂— or two or more of (—CH₂—)'s that are not adjacent to each other may be each independently substituted with —O—. X^{Y} represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, and in a case where a plurality of X^{Y} is present, these may be the same as each other or different from each other (provided that P^{Y}—(S^{Y}—X^{Y})ⱼ— does not include a —O—O— bond). From viewpoints of availability of raw materials and ease of synthesis, in a case where a plurality of X^{Y} is present, these may be the same as each other or different from each other, X^{Y}'s preferably each independently represent —O—, —S—, —OCH₂—, —CH₂O—, —COO—, —OCO—, —CO—S—, —S—CO—, —O—CO—O—, —COO—CH₂CH₂—, —OCO—CH₂CH₂—, —CH₂CH₂—COO—, —CH₂CH₂—OCO—, or a single bond, more preferably each independently represent —O—, —COO—, OCO—, or a single bond, and particularly preferably represents a single bond. j represents an integer of 0 to 10, and preferably represents an integer of 1 to 3, from viewpoints of liquid crystal properties and availability of raw materials. j particularly preferably represents 1, from a viewpoint of hardening shrinkage in a case where a film is obtained.

In Formula (V-1) to Formula (V-15), in a case where the group represented by P^{Y}—(S^{Y}—X^{Y})ⱼ— is bonded to a N atom, a group directly bonded to the N atom is preferably —CH₂—, from a viewpoint of ease of synthesis.

In Formula (V-1) to Formula (V-15), from viewpoints of a phase difference, temporal stability of reverse wavelength dispersibility, and peeling in a case of irradiation with ultraviolet light for a long period of time, the group represented by P^{Y}—(S^{Y}—X^{Y})ⱼ— preferably represents a group selected from Formula (PY-1), Formula (PY-2), or Formula (PY-3).

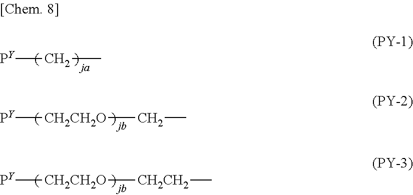

(In the formula, ja represents an integer of 2 to 20 and jb represents an integer of 1 to 6.) In the Formula (PY-1), from a viewpoint of liquid crystal properties, ja more preferably represents an integer of 2 to 12 and particularly preferably represents an integer of 2 to 8. In Formula (PY-2) and Formula (PY-3), from a viewpoint of liquid crystal properties, jb more preferably represents an integer of 1 to 3 and particularly preferably represents 1 or 2.

In Formula (V-1) to Formula (V-15), in a case where Y¹ represents a group other than the group represented by P^{Y}—(S^{Y}—X^{Y})ⱼ—, Y¹ represents a linear or branched alkyl group having 1 to 20 carbon atoms, in which one —CH₂— or two or more of (—CH₂—)'s that are not adjacent to each other may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, one or more of arbitrary hydrogen atoms in the alkyl group may be substituted with a fluorine atom, and in a case where a plurality of Y¹ is present, these preferably represent groups which may be the same as each other or different from each other. In this case, from viewpoints of liquid crystal properties, availability of raw materials, and ease of synthesis, in a case where a plurality of Y¹ is present, these may be the same as each other or different from each other, and Y¹ more preferably represents a linear or branched alkyl group having 1 to 20 carbon atoms, in which one or more of arbitrary hydrogen atoms in the group may be substituted with a fluorine atom and one —CH₂— or two or more of (—CH₂—)'s that are not adjacent to each other may be each independently substituted with —O—, —CO—, —COO—, —OCO—, —O—CO—O—, —CH═CH—, —CF═CF—, or —C≡C—. In a case where a plurality of Y¹ is present, these may be the same as each other or different from each other, and Y¹ even more preferably represents a linear alkyl group having 1 to 20 carbon atoms, in which one or more of arbitrary hydrogen atoms in the group may be substituted with a fluorine atom and one —CH₂— or two or more of (—CH₂—)'s that are not adjacent to each other may be each independently substituted with —O—. In a case where a plurality of Y¹ is present, these may be the same as each other or different from each other, and Y¹ particularly preferably represents a linear alkyl group having 1 to 10 carbon atoms, in which one —CH₂— or two or more of (—CH₂—)'s that are not adjacent to each other may be each independently substituted with —O—. In addition, from viewpoints of solubility in various solvents and adhesiveness to various base materials (or aligned films), Y¹ is preferably a group selected from a group represented by H₃C—(O— (CH₂)ⱼ₁)ⱼ₂— (in the formula, j1 represents an integer of 2 to 10, j2 represents an integer of 1 to 10, j1 is preferably an integer of 2 to 6, j2 is preferably an integer of 1 to 4, j1 is more preferably 2 or 3, j2 is more preferably an integer of 1 to 3, j1 is particularly preferably 2, and j2 is particularly preferably 2 or 3), a single bond, a double bond, —O—, —S—, —OCH₂—, —CH₂O—, —CO—, —CH₂—, —COO—, —OCO—, —CO—S—, —S—CO—, —O—CO—O—, —CO—NH—, —NH—CO—, —CS—NH—, —NH—CS—, —SCH₂—, —CH₂S—, —CF₂O—, —OCF₂—, —CF₁S—, —SCF₂—, —CH═CH—COO—, —CH═CH—OCO—, —COO—CH═CH—, —OCO—CH═CH—, —CH₂CH₂—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, and —CH₂—OCO—, provided that at least one of M¹-V¹, V¹—B¹, B¹—V², V²-M², M²-V³, V³—B², B²—V⁴, and V⁴—B³ present in Formula (I-W1) and Formula (I-W2) forms a conjugated system.

From viewpoints of reverse dispersibility, availability of raw materials, and ease of synthesis, V¹, V², V³, and V⁴ are more preferably each independently a group selected from the groups represented by Formula (V-1) to (V-15), a single bond, a double bond, —O—, —S—, —CH₂—, —COO—, —OCO—, —CO—S—, —S—CO—, —CO—NH—, —NH—CO—, —CS—NH—, —NH—CS—, —CH═CH—COO—, —CH═CH—OCO—, —COO—CH═CH—, —OCO—CH═CH—, —CH₂CH₂—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, and —CH₂—OCO—, even more preferably each independently a group selected from the groups represented by Formula (V-1) to (V-15), a single bond, a double bond, —S—, —CH₂—, —COO—, —OCO—, —CO—NH—, —NH—CO—, —CS—NH—, —NH—CS—, and —CH₂CH₂—, still more preferably each independently a group selected from the groups represented by Formula (V-1) to (V-15), a single bond, a double bond, —CH₂—, —COO—, —OCO—, and —CH₂CH₂—, and particularly preferably each independently a group selected from the groups represented by Formula (V-1) to (V-15), a single bond, and a double bond, provided that at least one of M¹-V¹, V¹—B¹, B¹—V², V²-M², M²-V³, V³—B², B¹—V⁴, and V⁴—B³ present in Formula (I-W1) and Formula (I-W2) forms a conjugated system.

From viewpoints of availability of raw materials and ease of synthesis, in a case where Y¹ is bonded to a carbon atom, Y¹ preferably represents a hydrogen atom, a fluorine atom, a chlorine atom, a nitro group, a cyano group, or a linear or branched alkyl group having 1 to 20 carbon atoms, in which one —CH₂— or two or more of (—CH₂—)'s that are not adjacent to each other may be each independently substituted with —O—, —COO—, or —OCO— and one or more of arbitrary hydrogen atoms in the alkyl group may be substituted with a fluorine atom, more preferably represents a hydrogen atom, a fluorine atom, a chlorine atom, a nitro group, a cyano group, or a linear alkyl group having 1 to 12 carbon atoms, even more preferably represents a hydrogen atom, a fluorine atom, a cyano group, or a linear alkyl group having 1 to 8 carbon atoms, and particularly preferably represents a hydrogen atom. In addition, in a case where Y¹ is bonded to a nitrogen atom, Y¹ preferably represents a hydrogen atom or a linear or branched alkyl group having 1 to 20 carbon atoms, in which one —CH₂— or two or more of (—CH₂—)'s that are not adjacent to each other may be each independently substituted with —O—, —COO—, OR—OCO— and one or more of arbitrary hydrogen atoms in the alkyl group may be substituted with a fluorine atom, more preferably represents a hydrogen atom or a linear or branched alkyl group having 1 to 20 carbon atoms, even more preferably represents a hydrogen atom or a linear or branched alkyl group having 1 to 8 carbon atoms, and particularly preferably represents a hydrogen atom.

In the formulae, B¹ being present and B² and B³ being present preferably each independently represent Formula (B-1) to Formula (B-21) or a single bond.

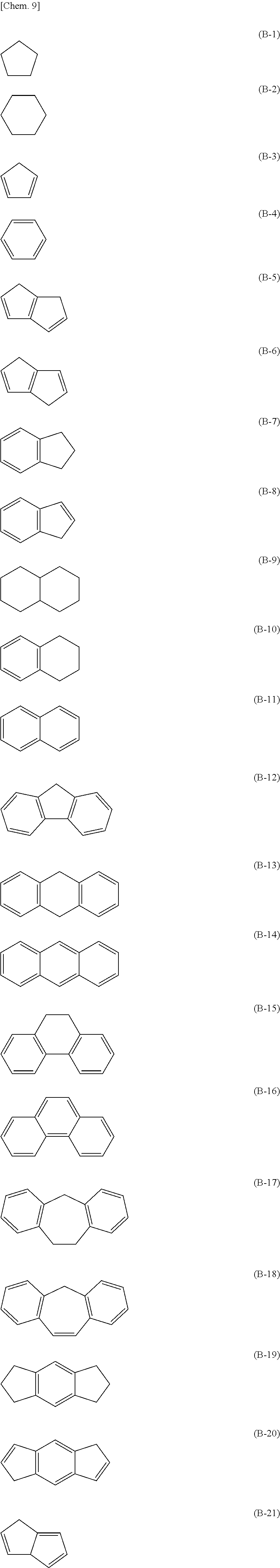

(in the formulae, in a ring structure, a bonding site may be at an arbitrary position, arbitrary —CH═ may be each independently substituted with —N═, —CH₂— may be each independently substituted with —O—, —S—, —NR⁰— (in the formulae, R⁰ represents a hydrogen atom or an alkyl group having 1 to 20 carbon atoms), —CS— or —CO—, provided that a —O—O— bond is not included. Here, the expression that a bonding site may be at an arbitrary position, means that, since B¹ is a divalent group, two bonding sites are provided at arbitrary positions, for example (hereinafter, in the present invention, the expression that a bonding site may be at an arbitrary position, indicates the same meaning). In addition, these groups may be unsubstituted or substituted with one or more of substituents L, and in a case where B³ represents a single bond, these groups are bonded to a hydrogen atom or a group represented by the substituent L).

From viewpoints of availability of raw materials, ease of synthesis, and reverse dispersibility, B¹, B², and B³ preferably each independently represent a group selected from Formula (B-3), Formula (B-4), Formula (B-5), Formula (B-6), Formula (B-7), Formula (B-8), Formula (B-10), Formula (B-11), Formula (B-12), Formula (B-13), Formula (B-17), Formula (B-18), Formula (B-19), Formula (B-20), Formula (B-21), or a single bond.

A group represented by Formula (B-3) preferably represents a group selected from Formula (B-3-1) to Formula (B-3-7),

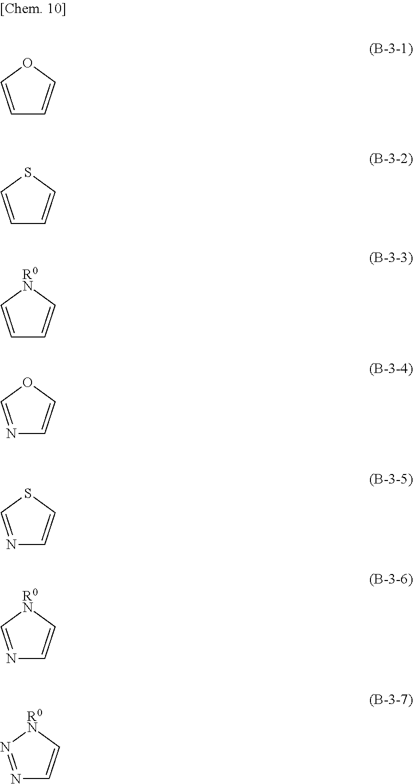

(in the formulae, in a ring structure, a bonding site may be at an arbitrary position, and R⁰ represents a hydrogen atom or an alkyl group having 1 to 20 carbon atoms. In addition, these groups may be unsubstituted or substituted with one or more of substituents L), and more preferably represents a group selected from Formula (B-3-2), Formula (B-3-4), Formula (B-3-5), Formula (B-3-6), and Formula (B-3-7).

A group represented by Formula (B-4) preferably represents a group selected from Formula (B-4-1) to Formula (B-4-8),

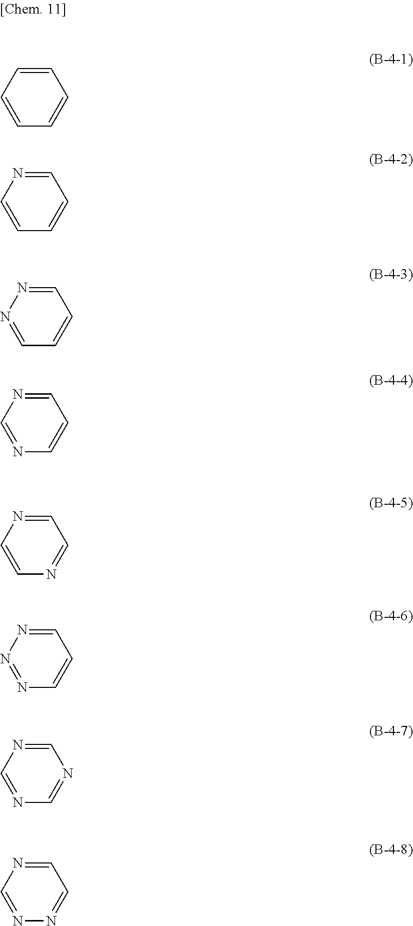

(in the formulae, in a ring structure, a bonding site may be at an arbitrary position. In addition, these groups may be unsubstituted or substituted with one or more of substituents L), and more preferably represents a group represented by Formula (B-4-1).

A group represented by Formula (B-5) preferably represents a group selected from Formula (B-5-1) to Formula (B-5-6).

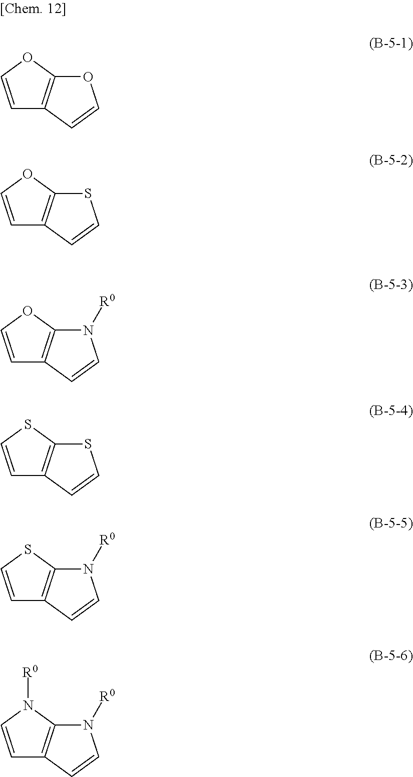

(In the formulae, in a ring structure, a bonding site may be at an arbitrary position, and R⁰ represents a hydrogen atom or an alkyl group having 1 to 20 carbon atoms. In addition, these groups may be unsubstituted or substituted with one or more of substituents L.)

A group represented by Formula (B-6) preferably represents a group selected from Formula (B-6-1) to Formula (B-6-9).

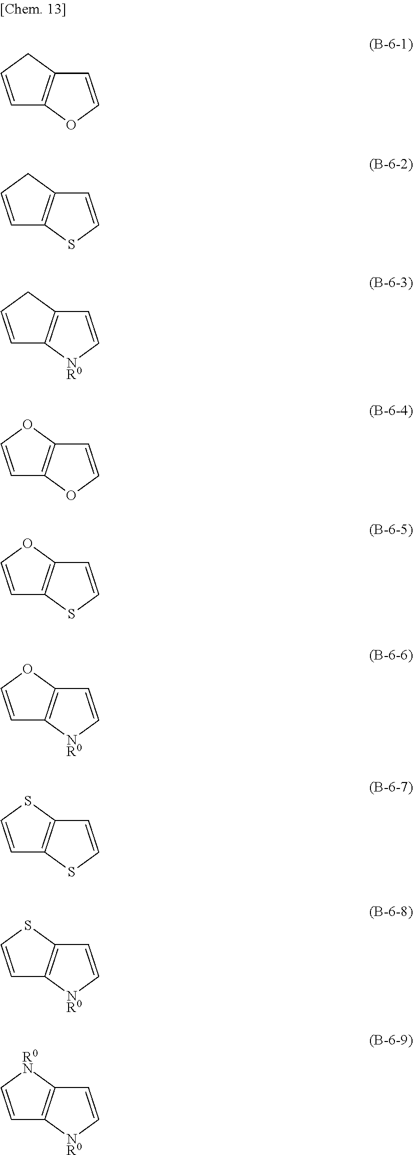

(In the formulae, in a ring structure, a bonding site may be at an arbitrary position, and R⁰ represents a hydrogen atom or an alkyl group having 1 to 20 carbon atoms. In addition, these groups may be unsubstituted or substituted with one or more of substituents L.)

A group represented by Formula (B-7) preferably represents a group selected from Formula (B-7-1) to Formula (B-7-12),

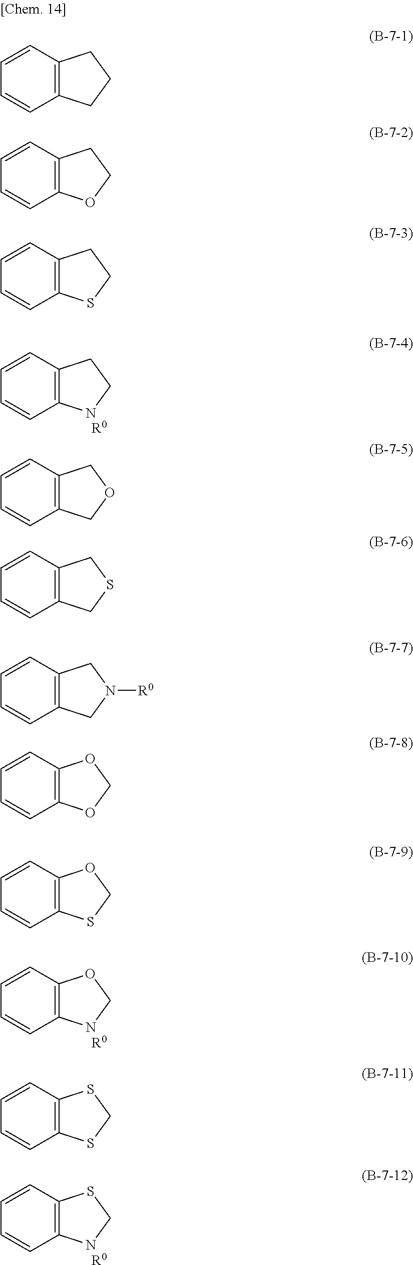

(in the formulae, in a ring structure, a bonding site may be at an arbitrary position, and R⁰ represents a hydrogen atom or an alkyl group having 1 to 20 carbon atoms. In addition, these groups may be unsubstituted or substituted with one or more of substituents L), and more preferably represents a group selected from Formula (B-7-8), Formula (B-7-9), Formula (B-7-10), Formula (B-7-11), and Formula (B-7-12), and even more preferably represents a group represented by Formula (B-7-11)

A group represented by Formula (B-8) preferably represents a group selected from Formula (B-8-1) to Formula (B-8-8),

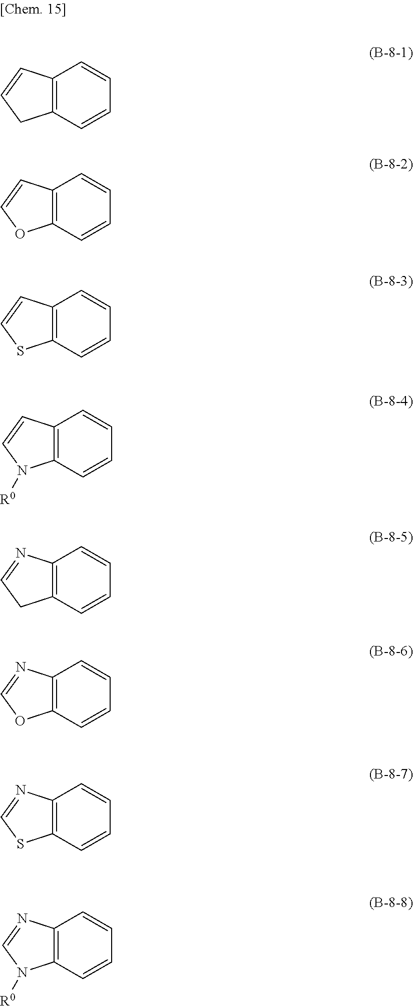

(in the formulae, in a ring structure, a bonding site may be at an arbitrary position, and R⁰ represents a hydrogen atom or an alkyl group having 1 to 20 carbon atoms. In addition, these groups may be unsubstituted or substituted with one or more of substituents L), and more preferably represents a group selected from Formula (B-8-2), Formula (B-8-3), Formula (B-8-4), Formula (B-8-6), Formula (B-8-7), and Formula (B-8-8).

A group represented by Formula (B-10) preferably represents a group selected from Formula (B-10-1) to Formula (B-10-19).

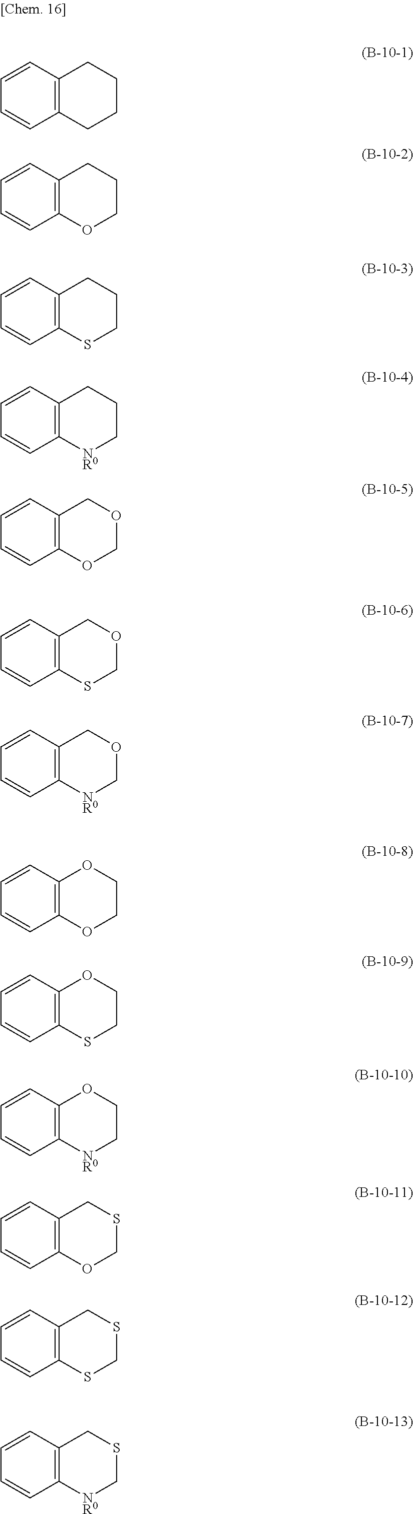

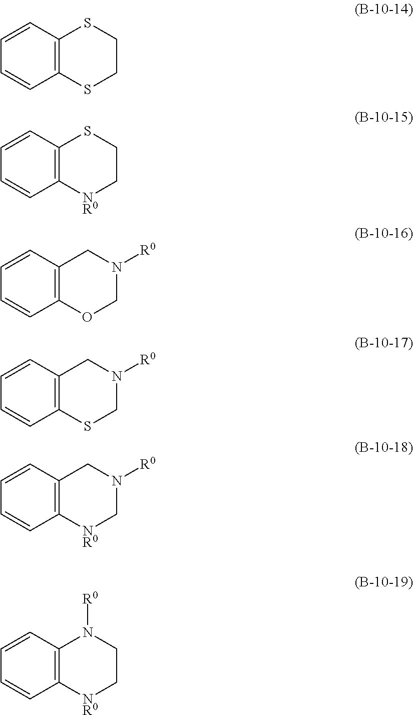

(In the formulae, in a ring structure, a bonding site may be at an arbitrary position, and R⁰ represents a hydrogen atom or an alkyl group having 1 to 20 carbon atoms. In addition, these groups may be unsubstituted or substituted with one or more of substituents L.)

A group represented by Formula (B-11) preferably represents a group selected from Formula (B-11-1) to Formula (B-11-7),

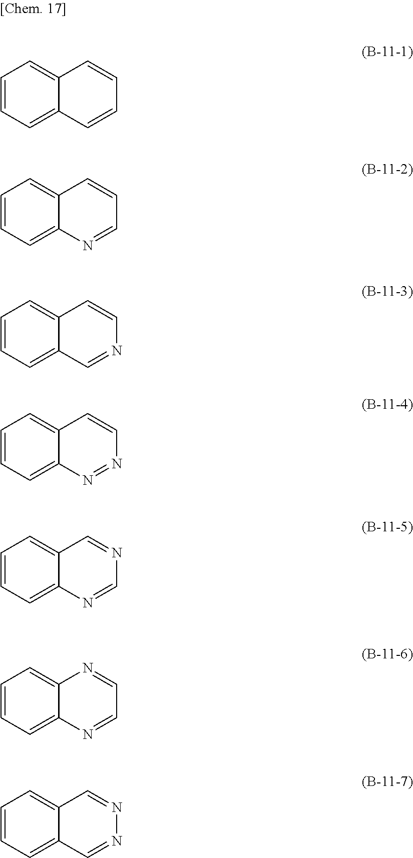

(in the formulae, in a ring structure, a bonding site may be at an arbitrary position, and R⁰ represents a hydrogen atom or an alkyl group having 1 to 20 carbon atoms. In addition, these groups may be unsubstituted or substituted with one or more of substituents L), and more preferably represents a group selected from Formula (B-11-1), Formula (B-11-2), and Formula (B-11-7).

A group represented by Formula (B-12) preferably represents a group selected from Formula (B-12-1) to Formula (B-12-4),

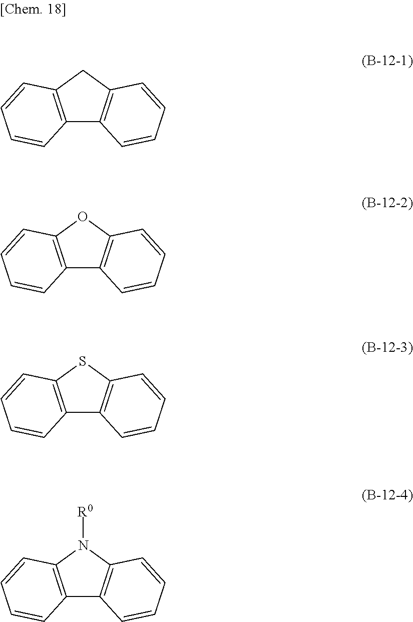

(in the formulae, in a ring structure, a bonding site may be at an arbitrary position, and R⁰ represents a hydrogen atom or an alkyl group having 1 to 20 carbon atoms. In addition, these groups may be unsubstituted or substituted with one or more of substituents L), and more preferably represents a group selected from Formula (B-12-1) and Formula (B-12-4).

A group represented by Formula (B-13) preferably represents a group selected from Formula (B-13-1) to Formula (B-13-10).

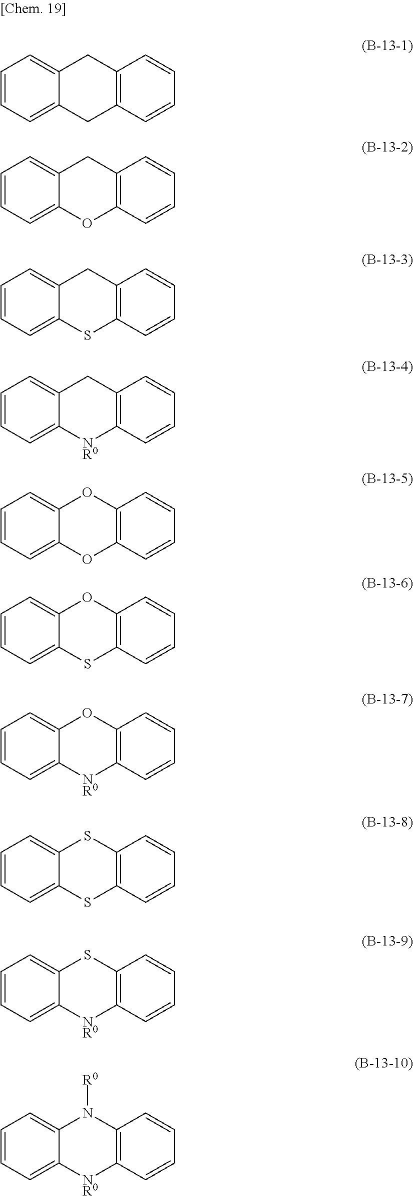

(In the formulae, in a ring structure, a bonding site may be at an arbitrary position, and R⁰ represents a hydrogen atom or an alkyl group having 1 to 20 carbon atoms. In addition, these groups may be unsubstituted or substituted with one or more of substituents L.)

A group represented by Formula (B-17) preferably represents a group selected from Formula (B-17-1) to Formula (B-17-18).

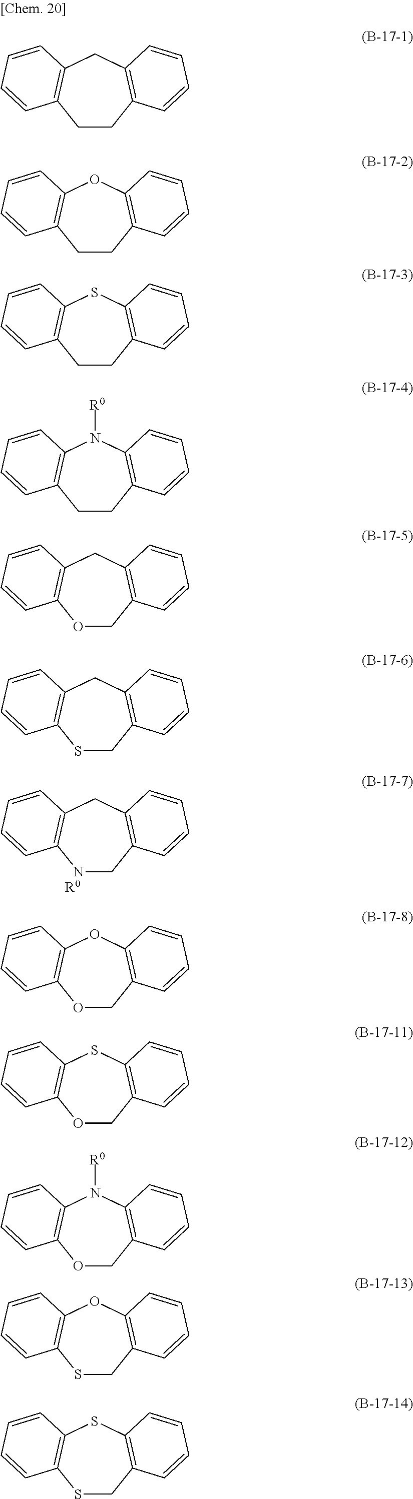

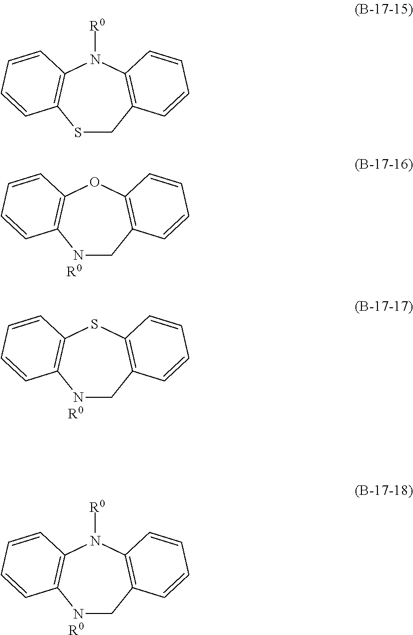

(In the formulae, in a ring structure, a bonding site may be at an arbitrary position, and R⁰ represents a hydrogen atom or an alkyl group having 1 to 20 carbon atoms. In addition, these groups may be unsubstituted or substituted with one or more of substituents L.)

A group represented by Formula (B-18) preferably represents a group selected from Formula (B-18-1) to Formula (B-18-4).

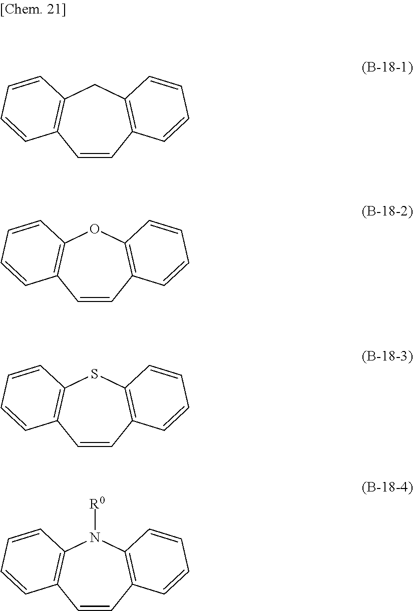

(In the formulae, in a ring structure, a bonding site may be at an arbitrary position, and R⁰ represents a hydrogen atom or an alkyl group having 1 to 20 carbon atoms. In addition, these groups may be unsubstituted or substituted with one or more of substituents L.)

A group represented by Formula (B-19) preferably represents a group selected from Formula (B-19-1) to Formula (B-19-16).

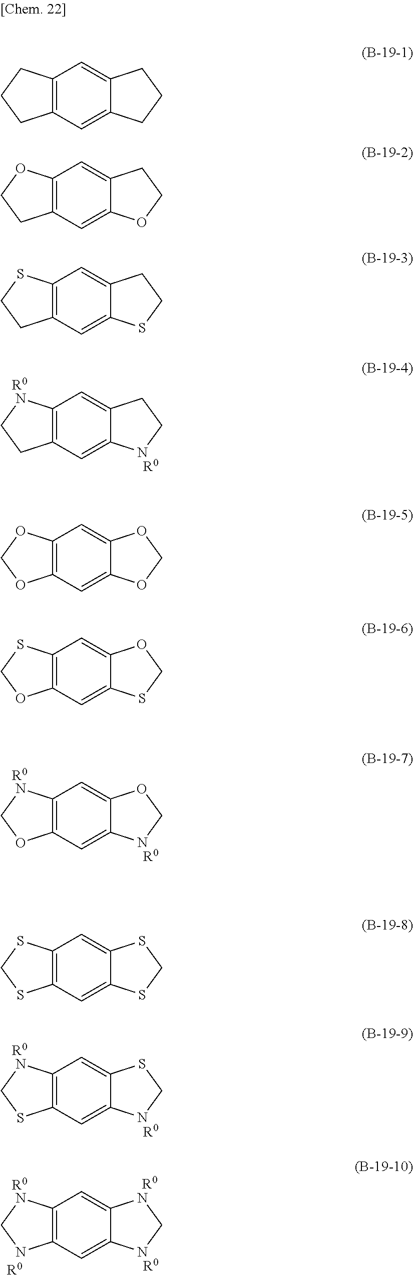

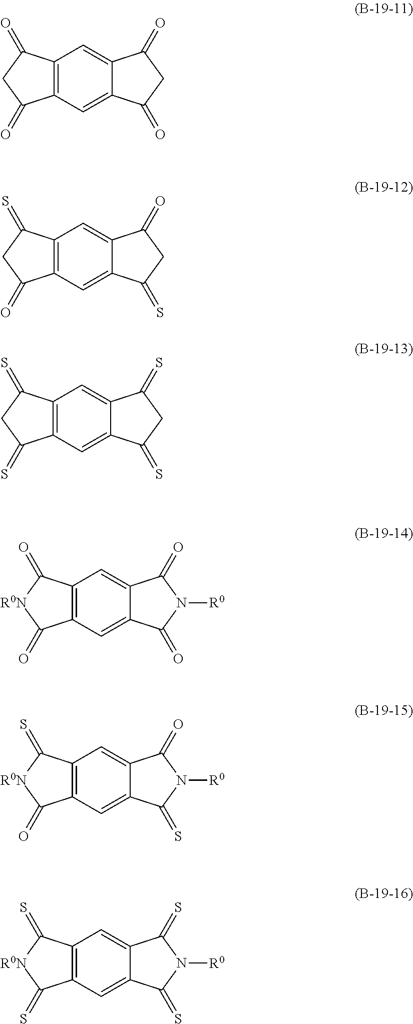

(In the formulae, in a ring structure, a bonding site may be at an arbitrary position, and R⁰ represents a hydrogen atom or an alkyl group having 1 to 20 carbon atoms. In addition, these groups may be unsubstituted or substituted with one or more of substituents L.)

A group represented by Formula (B-20) preferably represents a group selected from Formula (B-20-1) to Formula (B-20-12).

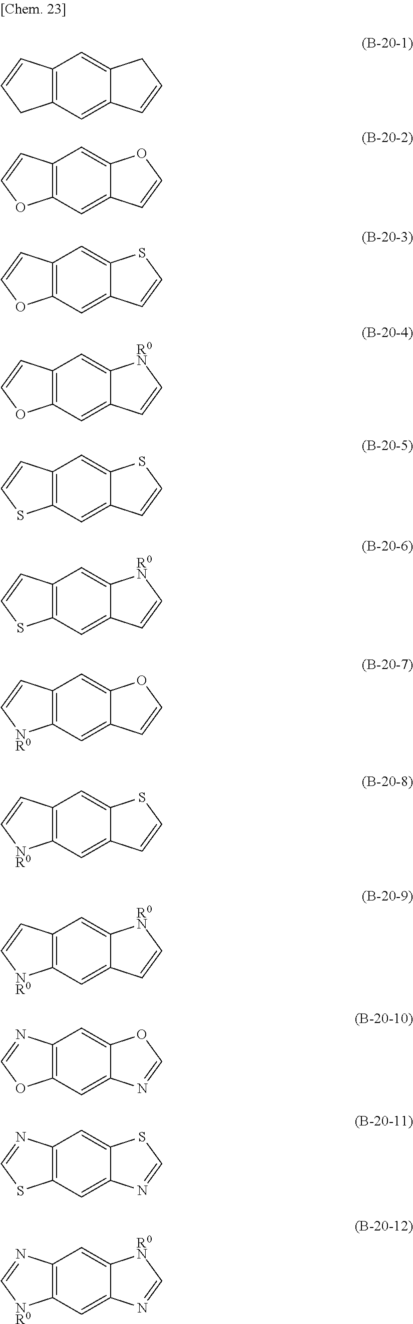

(In the formulae, in a ring structure, a bonding site may be at an arbitrary position, and R⁰ represents a hydrogen atom or an alkyl group having 1 to 20 carbon atoms. In addition, these groups may be unsubstituted or substituted with one or more of substituents L.)

A group represented by Formula (B-21) preferably represents a group selected from Formula (B-21-1) to Formula (B-21-13).

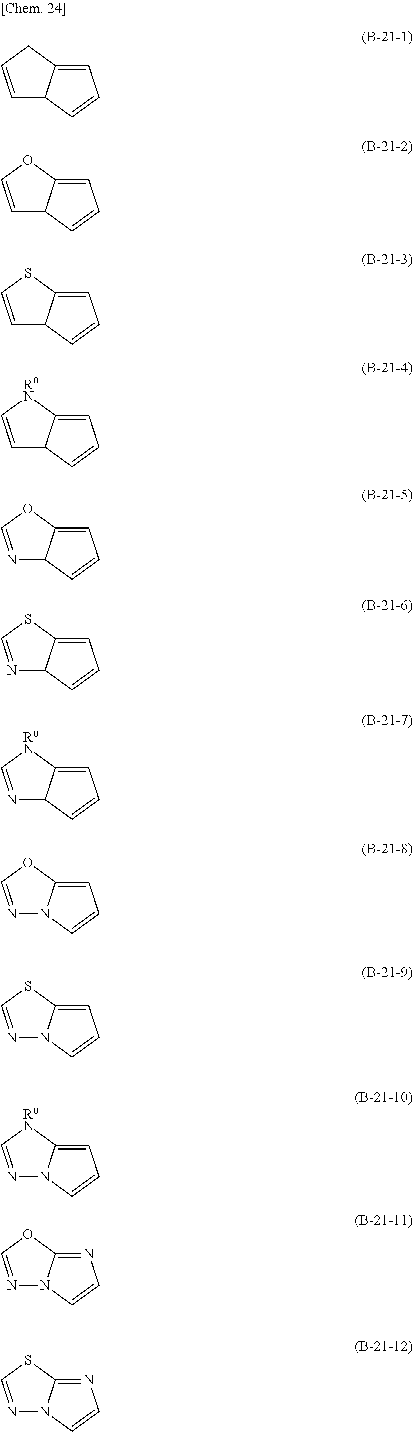

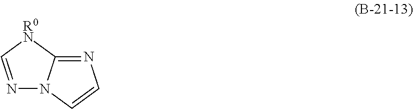

(In the formulae, in a ring structure, a bonding site may be at an arbitrary position, and R⁰ represents a hydrogen atom or an alkyl group having 1 to 20 carbon atoms. In addition, these groups may be unsubstituted or substituted with one or more of substituents L.)

<<M¹ and M²>>

In General Formula (I), M¹ and M² each independently represent a group including a mesogenic group.

More specifically, M¹ preferably represents a group represented by Formula (I-M1) and M² preferably represents a group represented by Formula (I-M2).

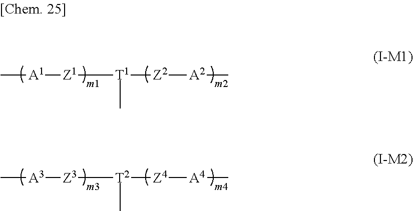

(In the formula, A¹, A², A³, and A⁴ each independently represent a 1,4-phenylene group, a 1,4-cyclohexylene group, a pyridine-2,5-diyl group, a pyrimidine-2,5-diyl group, a naphthalene-2,6-diyl group, a naphthalene-1,4-diyl group, a tetrahydronaphthalene-2,6-diyl group, a decahydronaphthalene-2,6-diyl group, or a 1,3-dioxane-2,5-diyl group, these groups may be unsubstituted or substituted with one or more of substituents L, and, in a case where a plurality of each of A¹, A², A³, and A⁴ is present, these may be the same as each other or different from each other. Z¹, Z², Z³, and Z⁴ each independently represent —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —OCO—NH—, —NH—COO—, —NH—CO—NH—, —NH—O—, —O—NH—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—, —N═CH—, —CH═N—N═CH—, —CF═CF—, —C≡C—, or a single bond, in a case where a plurality of each of Z¹, Z², Z³, and Z⁴ is present, these may be the same as each other or different from each other. T¹ represents a trivalent group which may be substituted, in a case where n2 is 0, T² represents a trivalent group which may be substituted, in a case where n2 is 1, T² represents a tetravalent group which may be substituted, and m1, m2, m3, and m4 each independently represent an integer of 0 to 5.)

From viewpoints of availability of raw materials and ease of synthesis, A¹, A², A³, and A⁴ preferably represent a 1,4-phenylene group, a 1,4-cyclohexylene group, or a naphthalene-2,6-diyl group which are not substituted or may be substituted with one or more substituent L, more preferably each independently represent a group selected from Formula (A-1) to Formula (A-11),

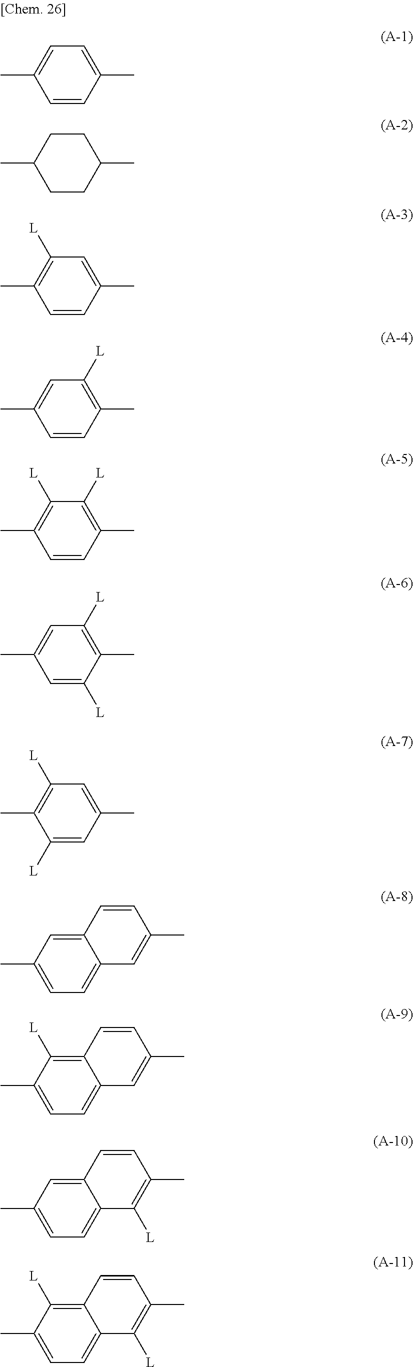

even more preferably each independently represent a group selected from Formula (A-1) to Formula (A-8), and particularly preferably each independently represent a group selected from Formula (A-1) to Formula (A-4).

From viewpoints of liquid crystal properties of the compound, availability of raw materials, and ease of synthesis, Z¹, Z², Z³, and Z⁴ preferably each independently represent a single bond, —OCH₂—, —CH₂O—, —COO—, —OCO—, —CF₂O—, —OCF₂—, —CH₂CH₂—, —CF₂CF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —CH═CH—, —CF═CF—, —C≡C—, or a single bond, more preferably each independently represent —OCH₂—, —CH₂O—, —CH₂CH₂—, —COO—, —OCO—, —COO—CH₂CH₂—, —OCO—CH₂CH₂—, —CH₂CH₂—COO—, —CH₂CH₂—OCO—, —CH═CH—, —C≡C—, or a single bond, even more preferably each independently represent —CH₂CH₂—, —COO—, —OCO—, —COO—CH₂CH₂—, —OCO—CH₂CH₂—, —CH₂CH₂—COO—, —CH₂CH₂—OCO—, or a single bond, and particularly preferably each independently represent —COO—, —OCO—, or a single bond.

m1, m2, m3, and m4 each independently represent an integer of 0 to 5, and from viewpoints of liquid crystal properties, ease of synthesis, and storage stability, m1, m2, m3, and m4 preferably each independently represent an integer of 1 to 4, more preferably each independently represent an integer of 1 to 3, and particularly preferably each independently represent 1 or 2. m1+m2 and m3+m4 preferably each independently represent an integer of 1 to 4 and particularly preferably each independently represent 2, 3, or 4.

In Formula (I-M1) and Formula (I-M2), T¹ and T² are preferably each independently a group selected from Formula (T-1) to Formula (T-22).

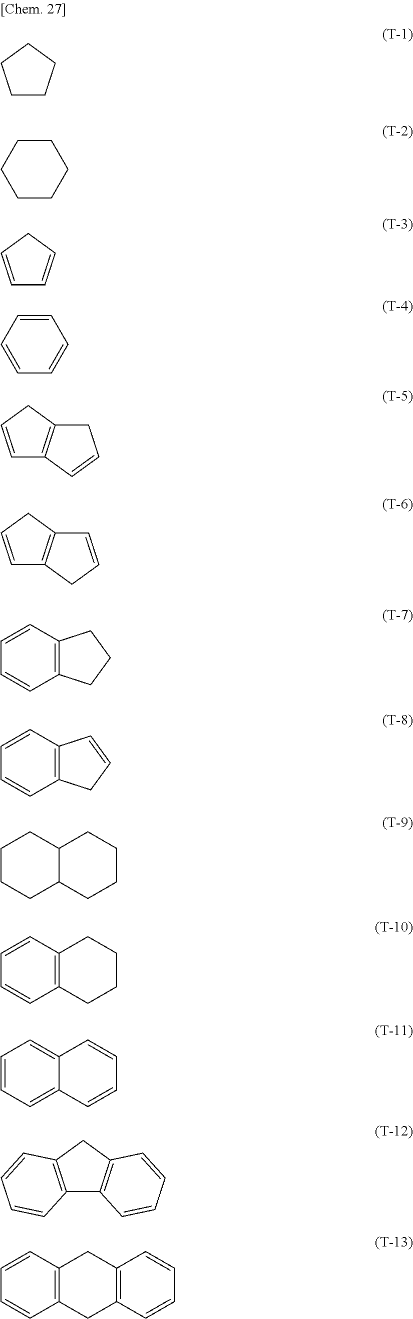

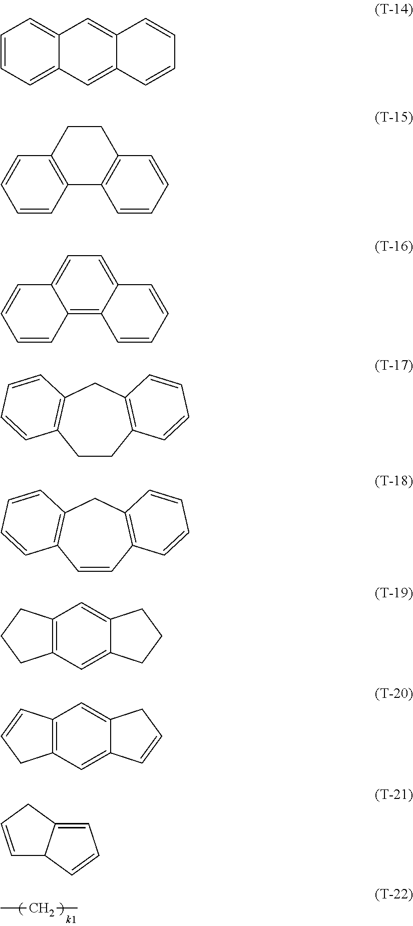

(In the formulae, a bonding site may be at an arbitrary position, arbitrary —CH═ may be each independently substituted with —N═, —CH₂— may be each independently substituted with —O—, —S—, —NR⁰— (in the formulae, R⁰ represents a hydrogen atom or an alkyl group having 1 to 20 carbon atoms), —CS— or —CO—, provided that a —O—O— bond is not included. In addition, these groups may be unsubstituted or substituted with one or more of substituents L, and k1 represents an integer of 1 to 20.)

<<n1, n2, and n3>>

n1 and n2 each independently represent 0 or 1. In a case where n1 is 0, a group linked to W¹ which will be described later represents a hydrogen atom, and in a case where n2 is 0, a group linked to M² which will be described later represents a hydrogen atom.

n3 represents an integer of 1 to 1,000, preferably represents an integer of 1 to 10, more preferably represents an integer of 1 to 5, even more preferably represents an integer of 1 to 3, and particularly preferably represents 1 or 2.

n1, n2, and n3 each represent the numbers described above, a case where A: <n1 and n2 represent 0 and n3 represents 1>, B: <n1 represents 1, n2 represents 0, and n3 represents 1>, C: <n1 represents 0, and n2 and n3 represent 1>, or D: <n1 and n2 represent 0 and n3 represents 2 to 1,000> is particularly preferable, because excellent reverse dispersibility is exhibited. Hereinafter, each group will be described in the aspects A: to D: which are particularly preferred aspects.

Compound in Which <<n1 and n2 Represent 0 and n3 Represents 1>>

<W¹-A11>

In the compound in which <n1 and n2 represent 0 and n3 represents 1>, in a case of significantly considering surface hardness and appearance after ultraviolet light irradiation, when a film-shaped polymer is prepared, in General Formula (I), W¹ is preferably a group represented by Formula (I-W11).

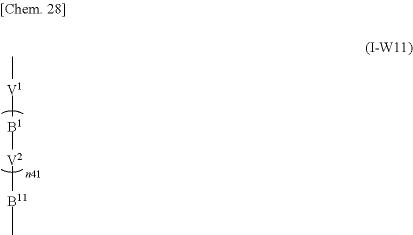

(In the formula, V¹ and V² being present each independently represent a single bond or a divalent linking group, B¹ being present and B¹¹ each independently a group selected from Formula (B-1) to Formula (B-21),

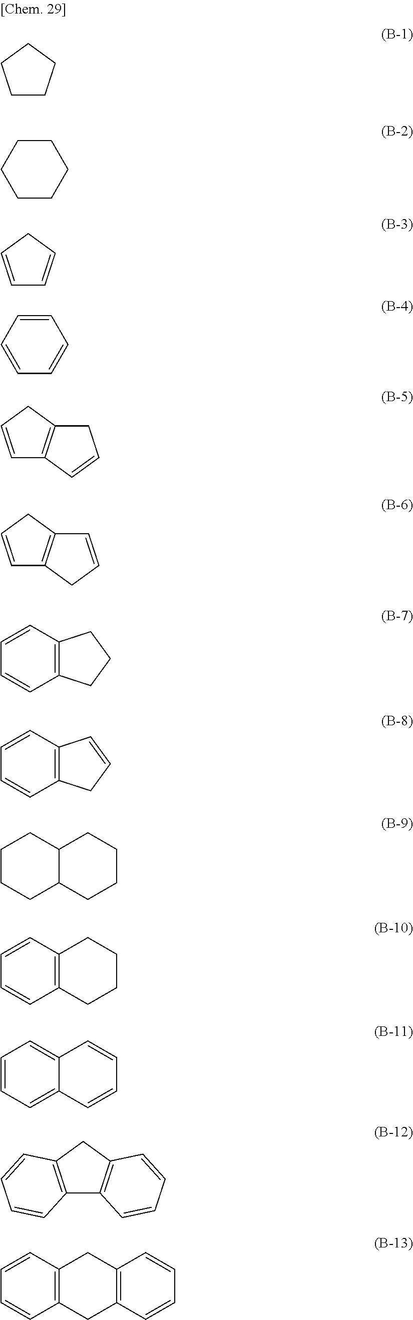

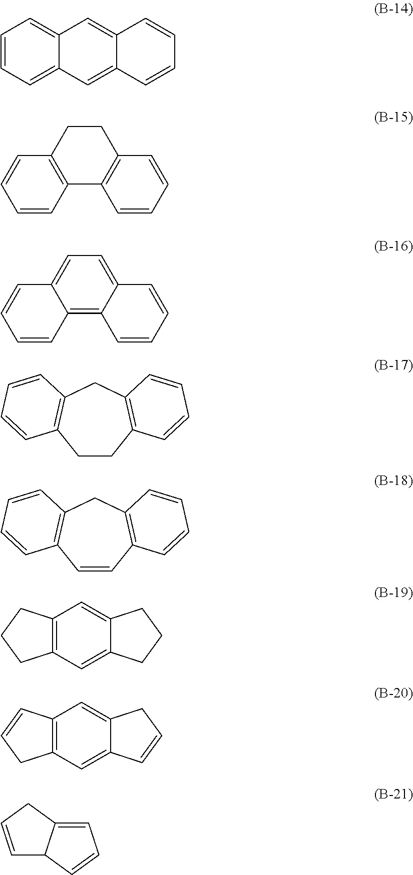

(in the formulae, a bonding site may be at an arbitrary position, arbitrary —CH═ may be each independently substituted with —N═, —CH₂— may be each independently substituted with —O—, —S—, —NR⁰— (in the formulae, R⁰ represents a hydrogen atom or an alkyl group having 1 to 20 carbon atoms), —CS— or —CO—, provided that a —O—O— bond is not included. In addition, these groups may be unsubstituted or substituted with one or more of substituents L.), and a single bond, and n41 represents an integer of 0 to 5.)

V¹ and V² are preferably each independently the groups represented by Formula (V-1) to Formula (V-15) shown in the section <<W¹ and W²>> (in the formulae, in a case of including Y¹, Y¹ is preferably a group selected from viewpoints of availability of raw materials and ease of synthesis described in the section <<W¹ and W²>>), a single bond, a double bond, —O—, —S—, —OCH₂—, —CH₂O—, —CO—, —CH₂—, —COO—, —OCO—, —CO—S—, —S—CO—, —O—CO—O—, —CO—NH—, —NH—CO—, —CS—NH—, —NH—CS—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —CH₂CH₂—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, more preferably a group selected from Formula (V-5), Formula (V-6), Formula (V-8), Formula (V-9), Formula (V-10), a single bond, and a double bond, and particularly preferably a single bond.

B¹ and B¹¹ are preferably each independently a group selected from Formula (B-3), Formula (B-4), Formula (B-8), Formula (B-13), Formula (B-16), and a single bond, and more preferably each independently a group selected from Formula (B-3), Formula (B-4), Formula (B-8), and a single bond. More specifically, B¹ and B¹¹ are specifically preferably each independently a group selected from Formula (B-3-1), Formula (B-3-2), Formula (B-3-5), Formula (B-3-7), Formula (B-4-1), Formula (B-8-4), Formula (B-8-7), Formula (B-13-7), Formula (B-13-8) shown in the section <<W¹ and W¹>>, and a single bond, and specifically preferably each independently a group selected from Formula (B-3-7), Formula (B-4-1), and Formula (B-8-4).

n41 more preferably represents 0, 1, or 2, even more preferably represents 0 or 1, and still more preferably represents 1.

<W¹-A12>

In the compound in which <n1 and n2 represent 0 and n3 represents 1>, in a case of significantly considering storage stability of a polymerizable composition, unevenness of alignment when a film-shaped polymer is prepared, and alignment defects after ultraviolet light irradiation, in General Formula (I), W¹ is preferably a group represented by Formula (I-W12).

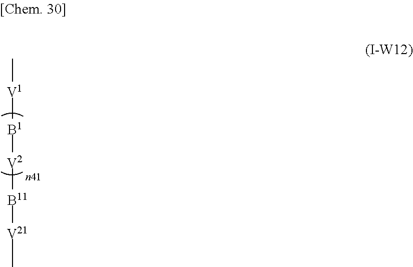

(In the formula, V¹ and V² being present each independently represent a single bond or a divalent linking group, V²¹ represents —NR⁰—, —CR⁰═, ═CR⁰—, —N═, or ═N— (in the formulae, R⁰'s each independently represent a hydrogen atom or an alkyl group having 1 to 8 carbon atoms), B¹ being present and B¹¹ each independently a group selected from Formula (B-1) to Formula (B-21),

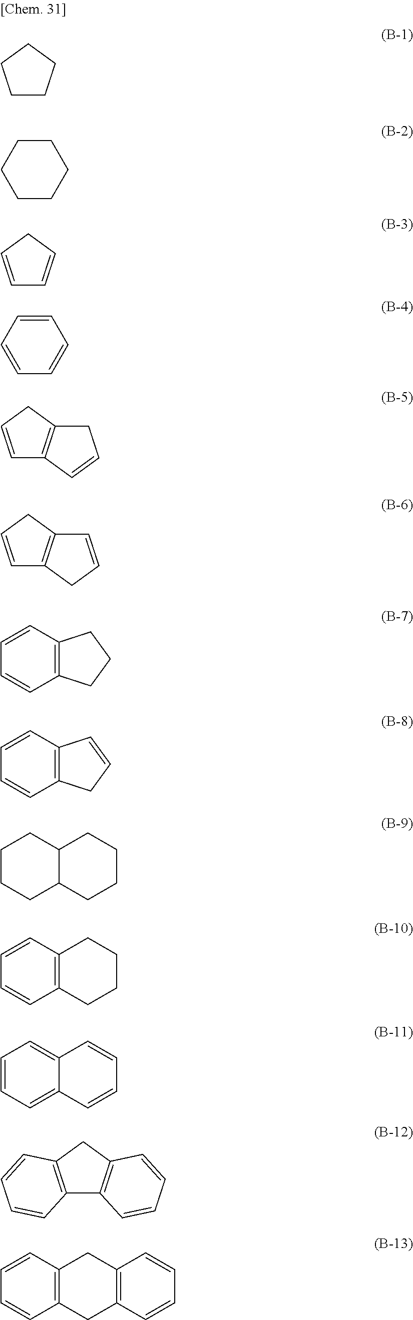

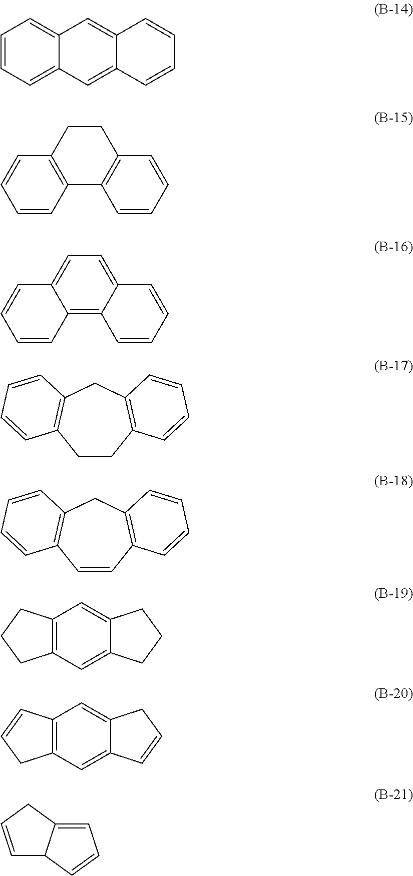

(in the formulae, a bonding site may be at an arbitrary position, arbitrary —CH═ may be each independently substituted with —N═, —CH₂— may be each independently substituted with —O—, —S—, —NR⁰— (in the formulae, R⁰ represents a hydrogen atom or an alkyl group having 1 to 20 carbon atoms), —CS— or —CO—, provided that a —O—O— bond is not included. In addition, these groups may be unsubstituted or substituted with one or more of substituents L.), and a single bond, and n41 represents an integer of 0 to 5.) V²¹ more preferably represents a group selected from —NR⁰—, —N═, and ═N— (in the formulae, R⁰ represents a hydrogen atom or an alkyl group having 1 to 8 carbon atoms) and even more preferably represents —NH—.

V¹ and V² being present are more preferably each independently a group represented by Formula (V-1) to Formula (V-15) (in the formulae, in a case of including Y¹, Y¹ is preferably a group selected from viewpoints of availability of raw materials and ease of synthesis described in the section <<W¹ and W²>>), a single bond, a double bond, —O—, —S—, —OCH₂—, —CH₂O—, —CO—, —CH₂—, —COO—, —OCO—, —CO—S—, —S—CO—, —O—CO—O—, —CO—NH—, —NH—CO—, —CS—NH—, —NH—CS—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —CH₂CH₂—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, and —CH₂—OCO—, even more preferably each independently Formula (V-1), Formula (V-2), Formula (V-5), Formula (V-6), Formula (V-8), Formula (V-9), a single bond, —S—, or —CH₂CH₂—, and still more preferably each independently Formula (V-5) or a single bond.

B¹ and B¹ are preferably each independently a group selected from Formula (B-3), Formula (B-4), Formula (B-6), Formula (B-7), Formula (B-8), Formula (B-10), Formula (B-11), Formula (B-21), and a single bond, and more preferably each independently a group selected from Formula (B-3), Formula (B-4), Formula (B-8), and Formula (B-21). More specifically, B¹ and B¹¹ are preferably a group selected from Formula (B-3-2), Formula (B-3-5), Formula (B-3-7), Formula (B-4-1), Formula (B-4-2), Formula (B-4-3), Formula (B-4-4), Formula (B-4-5), Formula (B-6-7), Formula (B-7-8), Formula (B-7-11), Formula (B-7-12), Formula (B-8-3), Formula (B-8-4), Formula (B-10-11), Formula (B-10-16), Formula (B-11-6), and Formula (B-21-12) shown in the section <<W¹ and W²>>, and more preferably a group selected from Formula (B-3-7), Formula (B-4-1), Formula (B-4-2), Formula (B-4-3), Formula (B-8-4), and Formula (B-21-12).

n41 more preferably represents 0, 1, or 2 and even more preferably represents 0 or 1.

<W¹-A13>

In the compound in which <n1 and n2 represent 0 and n3 represents 1>, in a case of significantly considering evenness of film thickness and adhesiveness, when a film-shaped polymer is prepared, in General Formula (I), W¹ is preferably a group represented by Formula (I-W13).

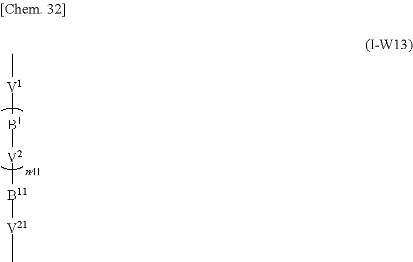

(In the formula, V¹ and V² being present each independently represent a single bond or a divalent linking group, V²¹ represents —CR⁰═CR⁰—, —C≡C—, —CR⁰═N—, —N═CR⁰—, —NR⁰—CR⁰═, ═CR⁰—NR⁰—, —NR⁰—N═, ═N—NR⁰—, —N═N—, or ═N—N═ (in the formulae, R⁰'s each independently represent a hydrogen atom or an alkyl group having 1 to 8 carbon atoms), B¹ being present and B¹¹ each independently a group selected from Formula (B-1) to Formula (B-21),

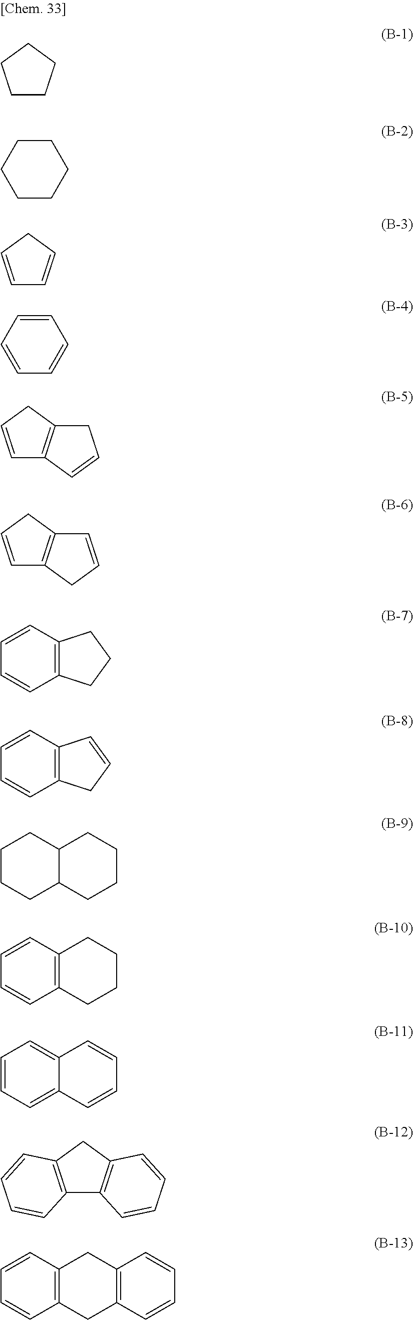

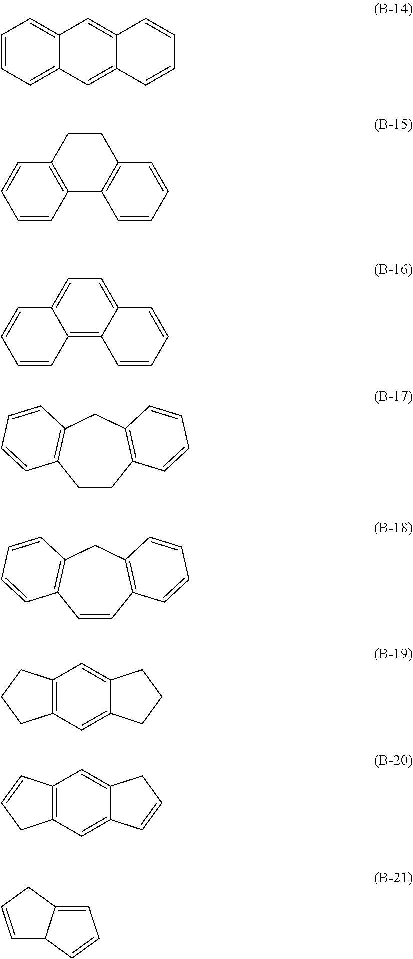

(in the formulae, a bonding site may be at an arbitrary position, arbitrary —CH═ may be each independently substituted with —N═, —CH₂— may be each independently substituted with —O—, —S—, —NR⁰— (in the formulae, R⁰ represents a hydrogen atom or an alkyl group having 1 to 20 carbon atoms), —CS— or —CO—, provided that a —O—O— bond is not included. In addition, these groups may be unsubstituted or substituted with one or more of substituents L.), and a single bond, and n41 represents an integer of 0 to 5.) V²¹ more preferably represents a group selected from —CR⁰═CR⁰—, —C≡C—, —CR⁰═N—, —N═CR⁰—, —NR⁰—CR⁰═, ═CR⁰—NR⁰—, —N═N—, or ═N—N═ (in the formulae, R⁰'s each independently represent a hydrogen atom or an alkyl group having 1 to 8 carbon atoms), even more preferably represents a group selected from —CH═CH—, —CH═N—, —N═CH—, and —N═N—, and still more preferably represents a group selected from —CH═CH—, —CH═N—, and —N═CH—. V¹ and V² are more preferably each independently a group represented by Formula (V-1) to Formula (V-15) (in the formulae, in a case of including Y¹, Y¹ is preferably a group selected from viewpoints of availability of raw materials and ease of synthesis described in the section <<W¹ and W²>>), a single bond, a double bond, —O—, —S—, —OCH₂—, —CH₂O—, —CO—, —CH₂—, —COO—, —OCO—, —CO—S—, —S—CO—, —O—CO—O—, —CO—NH—, —NH—CO—, —CS—NH—, —NH—CS—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —CH₂CH₂—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, and —CH₂—OCO—, even more preferably each independently Formula (V-1), Formula (V-2), Formula (V-3), Formula (V-4), Formula (V-5), Formula (V-10), —CH₂CH₂—, or a single bond, and still more preferably each independently Formula (V-1), Formula (V-2), Formula (V-3), Formula (V-4), or a single bond. B¹ and B¹¹ are preferably each independently a group selected from Formula (B-3), Formula (B-4), Formula (B-5), Formula (B-6), Formula (B-7), Formula (B-8), Formula (B-10), Formula (B-1), Formula (B-12), Formula (B-13), Formula (B-17), Formula (B-18), and a single bond, and more preferably each independently a group selected from Formula (B-3), Formula (B-4), Formula (B-7), Formula (B-8), Formula (B-10), Formula (B-12), Formula (B-13), and a single bond. More specifically, B¹ and B¹¹ are preferably a group selected from Formula (B-3-2), Formula (B-3-5), Formula (B-4-1), Formula (B-7-11), Formula (B-8-7), Formula (B-10-11), Formula (B-12-3), Formula (B-12-4), Formula (B-13-6), and a single bond, more preferably a group selected from Formula (B-3-2), Formula (B-3-5), Formula (B-4-1), Formula (B-7-11), Formula (B-8-7), Formula (B-12-4) shown in the section <<W¹ and W²>>, and a single bond, and even more preferably a group selected from Formula (B-3-2), Formula (B-4-1), Formula (B-8-7), Formula (B-12-4), and a single bond.

n41 more preferably represents 0, 1, or 2, even more preferably represents 0 or 1, and still more preferably represents 1.

<W¹-A14>

In the compound in which <n1 and n2 represent 0 and n3 represents 1>, in a case of significantly considering storage stability when the compound is added to a polymerizable composition, a haze value when a film-shaped polymer is prepared, and alignment defects after ultraviolet light irradiation, in General Formula (I), W¹ is preferably a group represented by Formula (I-W14).

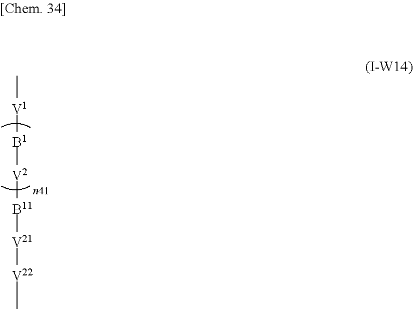

(In the formula, V¹ and V² being present each independently represent a single bond or a divalent linking group, V²¹ represents —CR⁰═CR⁰—, —C≡C—, —CR⁰═N—, —N═CR⁰—, —NR⁰—CR⁰═, ═CR⁰—NR⁰—, —NR⁰—N═, ═N—NR⁰—, —N═N—, or ═N—N═, V²² represents —NR⁰—, —CR⁰═, ═CR⁰—, —N═, or ═N— (in the formulae, R⁰'s each independently represent a hydrogen atom or an alkyl group having 1 to 8 carbon atoms), B¹ being present and B¹¹ each independently a group selected from Formula (B-1) to Formula (B-21),

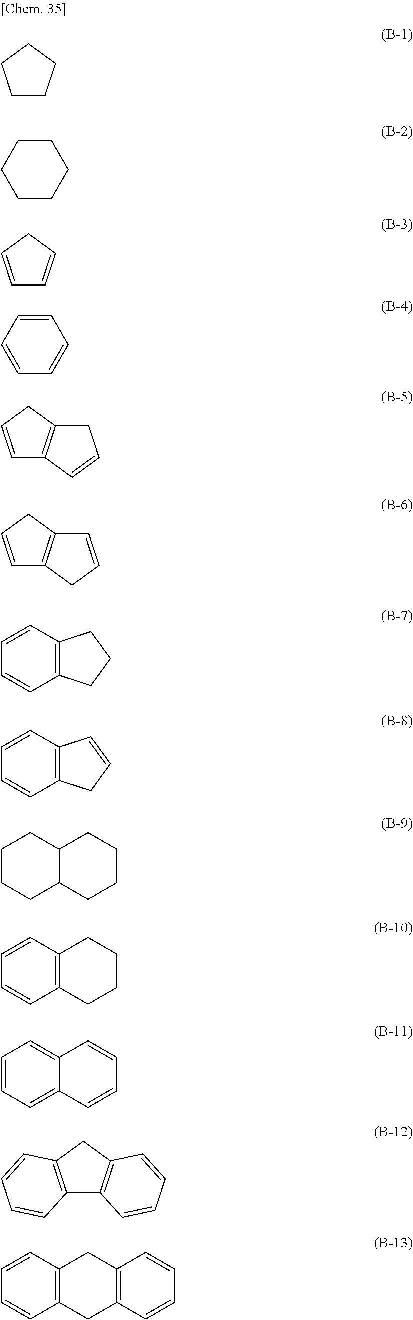

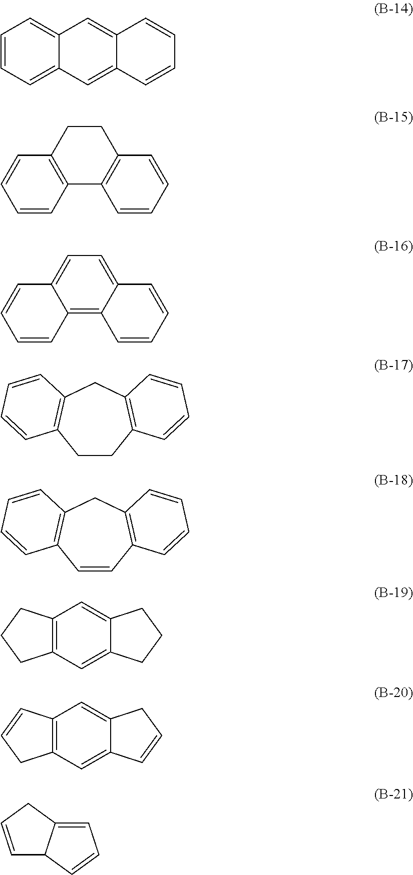

(in the formulae, a bonding site may be at an arbitrary position, arbitrary —CH═ may be each independently substituted with —N═, —CH₂— may be each independently substituted with —O—, —S—, —NR⁰— (in the formulae, R⁰ represents a hydrogen atom or an alkyl group having 1 to 20 carbon atoms), —CS— or —CO—, provided that a —O—O— bond is not included. In addition, these groups may be unsubstituted or substituted with one or more of substituents L.), and a single bond, and n41 represents an integer of 0 to 5.) V²¹ more preferably represents a group selected from —CR⁰═N—, —N═CR⁰—, —NR⁰—CR⁰═, ═CR⁰—NR⁰—, —NR⁰—N═, ═N—NR⁰—, and ═N—N═ (in the formulae, R⁰ each independently represents a hydrogen atom or an alkyl group having 1 to 8 carbon atoms), and even more preferably represents a group selected from —CH═N—, —N═CH—, —NH—CH═, ═CH—NH—, —NH—N═, ═N—NH—, and ═N—N═. V²² more preferably represents a group selected from —NR⁰—, —N═, and ═N— (in the formulae, R⁰ represents a hydrogen atom or an alkyl group having 1 to 8 carbon atoms) and even more preferably represents a group selected from —NH—, —N═, and ═N—. V¹ and V² being present are more preferably each independently a group represented by Formula (V-1) to Formula (V-15) (in the formulae, in a case of including Y¹, Y¹ is preferably a group selected from viewpoints of availability of raw materials and ease of synthesis described in the section <<W¹ and W²>>), a single bond, a double bond, —O—, —S—, —OCH₂—, —CH₂O—, —CO—, —CH₂—, —COO—, —OCO—, —CO—S—, —S—CO—, —O—CO—O—, —CO—NH—, —NH—CO—, —CS—NH—, —NH—CS—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —CH₂CH₂—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, and —CH₂—OCO—, even more preferably each independently Formula (V-5), Formula (V-6), Formula (V-8), Formula (V-9), a single bond, or —CH₂CH₂—, and still more preferably each independently a single bond. B¹ being present and B¹¹ are preferably each independently a group selected from Formula (B-3), Formula (B-4), Formula (B-7), Formula (B-8), Formula (B-10), Formula (B-11), Formula (B-12), and a single bond, and more preferably each independently a group selected from Formula (B-4), Formula (B-7), Formula (B-8), and a single bond. More specifically, B¹ being present and B¹¹ are preferably a group selected from Formula (B-3-1), Formula (B-3-2), Formula (B-3-5), Formula (B-3-7), Formula (B-4-1), Formula (B-4-3), Formula (B-4-6), Formula (B-7-11), Formula (B-8-4), Formula (B-8-7), Formula (B-10-11), Formula (B-11-1), Formula (B-12-4) shown in the section <<W¹ and W¹>>, and a single bond, and more preferably a group selected from Formula (B-4-1), Formula (B-7-11), Formula (B-8-7), and a single bond.

n41 more preferably represents 0, 1, or 2, even more preferably represents 0 or 1, and still more preferably represents 0.

<W¹-A15>

In the compound in which <n1 and n2 represent 0 and n3 represents 1>, in a case of significantly considering a haze value and evenness of film thickness, when a film-shaped polymer is prepared, in General Formula (I), W¹ is preferably a group represented by Formula (I-W18).

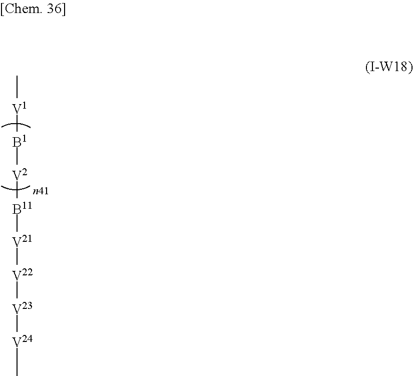

(In the formula, V¹ and V² being present each independently represent a single bond or a divalent linking group, V²¹, V²², V²³, and V²⁴ represent —CR⁰═CR⁰—, —C≡C—, —CR⁰═N—, —N═CR⁰—, —NR⁰—CR⁰═, ═CR⁰—NR⁰—, —NR⁰—N═, ═N—NR⁰—, —N═N—, ═N—N═, —NR⁰—, —CR⁰═, ═CR⁰—, —N═, or ═N— (in the formulae, R⁰'s each independently represent a hydrogen atom or an alkyl group having 1 to 8 carbon atoms), B¹ and B¹ being present each independently a group selected from Formula (B-1) to Formula (B-21),

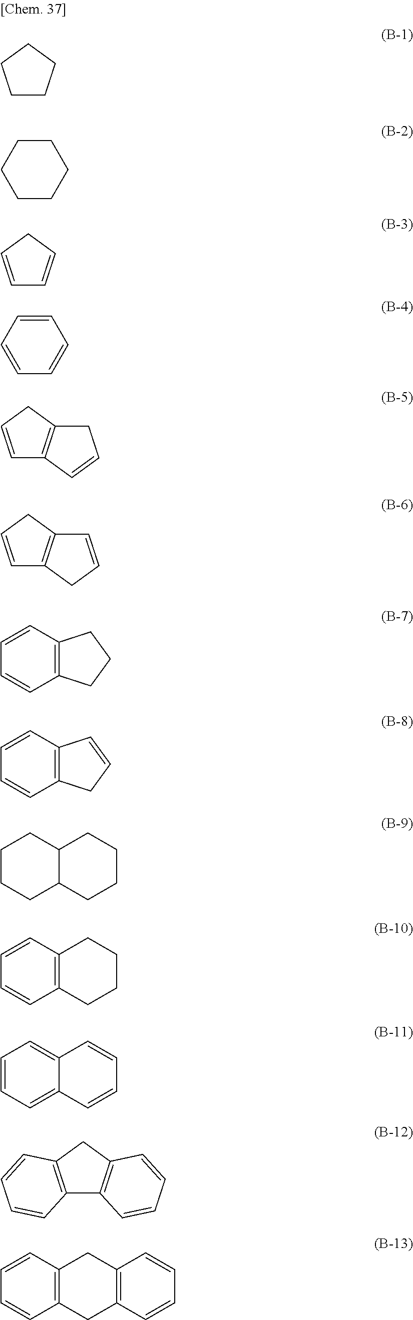

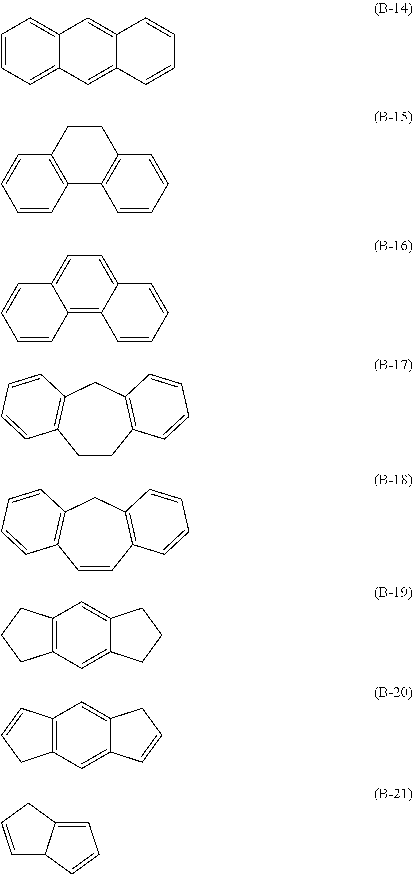

(in the formulae, a bonding site may be at an arbitrary position, arbitrary —CH═ may be each independently substituted with —N═, —CH₂— may be each independently substituted with —O—, —S—, —NR⁰— (in the formulae, R⁰ represents a hydrogen atom or an alkyl group having 1 to 20 carbon atoms), —CS— or —CO—, provided that a —O—O— bond is not included. In addition, these groups may be unsubstituted or substituted with one or more of substituents L.), and a single bond, and n41 represents an integer of 0 to 5.) V²¹, V²², V²³, and V²⁴ preferably represent —CR⁰═CR⁰—, —C≡C—, —CR⁰═N—, —N═CR⁰—, —NR⁰—CR⁰═, ═CR⁰—NR⁰—, —NR⁰—N═, ═N—NR⁰—, —NR⁰—, —CR⁰═, ═CR⁰—, —N═, or ═N— (in the formulae, R⁰ each independently represents a hydrogen atom or an alkyl group having 1 to 8 carbon atoms), more preferably represent —CR⁰═CR⁰—, —C≡C—, —CR⁰═N—, —N═CR⁰—, —NR⁰—N═, ═N—NR⁰—, —NR⁰—, —CR⁰═, or ═CR⁰— (in the formulae, R⁰ each independently represents a hydrogen atom or an alkyl group having 1 to 8 carbon atoms), even more preferably represent —CR⁰═N— or —N═CR⁰— (in the formulae, R⁰ each independently represents a hydrogen atom or an alkyl group having 1 to 8 carbon atoms), and still more preferably —CH═N— or —N═CH—. V¹ and V² being present are more preferably each independently a group represented by Formula (V-1) to Formula (V-15) (in the formulae, in a case of including Y¹, Y¹ is preferably a group selected from viewpoints of availability of raw materials and ease of synthesis described in the section <<W¹ and W²>>), a single bond, a double bond, —O—, —S—, —OCH₂—, —CH₂O—, —CO—, —CH₂—, —COO—, —OCO—, —CO—S—, —S—CO—, —O—CO—O—, —CO—NH—, —NH—CO—, —CS—NH—, —NH—CS—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —CH₂CH₂—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, and —CH₂—OCO—, even more preferably each independently Formula (V-6), a single bond, or —CH₂CH₂—, and still more preferably each independently Formula (V-6) or a single bond. B¹ being present and B¹¹ are preferably each independently a group selected from Formula (B-3), Formula (B-4), Formula (B-7), Formula (B-8), Formula (B-10), Formula (B-11), Formula (B-12), or a single bond, and more preferably each independently a group selected from Formula (B-4), Formula (B-8), Formula (B-12), or a single bond. More specifically, B¹ being present and B¹¹ are preferably a group selected from Formula (B-3-2), Formula (B-3-5), Formula (B-4-1), Formula (B-7-11), Formula (B-8-7), Formula (B-10-11), Formula (B-11-1), Formula (B-12-4) shown in the section <<W¹ and W²>>, and a single bond, more preferably a group selected from Formula (B-4-1), Formula (B-8-7), Formula (B-12-4), and a single bond, and even more preferably a group selected from Formula (B-4-1) and a single bond.

n41 more preferably represents 0, 1, or 2, even more preferably represents 0 or 1, and still more preferably represents 1.

<M²-A1>

In the compound in which <n1 and n2 represent 0 and n3 represents 1>, in a case of significantly considering storage stability when the compound is added to a polymerizable composition, a haze value, evenness of film thickness, unevenness of alignment, and surface hardness, when a film-shaped polymer is prepared, in General Formula (I), M² represents Formula (I-M21),

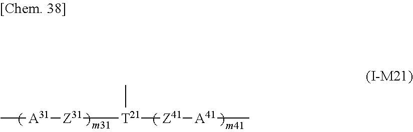

(in the formula, A³¹ being present and A⁴¹ being present each independently represent a 1,4-phenylene group, a 1,4-cyclohexylene group, a pyridine-2,5-diyl group, a pyrimidine-2,5-diyl group, a naphthalene-2,6-diyl group, a naphthalene-1,4-diyl group, a tetrahydronaphthalene-2,6-diyl group, a decahydronaphthalene-2,6-diyl group, or a 1,3-dioxane-2,5-diyl group, these groups may be unsubstituted or substituted with one or more of substituents L, and, in a case where a plurality of each of A³¹ and A⁴¹ is present, these may be the same as each other or different from each other. Z³¹ being present and Z⁴¹ being present each independently represent —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —OCO—NH—, —NH—COO—, —NH—CO—NH—, —NH—O—, —O—NH—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—, —N═CH—, —CH═N—N═CH—, —CF═CF—, —C≡C—, or a single bond, in a case where a plurality of each of Z³¹ and Z⁴¹ is present, these may be the same as each other or different from each other. m31 and m41 each independently represent an integer of 0 to 5.), and T²¹ represents a group selected from Formula (T2-1) to Formula (T2-10).

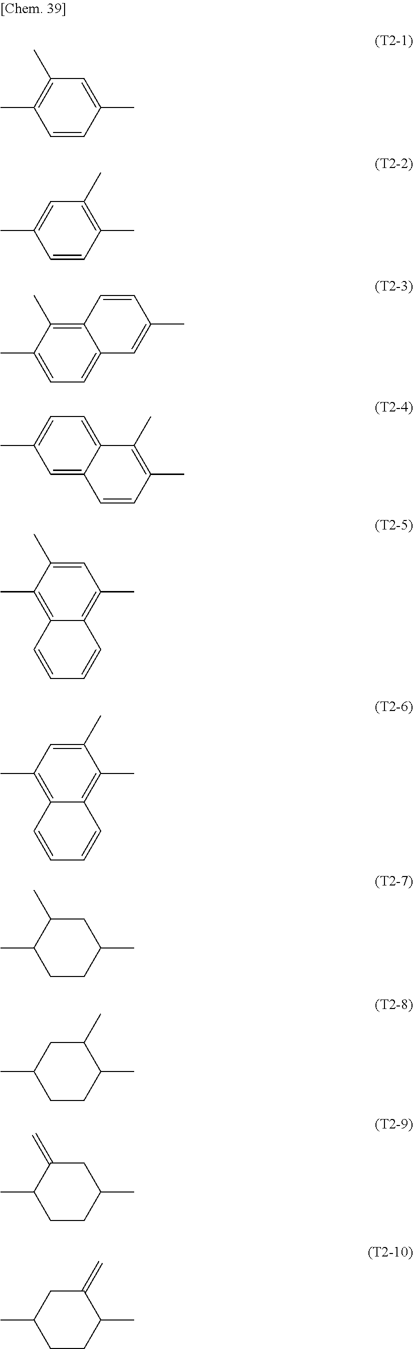

These groups may be unsubstituted or substituted with one or more of substituents L, and m31+m41 is preferably a group representing 1 to 6.

From viewpoints of availability of raw materials and ease of synthesis, A³¹ and A⁴¹ more preferably each independently represent a 1,4-phenylene group, a 1,4-cyclohexylene group, or a naphthalene-2,6-diyl group which are not substituted or may be substituted with one or more substituent L, more preferably each independently represent a group selected from Formula (A-A1-1) to Formula (A-A1-11),

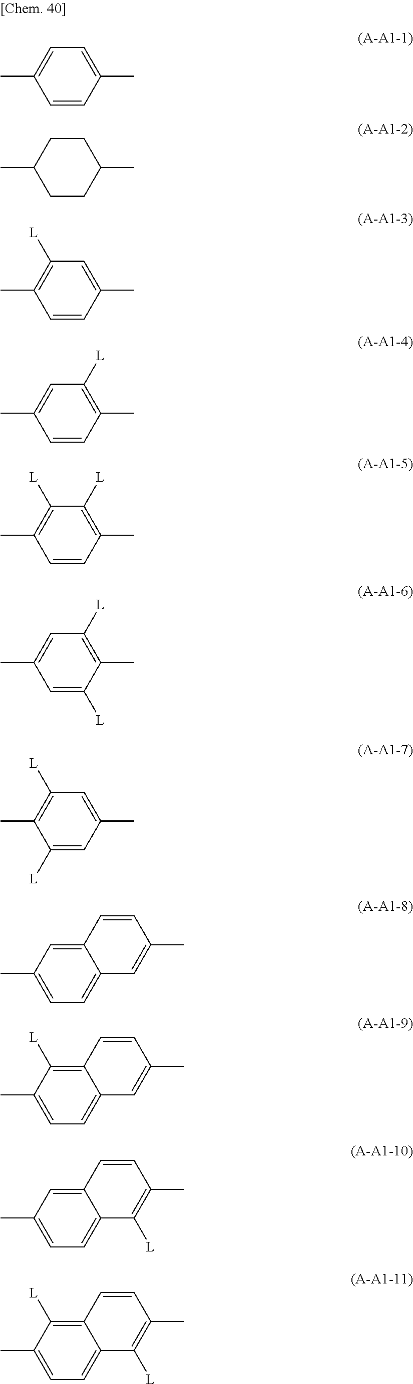

even more preferably each independently represent a group selected from Formula (A-A1-1) to Formula (A-A1-8), and particularly preferably each independently represent a group selected from Formula (A-A1-1) to Formula (A-A1-4).

From viewpoints of liquid crystal properties of the compound, availability of raw materials, and ease of synthesis, Z³¹ and Z⁴¹ preferably each independently represent a single bond, —OCH₂—, —CH₂O—, —COO—, —OCO—, —CF₂O—, —OCF₂—, —CH₂CH₂—, —CF₂CF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —CH═CH—, —CF═CF—, —C≡C—, or a single bond, more preferably each independently represent —OCH₂—, —CH₂O—, —CH₂CH₂—, —COO—, —OCO—, —COO—CH₂CH₂—, —OCO—CH₂CH₂—, —CH₂CH₂—COO—, —CH₂CH₂—OCO—, —CH═CH—, —C≡C—, or a single bond, even more preferably each independently represent —CH₂CH₂—, —COO—, —OCO—, —COO—CH₂CH₂—, —OCO—CH₂CH₂—, —CH₂CH₂—COO—, —CH₂CH₂—OCO—, or a single bond, and particularly preferably each independently represent —COO—, —OCO—, or a single bond.

From viewpoints of liquid crystal properties, ease of synthesis, and storage stability, m31 and m41 preferably each independently represent an integer of 1 to 4, more preferably each independently represent an integer of 1 to 3, and particularly preferably each independently represent 1 or 2. m31+m41 preferably each independently represents an integer of 1 to 4 and particularly preferably each independently represent 2, 3, or 4.

T²¹ is more preferably a group represented by Formula (T2-1) to Formula (T2-6) and even more preferably a group represented by Formula (T2-1) to Formula (T2-2).

In addition, in a case where M² is a group represented by Formula (I-M21), a group selected from <W¹-A11> to <W¹-A15> is preferably used and <W¹-A11>, <W¹-A12>, or <W¹-A14> is more preferably used as W¹.

<M²-A2>

In the compound in which <n1 and n2 represent 0 and n3 represents 1>, in a case of significantly considering appearance and alignment defects after ultraviolet light irradiation, when a film-shaped polymer is prepared, in General Formula (I), M² represents Formula (I-M22),

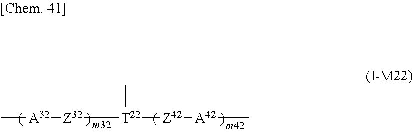

(in the formula, A³² being present and A⁴² being present each independently represent a 1,4-phenylene group, a 1,4-cyclohexylene group, a pyridine-2,5-diyl group, a pyrimidine-2,5-diyl group, a naphthalene-2,6-diyl group, a naphthalene-1,4-diyl group, a tetrahydronaphthalene-2,6-diyl group, a decahydronaphthalene-2,6-diyl group, or a 1,3-dioxane-2,5-diyl group, these groups may be unsubstituted or substituted with one or more of substituents L, and, in a case where a plurality of each of A³² and A⁴² is present, these may be the same as each other or different from each other. Z³² being present and Z⁴² being present each independently represent —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —OCO—NH—, —NH—COO—, —NH—CO—NH—, —NH—O—, —O—NH—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—, —N═CH—, —CH═N—N═CH—, —CF═CF—, —C≡C—, or a single bond, in a case where a plurality of each of Z³² and Z⁴² is present, these may be the same as each other or different from each other. T²² represents a trivalent group which may be substituted, and m32 and m42 each independently represent an integer of 0 to 5.), in Formula (I-M22), T²² represents a group selected from Formula (T2-11) to Formula (T2-27)

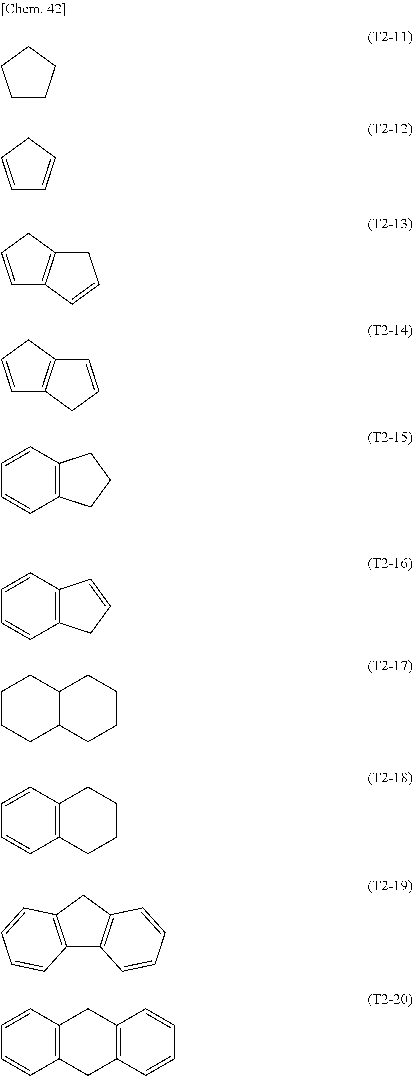

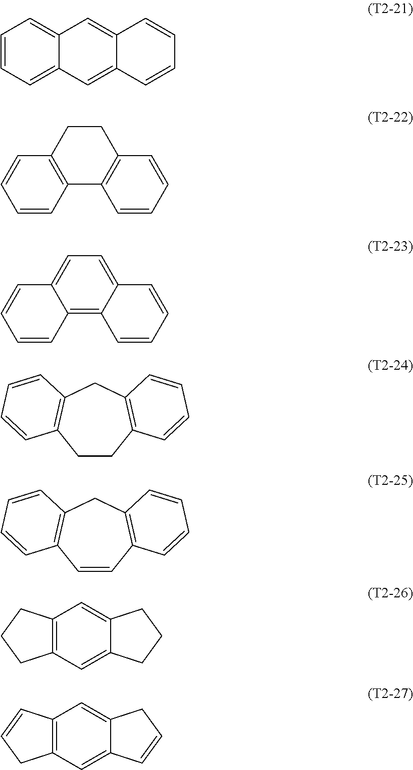

(in the formulae, a bonding site may be at an arbitrary position, arbitrary —CH═ may be each independently substituted with —N═, —CH₂— may be each independently substituted with —O—, —S—, —NR⁰— (in the formulae, R⁰ represents a hydrogen atom or an alkyl group having 1 to 20 carbon atoms), —CS— or —CO—, provided that a —O—O— bond is not included. In addition, these groups may be unsubstituted or substituted with one or more of substituents L.), Formula (T2-28) to Formula (T2-31),

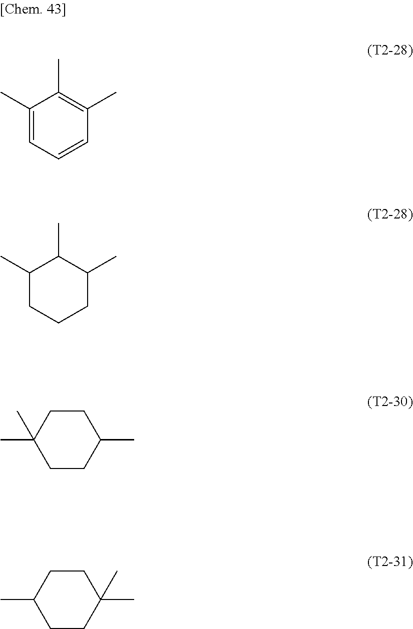

(in the formulae, a bonding site may be at an arbitrary position, arbitrary —CH═ may be each independently substituted with —N═, —CH₂— may be each independently substituted with —O—, —S—, —NR⁰— (in the formulae, R⁰ represents a hydrogen atom or an alkyl group having 1 to 20 carbon atoms), —CS— or —CO—, provided that a —O—O— bond is not included. In addition, these groups may be unsubstituted or substituted with one or more of substituents L.), Formula (T2-32),

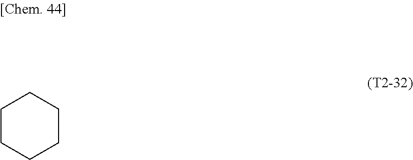

(in the formula, a bonding site may be at an arbitrary position, at least one —CH₂— is each independently substituted with —O—, —S—, —NR⁰— (in the formulae, R⁰ represents a hydrogen atom or an alkyl group having 1 to 20 carbon atoms), —CS— or —CO—, provided that a —O—O— bond is not included. In addition, these groups may be unsubstituted or substituted with one or more of substituents L.), and Formula (T2-33) or Formula (T2-34),

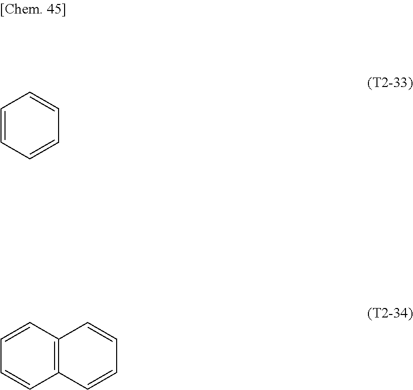 [SMILES: c1ccccc1 ; c1ccc2ccccc2c1]

(in the formulae, a bonding site may be at an arbitrary position, at least one —CH═ is each independently substituted with —N═. In addition, these groups may be unsubstituted or substituted with one or more of substituents L.), and m32+m42 is preferably a group representing an integer of 1 to 6.

In addition, M² represents Formula (I-M222),

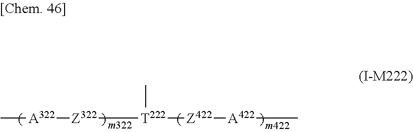

(in the formula, A³²² and A⁴² each independently represent a 1,4-phenylene group, a 1,4-cyclohexylene group, a pyridine-2,5-diyl group, a pyrimidine-2,5-diyl group, a naphthalene-2,6-diyl group, a naphthalene-1,4-diyl group, a tetrahydronaphthalene-2,6-diyl group, a decahydronaphthalene-2,6-diyl group, or a 1,3-dioxane-2,5-diyl group, these groups may be unsubstituted or substituted with one or more of substituents L, and, in a case where a plurality of each of A³²² and A⁴²² is present, these may be the same as each other or different from each other. Z³²² and Z⁴²² each independently represent —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —OCO—NH—, —NH—COO—, —NH—CO—NH—, —NH—O—, —O—NH—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—, —N═CH—, —CH═N—N═CH—, —CF═CF—, —C≡C—, or a single bond, in a case where a plurality of each of Z³²² and Z⁴²² is present, these may be the same as each other or different from each other. T²²² represents a trivalent group which may be substituted), in Formula (I-M222), T²²² represents a group selected from Formula (T2-35) to Formula (T2-41)

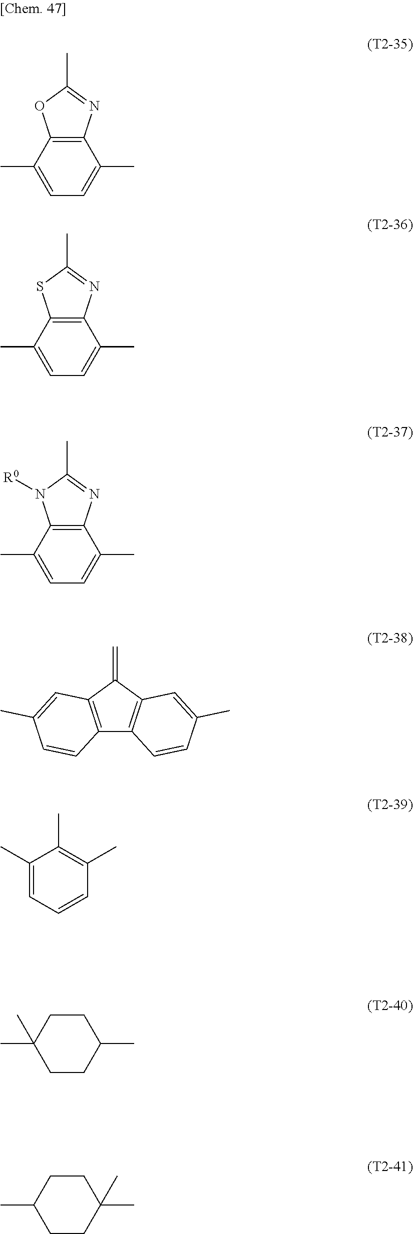

(in the formulae, R⁰ represents a hydrogen atom or an alkyl group having 1 to 20 carbon atoms), and m322 and m422 preferably each independently represent 1 or 2.

From viewpoints of availability of raw materials and ease of synthesis, A³²² and A⁴²² preferably represent a 1,4-phenylene group, a 1,4-cyclohexylene group, or a naphthalene-2,6-diyl group which are not substituted or may be substituted with one or more substituent L, more preferably each independently represent a group selected from Formula (A-A2-1) to Formula (A-A2-11),

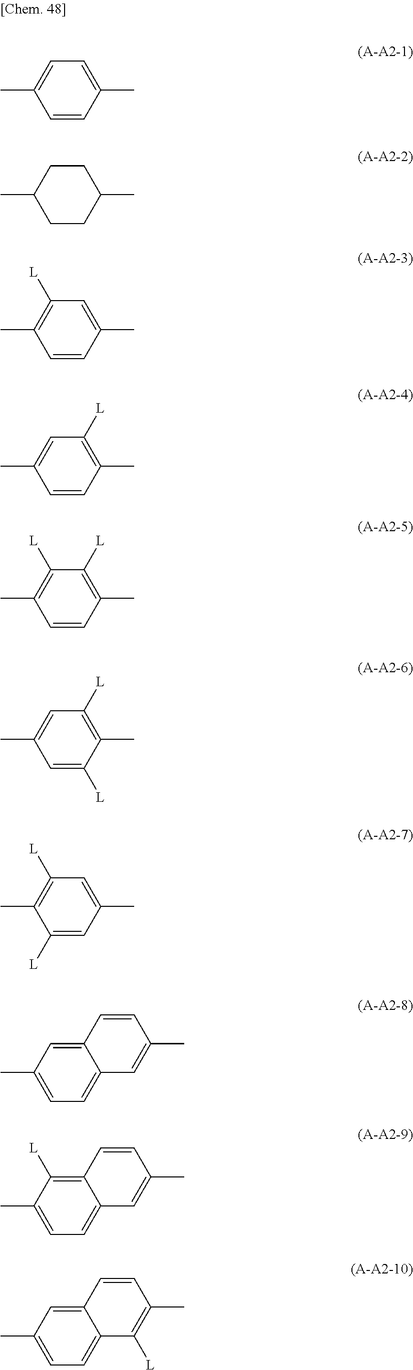

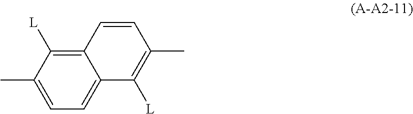

even more preferably each independently represent a group selected from Formula (A-A2-1) to Formula (A-A2-8), and particularly preferably each independently represent a group selected from Formula (A-A2-1) to Formula (A-A2-4).

From viewpoints of liquid crystal properties of the compound, availability of raw materials, and ease of synthesis, Z³²² and Z⁴²² preferably each independently represent a single bond, —OCH₂—, —CH₂O—, —COO—, —OCO—, —CF₂O—, —OCF₂—, —CH₂CH₂—, —CF₂CF₂—, —CH═CH—COO—, —CH═CH—OCO—, —COO—CH═CH—, —OCO—CH═CH—, —COO—CH₂CH₂—, —OCO—CH₂CH₂—, —CH—CH₂—COO—, —CH₂CH₂—OCO—, —CH═CH₂—, —CF═CF—, —C≡C—, or a single bond, more preferably each independently represent —OCH₂—, —CH₂O—, —CH₂CH₂—, —COO—, —OCO—, —COO—CH₂CH₂—, —OCO—CH₂CH₂—, —CH₂CH₂—COO—, —CH₂CH₂—OCO—, —CH═CH—, —C≡C—, or a single bond, even more preferably each independently represent —CH₂CH₂—, —COO—, —OCO—, —COO—CH₂CH₂—, —OCO—CH₂CH₂—, —CH₂CH₂—COO—, —CH₂CH₂—OCO—, or a single bond, and particularly preferably each independently represent —COO—, —OCO—, or a single bond.

T²²² is more preferably a group represented by Formula (T2-36), Formula (T2-38), Formula (T2-39), Formula (T2-40), or Formula (T2-41).

<W¹-A2>

In the compound in which <n1 and n2 represent 0 and n3 represents 1>, in a case of significantly considering appearance and alignment defects after ultraviolet light irradiation, when a film-shaped polymer is prepared, in General Formula (I), W¹ preferably represents a group selected from Formula (I-W19).

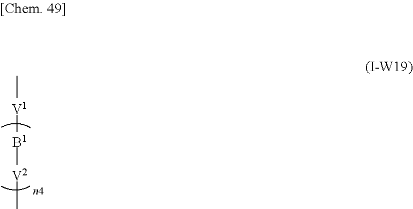

(In the formula, V¹ and V² each independently represent a single bond or a divalent linking group, B¹ each independently represents a group selected from Formula (B-1) to Formula (B-21),

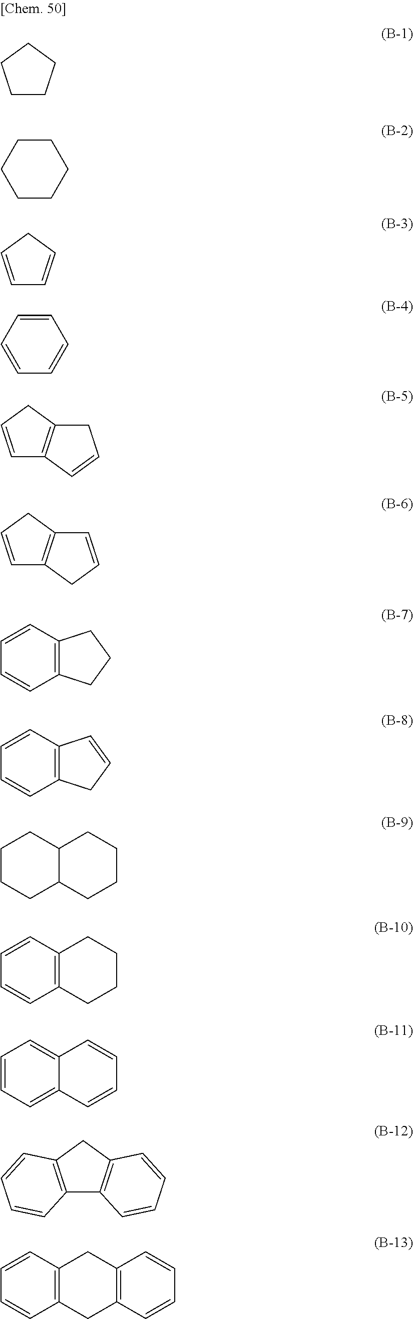

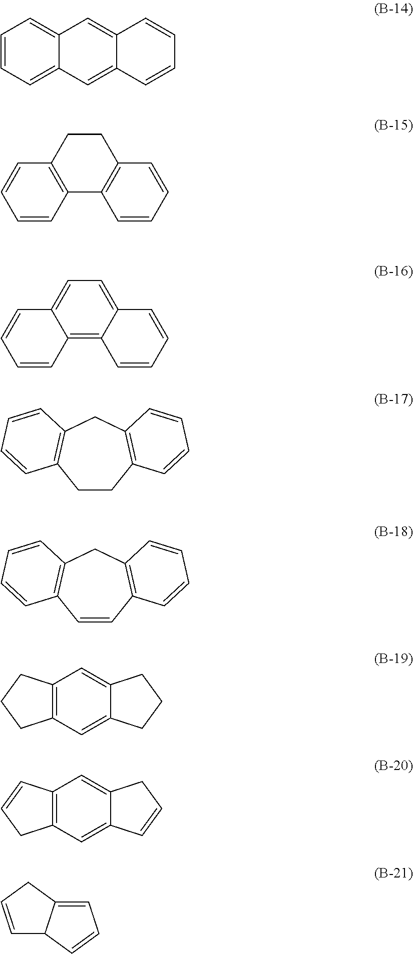

(in the formulae, a bonding site may be at an arbitrary position, arbitrary —CH═ may be each independently substituted with —N═, —CH₂— may be each independently substituted with —O—, —S—, —NR⁰— (in the formulae, R⁰ represents a hydrogen atom or an alkyl group having 1 to 20 carbon atoms), —CS— or —CO—, provided that a —O—O— bond is not included. In addition, these groups may be unsubstituted or substituted with one or more of substituents L.), and a single bond, and n4 represents an integer of 0 to 5.)

V¹ and V² are preferably each independently the groups represented by Formula (V-1) to Formula (V-15) shown in the section <(<W¹ and W²>> (in the formulae, in a case of including Y¹, Y¹ is preferably a group selected from viewpoints of availability of raw materials and ease of synthesis described in the section <<W¹ and W²>>), a single bond, a double bond, —O—, —S—, —OCH₂—, —CH₂O—, —CO—, —CH₂—, —COO—, —OCO—, —CO—S—, —S—CO—, —O—CO—O—, —CO—NH—, —NH—CO—, —CS—NH—, —NH—CS—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —CH₂CH₂—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, and —CH₂—OCO—, more preferably a group selected from Formula (V-1), Formula (V-2), Formula (V-5), Formula (V-6), Formula (V-7), Formula (V-8), Formula (V-9), Formula (V-12), Formula (V-13), —COO—, and —OCO—, and even more preferably a group selected from Formula (V-5), Formula (V-6), Formula (V-7), Formula (V-8), Formula (V-9), Formula (V-12), Formula (V-13), —COO—, and —OCO—.

B¹ is preferably each independently a group selected from Formula (B-4), Formula (B-8), Formula (B-11), Formula (B-12), and a single bond. More specifically, B¹ is preferably a group selected from Formula (B-4-1), Formula (B-8-7), Formula (B-11-1), Formula (B-12-4) shown in the section <<W¹ and W²>>, and a single bond, and more preferably a group selected from Formula (B-4-1), Formula (B-8-7), Formula (B-12-4), and a single bond.

n4 represents preferably 0 to 8 and more preferably represents 0 to 6.

In addition, in a case where T²²² represents a group selected from Formula (T2-35) or Formula (T2-36), in Formula (I-W19), B¹ represents a single bond, n4 represents 1 to 6, and V¹ and V² preferably represent a group other than a single bond.

<M²-A3>

In the compound in which <n1 and n2 represent 0 and n3 represents 1>, in a case of significantly considering storage stability when the compound is added to a polymerizable composition, evenness of film thickness and alignment defects after ultraviolet light irradiation, when a film-shaped polymer is prepared, in General Formula (I), M represents Formula (I-M23),

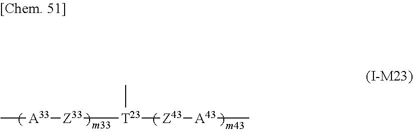

(in the formula, A³³ being present and A⁴³ being present each independently represent a 1,4-phenylene group, a 1,4-cyclohexylene group, a pyridine-2,5-diyl group, a pyrimidine-2,5-diyl group, a naphthalene-2,6-diyl group, a naphthalene-1,4-diyl group, a tetrahydronaphthalene-2,6-diyl group, a decahydronaphthalene-2,6-diyl group, or a 1,3-dioxane-2,5-diyl group, these groups may be unsubstituted or substituted with one or more of substituents L, and, in a case where a plurality of each of A³³ and A⁴³ is present, these may be the same as each other or different from each other. Z³³ being present and Z⁴³ being present each independently represent —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —OCO—NH—, —NH—COO—, —NH—CO—NH—, —NH—O—, —O—NH—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—, —N═CH—, —CH═N—N═CH—, —CF═CF—, —C≡C—, or a single bond, in a case where a plurality of each of Z³³ and Z⁴³ is present, these may be the same as each other or different from each other. T²³ represents a trivalent group which may be substituted, and m33 and m43 each independently represent an integer of 0 to 5.), in Formula (I-M23), T²³ represents an acyclic group having 1 to 80 carbon atoms which may be substituted, arbitrary carbon atoms of the acyclic group may be substituted with hetero atoms, and m33+m43 is preferably a group representing an integer of 1 to 6.

In addition, M² represents Formula (I-M232),

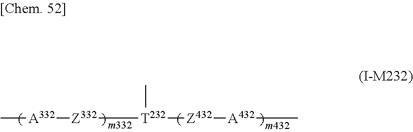

(in the formula, A³³ being present and A⁴³² being present each independently represent a 1,4-phenylene group, a 1,4-cyclohexylene group, a pyridine-2,5-diyl group, a pyrimidine-2,5-diyl group, a naphthalene-2,6-diyl group, a naphthalene-1,4-diyl group, a tetrahydronaphthalene-2,6-diyl group, a decahydronaphthalene-2,6-diyl group, or a 1,3-dioxane-2,5-diyl group, these groups may be unsubstituted or substituted with one or more of substituents L, and, in a case where a plurality of each of A³³² and A⁴³² is present, these may be the same as each other or different from each other. Z³³² being present and Z⁴³ being present each independently represent —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —OCO—NH—, —NH—COO—, —NH—CO—NH—, —NH—O—, —O—NH—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—, —N═CH—, —CH═N—N═CH—, —CF═CF—, —C≡C—, or a single bond, in a case where a plurality of each of Z³³² and Z⁴³² is present, these may be the same as each other or different from each other. T²³² represents a trivalent group which may be substituted, and m332 and m432 each independently represent an integer of 0 to 5), in Formula (I-M232), T²³² represents a group represented by Formula (T-22),

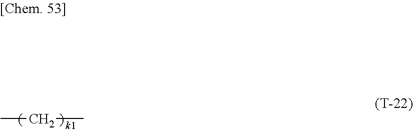

(in the formula, a bonding site may be at an arbitrary position, arbitrary —CH₂— may be each independently substituted with —O—, —S—, —NR⁰— (in the formula, R⁰ represents a hydrogen atom or an alkyl group having 1 to 20 carbon atoms), —CS— or —CO—, provided that a —O—O— bond is not included. In addition, these groups may be unsubstituted or substituted with one or more of substituents L, and k1 represents an integer of 1 to 20.), and m332+m432 more preferably represents an integer of 1 to 6.

From viewpoints of availability of raw materials and ease of synthesis, A³³² and A⁴³² more preferably represent a 1,4-phenylene group, a 1,4-cyclohexylene group, or a naphthalene-2,6-diyl group which are not substituted or may be substituted with one or more substituent L, more preferably each independently represent a group selected from Formula (A-A2-1) to Formula (A-A2-11),

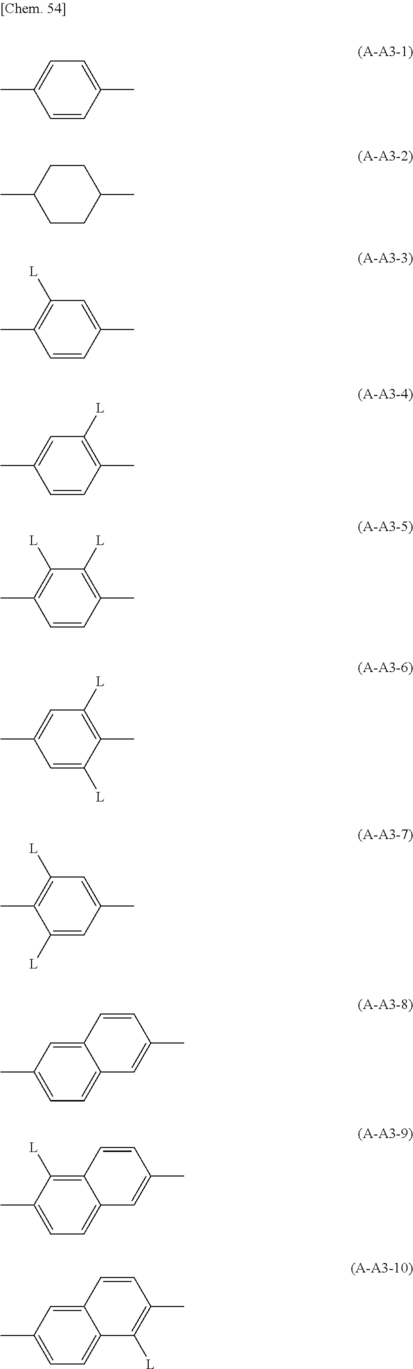

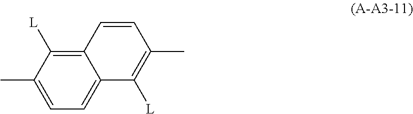

even more preferably each independently represent a group selected from Formula (A-A3-1) to Formula (A-A3-8), and particularly preferably each independently represent a group selected from Formula (A-A3-1) to Formula (A-A3-4).

From viewpoints of liquid crystal properties of the compound, availability of raw materials, and ease of synthesis, Z³³² and Z⁴³² preferably each independently represent a single bond, —OCH₂—, —CH₂O—, —COO—, —OCO—, —CF₂O—, —OCF₂—, —CH₂CH₂—, —CF₂CF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —CH═CH—, —CF═CF—, —C≡C—, or a single bond, more preferably each independently represent —OCH₂—, —CH₂O—, —CH₂CH₂—, —COO—, —OCO—, —COO—CH₂CH₂—, —OCO—CH₂CH₂—, —CH₂CH₂—COO—, —CH₂CH₂—OCO—, —CH═CH—, —C≡C—, or a single bond, even more preferably each independently represent —CH₂CH₂—, —COO—, —OCO—, —COO—CH₂CH₂—, —OCO—CH₂CH₂—, —CH₂CH₂—COO—, —CH₂CH₂—OCO—, or a single bond, and particularly preferably each independently represent —COO—, —OCO—, or a single bond.

From viewpoints of liquid crystal properties, ease of synthesis, and storage stability, m332 and m432 preferably each independently represent an integer of 1 to 4, more preferably each independently represent an integer of 1 to 3, and particularly preferably each independently represent 1 or 2. m31+m41 preferably each independently represent an integer of 1 to 4 and particularly preferably each independently represent 2, 3, or 4.

T²³² preferably represents a group selected from Formula (T-22-1) or Formula (T-22-2),

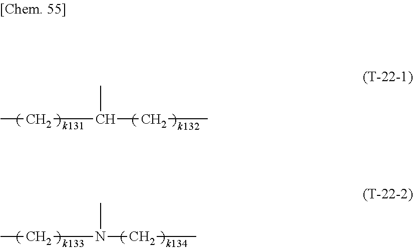

(in the formulae, arbitrary —CH₂— may be each independently substituted with —O—, —S—, —NR⁰— (in the formula, R⁰ represents a hydrogen atom or an alkyl group having 1 to 20 carbon atoms), —CS— or —CO—, provided that a —O—O— bond is not included. In addition, these groups may be unsubstituted or substituted with one or more of substituents L, and k131 to k134 represent an integer of 0 to 20), and more preferably represent Formula (T-22-1). It is particularly preferable that k131 and k132 in Formula (T-22-1) represent 1.

<W¹-A3>

In the compound in which <n1 and n2 represent 0 and n3 represents 1>, in a case of significantly considering storage stability when the compound is added to a polymerizable composition, evenness of film thickness and alignment defects after ultraviolet light irradiation, when a film-shaped polymer is prepared, in General Formula (I), W¹ represents Formula (I-W20).

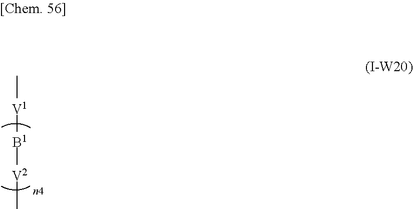

(In the formula, V¹ and V² being present each independently represent a single bond or a divalent linking group, B's being present each independently a group selected from Formula (B-1) to Formula (B-21),

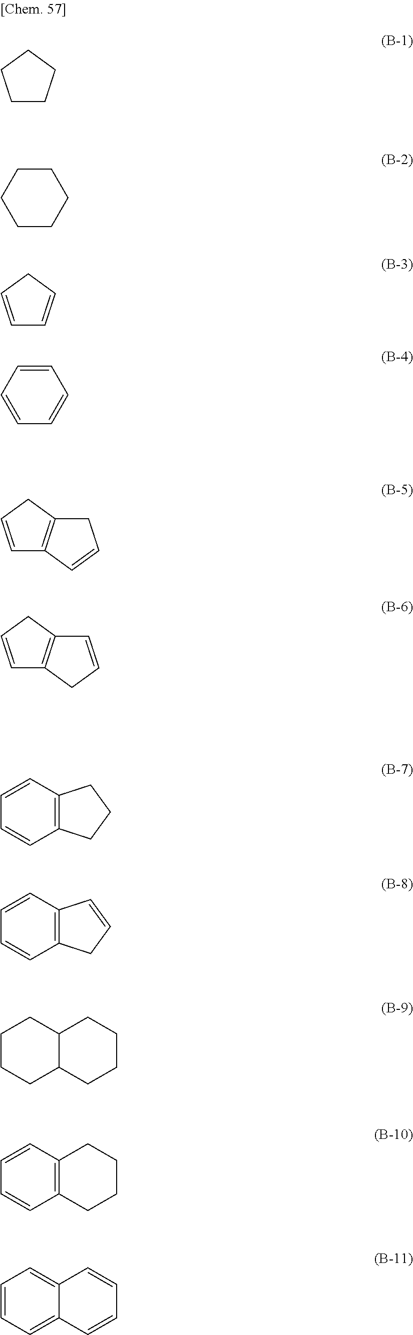

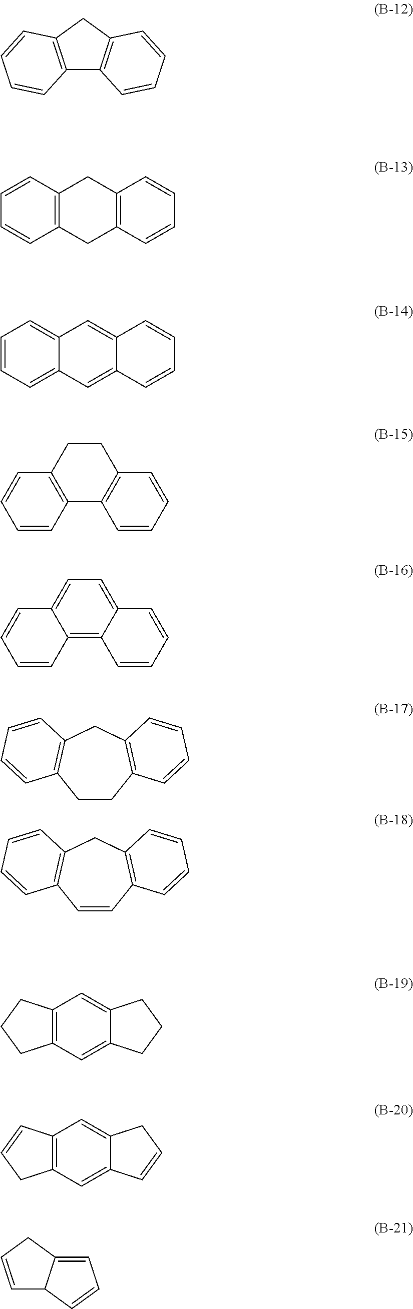

(in the formulae, a bonding site may be at an arbitrary position, arbitrary —CH═ may be each independently substituted with —N═, —CH₂— may be each independently substituted with —O—, —S—, —NR⁰— (in the formulae, R⁰ represents a hydrogen atom or an alkyl group having 1 to 20 carbon atoms), —CS— or —CO—, provided that a —O—O— bond is not included. In addition, these groups may be unsubstituted or substituted with one or more of substituents L.), and a single bond, and n4 represents an integer of 0 to 5.)

V¹ and V² are preferably each independently the groups represented by Formula (V-1) to Formula (V-15) shown in the section <<W¹ and W²>> (in the formulae, in a case of including Y¹, Y¹ is preferably a group selected from viewpoints of availability of raw materials and ease of synthesis described in the section <<W¹ and W²>>), a single bond, a double bond, —O—, —S—, —OCH₂—, —CH₂O—, —CO—, —CH₂—, —COO—, —OCO—, —CO—S—, —S—CO—, —O—CO—O—, —CO—NH—, —NH—CO—, —CS—NH—, —NH—CS—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —CH₂CH₂—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, and —CH₂—OCO—, more preferably a group selected from Formula (V-5), Formula (V-6), Formula (V-8), Formula (V-9), Formula (V-10), and a single bond, and even more preferably a group selected from Formula (V-5), Formula (V-6), Formula (V-8), and Formula (V-9). In addition, from a viewpoint of ease of synthesis, a group directly bonded to T²³² among the groups represented by V² is preferably a group other than the group represented by Formula (V-6).

B¹ is preferably each independently a group selected from Formula (B-4), Formula (B-8), Formula (B-11), and a single bond. More specifically, B¹ is preferably a group selected from Formula (B-4-1), Formula (B-8-7), Formula (B-11-1), shown in the section <<W¹ and W²>>, and a single bond, and more preferably a group selected from Formula (B-4-1), and a single bond.

<R³ and R⁴>

In the compound in which <n1 and n2 represent 0 and n3 represents 1>, M² and W¹ described above are preferably suitably selected and the following groups are preferably used as R³ and R⁴.

R³ represents a group represented by Formula (I-R).

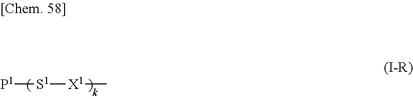

(In the formula, P¹ represents a polymerizable group, S¹ represents a spacer group or a single bond, in a case where a plurality of S¹ is present, these may be the same as each other or different from each other, X¹ represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, in a case where a plurality of X¹ is present in the compound, these may be the same as each other or different from each other (provided that P¹—(S¹—X¹)ₖ— does not include a —O—O— bond), and k represents an integer of 0 to 10.) R⁴ preferably represents a group selected from the group represented by Formula (I-R) and R⁵ (in the formula, R⁵ represents a hydrogen atom, a fluorine atom, a chlorine atom, a bromine atom, an iodine atom, a pentafluorosulfuranyl group, a nitro group, a cyano group, an isocyano group, an amino group, a hydroxyl group, a mercapto group, a methylamino group, a dimethylamino group, a diethylamino group, a diisopropylamino group, a trimethylsilyl group, a dimethylsilyl group, a thioisocyano group, or a linear or branched alkyl group having 1 to 20 carbon atoms, in which one —CH₂— or two or more of (—CH₂—)'s that are not adjacent to each other may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, and one or more of arbitrary hydrogen atoms in the alkyl group may be substituted with a fluorine atom). Both R³ and R⁴ are particularly preferably the group represented by Formula (I-R), and in this case, the preferable groups and numerical values shown in the section of <<R¹, R², R³, and R⁴>> are respectively applied to P¹, S¹, X¹, and k.

Compound in Which <<n1 Represents 1, n2 Represents 0, and n3 Represents 1>>

<W¹—B11>

In the compound in which <n1 represents 1, n2 represents 0, and n3 represents 1>, in a case of significantly considering unevenness of alignment and surface hardness, when a film-shaped polymer is prepared, in General Formula (I), W¹ is preferably a group represented by Formula (I-W15).

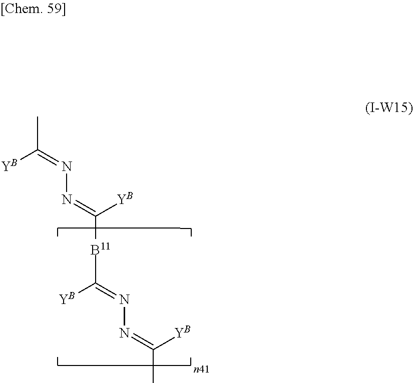

(In the formula, Y^{B} represents a hydrogen atom, a fluorine atom, a chlorine atom, a bromine atom, an iodine atom, a pentafluorosulfuranyl group, a nitro group, a cyano group, an isocyano group, an amino group, a hydroxyl group, a mercapto group, a methylamino group, a dimethylamino group, a diethylamino group, a diisopropylamino group, a trimethylsilyl group, a dimethylsilyl group, a thioisocyano group, or a linear or branched alkyl group having 1 to 20 carbon atoms, in which one —CH₂— or two or more of (—CH₂—)'s that are not adjacent to each other may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, one or more of arbitrary hydrogen atoms in the alkyl group may be substituted with a fluorine atom, and in a case where a plurality of Y^{B} is present, these may be the same as each other or different from each other. Alternatively, Y^{B} may represent a group represented by P—(S—X)ⱼ—, P represents a polymerizable group, S represents a spacer group or a single bond, in a case where a plurality of S is present, these may be the same as each other or different from each other, X represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, in a case where a plurality of X is present, these may be the same as each other or different from each other (provided that P—(S—X)ⱼ— does not include a —O—O— bond), j represents an integer of 0 to 10, B¹¹ represents a group selected from Formula (B-1) to Formula (B-21)

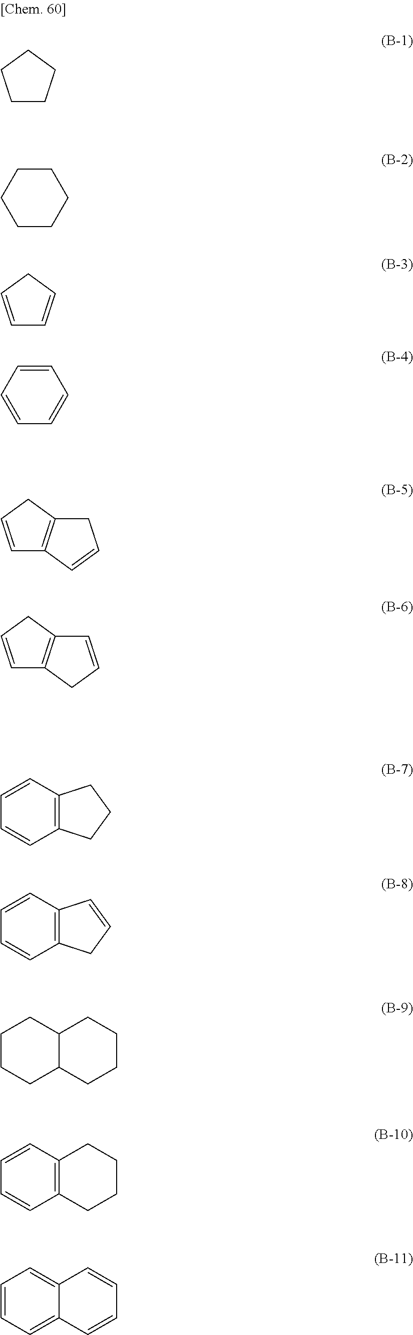

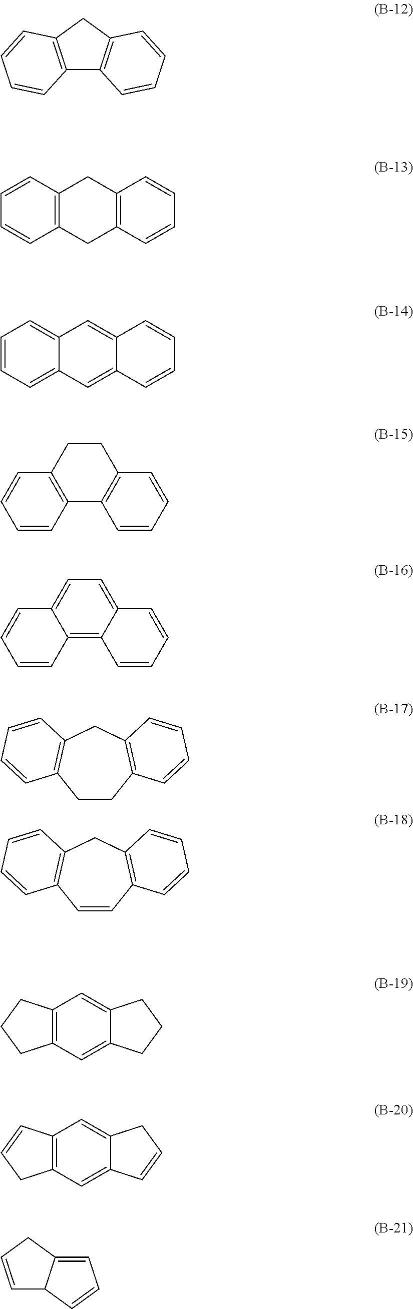

(in the formulae, a bonding site may be at an arbitrary position, arbitrary —CH═ may be each independently substituted with —N═, —CH₂— may be each independently substituted with —O—, —S—, —NR⁰— (in the formulae, R⁰ represents a hydrogen atom or an alkyl group having 1 to 20 carbon atoms), —CS— or —CO—, provided that a —O—O— bond is not included. In addition, these groups may be unsubstituted or substituted with one or more of substituents L), or a single bond, n41 represents an integer of 0 to 5.) In addition, Y^{B} more preferably represents a hydrogen atom, a fluorine atom, a chlorine atom, a nitro group, a cyano group, or a linear or branched alkyl group having 1 to 20 carbon atoms, in which one —CH₂— or two or more of (—CH₂—)'s that are not adjacent to each other may be each independently substituted with —O—, even more preferably represents a hydrogen atom or a methyl group, and still more preferably represents a hydrogen atom. B¹¹ is preferably each independently a group selected from Formula (B-4) and Formula (B-11). More specifically, B¹¹ is specifically preferably a group selected from Formula (B-4-1) and Formula (B-11-1) shown in the section <<W¹ and W²>>. n41 more preferably represents 0, 1, or 2, even more preferably represents 0 or 1, and still more preferably represents 0.

<W¹—B2>

In the compound in which <n1 represents 1, n2 represents 0, and n3 represents 1>, in a case of significantly considering surface hardness and adhesiveness, when a film-shaped polymer is prepared, in General Formula (I), W¹ is preferably a group represented by Formula (I-W21).

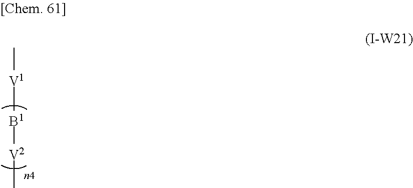

(In the formula, V¹ and V² each independently represent a single bond or a divalent linking group, B¹ each independently represents a group selected from Formula (B-1) to Formula (B-21),

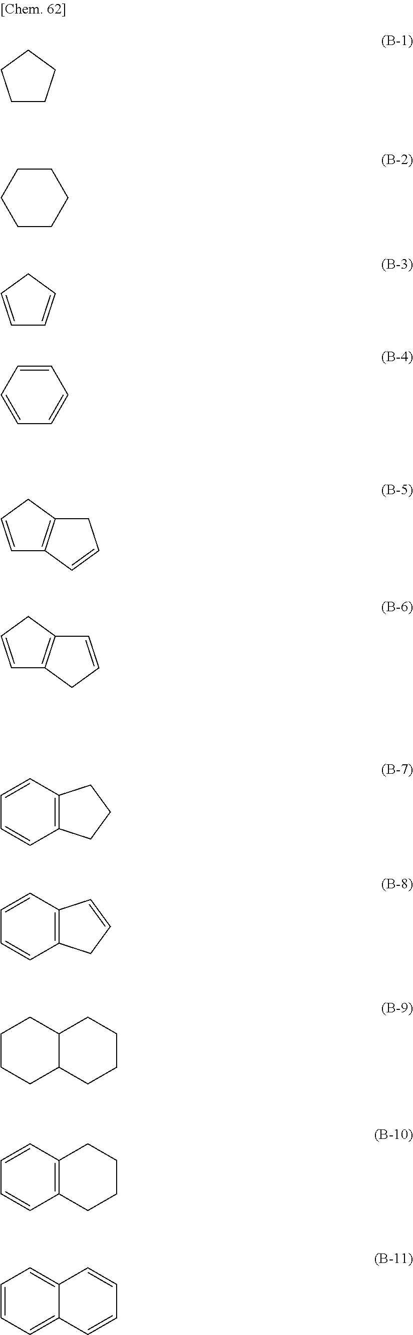

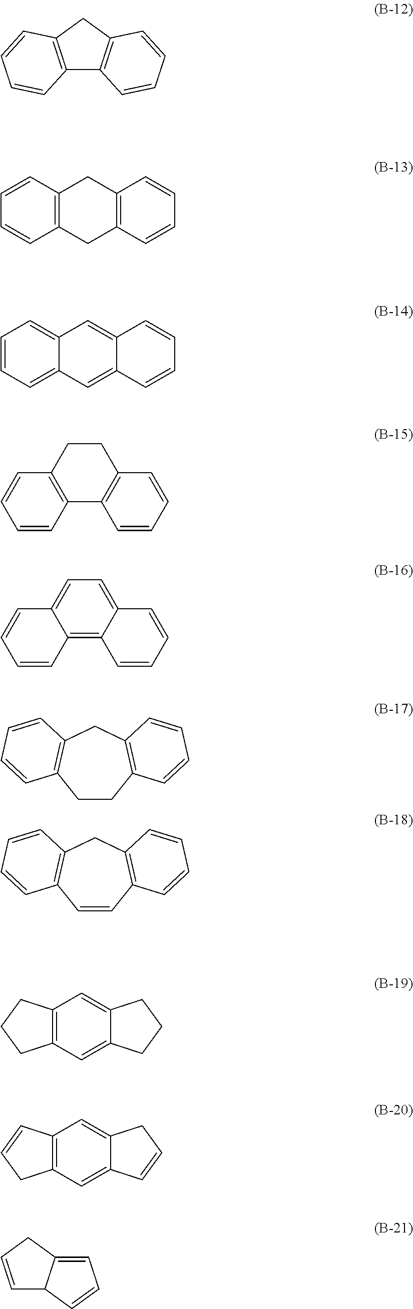

(in the formulae, a bonding site may be at an arbitrary position, arbitrary —CH═ may be each independently substituted with —N═, —CH₂— may be each independently substituted with —O—, —S—, —NR⁰— (in the formulae, R⁰ represents a hydrogen atom or an alkyl group having 1 to 20 carbon atoms), —CS— or —CO—, provided that a —O—O— bond is not included. In addition, these groups may be unsubstituted or substituted with one or more of substituents L.), and a single bond, and n4 represents an integer of 0 to 5.)

V¹ and V¹ are preferably each independently the groups represented by Formula (V-1) to Formula (V-15) shown in the section <<W¹ and W²>> (in the formulae, in a case of including Y¹, Y¹ is preferably a group selected from viewpoints of availability of raw materials and ease of synthesis described in the section <<W¹ and W²>>), a single bond, a double bond, —O—, —S—, —OCH₂—, —CH₂O—, —CO—, —CH₂—, —COO—, —OCO—, —CO—S—, —S—CO—, —O—CO—O—, —CO—NH—, —NH—CO—, —CS—NH—, —NH—CS—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —CH₂CH₂—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, and —CH₂—OCO—, more preferably a group selected from Formula (V-1), Formula (V-2), Formula (V-5), Formula (V-6), Formula (V-7), Formula (V-8), Formula (V-9), a single bond, —COO—, —OCO—, —CO—NH—, —NH—CO—, and —CH₂CH₂—, even more preferably a group selected from Formula (V-1), Formula (V-2), Formula (V-5), Formula (V-7), a single bond, —COO—, —OCO—, —CO—NH—, —NH—CO—, and —CH₂CH₂—, and still more preferably a group selected from Formula (V-1), Formula (V-2), —COO—, —OCO—, —CO—NH—, —NH—CO—, and —CH₂CH₂—.

B¹ is preferably each independently a group selected from Formula (B-4), Formula (B-20), and a single bond. More specifically, B¹ is specifically preferably a group selected from Formula (B-4-1), Formula (B-20-2) shown in the section <<W¹ and W2>>, and a single bond.

<W¹—B3>

In the compound in which <n1 represents 1, n2 represents 0, and n3 represents 1>, in a case of significantly considering adhesiveness, and appearance after ultraviolet light irradiation, when a film-shaped polymer is prepared, in General Formula (I), W1 is preferably a group represented by Formula (I-W22).

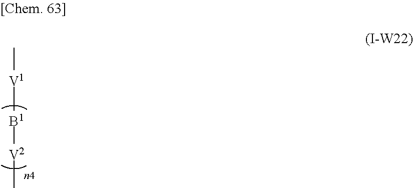

(In the formula, V² and V² each independently represent a single bond or a divalent linking group, B¹ each independently represents a group selected from Formula (B-1) to Formula (B-21),

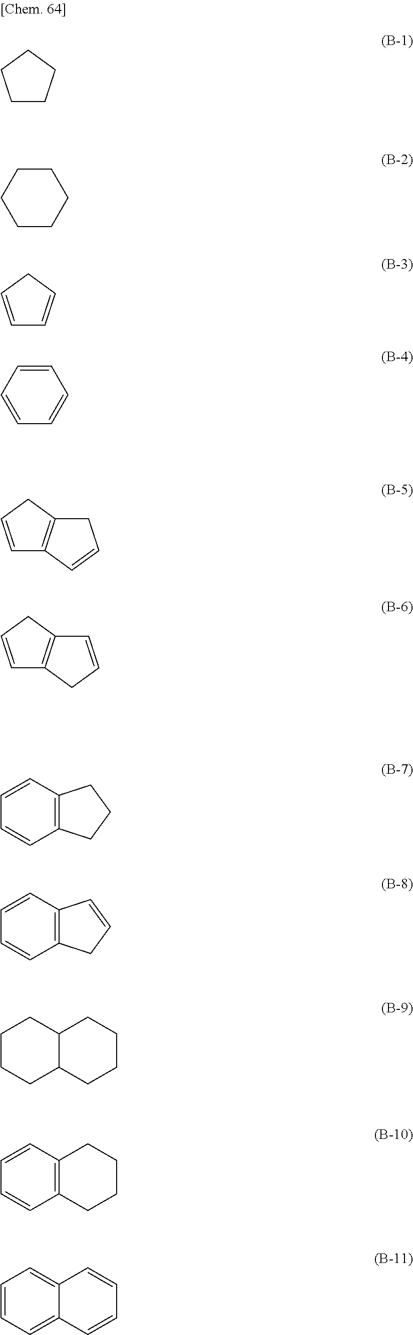

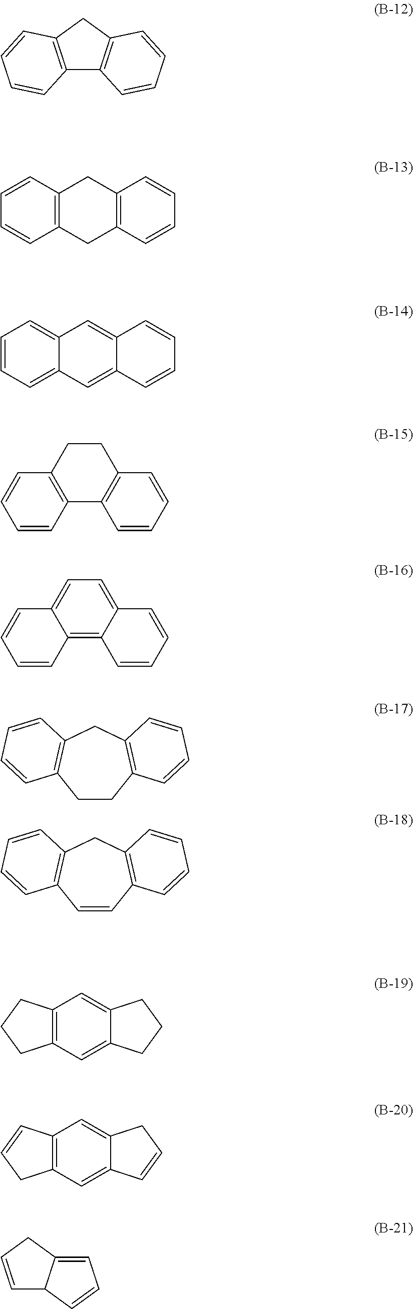

(in the formulae, a bonding site may be at an arbitrary position, arbitrary —CH═ may be each independently substituted with —N═, —CH₂— may be each independently substituted with —O—, —S—, —NR⁰— (in the formulae, R⁰ represents a hydrogen atom or an alkyl group having 1 to 20 carbon atoms), —CS— or —CO—, provided that a —O—O— bond is not included. In addition, these groups may be unsubstituted or substituted with one or more of substituents L.), and a single bond, and n4 represents an integer of 0 to 5.)

V¹ and V² are preferably each independently the groups represented by Formula (V-1) to Formula (V-15) shown in the section <<W¹ and W²>> (in the formulae, in a case of including Y¹, Y¹ is preferably a group selected from viewpoints of availability of raw materials and ease of synthesis described in the section <<W¹ and W²>>), a single bond, a double bond, —O—, —S—, —OCH₂—, —CH₂O—, —CO—, —CH₂—, —COO—, —OCO—, —CO—S—, —S—CO—, —O—CO—O—, —CO—NH—, —NH—CO—, —CS—NH—, —NH—CS—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —CH₂CH₂—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, and —CH₂—OCO—, more preferably a group selected from Formula (V-6), Formula (V-7), Formula (V-8), Formula (V-9), Formula (V-10), a single bond, —COO—, —OCO—, —CS—NH—, and —NH—CS—, and even more preferably a group selected from Formula (V-8), Formula (V-9), —COO—, and —OCO—.

B¹ is preferably each independently a group selected from Formula (B-4), Formula (B-11), and a single bond, and more preferably each independently a group selected from Formula (B-4) and a single bond. More specifically, B¹ is preferably a group selected from Formula (B-4-1), Formula (B-11-1) shown in the section <<W¹ and W²>>, and a single bond, and more preferably a group selected from Formula (B-4-1) and a single bond.

<M¹-B and M²-B>

In the compound in which <n1 represents 1, n2 represents 0, and n3 represents 1>, unevenness of alignment, surface hardness, or adhesiveness, when a film-shaped polymer is prepared, are excellent due to the structure of the compound. Therefore, in General Formula (I), M¹ represents a group represented by Formula (I-M14) and M² represents a group represented by Formula (I-M24).

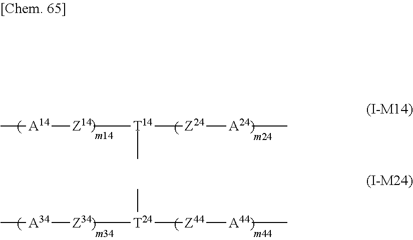

(In the formula, A¹⁴, A²⁴, A³⁴, and A⁴⁴ each independently represent a 1,4-phenylene group, a 1,4-cyclohexylene group, a pyridine-2,5-diyl group, a pyrimidine-2,5-diyl group, a naphthalene-2,6-diyl group, a naphthalene-1,4-diyl group, a tetrahydronaphthalene-2,6-diyl group, a decahydronaphthalene-2,6-diyl group, or a 1,3-dioxane-2,5-diyl group, these groups may be unsubstituted or substituted with one or more of substituents L, and, in a case where a plurality of each of A¹⁴, A²⁴, A³⁴, and A⁴⁴ is present, these may be the same as each other or different from each other. Z¹⁴, Z²⁴, Z³⁴, and Z⁴⁴ each independently represent —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —OCO—NH—, —NH—COO—, —NH—CO—NH—, —NH—O—, —O—NH—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—, —N═CH—, —CH═N—N═CH—, —CF═CF—, —C≡C—, or a single bond, in a case where a plurality of each of Z¹⁴, Z²⁴, Z³⁴, and Z⁴⁴ is present, these may be the same as each other or different from each other. m14, m24, m34, and m44 each independently represent an integer of 0 to 5.)

In Formula (I-M14) and Formula (I-M24), T¹⁴ and T²⁴ are preferably each independently a group selected from Formula (T-1) to Formula (T-22).

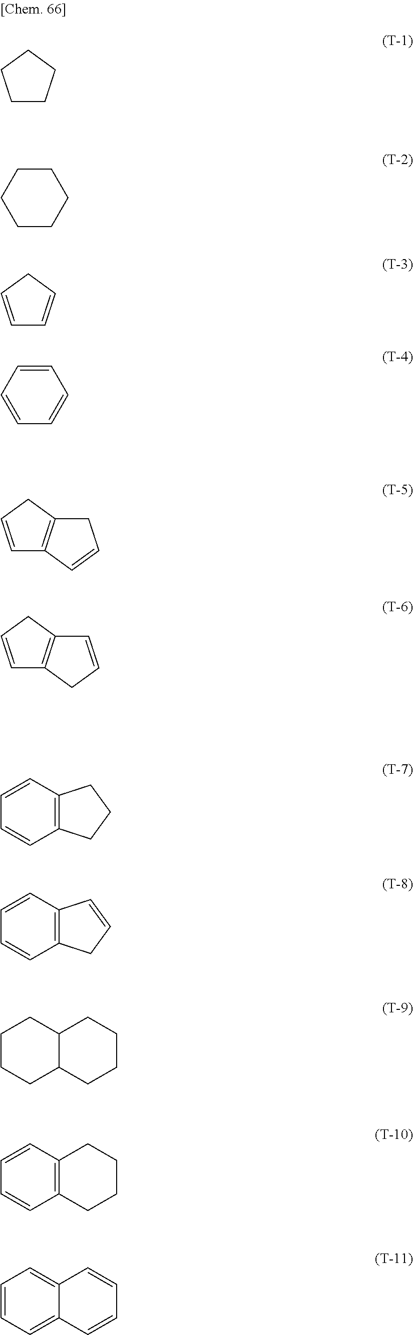

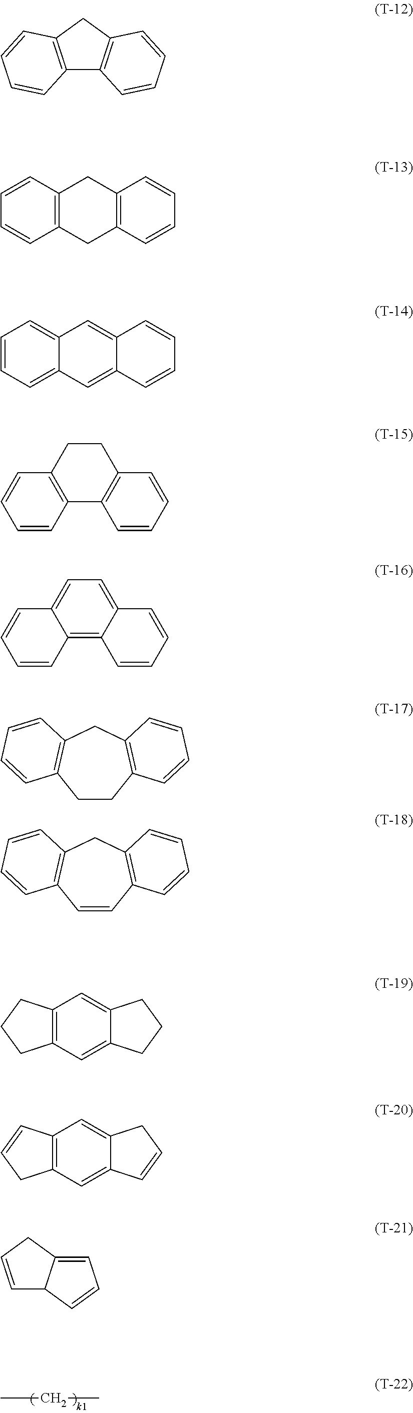

(In the formulae, a bonding site may be at an arbitrary position, arbitrary —CH═ may be each independently substituted with —N═, —CH₂— may be each independently substituted with —O—, —S—, —NR⁰— (in the formulae, R⁰ represents a hydrogen atom or an alkyl group having 1 to 20 carbon atoms), —CS— or —CO—, provided that a —O—O— bond is not included. In addition, these groups may be unsubstituted or substituted with one or more of substituents L, and k1 represents an integer of 1 to 20.) In addition, T¹⁴ and T²⁴ preferably each independently represent one group selected from Formula (T-1) to Formula (T-22) and even more preferably each independently represent the same group.

From viewpoints of availability of raw materials and ease of synthesis, A¹⁴, A²⁴, A³⁴, and A⁴⁴ preferably represent a 1,4-phenylene group, a 1,4-cyclohexylene group, or a naphthalene-2,6-diyl group which are not substituted or may be substituted with one or more substituent L, more preferably each independently represent a group selected from Formula (A-A2-1) to Formula (A-A2-11),

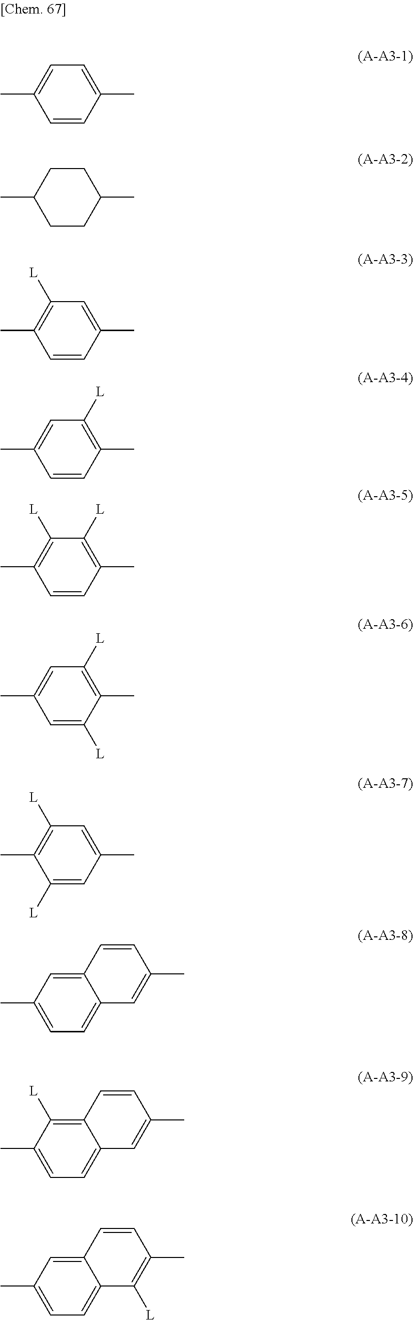

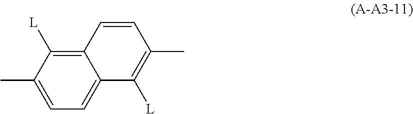

even more preferably each independently represent a group selected from Formula (A-A3-1) to Formula (A-A3-8), and particularly preferably each independently represent a group selected from Formula (A-A3-1) to Formula (A-A3-4).

From viewpoints of liquid crystal properties of the compound, availability of raw materials, and ease of synthesis, Z¹⁴, Z²⁴, Z³⁴, and Z⁴⁴ preferably each independently represent a single bond, —OCH₂—, —CH₂O—, —COO—, —OCO—, —CF₂O—, —OCF₂—, —CH₂CH₂—, —CF₂CF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —CH═CH—, —CF═CF—, —C≡C—, or a single bond, more preferably each independently represent —OCH₂—, —CH₂O—, —CH₂CH₂—, —COO—, —OCO—, —COO—CH₂CH₂—, —OCO—CH₂CH₂—, —CH₂CH₂—COO—, —CH₂CH₂—OCO—, —CH═CH—, —C≡C—, or a single bond, even more preferably each independently represent —CH₂CH₂—, —COO—, —OCO—, —COO—CH₂CH₂—, —OCO—CH₂CH₂—, —CH₂CH₂—COO—, —CH₂CH₂—OCO—, or a single bond, and particularly preferably each independently represent —COO—, —OCO—, or a single bond.

From viewpoints of liquid crystal properties of the compound, ease of synthesis, and storage stability, m14, m24, m34, and m44 preferably each independently represent an integer of 1 to 4, more preferably each independently represent an integer of 1 to 3, and particularly preferably each independently represent 1 or 2. m14+m24 and m34+m44 preferably each independently represent an integer of 1 to 4 and more preferably each independently represent 2, 3, or 4.

<M¹-B11 and M²-B11>

In a case of significantly considering unevenness of alignment and surface hardness, when a film-shaped polymer is prepared, T¹⁴ in Formula (I-M14) preferably represents the component described above and T²⁴ in Formula (I-M24) preferably represents a group selected from Formula (T2-1) to Formula (T2-10).

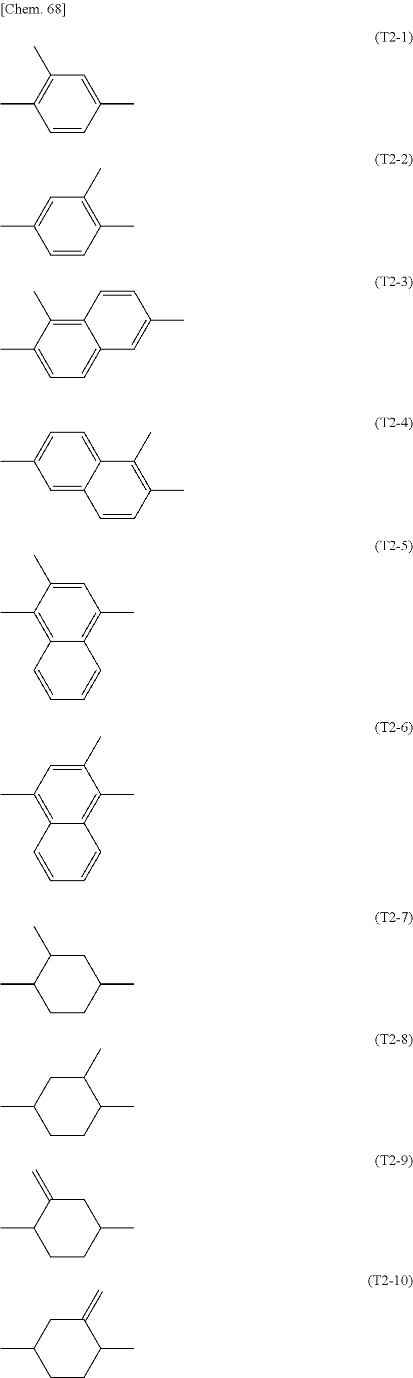

These groups may be unsubstituted or substituted with one or more of substituents L.

In addition, T²⁴ is more preferably a group represented by Formula (T2-1) to Formula (T2-6) and even more preferably a group represented by Formula (T2-1) or Formula (T2-2). Further, T¹⁴ represents a group selected from Formula (T1-1) to Formula (T1-10).

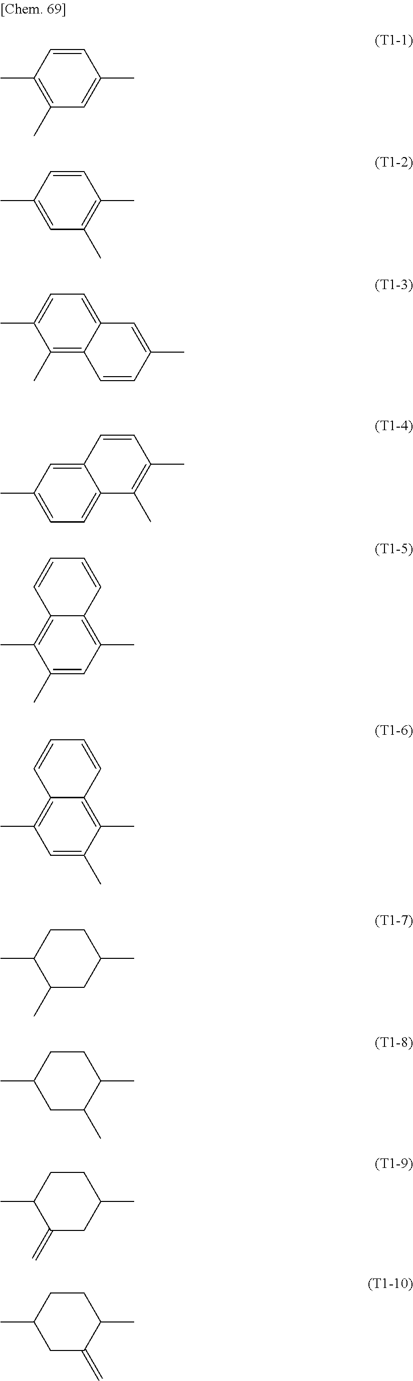

These groups may be unsubstituted or substituted with one or more of substituents L. It is more preferable that T²⁴ represents a group selected from Formula (T2-1) to Formula (T2-10) and these groups may be unsubstituted or substituted with one or more of substituents L. It is even more preferable that T¹⁴ represents a group selected from Formula (T1-1) to Formula (T1-6) and T²⁴ represents a group selected from Formula (T2-1) to Formula (T2-6). It is still more preferable that T¹⁴ represents a group selected from Formula (T1-1) or Formula (T1-2) and T²⁴ represents a group selected from Formula (T2-1) or Formula (T2-2).

<M¹-B2>

In addition, in a case of significantly considering surface hardness and adhesiveness, when a film-shaped polymer is prepared, T¹⁴ in Formula (I-M14) represents the component shown in the section <M¹-B and M²-B>, and T²⁴ in Formula (I-M24) represents a group selected from Formula (T2-11) to Formula (T2-27),

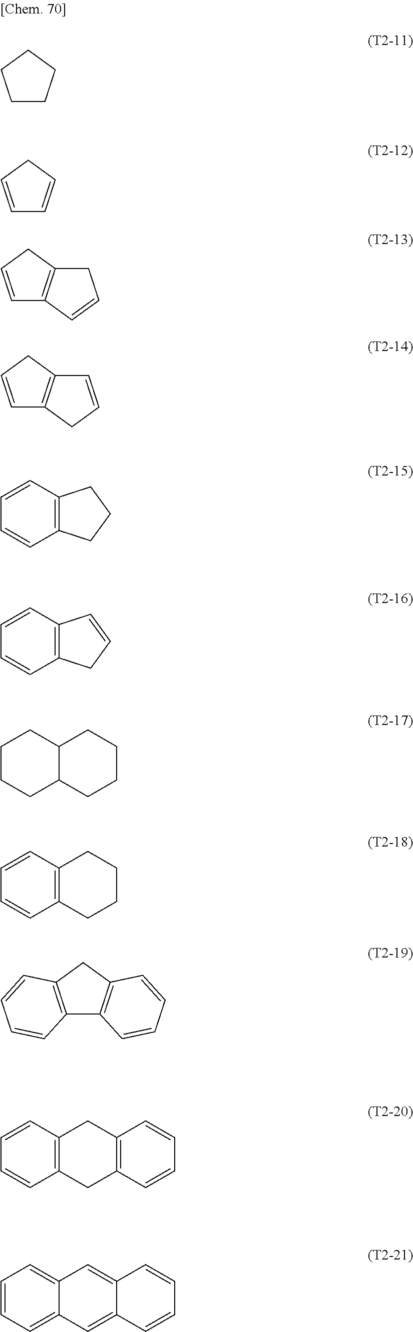

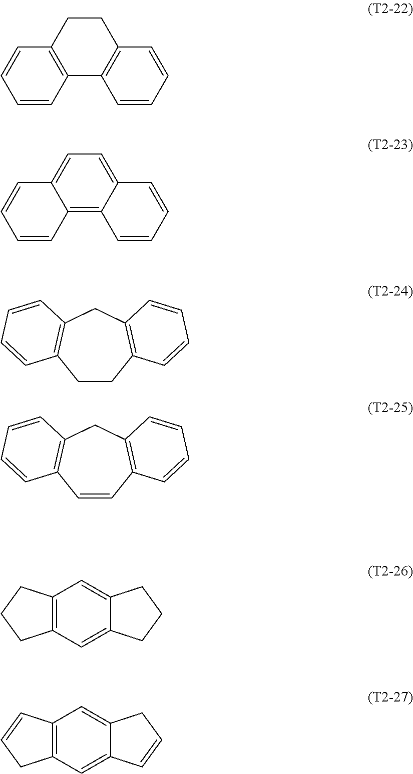

(in the formulae, a bonding site may be at an arbitrary position, arbitrary —CH═ may be each independently substituted with —N═, —CH₂— may be each independently substituted with —O—, —S—, —NR⁰— (in the formulae, R⁰ represents a hydrogen atom or an alkyl group having 1 to 20 carbon atoms), —CS— or —CO—, provided that a —O—O— bond is not included. In addition, these groups may be unsubstituted or substituted with one or more of L.), Formula (T2-28) to Formula (T2-31),

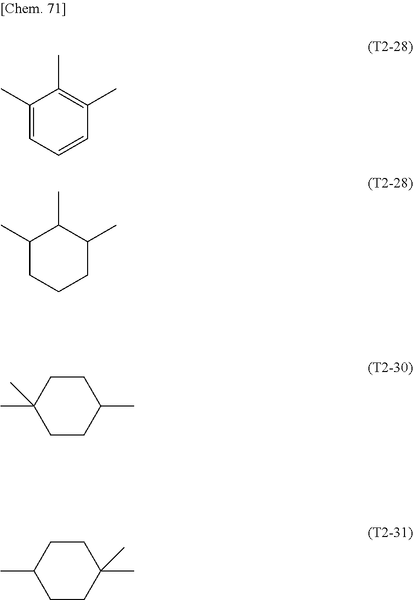

(in the formulae, arbitrary —CH═ may be each independently substituted with —N═, —CH₂— may be each independently substituted with —O—, —S—, —NR⁰— (in the formulae, R⁰ represents a hydrogen atom or an alkyl group having 1 to 20 carbon atoms), —CS— or —CO—, provided that a —O—O— bond is not included. In addition, these groups may be unsubstituted or substituted with one or more of L.), Formula (T2-32),

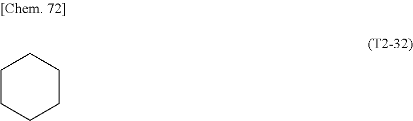

(in the formula, a bonding site may be at an arbitrary position, at least one —CH₂— is each independently substituted with —O—, —S—, —NR⁰— (in the formula, R⁰ represents a hydrogen atom or an alkyl group having 1 to 20 carbon atoms), —CS— or —CO—, provided that a —O—O— bond is not included. In addition, these groups may be unsubstituted or substituted with one or more of L.), and Formula (T2-33) or Formula (T2-34),

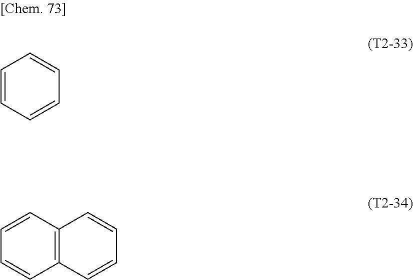 [SMILES: c1ccccc1 ; c1ccc2ccccc2c1]

(in the formulae, a bonding site may be at an arbitrary position, and at least one —CH═ is each independently substituted with —N═. In addition, these groups may be unsubstituted or substituted with one or more of L.), and m34+m44 is preferably a group representing an integer of 1 to 6.

Further, T²⁴ in Formula (I-M24) particularly preferably represents a group selected from Formula (T2-35) to Formula (T2-41).

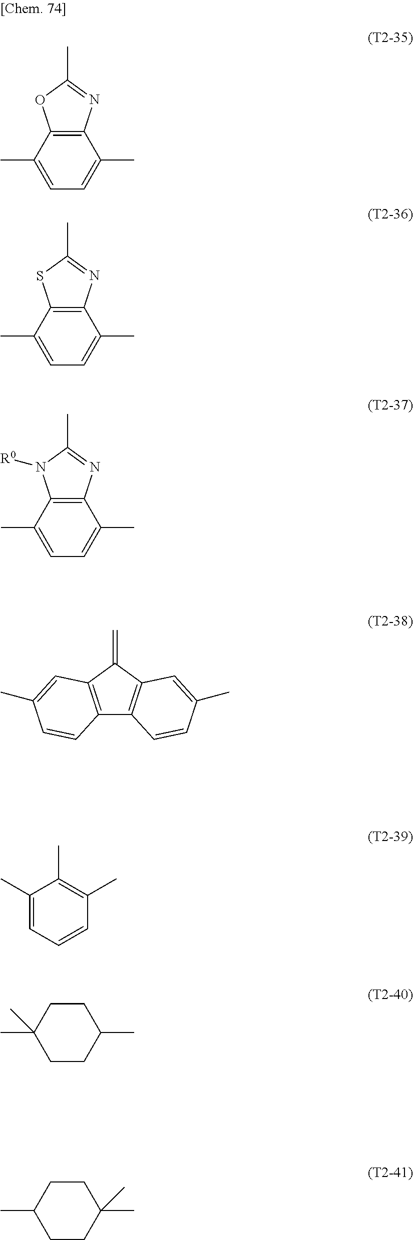

(In the formulae, R⁰ represents a hydrogen atom or an alkyl group having 1 to 20 carbon atoms.) Further, it is more preferable that T¹⁴ in Formula (I-M14) represents a group selected from Formula (T1-11) to Formula (T1-27),

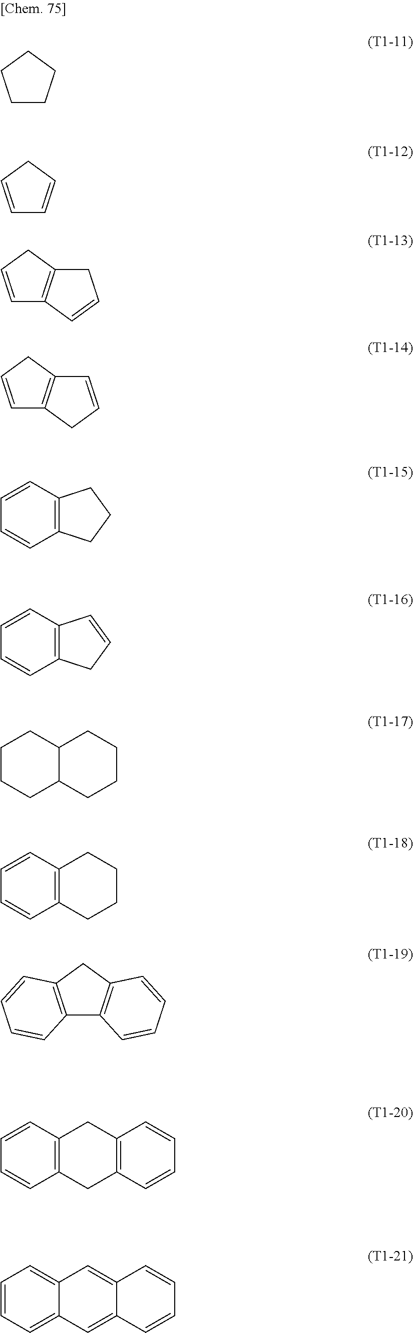

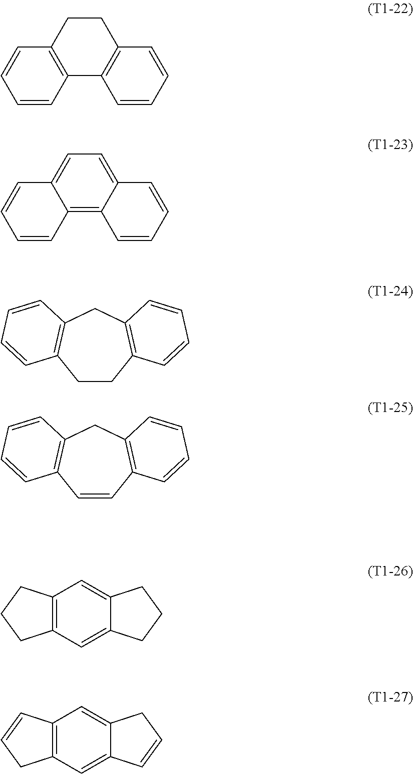

(in the formulae, a bonding site may be at an arbitrary position, arbitrary —CH═ may be each independently substituted with —N═, —CH₂— may be each independently substituted with —O—, —S—, —NR⁰— (in the formulae, R⁰ represents a hydrogen atom or an alkyl group having 1 to 20 carbon atoms), —CS— or —CO—, provided that a —O—O— bond is not included. In addition, these groups may be unsubstituted or substituted with one or more of L.), Formula (T1-28) to Formula (T1-31),

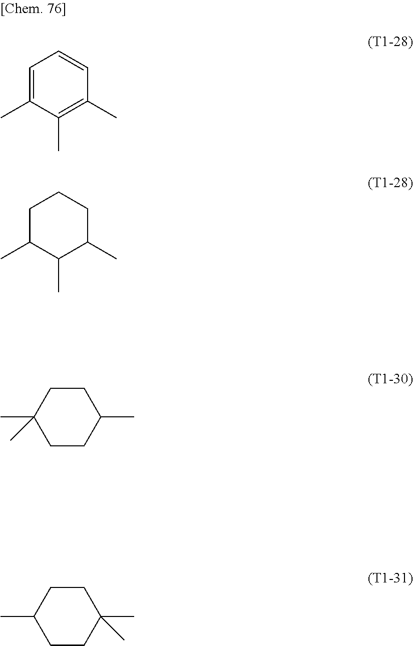

(in the formulae, arbitrary —CH═ may be each independently substituted with —N═, —CH₂— may be each independently substituted with —O—, —S—, —NR⁰— (in the formulae, R⁰ represents a hydrogen atom or an alkyl group having 1 to 20 carbon atoms), —CS— or —CO—, provided that a —O—O— bond is not included. In addition, these groups may be unsubstituted or substituted with one or more of L.), Formula (T1-32),

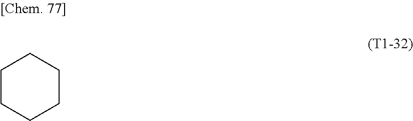

(in the formula, a bonding site may be at an arbitrary position, at least one —CH₂— is each independently substituted with —O—, —S—, —NR⁰— (in the formulae, R⁰ represents a hydrogen atom or an alkyl group having 1 to 20 carbon atoms), —CS— or —CO—, provided that a —O—O— bond is not included. In addition, these groups may be unsubstituted or substituted with one or more of L.), and Formula (T1-33) or Formula (T1-34),

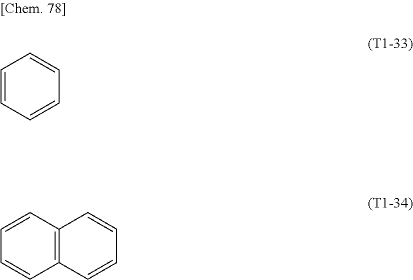 [SMILES: c1ccccc1 ; c1ccc2ccccc2c1]

(in the formulae, a bonding site may be at an arbitrary position, at least one —CH═ is each independently substituted with —N═. In addition, these groups may be unsubstituted or substituted with one or more of L.), and T²⁴ in Formula (I-M24) represents a group selected from Formula (T2-11) to Formula (T2-41). Further, it is even more preferable that T¹⁴ in Formula (I-M14) represents a group selected from Formula (T1-35) to Formula (T1-41),

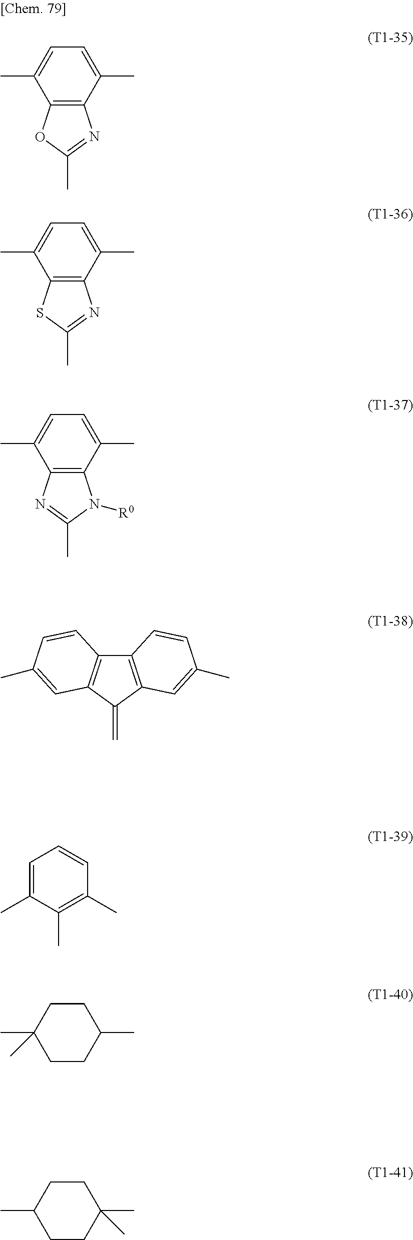

(in the formulae, R⁰ represents a hydrogen atom or an alkyl group having 1 to 20 carbon atoms), and T²⁴ in Formula (I-M24) represents a group selected from Formula (T2-35) to Formula (T2-41). In addition, in a case where T¹⁴ represents a group selected from Formula (T1-40) or Formula (T1-41) and T²⁴ represents a group selected from Formula (T2-40) or Formula (T2-41), in Formula (I-W21), V¹ and V² preferably represent a group other than the group represented by Formula (V-6).

<M¹-B3>

In addition, in a case of significantly considering adhesiveness, and appearance after ultraviolet light irradiation, when a film-shaped polymer is prepared, it is preferable that T¹⁴ in Formula (I-M14) represents the component described above and T²⁴ represents an acyclic group having 1 to 80 carbon atoms which may be substituted, and one or more of arbitrary carbon atoms of the acyclic group may be substituted with hetero atoms.

Further, T²⁴ preferably represents a group represented by Formula (T-22)

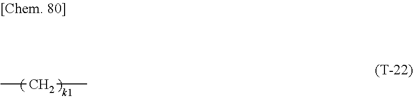

(in the formula, a bonding site may be at an arbitrary position, arbitrary —CH₂— may be each independently substituted with —O—, —S—, —NR⁰— (in the formula, R⁰ represents a hydrogen atom or an alkyl group having 1 to 20 carbon atoms), —CS— or —CO—, provided that a —O—O— bond is not included. In addition, these groups may be unsubstituted or substituted with one or more of L, and k1 represents an integer of 1 to 20.), preferably represents a group selected from Formula (T-22-1) or Formula (T-22-2),

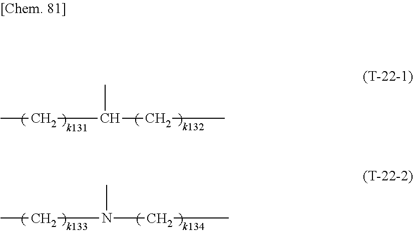

(in the formulae, arbitrary —CH₂— may be each independently substituted with —O—, —S—, —NR⁰— (in the formula, R⁰ represents a hydrogen atom or an alkyl group having 1 to 20 carbon atoms), —CS— or —CO—, provided that a —O—O— bond is not included. In addition, these groups may be unsubstituted or substituted with one or more of substituents L, and k131 to k134 represent an integer of 0 to 20), and more preferably represents Formula (T-22-1). It is even more preferable that k131 and k132 in Formula (T-22-1) represent 1. In addition, in Formula (T-22-1), k131 represents 0 and k132 represents 1. In a case where k131 represents 1 and k132 represents 0, in Formula (I-W22), a group represented by V² directly bonded to T¹⁴ and T²⁴ preferably represents a group other than Formula (V-6) and a single bond. Further, it is preferable that both T¹⁴ and T²⁴ represent a group represented by Formula (T-22), it is more preferable that both T¹⁴ and T²⁴ represent a group represented by Formula (T-22-1) or Formula (T-22-2), and it is even more preferable that both T¹⁴ and T²⁴ represent Formula (T-22-1).

<R¹, R², R³, and R⁴>

Meanwhile, in the compound in which <n1 represents 1, n2 represents 0, and n3 represents 1>, unevenness of alignment, surface hardness, or adhesiveness, when a film-shaped polymer is prepared, are excellent due to the structure of the compound. Therefore, in General Formula (I), M¹, M², and W¹ described above are preferably suitably selected and the following groups are preferably used as R¹ to R⁴.

R⁴ and R³ represent a group represented by Formula (I-R).

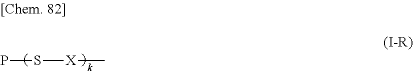

(In the formula, P represents a polymerizable group, S represents a spacer group or a single bond, in a case where a plurality of S is present, these may be the same as each other or different from each other, X represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, in a case where a plurality of X is present in the compound, these may be the same as each other or different from each other (provided that P—(S—X)ₖ— does not include a —O—O— bond), k represents an integer of 0 to 10.) R¹ and R⁴ preferably represent a group selected from the group represented by Formula (I-R) and R⁵ (in the formula, R⁵ represents a hydrogen atom, a fluorine atom, a chlorine atom, a bromine atom, an iodine atom, a pentafluorosulfuranyl group, a nitro group, a cyano group, an isocyano group, an amino group, a hydroxyl group, a mercapto group, a methylamino group, a dimethylamino group, a diethylamino group, a diisopropylamino group, a trimethylsilyl group, a dimethylsilyl group, a thioisocyano group, or a linear or branched alkyl group having 1 to 20 carbon atoms, in which one —CH₂— or two or more of (—CH₂—)'s that are not adjacent to each other may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, and one or more of arbitrary hydrogen atoms in the alkyl group may be substituted with a fluorine atom).

In addition, in the compound in which <n1 represents 1, n2 represents 0, and n3 represents 1>, in a case of significantly considering unevenness of alignment and surface hardness, when a film-shaped polymer is prepared, in General Formula (I), it is preferable that R² and R³ represent a group represented by Formula (I-R) and R¹ and R⁴ represent a group represented by R⁵, and in this case, the preferable groups and numerical values shown in the section of <<R¹, R², R³, and R⁴>> are respectively applied to P, S, X, k, and R⁵.

Further, in the compound in which <n1 represents 1, n2 represents 0, and n3 represents 1>, in a case of significantly considering surface hardness and adhesiveness, when a film-shaped polymer is prepared, or in a case of significantly considering adhesiveness, and appearance after ultraviolet light irradiation, when a film-shaped polymer is prepared, all of R¹, R², R³, and R⁴ are particularly preferably a group represented by Formula (I-R), and in this case, the preferable groups and numerical values shown in the section of <<R¹, R², R³, and R⁴>> are respectively applied to P, S, X, and k.

Compound in which <<n1 Represents 0, and n2 and n3 Represent 1>>

<M²-C>

In addition, in the compound in which <n1 represents 0, and n2 and n3 represent 1>, evenness of film thickness, surface hardness, and/or alignment defects after ultraviolet light irradiation, when a film-shaped polymer is prepared, are excellent due to the structure of the compound. Therefore, in General Formula (I), M² represents Formula (I-M2C).

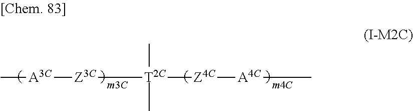

(In the formula, A^{3C} being present and A^{4C} being present each independently represent a 1,4-phenylene group, a 1,4-cyclohexylene group, a pyridine-2,5-diyl group, a pyrimidine-2,5-diyl group, a naphthalene-2,6-diyl group, a naphthalene-1,4-diyl group, a tetrahydronaphthalene-2,6-diyl group, a decahydronaphthalene-2,6-diyl group, or a 1,3-dioxane-2,5-diyl group, these groups may be unsubstituted or substituted with one or more of substituents L, and, in a case where a plurality of each of A^{3C} and A^{4C} are present, these may be the same as each other or different from each other. Z^{3C} and Z^{4C} each independently represent —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —OCO—NH—, —NH—COO—, —NH—CO—NH—, —NH—O—, —O—NH—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—, —N═CH—, —CH═N—N═CH—, —CF═CF—, —C≡C—, or a single bond, in a case where a plurality of each of Z^{3C} and Z^{4C} is present, these may be the same as each other or different from each other. m3C and m4C each independently represent an integer of 0 to 5.) In Formula (I-M²C), T^{2C} preferably represents a group selected from Formula (T-1) to Formula (T-22)

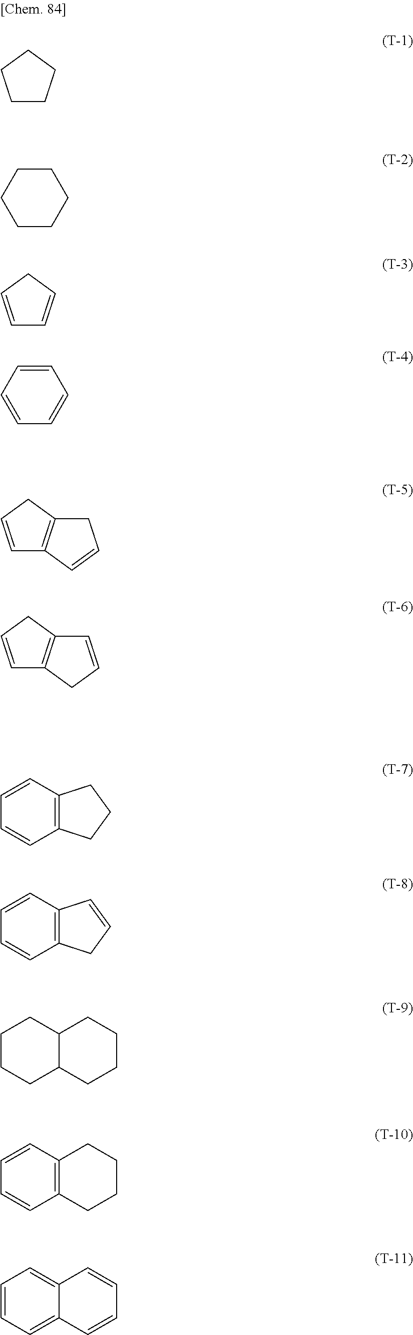

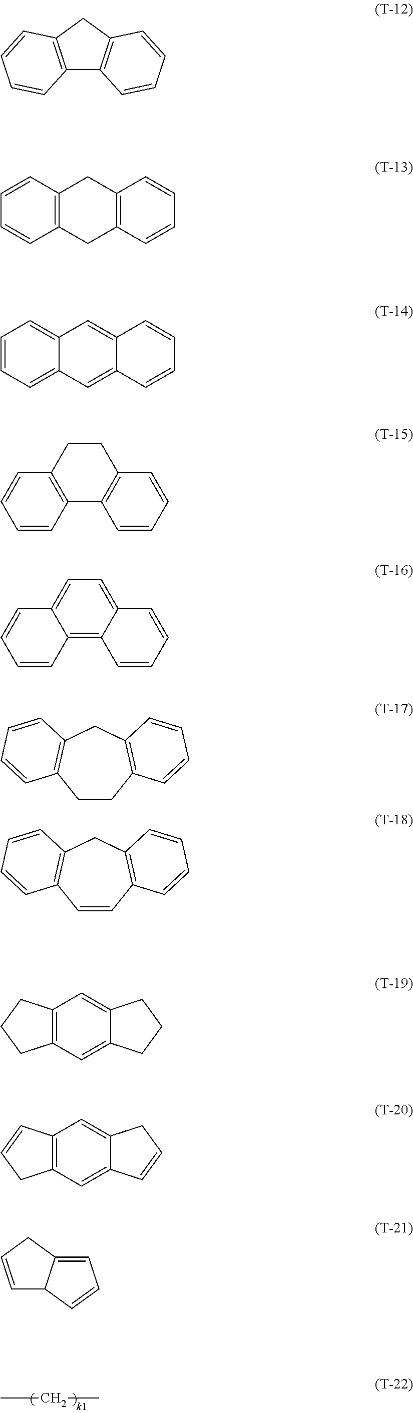

(in the formulae, a bonding site may be at an arbitrary position, arbitrary —CH═ may be each independently substituted with —N═, —CH₂— may be each independently substituted with —O—, —S—, —NR⁰— (in the formulae, R⁰ represents a hydrogen atom or an alkyl group having 1 to 20 carbon atoms), —CS— or —CO—, provided that a —O—O— bond is not included. In addition, these groups may be unsubstituted or substituted with one or more of L, and k1 represents an integer of 1 to 20.), and these groups preferably represent groups which may be unsubstituted or substituted with one or more of substituents L.

From viewpoints of availability of raw materials and ease of synthesis, A^{3C} and A^{4C} preferably represent a 1,4-phenylene group, a 1,4-cyclohexylene group, or a naphthalene-2,6-diyl group which are not substituted or may be substituted with one or more substituent L, more preferably each independently represent a group selected from Formula (A-C-1) to Formula (A-C-11),

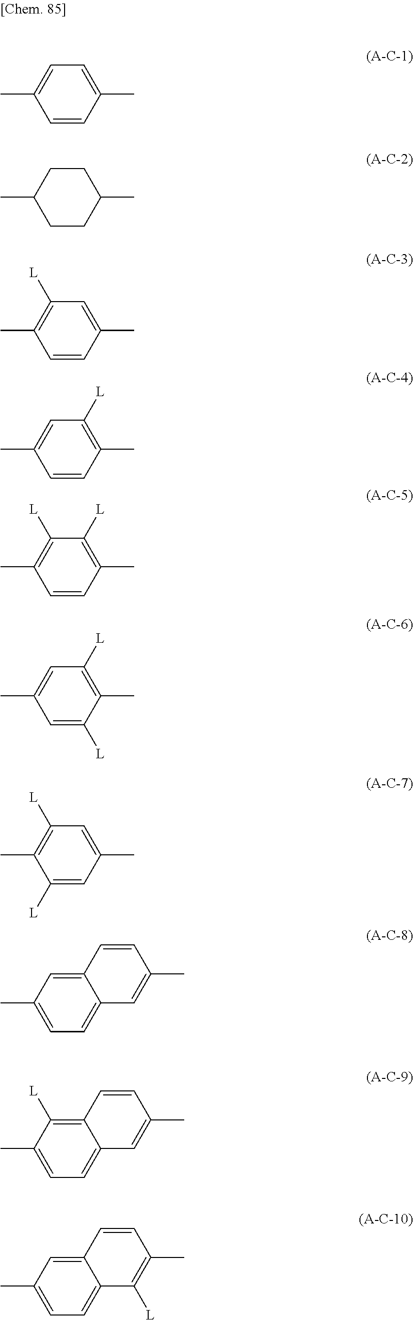

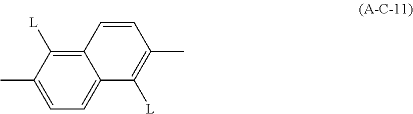

even more preferably each independently represent a group selected from Formula (A-C-1) to Formula (A-C-8), and particularly preferably each independently represent a group selected from Formula (A-C-1) to Formula (A-C-4).

From viewpoints of liquid crystal properties of the compound, availability of raw materials, and ease of synthesis, Z³c and Z^{4C} preferably each independently represent a single bond, —OCH₂—, —CH₂O—, —COO—, —OCO—, —CF₂O—, —OCF₂—, —CH₂CH₂—, —CF₂CF₂—, —CH═CH—COO—, —CH═CH—OCO—, —COO—CH═CH—, —OCO—CH═CH—, —COO—CH₂CH₂—, —OCO—CH₂CH₂—, —CH—CH₂—COO—, —CH₂CH₂—OCO—, —CH═CH—, —CF═CF—, —C≡C—, or a single bond, more preferably each independently represent —OCH₂—, —CH₂O—, —CH₂CH₂—, —COO—, —OCO—, —COO—CH₂CH₂—, —OCO—CH₂CH₂—, —CH₂CH₂—COO—, —CH₂CH₂—OCO—, —CH═CH—, —C≡C—, or a single bond, even more preferably each independently represent —CH₂CH₂—, —COO—, —OCO—, —COO—CH₂CH₂—, —OCO—CH₂CH₂—, —CH₂CH₂—COO—, —CH₂CH₂—OCO—, or a single bond, and particularly preferably each independently represent —COO—, —OCO—, or a single bond.

From viewpoints of liquid crystal properties, ease of synthesis, and storage stability, m3C and m4C preferably each independently represent an integer of 1 to 4, more preferably each independently represent an integer of 1 to 3, and particularly preferably each independently represent 1 or 2. m3C+m4C preferably each independently represent an integer of 1 to 4 and more preferably each independently represent 2, 3, or 4.

<M²-C11 and M²-C12>

In a case of significantly considering evenness of film thickness, when a film-shaped polymer is prepared, T^{2C} in Formula (I-M2C) represents a group selected from Formula (T2-C-1) to Formula (T2-C-12).

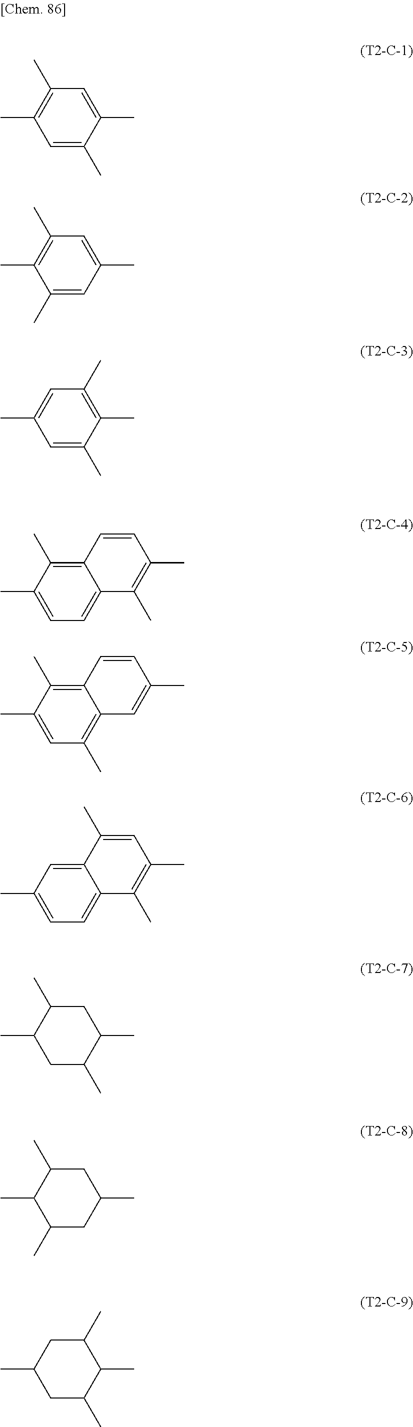

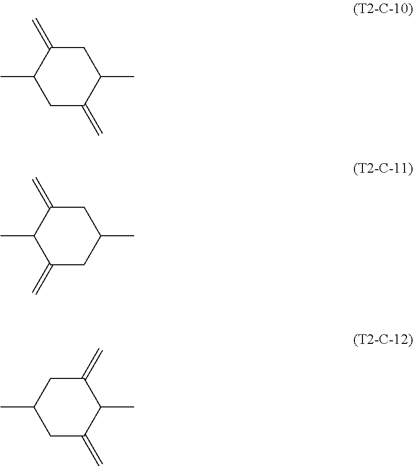

These groups are preferably groups which may be unsubstituted or substituted with one or more of substituents L.

In addition, T^{2C} is more preferably a group represented by Formula (T2-C-1) to Formula (T2-C-4) and even more preferably a group represented by Formula (T2-C-1) or Formula (T2-C-4).

<M²-C2>

In addition, in a case of significantly considering storage stability of a composition, and alignment defects after ultraviolet light irradiation, when a film-shaped polymer is prepared, T^{2C} in Formula (I-M2C) preferably represents a group selected from Formula (T2-C-13) to Formula (T2-C-42).

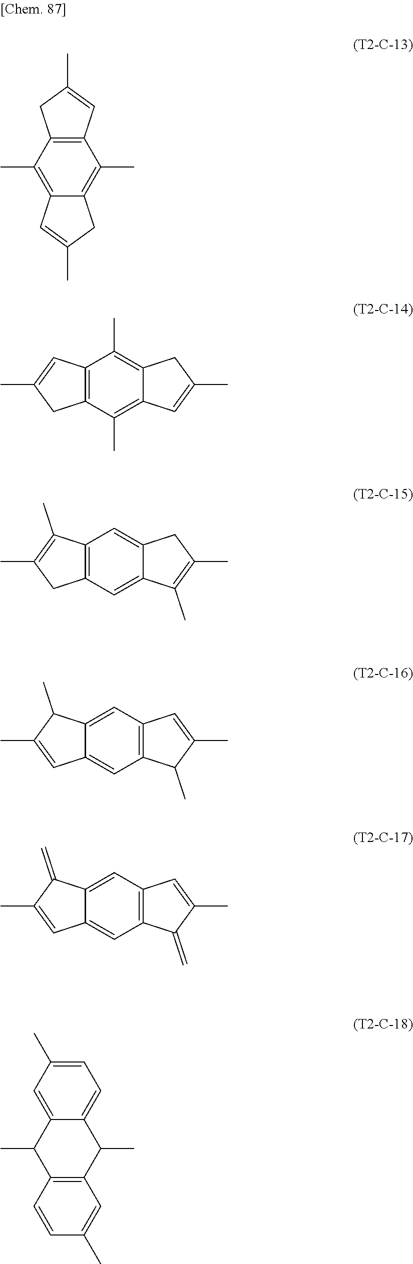

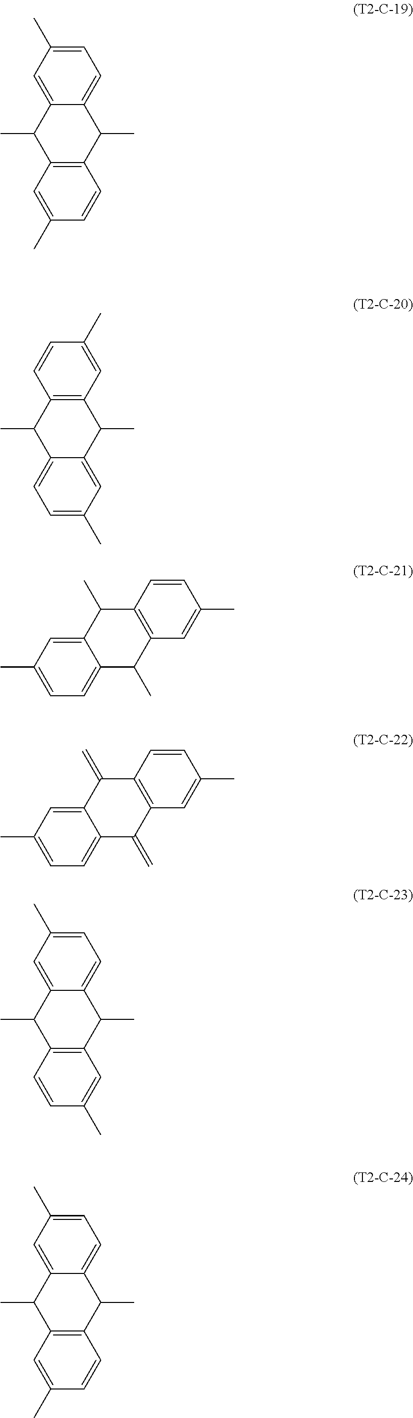

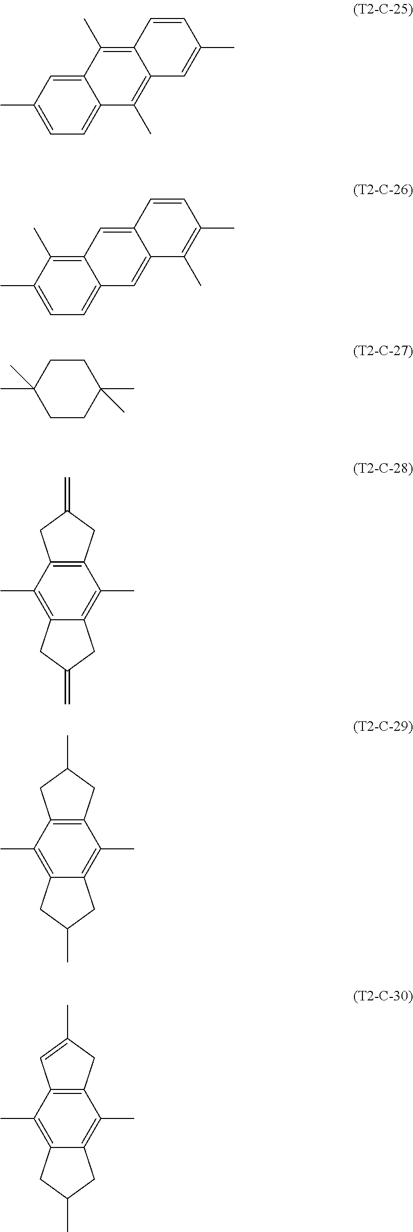

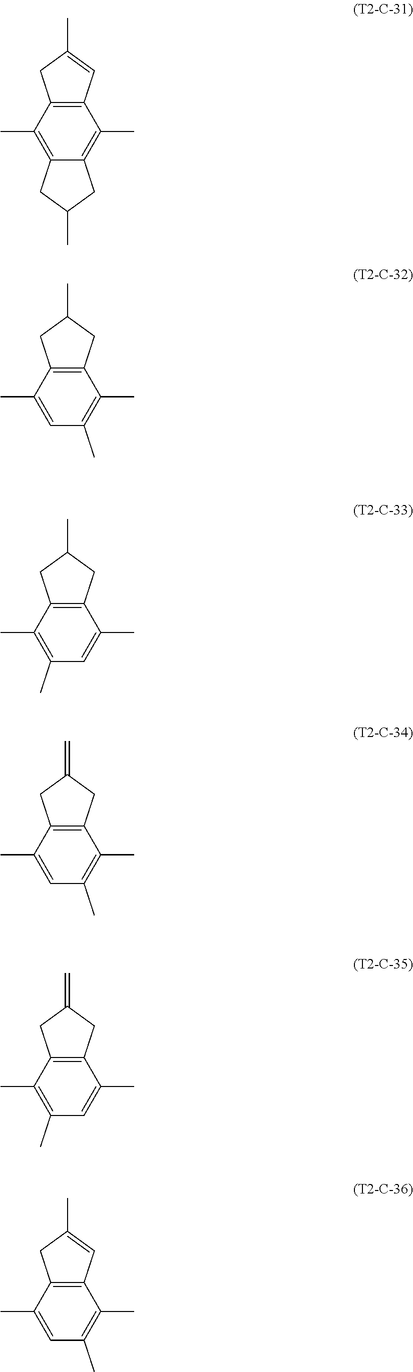

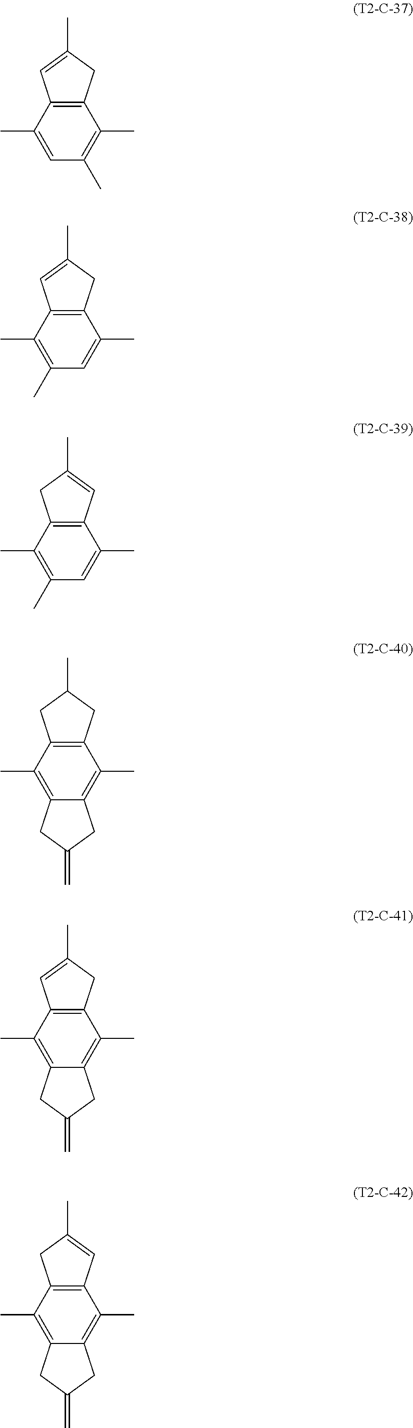

(In the formulae, a bonding site may be at an arbitrary position, arbitrary —CH═ may be each independently substituted with —N═, —CH₂— may be each independently substituted with —O—, —S—, —NR⁰— (in the formulae, R⁰ represents a hydrogen atom or an alkyl group having 1 to 20 carbon atoms), —CS— or —CO—, provided that a —O—O— bond is not included. In addition, these groups may be unsubstituted or substituted with one or more of L.) T^{2C} more preferably represents a group selected from Formula (T2-C-13), Formula (T2-C-22), Formula (T2-C-27), Formula (T2-C-28), Formula (T2-C-29), Formula (T2-C-36), Formula (T2-C-37), Formula (T2-C-38), Formula (T2-C-39), and Formula (T2-C-41), even more preferably represents a group selected from Formula (T2-C-13), Formula (T2-C-27), and Formula (T2-C-29), and still more preferably represents Formula (T2-C-13).

<M²-C3>

In addition, in a case of significantly considering surface hardness and alignment defects after ultraviolet light irradiation, when a film-shaped polymer is prepared, it is preferable that T^{2C} in Formula (I-M2C) represents an acyclic group having 1 to 80 carbon atoms which may be substituted, and one or more of arbitrary carbon atoms of the acyclic group may be substituted with hetero atoms.

Further, T^{2C} preferably represents a group represented by Formula (T-22)

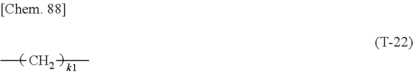

(in the formula, a bonding site may be at an arbitrary position, arbitrary —CH₂— may be each independently substituted with —O—, —S—, —NR⁰— (in the formula, R⁰ represents a hydrogen atom or an alkyl group having 1 to 20 carbon atoms), —CS— or —CO—, provided that a —O—O— bond is not included. In addition, these groups may be unsubstituted or substituted with one or more of L, and k1 represents an integer of 1 to 20.), and more preferably represents a group selected from Formula (T-22-3),

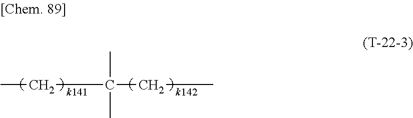

(in the formula, arbitrary —CH₂— may be each independently substituted with —O—, —S—, —NR⁰— (in the formula, R⁰ represents a hydrogen atom or an alkyl group having 1 to 20 carbon atoms), —CS— or —CO—, provided that a —O—O— bond is not included. In addition, these groups may be unsubstituted or substituted with one or more of L, and k141 and k142 represent an integer of 0 to 20). k141 and k42 in Formula (T-22-3) more preferably represent an integer of 1 to 10, k141 and k42 in Formula (T-22-3) even more preferably represent an integer of 1 to 4, and k141 and k42 in Formula (T-22-3) particularly preferably represent 1.

<W¹-M²-W²—C1>

In the compound in which <n1 represents 0, and n2 and n3 represent 1>, due to the structure of the compound, evenness of film thickness, when a film-shaped polymer is prepared, is high, surface hardness is high, and/or alignment defects after ultraviolet light irradiation hardly occurs. Therefore, in General Formula (I), the groups shown in the section <M²-C11 and M²-C12> are preferably used as M², and a group represented by W¹-M²-W² (provided that M² is linked to R³ and R⁴ at arbitrary positions) preferably represents a group selected from Formula (I-W16-1) or Formula (I-W16-2).

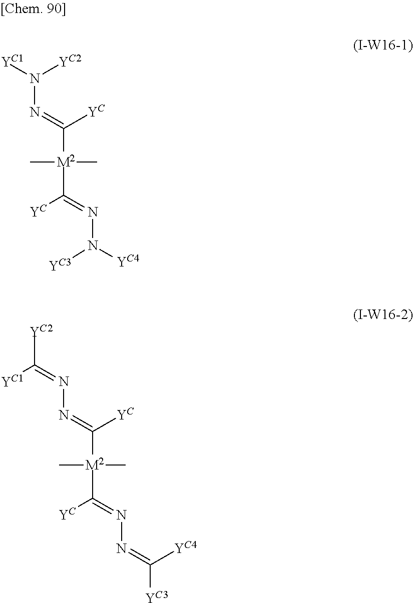

(In the formula, Y^{C1} and Y^{C4} each independently represent a group including aromatic and/or nonaromatic carbon ring or heterocyclic ring having 1 to 80 carbon atoms which may be substituted, and one or more of arbitrary carbon atoms of the carbon ring or the heterocyclic ring may be substituted with hetero atoms (provided that oxygen atoms are not directly bonded to each other). Y^{C2} and Y^{C3} each independently represent a hydrogen atom or a linear or branched alkyl group having 1 to 20 carbon atoms, in which one —CH₂— or two or more of (—CH₂—)'s that are not adjacent to each other may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, one or more of arbitrary hydrogen atoms in the alkyl group may be substituted with a fluorine atom, Y^{C2} and Y^{C3} may represent a group having 5 to 30 carbon atoms including at least one aromatic group, the group may be unsubstituted or substituted with one or more of substituents L. Y^{C} represents a hydrogen atom, a fluorine atom, a chlorine atom, a bromine atom, an iodine atom, a pentafluorosulfuranyl group, a nitro group, a cyano group, an isocyano group, an amino group, a hydroxyl group, a mercapto group, a methylamino group, a dimethylamino group, a diethylamino group, a diisopropylamino group, a trimethylsilyl group, a dimethylsilyl group, a thioisocyano group, or a linear or branched alkyl group having 1 to 20 carbon atoms, in which one —CH₂— or two or more of (—CH₂—)'s that are not adjacent to each other may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, one or more of arbitrary hydrogen atoms in the alkyl group may be substituted with a fluorine atom, and in a case where a plurality of Y^{C} is present, these may be the same as each other or different from each other. Alternatively, Y^{C} may represent a group represented by P—(S—X)ⱼ—, P represents a polymerizable group, S represents a spacer group or a single bond, in a case where a plurality of S is present, these may be the same as each other or different from each other, X represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, in a case where a plurality of X is present, these may be the same as each other or different from each other (provided that P—(S—X)ⱼ— does not include a —O—O— bond), j represents an integer of 0 to 10, Y^{C1} and Y^{C2} may be integrated to form a ring structure, and Y^{C3} and Y^{C4} may be integrated to form a ring structure.)

From viewpoints of liquid crystal properties and ease of synthesis, Y^{C} in Formula (I-W16-1) and Formula (I-W16-2) preferably represents a linear or branched alkyl group having 1 to 12 carbon atoms, in which one or more of arbitrary hydrogen atoms in the group may be substituted with a fluorine atom and one —CH₂— or two or more of (—CH₂—)'s that are not adjacent to each other may be each independently substituted with —O—, —COO—, or —OCO—, more preferably represents a linear or branched alkyl group having 1 to 12 carbon atoms, in which one or more of arbitrary hydrogen atoms in the group may be substituted with a fluorine atom, and particularly preferably represents a linear alkyl group having 1 to 12 carbon atoms.

Y^{C1} and Y^{C4} in Formula (I-W16-1) and Formula (I-W16-2) preferably each independently a group represented by Formula (B-1) to Formula (B-21).

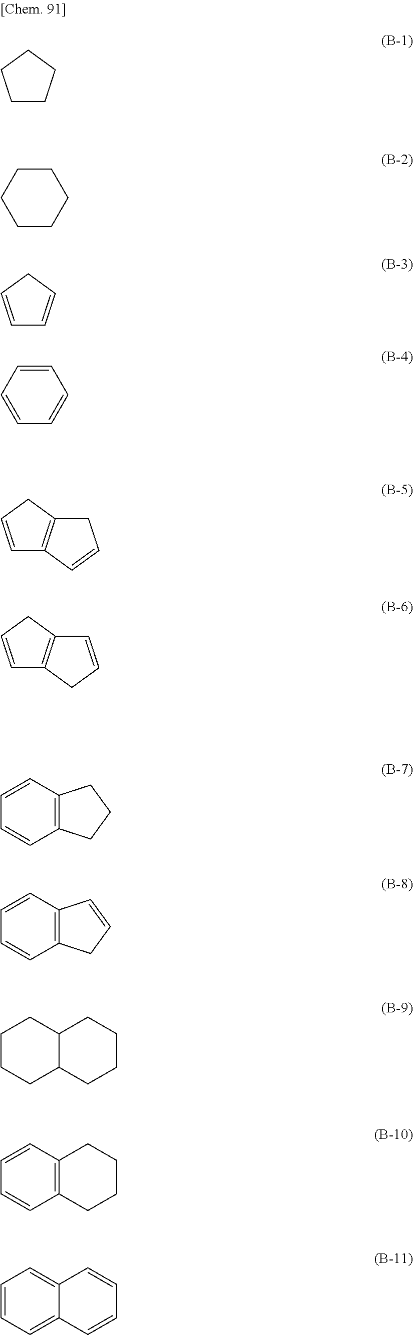

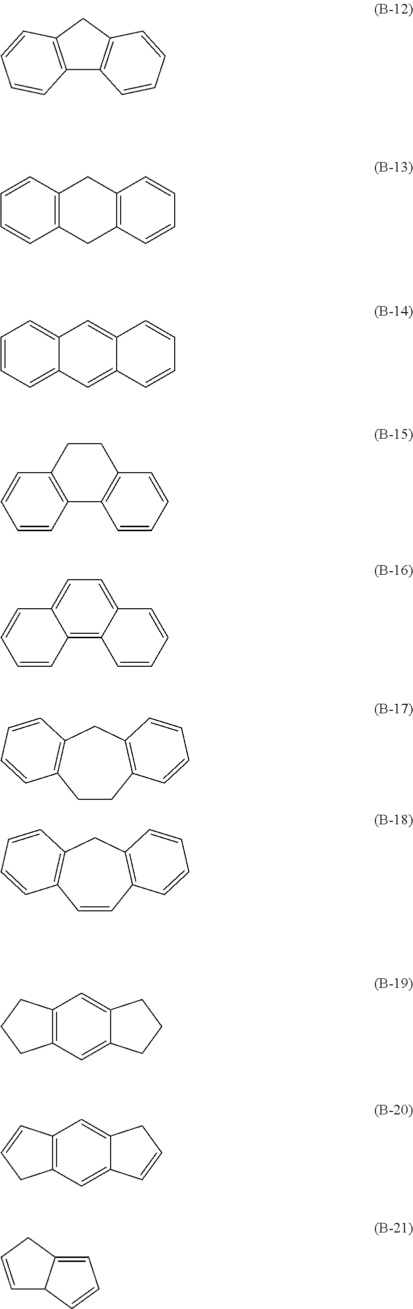

(In the formulae, a bonding site may be at an arbitrary position, arbitrary —CH═ may be each independently substituted with —N═, —CH₂— may be each independently substituted with —O—, —S—, —NR⁰— (in the formulae, R⁰ represents a hydrogen atom or an alkyl group having 1 to 20 carbon atoms), —CS— or —CO—, provided that a —O—O— bond is not included. In addition, these groups may be unsubstituted or substituted with one or more of substituents L.) Y^{C1} and Y^{C4} more preferably each independently a group selected from Formula (B-8) and Formula (B-12). More specifically, Y^{C1} and Y^{C4} are preferably a group selected from Formula (B-8-1) and Formula (B-12-1) shown in the section <<W¹ and W²>>.

From viewpoints of availability of raw materials and ease of synthesis, in a case where Y^{C2} and Y^{C3} in Formula (I-W16-1) and Formula (I-W16-2) each independently represent a hydrogen atom, or a linear or branched alkyl group having 1 to 20 carbon atoms, in which one —CH₂— or two or more of (—CH₂—)'s that are not adjacent to each other may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, and one or more of arbitrary hydrogen atoms may be substituted with a fluorine atom, Y^{C2} and Y^{C3} preferably each independently represent a hydrogen atom, or a linear or branched alkyl group having 1 to 12 carbon atoms in which one —CH₂— or two or more of (—CH₂—)'s that are not adjacent to each other may be each independently substituted with —O—, —CO—, —COO—, or —OCO—, and one or more of arbitrary hydrogen atoms may be substituted with a fluorine atom, more preferably each independently represent a hydrogen atom, or a linear or branched alkyl group having 1 to 12 carbon atoms in which one —CH₂— or two or more of (—CH₂—)'s that are not adjacent to each other may be each independently substituted with —O—, —CO—, —COO—, or —OCO—, even more preferably each independently represent a hydrogen atom, or a linear alkyl group having 1 to 8 carbon atoms, and still more preferably each independently represent a hydrogen atom. In addition, from viewpoints of availability of raw materials and ease of synthesis, in a case where Y^{C2} and Y^{C3} represent a group having 5 to 30 carbon atoms including at least one aromatic group, which may be unsubstituted or substituted with one or more of substituents L, Y^{C2} and Y^{C3} are preferably each independently a group represented by Formula (B-1) to Formula (B-21),

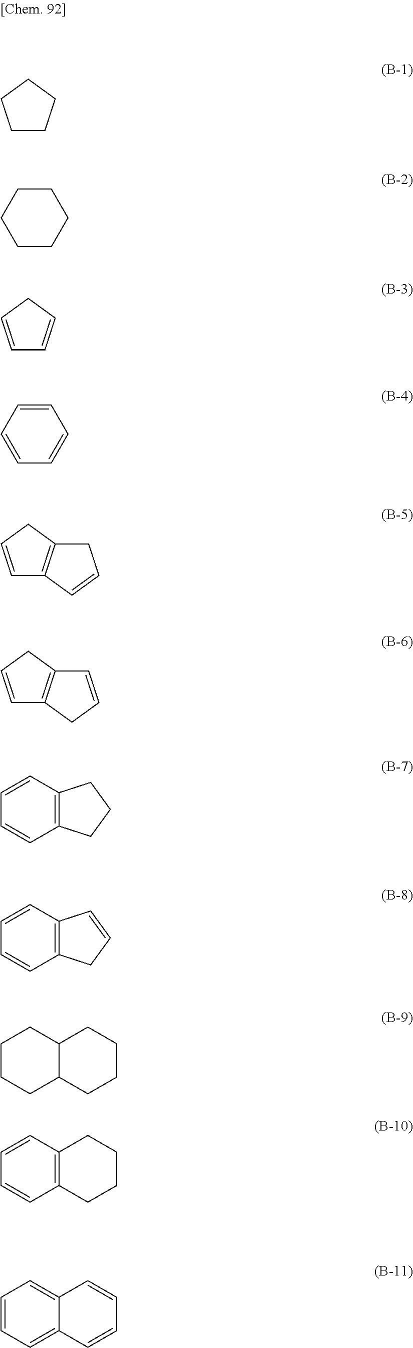

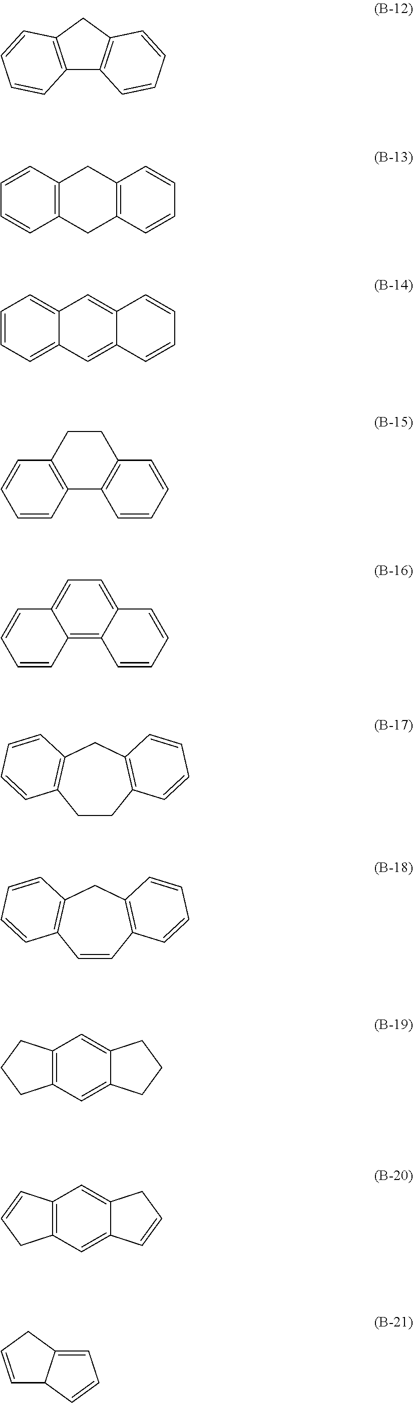

(in the formulae, a bonding site may be at an arbitrary position, arbitrary —CH═ may be each independently substituted with —N═, —CH₂— may be each independently substituted with —O—, —S—, —NR⁰— (in the formulae, R⁰ represents a hydrogen atom or an alkyl group having 1 to 20 carbon atoms), —CS— or —CO—, provided that a —O—O— bond is not included. In addition, these groups may be unsubstituted or substituted with one or more of substituents L.), Y^{C2} and Y^{C3} are more preferably each independently a group selected from Formula (B-8) and Formula (B-12). More specifically, the group selected from Formula (B-8-1) and Formula (B-12-1) shown in the section <<W¹ and W²>>is preferable.

In addition, in a case where Y^{C1} and Y^{C2} or Y^{C3} and Y^{C4} in Formula (I-W16-1) and Formula (I-W16-2) are integrated to form a ring structure, Y^{C1} and Y^{C2} or Y^{C3} and Y^{C4} preferably represent a group selected from Formula (Y—C-1) to Formula (Y—C-29),

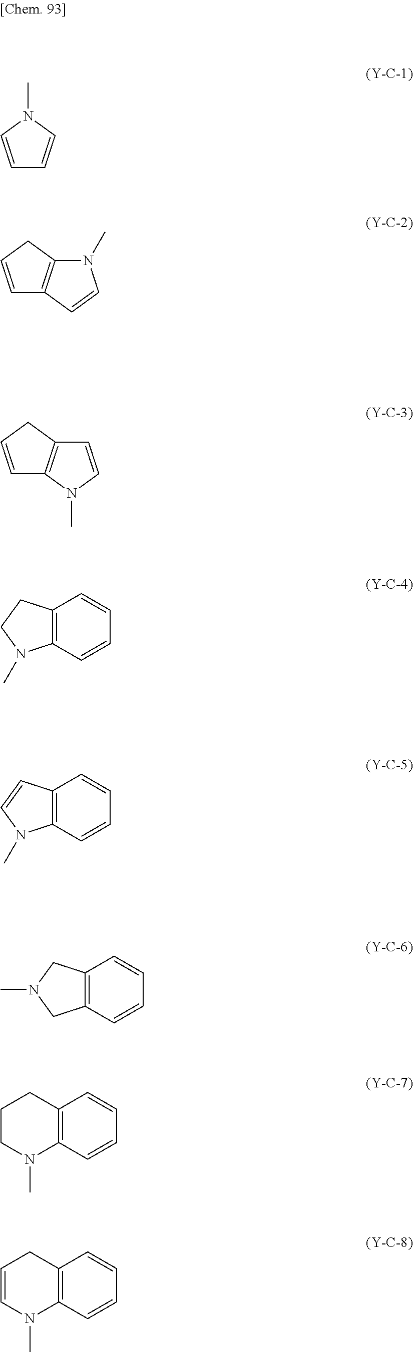

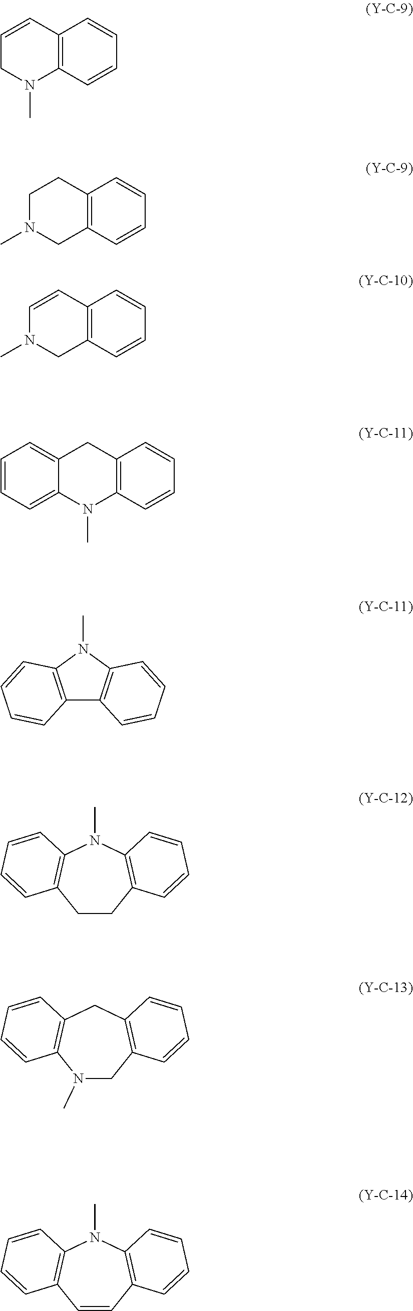

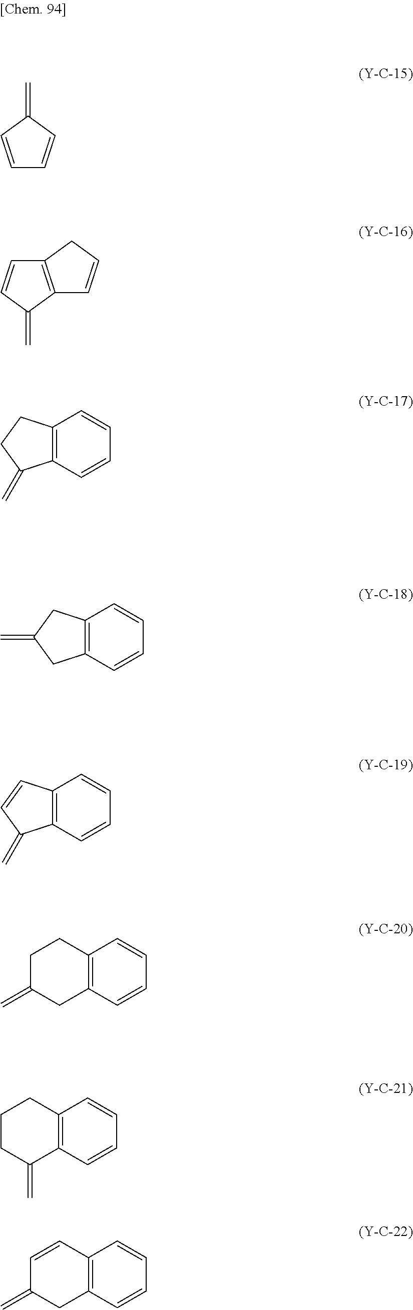

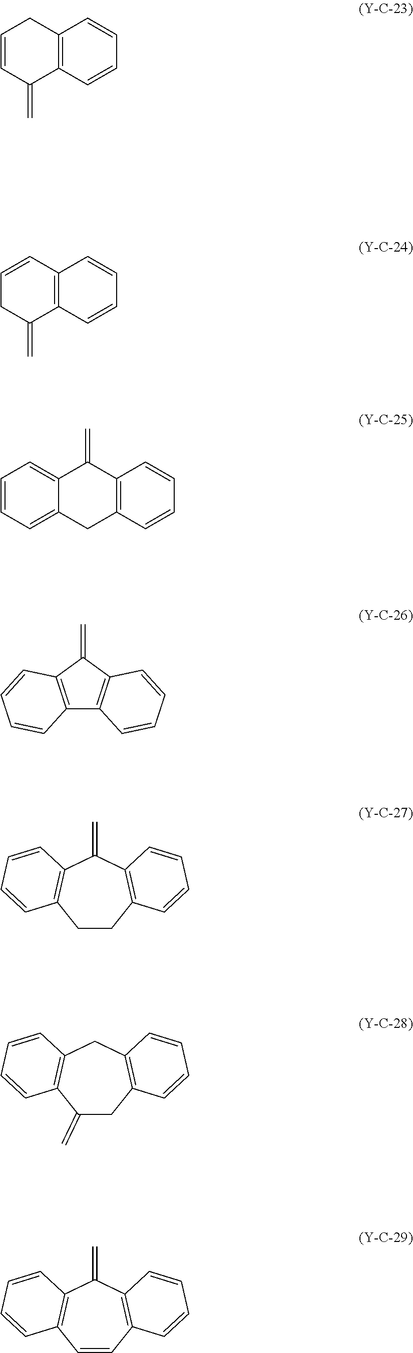

(in the formulae, arbitrary —CH═ may be each independently substituted with —N═, —CH₂— may be each independently substituted with —O—, —S—, —NR⁰— (in the formulae, R⁰ represents a hydrogen atom or an alkyl group having 1 to 20 carbon atoms), —CS— or —CO—, provided that a —O—O— bond is not included. In addition, these groups may be unsubstituted or substituted with one or more of substituents L.), and more preferably a group represented by Formula (Y—C-26).

<W¹-M²-W²—C2>

In the compound in which <n1 represents 0, and n2 and n3 represent 1>, in a case of significantly considering storage stability of a composition, alignment defects, when a film-shaped polymer is prepared and irradiated with ultraviolet light, a group represented by W¹ and W² is preferably a group selected from viewpoints of availability of raw materials and ease of synthesis, among General Formula (I-W1) and General Formula (I-W2) shown in the section <<W¹ and W²>>.

In General Formula (I-W1) and General Formula (I-W2), V¹, V², V³, and V⁴ preferably each independently represent a group represented by Formula (V-1) to Formula (V-15) described in the section <<W¹ and W²>> (in the formulae, in a case of including Y¹, Y¹ is preferably a group selected from viewpoints of availability of raw materials and ease of synthesis described in the section <<W¹ and W²>>), a single bond, a double bond, —O—, —S—, —OCH₂—, —CH₂O—, —CO—, —CH₂—, —COO—, —OCO—, —CO—S—, —S—CO—, —O—CO—O—, —CO—NH—, —NH—CO—, —CS—NH—, —NH—CS—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —CH₂CH₂—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, and —CH₂—OCO—, more preferably each independently represent Formula (V-1), Formula (V-2), Formula (V-3), Formula (V-4), Formula (V-5), Formula (V-6), Formula (V-7), Formula (V-11), a single bond, or a double bond, even more preferably each independently represent Formula (V-1), Formula (V-2), Formula (V-3), Formula (V-4), Formula (V-5), or a single bond, and still more preferably each independently represent a single bond.

In General Formula (I-W1) and General Formula (I-W2), B¹, B², and B³ preferably each independently represent a group selected from Formula (B-1) to Formula (B-21)

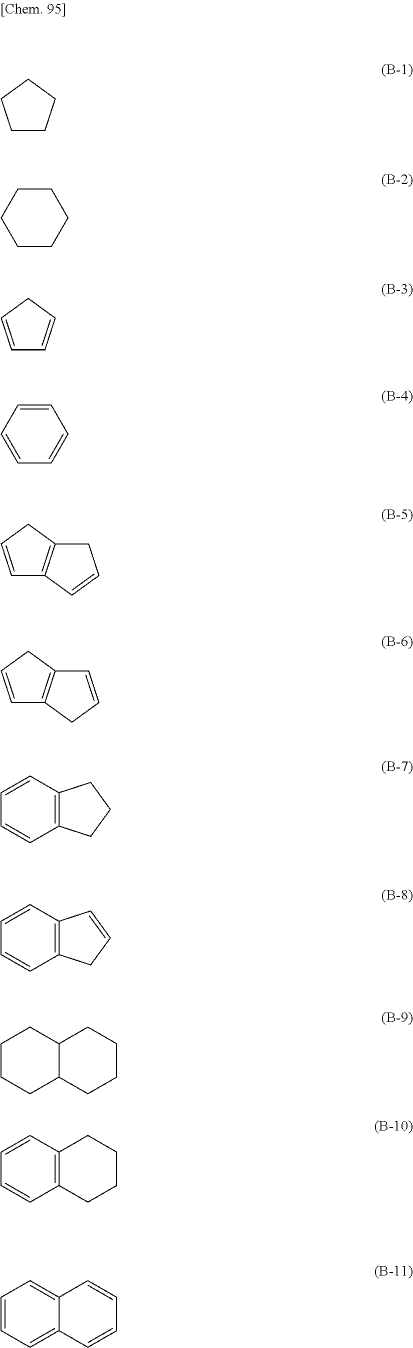

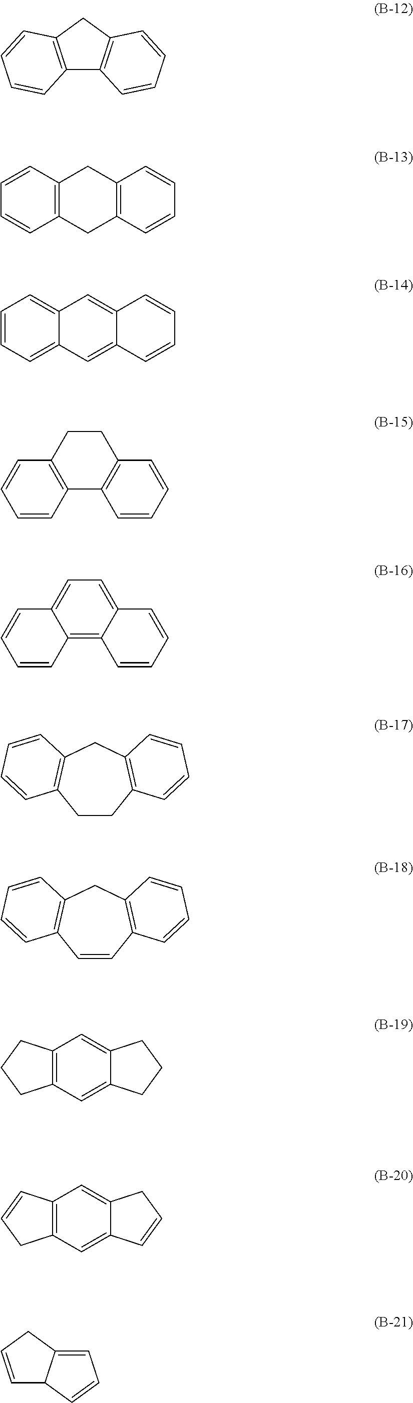

(in the formulae, a bonding site may be at an arbitrary position, arbitrary —CH═ may be each independently substituted with —N═, —CH₂— may be each independently substituted with —O—, —S—, —NR⁰— (in the formulae, R⁰ represents a hydrogen atom or an alkyl group having 1 to 20 carbon atoms), —CS— or —CO—, provided that a —O—O— bond is not included. In addition, these groups may be unsubstituted or substituted with one or more of substituents L.), and a single bond. B¹, B², and B³ are preferably a group selected from Formula (B-4), Formula (B-8), Formula (B-11), Formula (B-12), and a single bond, and more preferably a group selected from Formula (B-4), Formula (B-8), and a single bond. More specifically, B¹, B², and B³ are preferably a group selected from Formula (B-4-1), Formula (B-8-6), Formula (B-8-7), Formula (B-11-1), Formula (B-11-2), Formula (B-12-1), Formula (B-12-2) shown in the section <<W¹ and W²>>, and a single bond, more preferably a group selected from Formula (B-4-1), Formula (B-8-6), Formula (B-8-7), and a single bond, and even more preferably a group selected from Formula (B-4-1) and a single bond.

<W¹-M²-W¹—C3>

In the compound in which <n1 represents 0, and n2 and n3 represent 1>, in a case of significantly considering surface hardness, when a film-shaped polymer is prepared, and alignment defects, when the film is irradiated with ultraviolet light, a group represented by W¹ and W² is preferably a group selected from viewpoints of availability of raw materials and ease of synthesis described in the section <<W¹ and W²>>.

V¹, V², V³, and V⁴ preferably each independently represent a group represented by Formula (V-1) to Formula (V-15) described in the section <<W¹ and W²>> (in the formulae, in a case of including Y¹, Y¹ is preferably a group selected from viewpoints of availability of raw materials and ease of synthesis described in the section <<W¹ and W²>>), a single bond, a double bond, —O—, —S—, —OCH₂—, —CH₂O—, —CO—, —CH₂—, —COO—, —OCO—, —CO—S—, —S—CO—, —O—CO—O—, —CO—NH—, —NH—CO—, —CS—NH—, —NH—CS—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —CH₂CH₂—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, and —CH₂—OCO—, more preferably each independently represent Formula (V-1), Formula (V-2), Formula (V-6), Formula (V-8), Formula (V-9), Formula (V-10), a single bond, —CH₂—, —COO—, —OCO—, —CS—NH—, —NH—CS—, or —CH₂CH₂—, even more preferably each independently represent Formula (V-6), Formula (V-8), Formula (V-9), —CH₂—, —COO—, or —OCO—, and still more preferably each independently represent Formula (V-8) or Formula (V-9).

B¹, B², and B³ preferably each independently represent a group selected from Formula (B-1) to Formula (B-21)

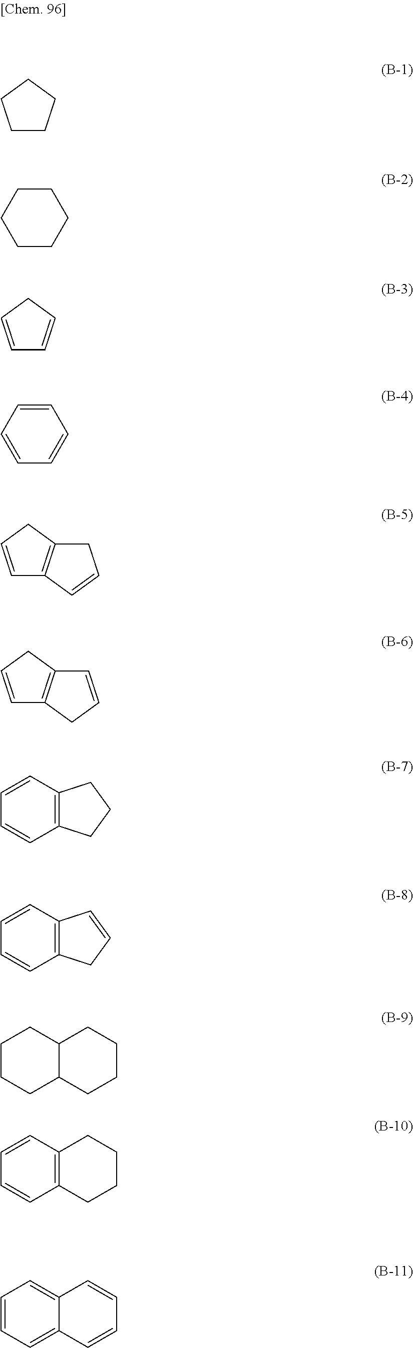

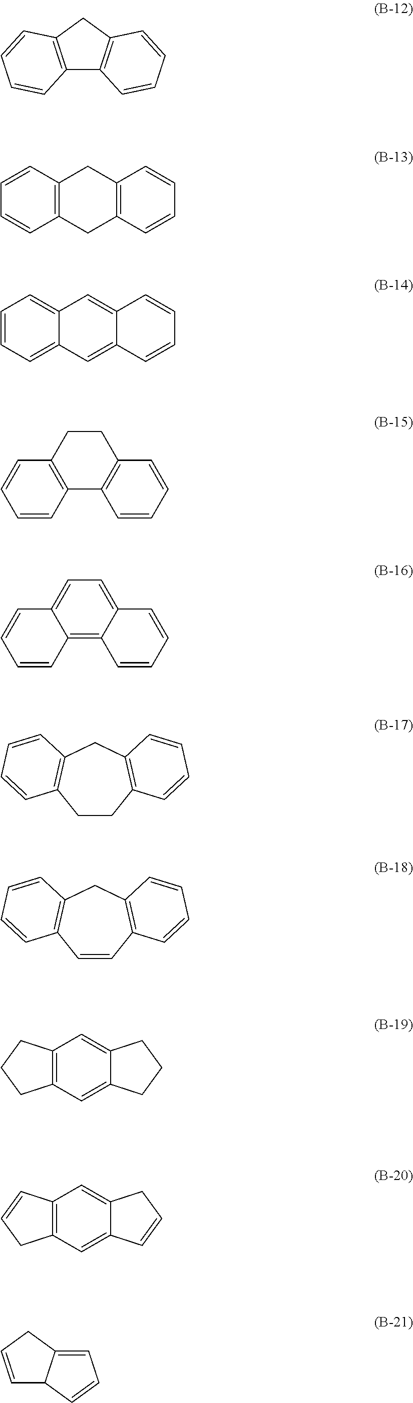

(in the formulae, a bonding site may be at an arbitrary position, arbitrary —CH═ may be each independently substituted with —N═, —CH₂— may be each independently substituted with —O—, —S—, —NR⁰— (in the formulae, R⁰ represents a hydrogen atom or an alkyl group having 1 to 20 carbon atoms), —CS— or —CO—, provided that a —O—O— bond is not included. In addition, these groups may be unsubstituted or substituted with one or more of substituents L.), and a single bond. B¹, B², and B³ are preferably a group selected from Formula (B-3), Formula (B-4), Formula (B-7), Formula (B-11), Formula (B-12), and a single bond, and more preferably a group selected from Formula (B-4), Formula (B-12), and a single bond. More specifically, B¹, B², and B³ are preferably a group selected from Formula (B-3-2), Formula (B-4-1), Formula (B-7-9), Formula (B-7-11), Formula (B-11-1), Formula (B-12-4) shown in the section <<W¹ and W²>>, and a single bond, more preferably a group selected from Formula (B-4-1), Formula (B-12-4), and a single bond, and even more preferably a group selected from Formula (B-4-1) and a single bond.

<R³ and R⁴>

In the compound in which <n1 represents 0, and n2 and n3 represent 1>, M², W¹, and W¹ described above are preferably suitably selected and the following groups are preferably respectively used for R³ and R⁴.

R³ represents a group represented by Formula (I-R).

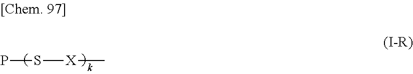

(In the formula, P represents a polymerizable group, S represents a spacer group or a single bond, in a case where a plurality of S is present, these may be the same as each other or different from each other, X represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, in a case where a plurality of X is present in the compound, these may be the same as each other or different from each other (provided that P—(S—X)ₖ— does not include a —O—O— bond), k represents an integer of 0 to 10.) R⁴ preferably represent a group selected from the group represented by Formula (I-R) and R⁵ (in the formula, R⁵ represents a hydrogen atom, a fluorine atom, a chlorine atom, a bromine atom, an iodine atom, a pentafluorosulfuranyl group, a nitro group, a cyano group, an isocyano group, an amino group, a hydroxyl group, a mercapto group, a methylamino group, a dimethylamino group, a diethylamino group, a diisopropylamino group, a trimethylsilyl group, a dimethylsilyl group, a thioisocyano group, or a linear or branched alkyl group having 1 to 20 carbon atoms, in which one —CH₂— or two or more of (—CH₂—)'s that are not adjacent to each other may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, and one or more of arbitrary hydrogen atoms in the alkyl group may be substituted with a fluorine atom). Both R³ and R⁴ are particularly preferably a group represented by Formula (I-R), and in this case, the preferable groups and numerical values shown in the section of <<R¹, R², R³, and R⁴>> are respectively applied to P, S, X, and k.

Compound in Which <<n1 and n2 Represent 0 and n3 Represents 2 to 1,000>>

<W¹-D1>

In the compound in which <n1 and n2 represent 0 and n3 represents 2>, evenness of film thickness or adhesiveness, when a film-shaped polymer is prepared, is excellent due to the structure of the compound. Therefore, in General Formula (I), W¹ preferably represents a group selected from by Formula (I-W17-1) or Formula (I-W17-2).

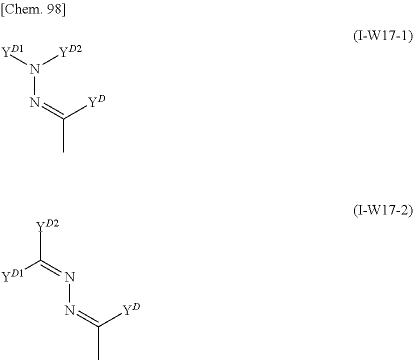

(In the formulae, Y^{D1} represents a group including aromatic and/or nonaromatic carbon ring or heterocyclic ring having 1 to 80 carbon atoms which may be substituted, arbitrary carbon atoms of the carbon ring or the heterocyclic ring may be substituted with hetero atoms (provided that oxygen atoms are not directly bonded to each other). Y^{D2} represents a hydrogen atom or a linear or branched alkyl group having 1 to 20 carbon atoms, in which one —CH₂— or two or more of (—CH₂—)'s that are not adjacent to each other may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, one or more of arbitrary hydrogen atoms in the alkyl group may be substituted with a fluorine atom, Y^{D2} may represent a group having 2 to 30 carbon atoms including at least one aromatic group, the group may be unsubstituted or substituted with one or more of substituents L. Y^{D} represents a hydrogen atom, a fluorine atom, a chlorine atom, a bromine atom, an iodine atom, a pentafluorosulfuranyl group, a nitro group, a cyano group, an isocyano group, an amino group, a hydroxyl group, a mercapto group, a methylamino group, a dimethylamino group, a diethylamino group, a diisopropylamino group, a trimethylsilyl group, a dimethylsilyl group, a thioisocyano group, or a linear or branched alkyl group having 1 to 20 carbon atoms, in which one —CH₂— or two or more of (—CH₂—)'s that are not adjacent to each other may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, one or more of arbitrary hydrogen atoms in the alkyl group may be substituted with a fluorine atom, and in a case where a plurality of Y^{D} is present, these may be the same as each other or different from each other. Alternatively, Y^{D2} may represent a group represented by P—(S—X)ⱼ—, P represents a polymerizable group, S represents a spacer group or a single bond, in a case where a plurality of S is present, these may be the same as each other or different from each other, X represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, in a case where a plurality of X is present, these may be the same as each other or different from each other (provided that P—(S—X)ⱼ— does not include a —O—O— bond), j represents an integer of 0 to 10, Y^{D1} and Y^{D2} may be integrated to form a ring structure.)

In addition, from viewpoints of liquid crystal properties and ease of synthesis, Y^{D} preferably represents a linear or branched alkyl group having 1 to 12 carbon atoms, in which one or more of arbitrary hydrogen atoms in the group may be substituted with a fluorine atom and one —CH₂— or two or more of (—CH₂—)'s that are not adjacent to each other may be each independently substituted with —O—, —COO—, or —OCO—, more preferably represents a linear or branched alkyl group having 1 to 12 carbon atoms, in which one or more of arbitrary hydrogen atoms in the group may be substituted with a fluorine atom, and particularly preferably represents a linear alkyl group having 1 to 12 carbon atoms.

Further, Y^{D1} is preferably a group represented by Formula (B-1) to Formula (B-21).

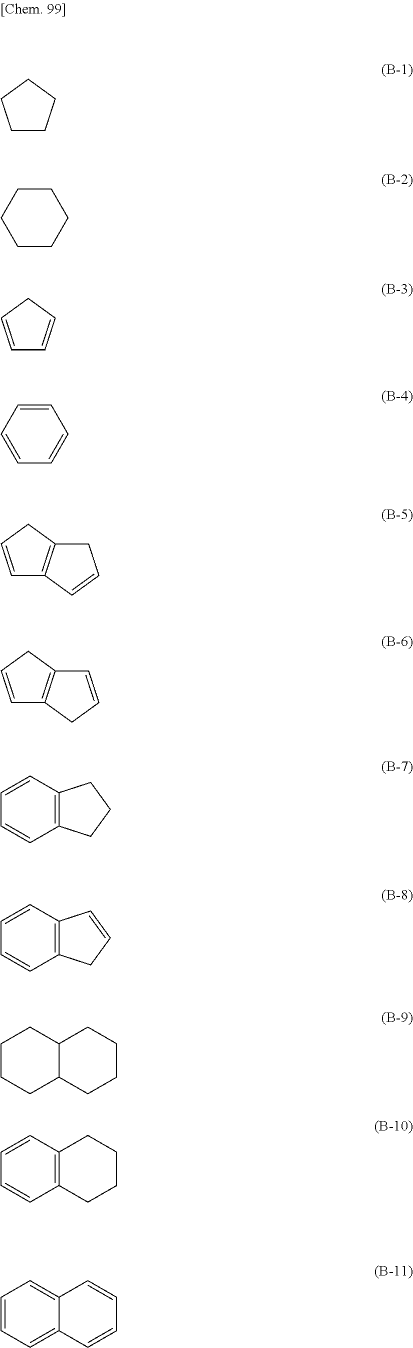

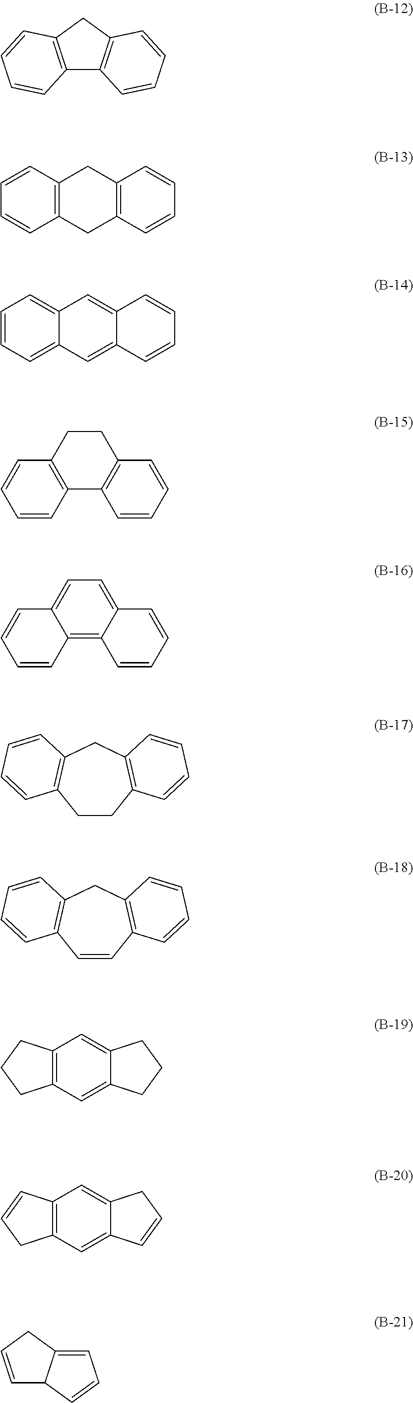

(In the formulae, a bonding site may be at an arbitrary position, arbitrary —CH═ may be each independently substituted with —N═, —CH₂— may be each independently substituted with —O—, —S—, —NR⁰— (in the formulae, R⁰ represents a hydrogen atom or an alkyl group having 1 to 20 carbon atoms), —CS— or —CO—, provided that a —O—O— bond is not included. In addition, these groups may be unsubstituted or substituted with one or more of substituents L.) Y^{D1} is more preferably a group selected from Formula (B-3), Formula (B-8), Formula (B-11), and Formula (B-12). More specifically, Y^{D1} is preferably a group selected from Formula (B-3-5), Formula (B-8-7), Formula (B-11-1), and Formula (B-12-1) shown in the section <<W¹ and W²>>, more preferably a group selected from Formula (B-8-7) and Formula (B-12-1), and even more preferably a group represented by Formula (B-8-7).

From viewpoints of availability of raw materials and ease of synthesis, in a case where Y^{D2} each independently represent a hydrogen atom, or a linear or branched alkyl group having 1 to 20 carbon atoms, in which one —CH₂— or two or more of (—CH₂—)'s that are not adjacent to each other may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, and one or more of arbitrary hydrogen atoms may be substituted with a fluorine atom, Y^{D2} preferably each independently represent a hydrogen atom, or a linear or branched alkyl group having 1 to 12 carbon atoms in which one —CH₂— or two or more of (—CH₂—)'s that are not adjacent to each other may be each independently substituted with —O—, —CO—, —COO—, or —OCO—, and one or more of arbitrary hydrogen atoms may be substituted with a fluorine atom, more preferably each independently represent a hydrogen atom, or a linear or branched alkyl group having 1 to 12 carbon atoms in which one —CH₂— or two or more of (—CH₂—)'s that are not adjacent to each other may be each independently substituted with —O—, —CO—, —COO—, or —OCO—, even more preferably each independently represent a hydrogen atom, or a linear alkyl group having 1 to 8 carbon atoms, and still more preferably each independently represent a hydrogen atom. In addition, from viewpoints of availability of raw materials and ease of synthesis, in a case where Y^{D2} represents a group having 5 to 30 carbon atoms including at least one aromatic group, which may be unsubstituted or substituted with one or more of substituents L, Y^{D2} is preferably a group represented by Formula (B-1) to Formula (B-21),

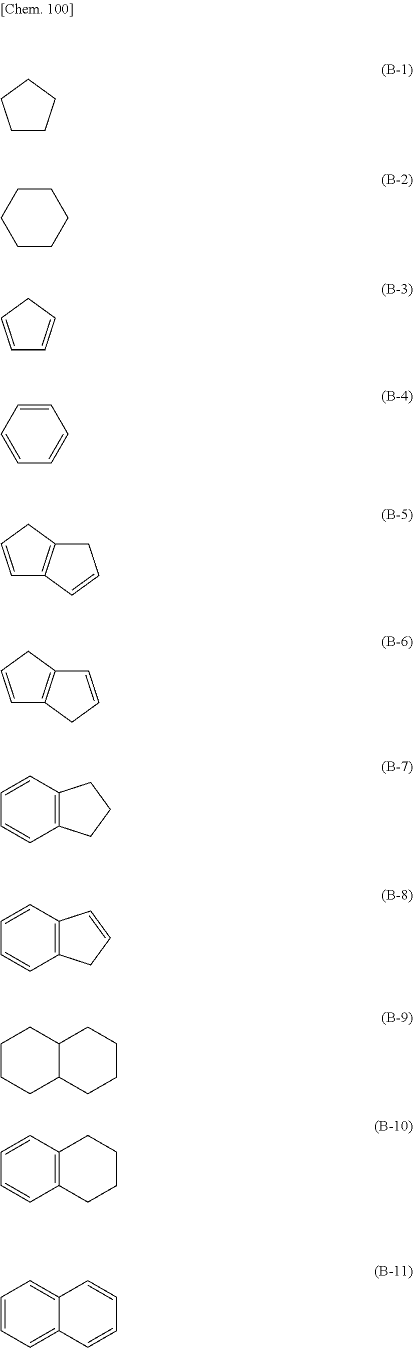

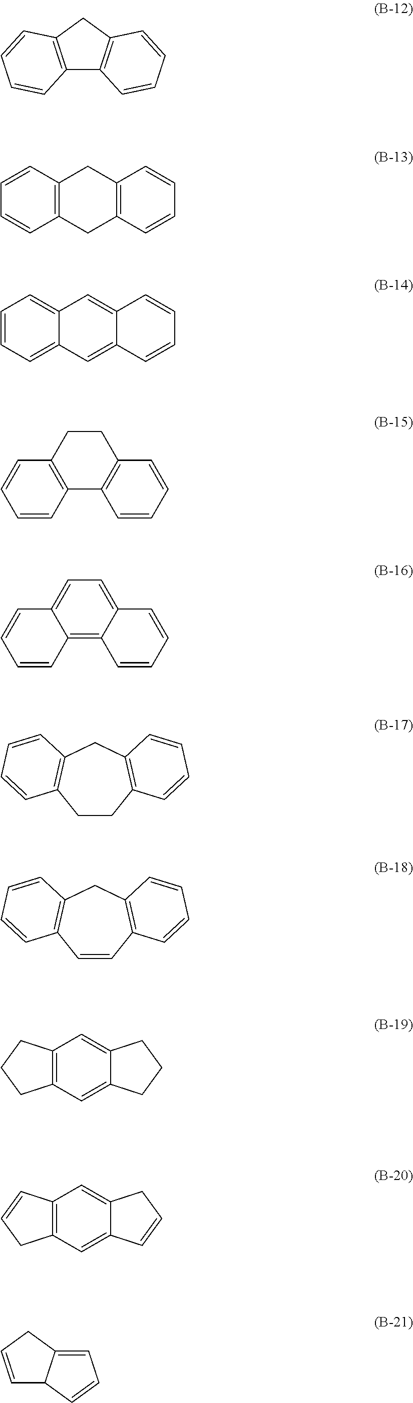

(in the formulae, a bonding site may be at an arbitrary position, arbitrary —CH═ may be each independently substituted with —N═, —CH₂— may be each independently substituted with —O—, —S—, —NR⁰— (in the formulae, R⁰ represents a hydrogen atom or an alkyl group having 1 to 20 carbon atoms), —CS— or —CO—, provided that a —O—O— bond is not included. In addition, these groups may be unsubstituted or substituted with one or more of substituents L.), and Y^{D2} is more preferably a group selected from Formula (B-3), Formula (B-8), Formula (B-11), and Formula (B-12). More specifically, Y^{D2} is preferably a group selected from Formula (B-3-5), Formula (B-8-7), Formula (B-11-1), and Formula (B-12-1) shown in the section <<W¹ and W²>>, more preferably a group selected from Formula (B-8-7) and Formula (B-12-1), and even more preferably a group represented by Formula (B-8-7).

In addition, in a case where Y^{D1} and Y^{D2} are integrated to form a ring structure, Y^{D1} and Y^{D2} preferably represent a group selected from Formula (Y-D-1) to Formula (Y-D-29),

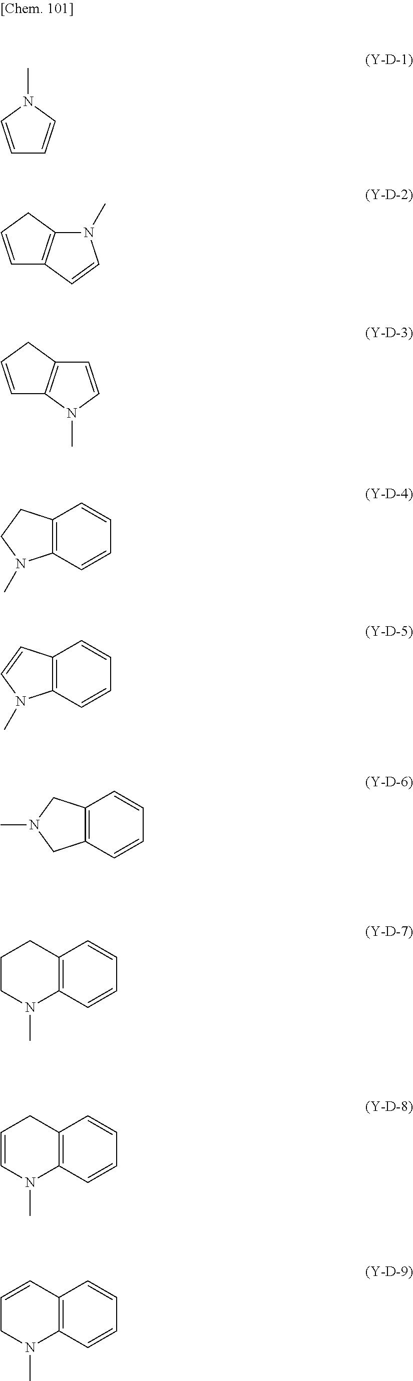

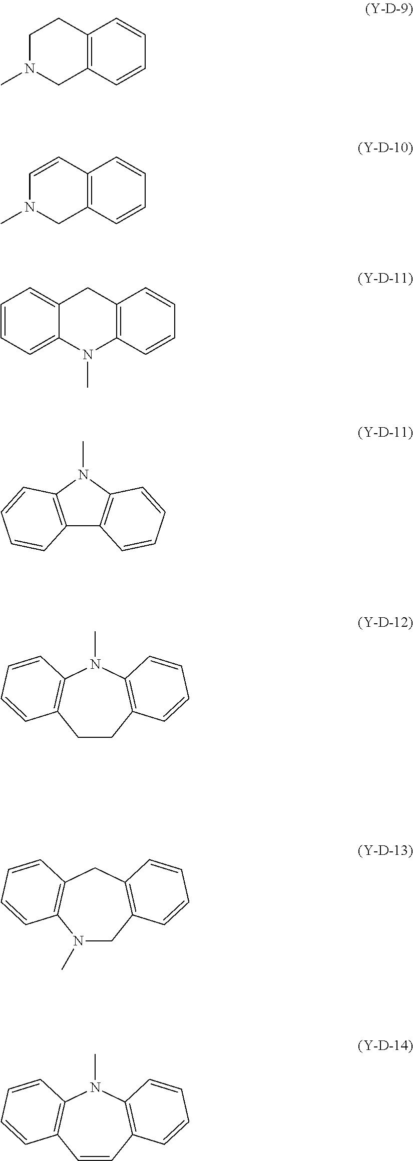

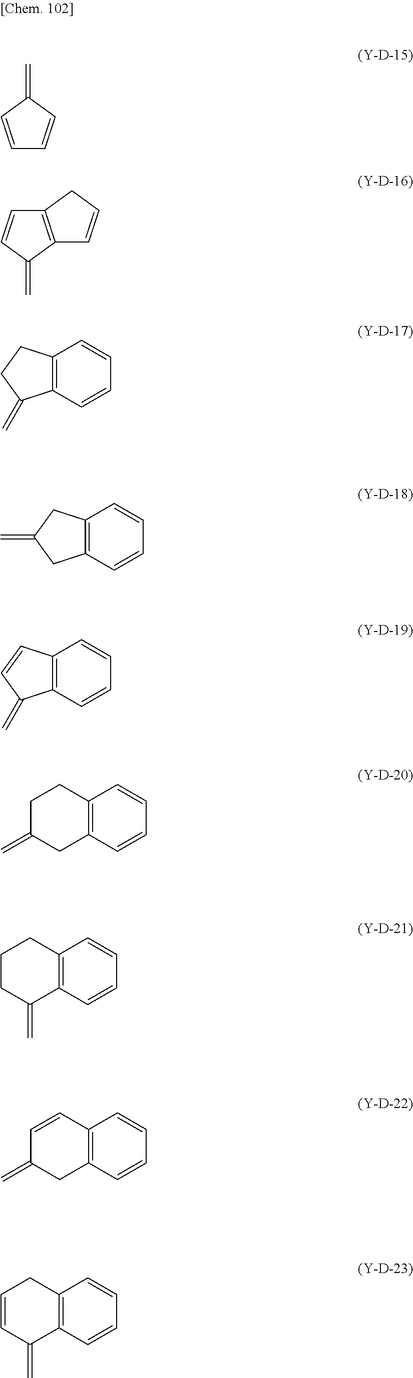

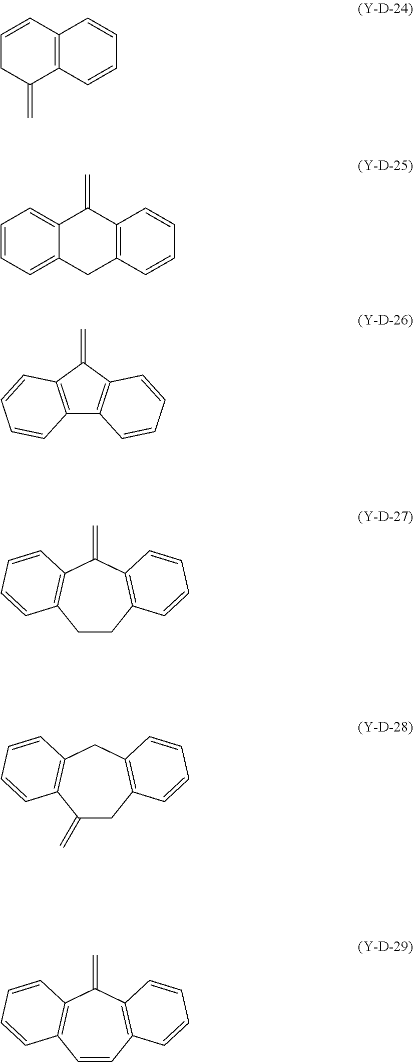

(in the formulae, arbitrary —CH═ may be each independently substituted with —N═, —CH₂— may be each independently substituted with —O—, —S—, —NR⁰— (in the formulae, R⁰ represents a hydrogen atom or an alkyl group having 1 to 20 carbon atoms), —CS— or —CO—, provided that a —O—O— bond is not included. In addition, these groups may be unsubstituted or substituted with one or more of substituents L.), and more preferably a group represented by Formula (Y-D-26).

<W¹-D2>

In the compound in which <n1 and n2 represent 0 and n3 represents 2>, in a case of significantly considering haze and adhesiveness, when a film-shaped polymer is prepared, a group represented by W¹ is preferably a group selected from viewpoints of availability of raw materials and ease of synthesis, among General Formula (I-W1) shown in the section <<W¹ and W²>>.

In General Formula (I-W1), V¹ and V² preferably each independently represents the groups represented by Formula (V-1) to Formula (V-15) shown in the section <<W¹ and W²>> (in the formulae, in a case of including Y¹, Y¹ is preferably a group selected from viewpoints of availability of raw materials and ease of synthesis described in the section <<W¹ and W²>>), a single bond, a double bond, —O—, —S—, —OCH₂—, —CH₂O—, —CO—, —CH₂—, —COO—, —OCO—, —CO—S—, —S—CO—, —O—CO—O—, —CO—NH—, —NH—CO—, —CS—NH—, —NH—CS—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —CH₂CH₂—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, or —CH₂—OCO—, more preferably represent Formula (V-1), Formula (V-2), Formula (V-3), Formula (V-4), Formula (V-5), Formula (V-6), Formula (V-7), Formula (V-8), Formula (V-9), a single bond, —COO—, or —OCO—, even more preferably represent Formula (V-5), Formula (V-8), Formula (V-9), or a single bond, and still more preferably represent a single bond.

In General Formula (I-W1), B¹ preferably each independently represents a group selected from Formula (B-1) to Formula (B-21).

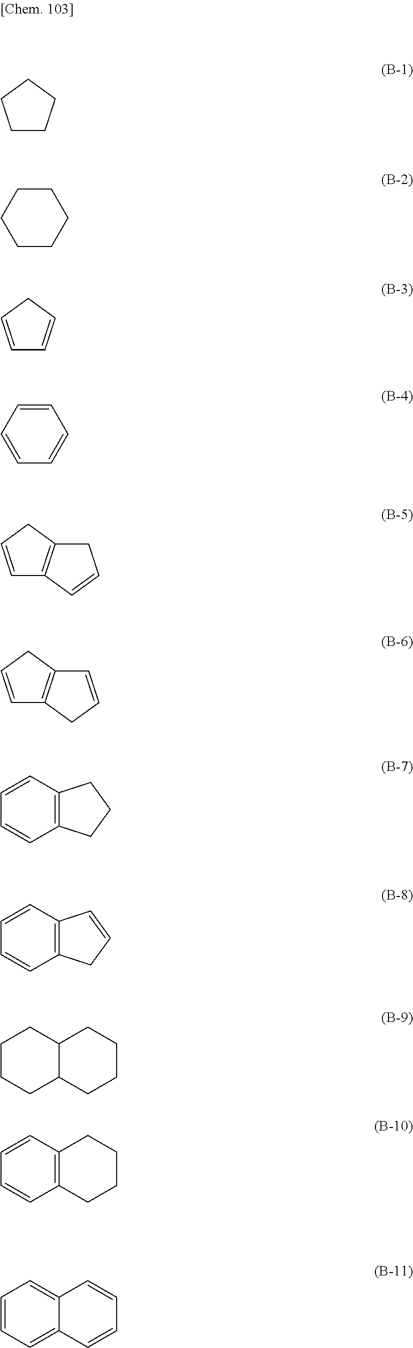

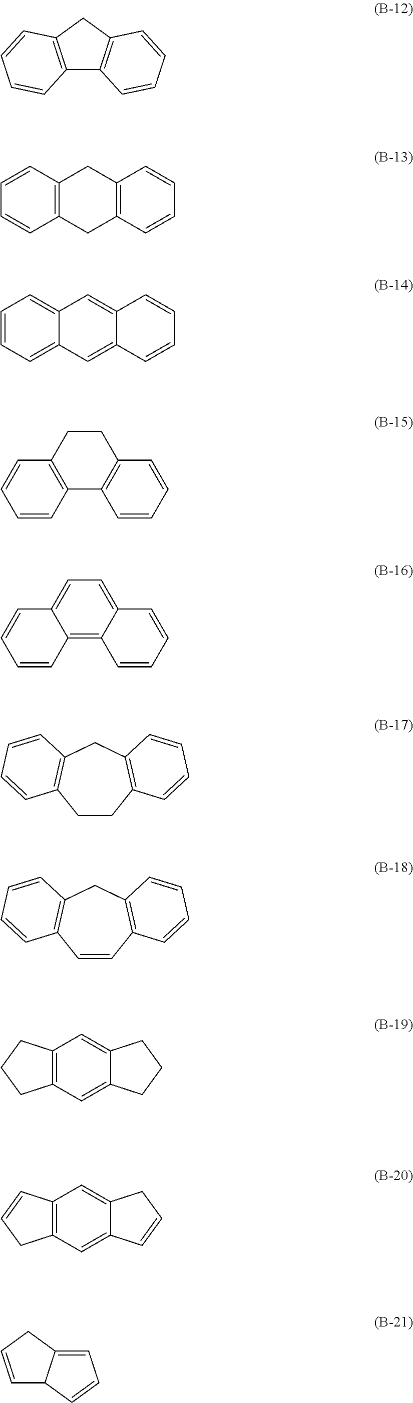

(In the formulae, a bonding site may be at an arbitrary position, arbitrary —CH═ may be each independently substituted with —N═, —CH₂— may be each independently substituted with —O—, —S—, —NR⁰— (in the formulae, R⁰ represents a hydrogen atom or an alkyl group having 1 to 20 carbon atoms), —CS— or —CO—, provided that a —O—O— bond is not included. In addition, these groups may be unsubstituted or substituted with one or more of substituents L), and a single bond.

B¹ is preferably a group selected from Formula (B-4), Formula (B-8), Formula (B-11), Formula (B-12), and a single bond, and more preferably a group selected from Formula (B-8), Formula (B-12), and a single bond. More specifically, B¹ is preferably a group selected from Formula (B-4-1), Formula (B-8-2), Formula (B-8-7), Formula (B-11-1), Formula (B-12-1), Formula (B-12-4) shown in the section <<W¹ and W²>>, and a single bond, more preferably a group selected from Formula (B-8-2), Formula (B-12-4) and a single bond, and even more preferably a group represented by Formula (B-8-2).

<W¹-D3>

In the compound in which <n1 and n2 represent 0 and n3 represents 2>, in a case of significantly considering haze and surface hardness, when a film-shaped polymer is prepared, a group represented by W¹ and W² is preferably a group selected from viewpoints of availability of raw materials and ease of synthesis, among General Formula (I-W1) shown in the section <<W¹ and W²>>.

In General Formula (I-W1), V¹ and V² preferably each independently represent the groups represented by Formula (V-1) to Formula (V-15) shown in the section <<W¹ and W²>> (in the formulae, in a case of including Y¹, Y is preferably a group selected from viewpoints of availability of raw materials and ease of synthesis described in the section <<W¹ and W²>>), a single bond, a double bond, —O—, —S—, —OCH₂—, —CH₂O—, —CO—, —CH₂—, —COO—, —OCO—, —CO—S—, —S—CO—, —O—CO—O—, —CO—NH—, —NH—CO—, —CS—NH—, —NH—CS—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —CH₂CH₂—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, and —CH₂—OCO—, more preferably represent Formula (V-5), Formula (V-6), Formula (V-7), Formula (V-8), Formula (V-9), Formula (V-10), a single bond, —COO—, —OCO—, —CS—NH—, and —NH—CS—, and even more preferably represent Formula (V-6), Formula (V-8), Formula (V-9), —COO—, and —OCO—.

In General Formula (I-W1), B¹ preferably each independently represents a group selected from Formula (B-1) to Formula (B-21),

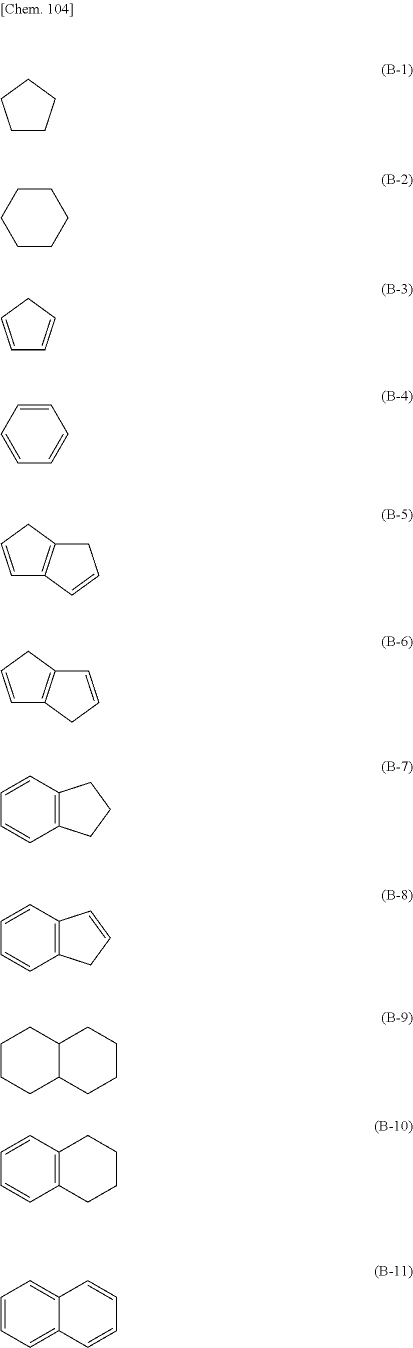

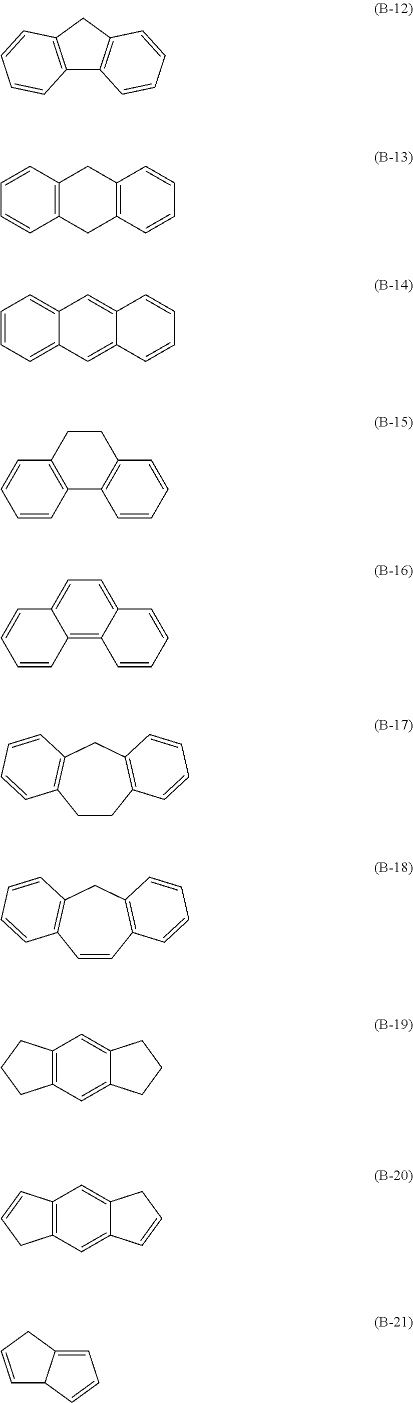

(In the formulae, a bonding site may be at an arbitrary position, arbitrary —CH═ may be each independently substituted with —N═, —CH₂— may be each independently substituted with —O—, —S—, —NR⁰— (in the formulae, R⁰ represents a hydrogen atom or an alkyl group having 1 to 20 carbon atoms), —CS— or —CO—, provided that a —O—O— bond is not included. In addition, these groups may be unsubstituted or substituted with one or more of substituents L.), and a single bond. B¹ is preferably a group selected from Formula (B-4), Formula (B-8), Formula (B-11), and a single bond, and more preferably a group selected from Formula (B-4) and a single bond. More specifically, B¹ is preferably a group selected from Formula (B-4-1), Formula (B-8-6), Formula (B-8-7), Formula (B-11-1) shown in the section <<W¹ and W²>>, and a single bond, and more preferably a group selected from Formula (B-4-1) and a single bond.

<-(M²)₂->

In the compound in which <n1 and n2 represent 0 and n3 represents 2>, a haze value, evenness of film thickness, or adhesiveness, when a film-shaped polymer is prepared, are excellent due to the structure of the compound. Therefore, in General Formula (I), -(M²)₂- is preferably a group represented by General Formula (I-M3).

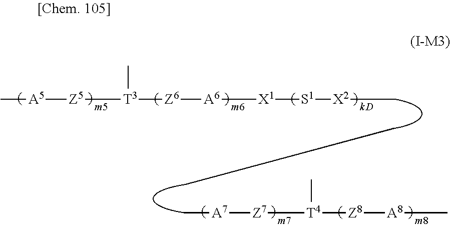

(In the formula, A⁵, A⁶, A⁷, and A8 being present each independently represent a 1,4-phenylene group, a 1,4-cyclohexylene group, a pyridine-2,5-diyl group, a pyrimidine-2,5-diyl group, a naphthalene-2,6-diyl group, a naphthalene-1,4-diyl group, a tetrahydronaphthalene-2,6-diyl group, a decahydronaphthalene-2,6-diyl group, or a 1,3-dioxane-2,5-diyl group, these groups may be unsubstituted or substituted with one or more of substituents L, and, in a case where a plurality of A⁵, A⁶, A⁷, and A⁸ is present, these may be the same as each other or different from each other. Z⁵, Z⁶, Z⁷, and Z⁸ being present each independently represent —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —OCO—NH—, —NH—COO—, —NH—CO—NH—, —NH—O—, —O—NH—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—, —N═CH—, —CH═N—N═CH—, —CF═CF—, —C≡C—, or a single bond, in a case where a plurality of each of Z⁵, Z⁶, Z⁷, and Z⁸ is present, these may be the same as each other or different from each other. X¹ and X² represent —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, in a case where a plurality of X² is present in the compound, these may be the same as each other or different from each other, S¹ represents a single bond or a linear or branched alkylene group having 1 to 20 carbon atoms in which one —CH₂— or two or more of (—CH₂—)'s that are not adjacent to each other may be each independently substituted with —O—, —COO—, —OCO—, —OCO—O—, —CO—NH—, —NH—CO—, —CH═CH—, or —C≡C—, in a case where a plurality of S¹ is present, these may be the same as each other or different from each other (provided that X¹—S¹ and S¹—X² do not include a —O—O— bond.), kD represents an integer of 0 to 8, m5, m6, m7, and m8 each independently represent an integer of 0 to 5, total of m5, m6, m7, and m8 represents 0 to 6, T³ and T⁴ each independently represent a group selected from Formula (T-1) to Formula (T-22)

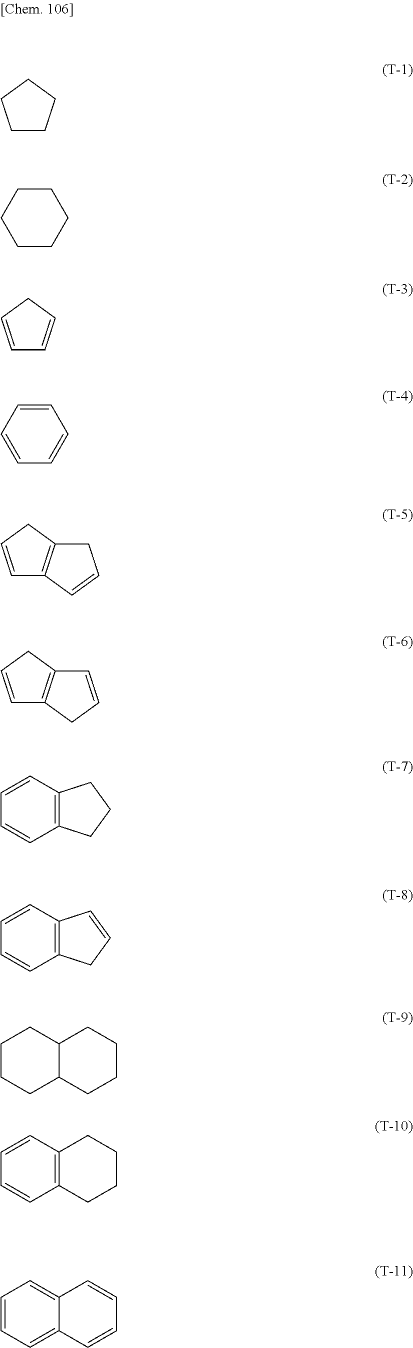

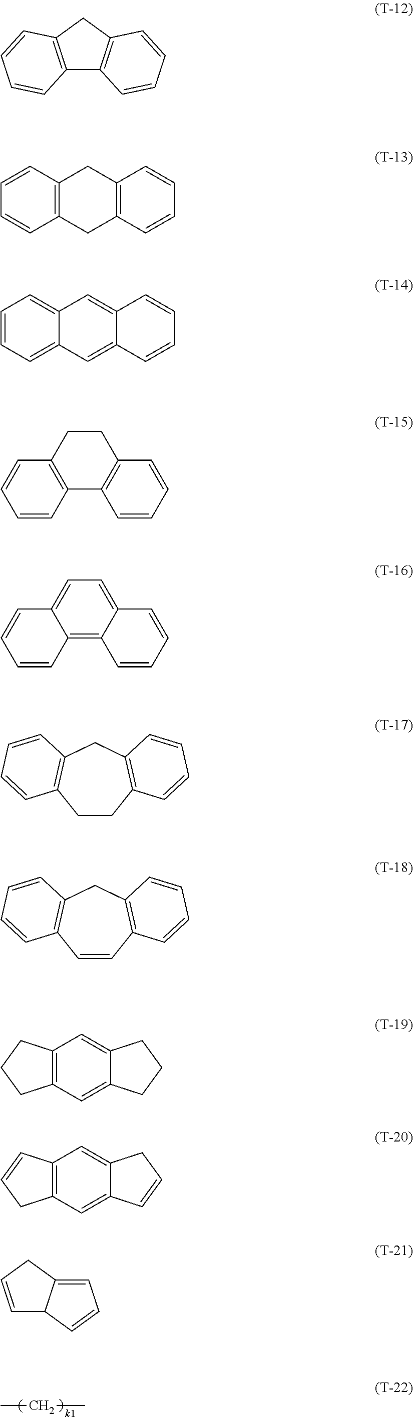

(in the formulae, a bonding site may be at an arbitrary position, arbitrary —CH═ may be each independently substituted with —N═, —CH₂— may be each independently substituted with —O—, —S—, —NR⁰— (in the formulae, R⁰ represents a hydrogen atom or an alkyl group having 1 to 20 carbon atoms), —CS— or —CO—, provided that a —O—O— bond is not included. In addition, these groups may be unsubstituted or substituted with one or more of substituents L, and kD represents an integer of 1 to 20).) In addition, both T³ and T⁴ preferably represent one group selected from Formula (T-1) to Formula (T-22) and T³ and T⁴ more preferably represent the same group.

In addition, from viewpoints of availability of raw materials and ease of synthesis, A⁵, A⁶, A⁷, and A⁸ preferably represent a 1,4-phenylene group, a 1,4-cyclohexylene group, or a naphthalene-2,6-diyl group which are not substituted or may be substituted with one or more substituent L, more preferably each independently represent a group selected from Formula (A-D-1) to Formula (A-D-11),

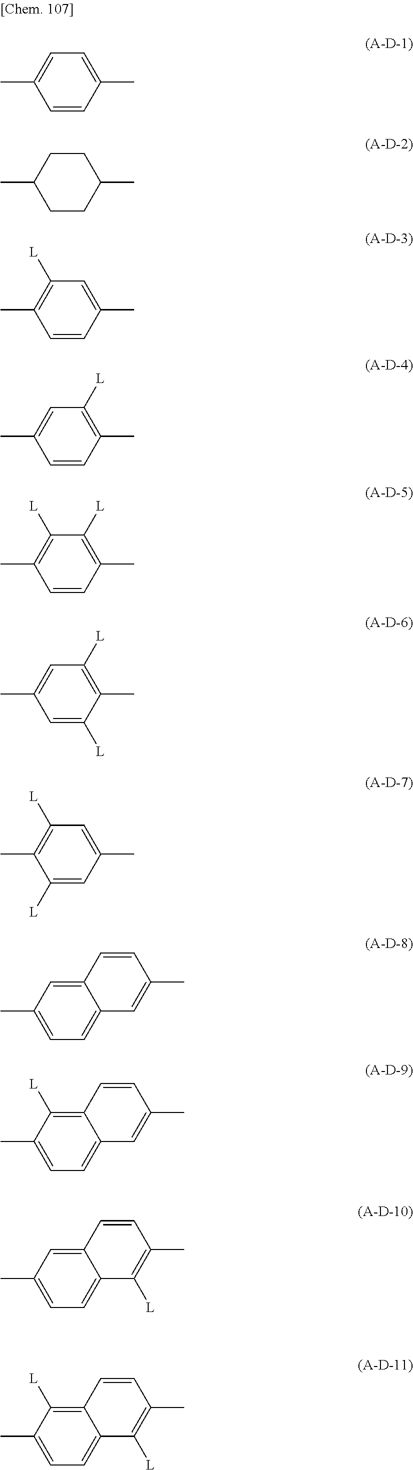

even more preferably each independently represent a group selected from Formula (A-D-1) to Formula (A-D-8), and particularly preferably each independently represent a group selected from Formula (A-D-1) to Formula (A-D-4).

In addition, from viewpoints of liquid crystal properties of the compound, availability of raw materials, and ease of synthesis, Z⁵, Z⁶, Z⁷, and Z⁸ preferably each independently represent a single bond, —OCH₂—, —CH₂O—, —COO—, —OCO—, —CF₂O—, —OCF₂—, —CH₂CH₂—, —CF₂CF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —CH═CH—, —CF═CF—, —C≡C—, or a single bond, more preferably each independently represent —OCH₂—, —CH₂O—, —CH₂CH₂—, —COO—, —OCO—, —COO—CH₂CH₂—, —OCO—CH₂CH₂—, —CH₂CH₂—COO—, —CH₂CH₂—OCO—, —CH═CH—, —C≡C—, or a single bond, even more preferably each independently represent —CH₂CH₂—, —COO—, —OCO—, —COO—CH₂CH₂—, —OCO—CH₂CH₂—, —CH₂CH₂—COO—, —CH₂CH₂—OCO—, or a single bond, and particularly preferably each independently represent —COO—, —OCO—, or a single bond.

In addition, from viewpoints of liquid crystal properties of the compound, ease of synthesis, and storage stability, m5, m6, m7, and m8 preferably each independently represent an integer of 1 to 4, more preferably each independently represent an integer of 1 to 3, and particularly preferably each independently represent 1 or 2. The total of m5, m6, m7, and m8 preferably each independently represents an integer of 2 to 4.

In addition, S-preferably each independently represents a linear alkylene group having 1 to 20 carbon atoms in which one —CH₂— or two or more of (—CH₂—)'s that are not adjacent to each other may be each independently substituted with —O—, —COO—, —OCO—, —OCO—O—, —CO—NH—, —NH—CO—, —CH═CH—, or —C≡C—, more preferably each independently represents a linear alkylene group having 1 to 12 carbon atoms in which one —CH₂— or two or more of (—CH₂—)'s that are not adjacent to each other may be each independently substituted with —O—, —COO—, or —OCO—, and even more preferably each independently represents a linear alkylene group having 1 to 6 carbon atoms.

In addition, X¹ and X² preferably represent —O—, —CO—, —COO—, —OCO—, —CO—NH—, —NH—CO—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, or a single bond and more preferably represent —O—, —COO—, —OCO—, or a single bond.

In addition, kD preferably represents an integer of 0 to 4, more preferably represents an integer of 0 to 2, even more preferably represents 1 or 2, and still more preferably represents 1.

<-(M²)₂-D1>

In the compound in which <n1 and n2 represent 0 and n3 represents 2>, in a case of significantly considering storage stability of the composition, adhesiveness, when a film-shaped polymer is prepared, and appearance after ultraviolet light irradiation, or in a case of significantly considering evenness of film thickness and unevenness of alignment, when a film-shaped polymer is prepared, in General Formula (I-M3), T³ and T⁴ each independently represent a group selected from Formula (T2-1) to Formula (T2-10).

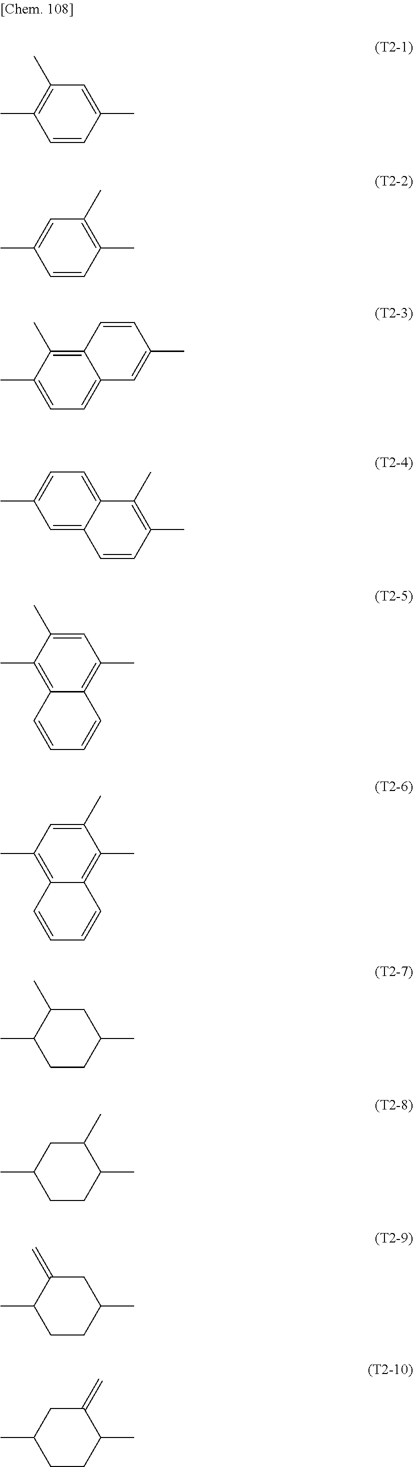

These groups preferably represent a group which may be unsubstituted or substituted with one or more of substituents L, and more preferably represent a group represented by Formula (T2-1) and Formula (T2-2). In addition, both T³ and T⁴ preferably represent one group selected from Formula (T2-1) to Formula (T2-10) and T³ and T⁴ more preferably represent the same group.

<-(M²)₂-D2>

In the compound in which <n1 and n2 represent 0 and n3 represents 2>, in a case of significantly considering haze and adhesiveness, when a film-shaped polymer is prepared, in General Formula (I-M3), T³'s each independently represent a group selected from Formula (T2-11) to Formula (T2-27),

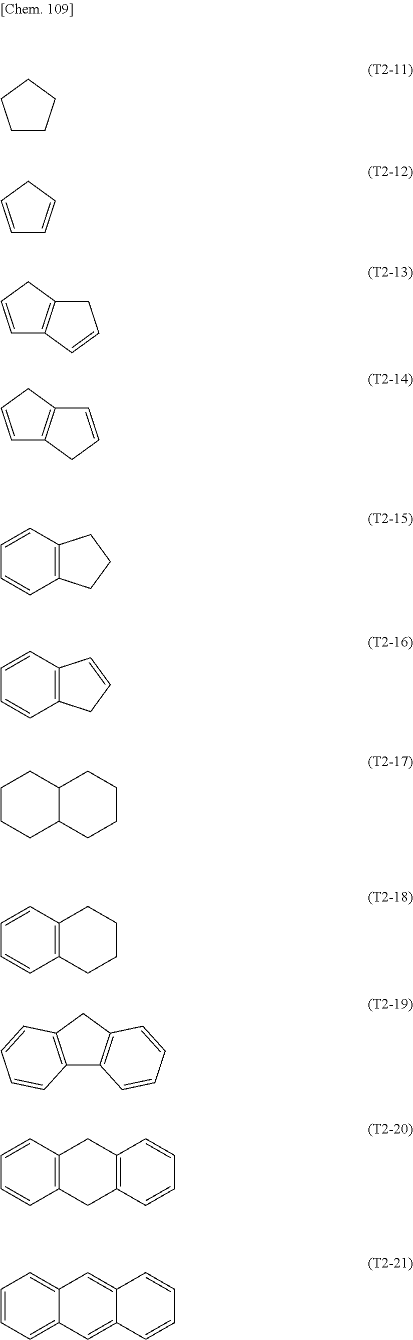

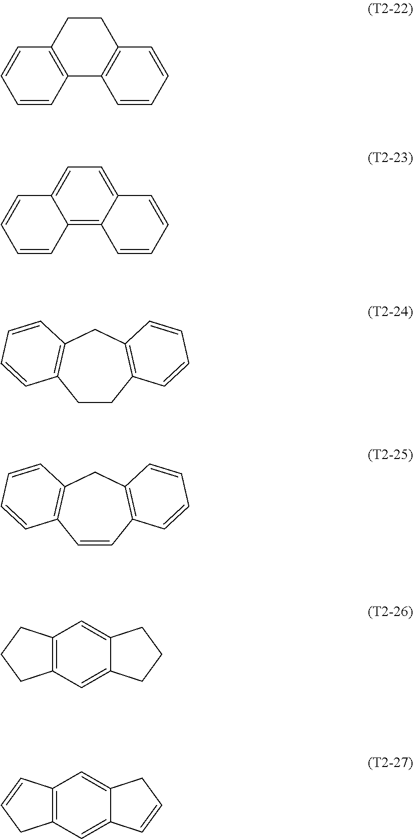

(in the formulae, a bonding site may be at an arbitrary position, arbitrary —CH═ may be each independently substituted with —N═, —CH₂— may be each independently substituted with —O—, —S—, —NR⁰— (in the formulae, R⁰ represents a hydrogen atom or an alkyl group having 1 to 20 carbon atoms), —CS— or —CO—, provided that a —O—O— bond is not included. In addition, these groups may be unsubstituted or substituted with one or more of L.), Formula (T2-28) to Formula (T2-31),

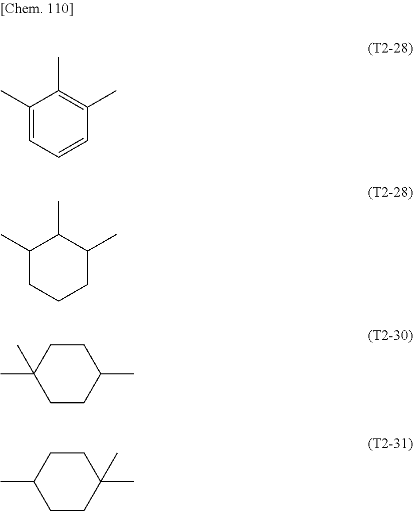

(in the formulae, arbitrary —CH═ may be each independently substituted with —N═, —CH₂— may be each independently substituted with —O—, —S—, —NR⁰— (in the formulae, R⁰ represents a hydrogen atom or an alkyl group having 1 to 20 carbon atoms), —CS— or —CO—, provided that a —O—O— bond is not included. In addition, these groups may be unsubstituted or substituted with one or more of L.), Formula (T2-32),

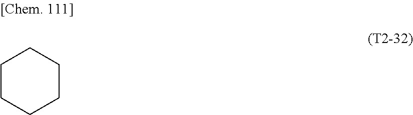

(in the formula, a bonding site may be at an arbitrary position, at least one —CH₂— is each independently substituted with —O—, —S—, —NR⁰— (in the formulae, R⁰ represents a hydrogen atom or an alkyl group having 1 to 20 carbon atoms), —CS— or —CO—, provided that a —O—O— bond is not included. In addition, these groups may be unsubstituted or substituted with one or more of L.), and Formula (T2-33) or Formula (T2-34),

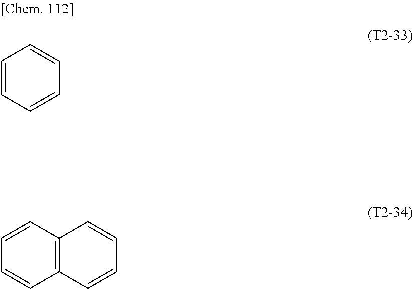 [SMILES: c1ccccc1 ; c1ccc2ccccc2c1]

(in the formulae, a bonding site may be at an arbitrary position, at least one —CH═ is each independently substituted with —N═. In addition, these groups may be unsubstituted or substituted with one or more of L.). In General Formula (I-M3), T⁴ preferably represents a group selected from Formula (T2-1) to Formula (T2-10) or Formula (T2-11) to Formula (T2-34).

In addition, T³ more preferably represents a group selected from Formula (T2-35) to Formula (T2-41),

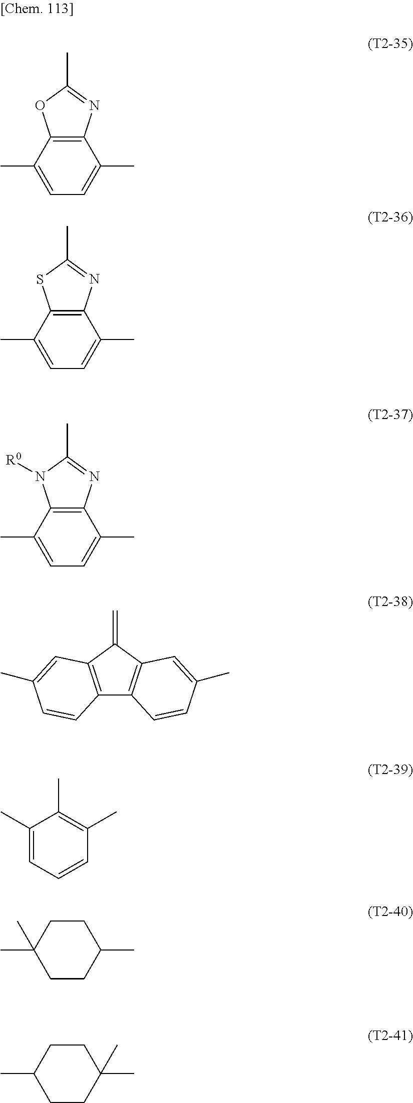

(in the formulae, R⁰ represents a hydrogen atom or an alkyl group having 1 to 20 carbon atoms), even more preferably represents a group selected from Formula (T2-36), Formula (T2-40), and Formula (T2-41), and still more preferably represents Formula (T2-36). In addition, both T³ and T⁴ preferably represent a group selected from Formula (T2-35) to Formula (T2-41), more preferably represent a group selected from Formula (T2-36), Formula (T2-40), and Formula (T2-41), and still more preferably represent Formula (T2-36).

<-(M²)₂-D3>

In the compound in which <n1 and n2 represent 0 and n3 represents 2>, in a case of significantly considering haze and surface hardness, when a film-shaped polymer is prepared, T³ preferably represents an acyclic group having 1 to 80 carbon atoms which may be substituted, and arbitrary carbon atoms of the acyclic group may be substituted with hetero atoms.

In addition, in General Formula (I-M3), T³ preferably represents Formula (T-22)

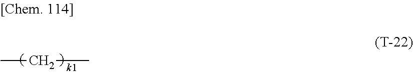

(in the formula, a bonding site may be at an arbitrary position, arbitrary —CH₂— may be each independently substituted with —O—, —S—, —NR— (in the formula, R⁰ represents a hydrogen atom or an alkyl group having 1 to 20 carbon atoms), —CS— or —CO—, provided that a —O—O— bond is not included. In addition, these groups may be unsubstituted or substituted with one or more of L, and k1 represents an integer of 1 to 20.), preferably represents a group selected from Formula (T-22-1) or Formula (T-22-2),

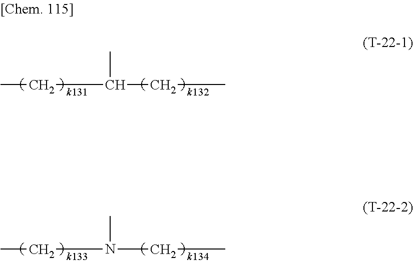

(in the formulae, arbitrary —CH₂— may be each independently substituted with —O—, —S—, —NR⁰— (in the formula, R⁰ represents a hydrogen atom or an alkyl group having 1 to 20 carbon atoms), —CS— or —CO—, provided that a —O—O— bond is not included. In addition, these groups may be unsubstituted or substituted with one or more of L, and k131 to k134 represent an integer of 0 to 20), and more preferably represents Formula (T-22-1). It is even more preferable that k131 and k132 in Formula (T-22-1) represent 1. In addition, both T³ and T⁴ preferably represent a group represented by Formula (T-22), more preferably represent a group selected from Formula (T-22-1) or Formula (T-22-2), and even more preferably represent Formula (T-22-1).

<R³ and R⁴>

In the compound in which <n1 and n2 represent 0 and n3 represents 2>, M² and W¹ described above are preferably suitably selected and the following groups are preferably respectively used as R³ and R⁴. R³ represents a group represented by Formula (I-R).

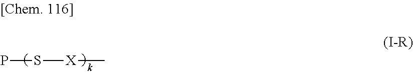

(In the formula, P represents a polymerizable group, S represents a spacer group or a single bond, in a case where a plurality of S is present, these may be the same as each other or different from each other, X represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, in a case where a plurality of X is present in the compound, these may be the same as each other or different from each other (provided that P—(S—X)ₖ— does not include a —O—O— bond), k represents an integer of 0 to 10.) R⁴ preferably represents a group selected from the group represented by Formula (I-R) and R⁵ (in the formula, R⁵ represents a hydrogen atom, a fluorine atom, a chlorine atom, a bromine atom, an iodine atom, a pentafluorosulfuranyl group, a nitro group, a cyano group, an isocyano group, an amino group, a hydroxyl group, a mercapto group, a methylamino group, a dimethylamino group, a diethylamino group, a diisopropylamino group, a trimethylsilyl group, a dimethylsilyl group, a thioisocyano group, or a linear or branched alkyl group having 1 to 20 carbon atoms, in which one —CH₂— or two or more of (—CH₂—)'s that are not adjacent to each other may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, and one or more of arbitrary hydrogen atoms in the alkyl group may be substituted with a fluorine atom). Both R³ and R⁴ are particularly preferably a group represented by Formula (I-R), and in this case, the preferable groups and numerical values shown in the section of <<R¹, R², R³, and R⁴>> are respectively applied to P, S, X, and k.

In the compound in which n3 represents 3 to 1,000 in the compound in which <n1 and n2 represent 0 and n3 represents 2 to 1,000>, haze, appearance after ultraviolet light irradiation, and alignment defects, when a film-shaped polymer is prepared, are excellent due to the structure of the compound. Therefore, in General Formula (I), the preferable groups and numerical values shown in the sections of <W¹-D1>, <W¹-D2>, and <W¹-D3> are applied to W¹. In addition, in General Formula (I), the preferable groups and numerical values shown in the sections of <-(M²)₂-D1>, <-(M²)₂-D2>, and <-(M²)₂-D3> are applied to -(M²)ₙ₃-.

In a case of significantly considering reverse dispersibility, the compound represented by General Formula (I) is preferably a compound represented by General Formula (I-z1) and/or General Formula (I-z2).

More specifically, in a case of significantly considering reverse dispersibility, solubility in a solvent, ease of synthesis, availability of raw materials, liquid crystal properties, hardening shrinkage in a case where a film is obtained, and reduced warp, a compound represented by General Formula (I) is preferably a compound represented by General Formula (I-z1).

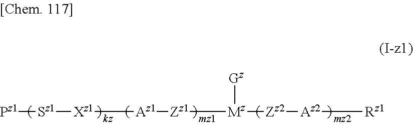

In the formula, P^{z1} represents a polymerizable group and preferably represents a group selected from Formula (P-1) to Formula (P-20), and the polymerizable groups are polymerized by radical polymerization, radical addition polymerization, cation polymerization, and anion polymerization. Particularly, in a case of performing ultraviolet ray polymerization as a polymerization method, Formula (P-1), Formula (P-2), Formula (P-3), Formula (P-4), Formula (P-5), Formula (P-7), Formula (P-11), Formula (P-13), Formula (P-15), or Formula (P-18) is preferable, Formula (P-1), Formula (P-2), Formula (P-7), Formula (P-11), or Formula (P-13) is more preferable, Formula (P-1), Formula (P-2), or Formula (P-3) is even more preferable, and Formula (P-1) or Formula (P-2) is particularly preferable. S^{z1} represents a spacer group or a single bond, and in a case where a plurality of S^{z1} is present, these may be the same as each other or different from each other. From viewpoints of liquid crystal properties, availability of raw materials, and ease of synthesis, in a case where a plurality of S^{z1} is present, these may be the same as each other or different from each other, and S^{z1}'s preferably each independently represent an alkylene group having 1 to 20 carbon atoms in which one —CH₂— or two or more of (—CH₂—)'s that are not adjacent to each other may be each independently substituted with —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, or —C≡C—, and a single bond. In a case where a plurality of S^{z1} is present, these may be the same as each other or different from each other, and S^{z1}'s more preferably each independently represent a linear alkylene group having 1 to 20 carbon atoms in which one —CH₂— or two or more of (—CH₂—)'s that are not adjacent to each other may be each independently substituted with —O—, —COO—, —OCO—, or —OCO—O—, or a single bond. In a case where a plurality of S^{z1} is present, these may be the same as each other or different from each other, and S^{z1}'s even more preferably each independently represent a linear alkylene group having 1 to 12 carbon atoms in which one —CH₂— or two or more of (—CH₂—)'s that are not adjacent to each other may be each independently substituted with —O—, still more preferably each independently represent a linear alkylene group having 1 to 12 carbon atoms in which one —CH₂— or two or more of (—CH₂—)'s that are not adjacent to each other may be each independently substituted with —O—, and particularly preferably represent a linear alkylene group having 1 to 12 carbon atoms. X^{z1} represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, and in a case where a plurality of X is present, these may be the same as each other or different from each other (provided that P^{z1}—(S^{z1}—X^{z1})_{kz}— does not include a —O—O— bond). From viewpoints of availability of raw materials and ease of synthesis, in a case where a plurality of X^{z1} is present, these may be the same as each other or different from each other, X^{z1}'s preferably each independently represent —O—, —S—, —OCH₂—, —CH₂O—, —COO—, —OCO—, —CO—S—, —S—CO—, —O—CO—O—, —CO—NH—, —NH—CO—, —COO—CH₂CH₂—, —OCO—CH₂CH₂—, —CH₂CH₂—COO—, —CH₂CH₂—OCO—, or a single bond, more preferably each independently represent —O—, —OCH₂—, —CH₂O—, —COO—, —OCO—, —COO—CH₂CH₂—, —OCO—CH₂CH₂—, —CH₂CH₂—COO—, —CH₂CH₂—OCO—, or a single bond. In a case where a plurality of X^{z1} is present, these may be the same as each other or different from each other, and X^{z1}'s particularly preferably each independently represent —O—, —COO—, —OCO—, or a single bond. A^{z1} and A^{z2} each independently represent a 1,4-phenylene group, a 1,4-cyclohexylene group, a pyridine-2,5-diyl group, a pyrimidine-2,5-diyl group, a naphthalene-2,6-diyl group, a naphthalene-1,4-diyl group, a tetrahydronaphthalene-2,6-diyl group, a decahydronaphthalene-2,6-diyl group, or a 1,3-dioxane-2,5-diyl group, these groups may be unsubstituted or substituted with one or more of L described above, and, in a case where a plurality of each of A^{z1} and A^{z2} is present, these may be the same as each other or different from each other. The preferable structure of A^{z1} and A^{z2} is the same as that in a case of A¹, A², A³, and A⁴. Z^{z1} and Z^{z2} each independently represent —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —OCO—NH—, —NH—COO—, —NH—CO—NH—, —NH—O—, —O—NH—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—, —N═CH—, —CH═N—N═CH—, —CF═CF—, —C≡C—, or a single bond, in a case where a plurality of each of Z^{z1} and Z^{z2} is present, these may be the same as each other or different from each other. From viewpoints of liquid crystal properties of the compound, availability of raw materials, and ease of synthesis, Z^{z1} and Z^{z2} preferably each independently represent a single bond, —OCH₂—, —CH₂O—, —COO—, —OCO—, —CF₂O—, —OCF₂—, —CH₂CH₂—, —CF₂CF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —CH═CH—, —CF═CF—, —C≡C—, or a single bond, more preferably each independently represent —OCH₂—, —CH₂O—, —CH₂CH₂—, —COO—, —OCO—, —COO—CH₂CH₂—, —OCO—CH₂CH₂—, —CH₂CH₂—COO—, —CH₂CH₂—OCO—, —CH═CH—, —C≡C—, or a single bond, even more preferably each independently represent —OCH₂—, —CH₂O—, —CH₂CH₂—, —COO—, —OCO—, —COO—CH₂CH₂—, —OCO—CH₂CH₂—, —CH₂CH₂—COO—, —CH₂CH₂—OCO—, or a single bond, still more preferably each independently represent —OCH₂—, —CH₂O—, —COO—, —OCO—, —COO—CH₂CH₂—, —OCO—CH₂CH₂—, —CH₂CH₂—COO—, —CH₂CH₂—OCO—, or a single bond, and particularly preferably each independently represent —OCH₂—, —CH₂O—, —COO—, —OCO—, or a single bond.

M^{z} represents a group selected from Formula (M-z-1) to Formula (M-z-8).

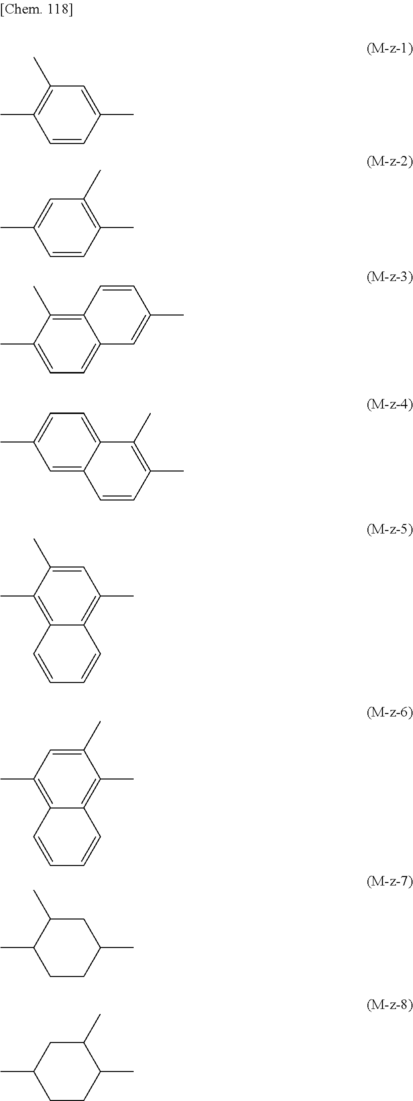

These groups may be unsubstituted or substituted with one or more of L^{Mz}. L^{Mz} represents a fluorine atom, a chlorine atom, a bromine atom, an iodine atom, a pentafluorosulfuranyl group, a nitro group, a cyano group, an isocyano group, an amino group, a hydroxyl group, a mercapto group, a methylamino group, a dimethylamino group, a diethylamino group, a diisopropylamino group, a trimethylsilyl group, a dimethylsilyl group, a thioisocyano group, or a linear or branched alkyl group having 1 to 20 carbon atoms, in which one —CH₂— or two or more of (—CH₂—)'s that are not adjacent to each other may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, one or more of arbitrary hydrogen atoms in the alkyl group may be substituted with a fluorine atom, and in a case where a plurality of L^{Mz} is present, these may be the same as each other or different from each other. From viewpoints of availability of raw materials and ease of synthesis, M^{z} preferably each independently represents a group selected from Formula (M-z-1) or Formula (M-z-2) which may be unsubstituted or substituted with one or more of L^{Mz}, or Formula (M-z-3) to Formula (M-z-6) which may not be substituted, more preferably represents a group selected from Formula (M-z-1) or Formula (M-z-2) which may be unsubstituted or substituted with one or more of L^{Mz}, and particularly preferably represents a group selected from Formula (M-z-1) or Formula (M-z-2) which may not be substituted. R^{z1} represents a hydrogen atom, a fluorine atom, a chlorine atom, a bromine atom, an iodine atom, a pentafluorosulfuranyl group, a cyano group, a nitro group, an isocyano group, a thioisocyano group, or a linear or branched alkyl group having 1 to 20 carbon atoms, in which one —CH₂— or two or more of (—CH₂—)'s that are not adjacent to each other may be each independently substituted with —O—, —S—, —CO—, —COO—, —OCO—, —CO—S—, —S—CO—, —O—CO—O—, —CO—NH—, —NH—CO—, —CH═CH—, —CF═CF—, or —C≡C—, and one or more of arbitrary hydrogen atoms in the alkyl group may be substituted with a fluorine atom. From viewpoints of liquid crystal properties and ease of synthesis, R^{z1} preferably represents a hydrogen atom, a fluorine atom, a chlorine atom, a cyano group, or a linear or branched alkyl group having 1 to 12 carbon atoms, in which one —CH₂— or two or more of (—CH₂—)'s that are not adjacent to each other may be each independently substituted with —O—, —COO—, —OCO—, or —O—CO—O—, more preferably a hydrogen atom, a fluorine atom, a chlorine atom, a cyano group, or a linear alkyl group or a linear alkoxy group having 1 to 12 carbon atoms, even more preferably a hydrogen atom, or a linear alkyl group or a linear alkoxy group having 1 to 12 carbon atoms, and particularly preferably a linear alkyl group or a linear alkoxy group having 1 to 12 carbon atoms. G^{z} is preferably a compound represented by Formula (G-z-1) or Formula (G-z-2),

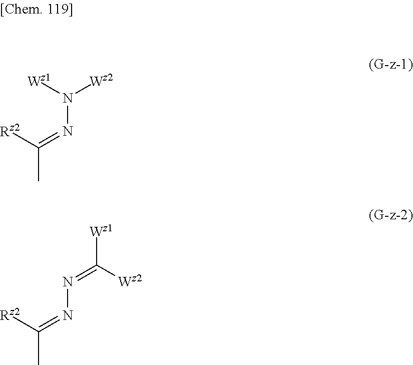

(in the formulae, R^{z2} represents a hydrogen atom, or a linear or branched alkyl group having 1 to 20 carbon atoms in which one —CH₂— or two or more of (—CH₂—)'s that are not adjacent to each other may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, one or more of arbitrary hydrogen atoms in the alkyl group may be substituted with a fluorine atom, W^{z1} represents a group having 2 to 30 carbon atoms including at least one aromatic group, the group may be unsubstituted or substituted with one or more of L^{Wz}. L^{Wz} represents a fluorine atom, a chlorine atom, a bromine atom, an iodine atom, a pentafluorosulfuranyl group, a nitro group, a cyano group, an isocyano group, an amino group, a hydroxyl group, a mercapto group, a methylamino group, a dimethylamino group, a diethylamino group, a diisopropylamino group, a trimethylsilyl group, a dimethylsilyl group, a thioisocyano group, or a linear or branched alkyl group having 1 to 20 carbon atoms, in which one —CH₂— or two or more of (—CH₂—)'s that are not adjacent to each other may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, one or more of arbitrary hydrogen atoms in the alkyl group may be substituted with a fluorine atom, and in a case where a plurality of L^{Wz} is present, these may be the same as each other or different from each other. W^{Z2} represents a hydrogen atom, or a linear or branched alkyl group having 1 to 20 carbon atoms, in which one —CH₂— or two or more of (—CH₂—)'s that are not adjacent to each other may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, and one or more of arbitrary hydrogen atoms in the alkyl group may be substituted with a fluorine atom. Alternatively, W^{z2} may represent a group having 2 to 30 carbon atoms including at least one aromatic group, the group may be unsubstituted or substituted with one or more of substituents L^{Wz}. W^{z1} and W^{z2} may be integrated to form a ring structure. kz represents an integer of 0 to 8. From viewpoints of liquid crystal properties, availability of raw materials, ease of synthesis, kz preferably represents an integer of 0 to 4, more preferably represents an integer of 0 to 2, even more preferably represents 0 or 1, and particularly preferably represents 1. mz1 and mz2 each independently represent an integer of 0 to 5 and mz1+mz2 represents an integer of 1 to 5. From viewpoints of liquid crystal properties, ease of synthesis, and storage stability, mz1 and mz2 preferably each independently represent an integer of 1 to 4, more preferably each independently represent an integer of 1 to 3, and particularly preferably represent 1 or 2. mz1+mz2 preferably represents an integer of 1 to 4 and particularly preferably represents 2 or 3), and more preferably represents a compound selected from General Formula (I-z1-A) to General Formula (I-z1-D).

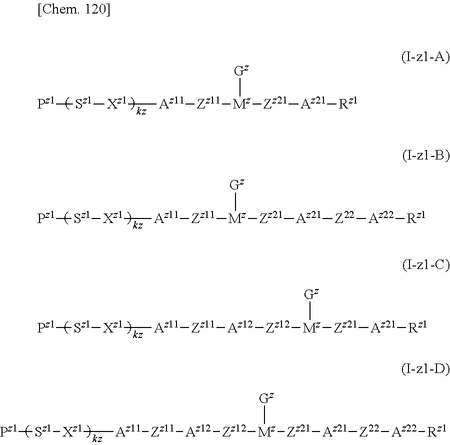

(In the formulae, P^{z1}, S^{z1}, X^{z1}, kz, M^{z}, G^{z}, and R^{z1} represent the same meaning as those in General Formula (I-z1), A^{z11} and A^{z12} each independently represent the same meaning as A^{z1} in General Formula (I-z1), Z^{z11} and Z^{z12} each independently represent the same meaning as Z^{z1} in General Formula (I-z1), A^{z21} and A^{z22} each independently represent the same meaning as A^{z2} in General Formula (I-z1), and Z^{z21} and Z^{z22} each independently represent the same meaning as Z^{z2} in General Formula (I-z1).) From viewpoints of balance between refractive index anisotropy and reverse dispersibility, A^{z11} in General Formula (I-z1-A) and General Formula (I-z1-B) more preferably represents 1,4-phenylene group which may be unsubstituted or substituted with the substituent L, A^{z11} in General Formula (I-z1-C) and General Formula (I-z1-D) represents a 1,4-phenylene group which may be unsubstituted or substituted with the substituent L, A^{z12} more preferably represents a 1,4-cyclohexylene group which may be unsubstituted or substituted with the substituent L. In addition, A^{z21} in General Formula (I-z1-A) to General Formula (I-z1-D) represents a 1,4-phenylene group or a 1,4-cyclohexylene group which may be unsubstituted or substituted with the substituent L, and A^{z22} more preferably represents a 1,4-cyclohexylene group which may be unsubstituted or substituted with the substituent L. In General Formula (I-z1-A) to General Formula (I-z1-D), from viewpoints of liquid crystal properties, ease of synthesis, and storage stability, a compound represented by General Formula (I-z1-A) to General Formula (I-z1-C) is more preferable and a compound represented by General Formula (I-z1-A) or General Formula (I-z1-C) is particularly preferable. In a case where it is necessary to obtain a higher transition temperature T_{NI} from a nematic phase to an isotropic phase, a compound represented by General Formula (I-z1-C) is particularly preferable.

From viewpoints of reverse dispersibility, solubility in a solvent, ease of synthesis, availability of raw materials, and liquid crystal properties, even more specifically, a compound represented by General Formula (I-z1) even more preferably represents a compound selected from General Formula (I-z1-A-1) to General Formula (I-z1-D-2).

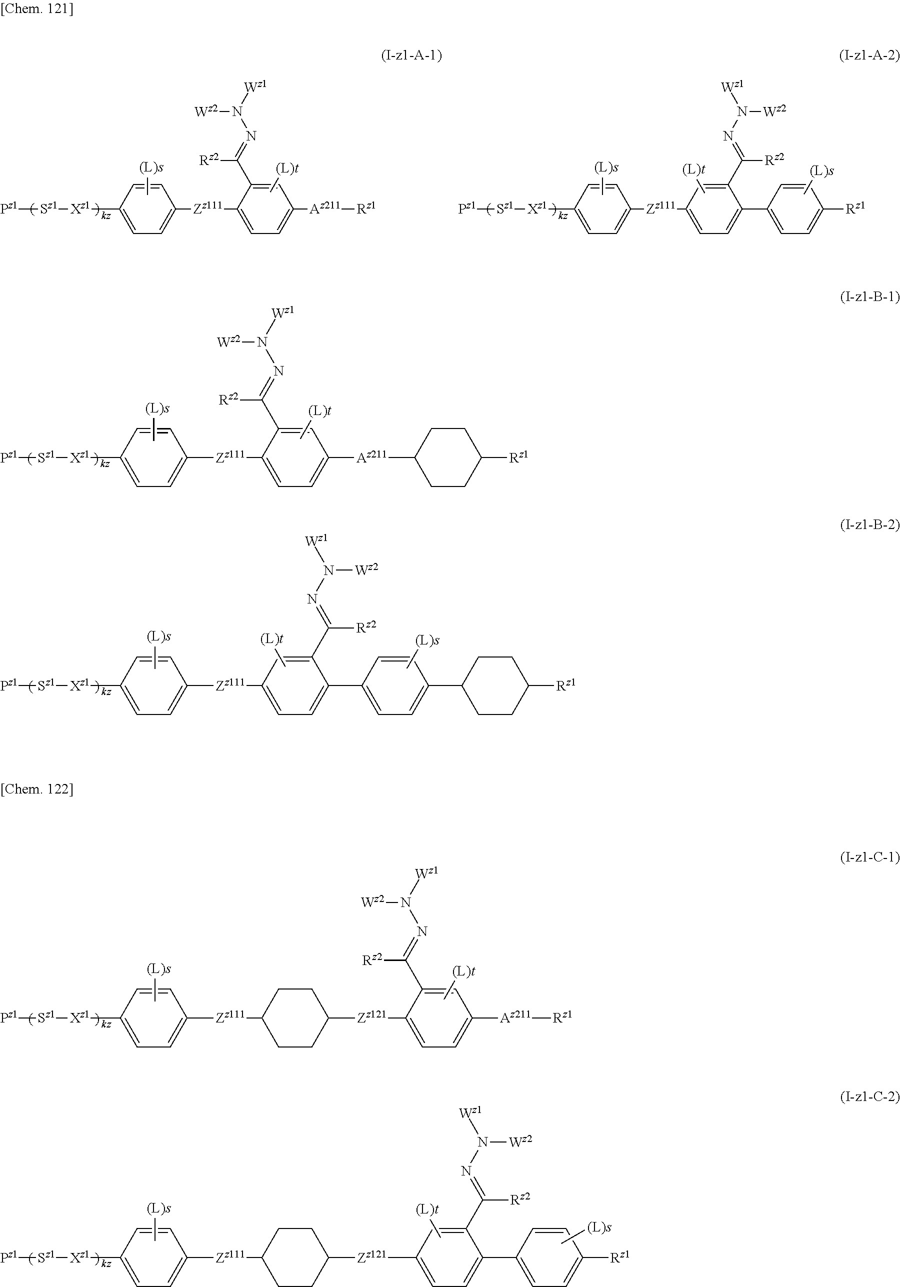

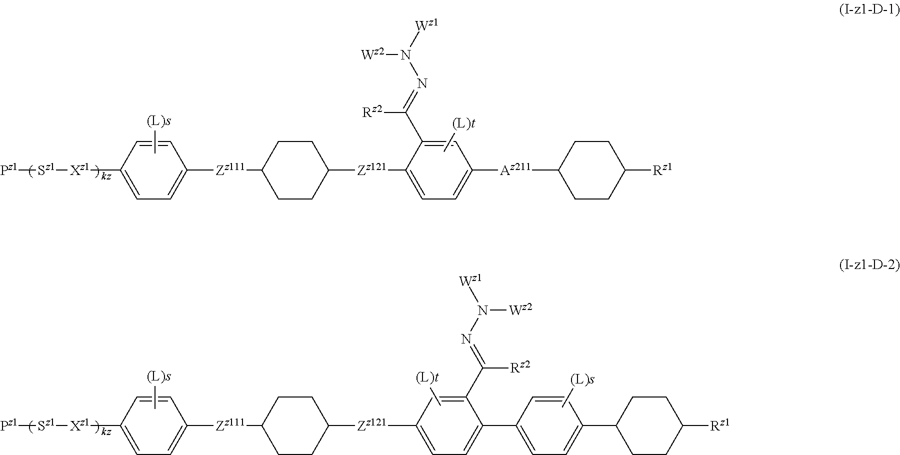

(In the formulae, P^{z1}, S^{z1}, X^{z1}, kz, L, R^{z2}, W^{z1}, W^{z2}, and R^{z1} represent the same meaning as those in General Formula (I-z1), s represents an integer of 0 to 4, t represents an integer of 0 to 3, A^{z211} represents the same meaning as A^{z2} in General Formula (I-z1), and Z^{z111} and Z^{z121} each independently represent the same meaning as Z^{z1} in General Formula (I-z1). The preferable structure of each group is the same as that in General Formula (I-z1).) In General Formula (I-z1-A-1) to General Formula (I-z1-D-2), from viewpoints of liquid crystal properties, ease of synthesis, and storage stability, a compound represented by General Formula (I-z1-A-1) to General Formula (I-z1-C-2) is more preferable and a compound represented by General Formula (I-z1-A-1), General Formula (I-z1-A-2), General Formula (I-z1-C-1), or General Formula (I-z1-C-2) is particularly preferable. In a case where it is necessary to obtain reverse wavelength dispersibility of a short wavelength side, a compound represented by General Formula (I-z1-A-1) or General Formula (I-z1-C-1) is particularly preferable. In a case where it is necessary to obtain balance between reverse wavelength dispersibility and refractive index anisotropy, a compound represented by General Formula (I-z1-A-2) or General Formula (I-z1-C-2) is particularly preferable. In a case where it is necessary to obtain a higher transition temperature T_{NI} from a nematic phase to an isotropic phase, a compound represented by General Formula (I-z1-C-1) or General Formula (I-z1-C-2) is particularly preferable. In a case where it is necessary to obtain reverse wavelength dispersibility of a long wavelength side, a compound represented by General Formula (I-z1-C-1) is particularly preferable.

In addition, W^{z1} particularly preferably represents a group selected from Formula (W-a-1) to Formula (W-a-6).

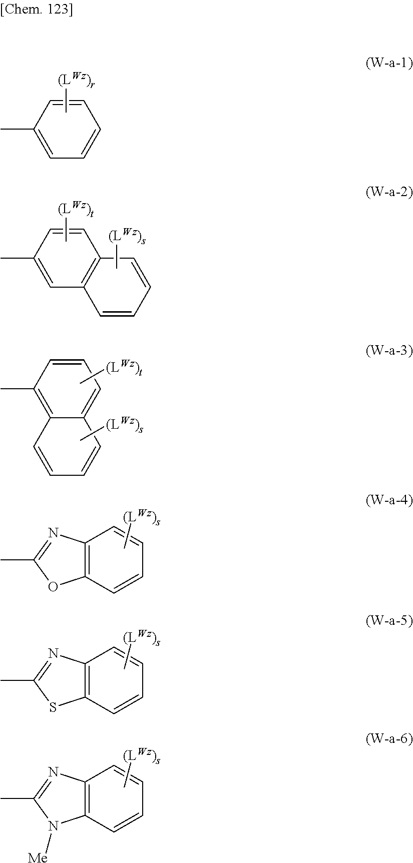

(In the formulae, r represents an integer of 0 to 5, s represents an integer of 0 to 4, and t represents an integer of 0 to 3.)

In addition, R^{z2} is more preferably a hydrogen atom or an alkyl group having 1 to 6 carbon atoms which is not substituted or substituted with one or more of F, and particularly preferably a hydrogen atom.

Further, in a case of significantly considering reverse dispersibility and liquid crystal properties, W^{z2} is preferably a hydrogen atom.

In a case of significantly considering a degree how hardly a change in quality occurs, in a case the compound is dissolved in an organic solvent and stored for a long period of time, a degree how hardly a change in quality occurs, in a case the compound is added to the composition and stored for a long period of time, or stability of a phase difference in a case where a film is obtained, W^{z2} preferably represents a linear or branched alkyl group having 1 to 20 carbon atoms, in which one or more of arbitrary hydrogen atoms in the group may be substituted with a fluorine atom and one —CH₂— or two or more of (—CH₂—)'s that are not adjacent to each other may be each independently substituted with —O—, —CO—, —COO—, or —OCO—, or a group represented by —(X^{z4}—S^{z4})_{kz}—P^{z4} (in the formula, P^{z4} represents the same meaning as P^{z1}, and S^{z4} represents the same meaning as S^{z1}, and X^{z4} represents the same meaning as X^{z1}). Among the groups described above, W² more preferably represents a linear alkyl group having 1 to 12 carbon atoms in which one —CH₂— or two or more of (—CH₂—)'s that are not adjacent to each other may be each independently substituted with —O—, or a group represented by —(X^{z4}—S^{z4})_{kz}—P^{z4}. More specifically, from a viewpoint of ease of synthesis, W^{z2} more preferably represents a linear or branched alkyl group having 1 to 20 carbon atoms in which one —CH₂— or two or more of (—CH₂—)'s that are not adjacent to each other may be each independently substituted with —O—, or a group represented by —(X^{z4}—S^{z4})_{kz}—P^{z4}, and even more preferably represents a linear alkyl group having 1 to 12 carbon atoms in which one —CH₂— or two or more of (—CH₂—)'s that are not adjacent to each other may be each independently substituted with —O—, or a group represented by —(X^{z4}—S^{z4})_{kz}—P^{z4}.

In a case of significantly considering balance between reverse dispersibility, high refractive index anisotropy, and high liquid crystal properties, in a case where the compound is added to the composition, a degree how hardly a change in quality occurs, in a case the compound is dissolved in an organic solvent and stored for a long period of time, a degree how hardly a change in quality occurs, in a case the compound is added to the composition and stored for a long period of time, or stability of a phase difference in a case where a film is obtained, W^{z2} is preferably a compound represented by General Formula (I-z2).

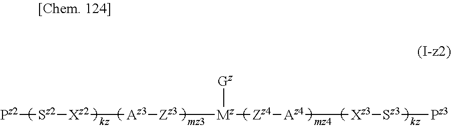

(In the formula, kz, M^{z}, and G^{z} represent the same meaning as those in General Formula (I-z1), P^{z2} and P^{z3} each independently represent the same meaning as P^{z1} in General Formula (I-z1), S^{z2} and S^{z3} each independently represent the same meaning as S^{z1} in General Formula (I-z1), X^{z2} and X^{z3} each independently represent the same meaning as X^{z1} in General Formula (I-z1), A^{z3} and A^{z4} each independently represent the same meaning as A^{z1} and A^{z2} in General Formula (I-z1), Z^{z3} and Z^{z4} each independently represent the same meaning as Z^{z1} and Z^{z2} in General Formula (I-z1), mz3 and mz4 each independently represent an integer of 0 to 5, and mz3+mz4 represents an integer of 1 to 5). In a case of significantly considering balance between reverse dispersibility, high refractive index anisotropy, and high liquid crystal properties, when the compound is added to the composition, W^{z2} is preferably General Formula (I-z2-A) and General Formula (I-z2-B).

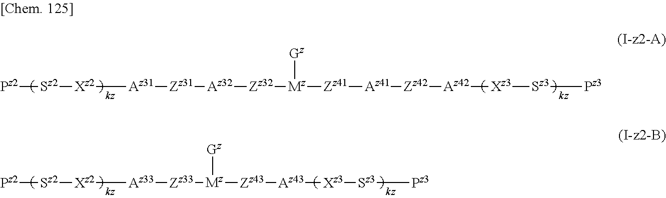

(In the formulae, P^{z2}, P^{z3}, S^{z2}, S^{z3}, M^{z}, and G^{z} represent the same meaning as those in General Formula (I-z2), A^{z31}, A^{z42}, A^{z33}, and A^{z43} each independently represent a 1,4-phenylene group, the group may be unsubstituted or substituted with one or more of substituents L^{z11}. L^{z11} represents a fluorine atom, a chlorine atom, or a linear or branched alkyl group having 1 to 20 carbon atoms, in which one —CH₂— or two or more of (—CH₂—)'s that are not adjacent to each other may be each independently substituted with —O—, —CO—, —COO—, or —OCO—, and one or more of arbitrary hydrogen atoms in the alkyl group may be substituted with a fluorine atom. In a case where a plurality of L^{z11} are present in the compound, these may be the same as each other or different from each other. A^{z32} and A^{z41} represent a 1,4-cyclohexylene group, Z^{z31} and Z^{z42} each independently represent —OCH₂—, —CH₂O—, —COO—, —OCO—, or a single bond, Z^{z32}, Z^{z41}, Z^{z33}, and Z^{z43} each independently represent —OCH₂—, —CH₂O—, —COO—CH₂CH₂—, —CH₂CH₂—OCO—, —COO—, or —OCO—, and at least one of Z^{z32} and Z^{z41} and at least one of Z^{z33} and Z^{z43} represent a group selected from —OCH₂—, —CH₂O—, —COO—CH₂CH₂—, or —CH₂CH₂—OCO—.)

In a case of significantly considering balance between reverse dispersibility, high refractive index anisotropy, and high liquid crystal properties, in a case where the compound is added to the composition, a degree how hardly a change in quality occurs, in a case the compound is dissolved in an organic solvent and stored for a long period of time, a degree how hardly a change in quality occurs, in a case the compound is added to the composition and stored for a long period of time, or stability of a phase difference in a case where a film is obtained, W^{z2} is preferably a compound represented by General Formula (I-z2-A-1).

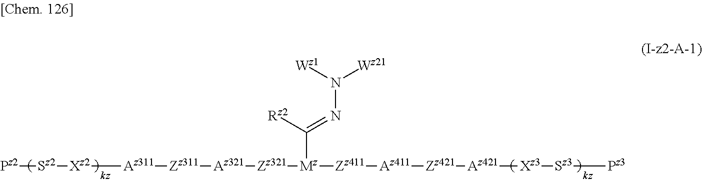

(In the formula, P^{z2}, P^{z3}, S^{z2}, S^{z3}, X^{z2}, X^{z3}, M^{z}, R^{z2}, W^{z1} represent the same meaning as those in General Formula (I-z1), A^{z311} and A^{z421} each independently represent a 1,4-phenylene group, the group may be unsubstituted or substituted with one or more of substituents L^{z11}. A^{z321} and A^{z411} represent a 1,4-cyclohexylene group, Z^{z311} and Z^{z421} each independently represent —OCH₂—, —CH₂O—, —COO—, or —OCO—, Z^{z321} and Z^{z411} each independently represent —OCH₂—, —CH₂O—, —COO—CH₂CH₂—, —CH₂CH₂—OCO—, —COO—, or —OCO—, and at least one of Z^{z321} and Z^{z411} particularly preferably represents a group selected from —OCH₂—, —CH₂O—, —COO—CH₂CH₂—, or —CH₂CH₂—OCO—. W^{z21} represents a group selected from a linear or branched alkyl group having 1 to 20 carbon atoms in which one —CH₂— or two or more of (—CH₂—)'s that are not adjacent to each other may be each independently substituted with —O—, or a group represented by —(X^{z4}—S^{z4})_{kz}—P^{z4}.) The preferable structure of W^{z1} is the same as that described above.

Specifically, the compounds represented by General Formula (I) are preferably compounds represented by the following formulae.

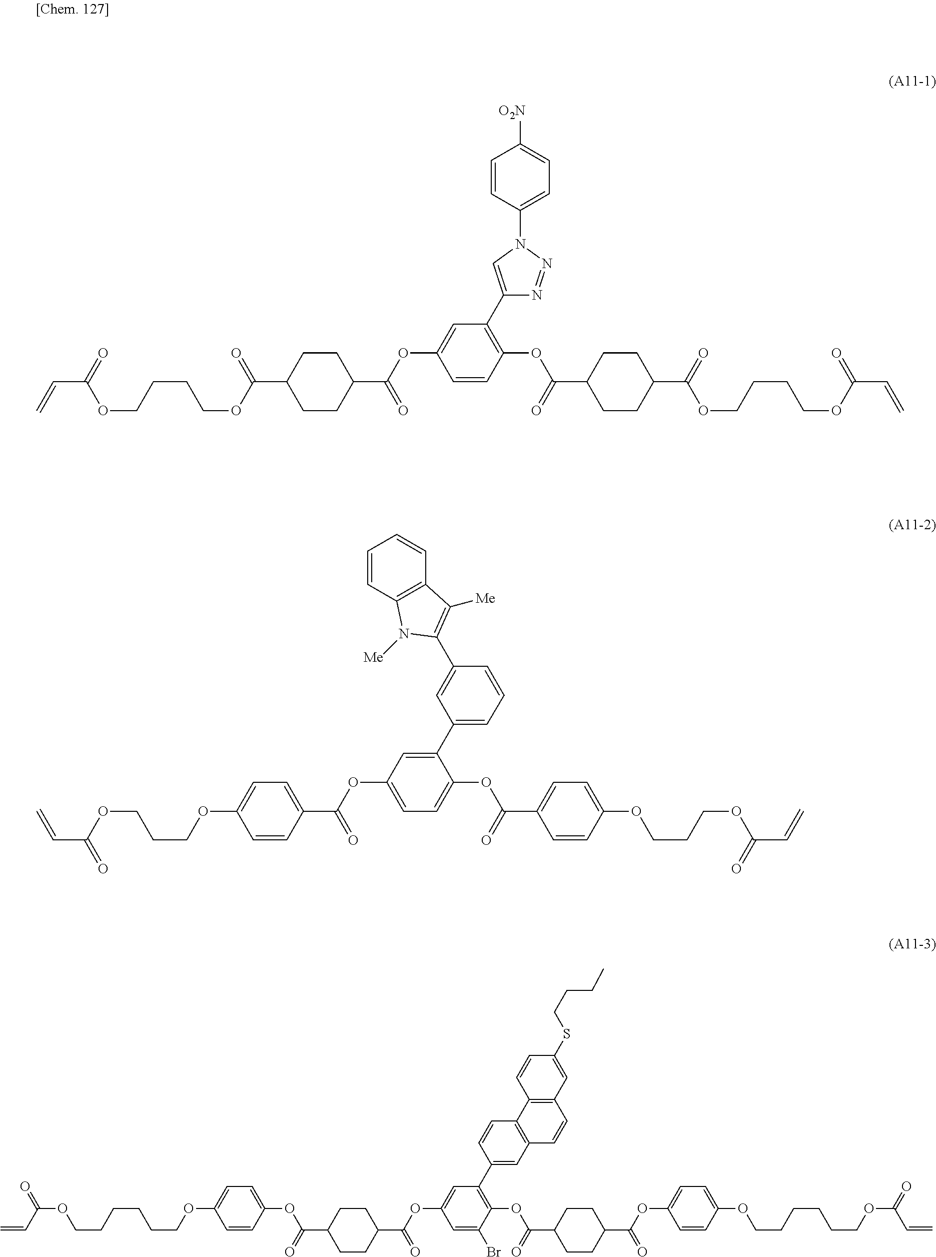

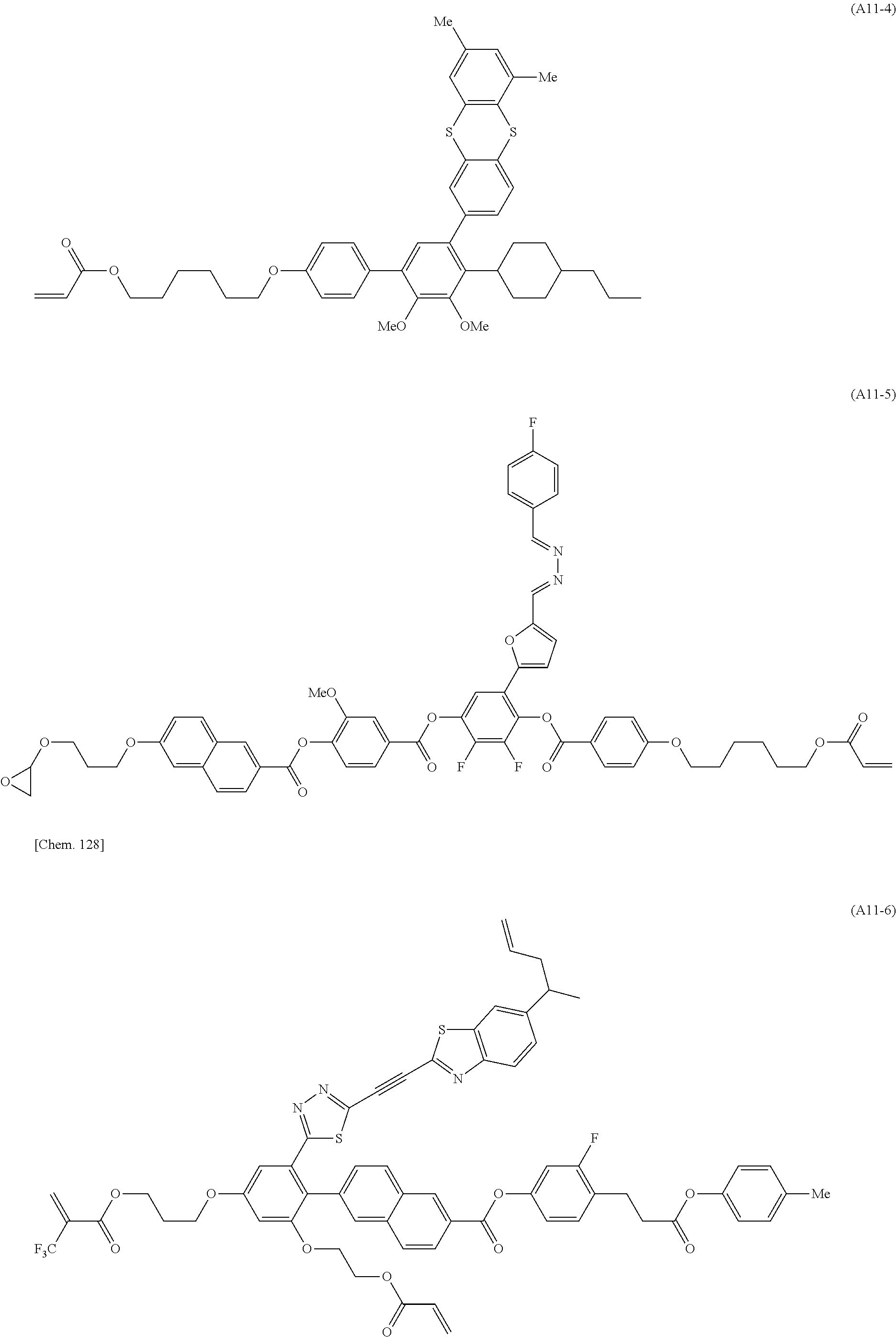

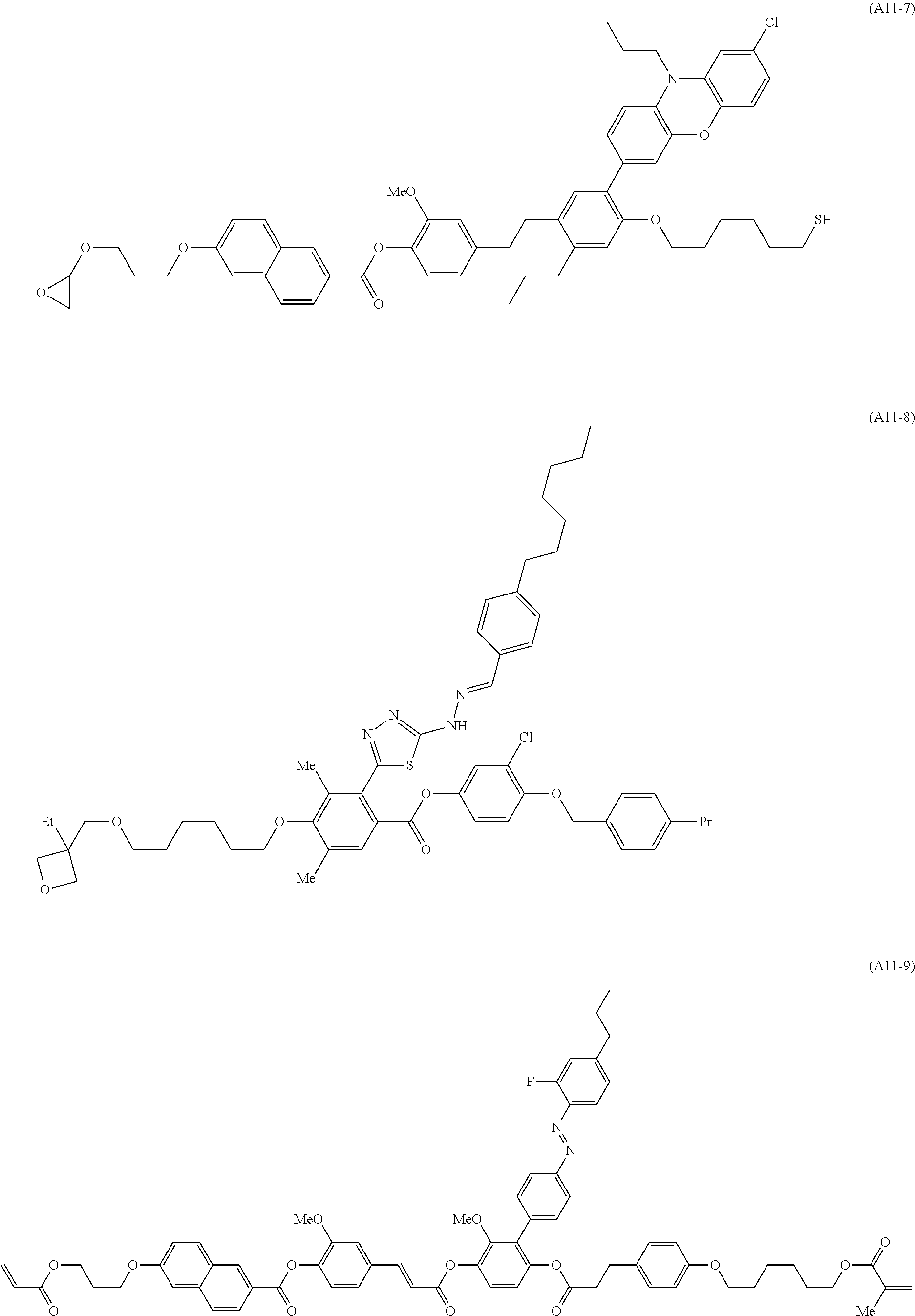

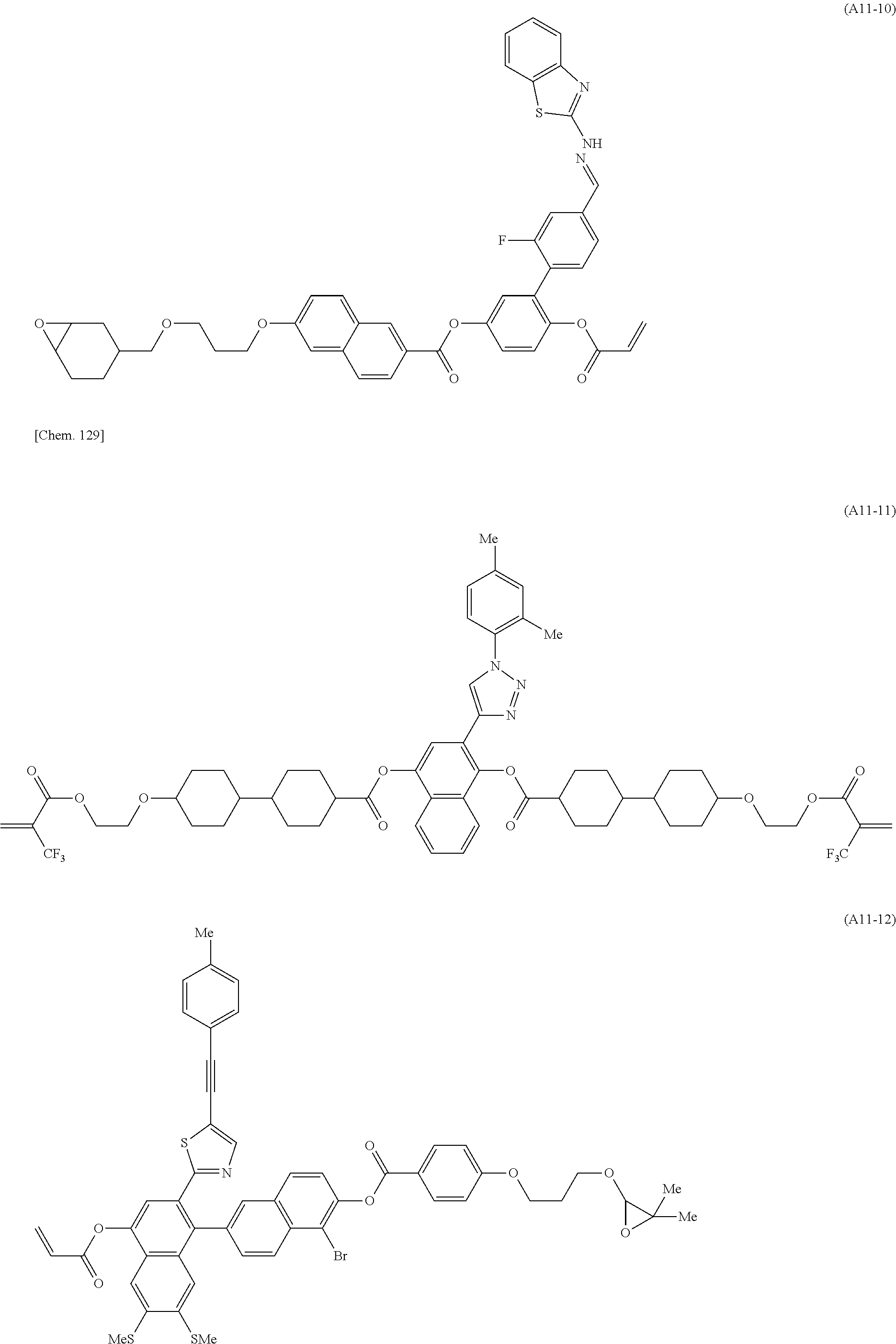

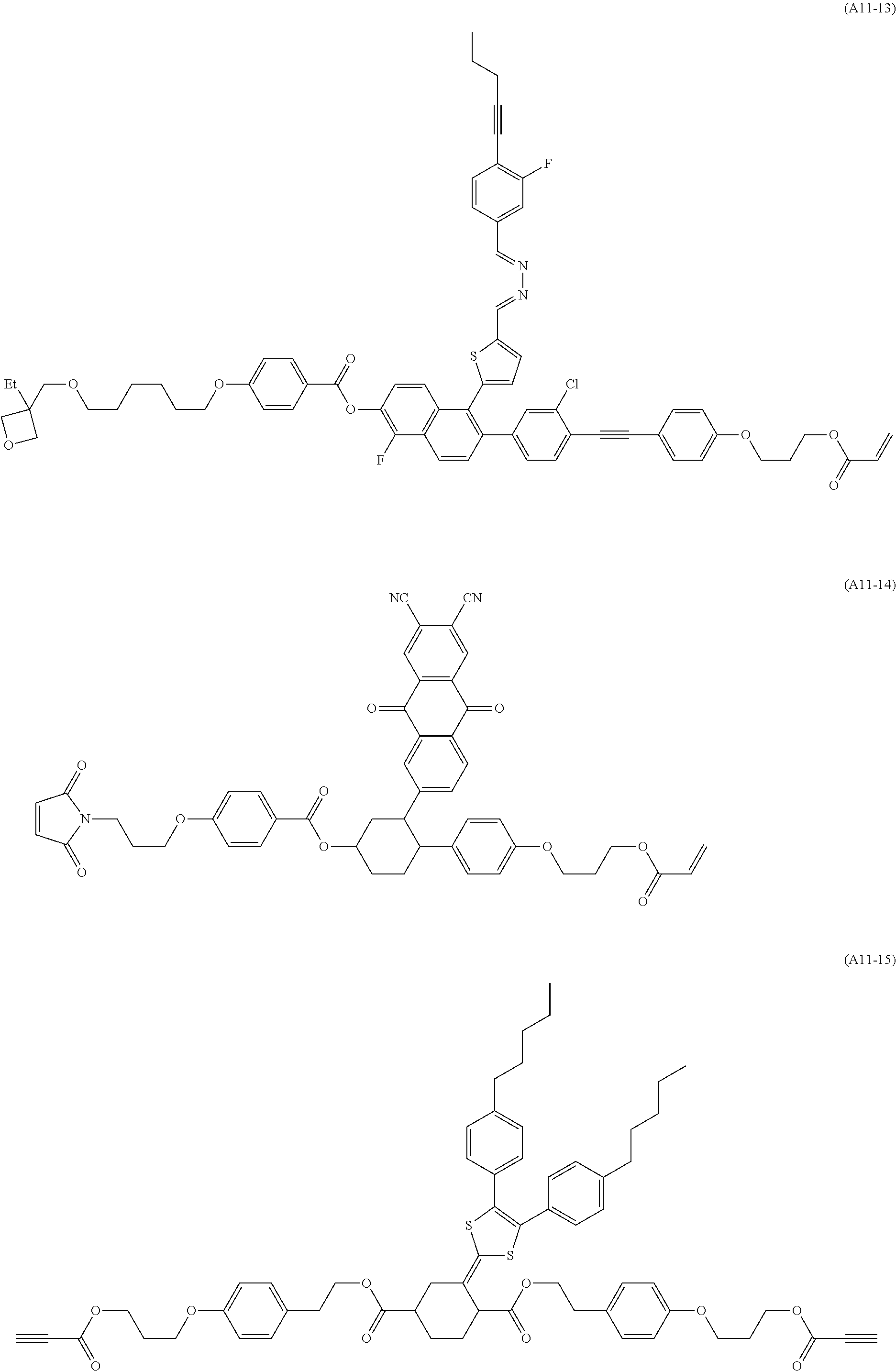

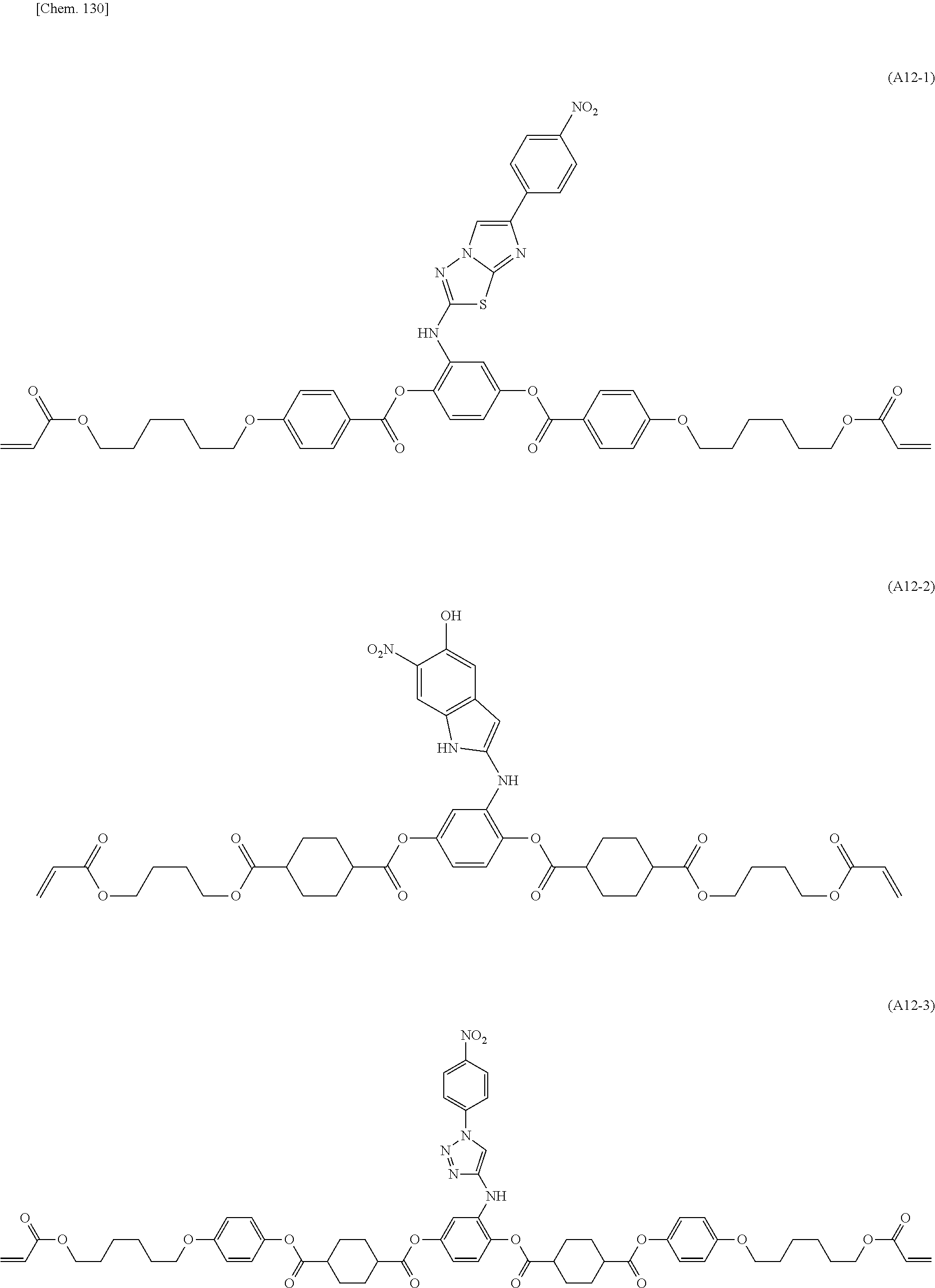

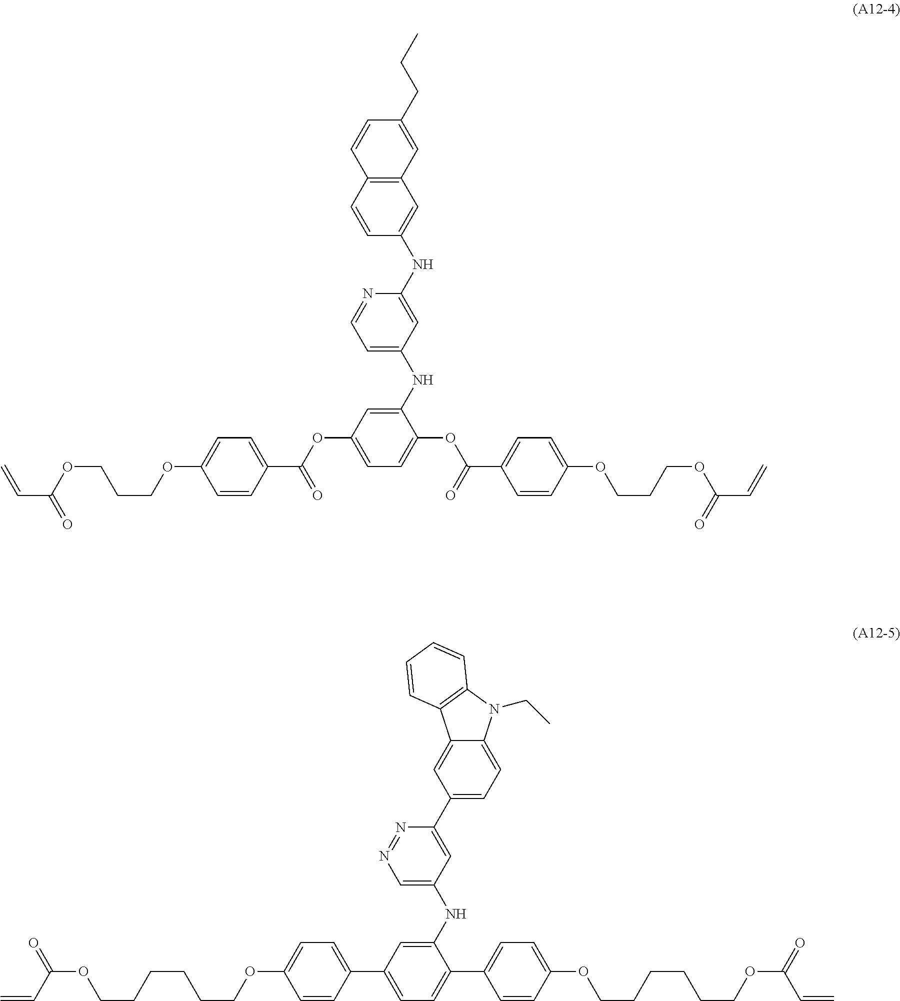

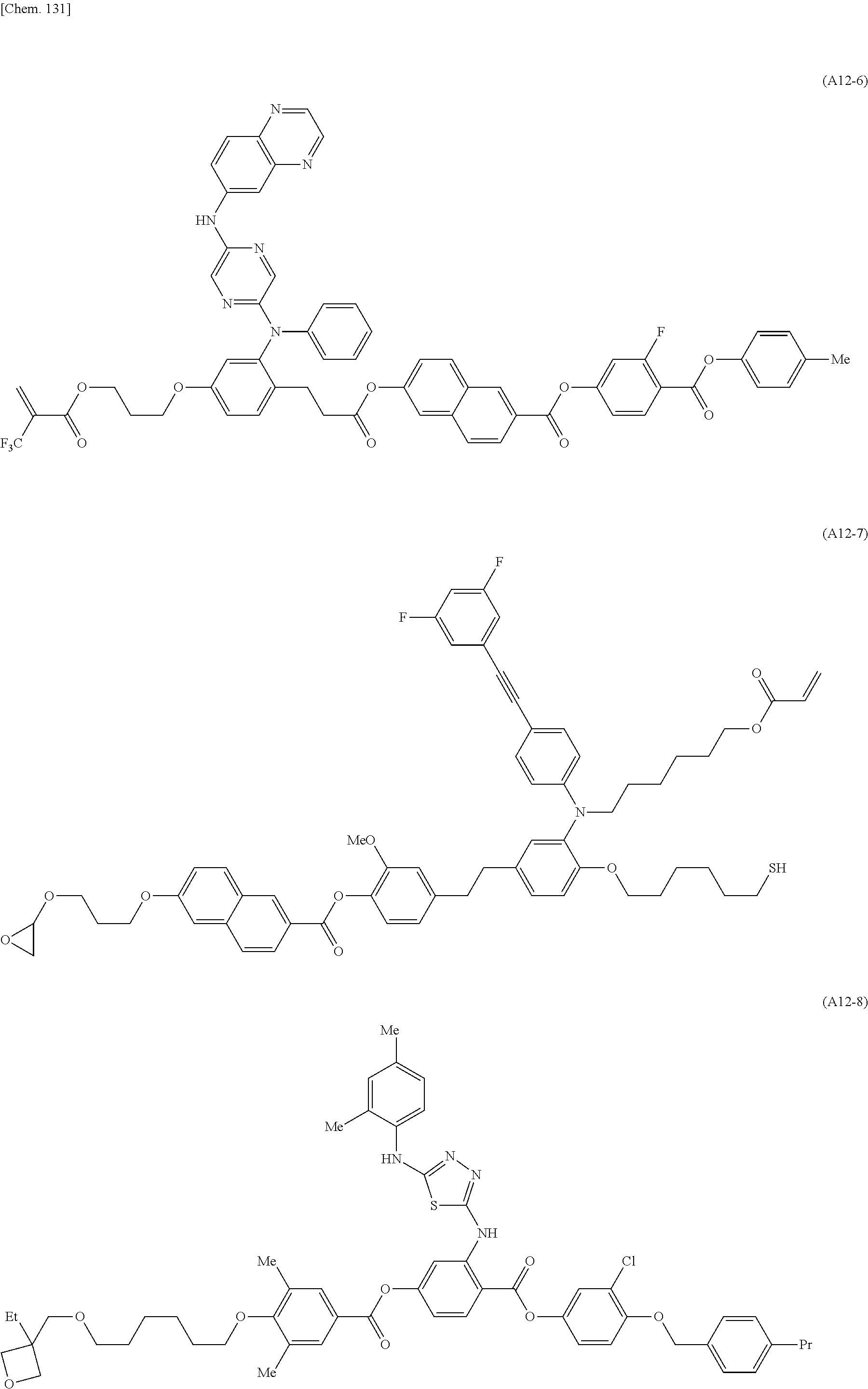

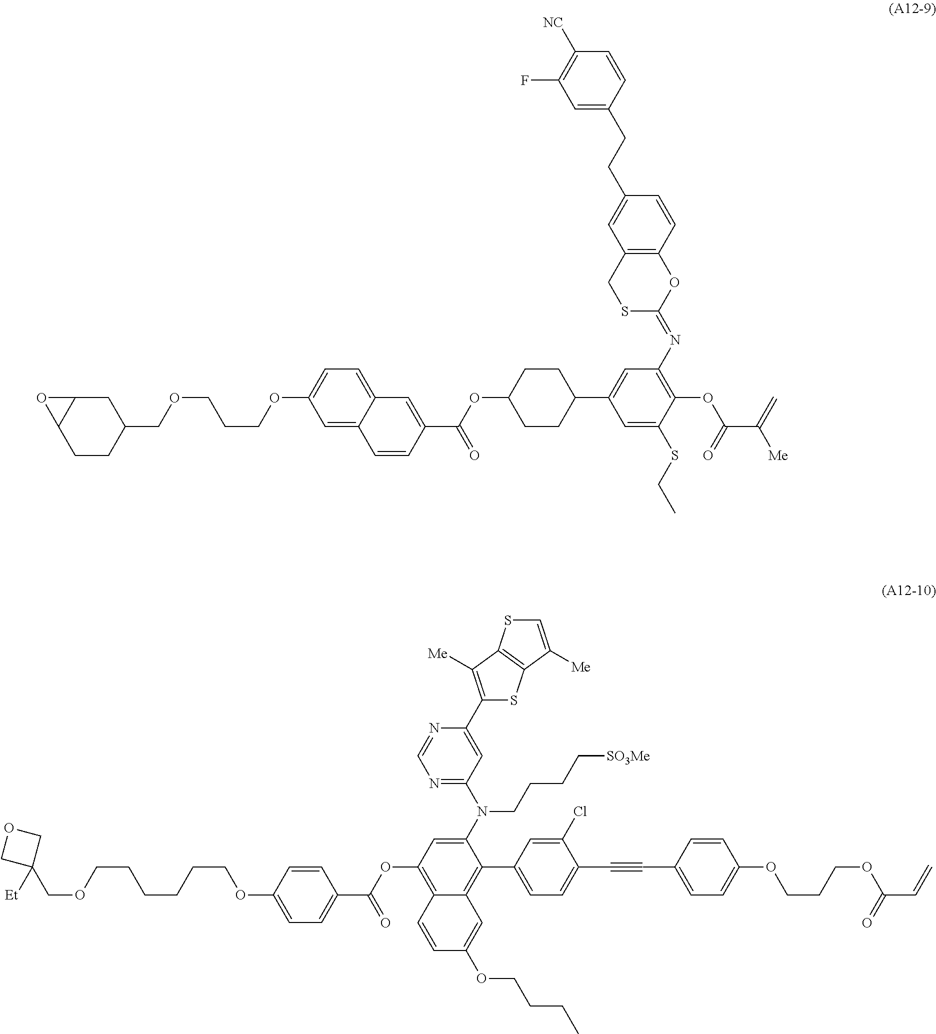

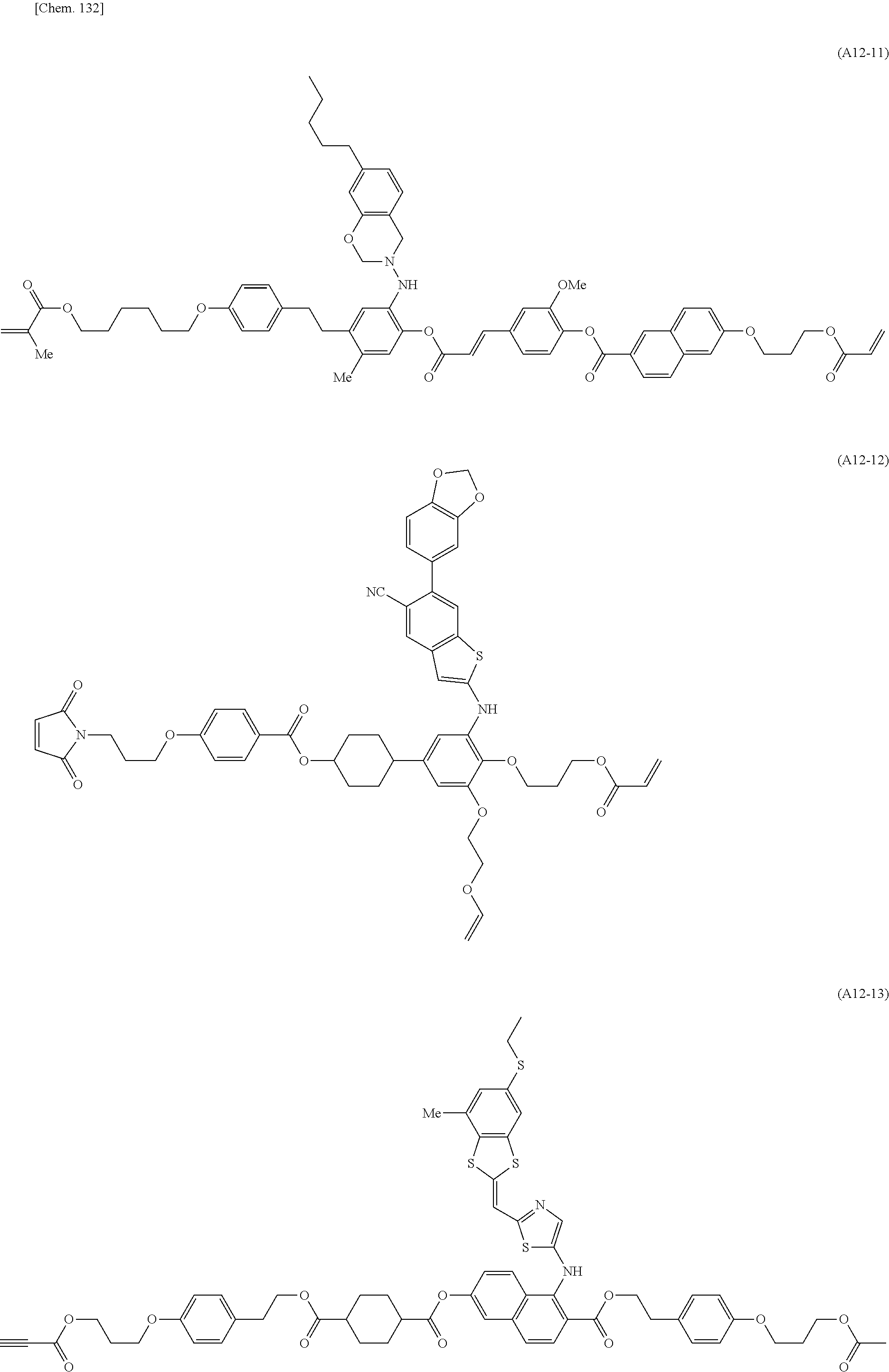

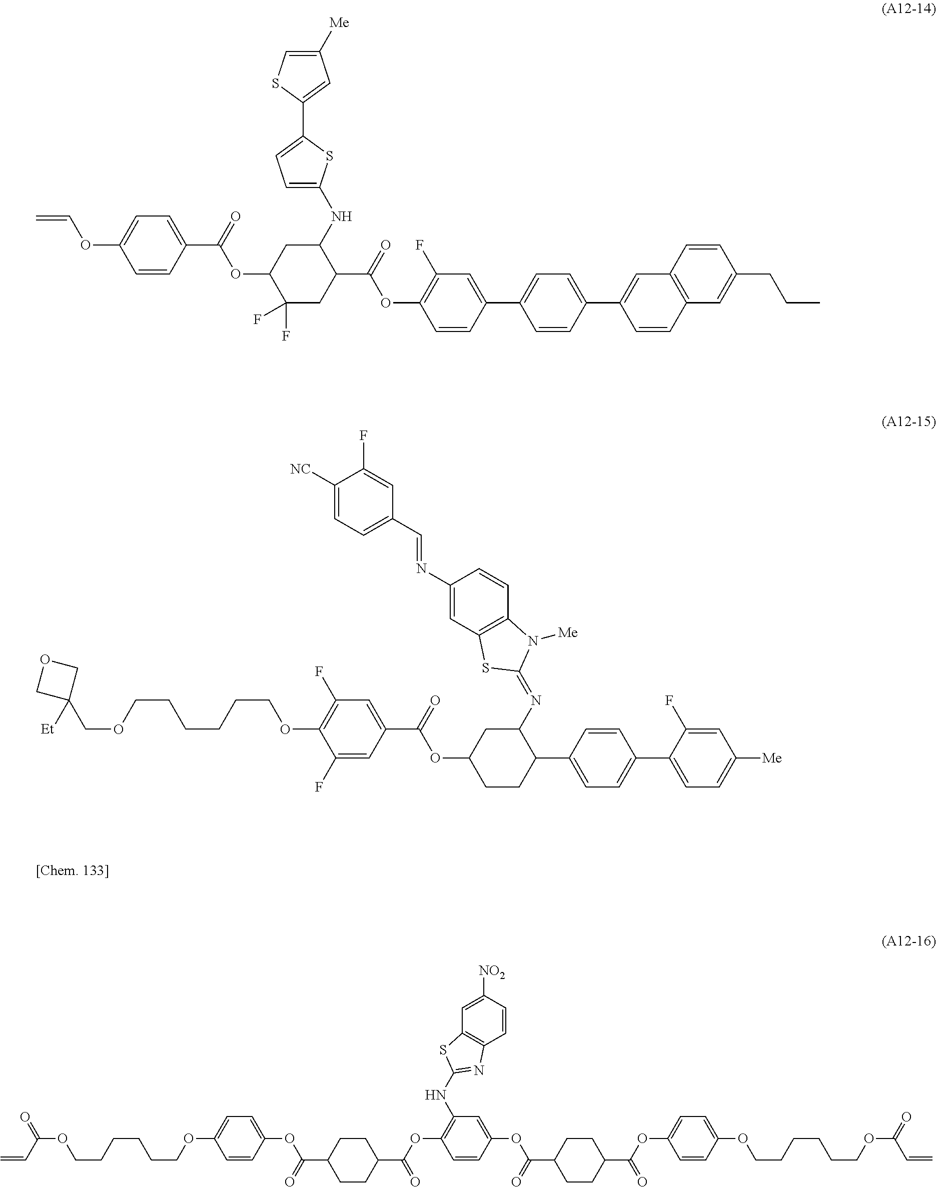

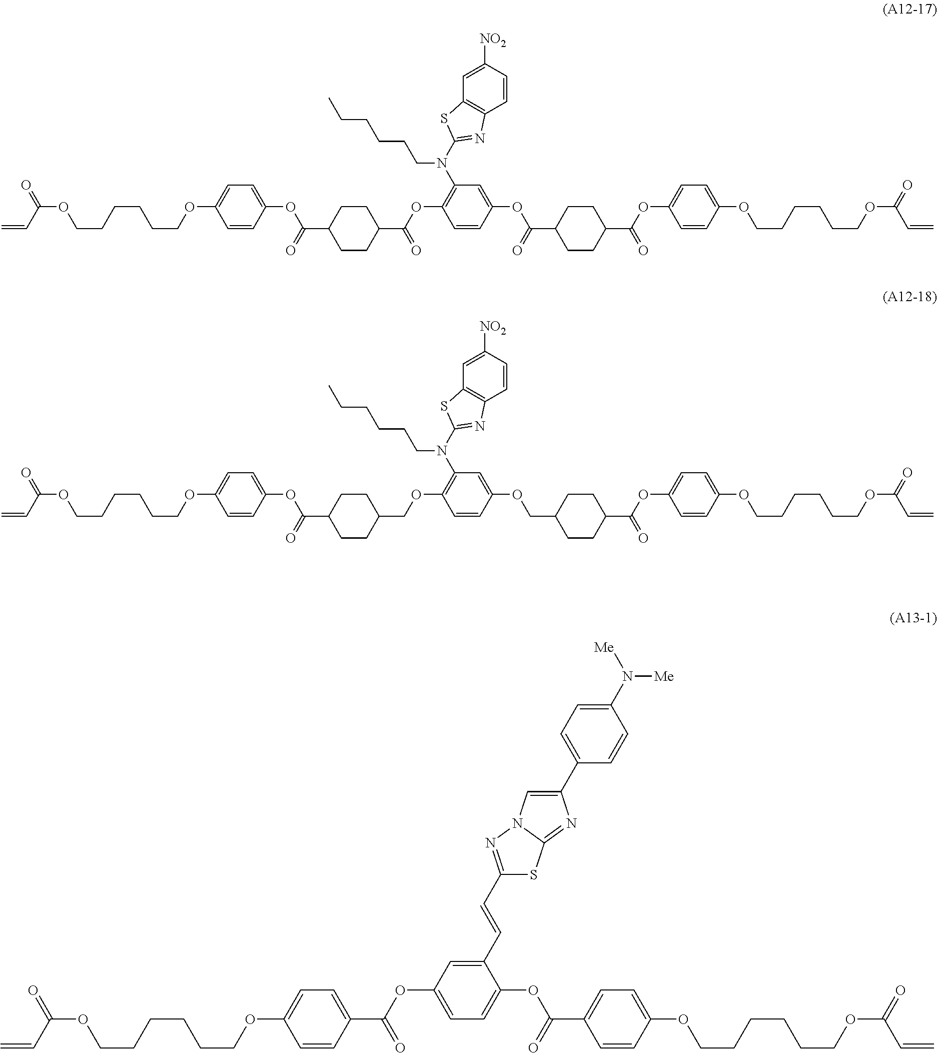

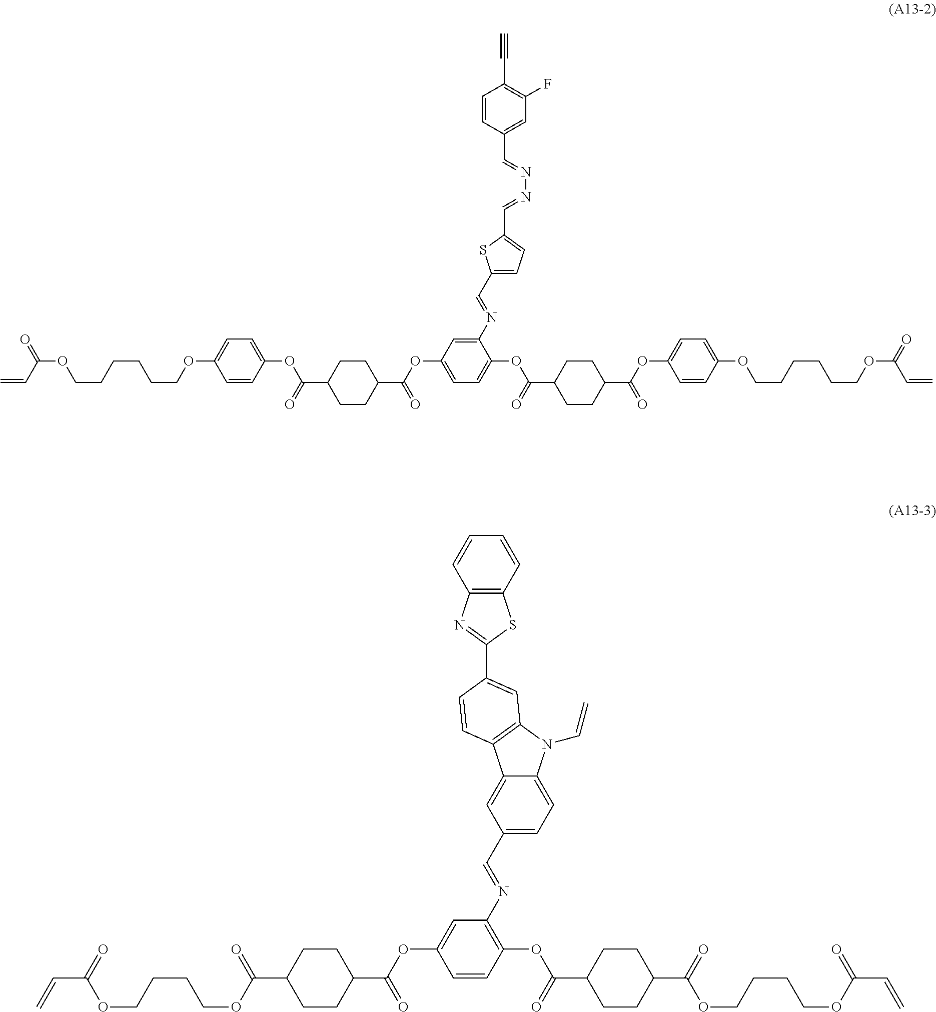

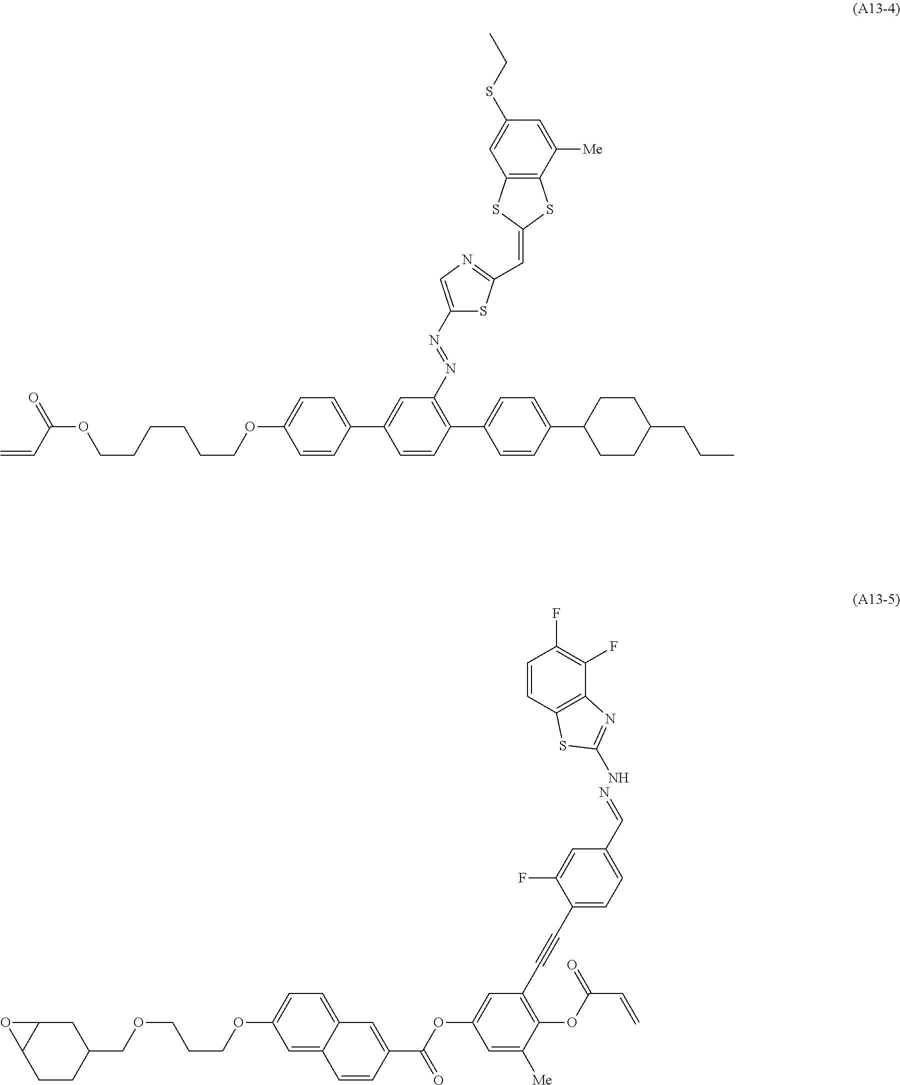

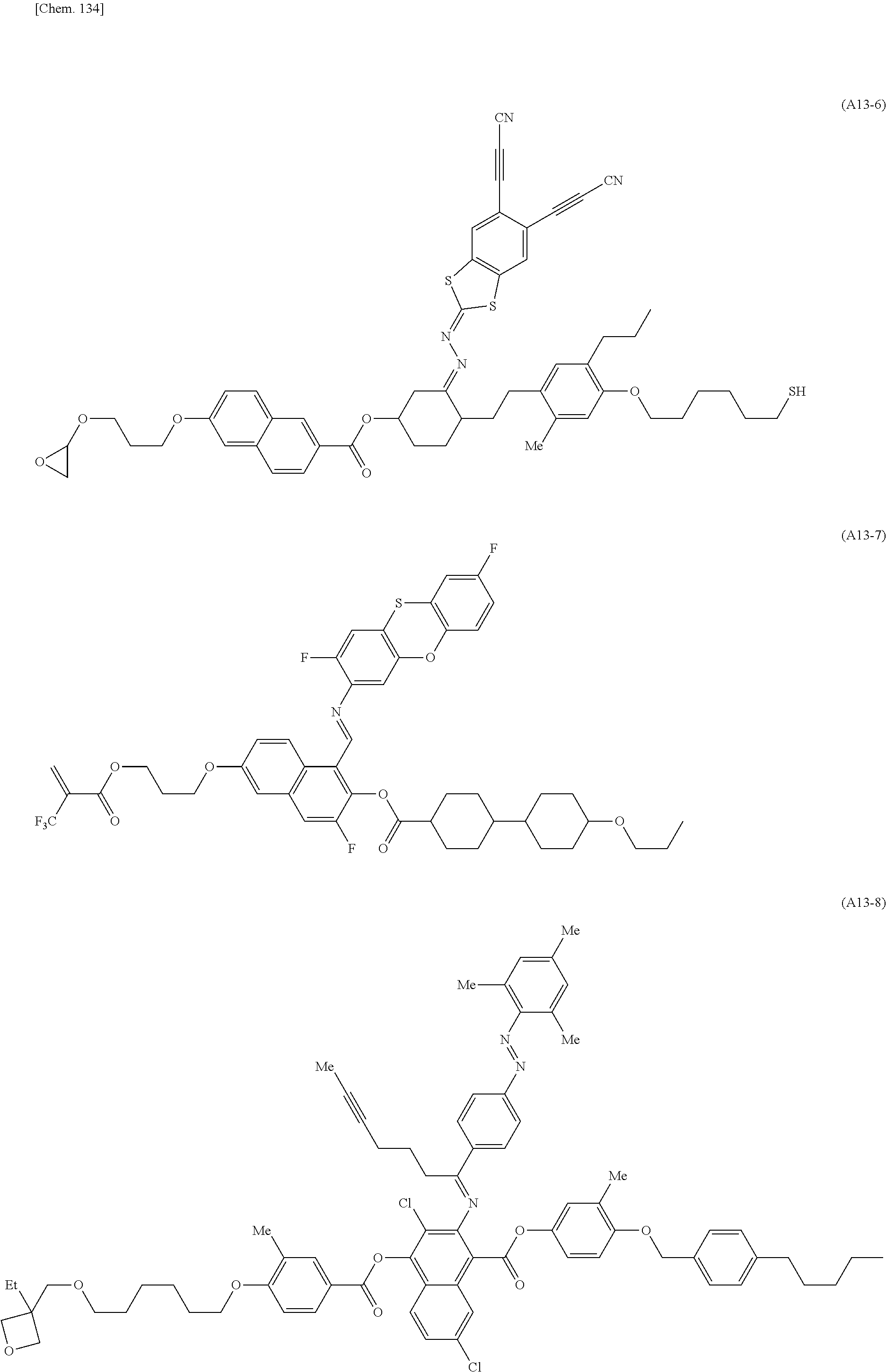

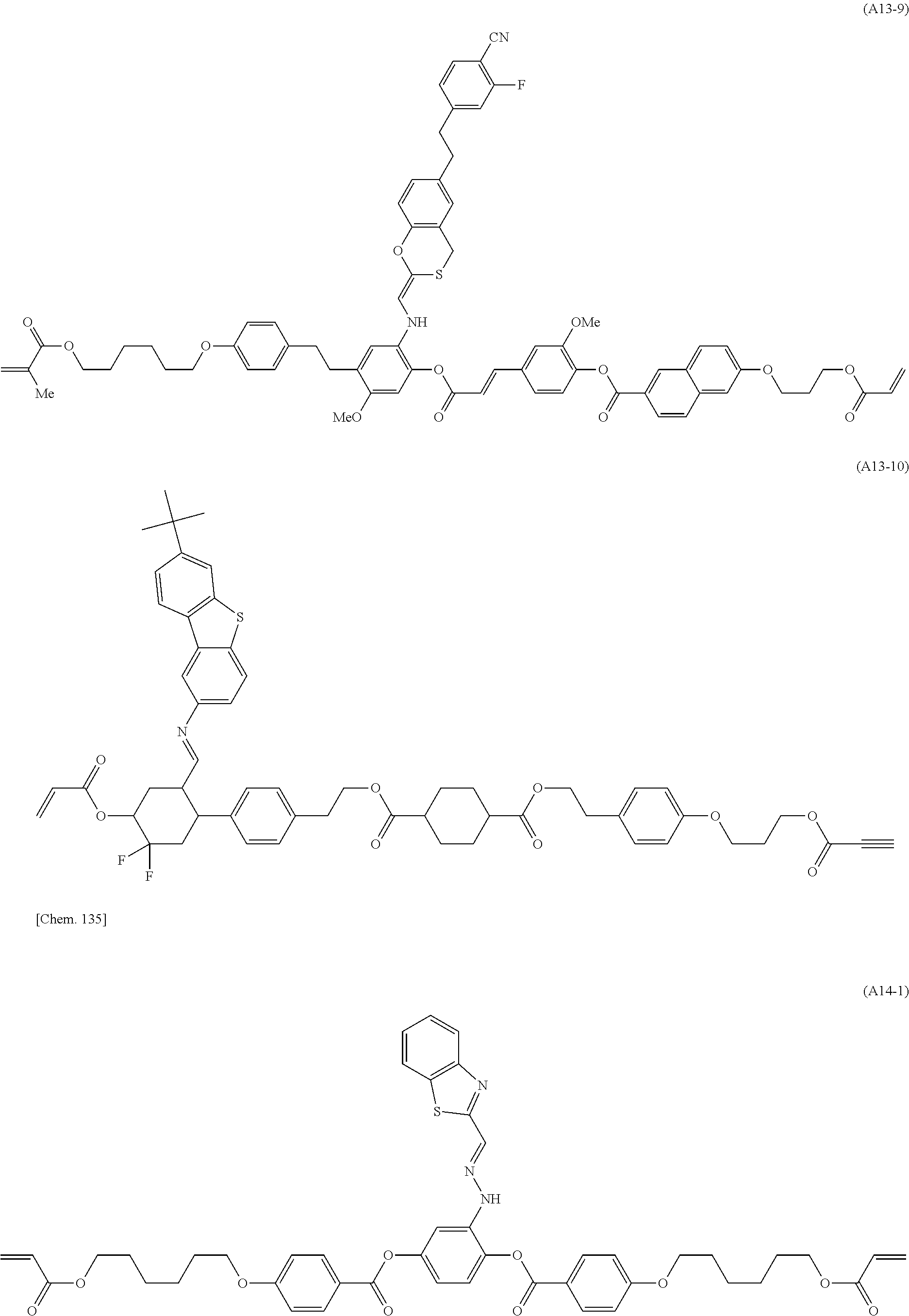

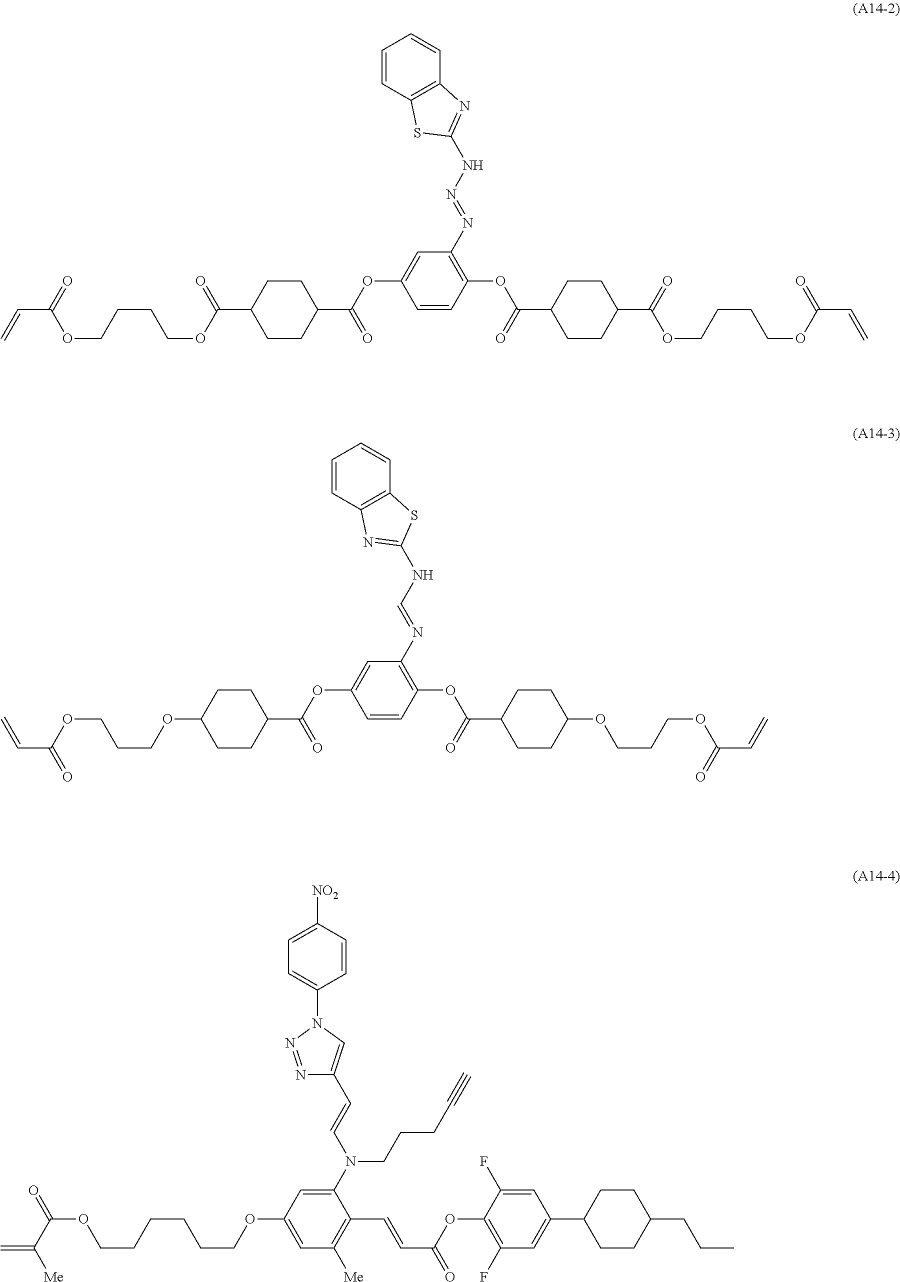

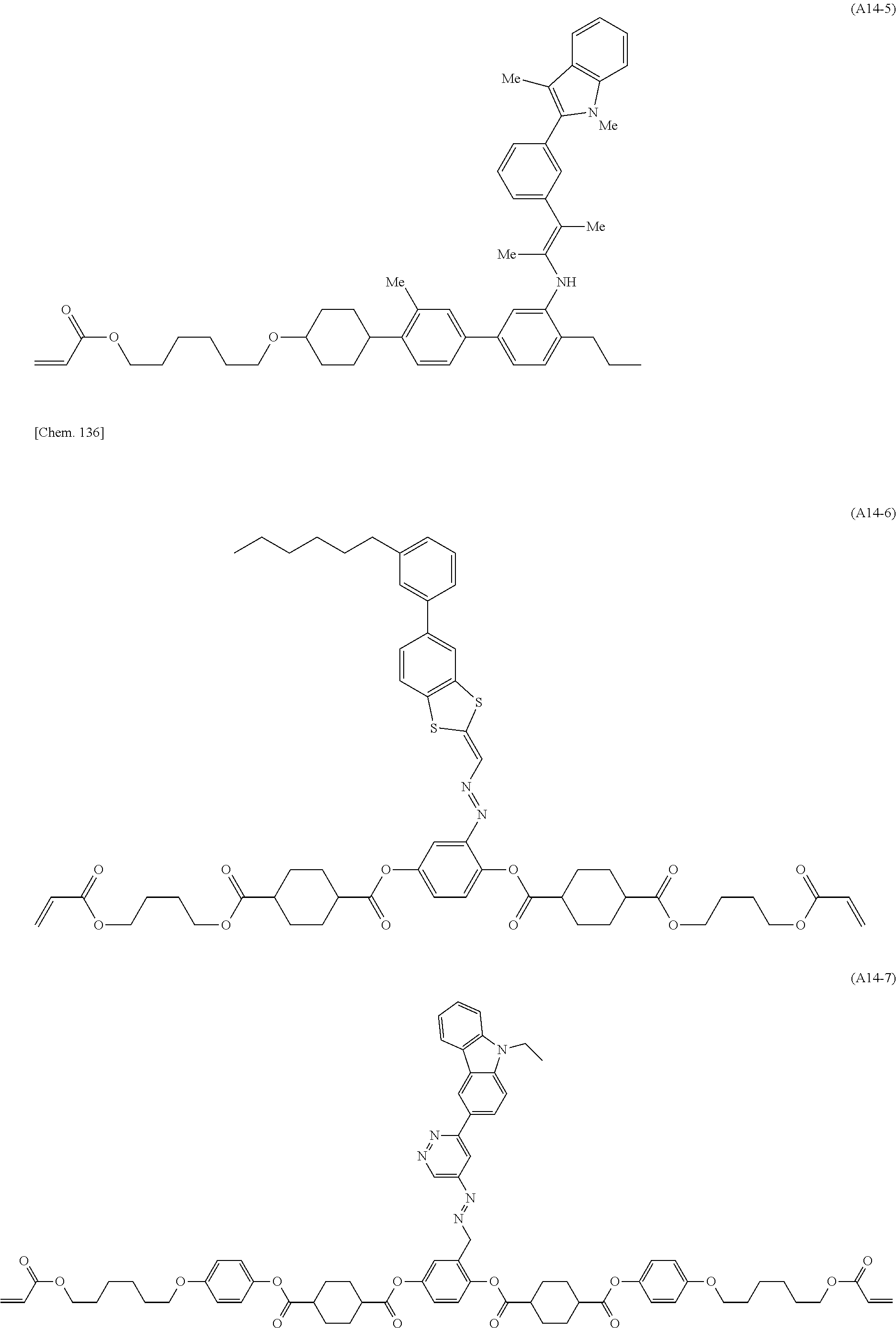

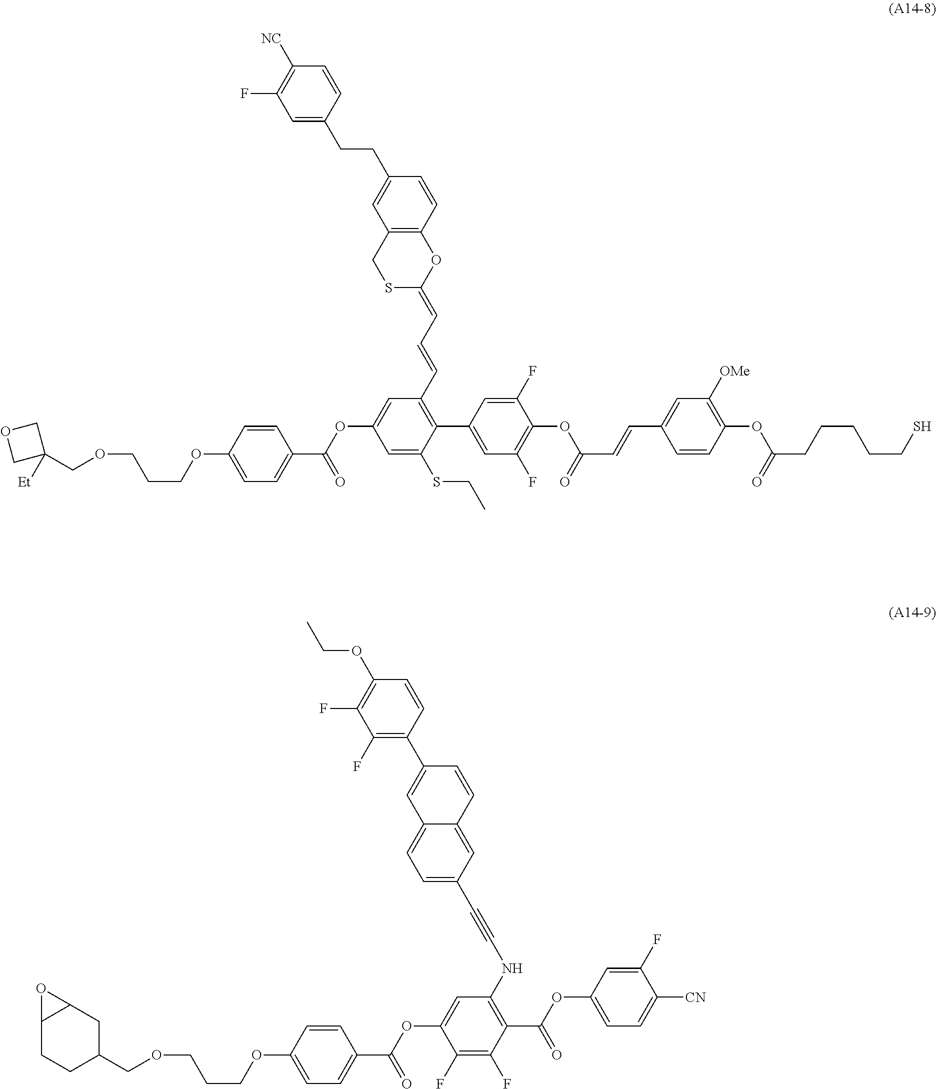

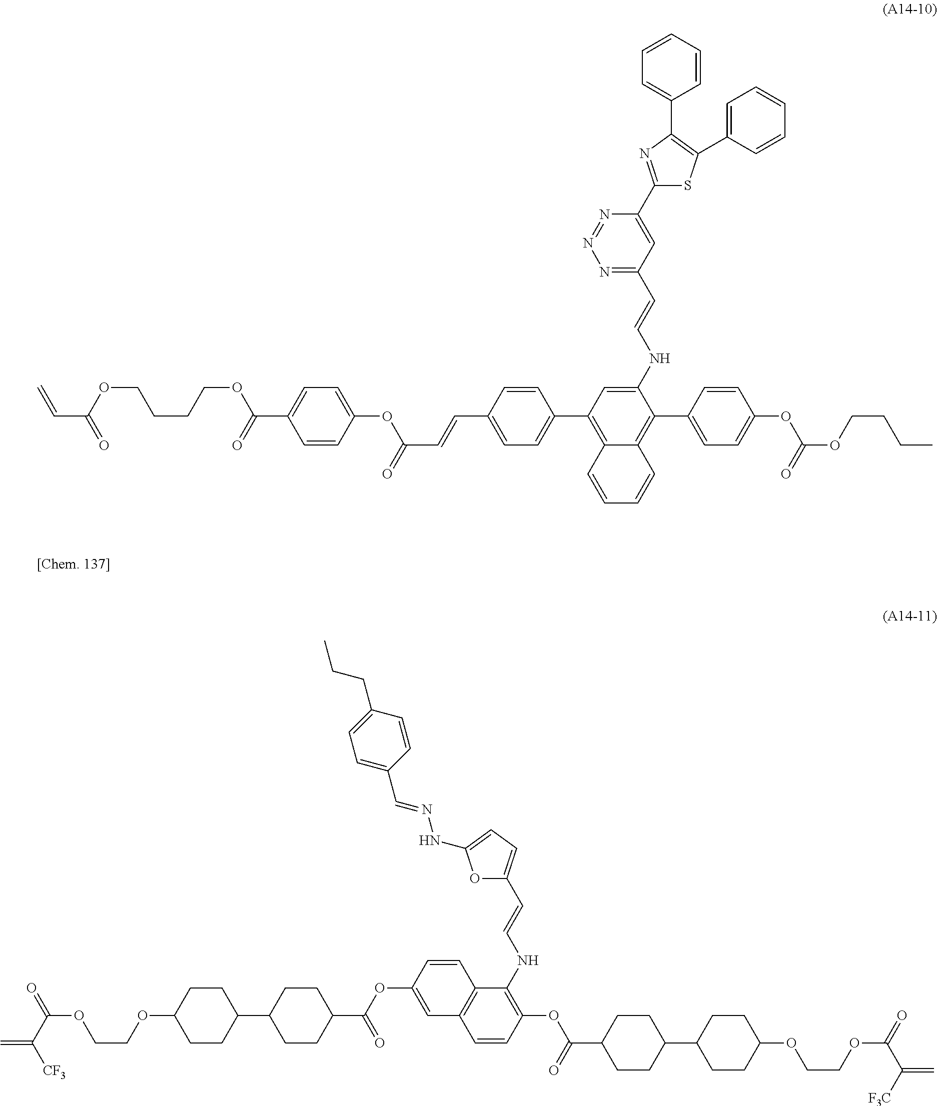

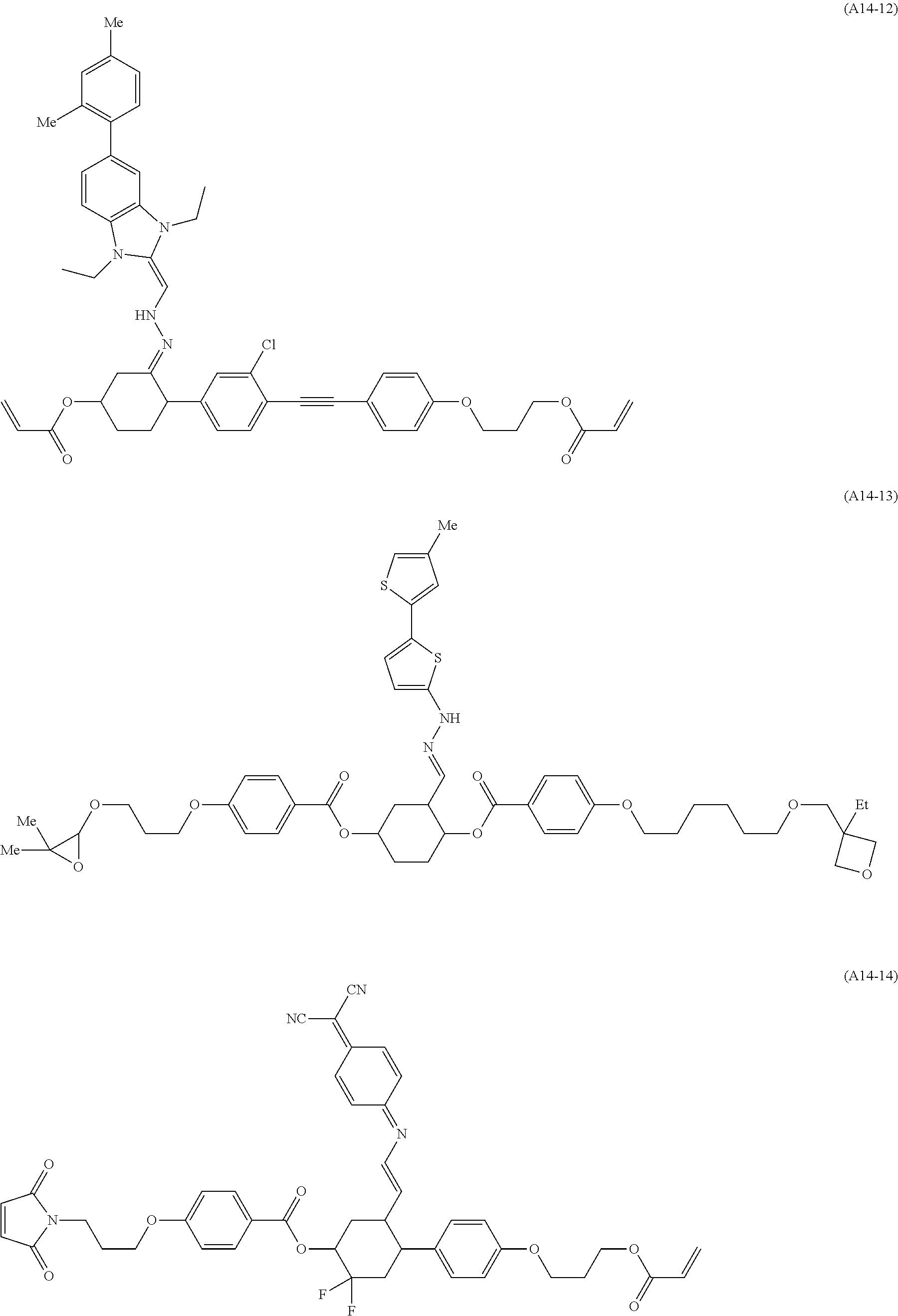

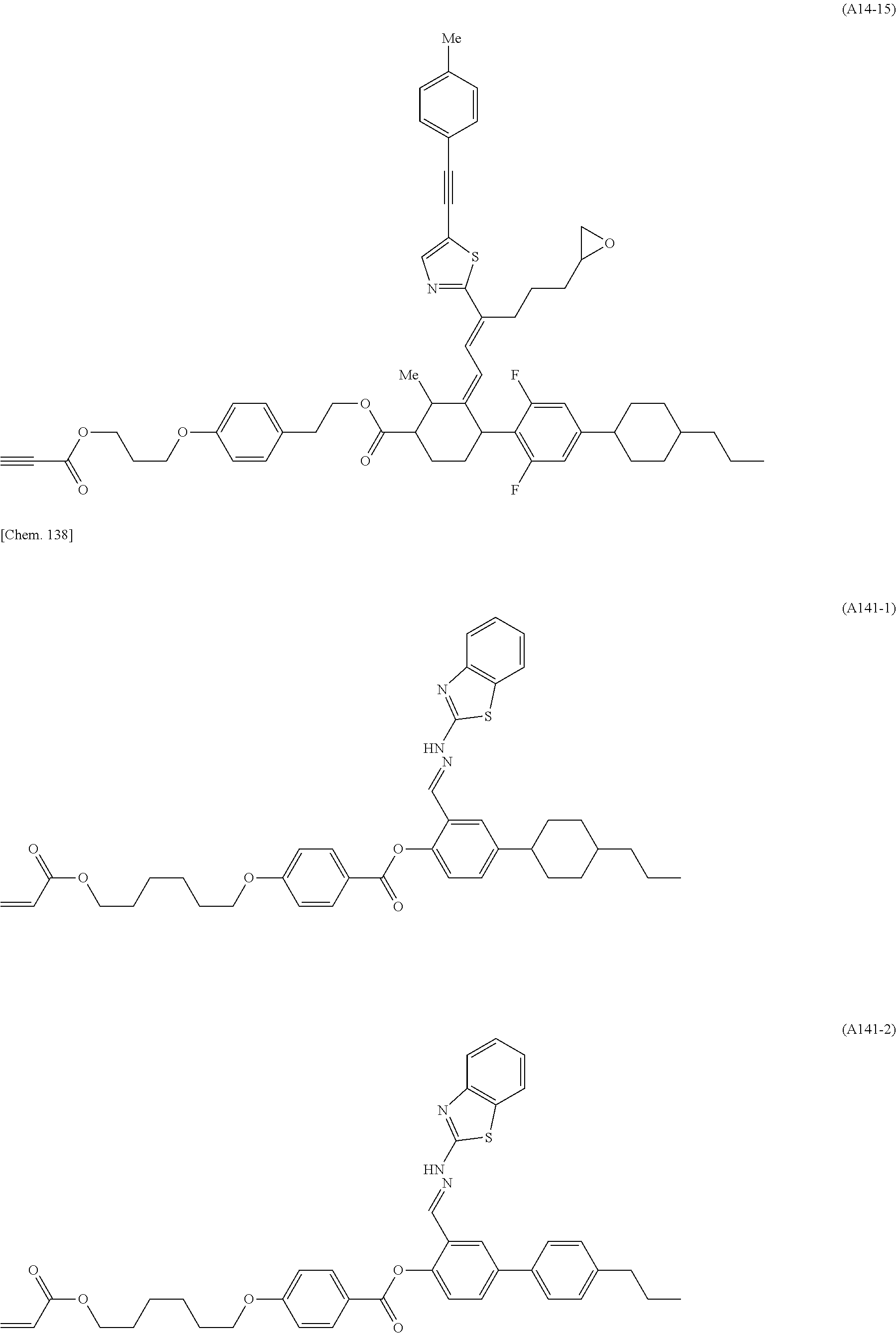

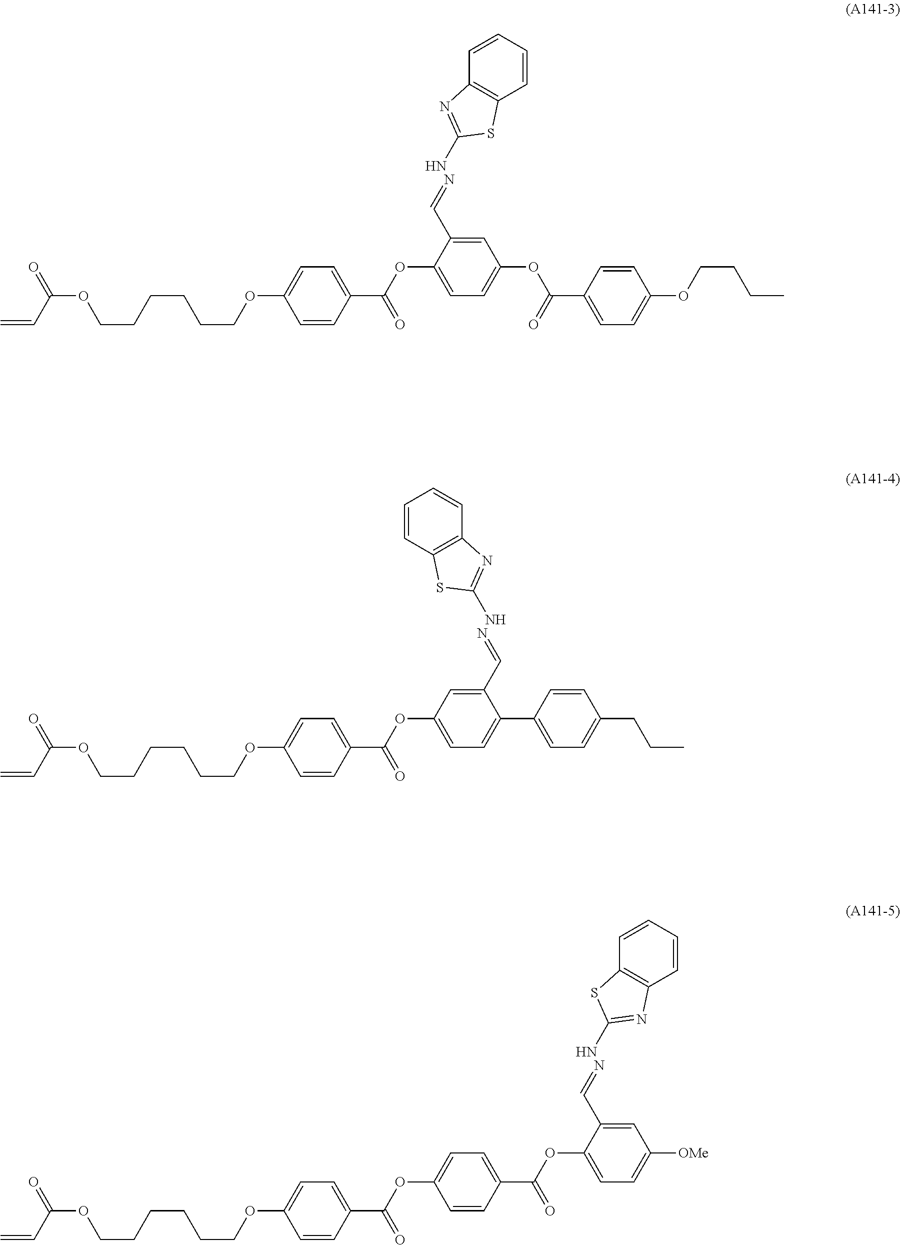

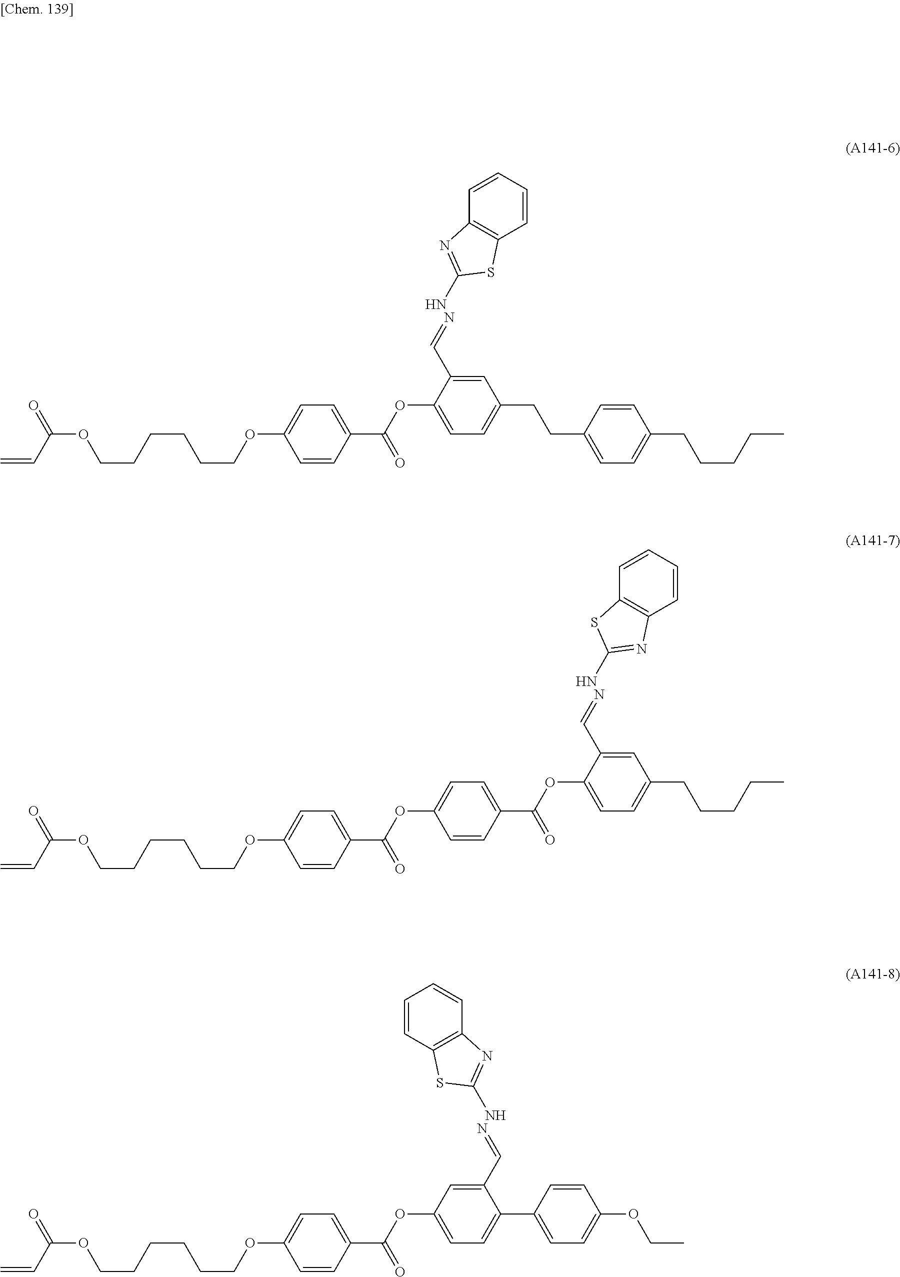

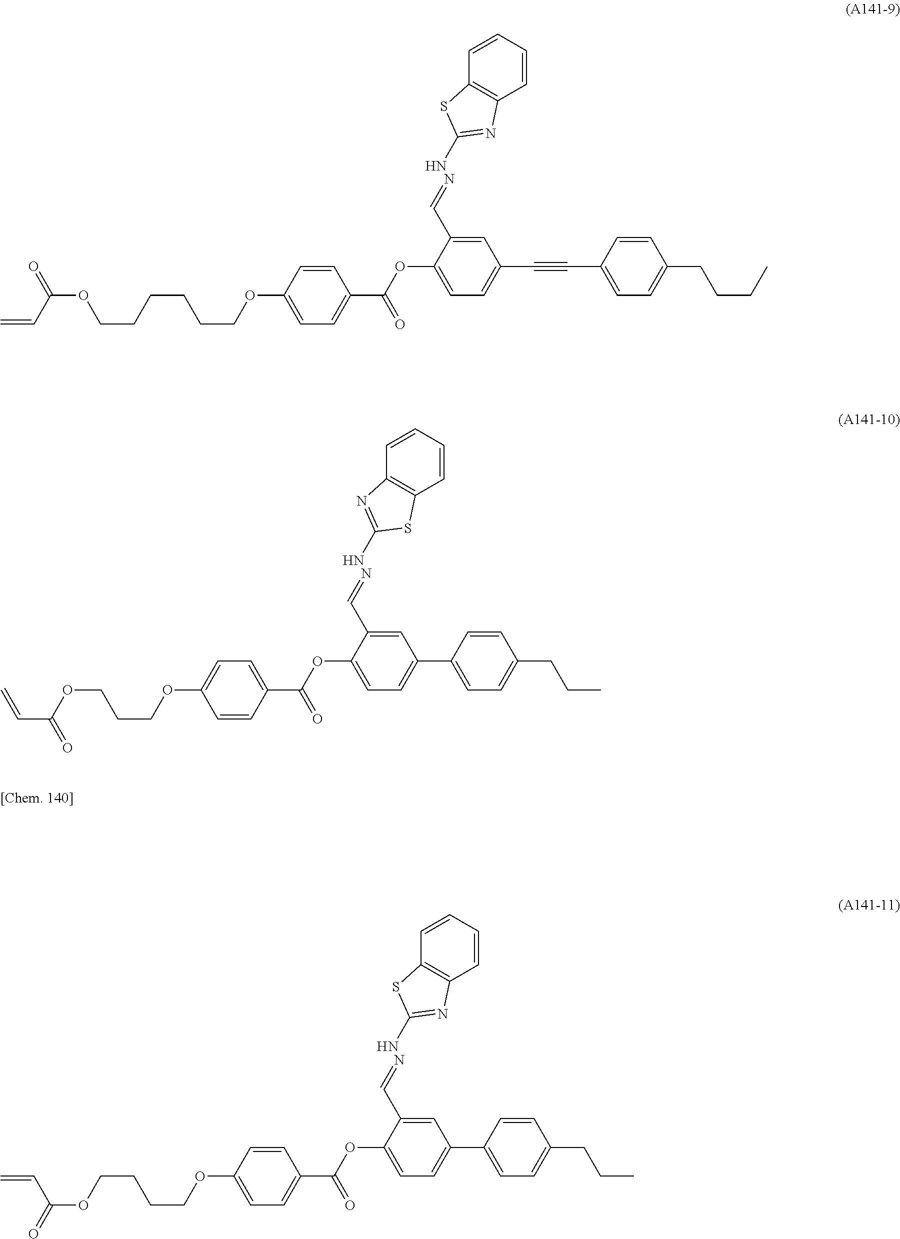

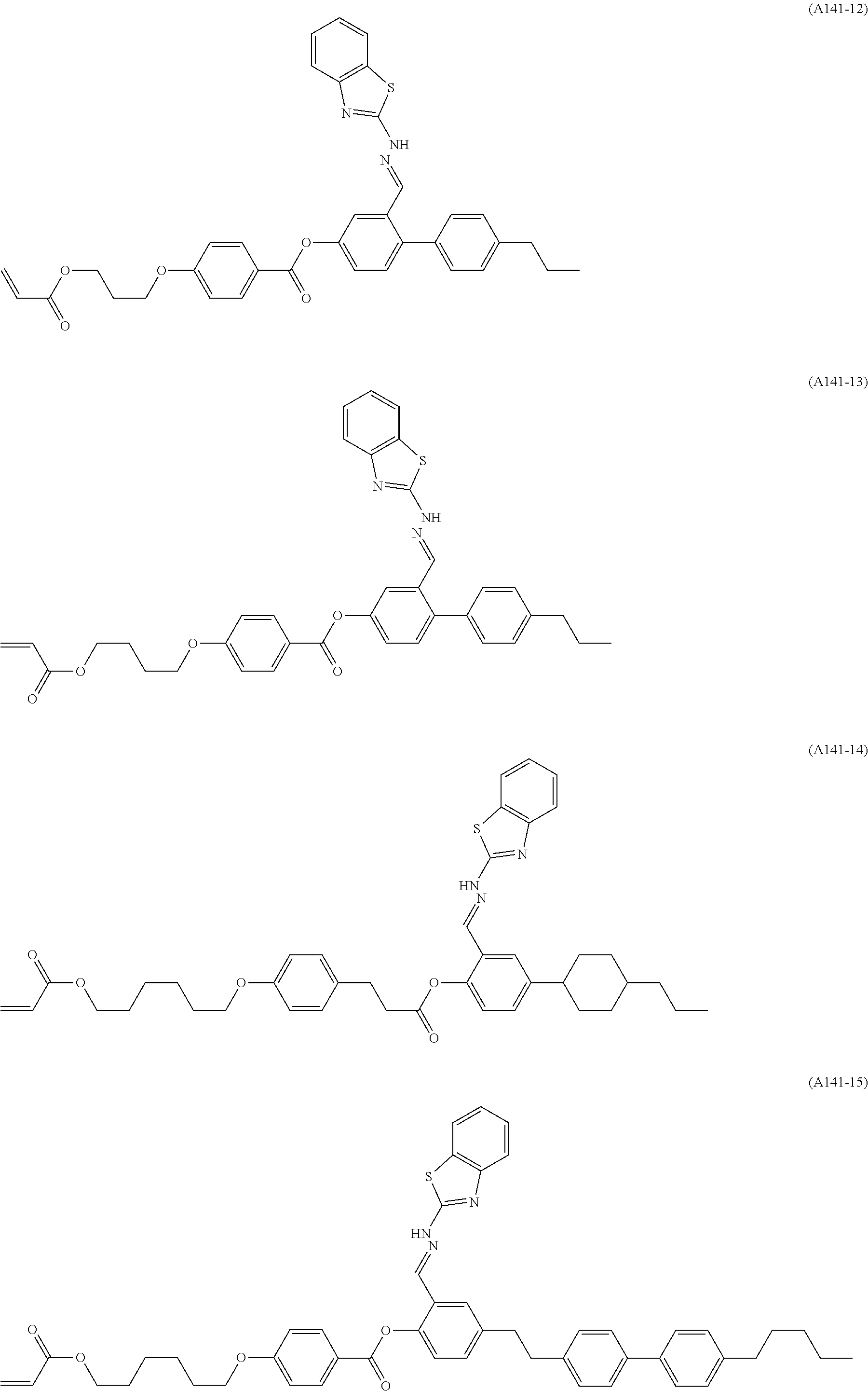

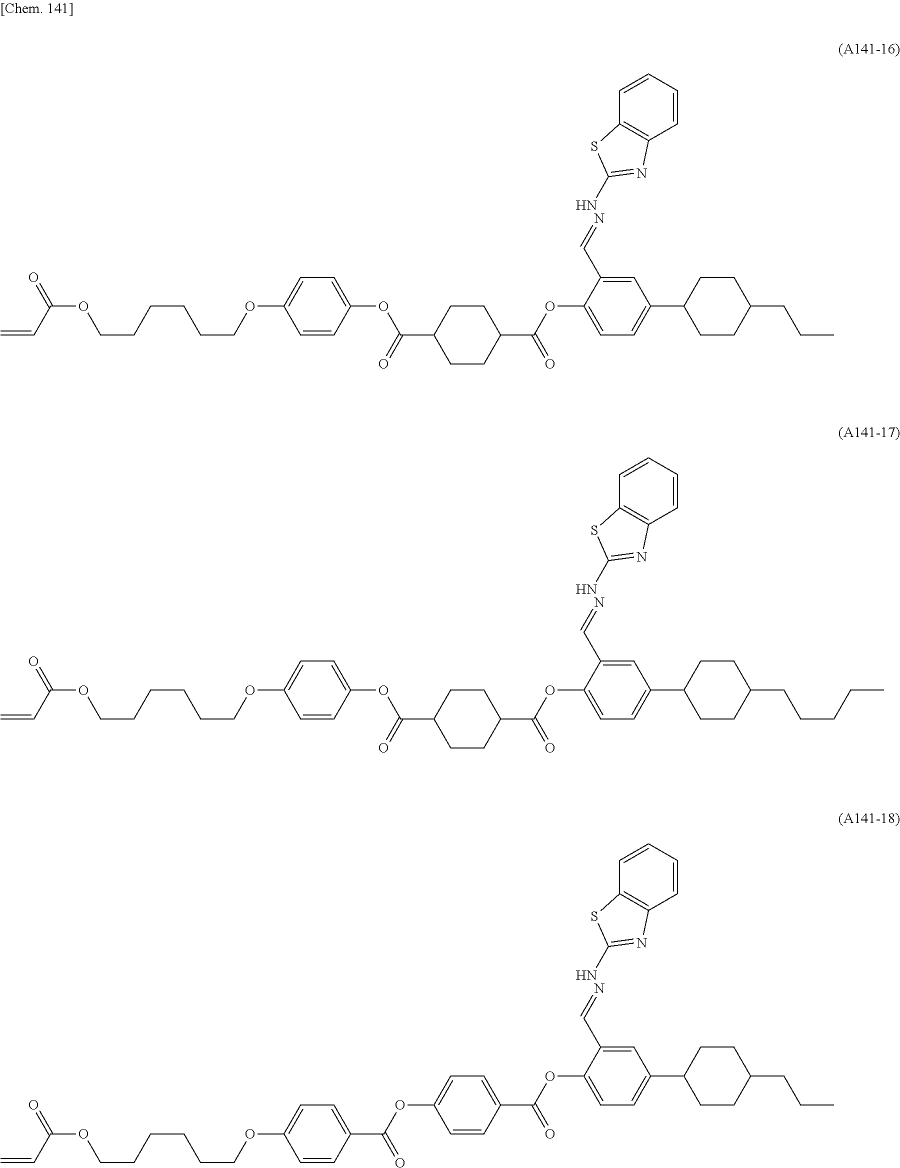

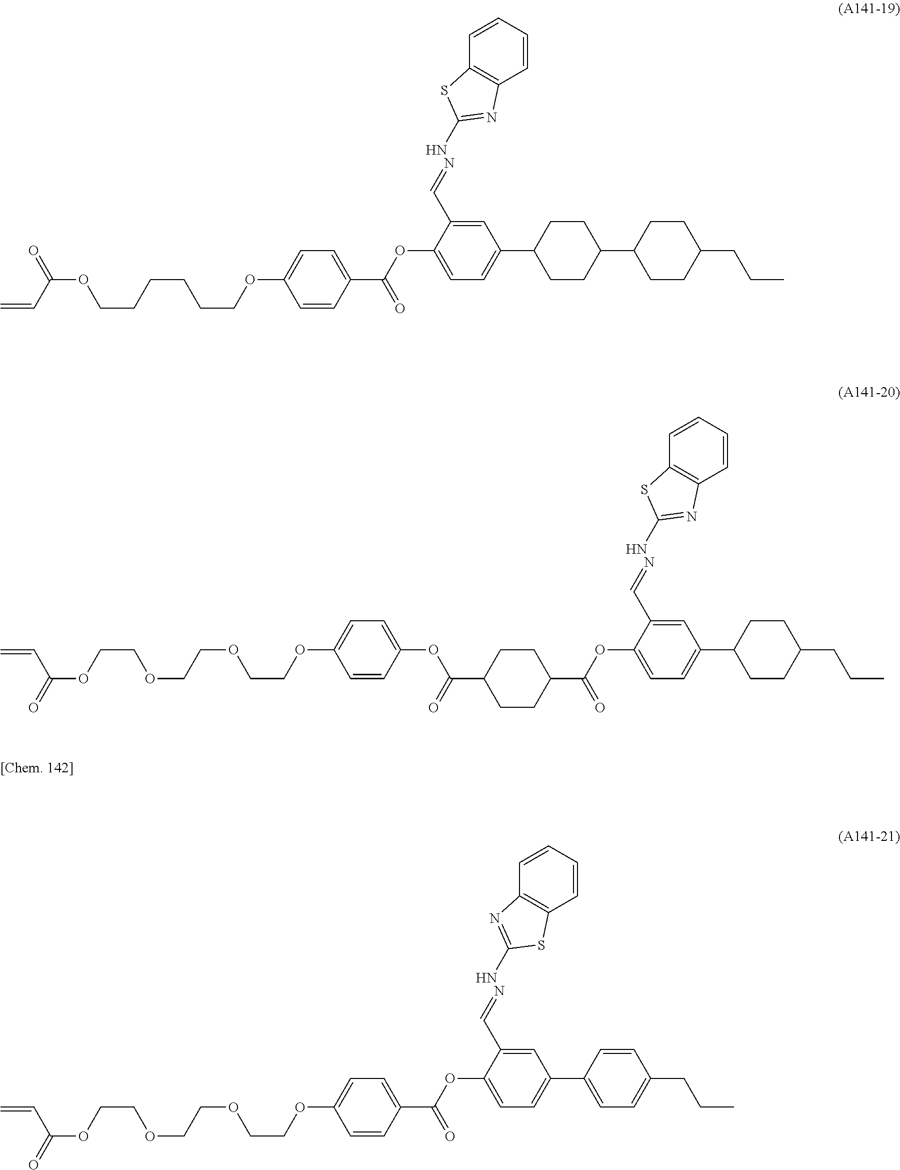

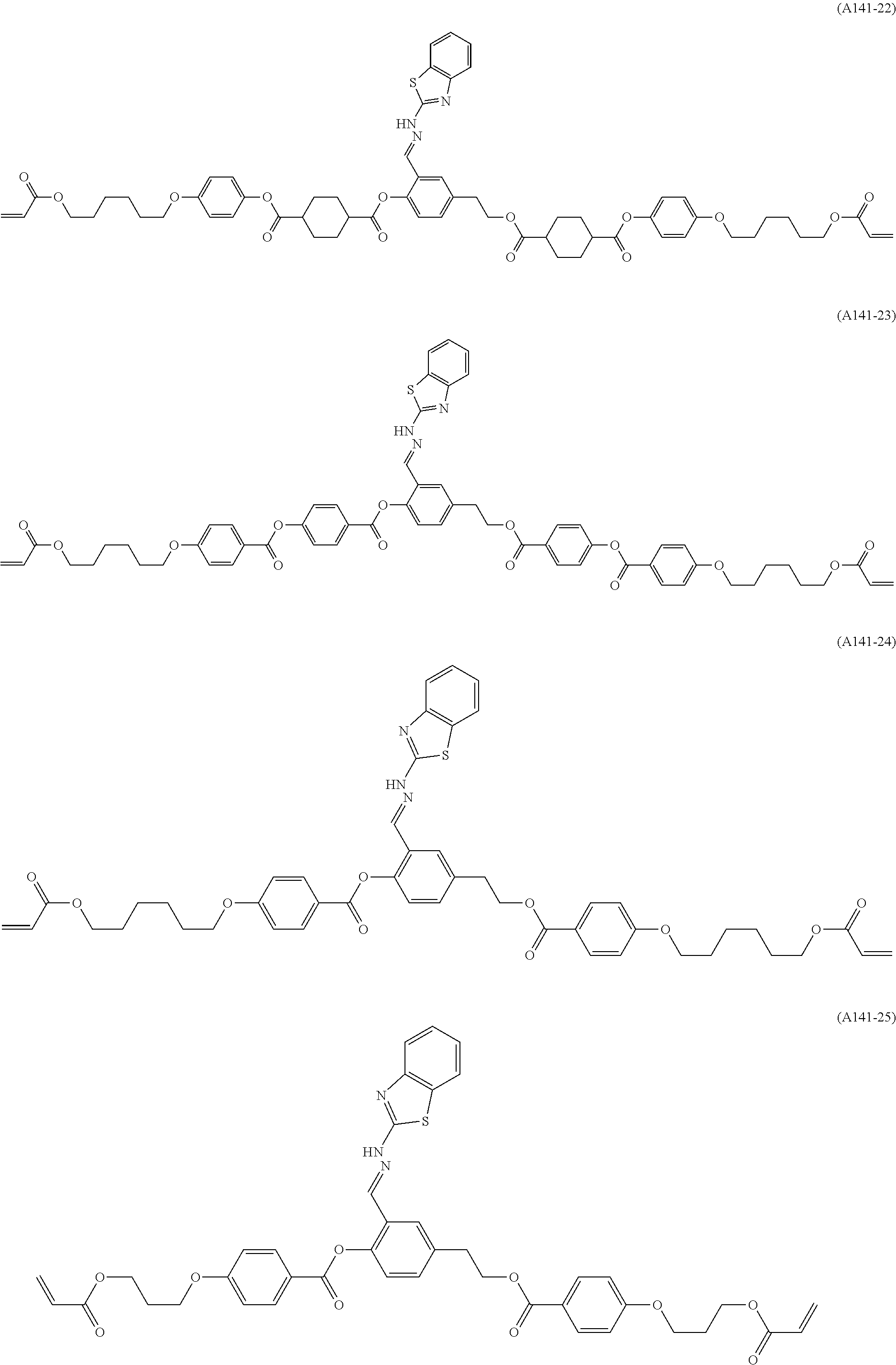

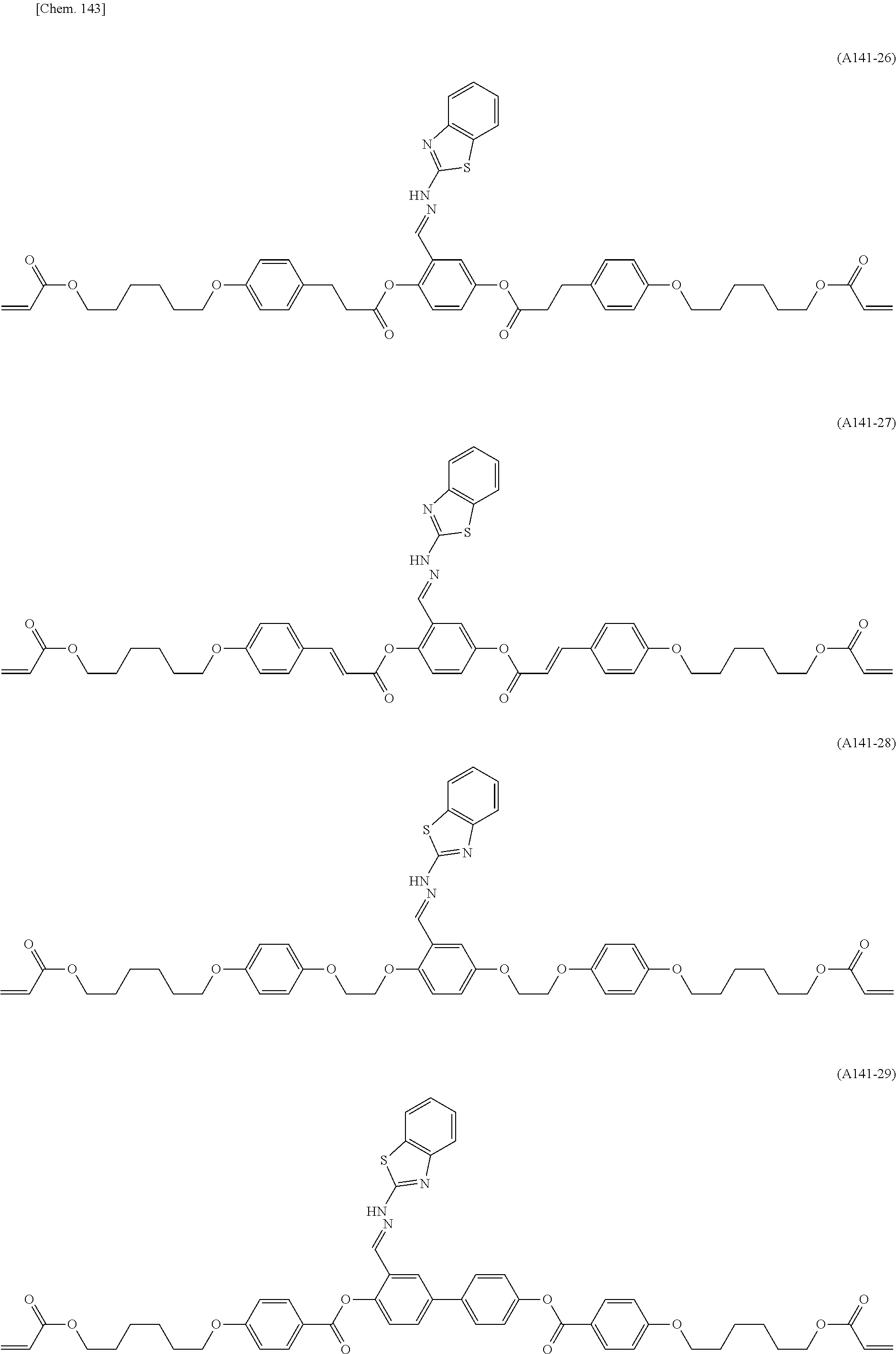

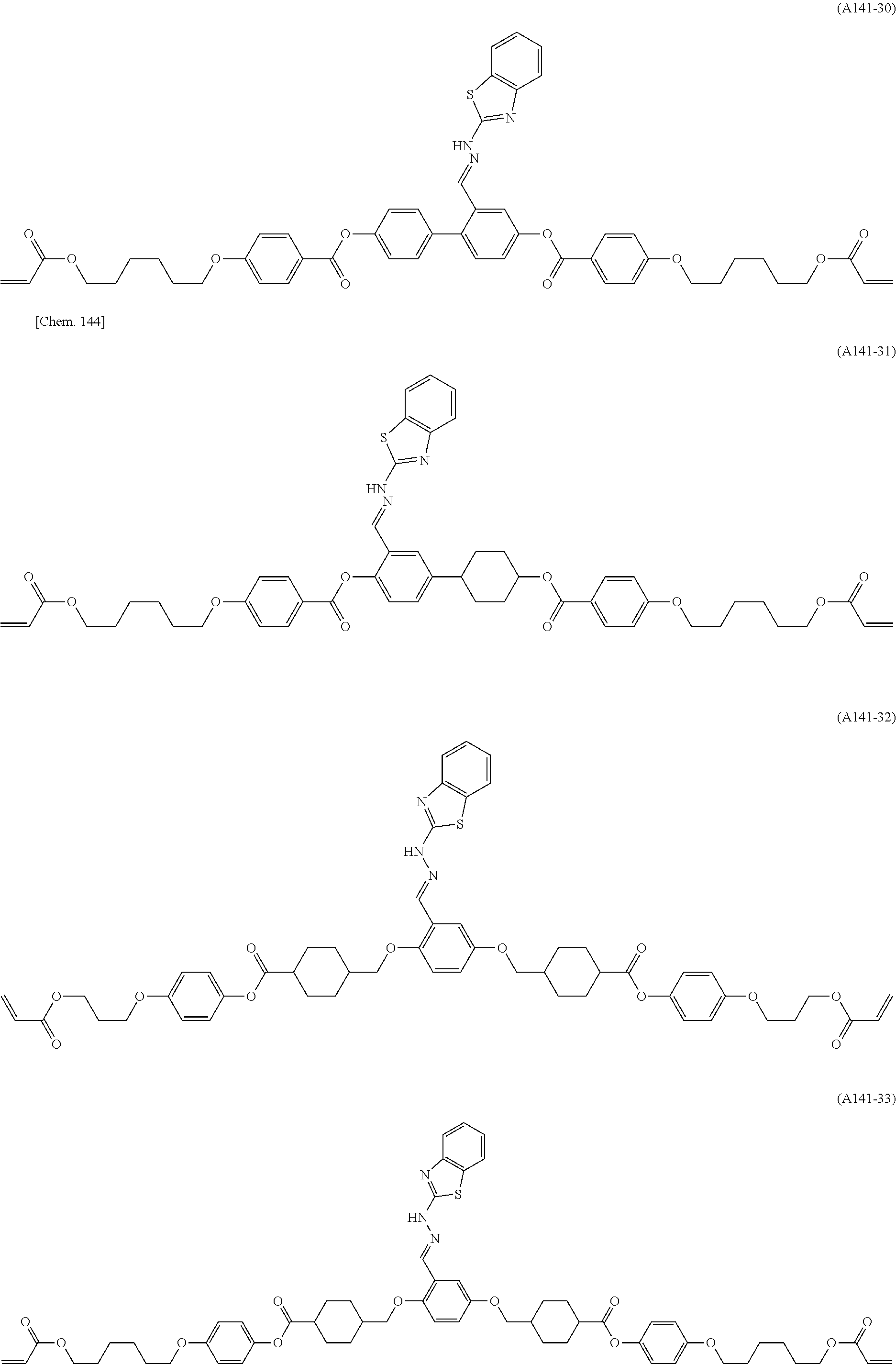

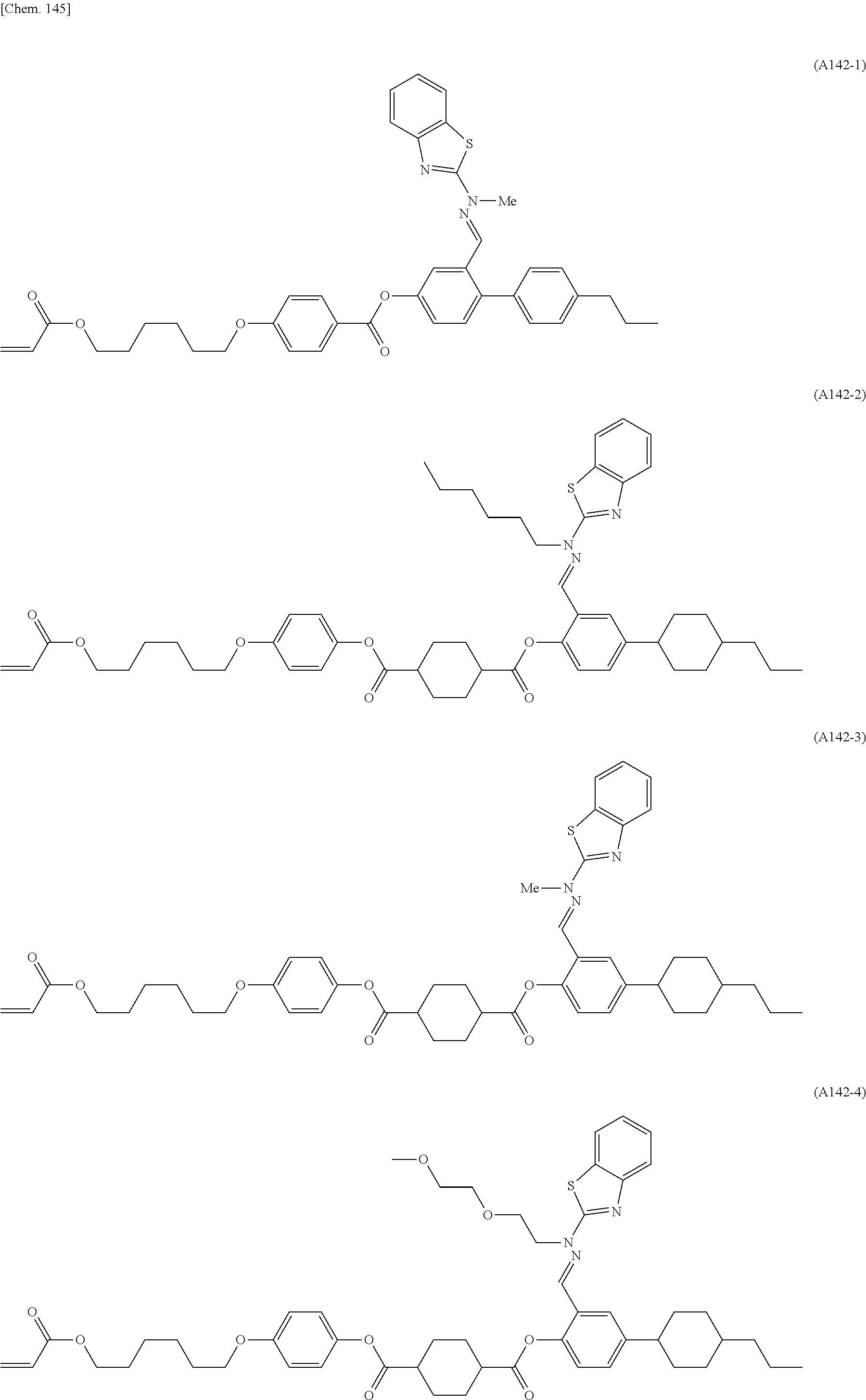

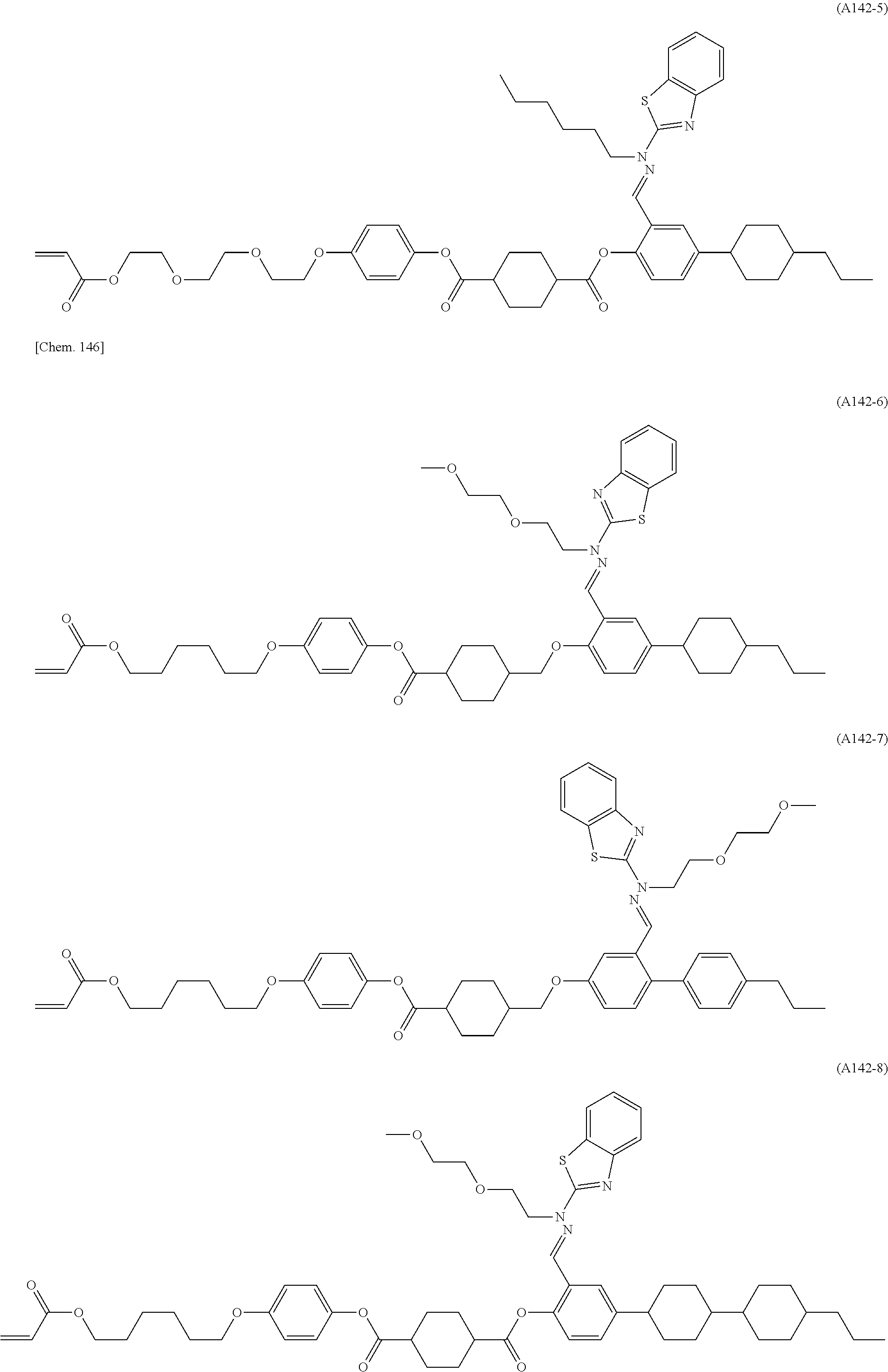

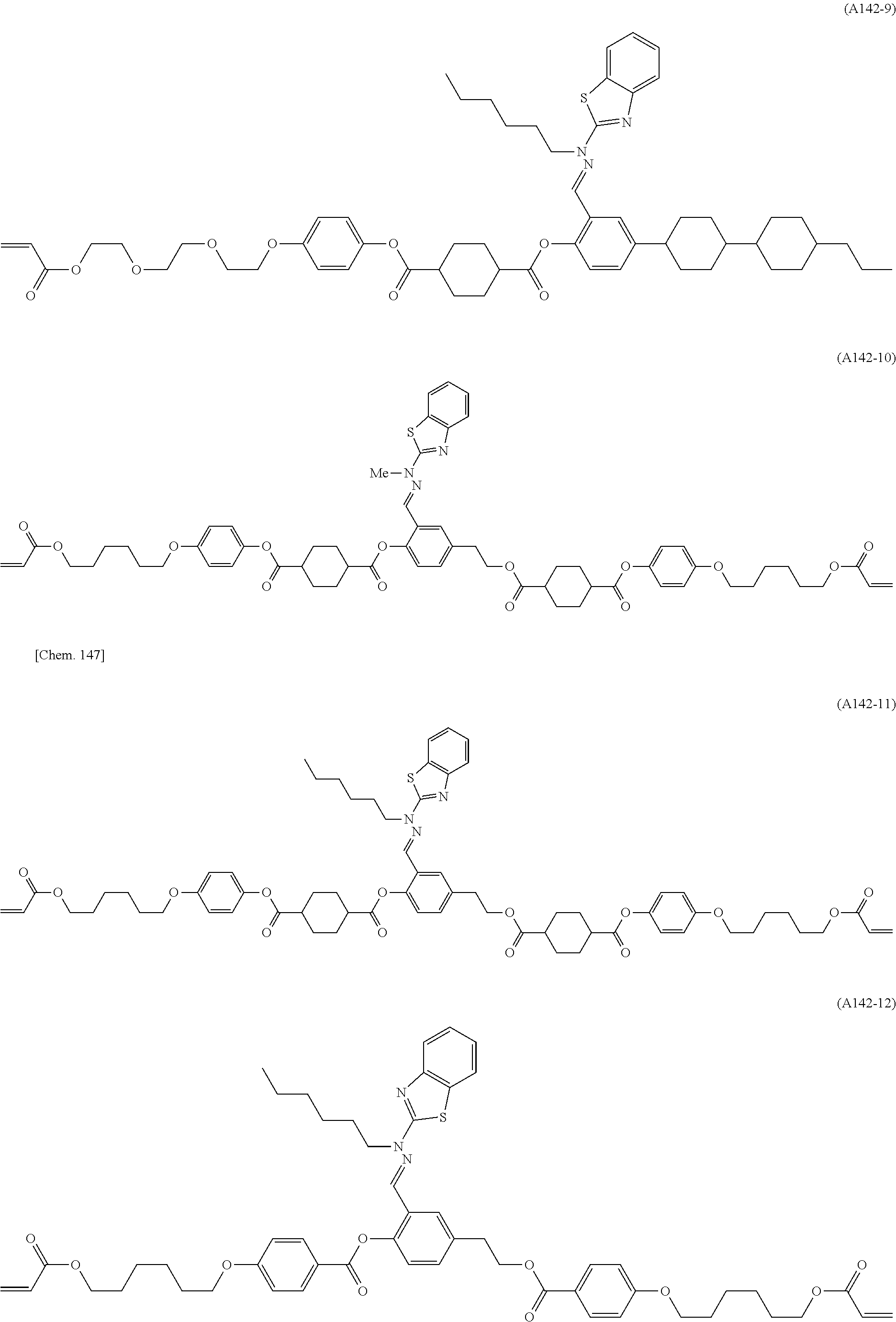

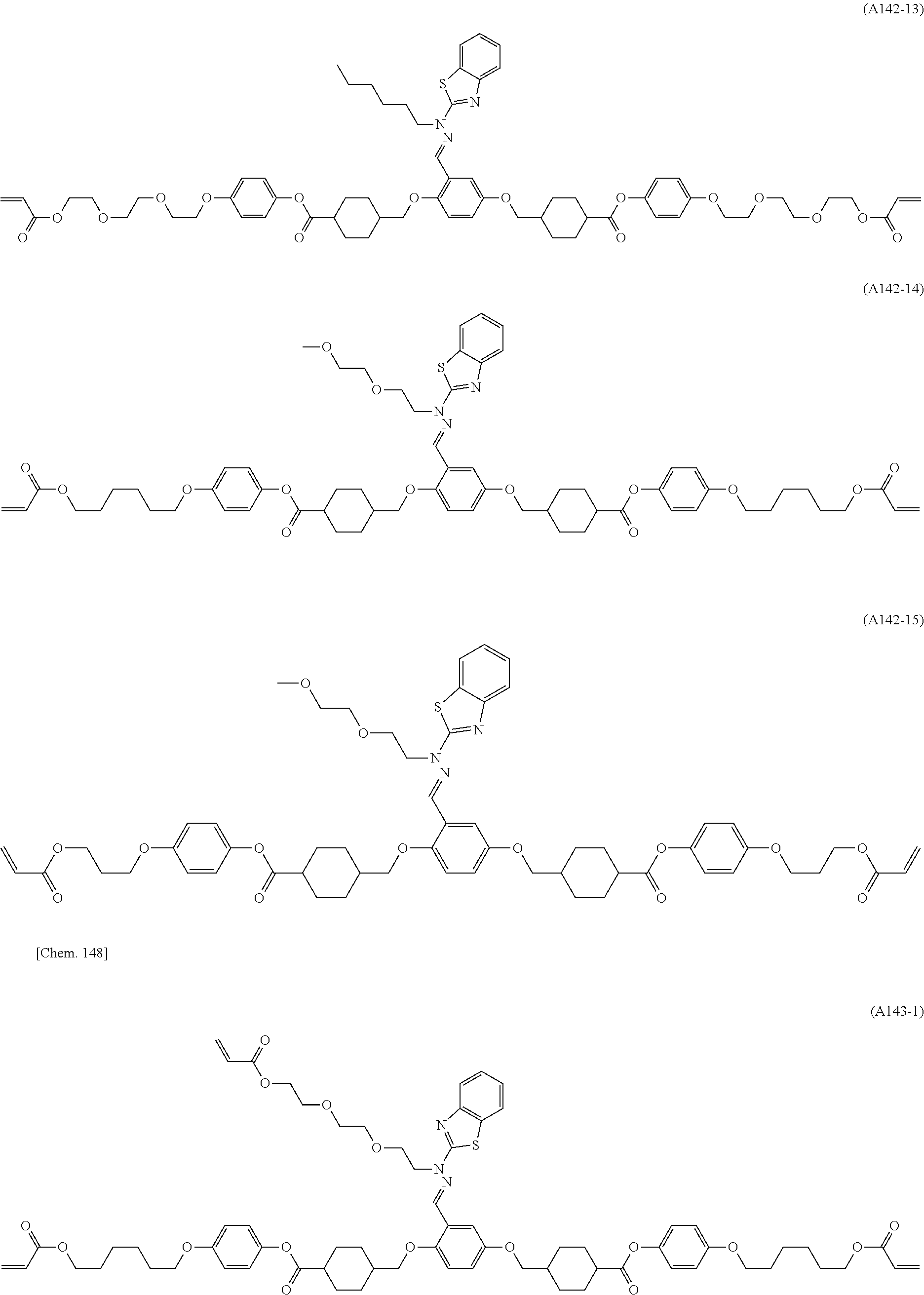

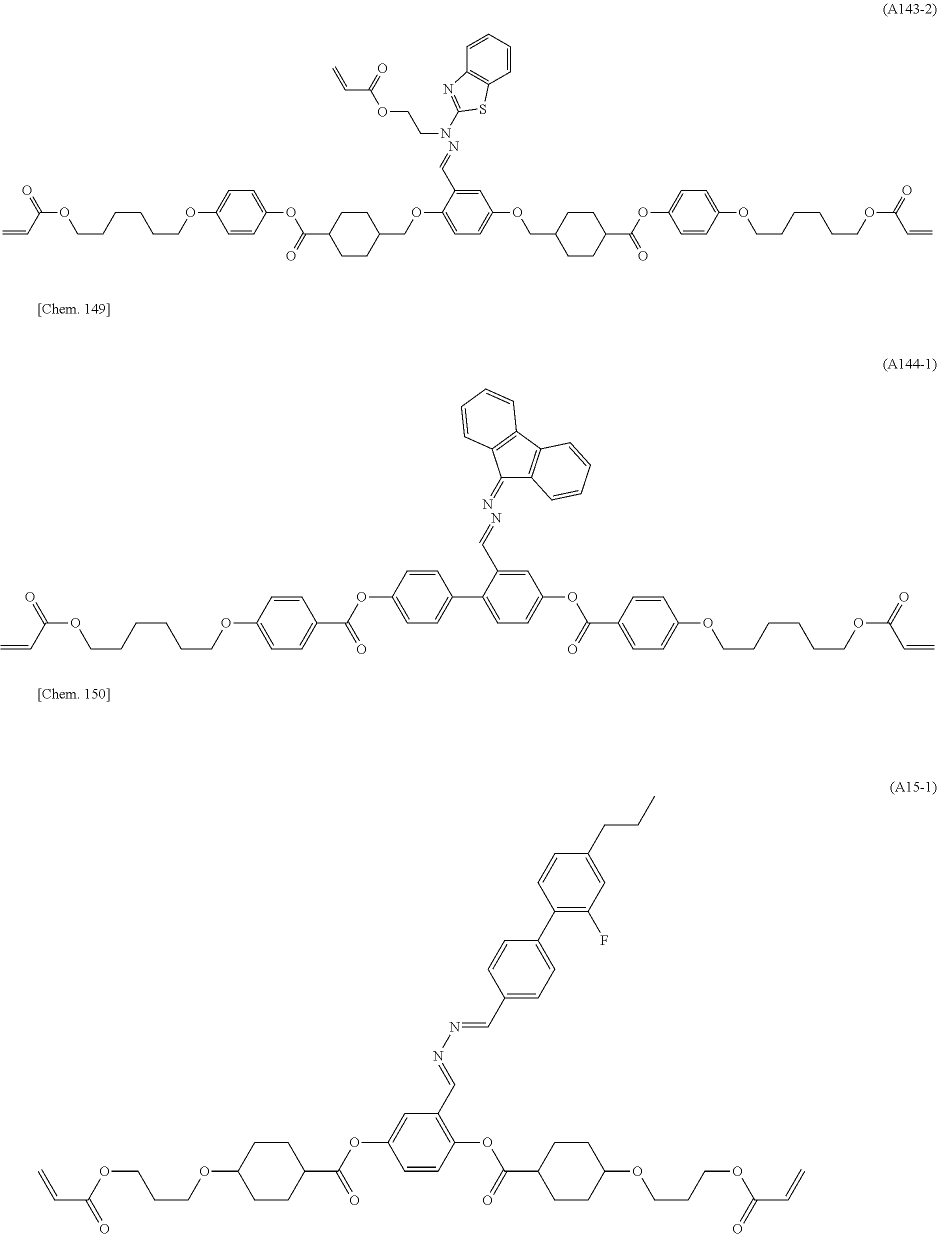

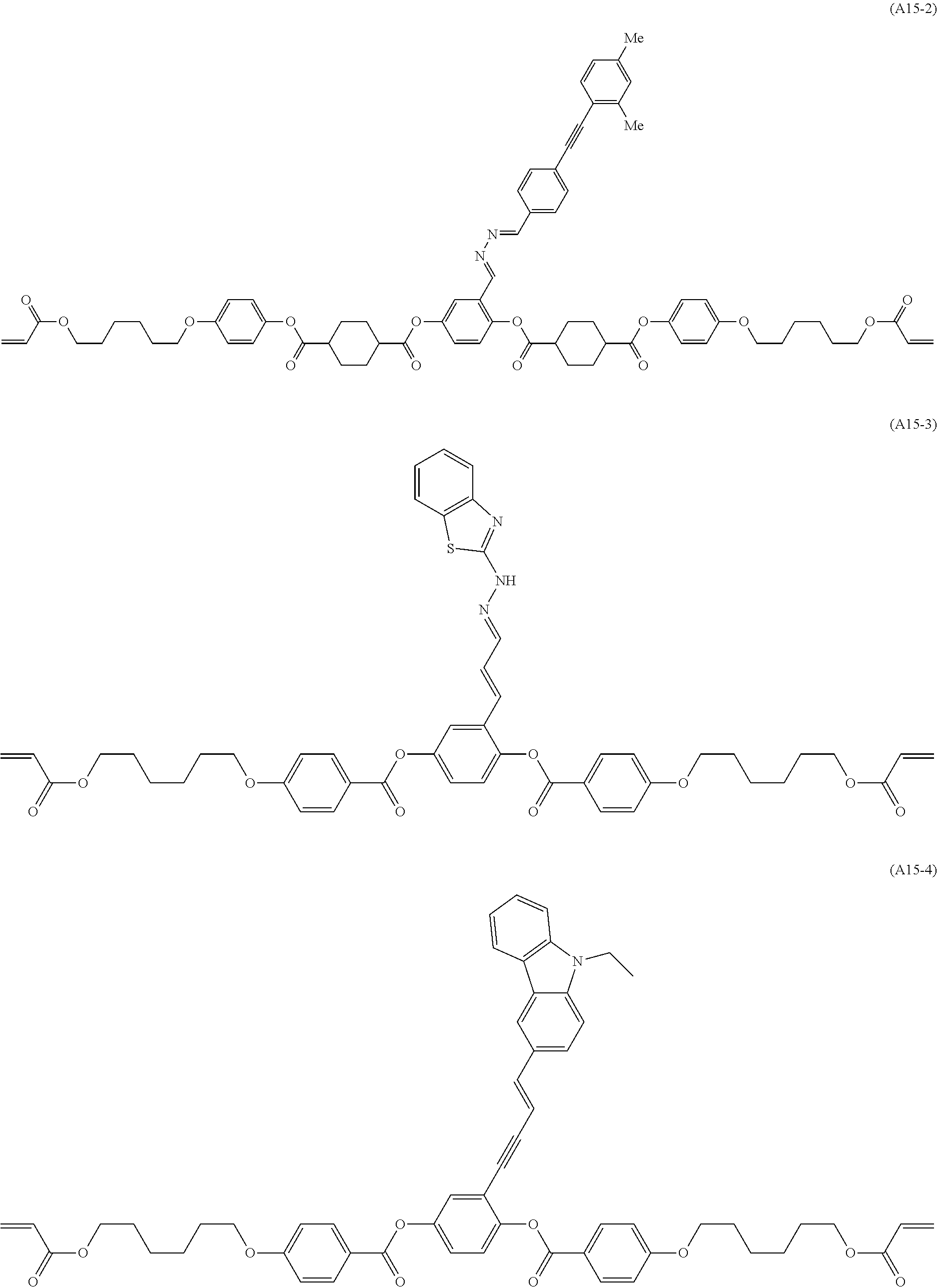

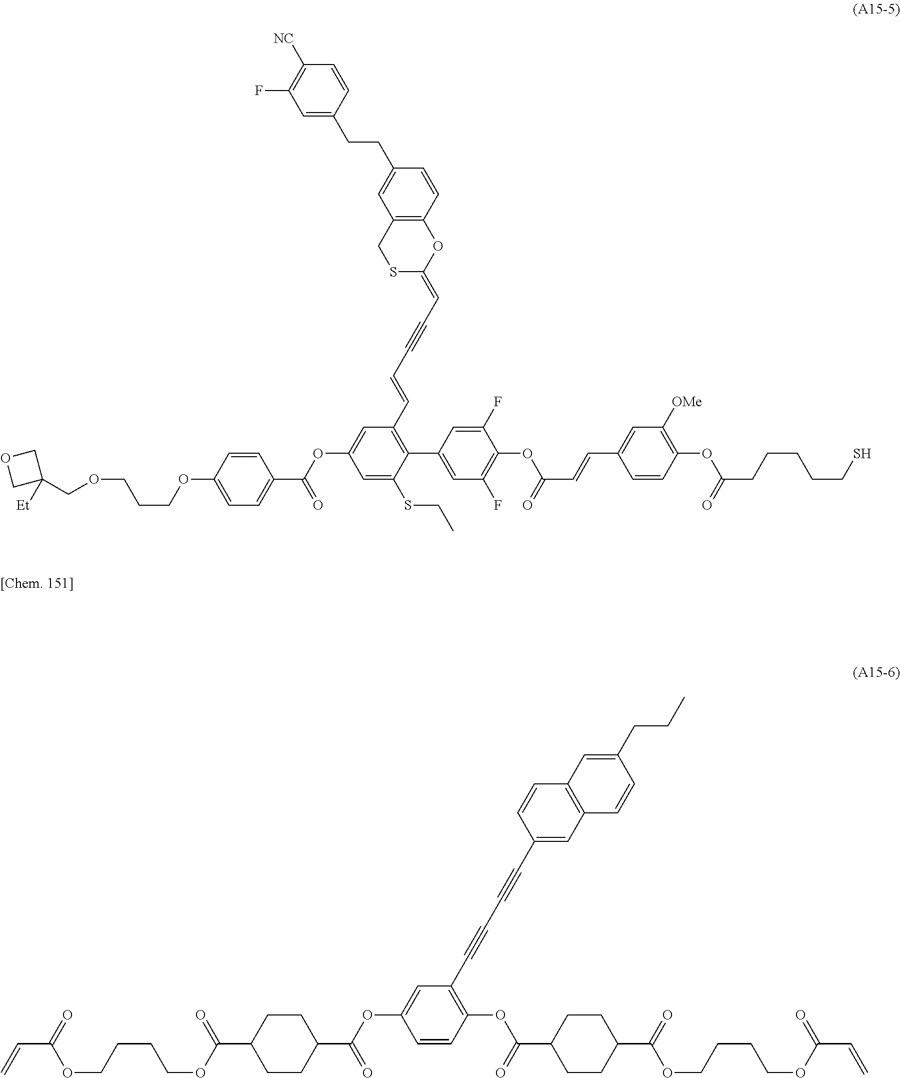

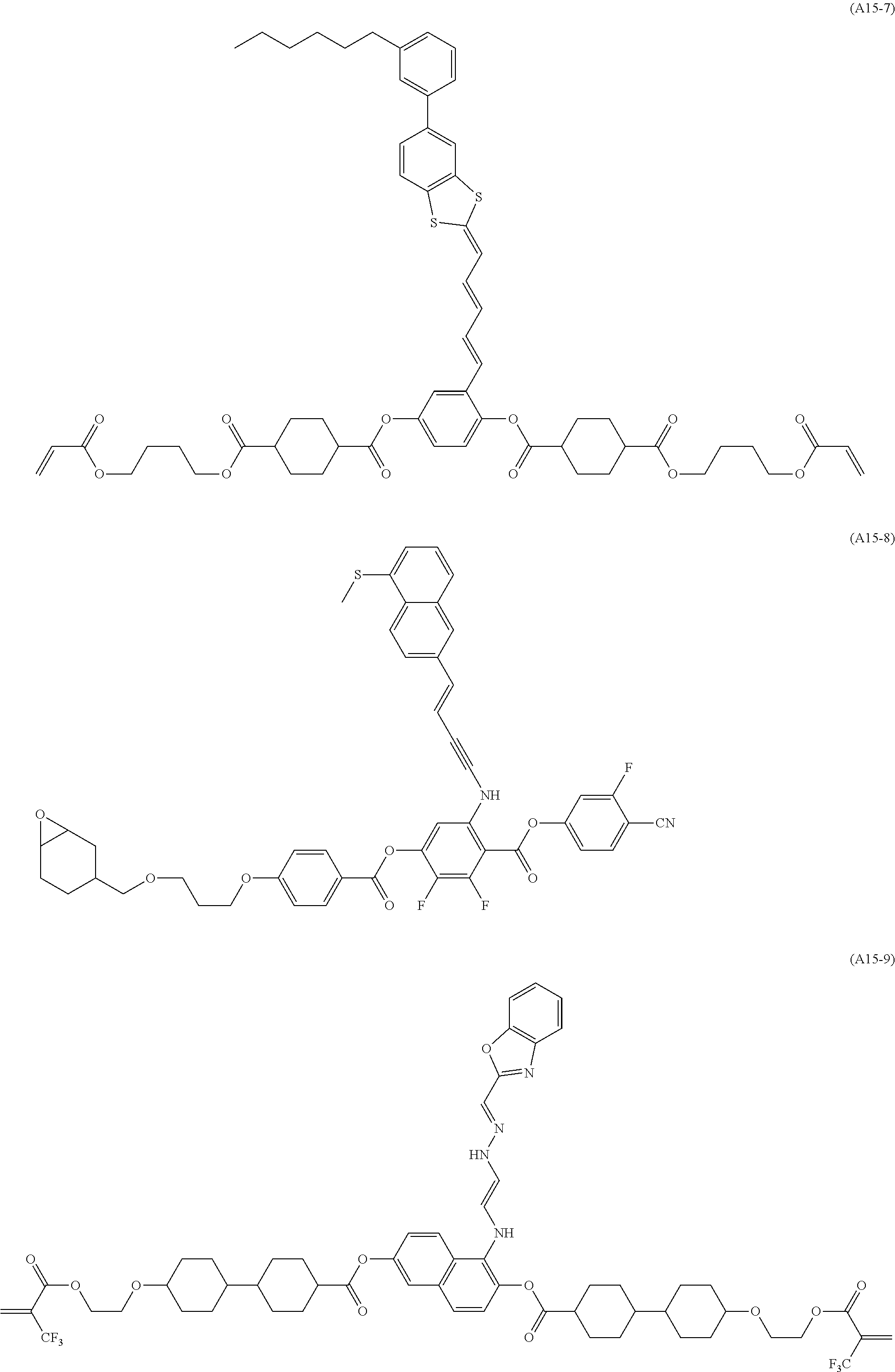

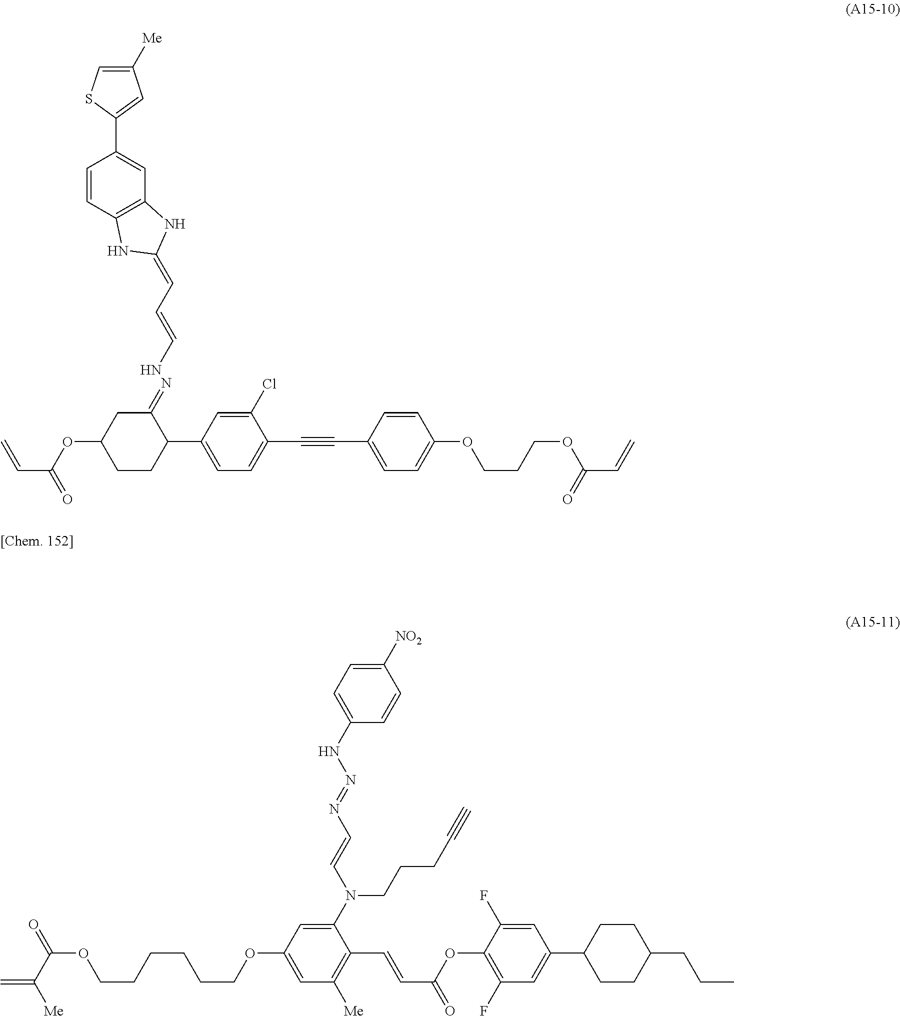

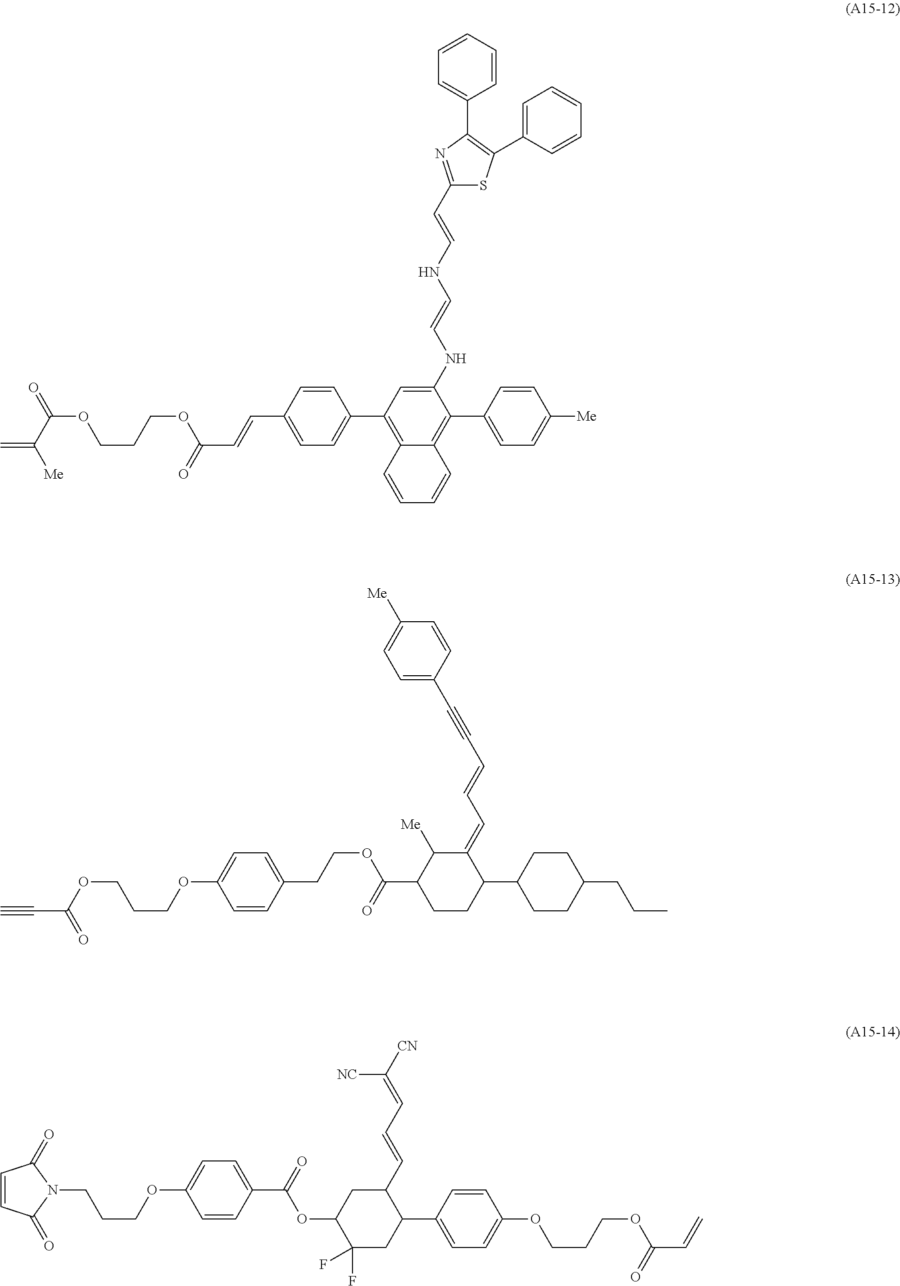

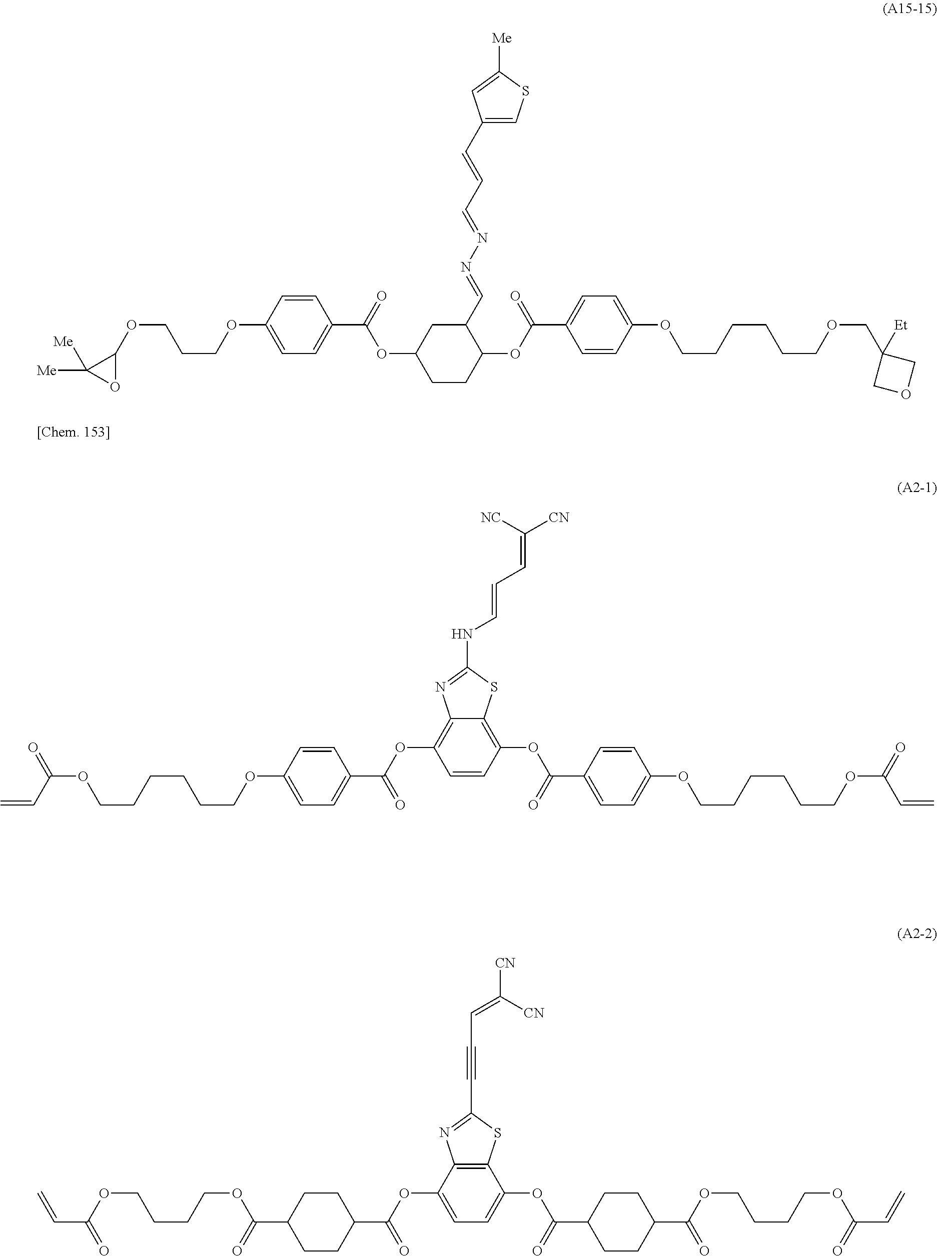

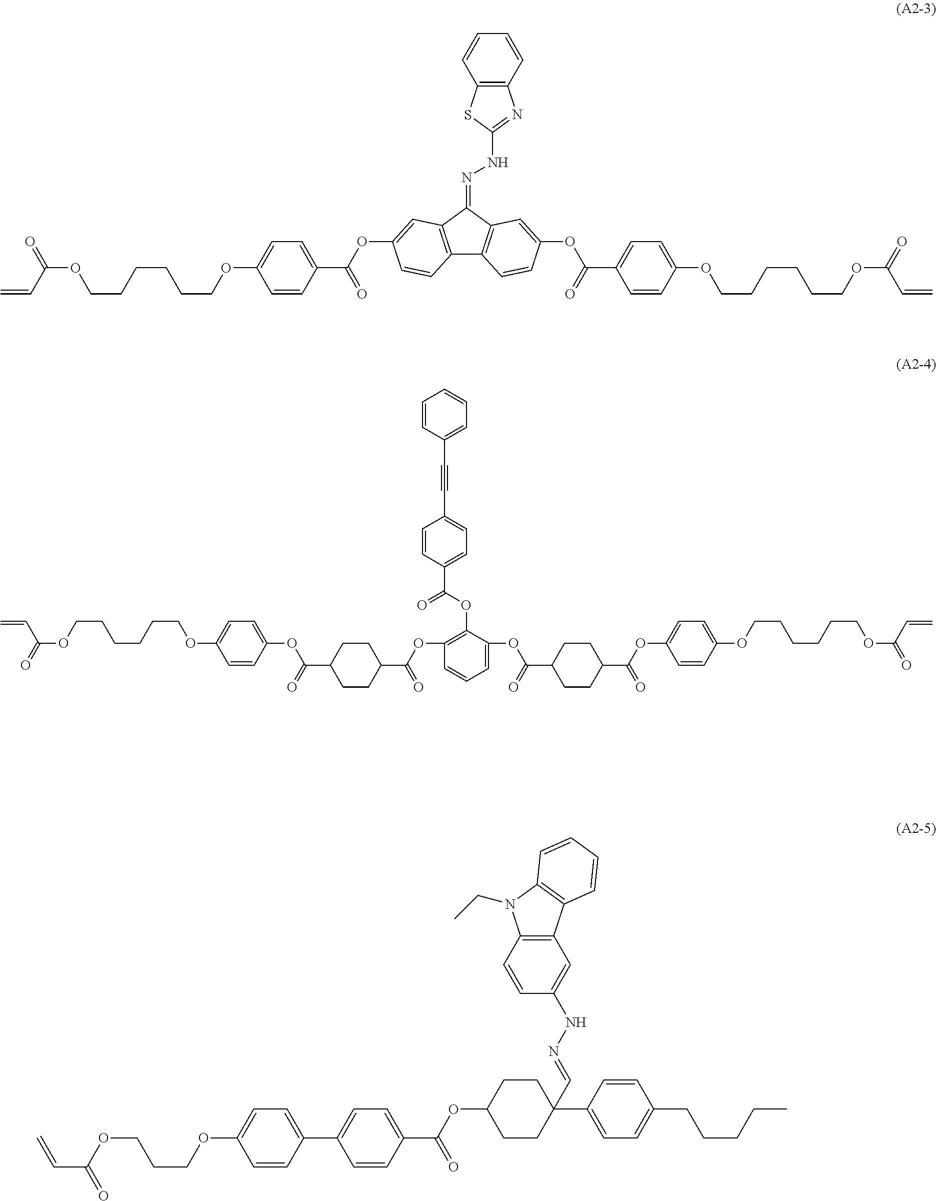

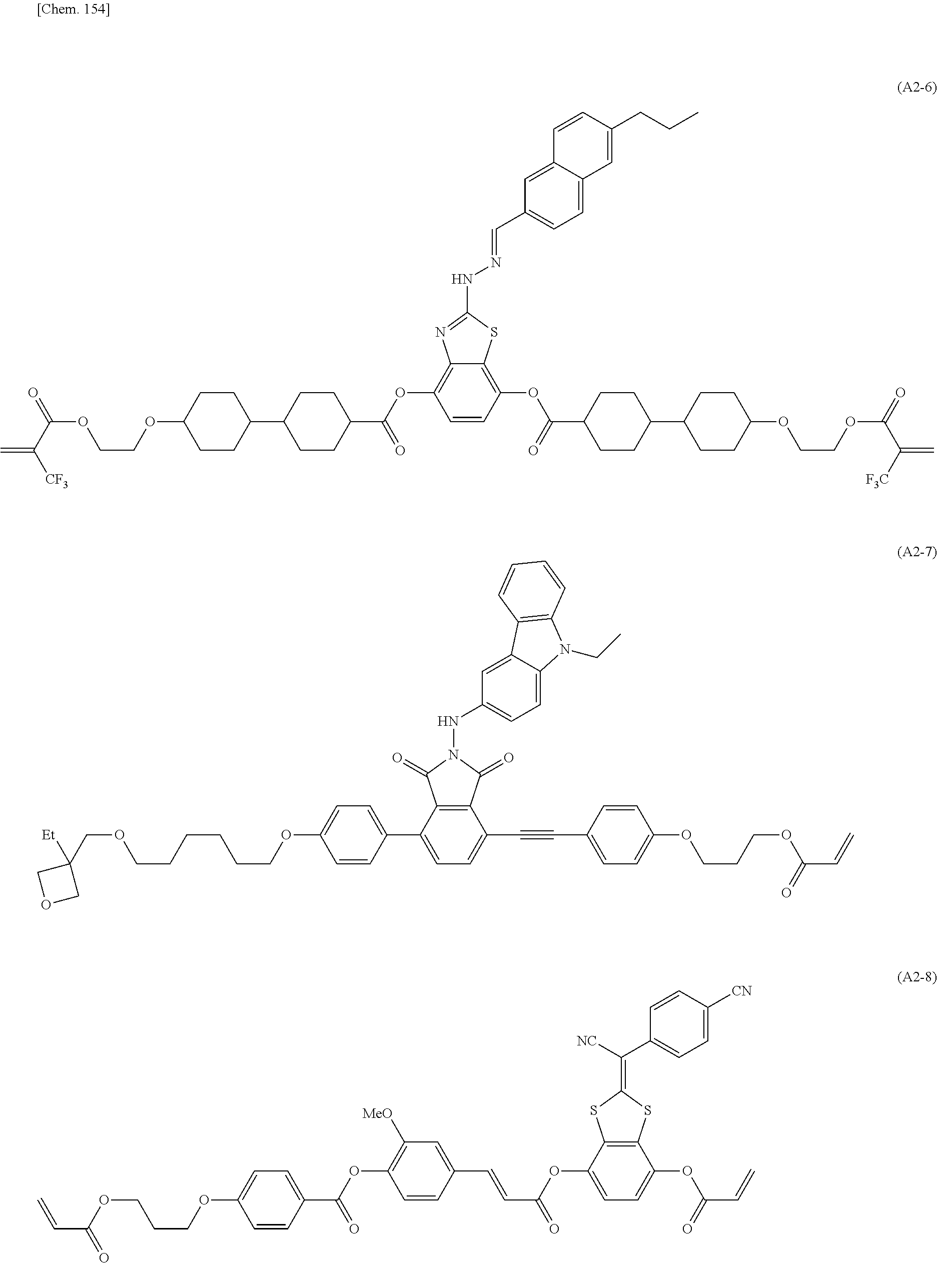

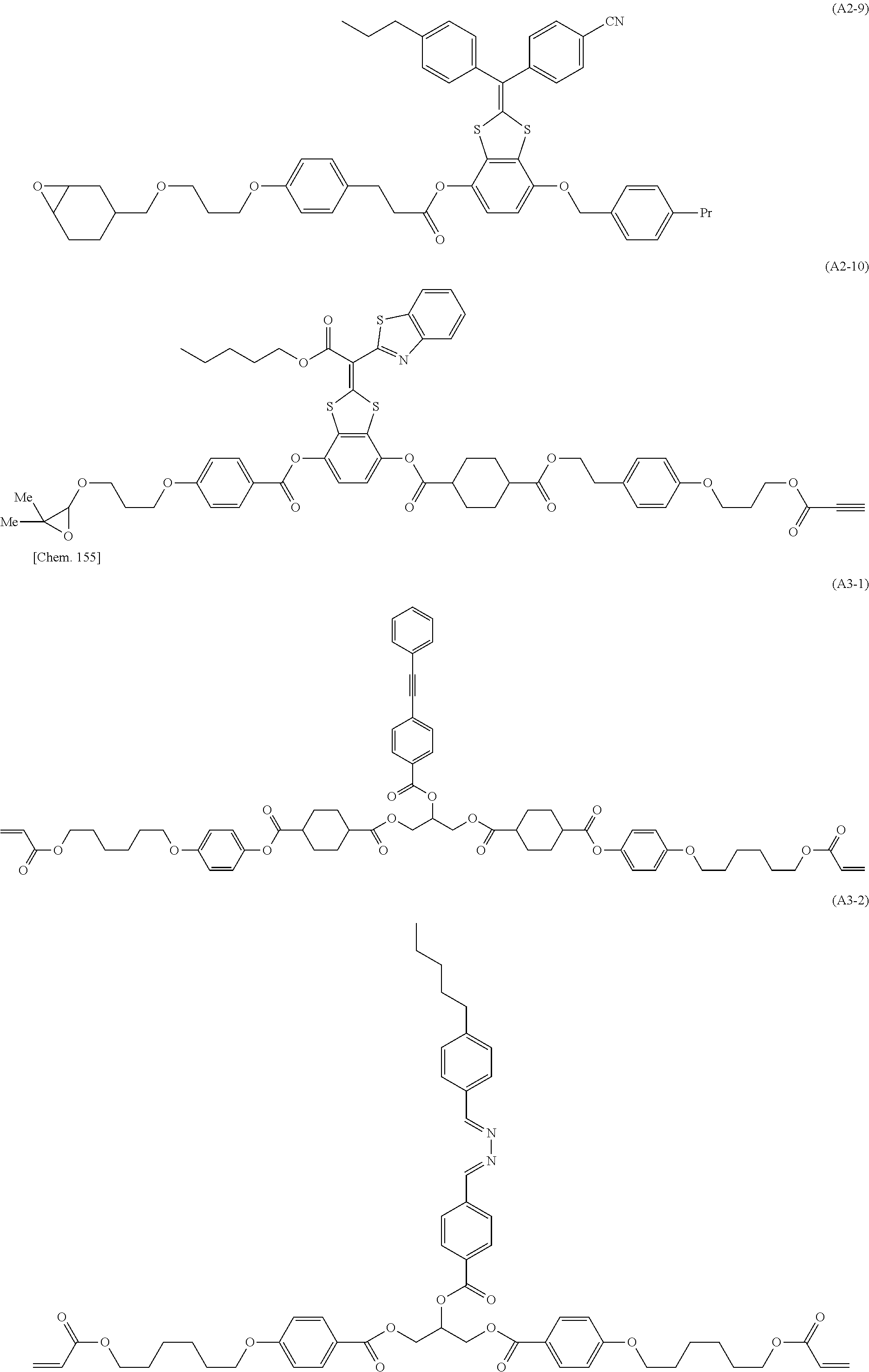

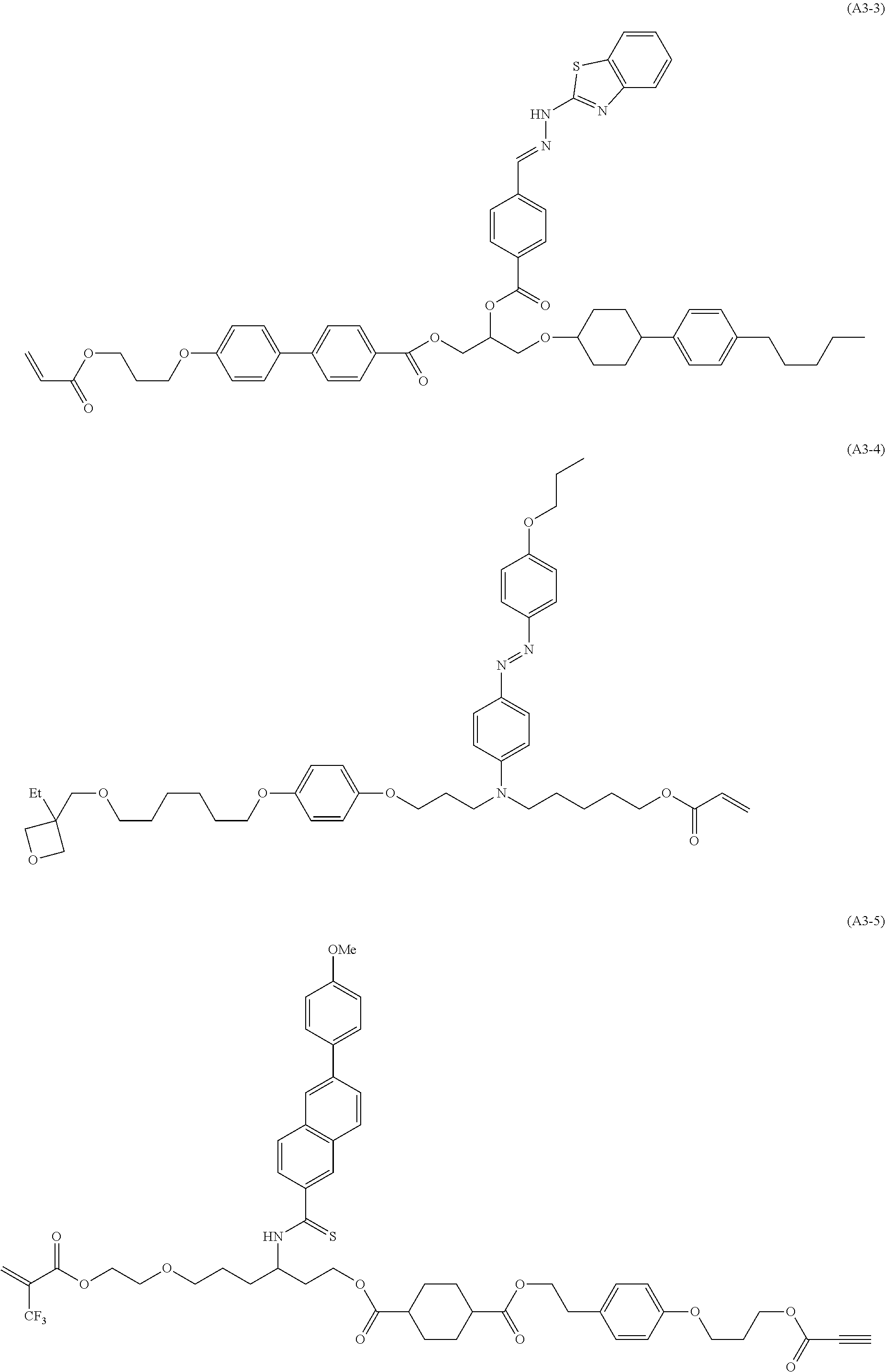

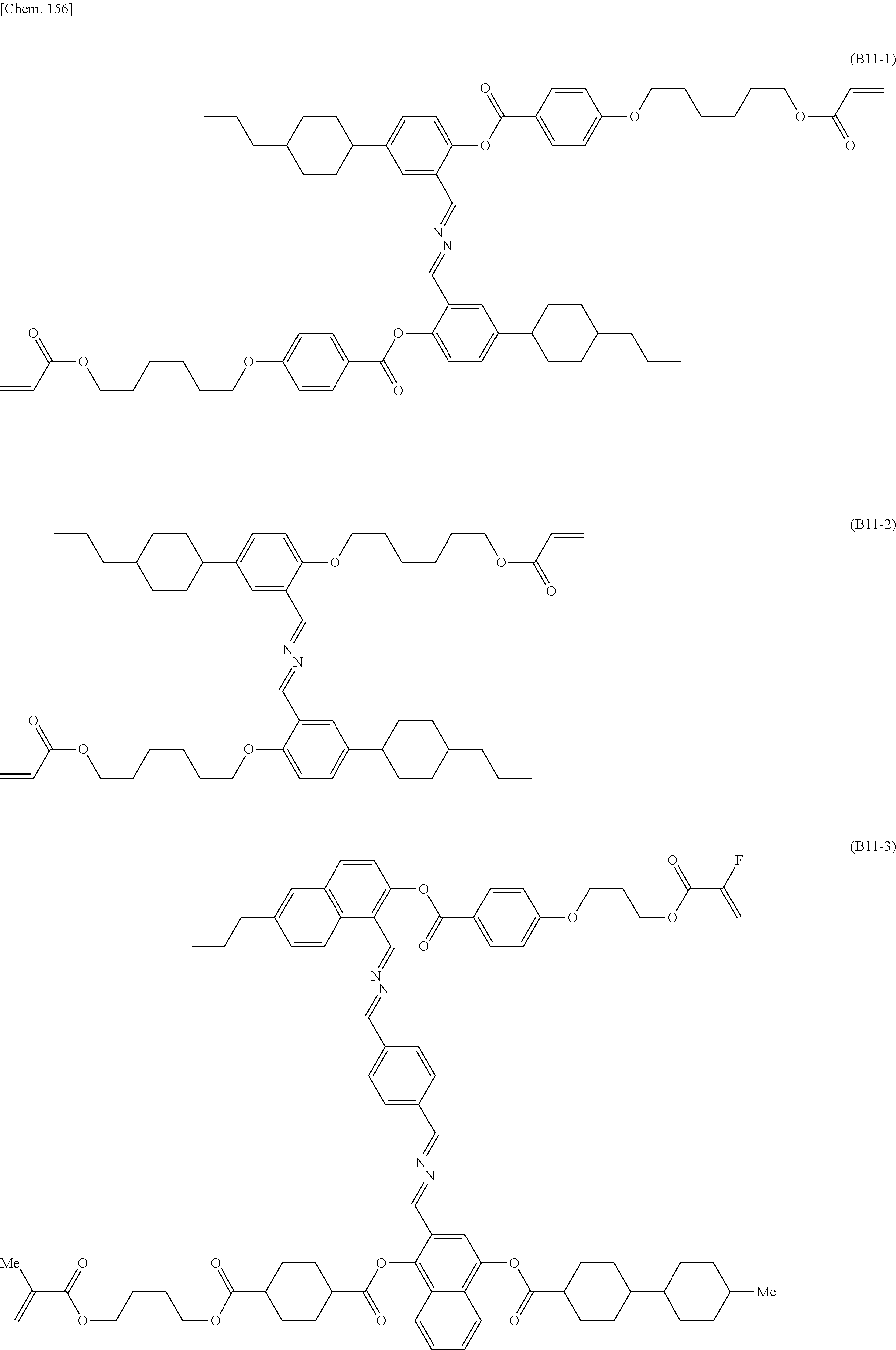

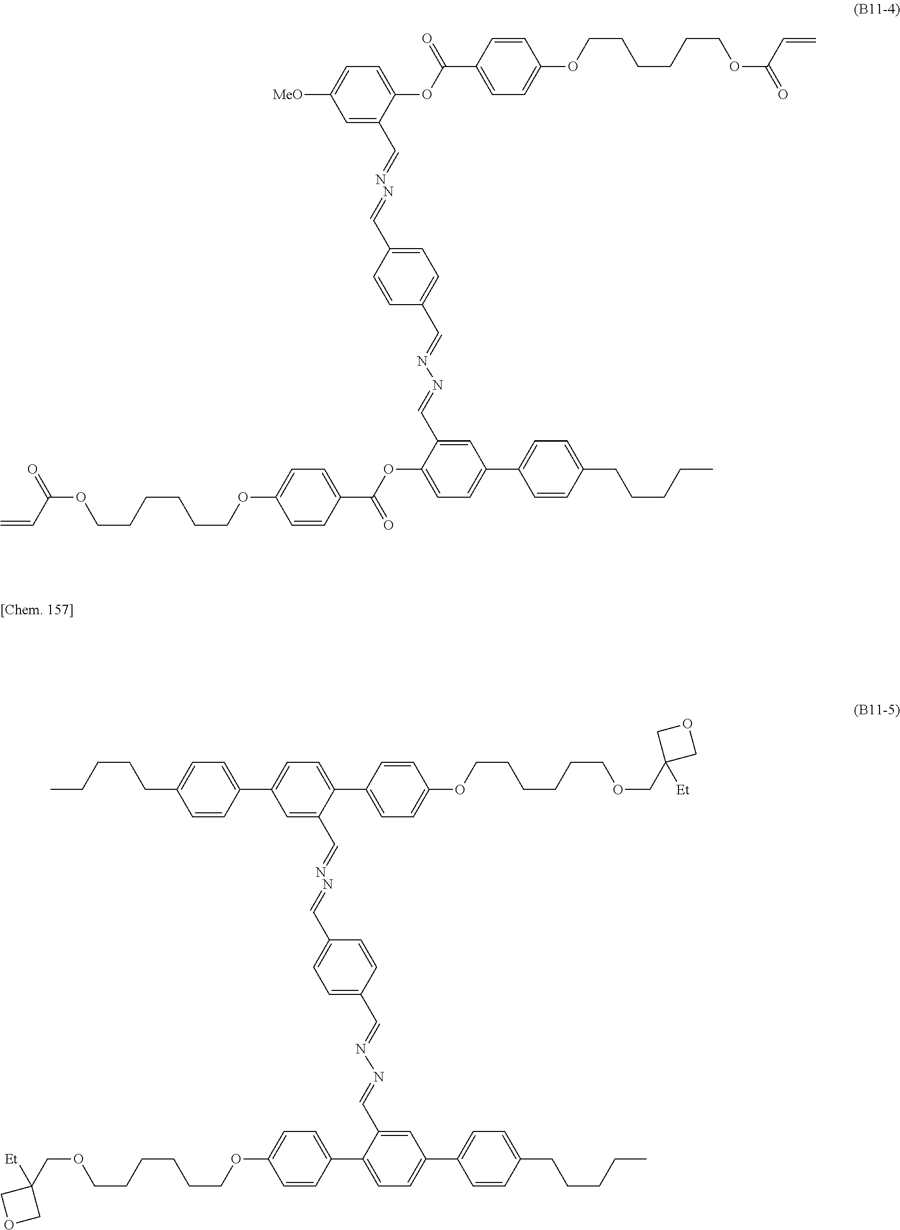

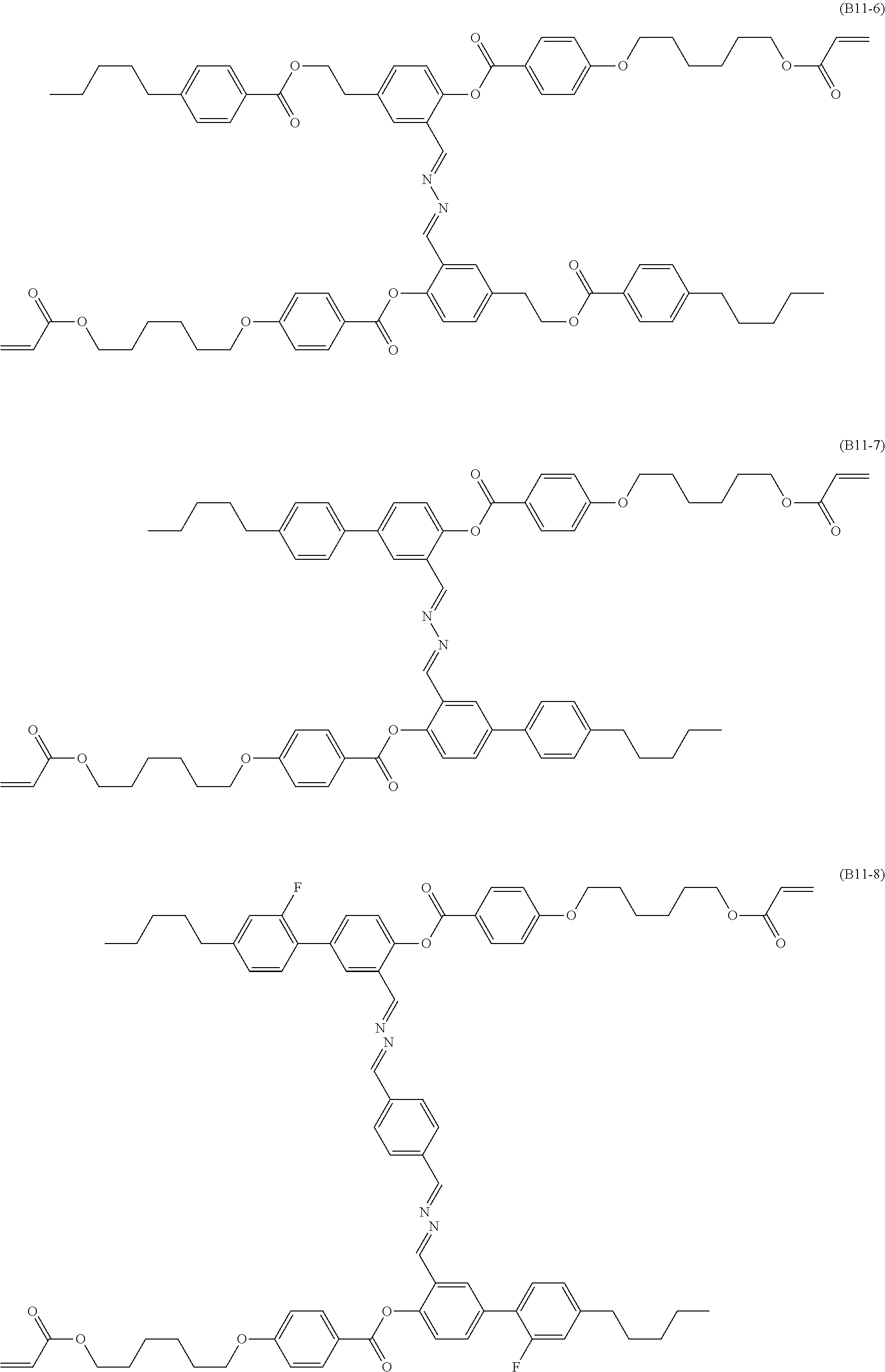

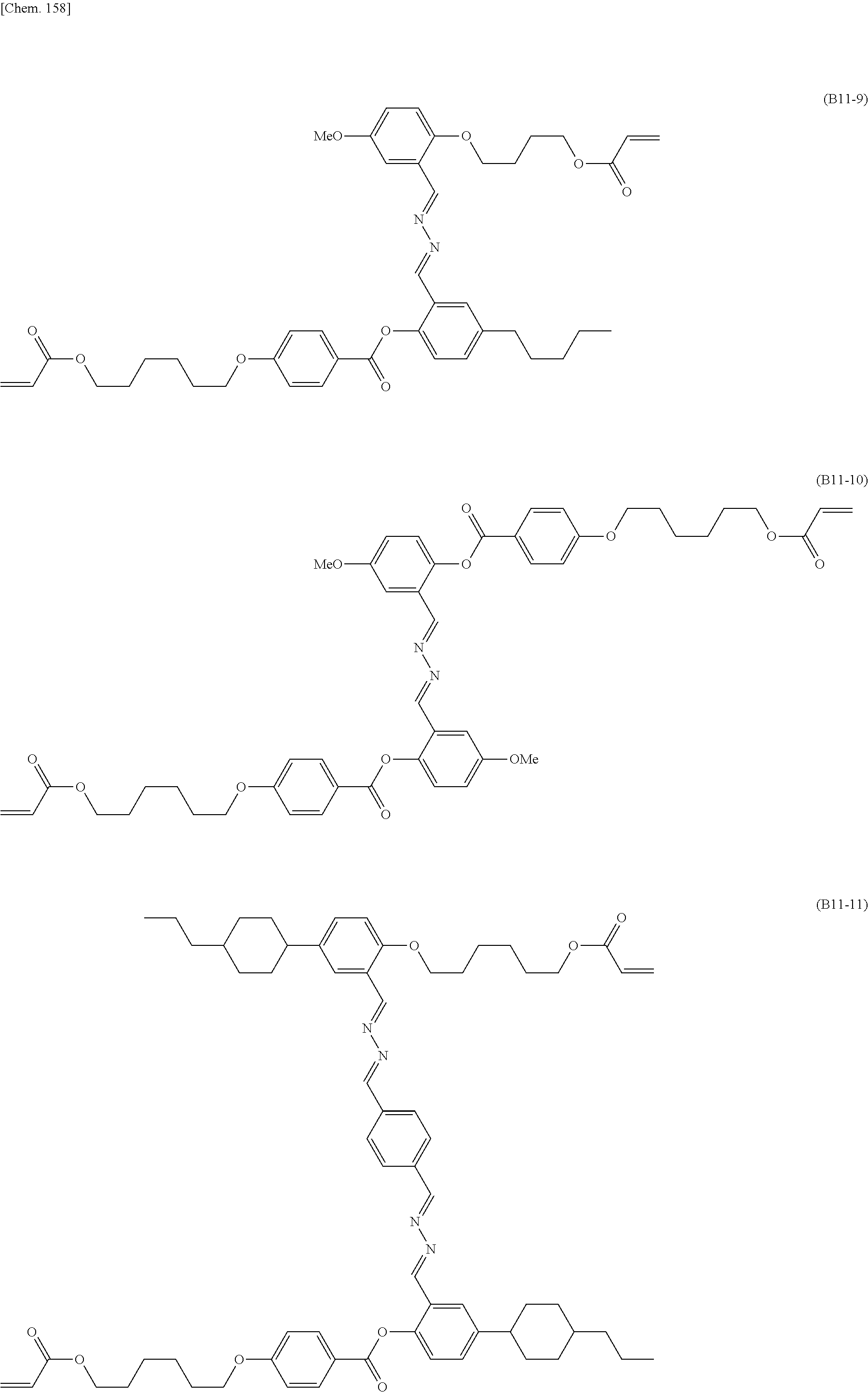

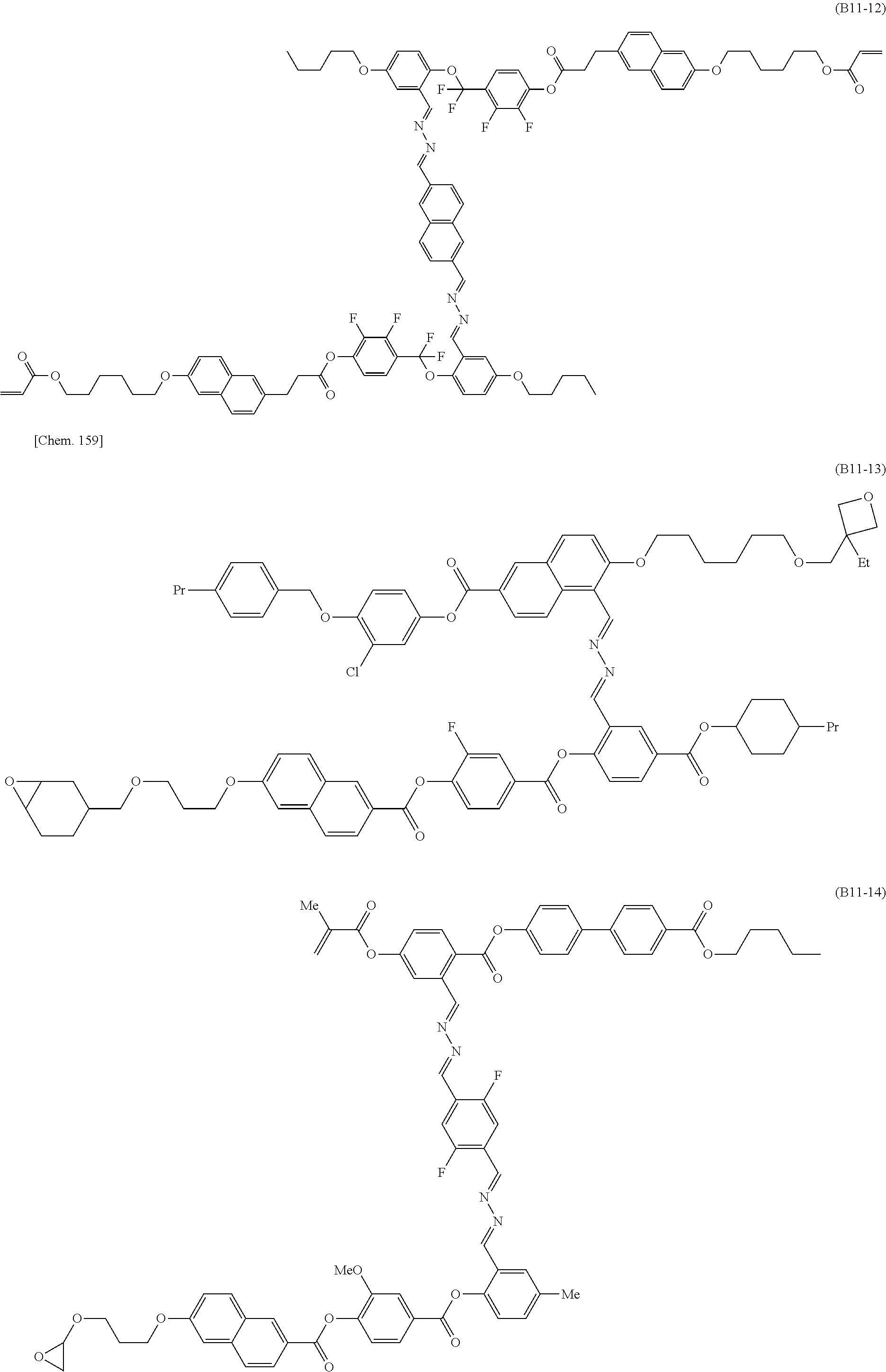

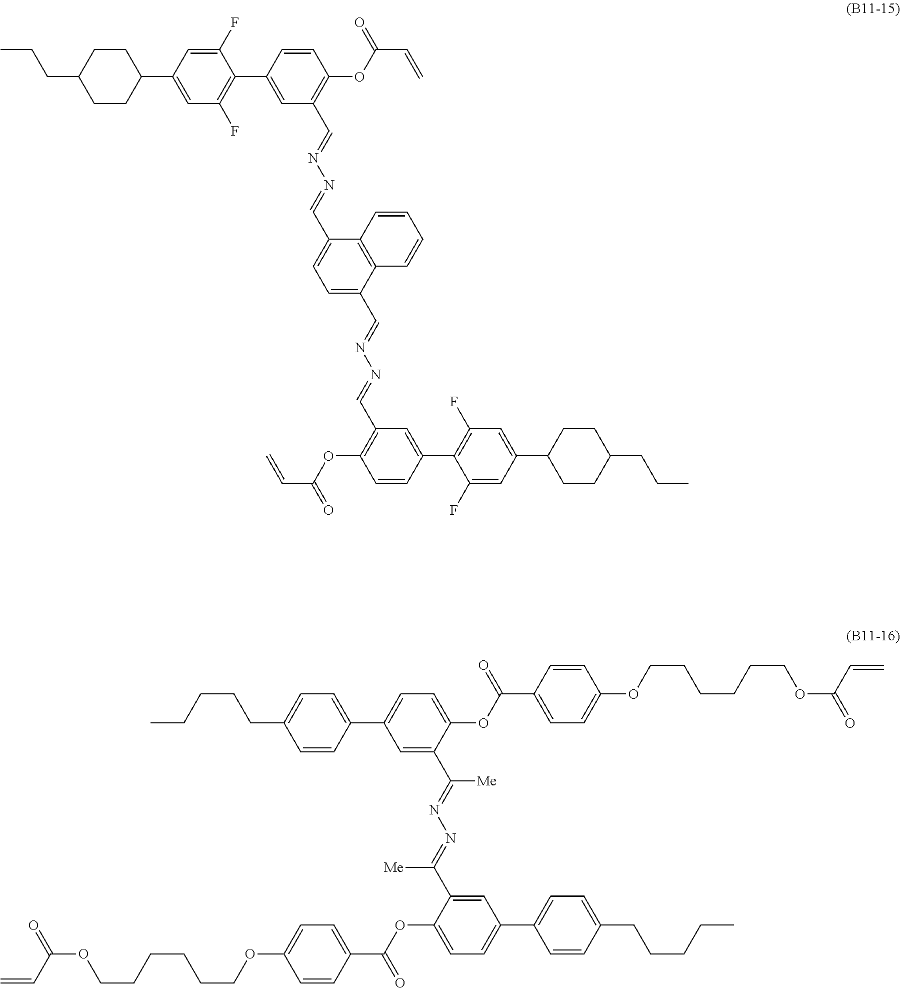

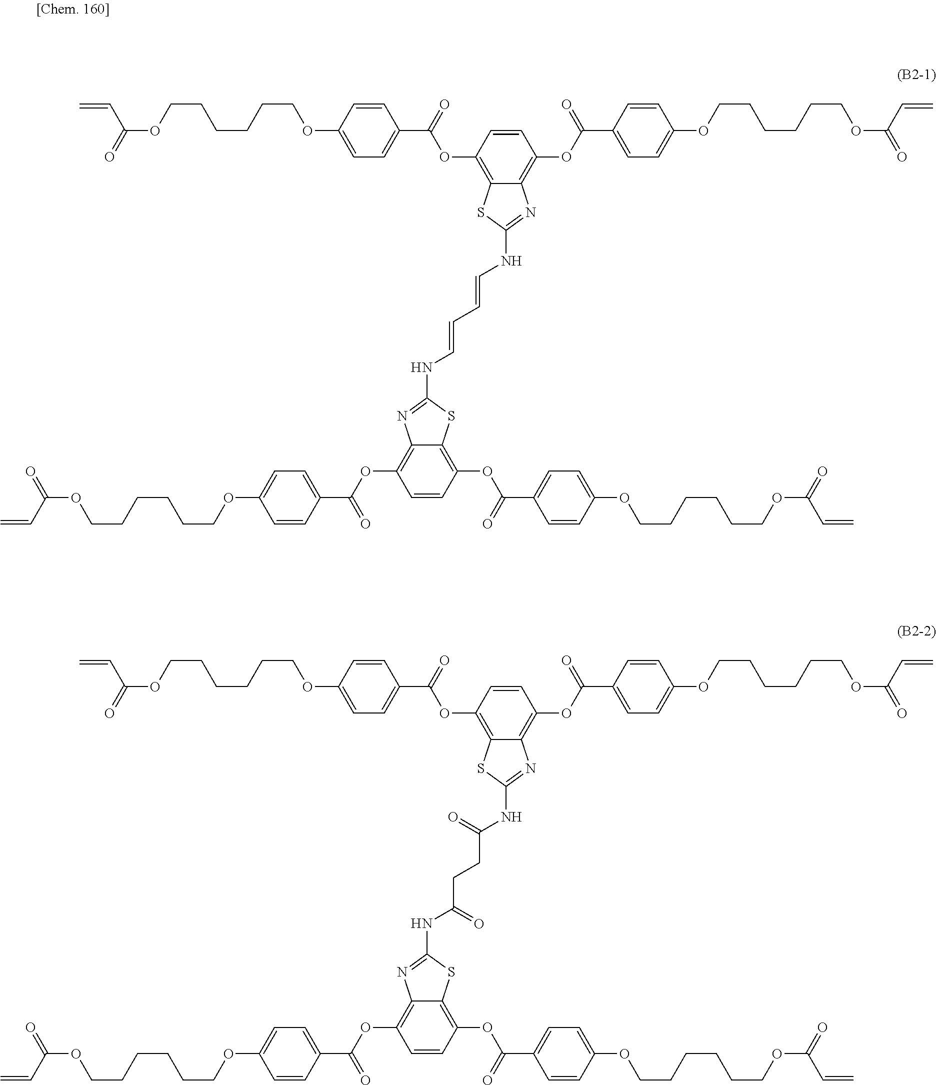

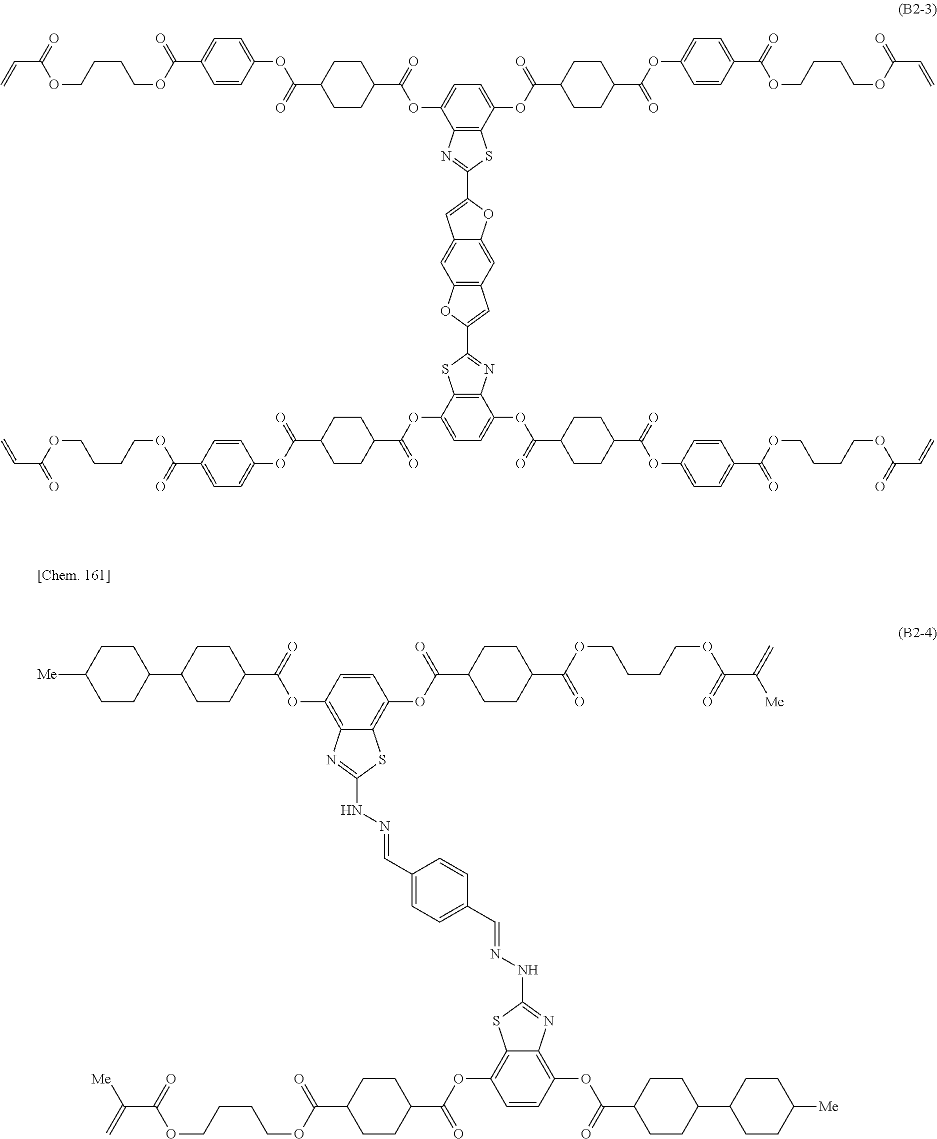

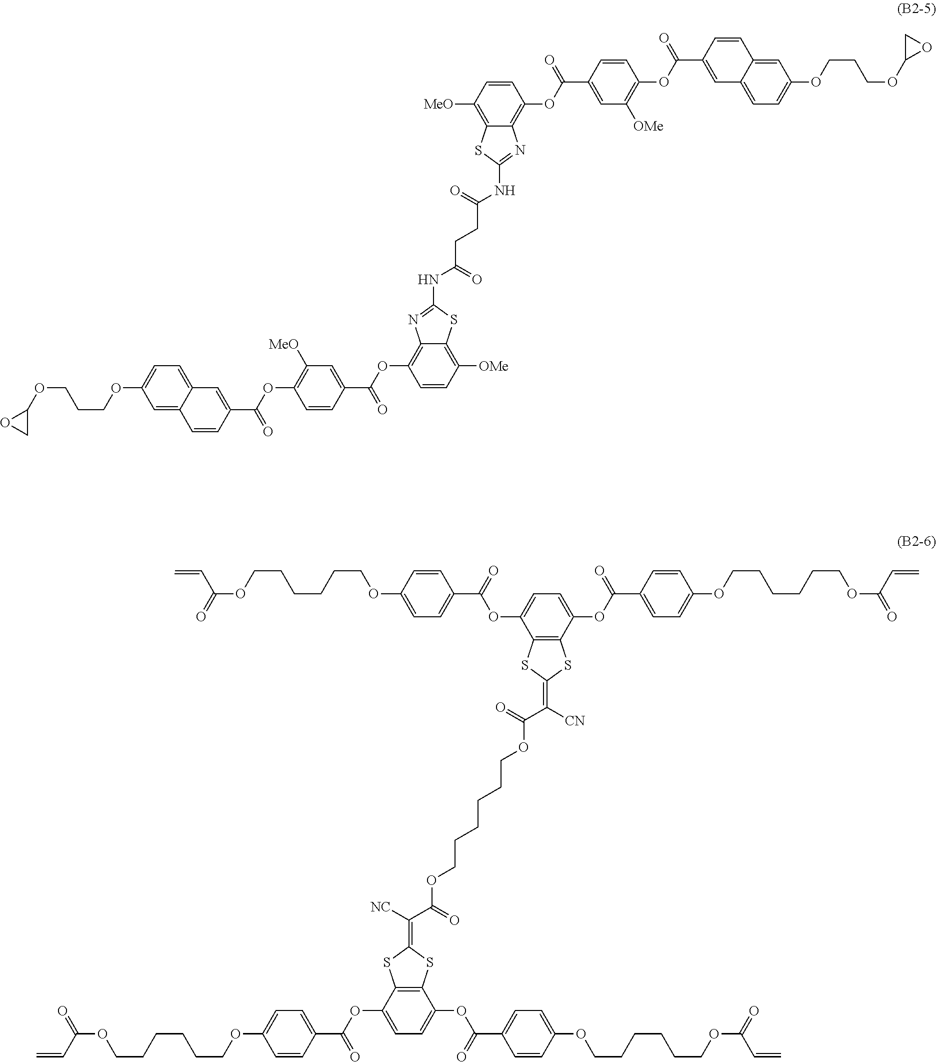

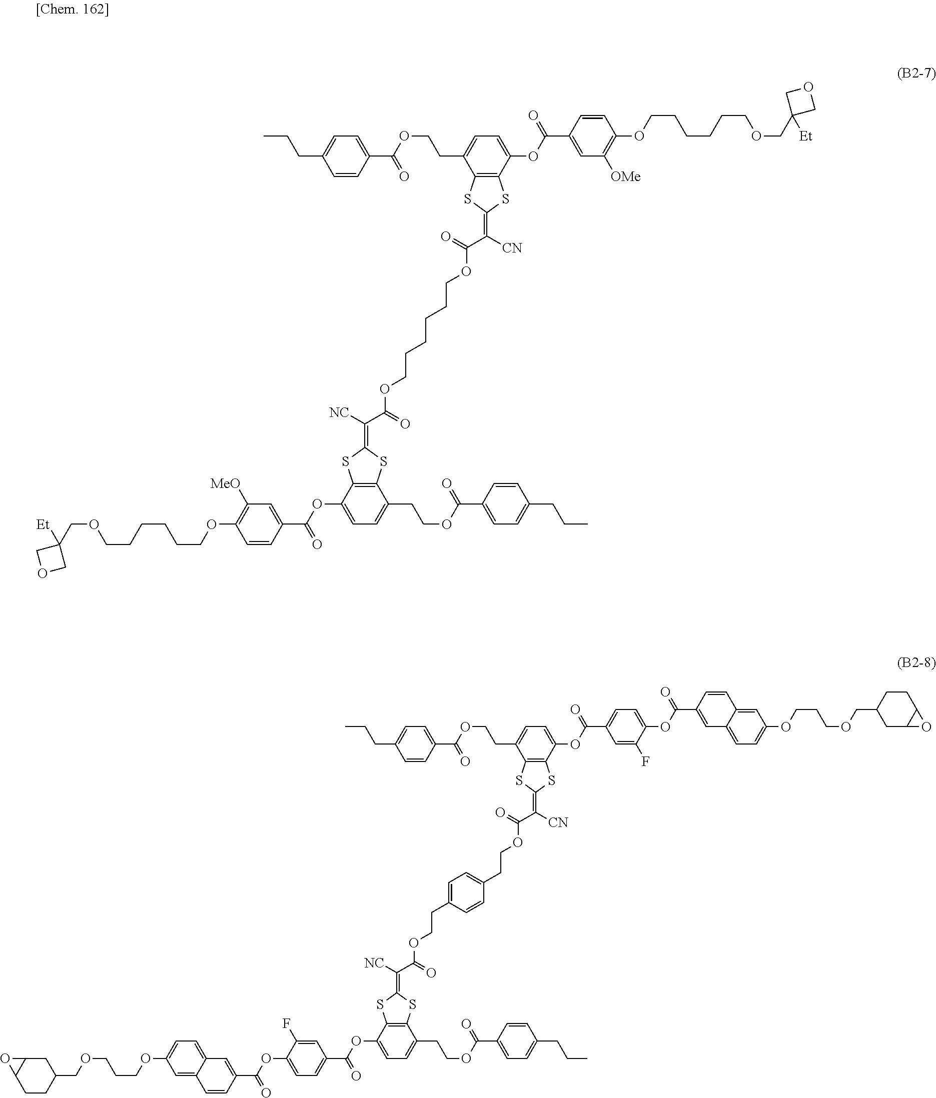

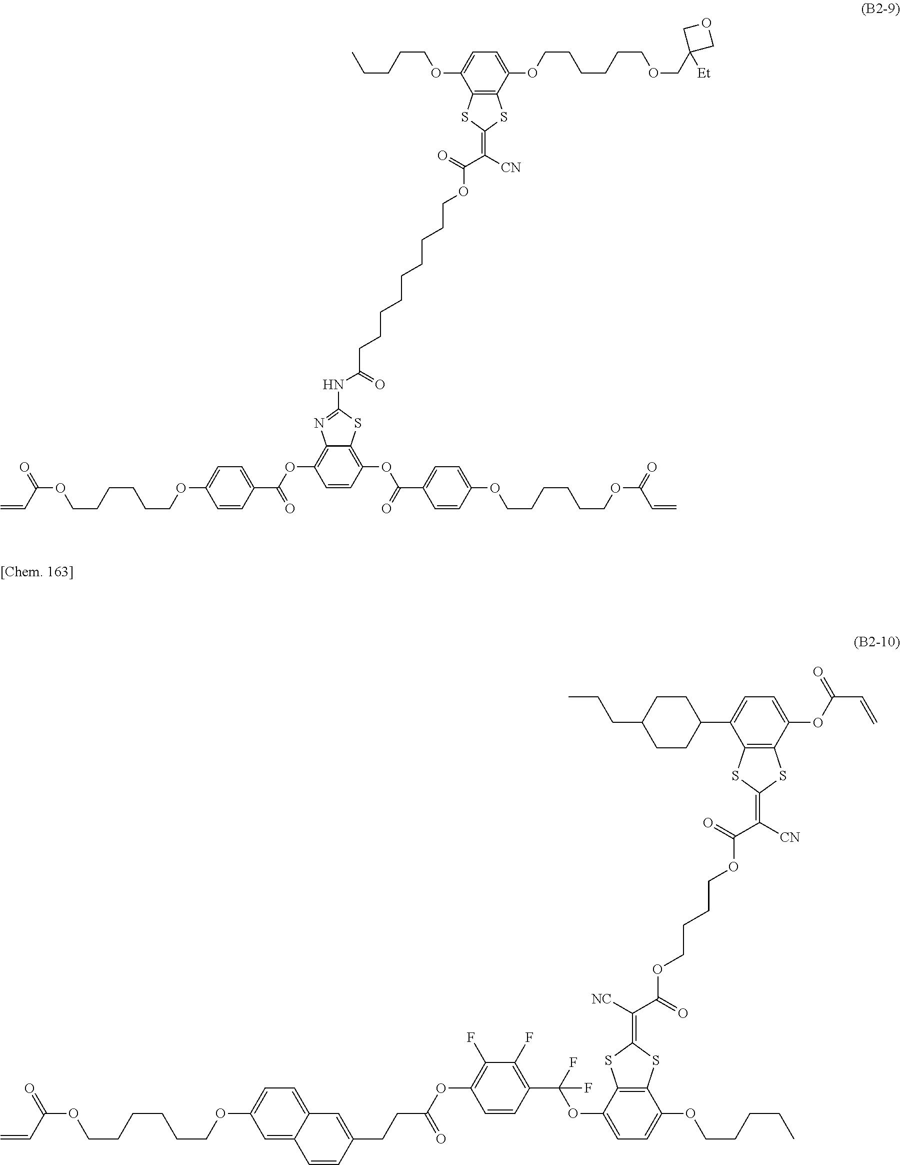

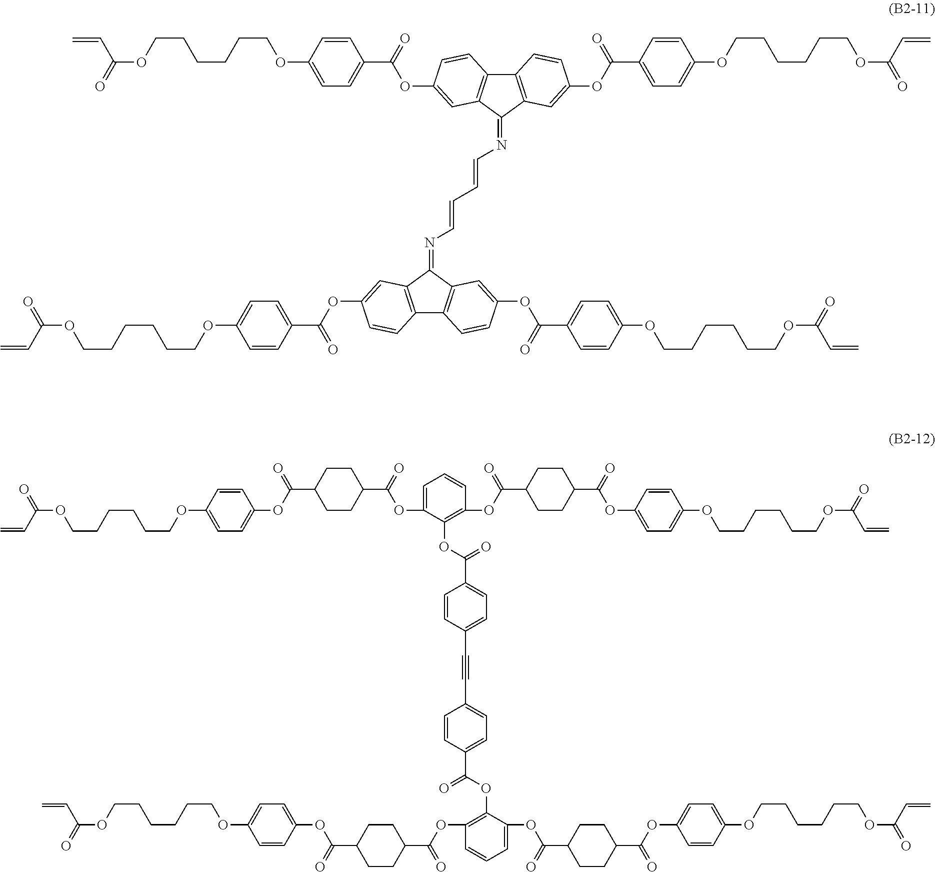

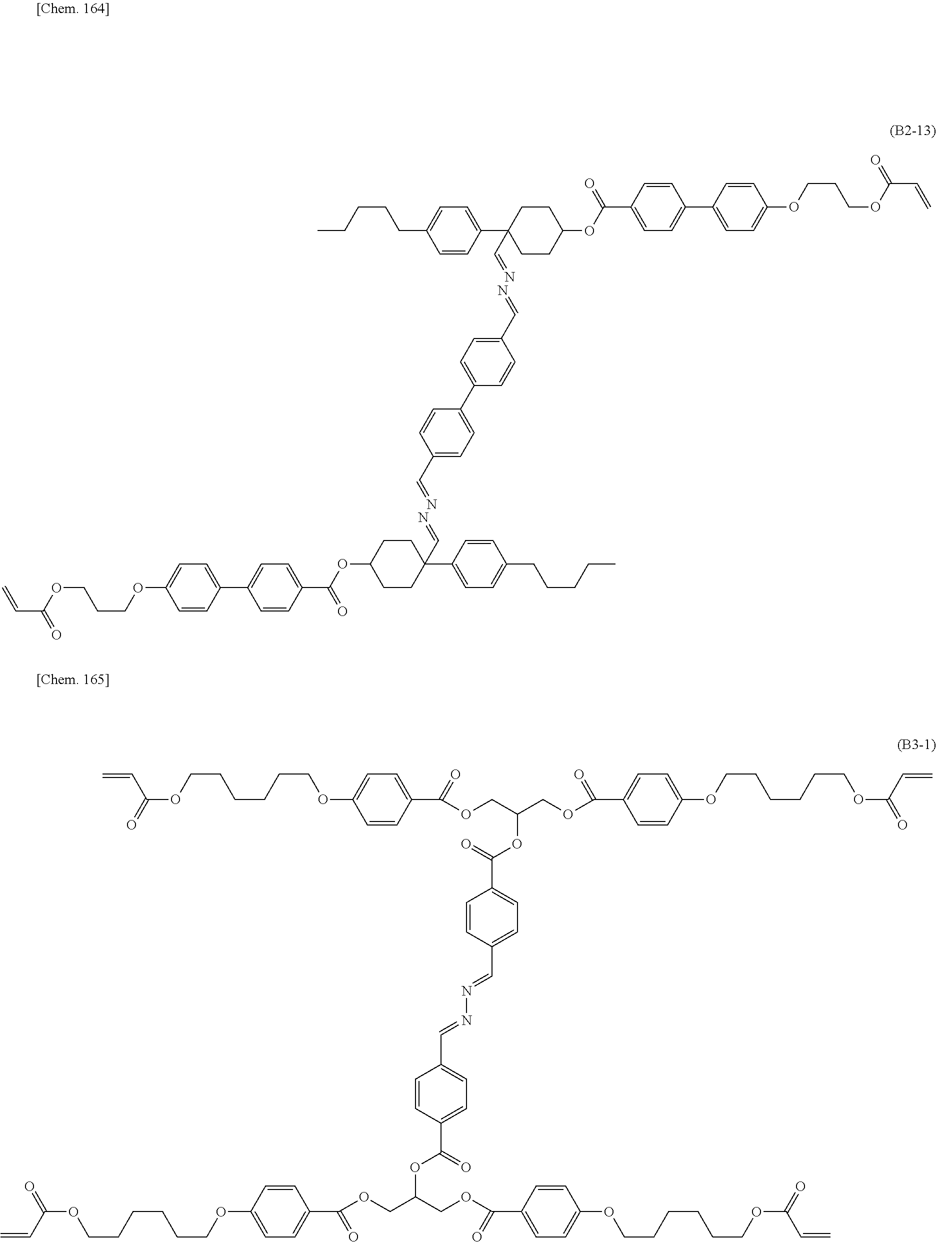

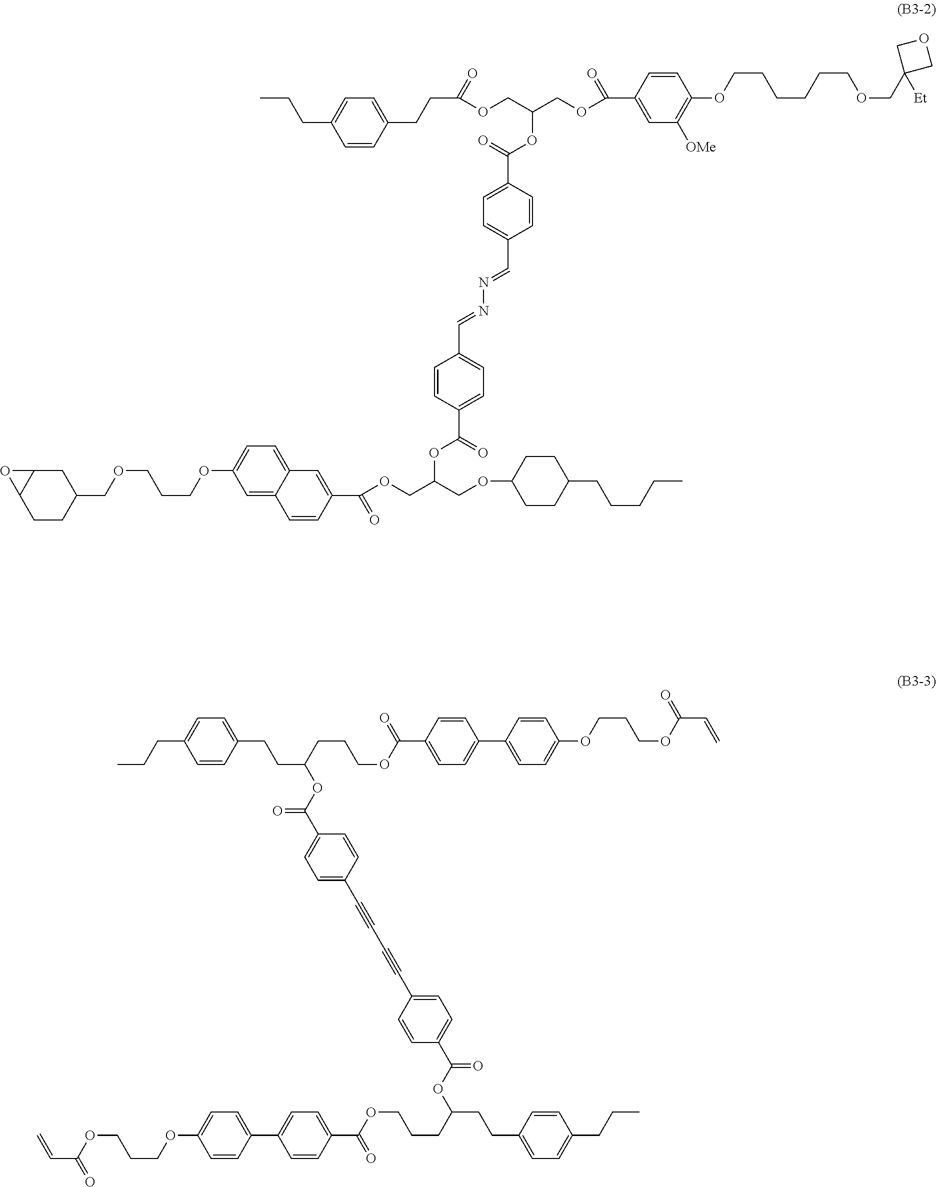

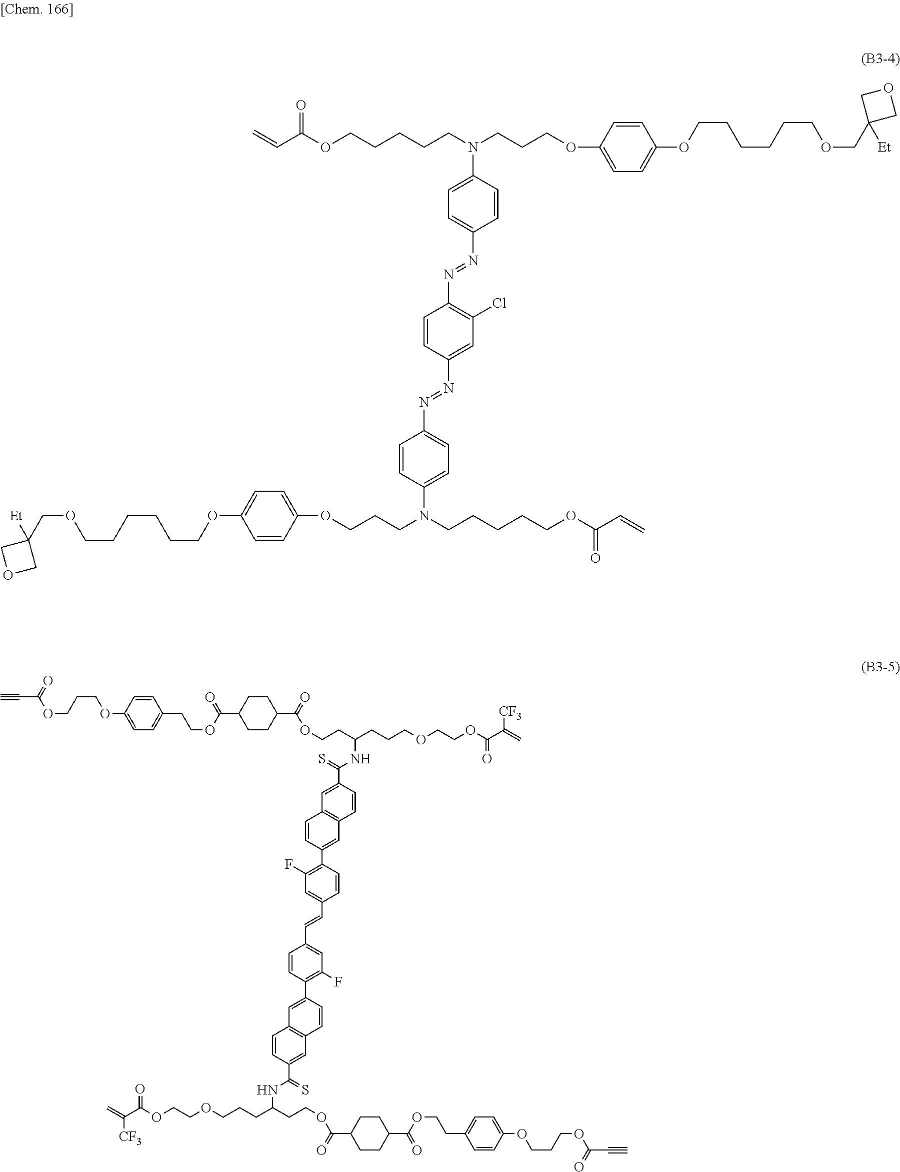

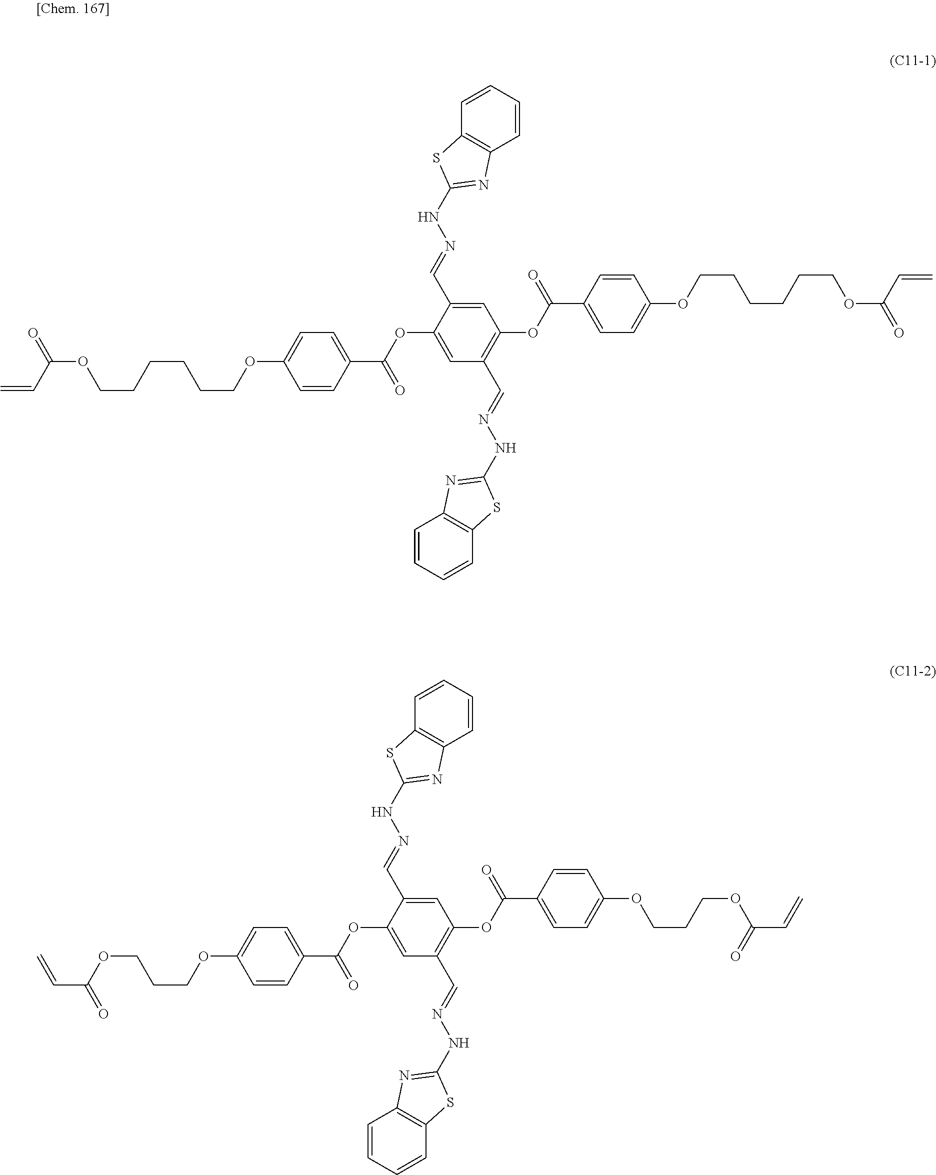

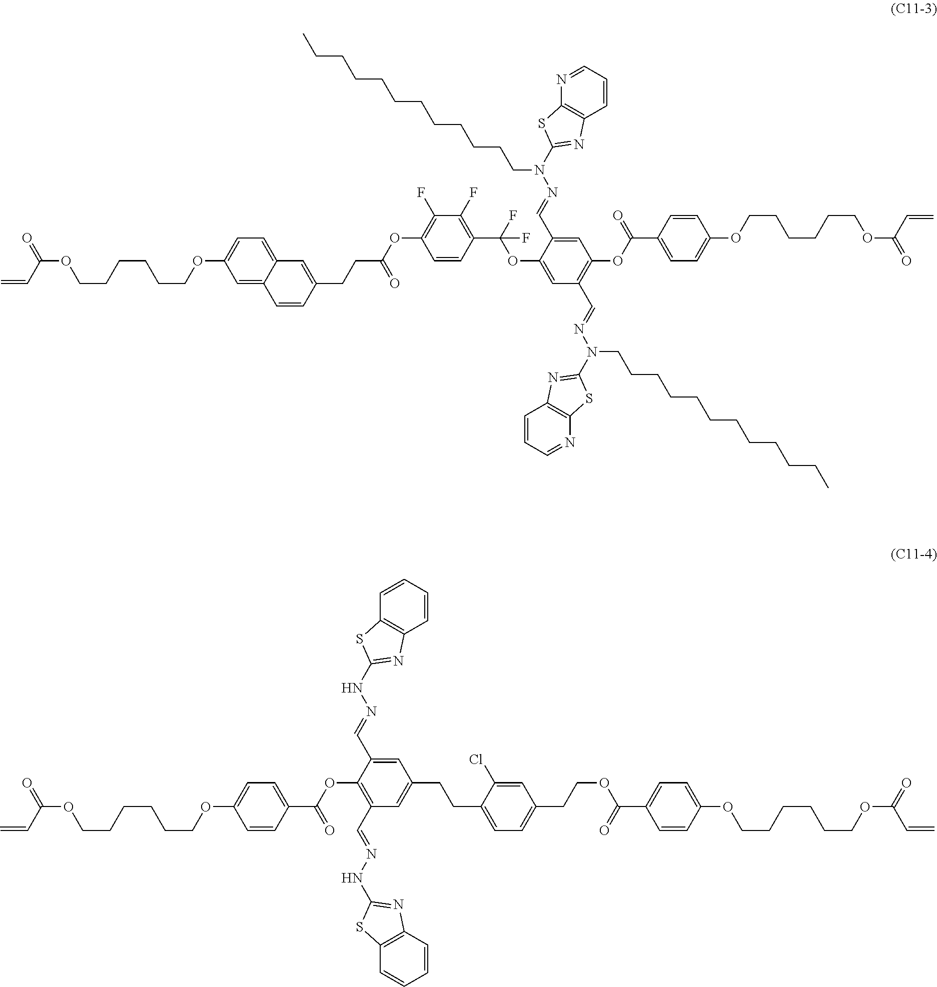

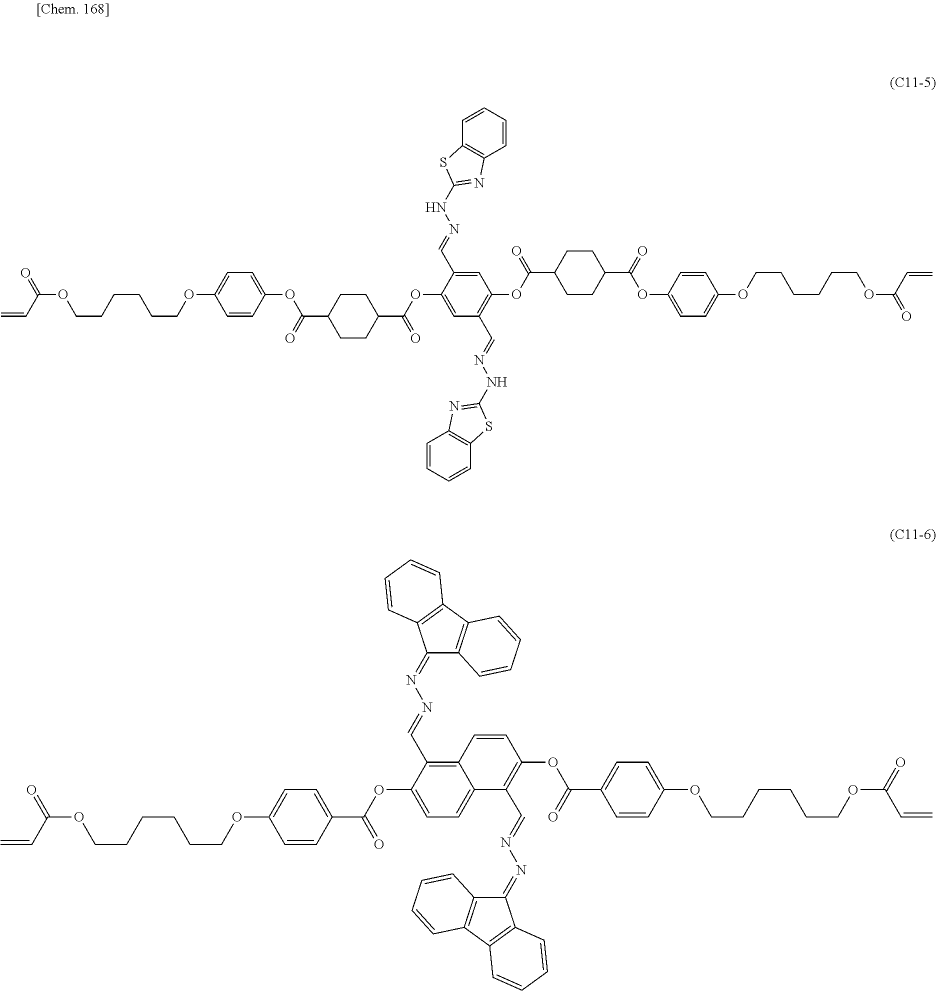

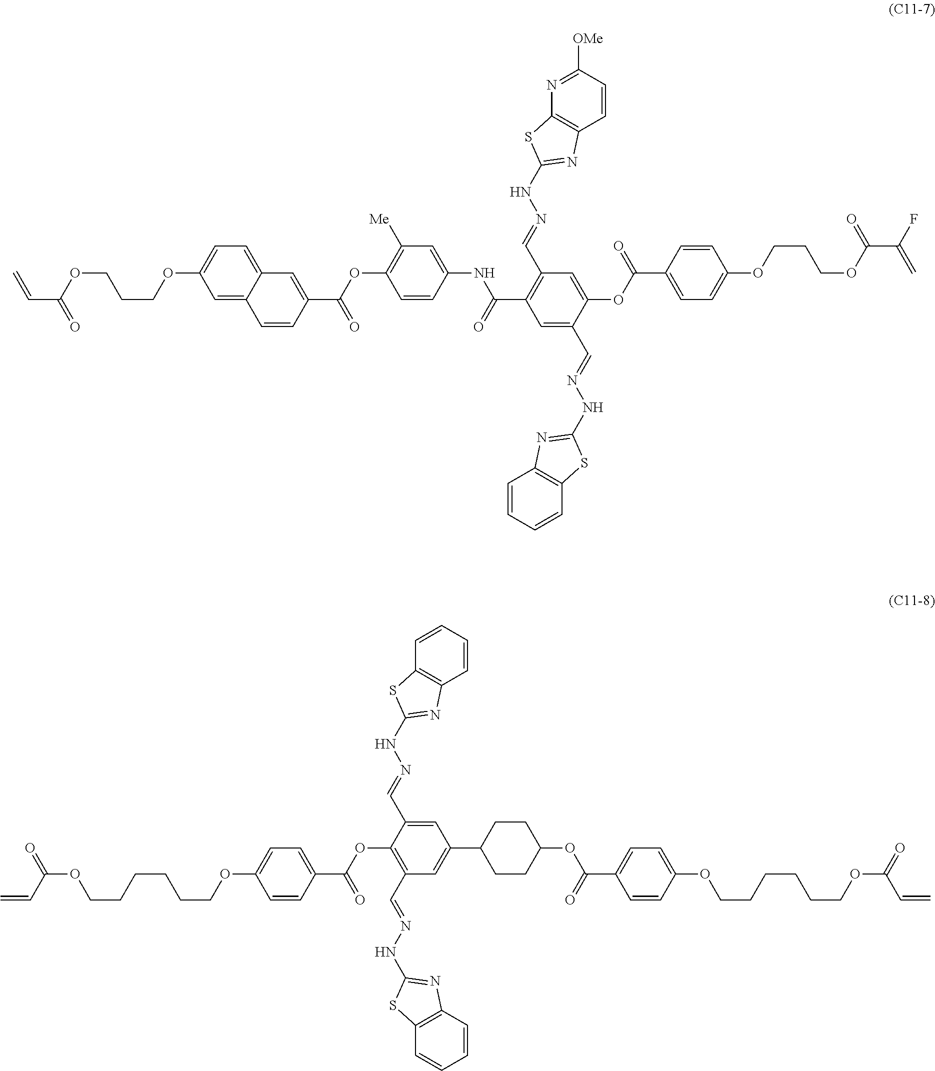

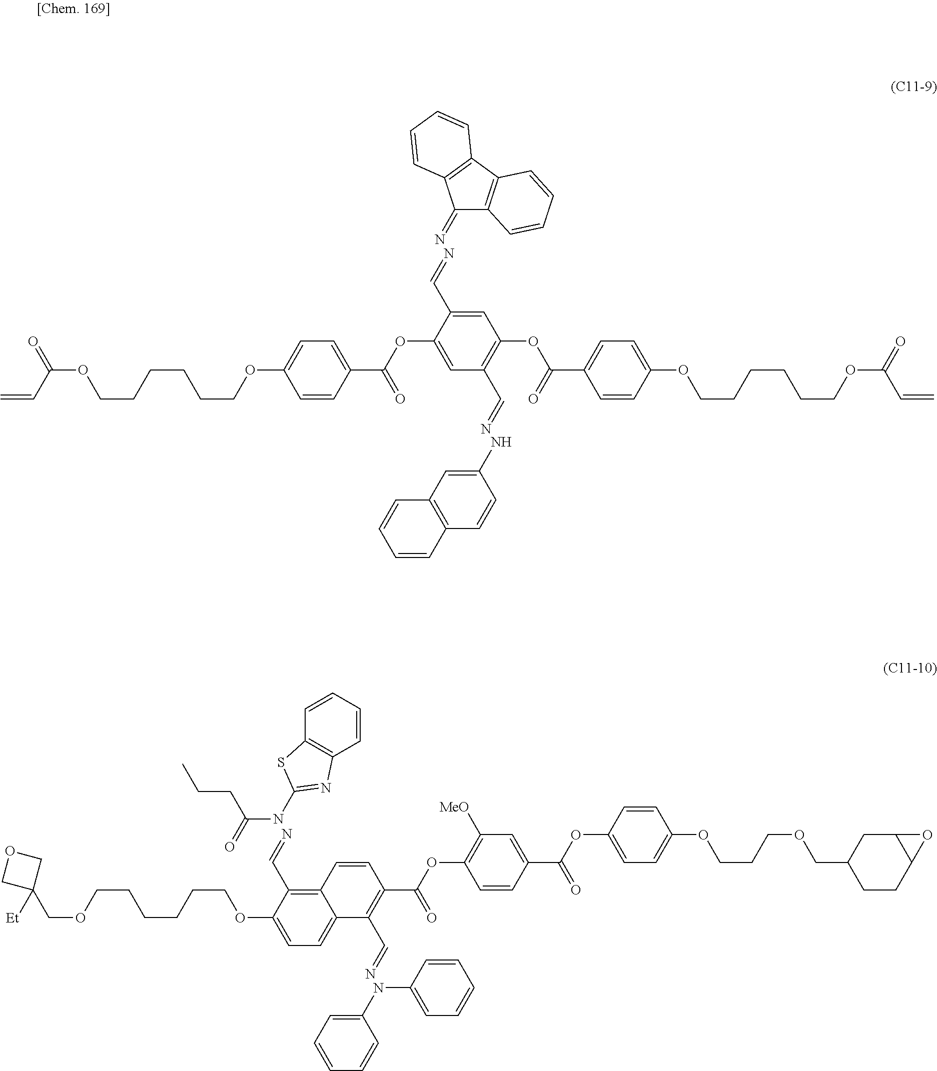

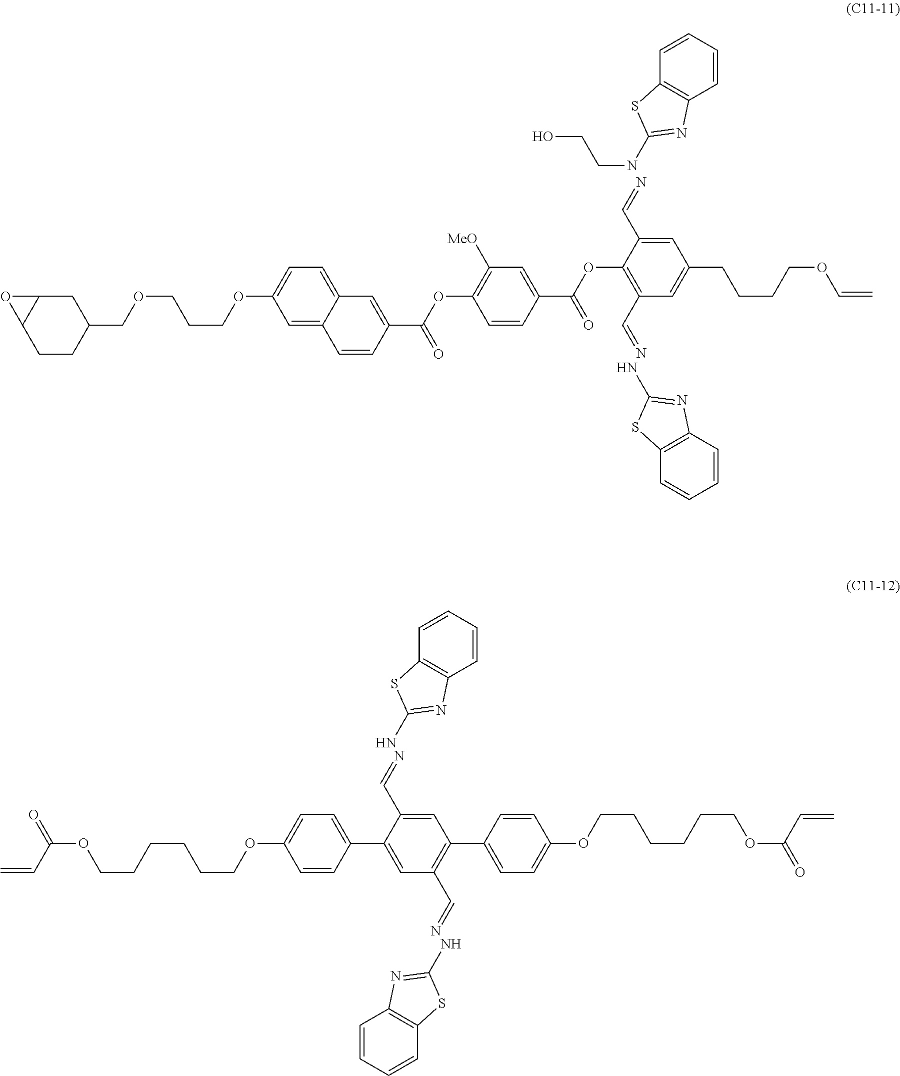

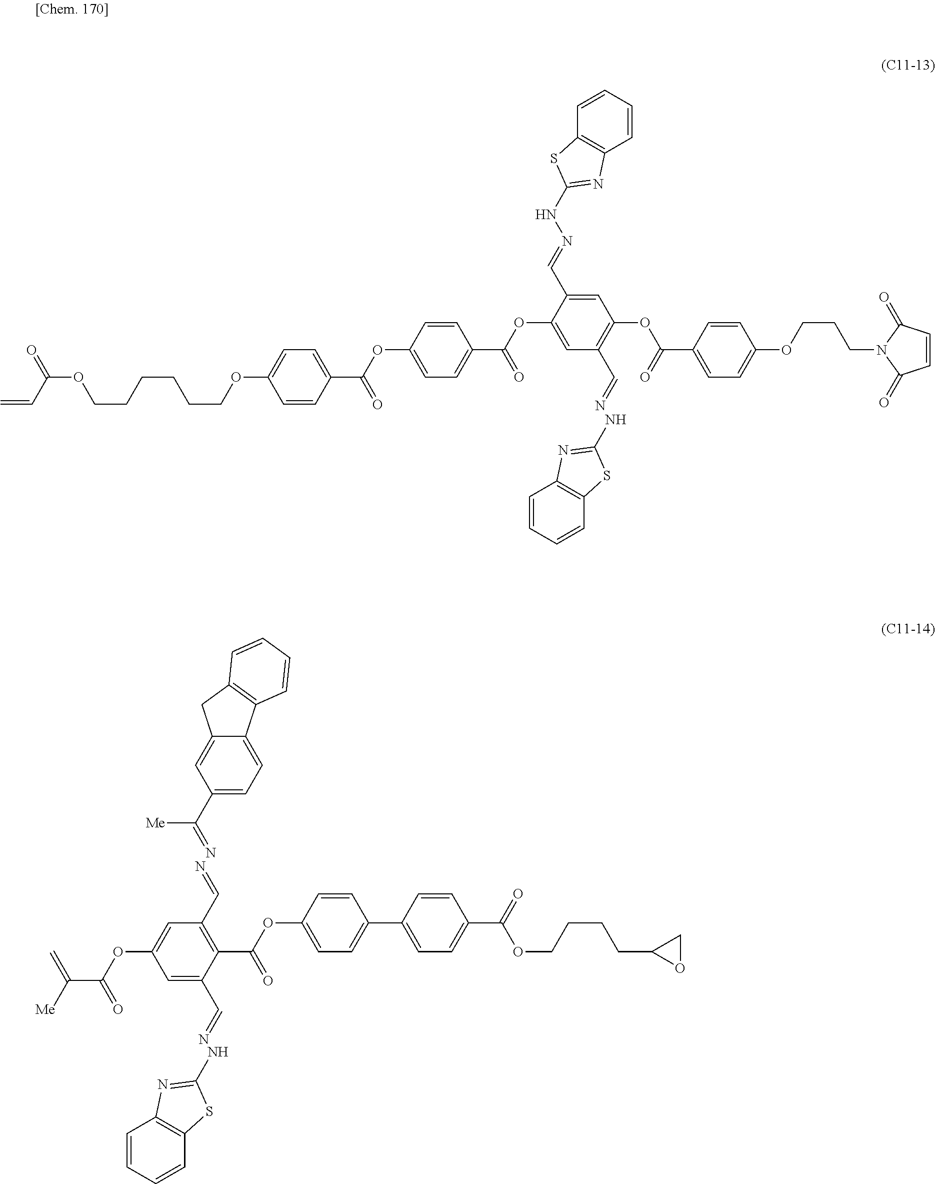

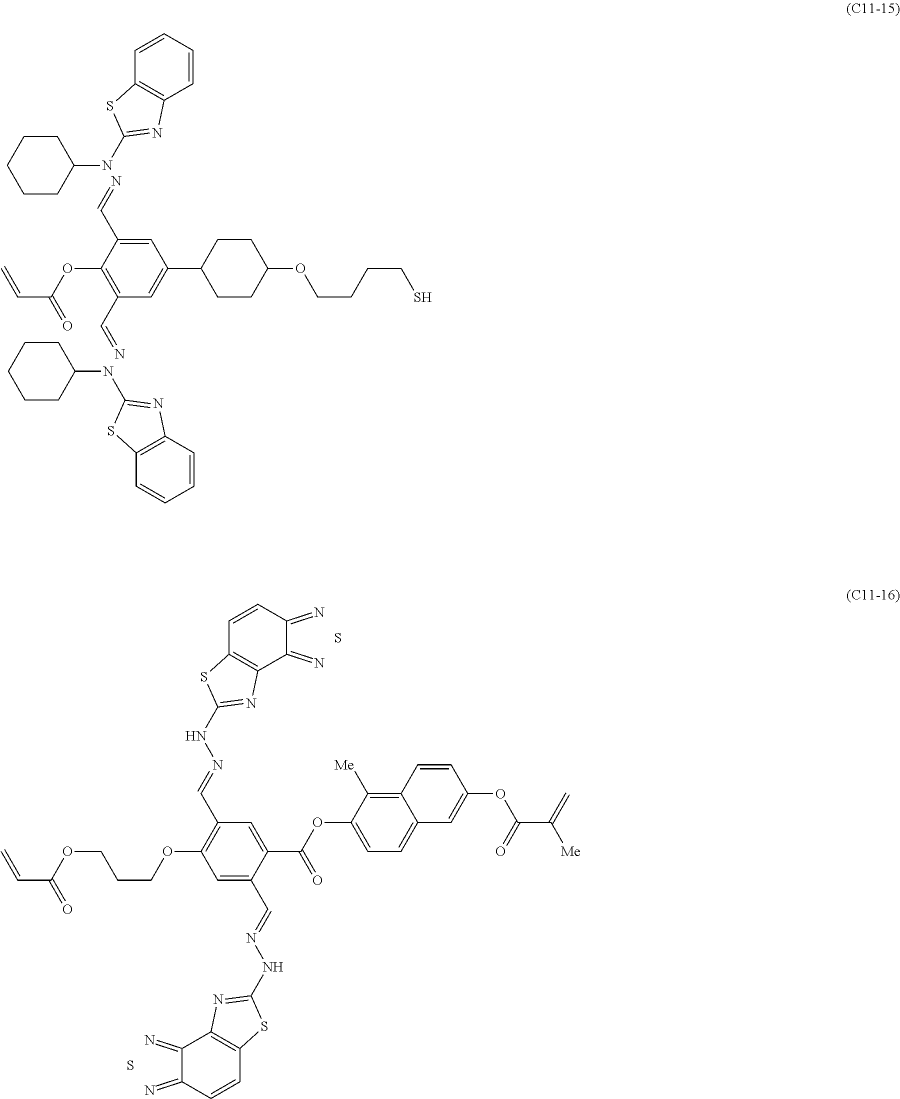

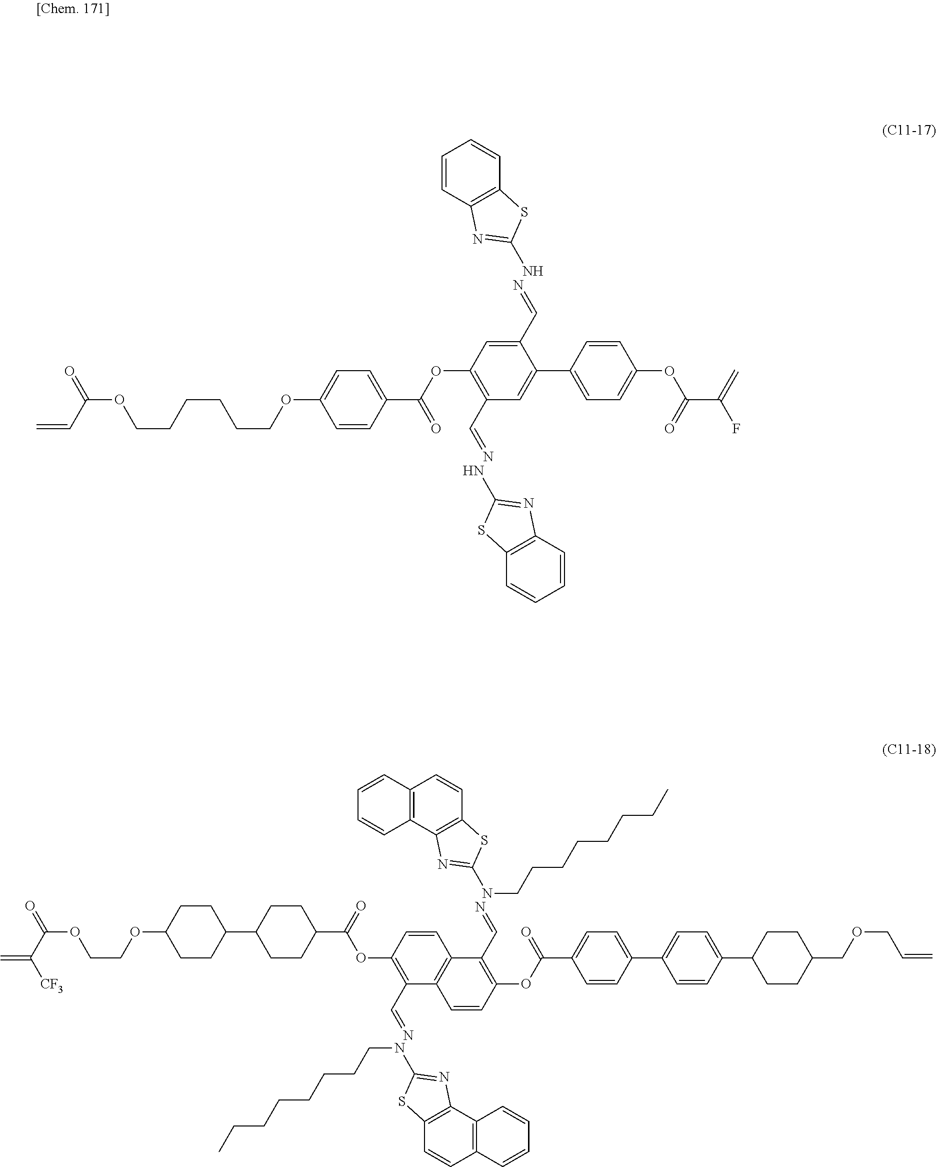

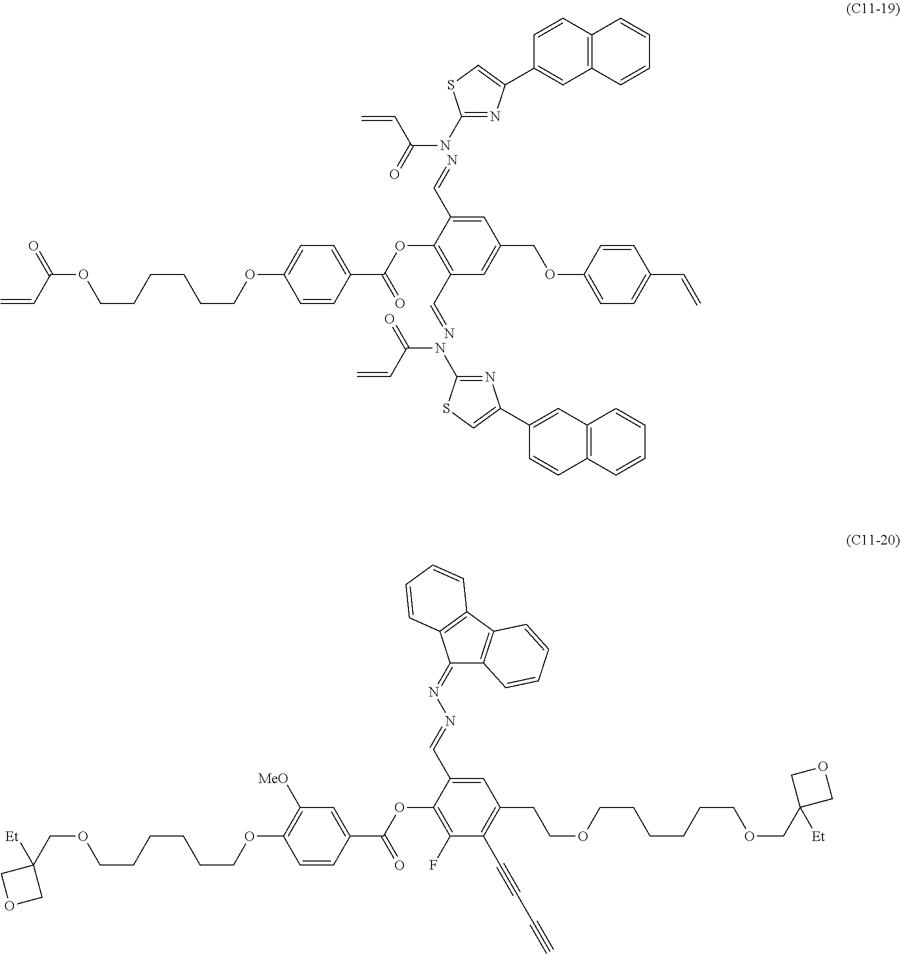

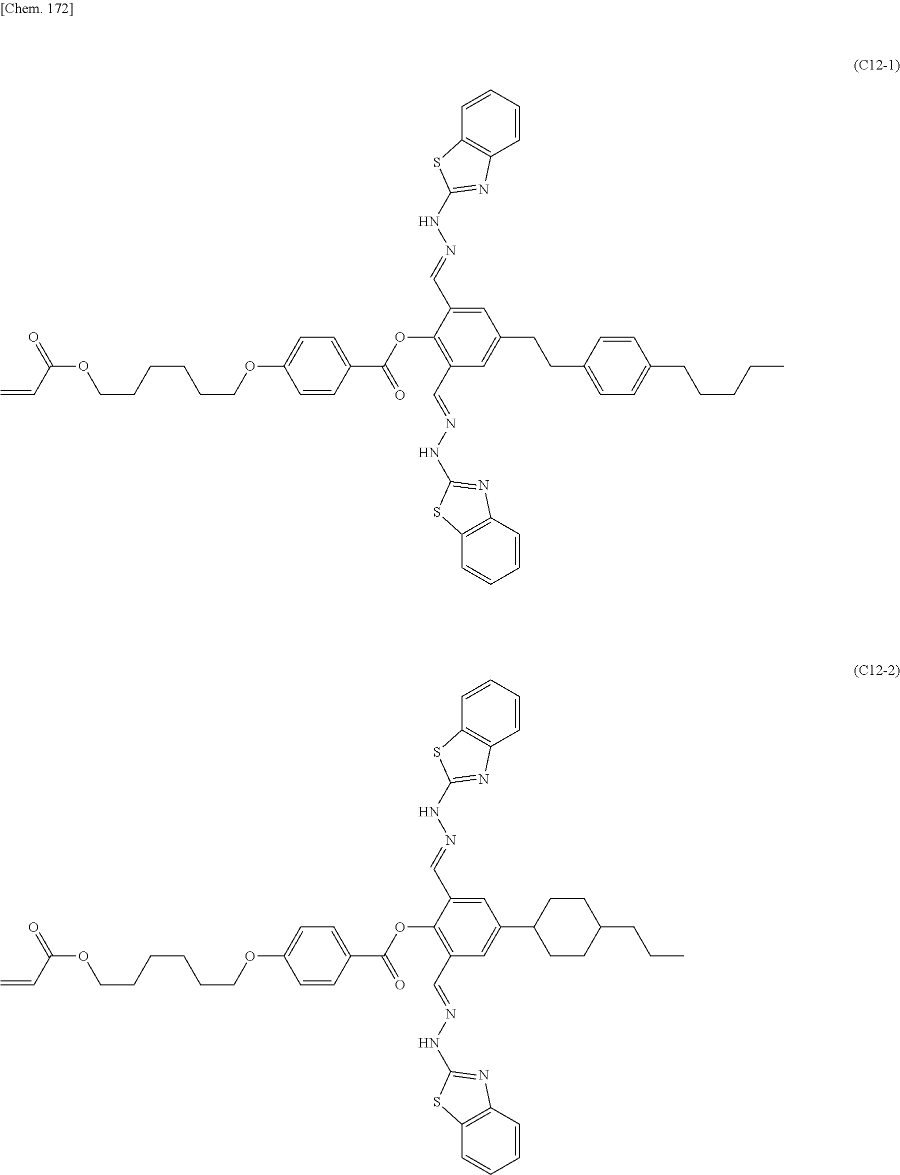

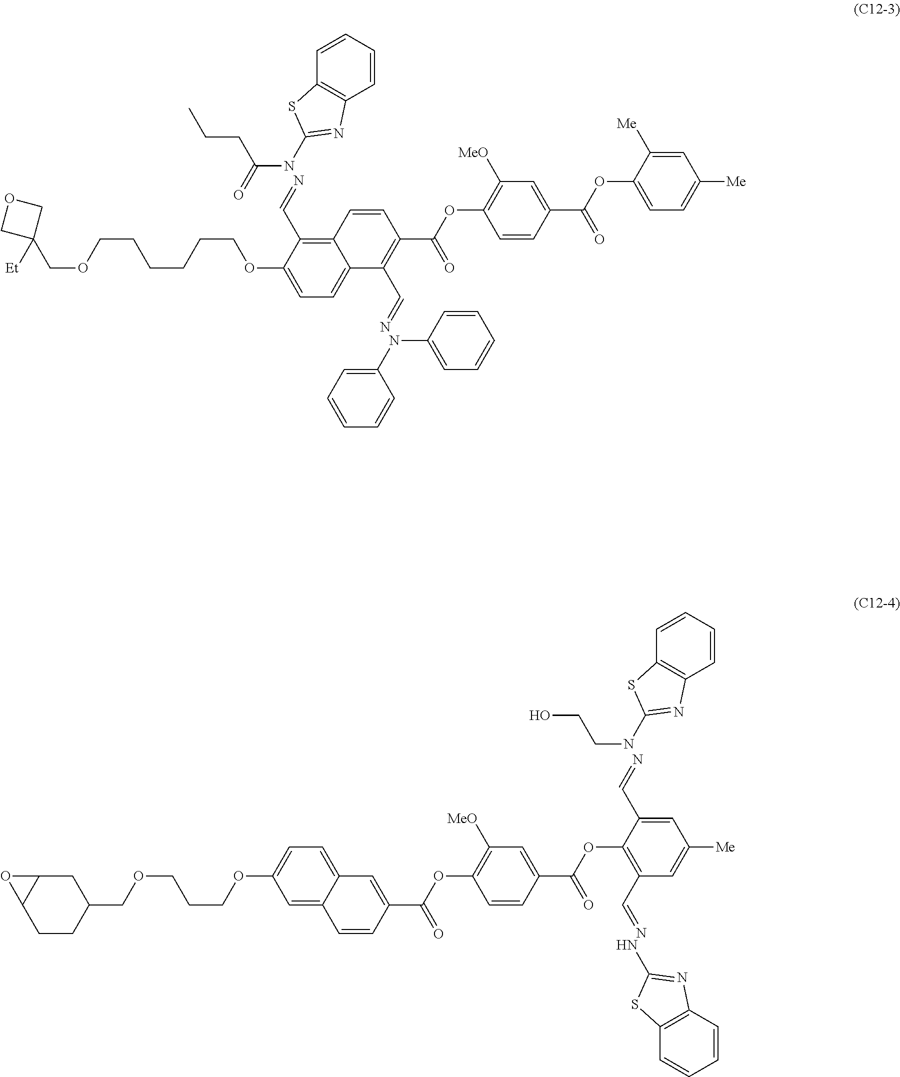

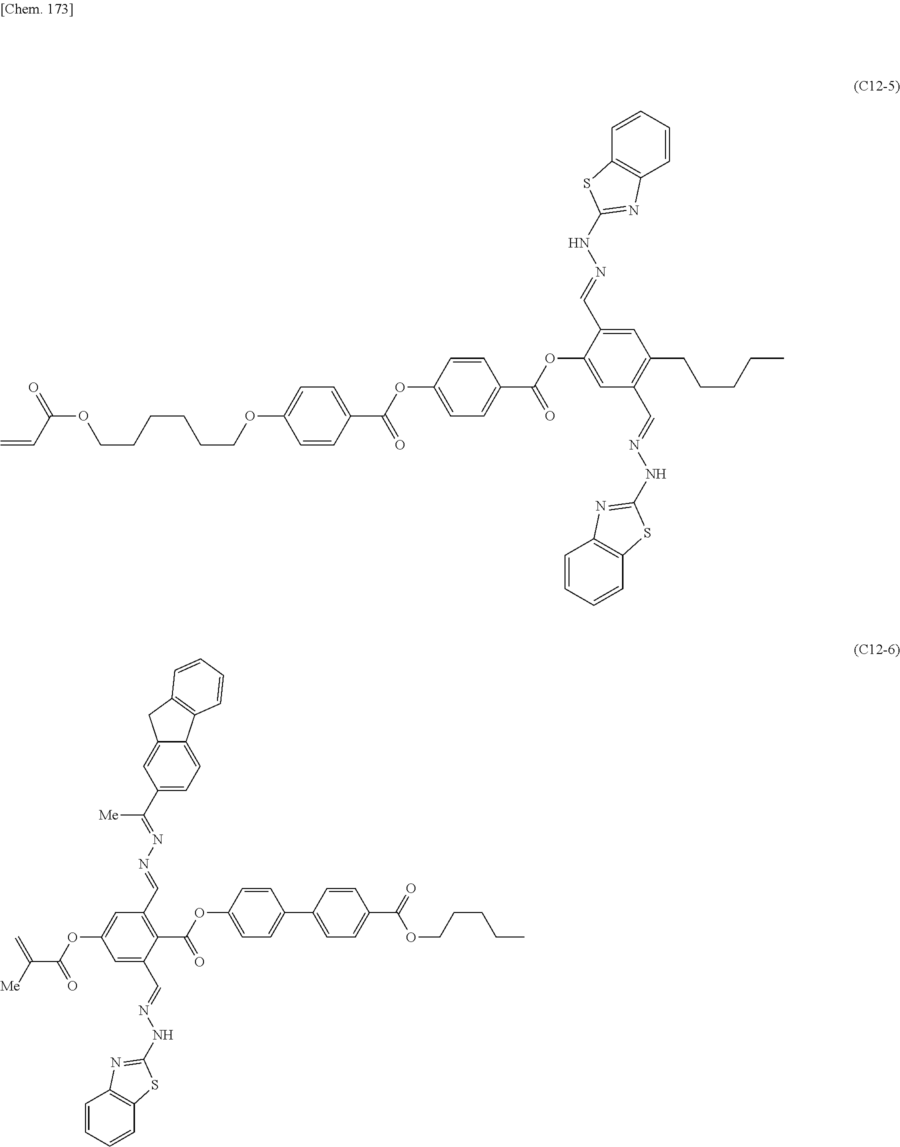

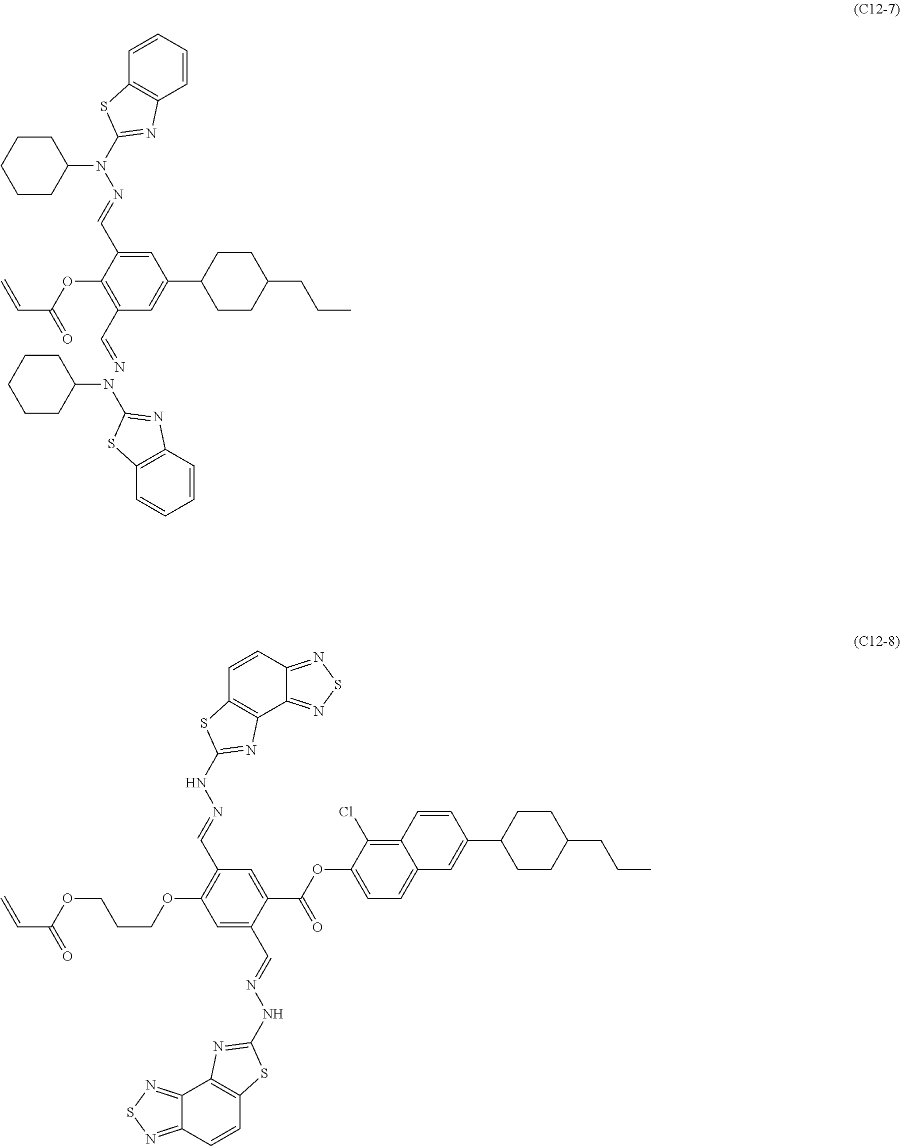

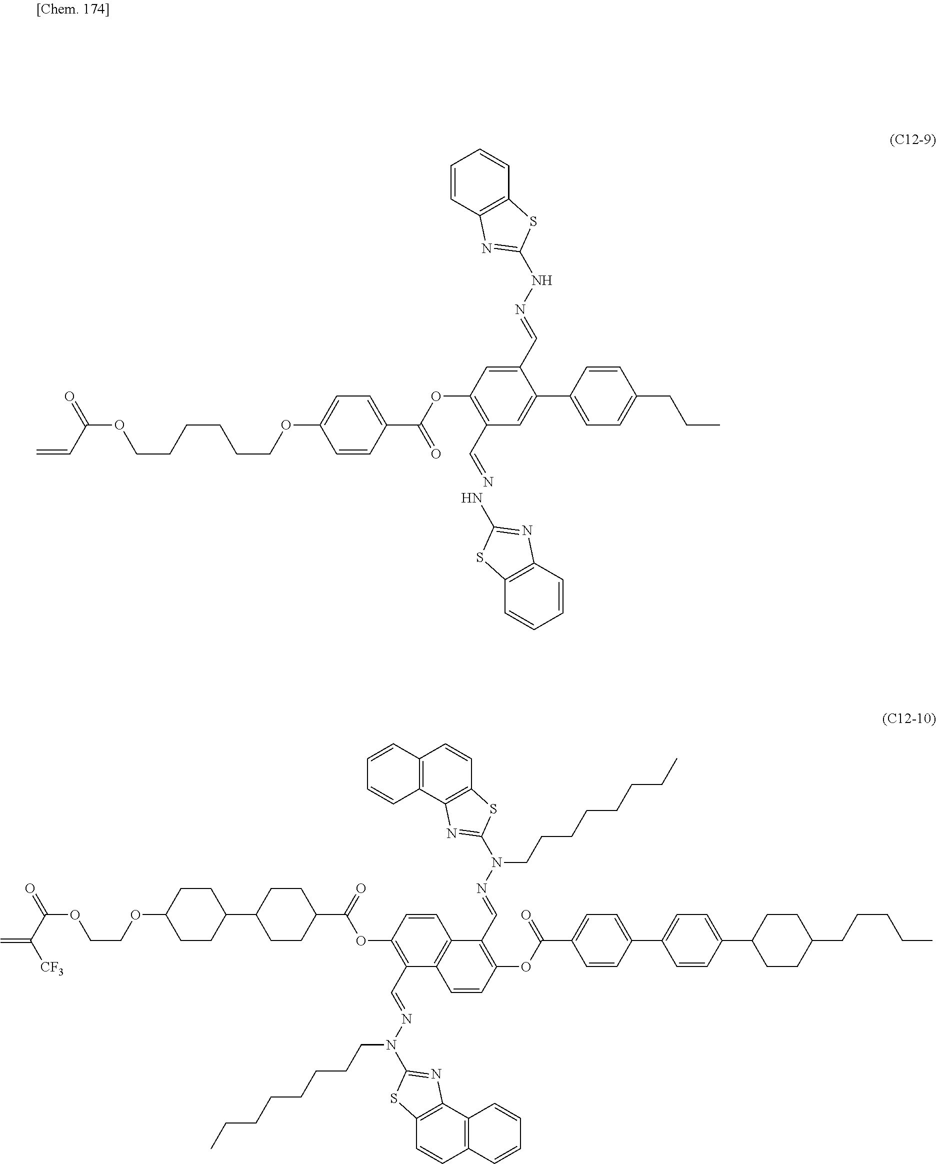

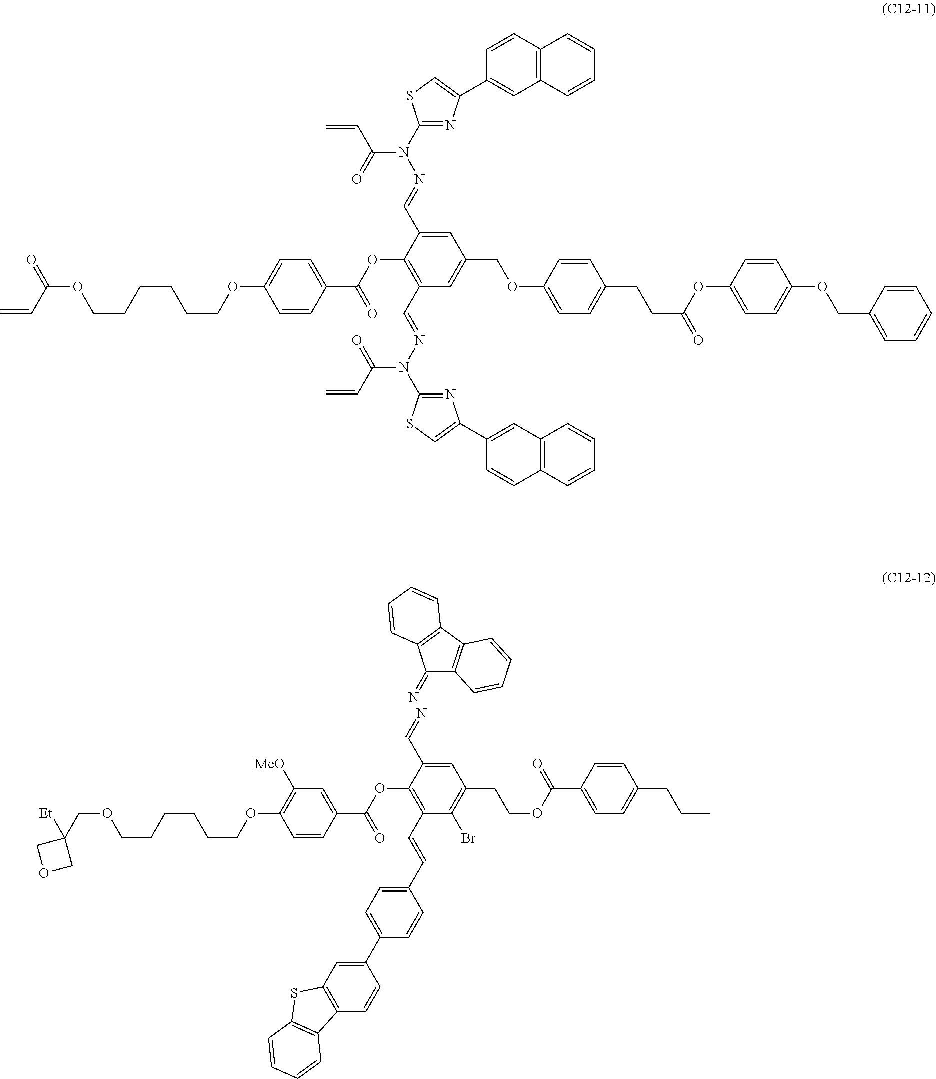

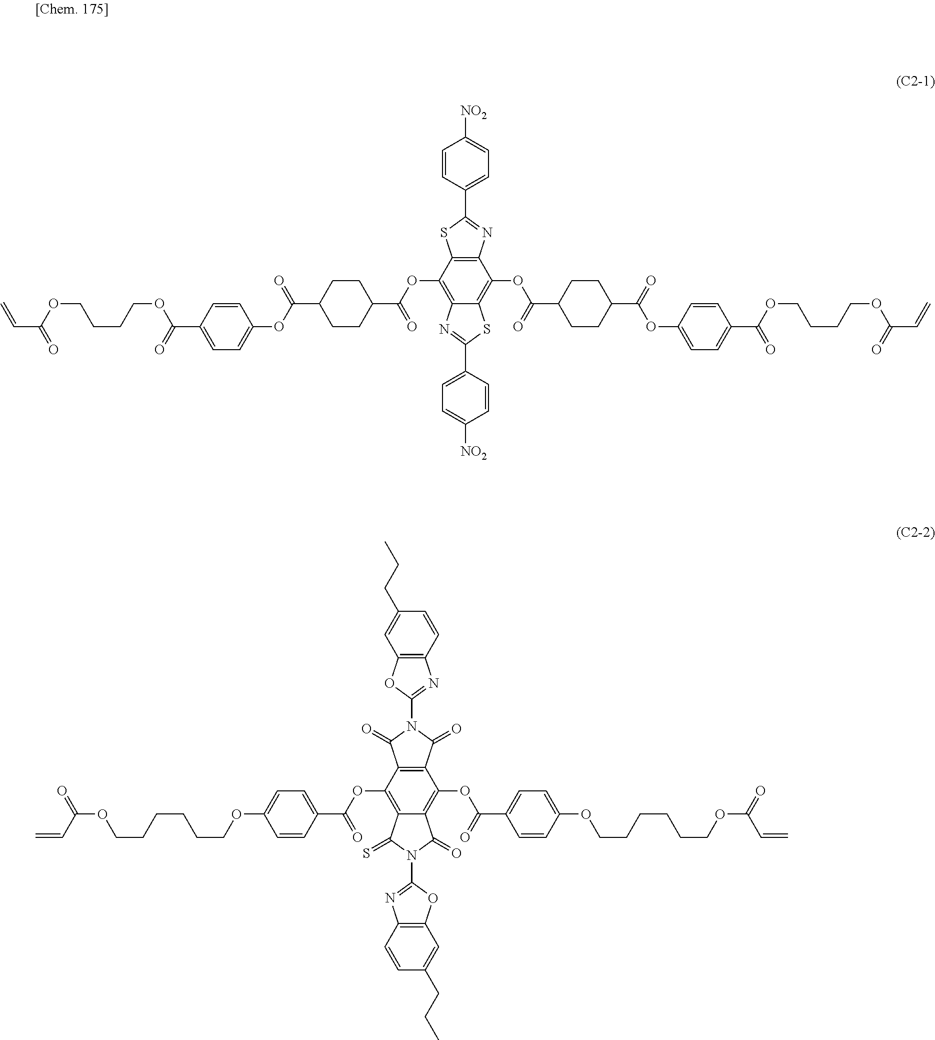

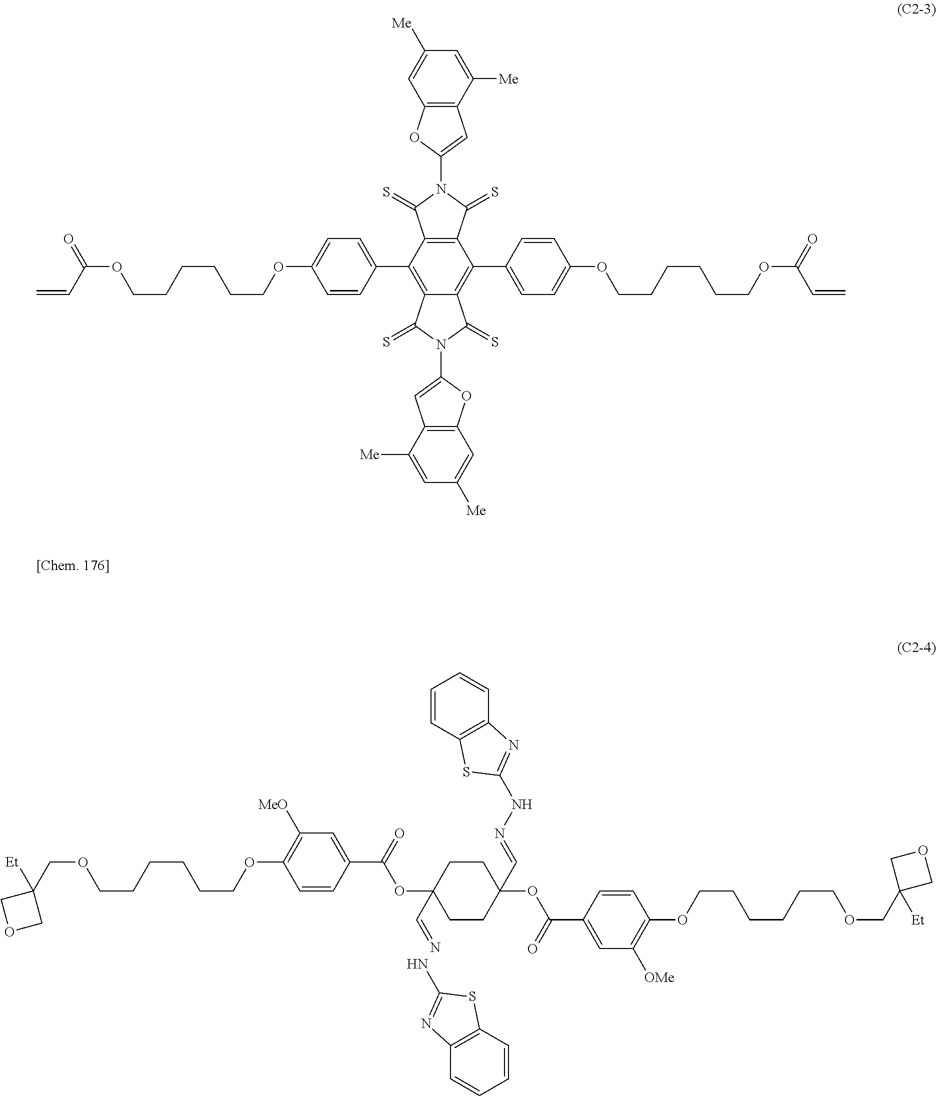

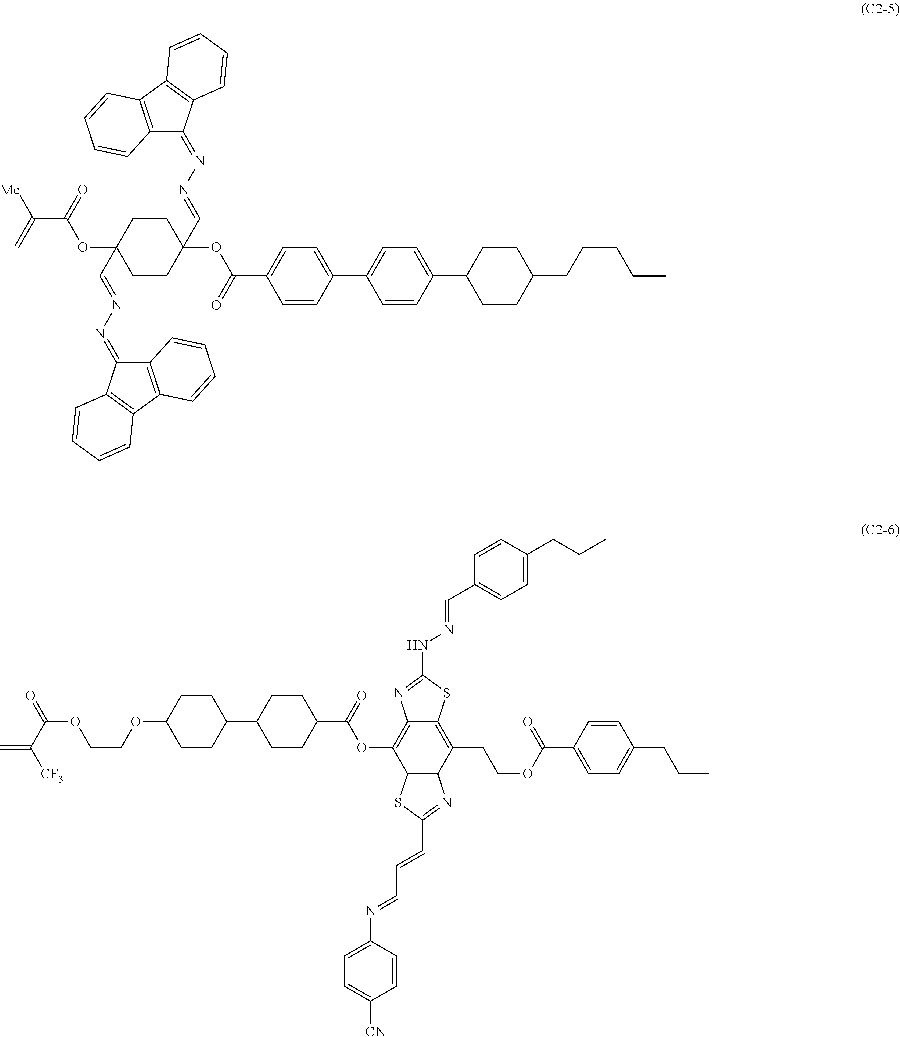

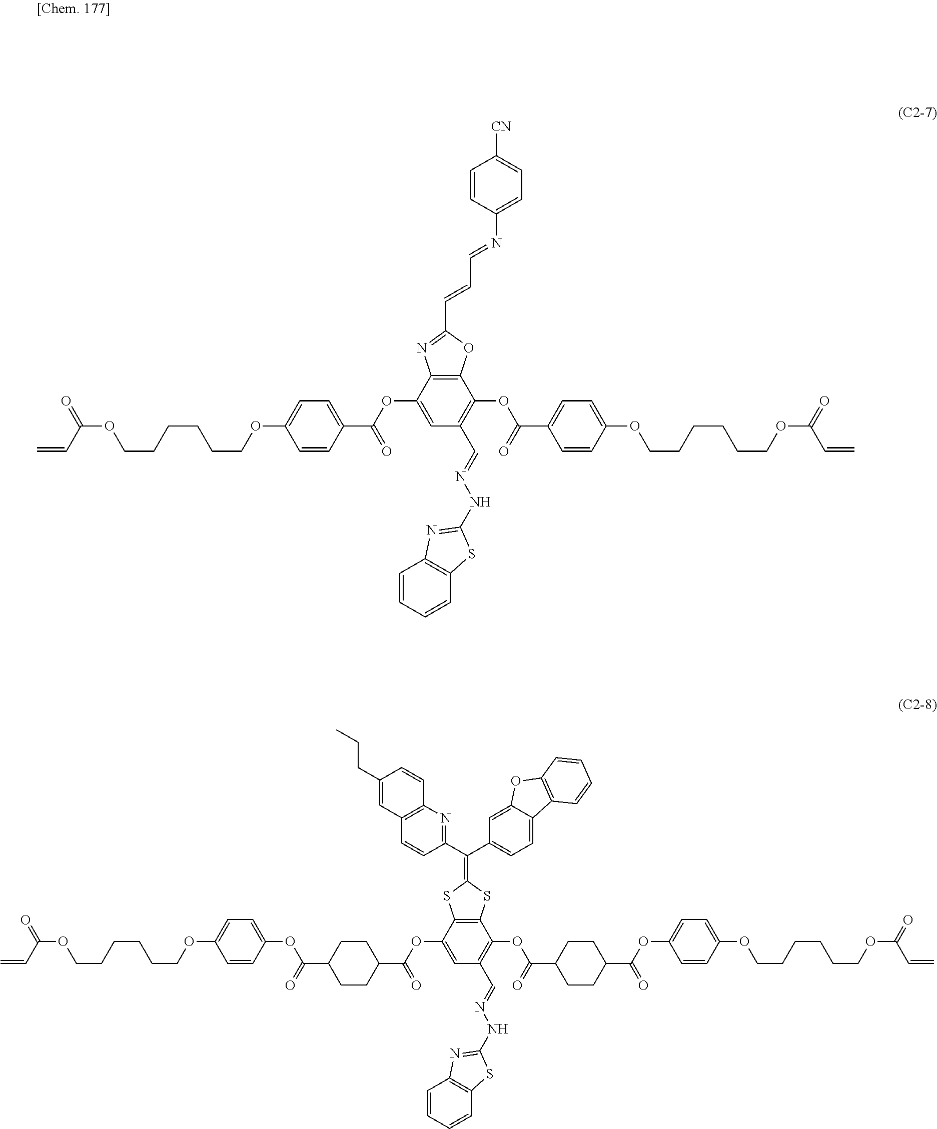

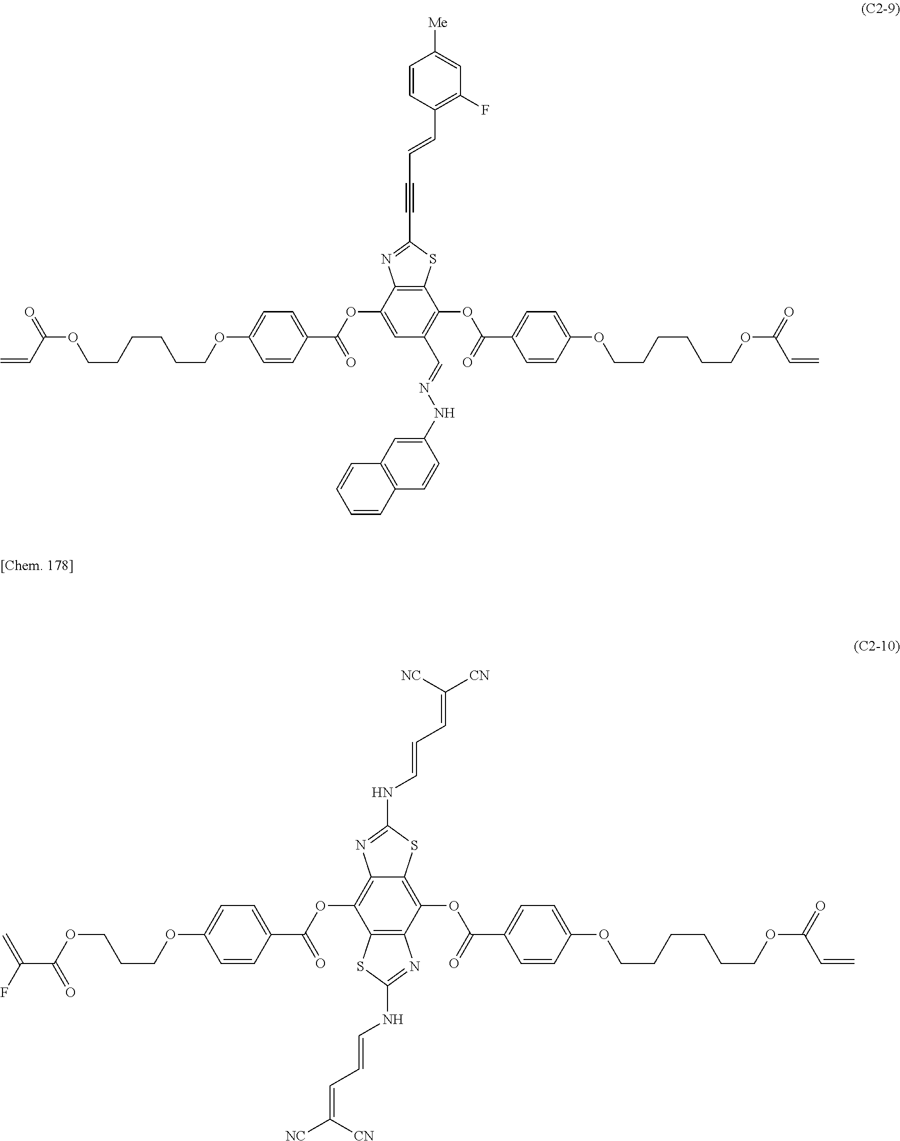

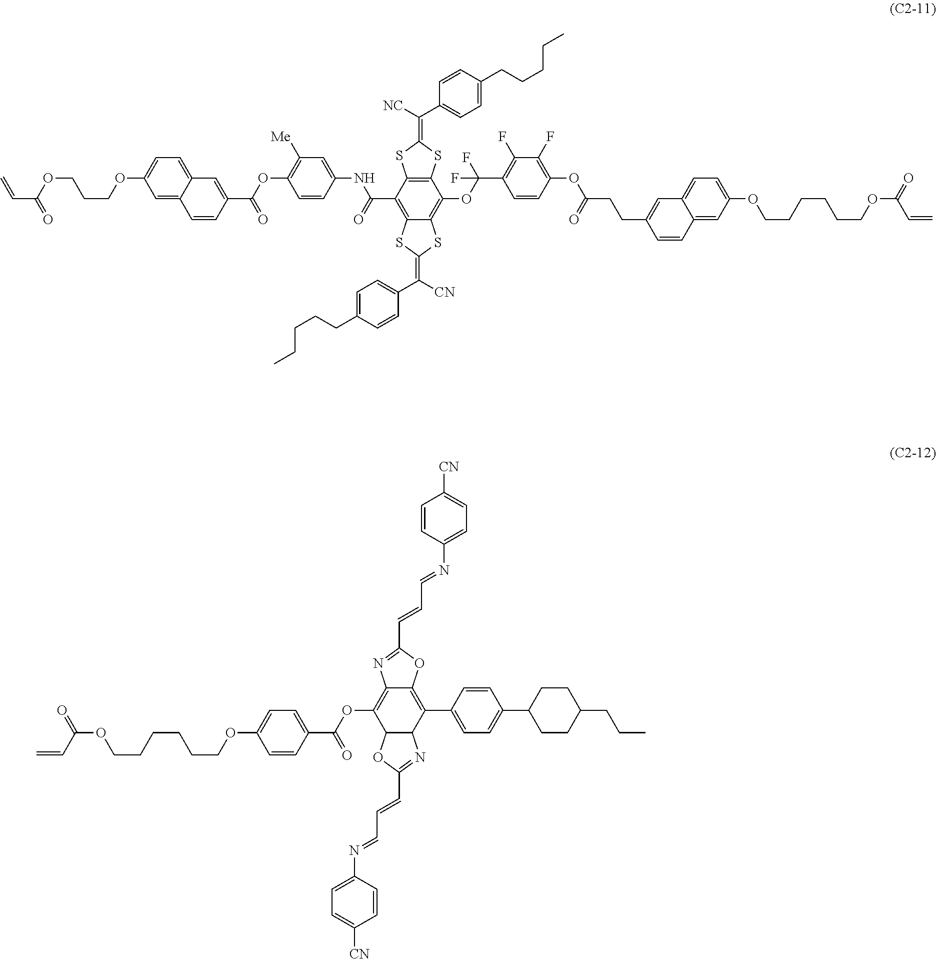

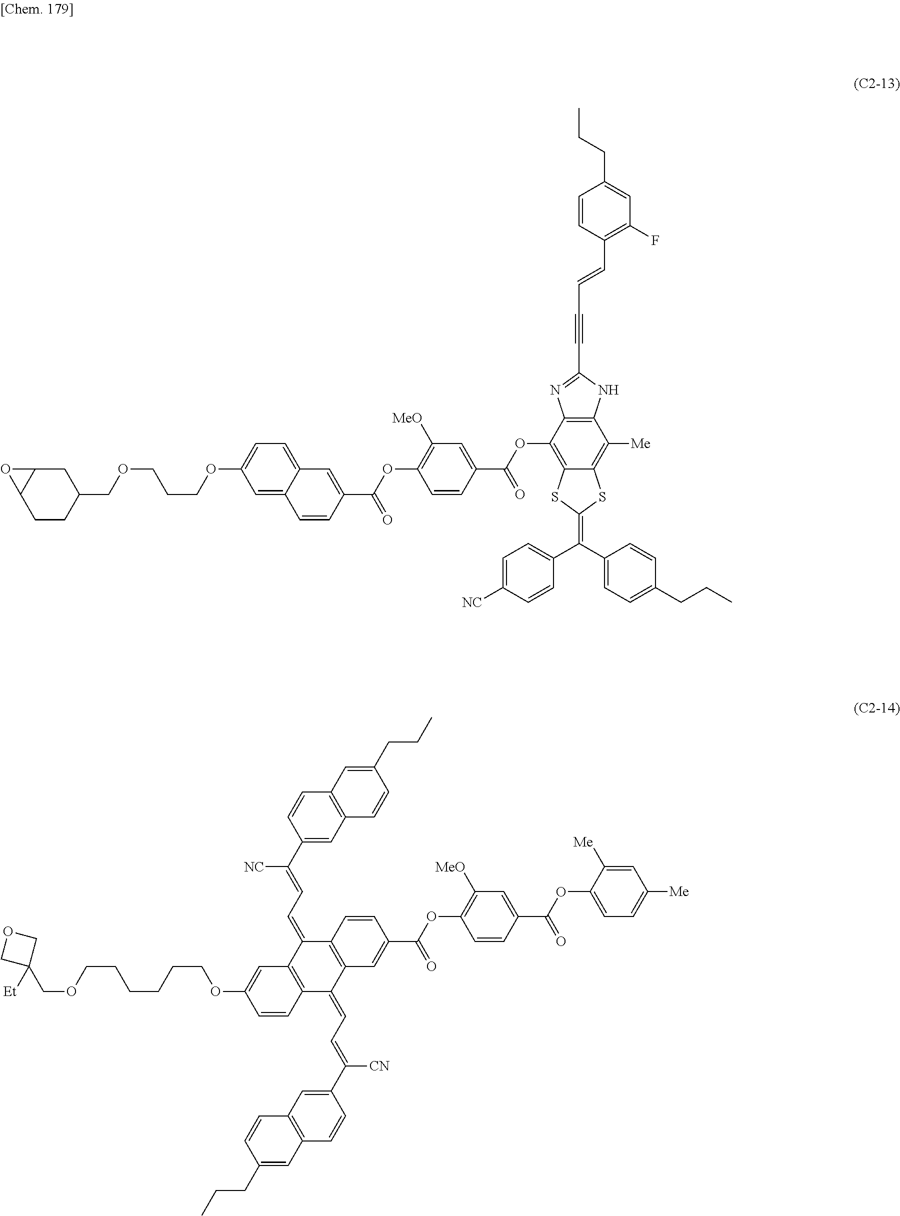

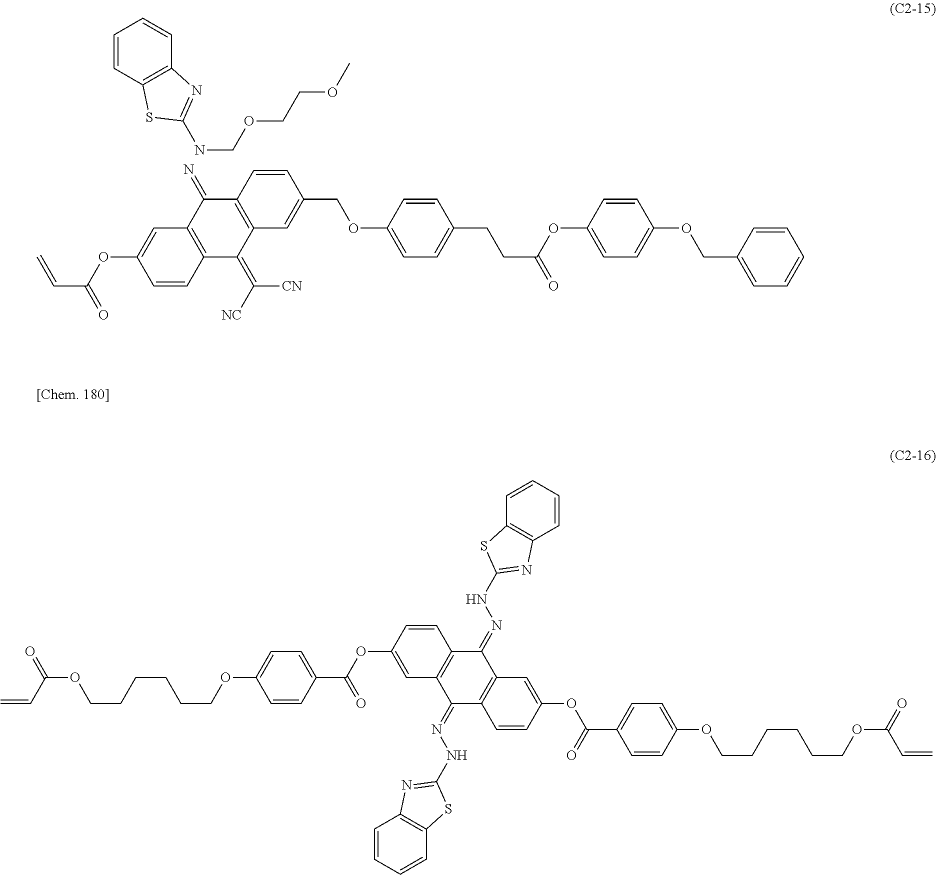

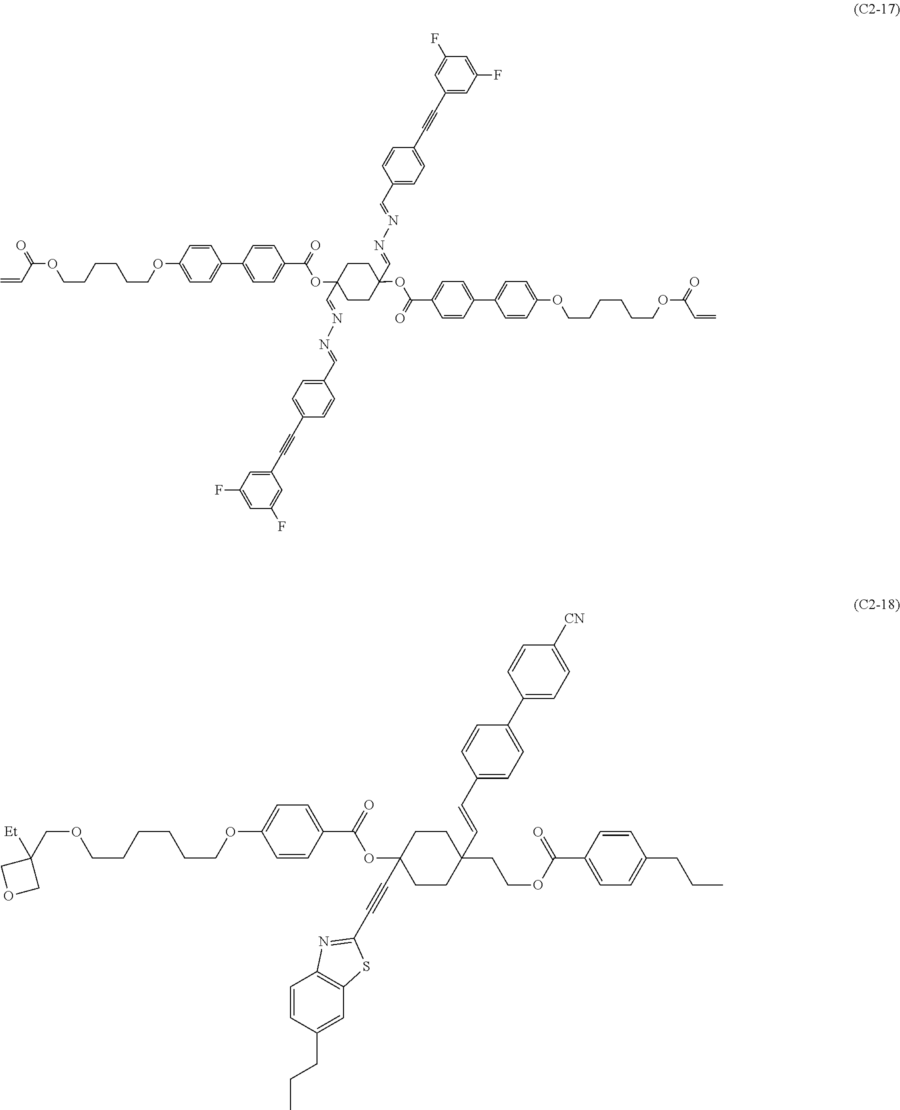

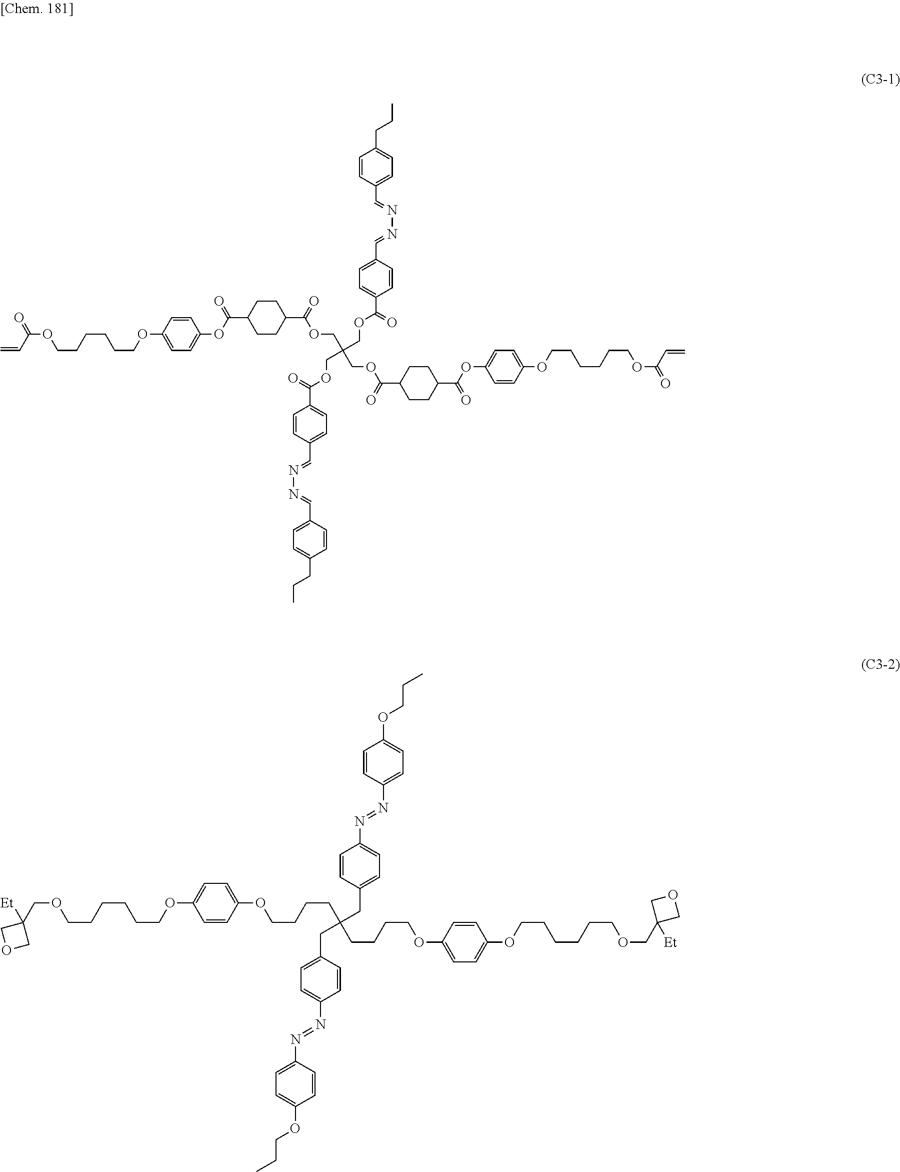

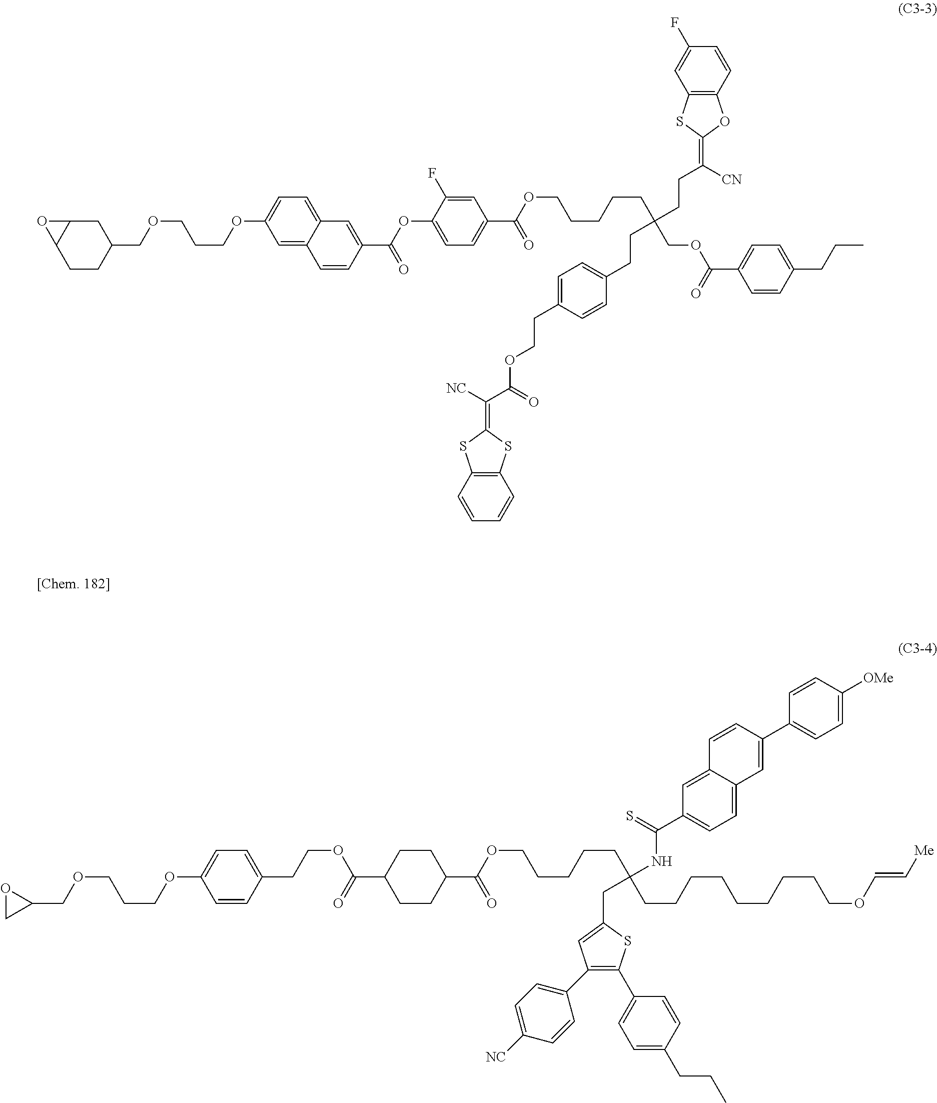

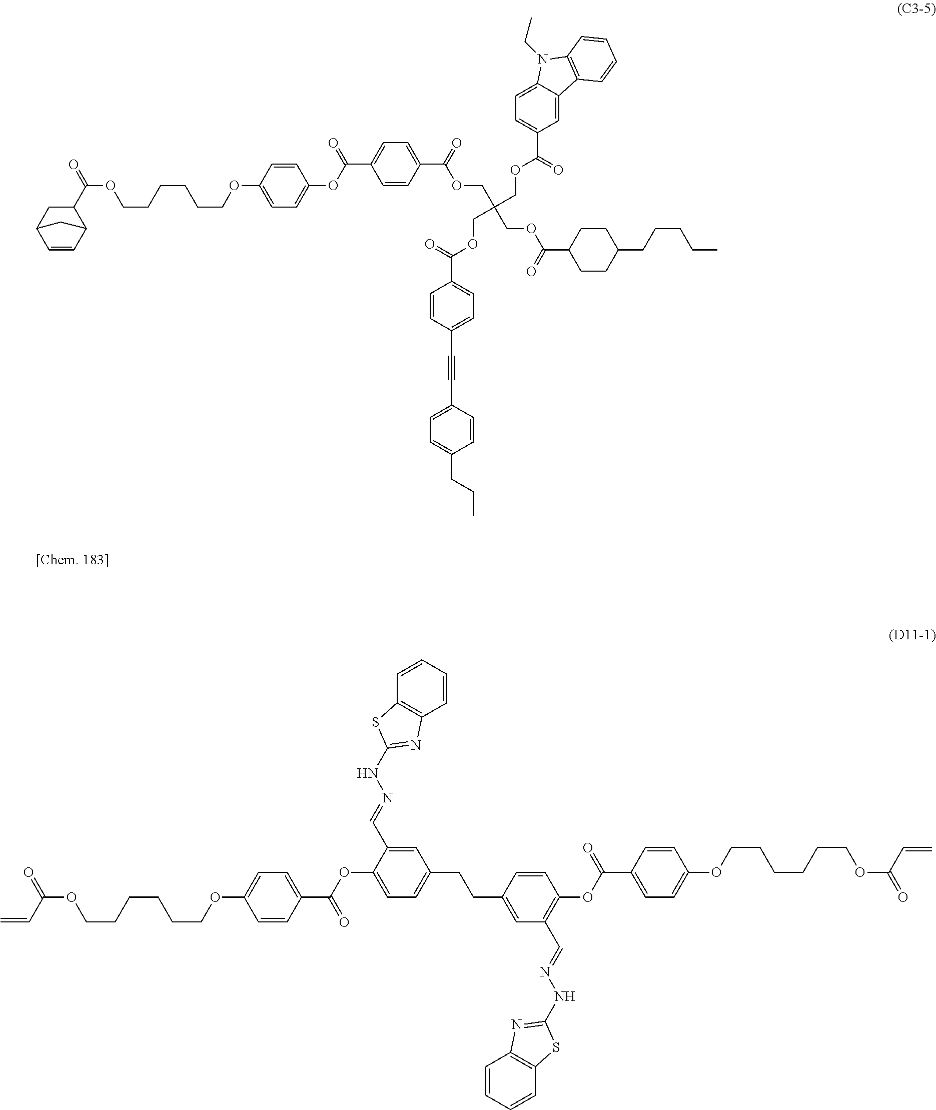

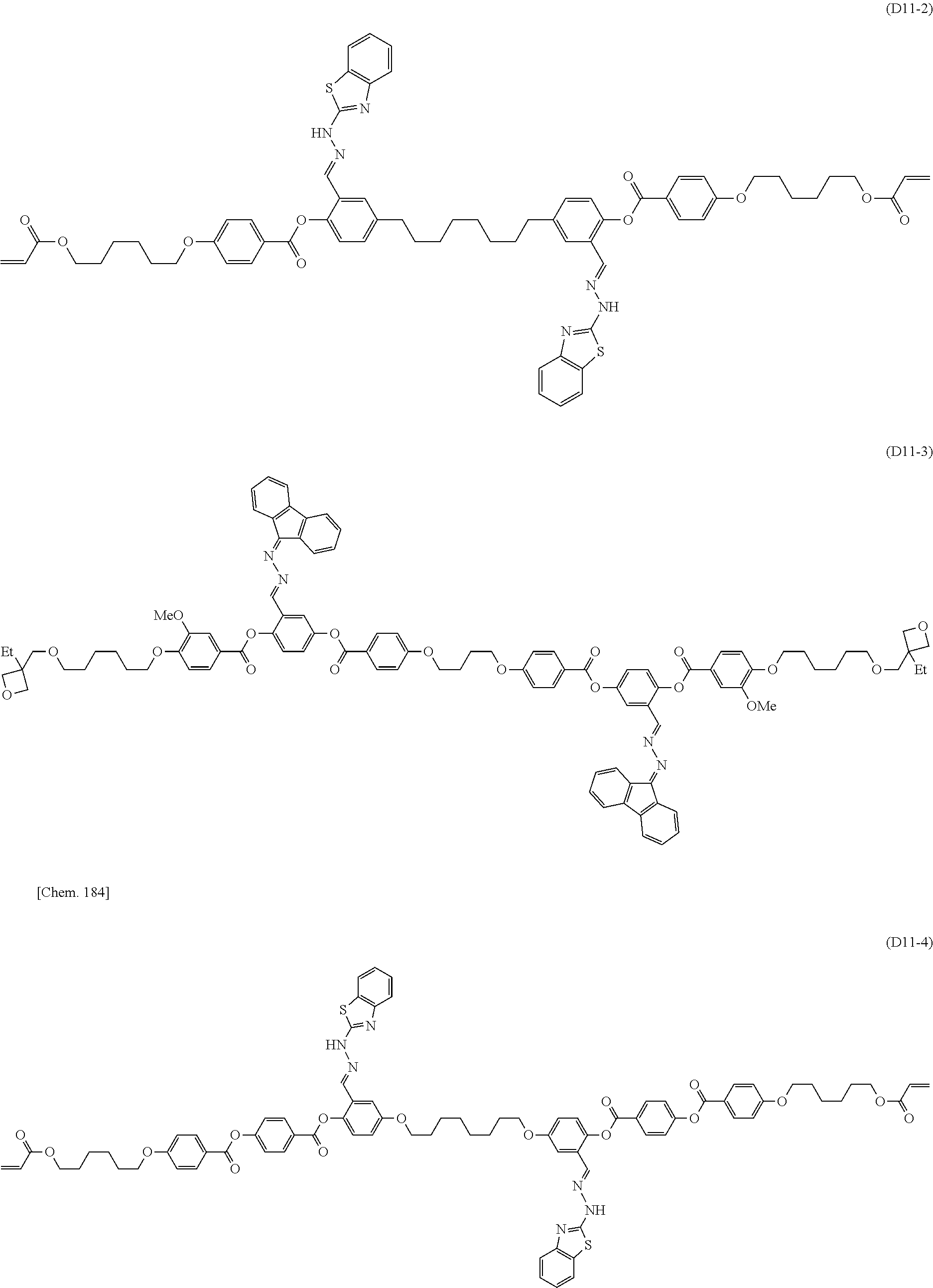

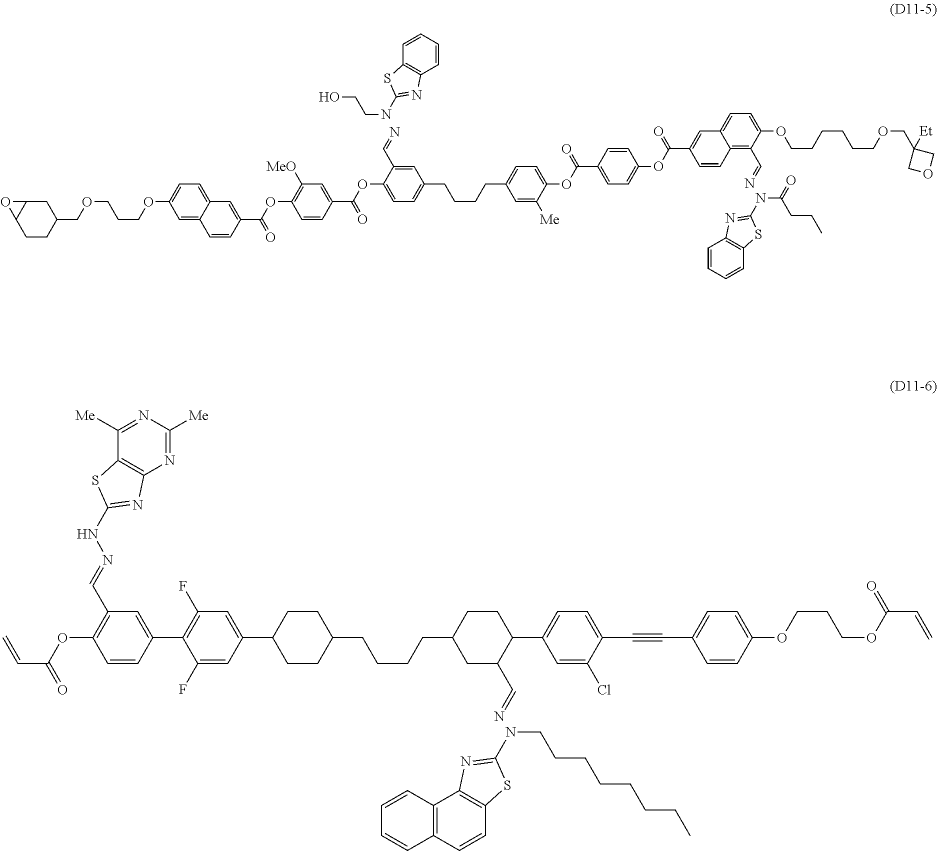

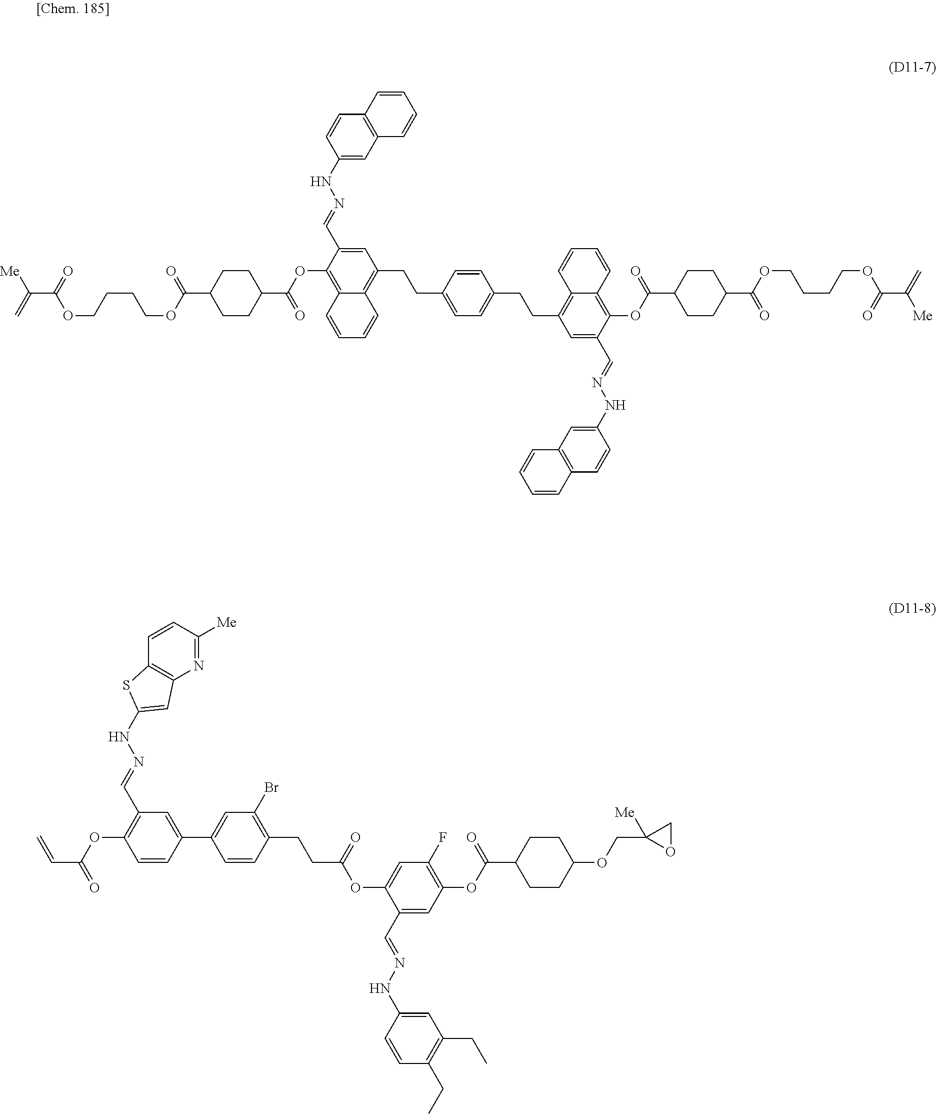

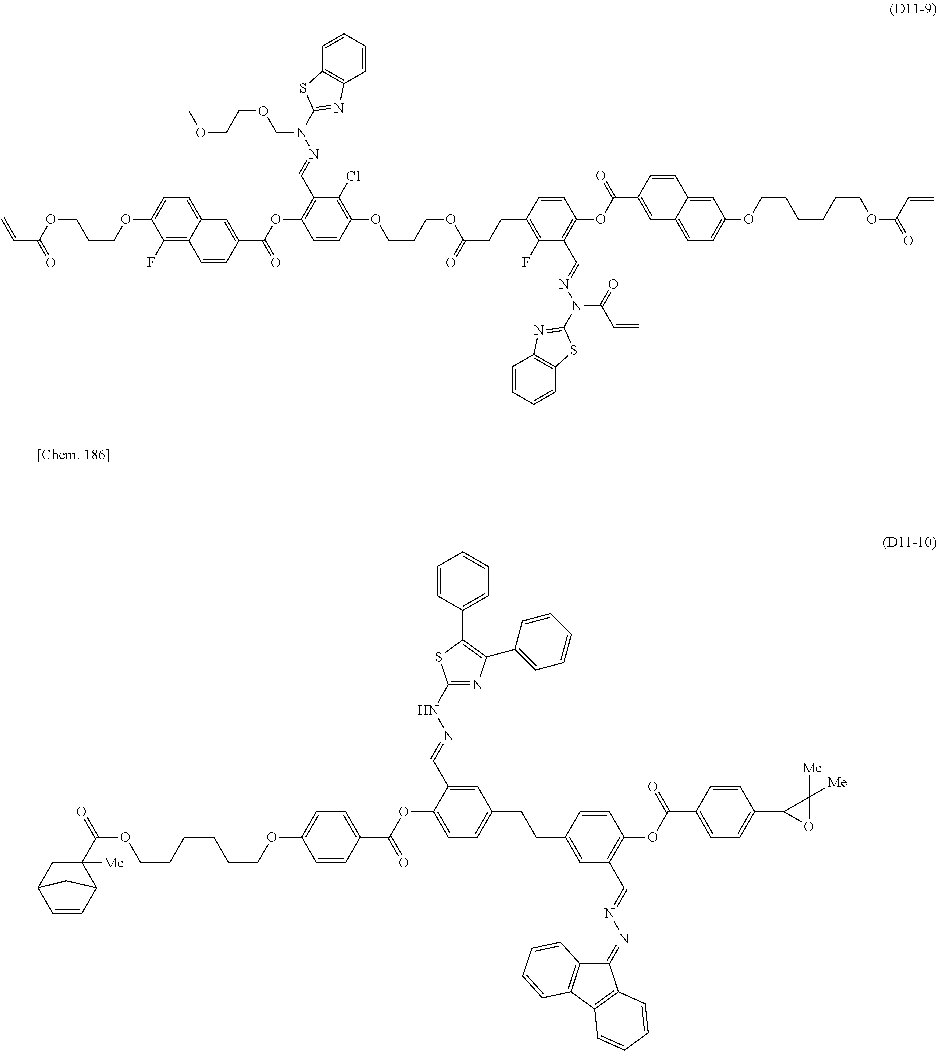

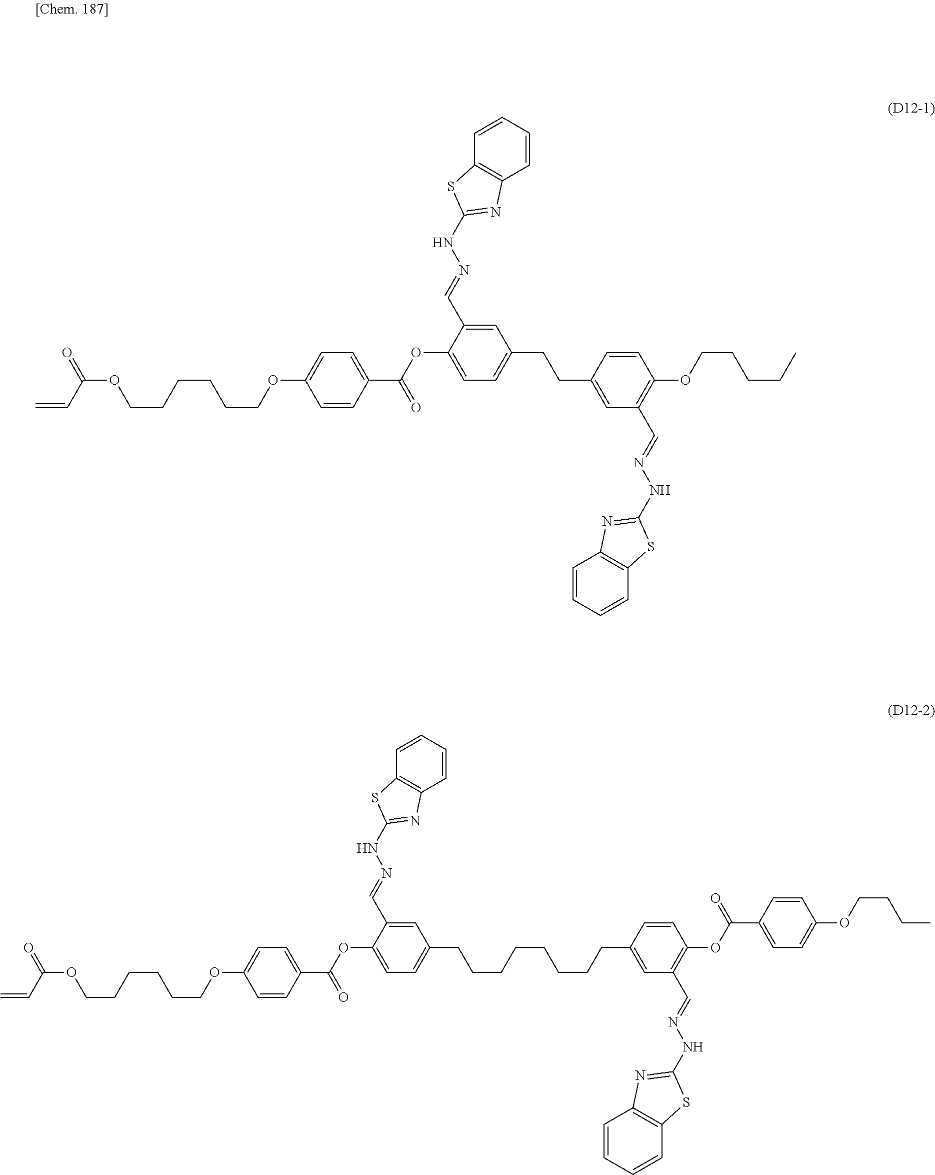

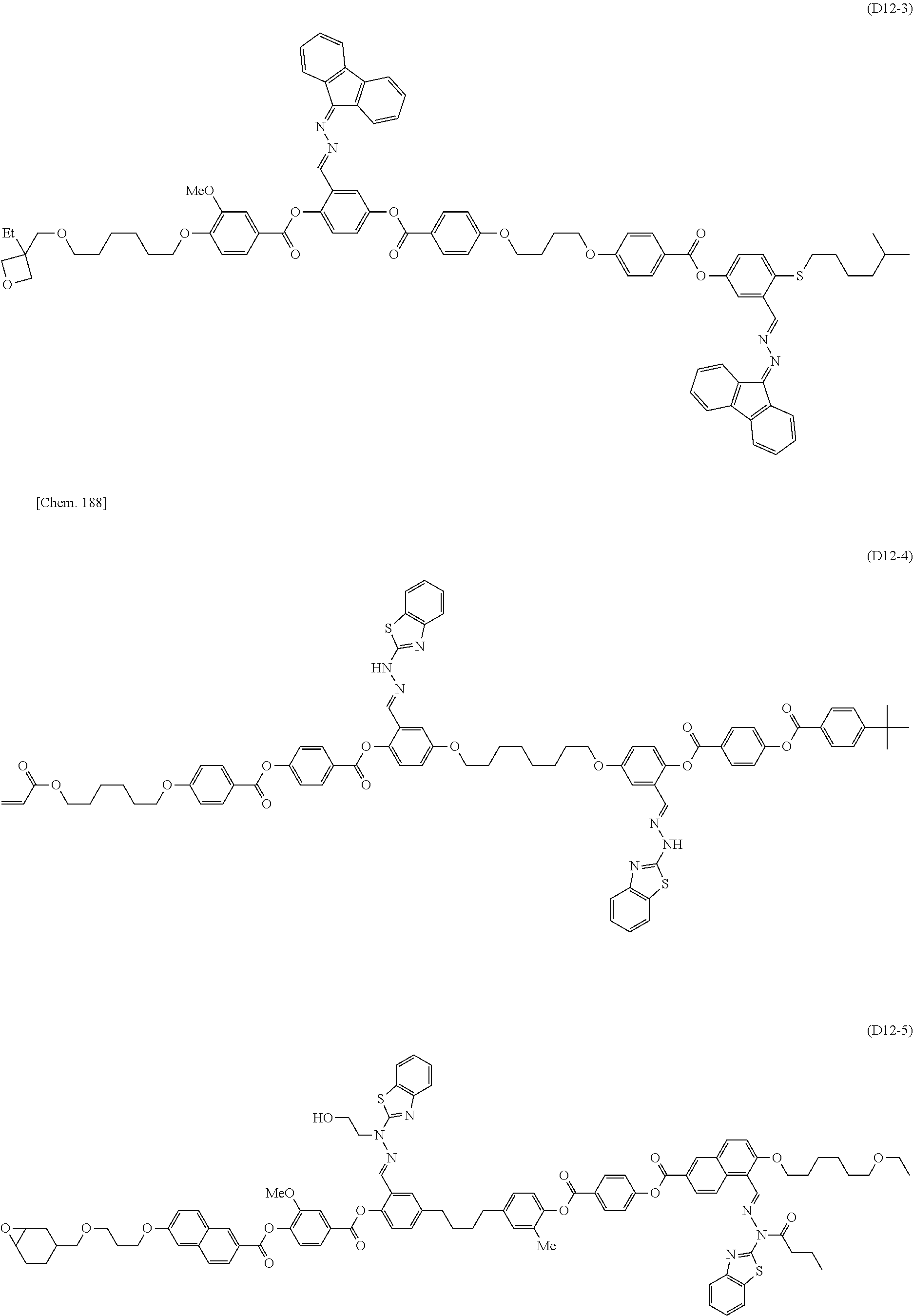

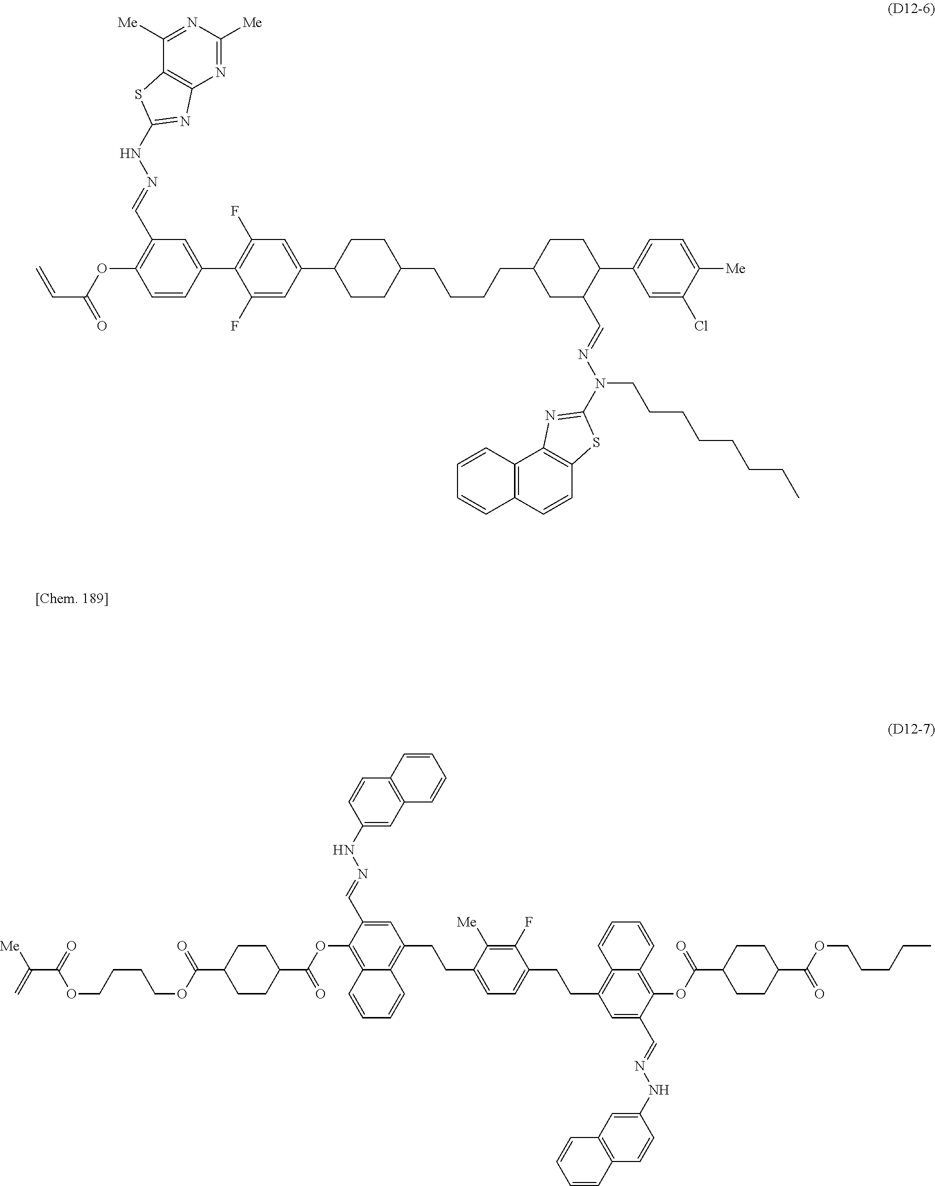

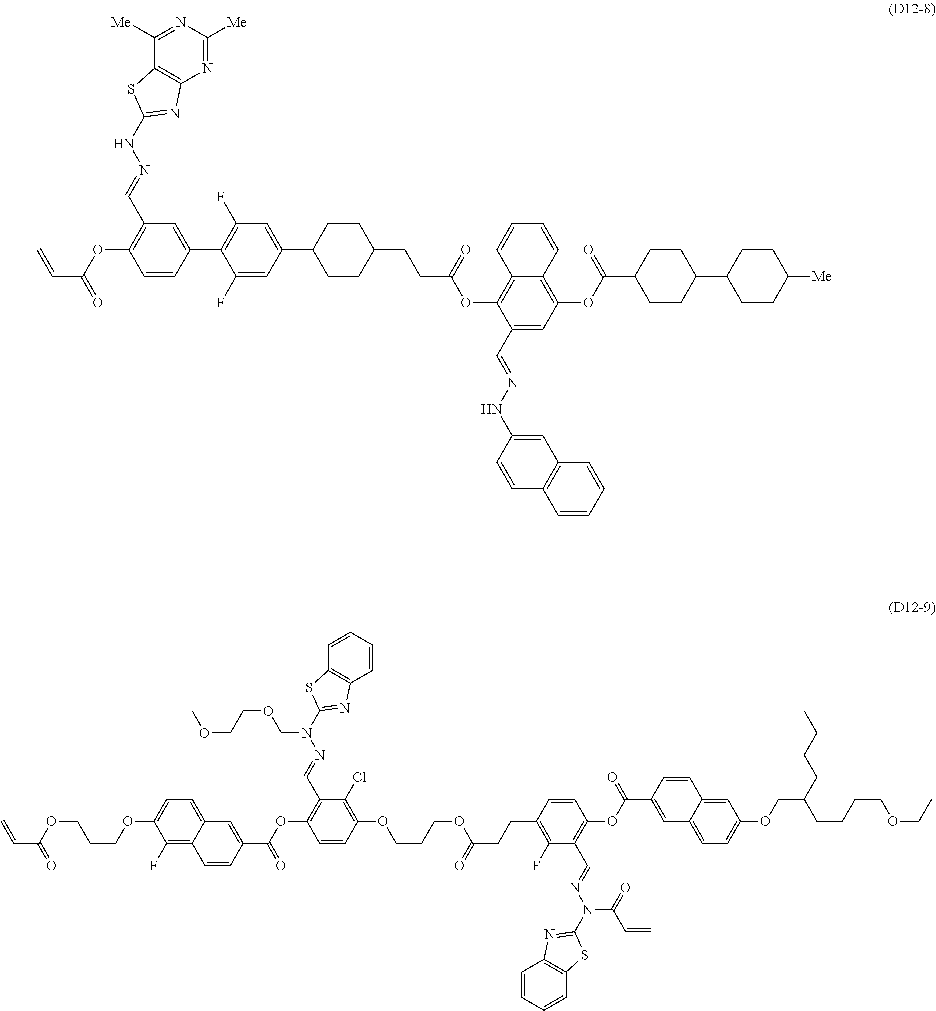

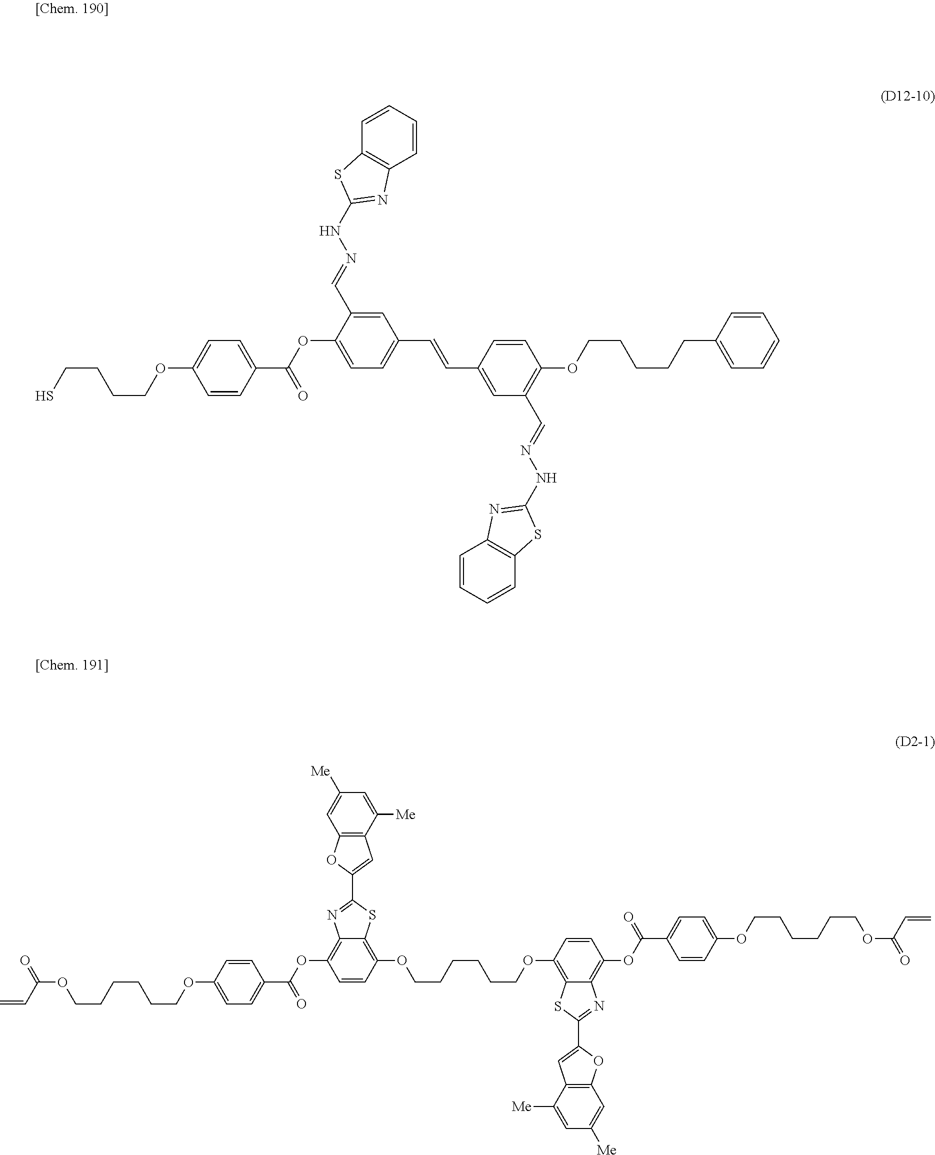

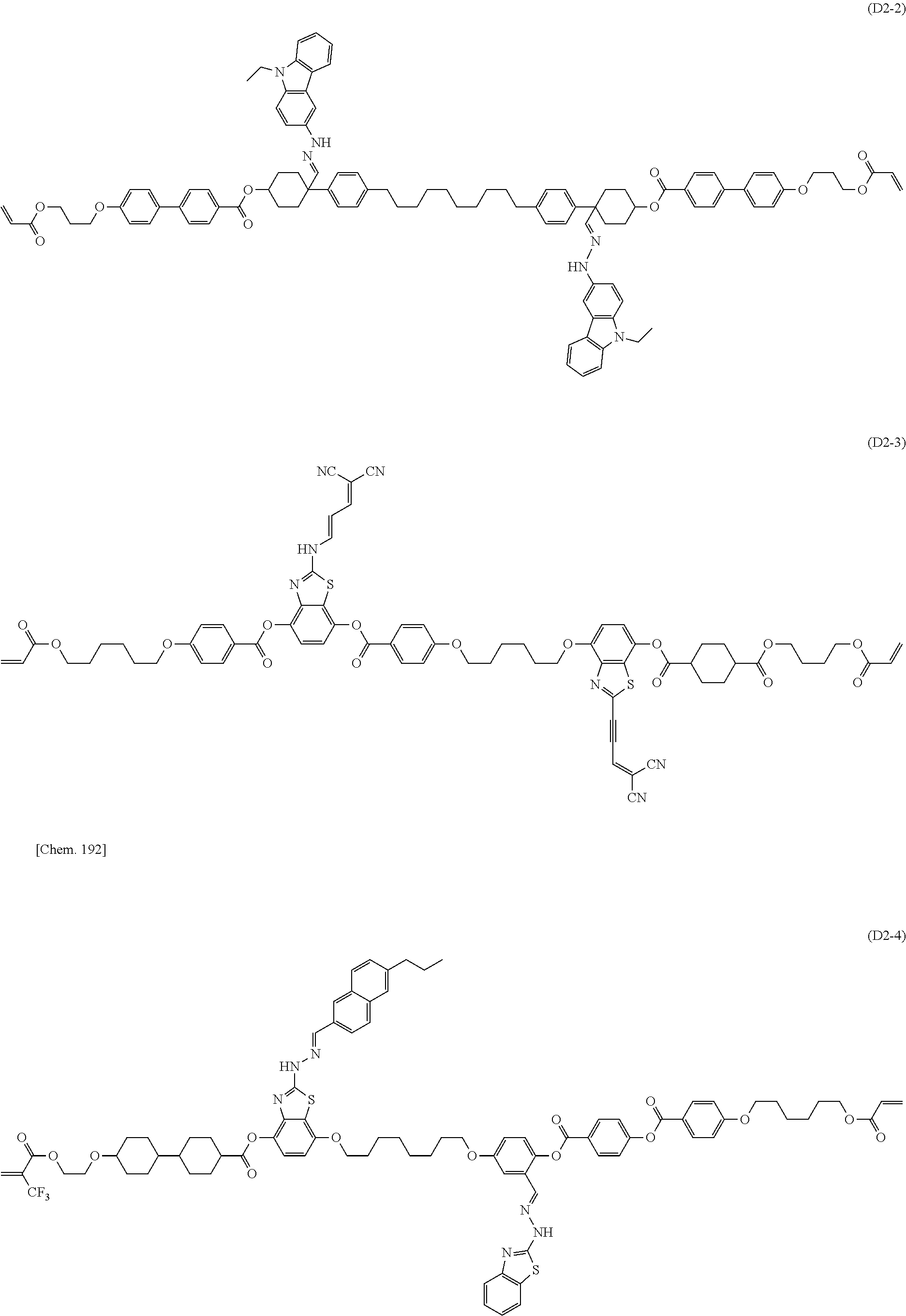

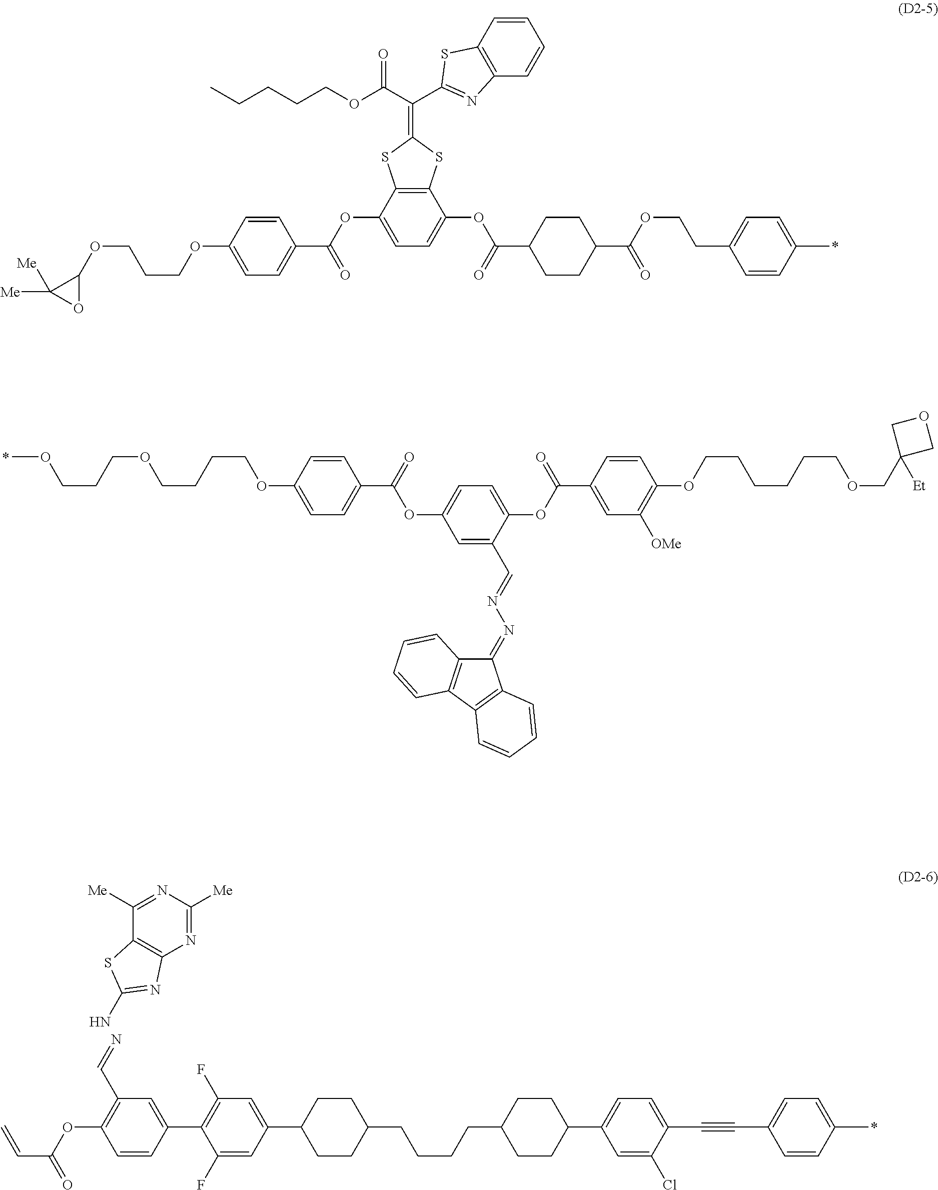

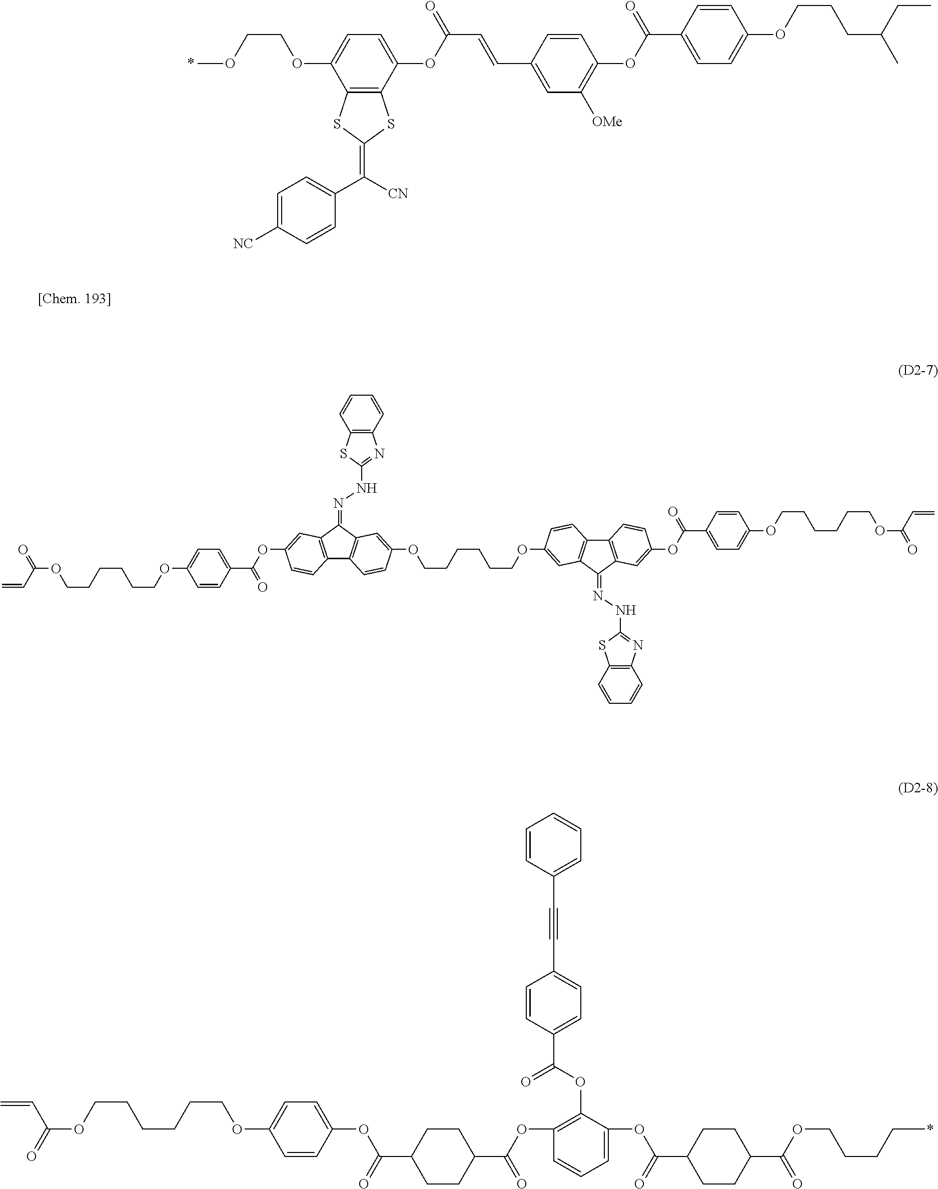

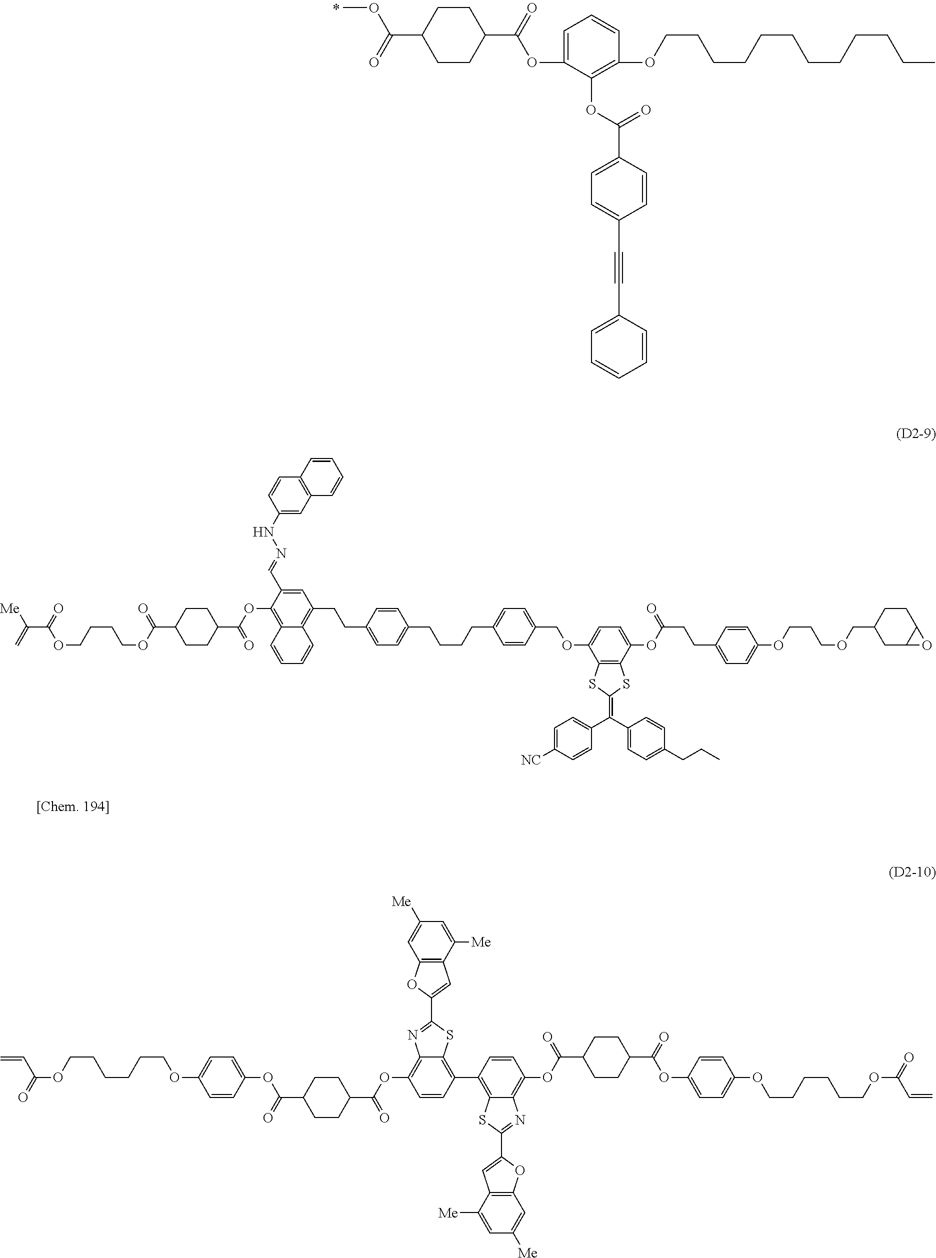

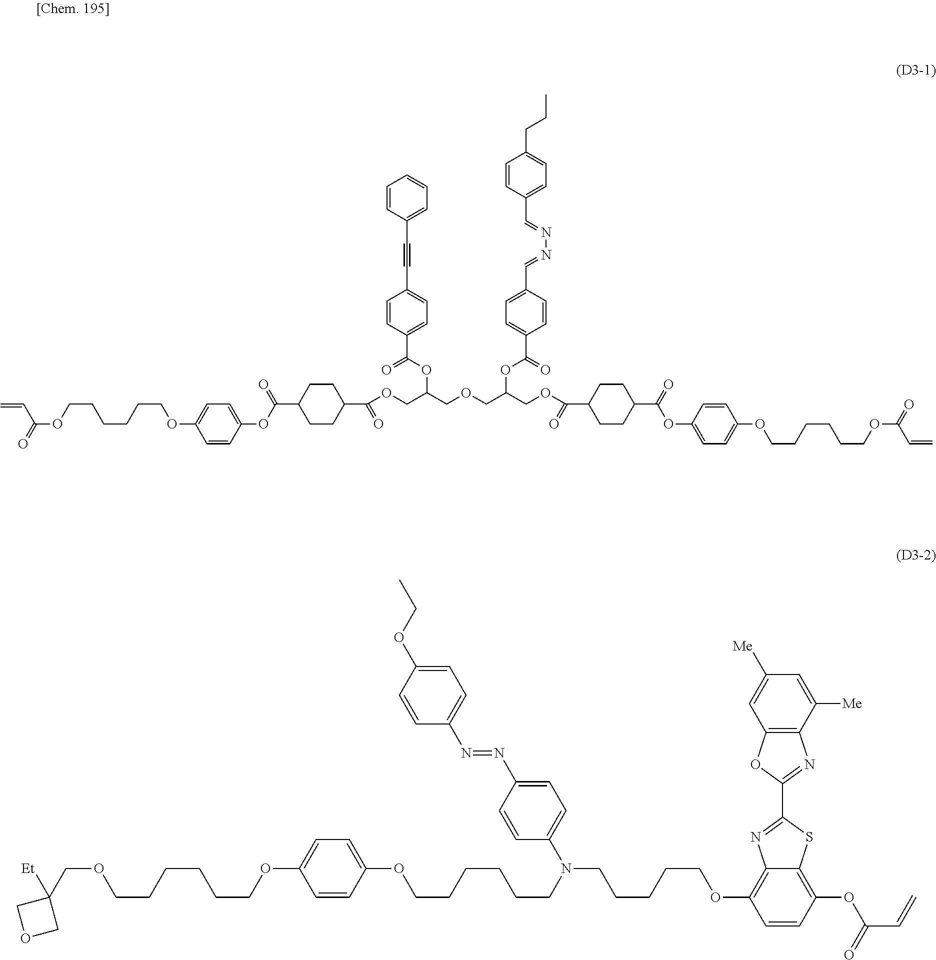

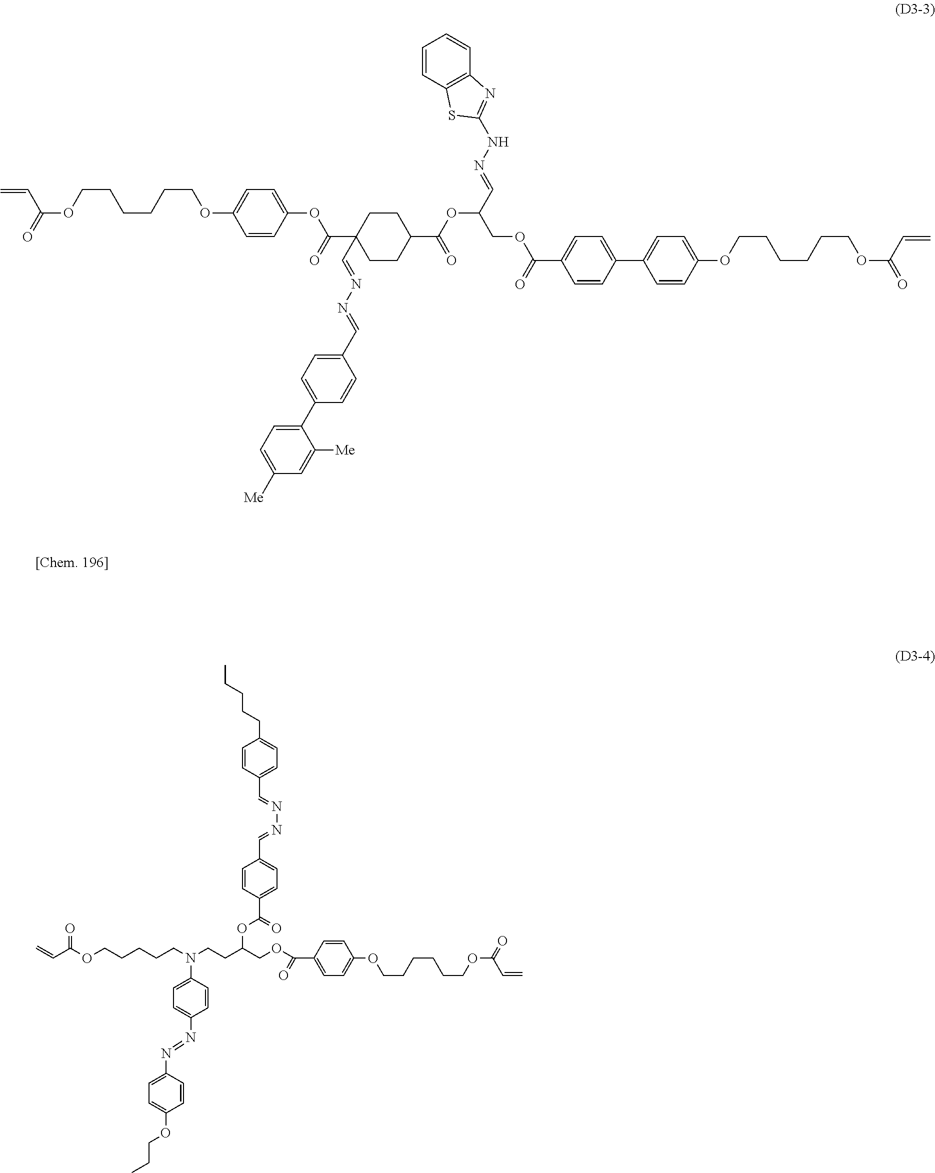

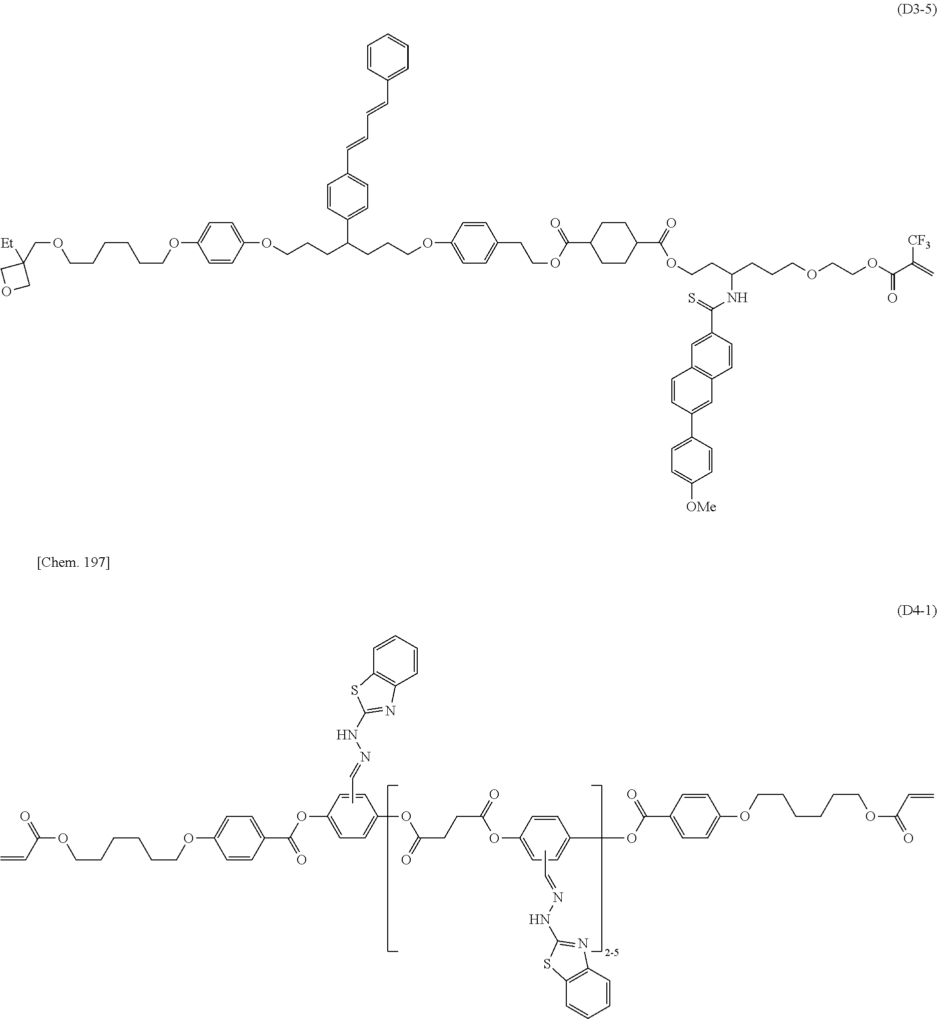

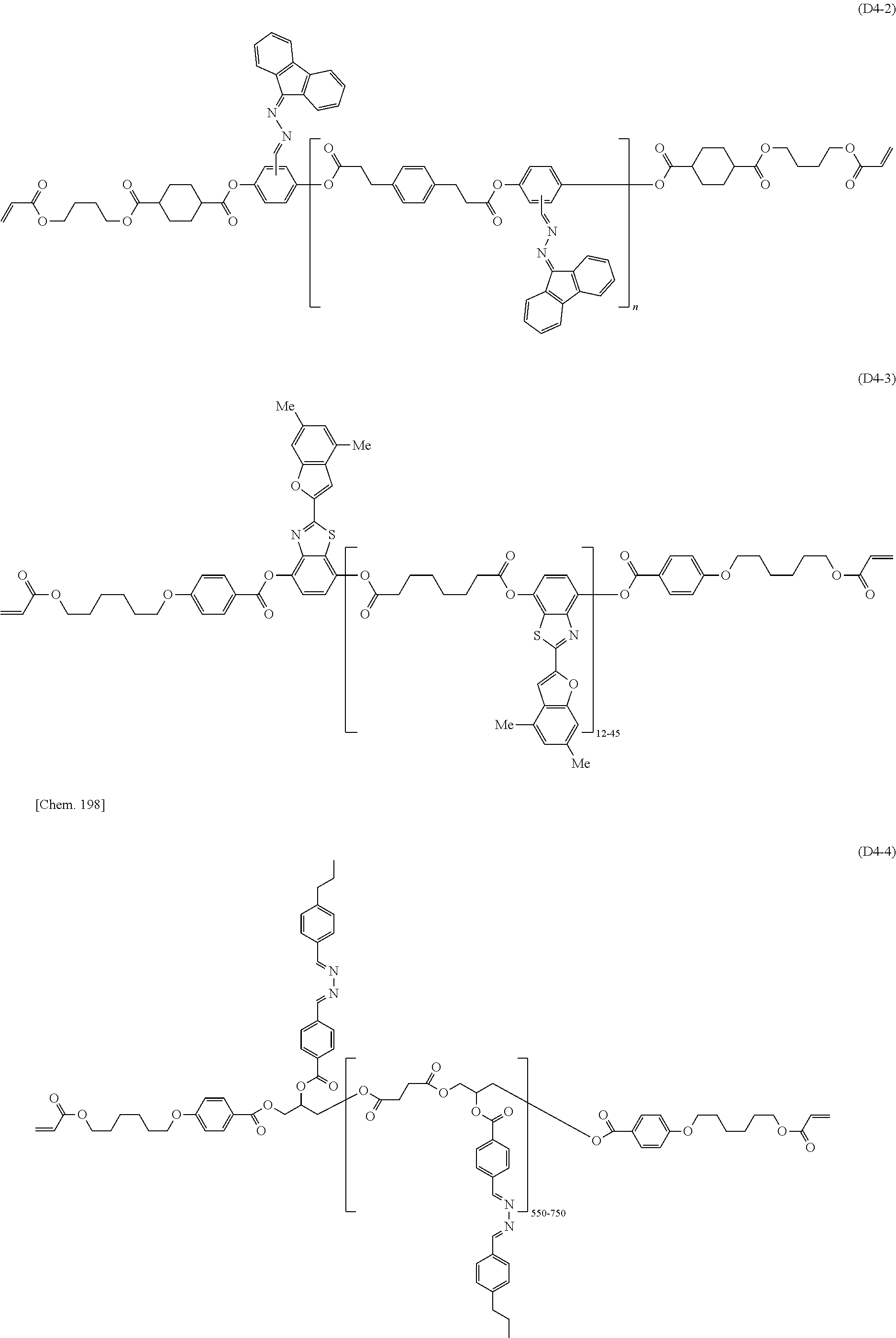

The total content of the reverse dispersible compound represented by General Formula (I) is preferably 10% to 95% by mass, more preferably 30% to 95% by mass, and particularly preferably 60% to 95% by mass, with respect to the total amount of the polymerizable compound used in the polymerizable composition (that is, the total content of the reverse dispersible compound represented by General Formula (I) and the total content of the compound represented by General Formula (II)).

<<General Formula (II)>>

In the present invention, a compound represented by General Formula (II) is included as an essential component.

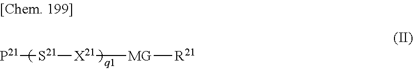

In the formula, P²¹ represents a polymerizable functional group, S²¹ represents an alkylene group having 1 to 18 carbon atoms (hydrogen atoms in the alkylene group may be substituted with one or more halogen atoms, a CN group, or an alkyl group having 1 to 8 carbon atoms including a polymerizable functional group, and one CH₂ group or two or more of (—CH₂—)'s that are not adjacent to each other present in this group may be each independently substituted with —O—, —COO—, —OCO—, or —OCO—O—), X²¹ represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF—S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond (provided that P²¹—S²¹ and S²¹—X²¹ do not include a —O—O—, —O—NH—, —S—S—, and —O—S— group), q1 represents 0 or 1, MG represents a mesogenic group, R²¹ represents a hydrogen atom, a halogen atom, a cyano group, or a linear or a branched alkyl group having 1 to 12 carbon atoms, the alkyl group may be linear or branched, and one —CH₂— or two or more of (—CH₂—)'s that are not adjacent to each other of the alkyl group may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—. Alternatively, R²¹ represents General Formula (II-a).

[Chem. 200]

—(X²²—S²²)_{q2}—P²³ (II-a)

(In the formula, P²³ represents a polymerizable functional group, S²² represents a component which is the same as that defined in the description regarding S²¹, X²² represents a component which is the same as that defined in the description regarding X²¹ (provided that P²³—S²² and S²²—X²² do not include a —O—O—, —O—NH—, —S—S—, and —O—S— group), q² represents 0 or 1). A mesogenic group represented by MG described above is represented by General Formula (II-b).

[Chem. 201]

-(B1-Z1)ᵣ₁—B2-Z2-B3- (II-b)

(In the formula, B1, B2, and B3 each independently represent a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo (2,2,2) octylene group, a decahydronaphthalene-2,6-diyl group, a pyridine-2,5-diyl group, a pyrimidine-2,5-diyl group, a pyrazine-2,5-diyl group, a thiophene-2,5-diyl group-, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b] selenophene-2, 7-diyl group, or a fluorene-2,7-diyl group. As a substituent, one or more of F, Cl, CF₃, OCF₃, a CN group, an alkyl group having 1 to 8 carbon atoms, an alkoxy group having 1 to 8 carbon atoms, an alkanoyl group having 1 to 8 carbon atoms, an alkanoyloxy group having 1 to 8 carbon atoms, an alkoxycarbonyl group having 1 to 8 carbon atoms, an alkenyl group having 2 to 8 carbon atoms, an alkenyloxy group having 2 to 8 carbon atoms, an alkenoyl group having 2 to 8 carbon atoms, an alkenoyloxy group having 2 to 8 carbon atoms, and/or General Formula (II-c)

[Chem. 202]

—(X²³)_{q4}—(S²³)_{q3}—P²⁴ (II-c)

(in the formula, P⁴ represents a reactive functional group, S²³ represents a component which is the same as that defined in the description regarding S²¹, X²³ represents —O—, —COO—, —OCO—, —OCH₂—, —CH₂O—, —CH₂CH₂OCO—, —COOCH₂CH₂—, —OCOCH₂CH₂—, or a single bond, q³ represents 0 or 1, and q⁴ represents 0 or 1 (provided that P²⁴—S²³ and S²³—X²³ do not include a —O—O—, —O—NH—, —S—S— or —O—S— group).) may be included. B1, B2, and B3 are preferably a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo (2,2,2) octylene group, or a decahydronaphthalene-2,6-diyl group (as a substituent, one or more of F, Cl, CF₃, OCF₃, a CN group, an alkyl group having 1 to 8 carbon atoms, an alkoxy group having 1 to 8 carbon atoms, an alkanoyl group having 1 to 8 carbon atoms, an alkanoyloxy group having 1 to 8 carbon atoms, an alkoxycarbonyl group having 1 to 8 carbon atoms, an alkenyl group having 2 to 8 carbon atoms, an alkenyloxy group having 2 to 8 carbon atoms, an alkenoyl group having 2 to 8 carbon atoms, an alkenoyloxy group having 2 to 8 carbon atoms, and/or General Formula (II-c)), Z1 and Z2 each independently represent —COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —C═N—, —N═C—, —CONH—, —NHCO—, —C(CF₃)₂—, an alkyl group having 2 to 10 carbon atoms which may include a halogen atom, or a single bond, r1 represents 0, 1, 2, or 3, and in a case where a plurality of each of B1 and Z1 is present, these may be respectively the same as each other or different from each other, and r1 is preferably 0.)

In the present invention, as a preferable halogen atom, a fluorine atom, a chlorine atom, a bromine atom, or an iodine atom is preferable, a fluorine atom or a chlorine atom is more preferable, and a fluorine atom is particularly preferable. The same applies to a halogen atom described below.

P²², P²³, and P²⁴ preferably each independently represent a substituent selected from a polymerizable group represented by Formula (P-2-1) to Formula (P-2-20).

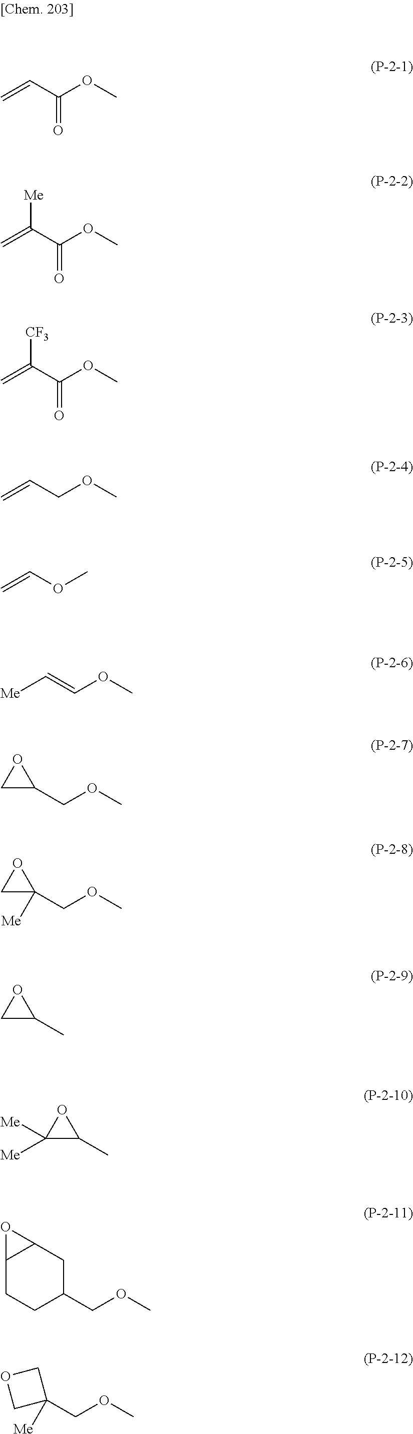

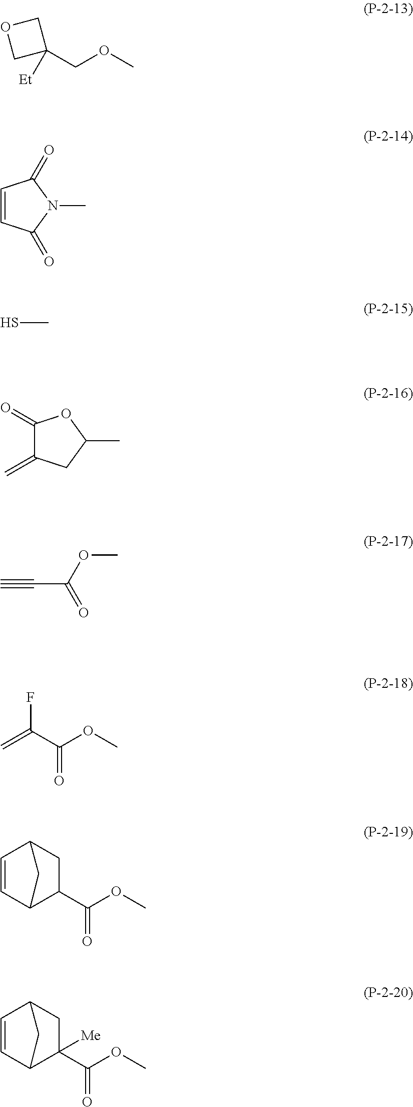

From a viewpoint of increasing polymerizability, among these polymerizable functional groups, Formula (P-2-1), Formula (P-2-2), Formula (P-2-7), Formula (P-2-12), and Formula (P-2-13) are preferable, and Formula (P-2-1) and Formula (P-2-2) are more preferable.

(Monofunctional Polymerizable Liquid Crystal Compound)

Among the compounds represented by General Formula (II), a compound represented by General Formula (II-2-1) is preferable, as a monofunctional polymerizable liquid crystal compound including one polymerizable functional group in a molecule.

[Chem. 204]

P²¹—(S²¹—X²¹)_{q1}-MG-R²¹ (II-2-1)

In the formulae, P²¹, S²¹, X²¹, q1, and MG respectively represent the same definition as those in General Formula (II), R²¹ represents a hydrogen atom, a halogen atom, a cyano group, or a linear or branched alkyl group having 1 to 12 carbon atoms or a linear or branched alkenyl group having 1 to 12 carbon atoms, in which one —CH₂— or two or more of (—CH₂—)'s that are not adjacent to each other may be each independently substituted with —O—, —S—, —CO—, —COO—, —OCO—, —CO—S—, —S—CO—, —O—CO—O—, —CO—NH—, —NH—CO—, —NH—, —N(CH₃)—, —CH═CH—COO—, —CH═CH—OCO—, —COO—CH═CH—, —OCO—CH═CH—, —CH═CH—, —CF═CF—, or —C≡C—, one hydrogen atom or two or more hydrogen atoms in the alkyl group and the alkenyl group may be substituted with halogen atoms or cyano groups, and in a case where a plurality of atoms are substituted, these may be the same as each other or different from each other. The monofunctional polymerizable liquid crystal compound has characteristics in which polarities of both ends are different from each other, compared to a multifunctional polymerizable liquid crystal compound. In a case where the polymerizable composition of the present invention is applied onto a base material, a hydrophobic group tends to easily appear on a side of an air interface. Accordingly, by adding the monofunctional polymerizable liquid crystal compound and suitably selecting the kind of a surfactant which will be described later and an amount thereof added, it is possible to control an angle of alignment of polymerizable liquid crystals in the air interface, that is, a tilt angle.

As examples of General Formula (II-2-1), compounds represented by General Formulae (II-2-1-1) to (II-2-1-4) can be used, but there is no limitation to the general formulae below.

[Chem. 205]

P²¹—(S²¹—X²¹)_{q1}—B2-Z2-B3-R²¹ (II-2-1-1)

P²¹—(S²¹—X²¹)_{q1}-B11-Z11-B2-Z2-B3-R²¹ (II-2-1-2)

P²¹—(S²¹—X²¹)_{q1}-B11-Z11-B12-Z12-B2-Z2-B3-R²¹ (II-2-1-3)

P²¹—(S²¹—X²¹)_{q1}-B11-Z12-Z12-B13-Z13-B2-Z2-B3-R²¹ (II-2-1-4)

In the formulae, P²¹, S²¹, X²¹, and q1 respectively represent the same definition as those in General Formula (II) (in a case of controlling tilt, S²¹ is preferably an alkylene group having 3 to 18 carbon atoms (one or more of arbitrary hydrogen atoms in the alkylene group may be substituted with a halogen atom, a cyano group, or an alkyl group having 1 to 8 carbon atoms including a polymerizable functional group, and one CH₂ group or two or more of (—CH₂—)'s that are not adjacent to each other present in this group may be each independently substituted with —O—, —COO—, —OCO—, or —OCO—O—).

B11, B12, B13, B2, and B3 represent the same definition as B1 to B3 of General Formula (II-b), and these may be respectively the same as each other or different from each other.

Z1, Z12, Z13, and Z2 represent the same definition as Z1 to Z3 of General Formula (II-b), and these may be respectively the same as each other or different from each other. R²¹ represents a hydrogen atom, a halogen atom, a cyano group, or a linear or branched alkyl group having 1 to 12 carbon atoms or a linear or branched alkenyl group having 1 to 12 carbon atoms, in which one —CH₂— or two or more of (—CH₂—)'s that are not adjacent to each other may be each independently substituted with —O—, —S—, —CO—, —COO—, —OCO—, —CO—S—, —S—CO—, —O—CO—O—, —CO—NH—, —NH—CO—, —NH—, —N(CH₃)—, —CH═CH—COO—, —CH═CH—OCO—, —COO—CH═CH—, —OCO—CH═CH—, —CH═CH—, —CF═CF—, or —C≡C—, one hydrogen atom or two or more hydrogen atoms in the alkyl group and the alkenyl group may be substituted with halogen atoms or cyano groups, and in a case where a plurality of atoms are substituted, these may be the same as each other or different from each other. Meanwhile, in a case R²¹ is a cyano group, S²¹ is preferably an alkylene group having 3 to 18 carbon atoms (hydrogen atoms in the alkylene group may be substituted with one or more halogen atoms, a cyano group, or an alkyl group having 1 to 8 carbon atoms including a polymerizable functional group, one CH₂ group or two or more of (—CH₂—)'s that are not adjacent to each other present in this group may be each independently substituted with —O—, —COO—, —OCO—, or —OCO—O—), from a viewpoint in that the tilt is easily controlled, in a case of having different polarities on both ends of the compound.

As the compounds represented by General Formulae (II-2-1-1) to (II-2-1-4), compounds represented by General Formula (II-2-1-1-1) to General Formula (II-2-1-1-32) are used, but there is no limitation thereto.

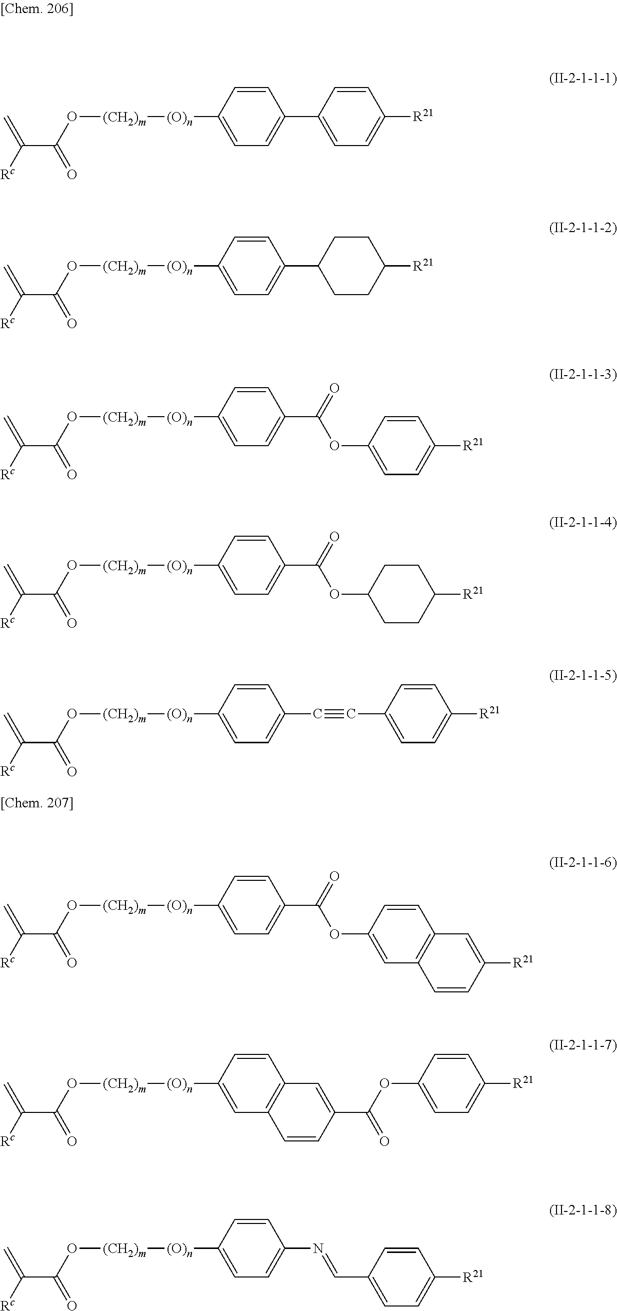

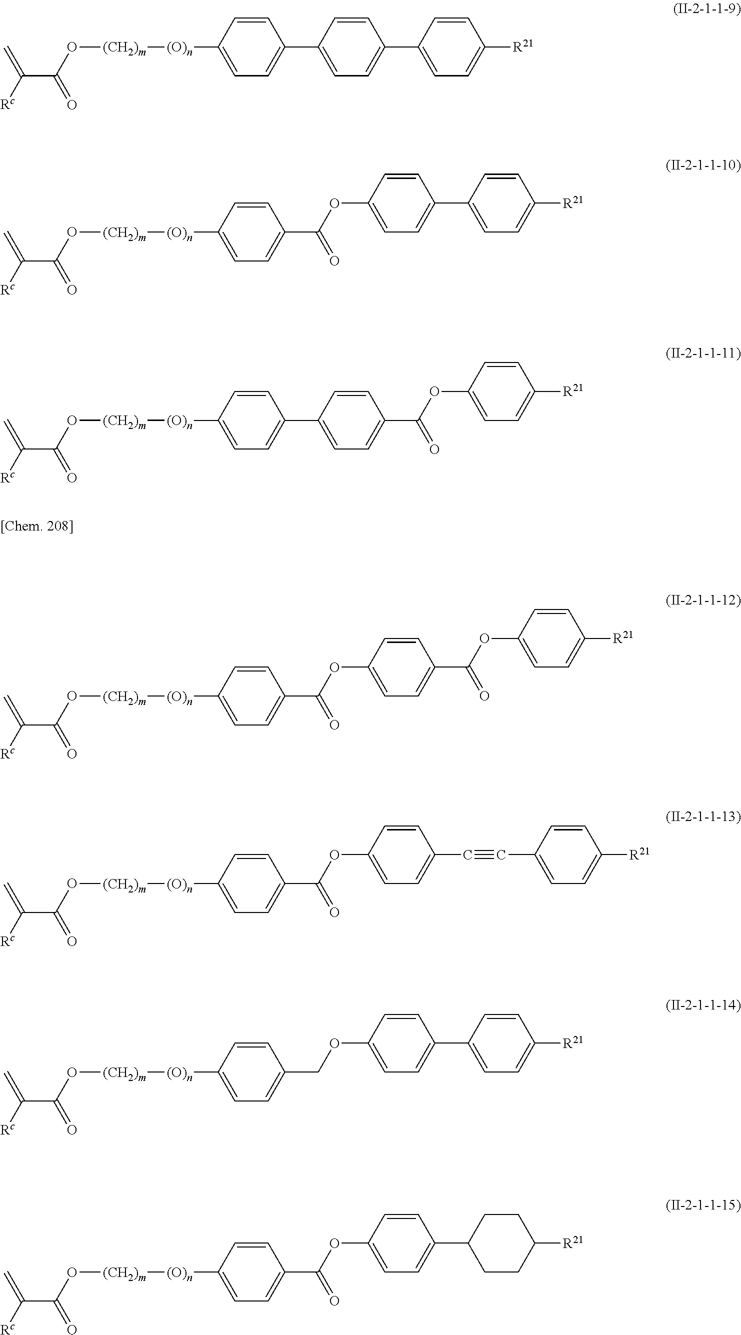

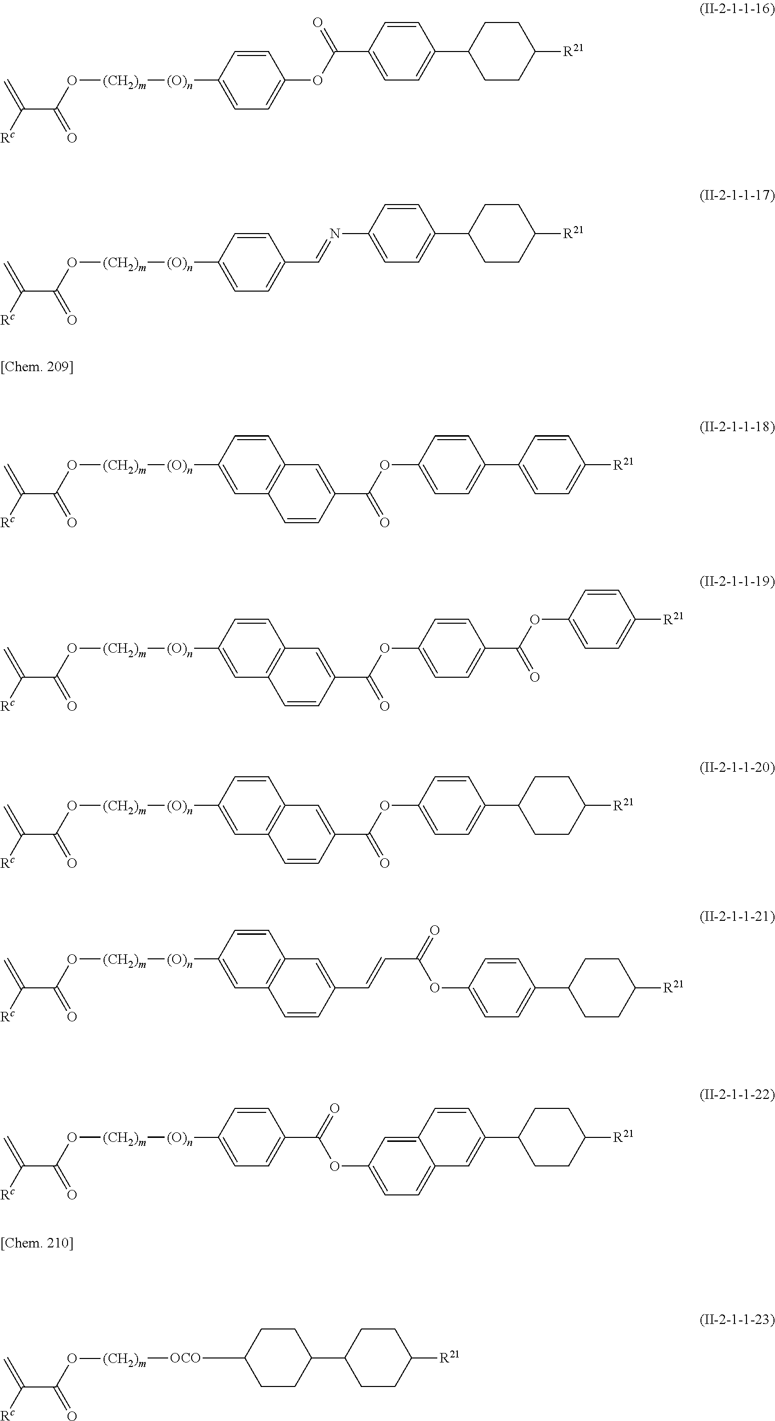

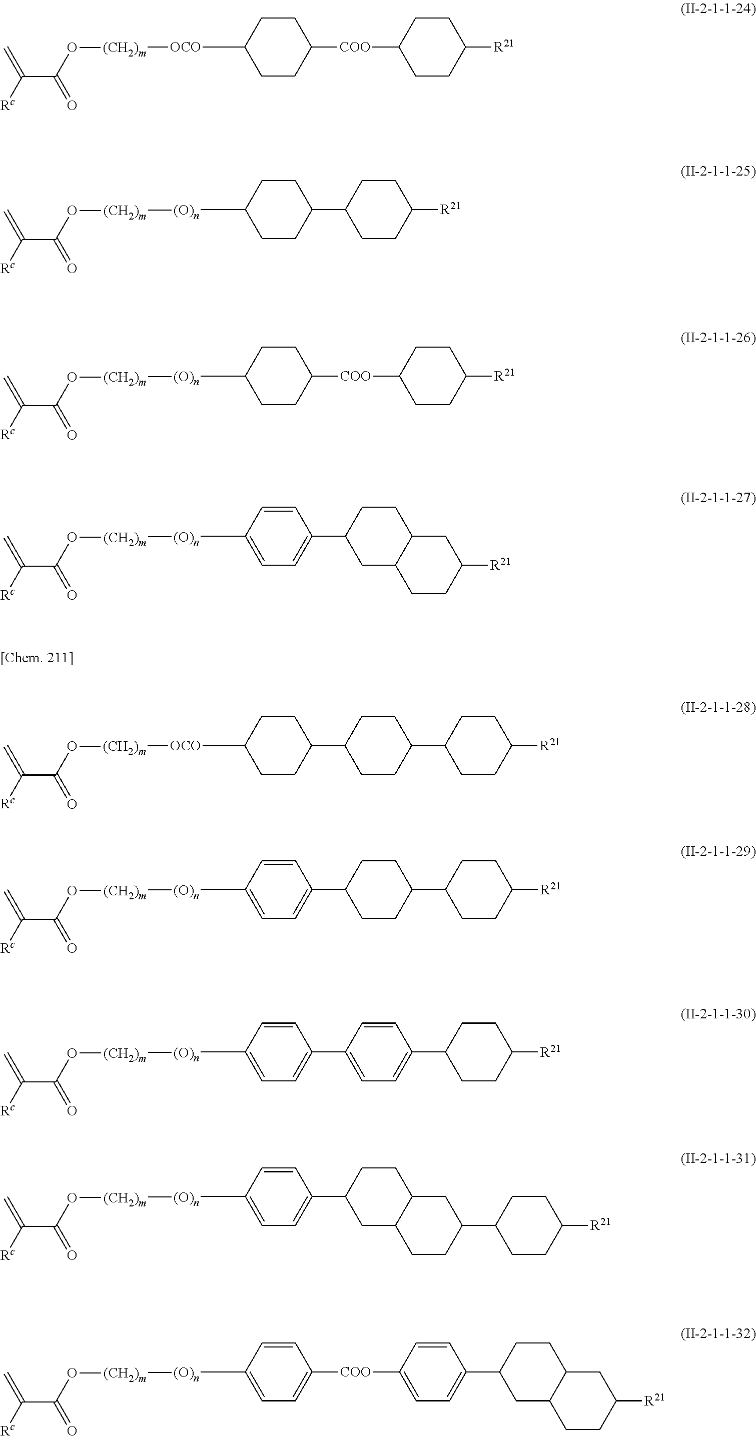

In the formulae, R^{c} represents a hydrogen atom or a methyl group, m represents an integer of 0 to 18, n represents 0 or 1, R²¹ represents the same definition as those in General Formulae (II-2-1-1) to (II-2-1-4), R²¹ preferably represents a hydrogen atom, a halogen atom, a cyano group, or a linear alkyl group having 1 to 6 carbon atoms or a linear alkenyl group having 1 to 6 carbon atoms, in which one —CH₂— may be substituted with —O—, —CO—, —COO—, or —OCO—, R²¹ more preferably represents a halogen atom or a cyano group, and in a case where R²¹ represents a cyano group, m is preferably an integer of 3 to 18, from a viewpoint in that the tilt is easily controlled, in a case of having different polarities on both ends of the compound, as described above.

The cyclic group described above may include one or more of F, Cl, CF₃, OCF₃, a CN group, an alkyl group having 1 to 8 carbon atoms, an alkoxy group having 1 to 8 carbon atoms, an alkanoyl group having 1 to 8 carbon atoms, an alkanoyloxy group having 1 to 8 carbon atoms, an alkoxycarbonyl group having 1 to 8 carbon atoms, an alkenyl group having 2 to 8 carbon atoms, an alkenyloxy group having 2 to 8 carbon atoms, an alkenoyl group having 2 to 8 carbon atoms, or an alkenoyloxy group having 2 to 8 carbon atoms, as a substituent.

More specifically, compounds represented by the following formulae are preferable.

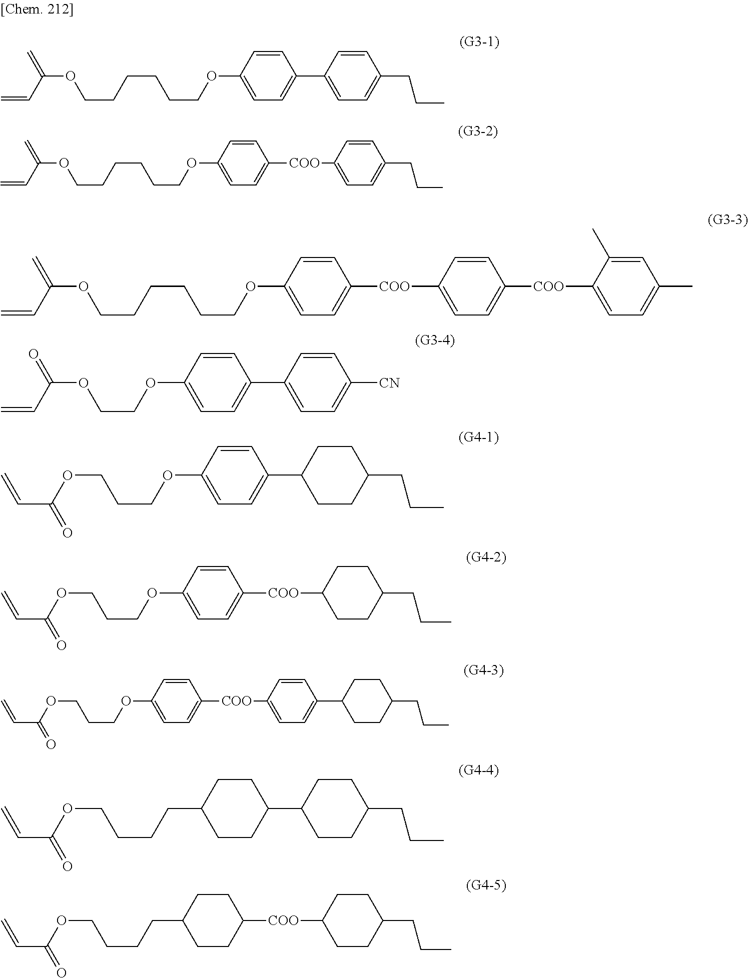

The total content of the monofunctional polymerizable liquid crystal compound including one polymerizable functional group in one molecule is preferably 0% to 90% by mass, more preferably 0% to 85% by mass, and particularly preferably 0% to 80% by mass, with respect to total amount of the compound represented by General Formula (II) used. In a case of significantly considering alignment of an optically anisotropic body, the lower limit value is preferably equal to or greater than 5% by mass and more preferably equal to or greater than 10% by mass, and in a case of significantly considering hardness of a coated film, the upper limit value is preferably equal to or smaller than 80% by mass and more preferably equal to or smaller than 70% by mass.

(Bifunctional Polymerizable Liquid Crystal Compound)

Among the compounds represented by General Formula (II), a compound represented by General Formula (II-2-2) is preferable, as a bifunctional polymerizable liquid crystal compound including two polymerizable functional groups in a molecule.

[Chem. 213]

P²¹—(S²¹—X²¹)_{q1}-MG-(X²²—S²²)_{q2}P²³ (II-2-2)

In the formula, P²¹, S²¹, X²¹, q1, MG, X²², S²², q2, and P²³ respectively represent the same definition as those in General Formula (II). As examples of General Formula (II-2-2), compounds represented by General Formulae (II-2-2-1) to (II-2-2-4) can be used, but there is no limitation to General Formulae below.

[Chem. 214]

P²¹—(S²¹—X²¹)_{q1}-B2-Z2-B3-(X²²—S²²)_{q2}P²³ (II-2-2-1)

P²¹—(S²¹—X²¹)_{q1}B11-Z11-B2-Z2-B3-(X²²—S²²)_{q2}—P²³ (II-2-2-2)

P²¹—(S²¹—X²¹)_{q1}-B11-Z11-BIZ B2-Z2-B23-(X²²—S²²)_{q2}—P²³ (II-2-2-3)

P²¹—(S²¹—X²¹)_{q1}—B11-Z11-B12-Z12-B13-Z13-B2-Z2-B3-(X²²—S²²)_{q2}P²³ (II-2-2-4)

In the formulae, P²¹, S²¹, X²¹, q1, MG, X²², S²², q2, and P²³ respectively represent the same definition as those in General Formula (II), B11, B12, B13, B2, and B3 represent the same definition as B1 to B3 of General Formula (II-b), and these may be respectively the same as each other or different from each other. Z11, Z¹², Z¹³, and Z2 represent the same definition as Z1 to Z3 of General Formula (II-b), and these may be respectively the same as each other or different from each other.

Among the compounds represented by General Formulae (II-2-2-1) to (II-2-2-4), it is preferable to use the compounds represented by General Formulae (II-2-2-2) to (II-2-2-4) having three or more of ring structures in the compound, because alignment of an optically anisotropic body to be obtained is excellent and hardenability is excellent. It is particularly preferable to use a compound represented by General Formula (II-2-2-2) having three or more of ring structures in the compound.

As the compounds represented by General Formulae (II-2-2-1) to (II-2-2-4), compounds represented by General Formula (1I-2-2-1-1) to General Formula (II-2-2-1-45) are used, but there is no limitation thereto.

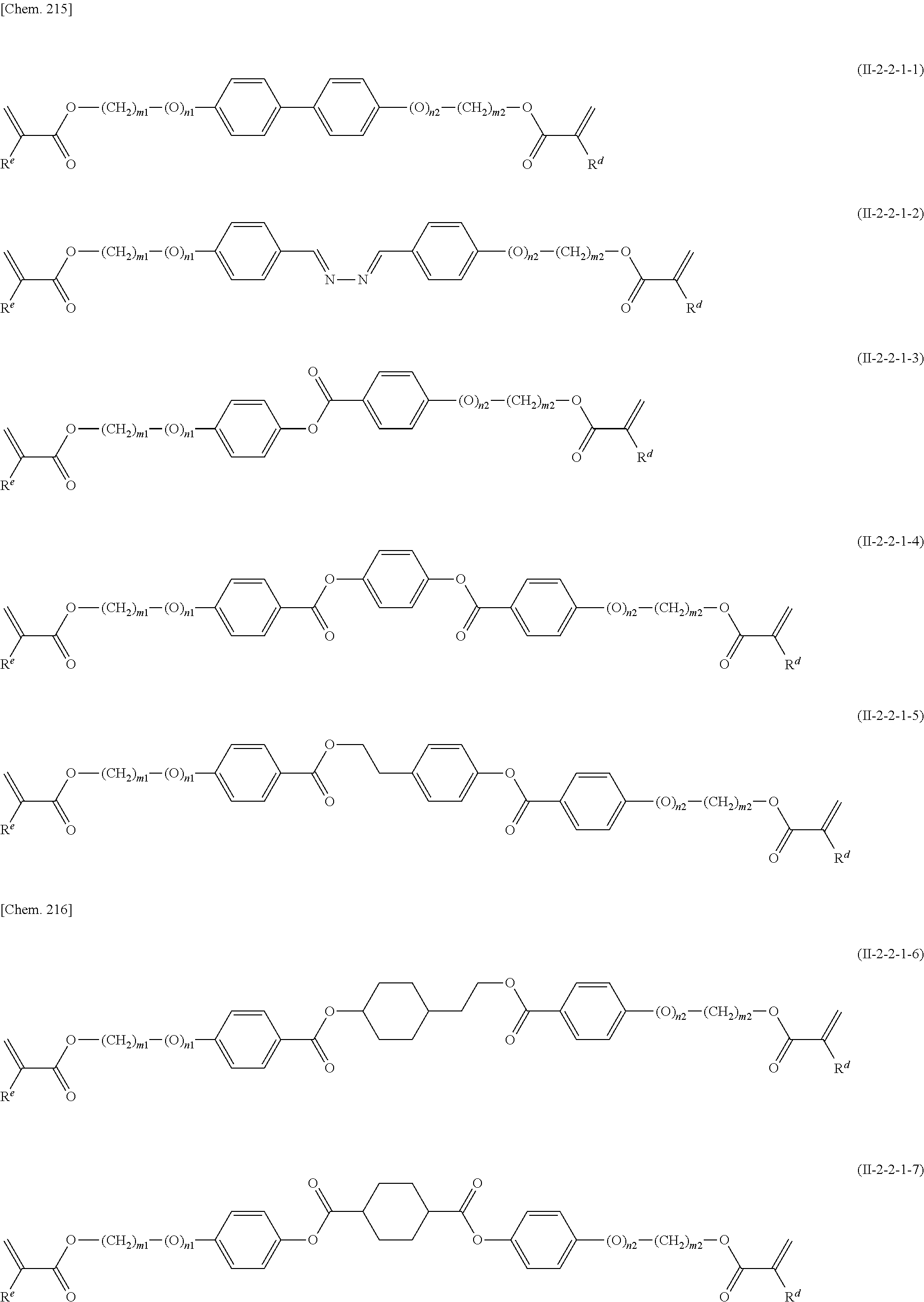

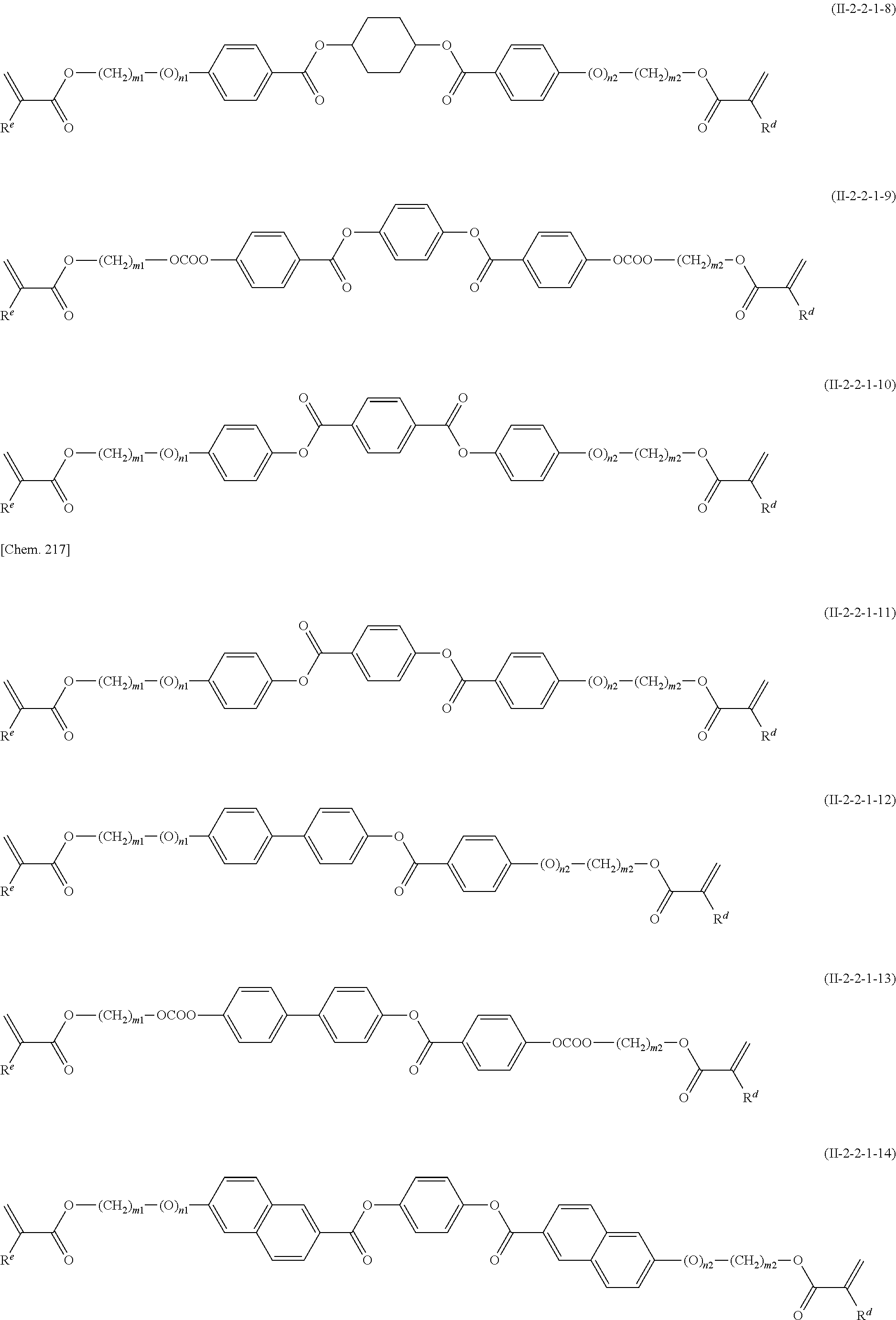

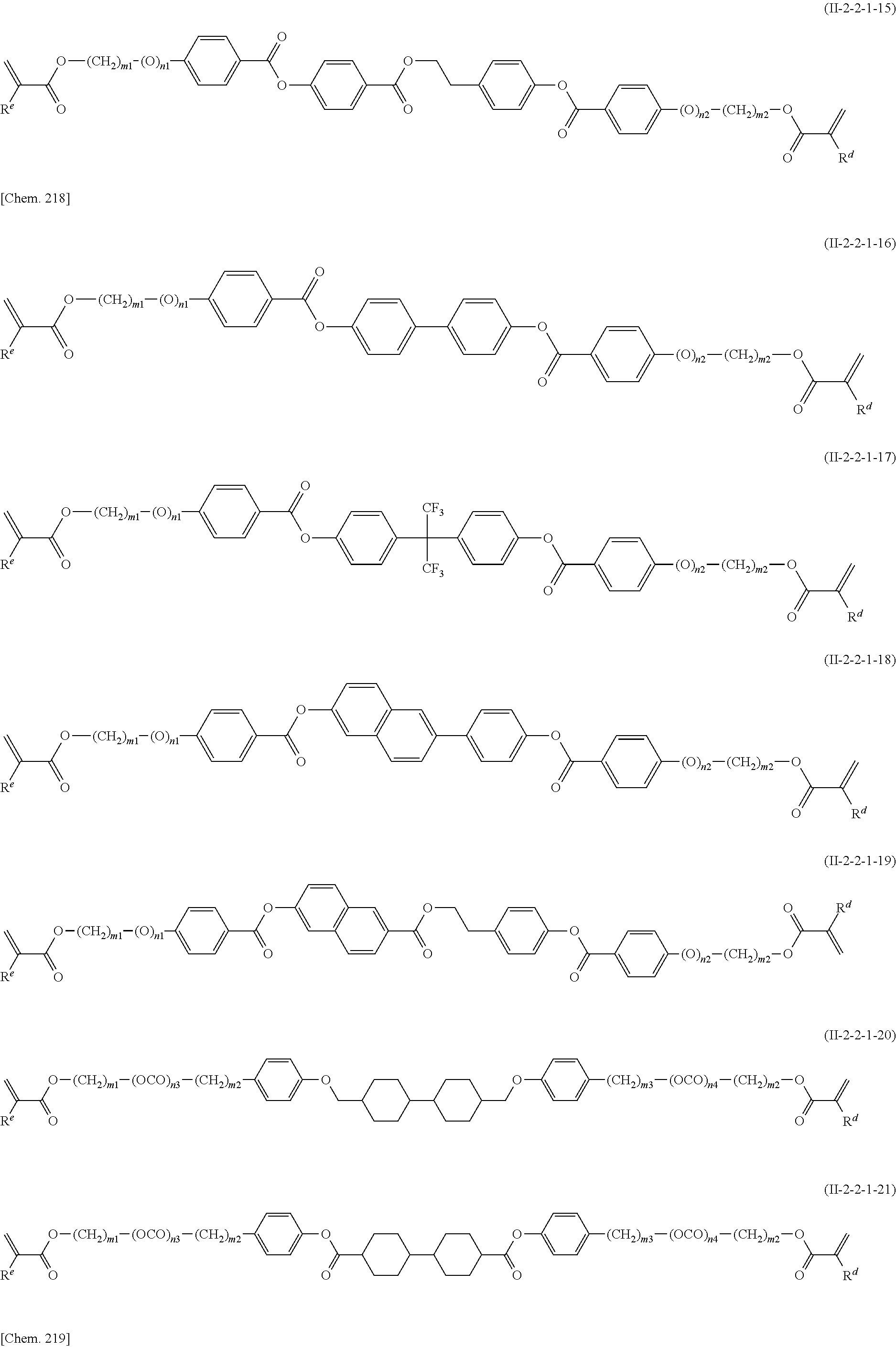

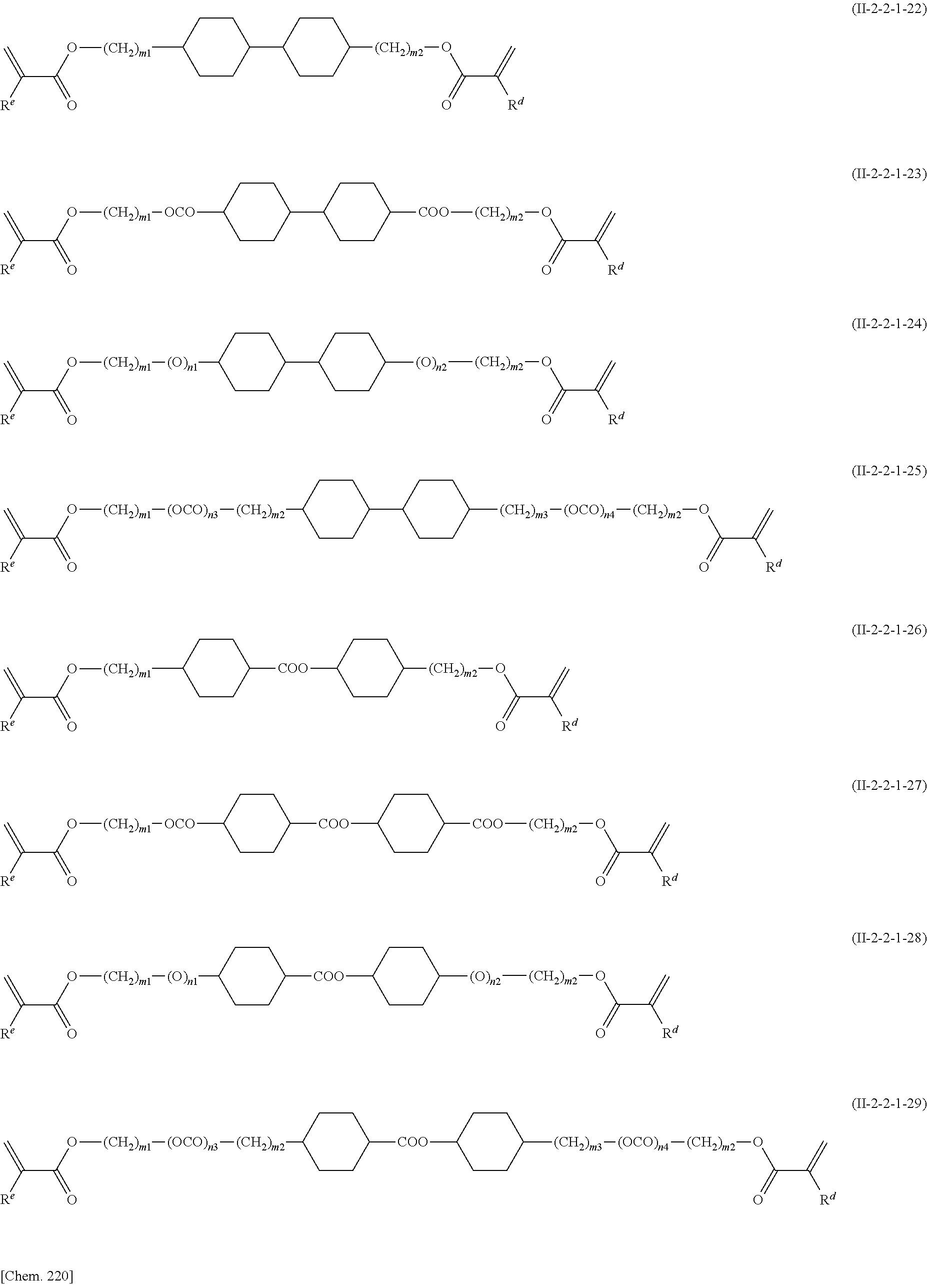

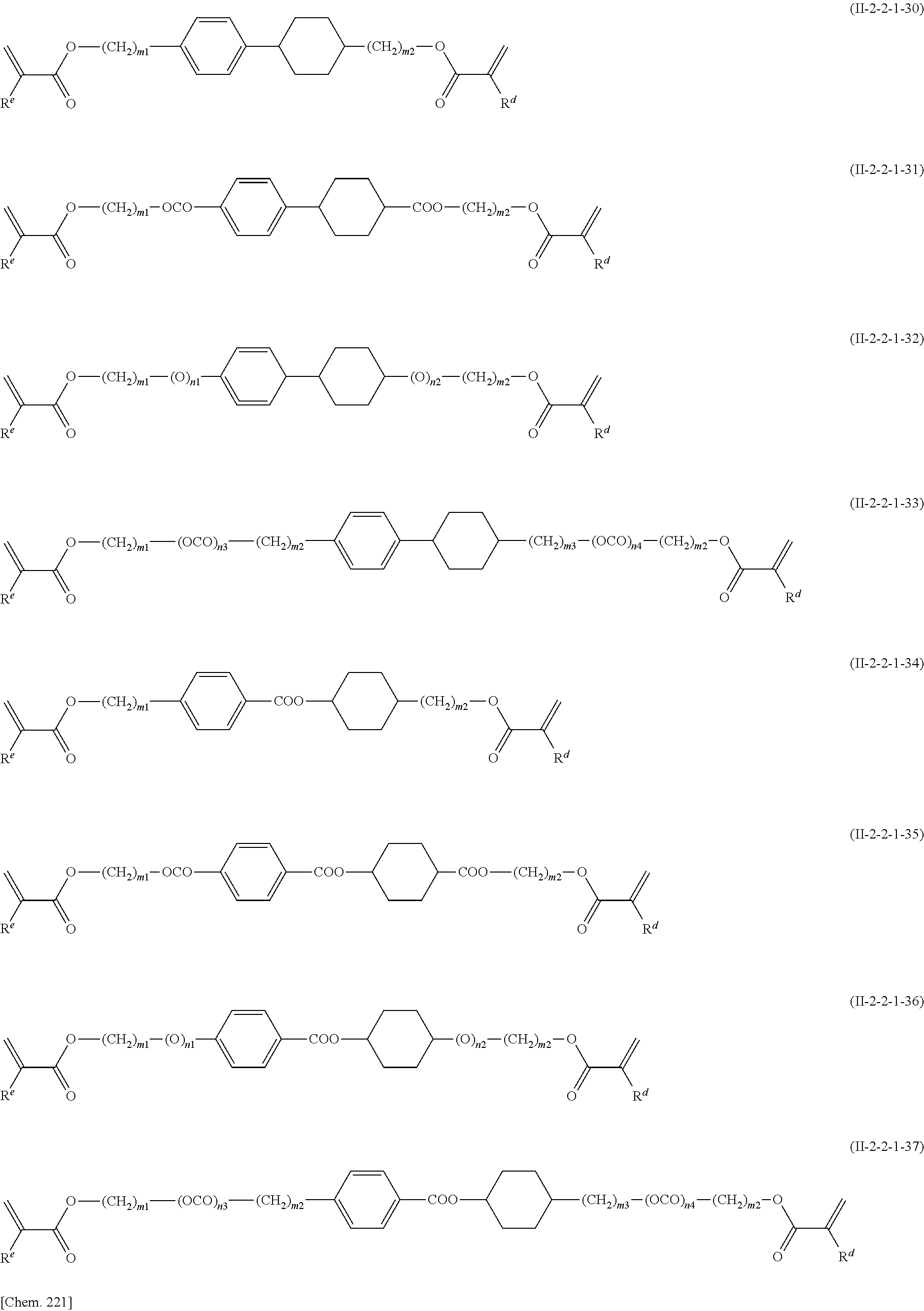

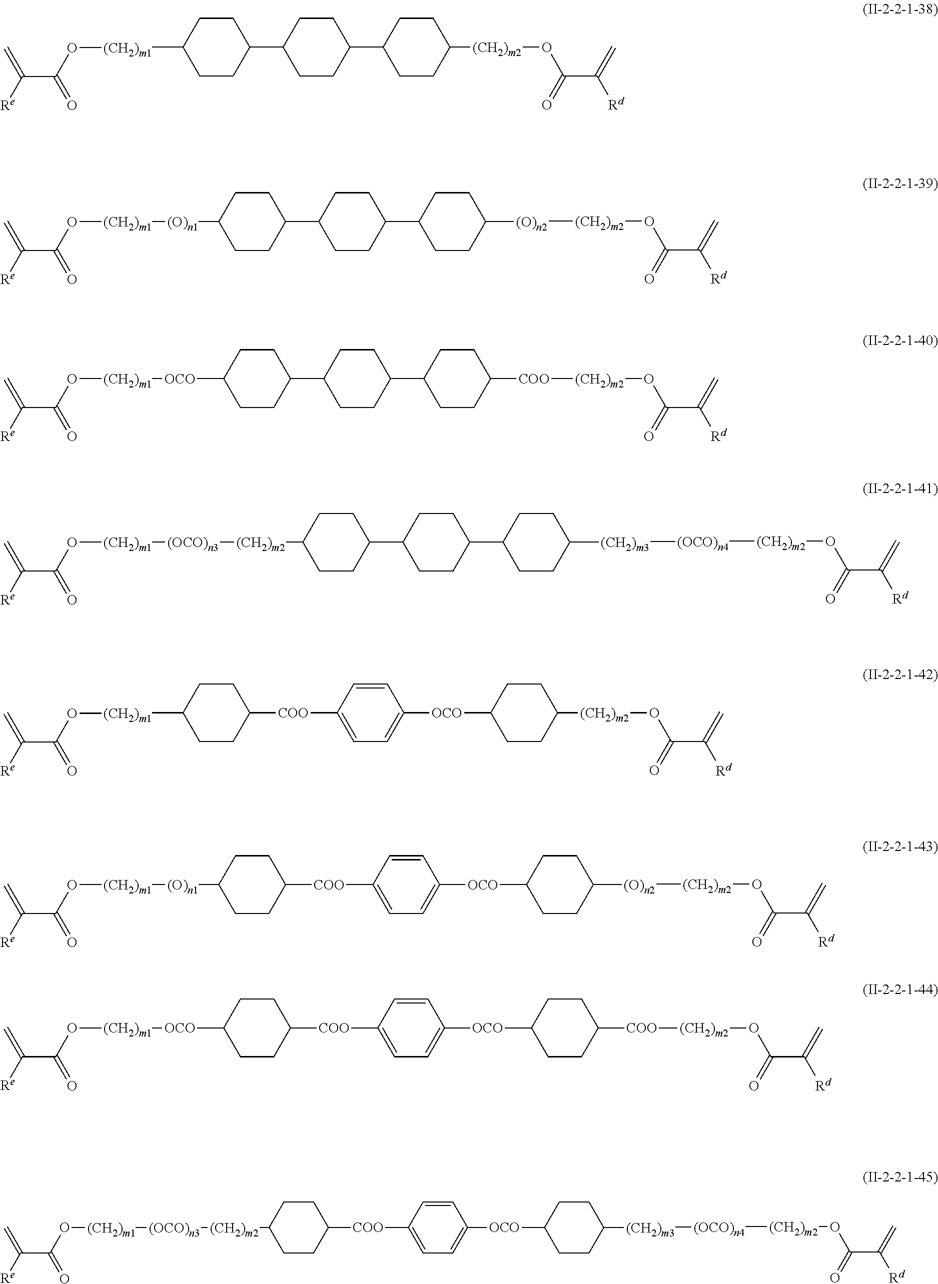

In the formulae, R^{d} and R^{e} each independently represent a hydrogen atom or a methyl group, and the cyclic group may include one or more of F, Cl, CF₃, OCF₃, a CN group, an alkyl group having 1 to 8 carbon atoms, an alkoxy group having 1 to 8 carbon atoms, an alkanoyl group having 1 to 8 carbon atoms, an alkanoyloxy group having 1 to 8 carbon atoms, an alkoxycarbonyl group having 1 to 8 carbon atoms, an alkenyl group having 2 to 8 carbon atoms, an alkenyloxy group having 2 to 8 carbon atoms, an alkenoyl group having 2 to 8 carbon atoms, or an alkenoyloxy group having 2 to 8 carbon atoms, as a substituent.

m1 and m2 each independently represent an integer of 0 to 18, and n1, n2, n3, and n4 each independently represent 0 or 1.

More specifically, compounds represented by the following formulae are preferable.

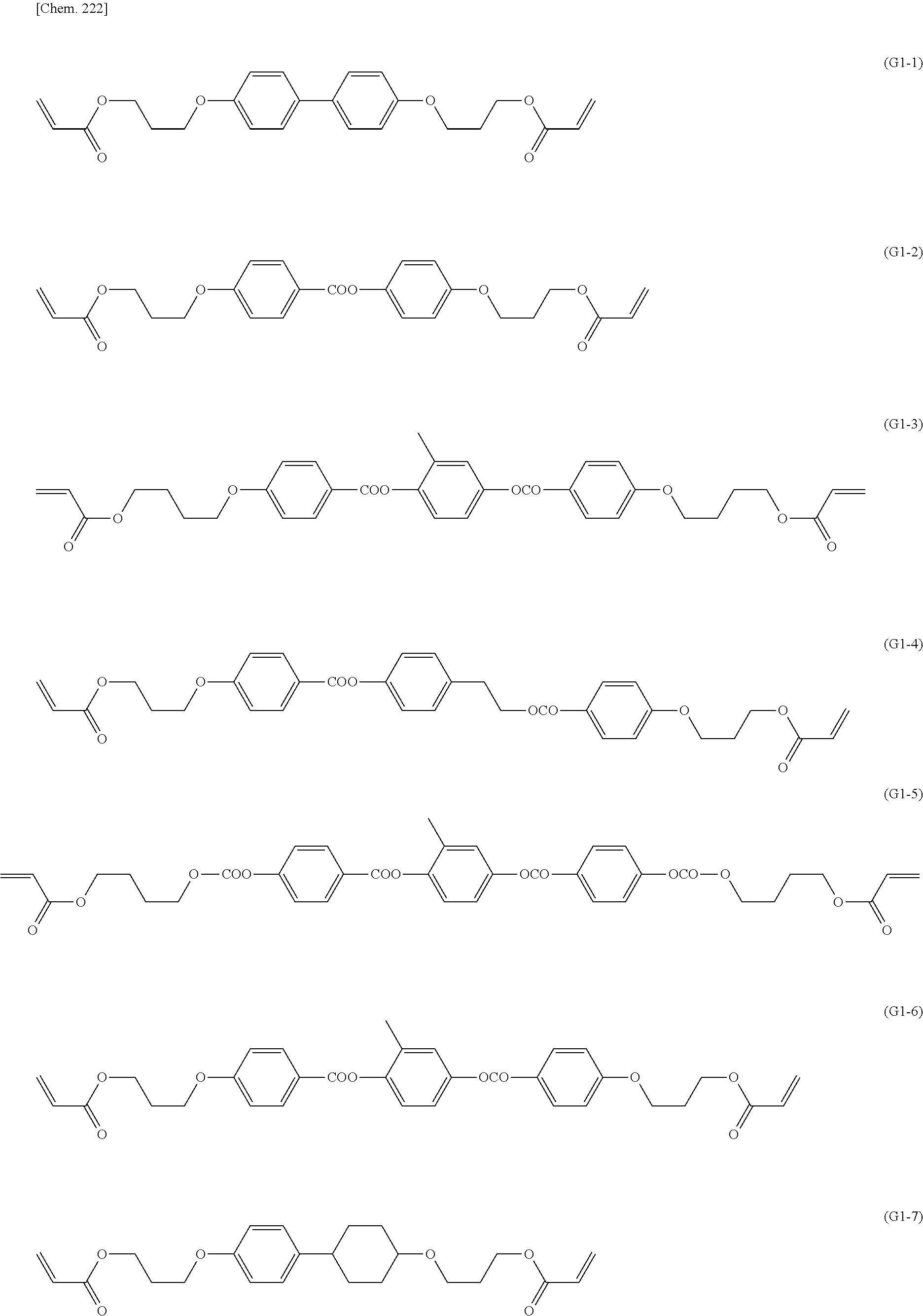

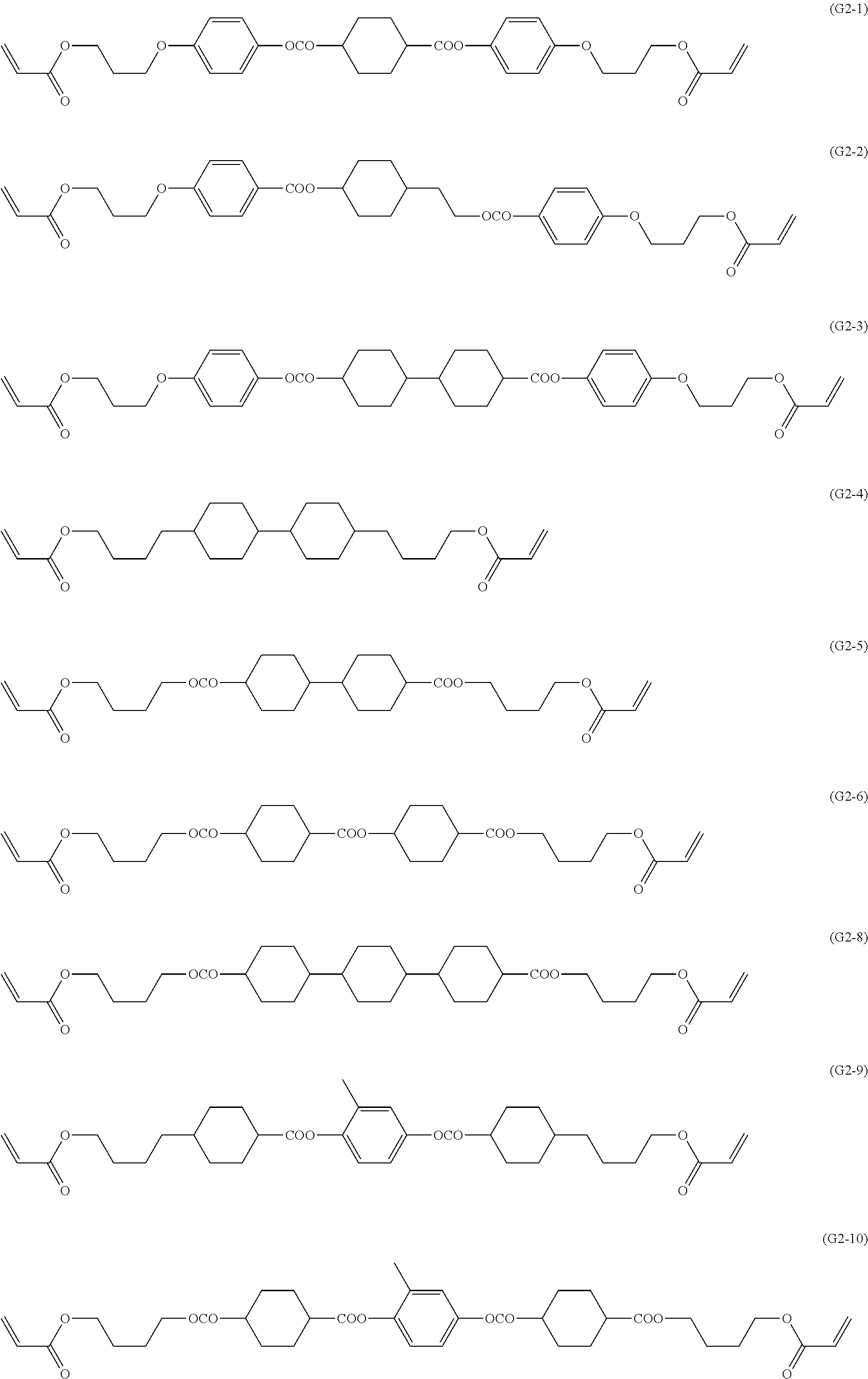

The total content of the bifunctional polymerizable liquid crystal compound including two polymerizable functional groups in a molecule is preferably 10% to 100% by mass, more preferably 15% to 85% by mass, and particularly preferably 20% to 80% by mass, with respect to the total amount of the compound represented by General Formula (II) used. In a case of significantly considering hardness of a coated film, the lower limit value is preferably equal to or greater than 30% by mass and more preferably equal to or greater than 50% by mass, and in a case of significantly considering alignment of an optically anisotropic body, the upper limit value is preferably equal to or smaller than 85% by mass and more preferably equal to or smaller than 80% by mass.

(Multifunctional Polymerizable Liquid Crystal Compound)

As a multifunctional polymerizable liquid crystal compound including three or more of polymerizable functional groups, a compound including three polymerizable functional groups is preferably used. Among the compounds represented by General Formula (II), a compound represented by General Formula (1I-2-3) is preferable, as a multifunctional polymerizable liquid crystal compound including three polymerizable functional groups in a molecule.

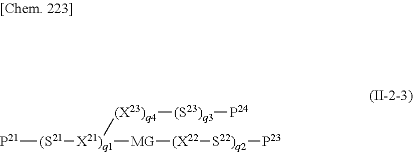

In the formula, P²¹, S²¹, X²¹, q1, MG, X²², S²², q2, P²³, X²³, q4, S²³, q3, P²⁴ respectively represent the same definition as those in General Formula (II). As examples of General Formula (II-2-3), compounds represented by General Formulae (II-2-3-1) to (II-2-3-8) can be used, but there is no limitation to General Formulae below.

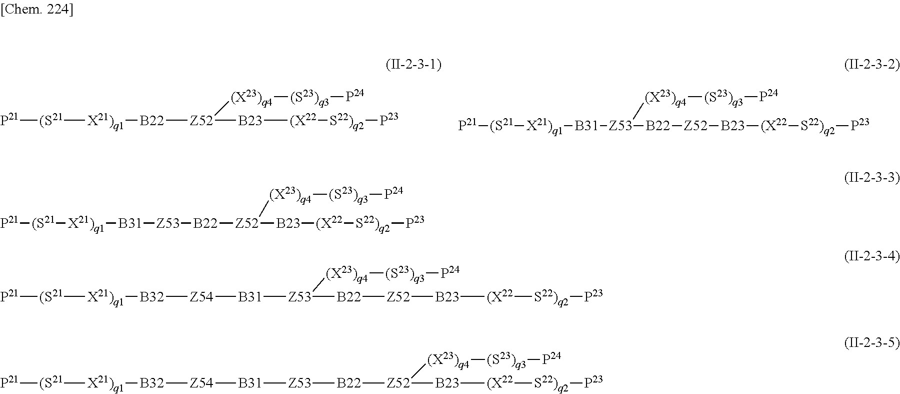

In the formulae, P²¹, S²¹, X²¹, q1, MG, X²², S²², q2, P²³, X²³, q4, S²³, q3, P²⁴ respectively represent the same definition as those in General Formula (II), B³¹, B³², B²², B²³ represent the same definition as B²¹ to B²³ of General Formula (II-b), and these may be respectively the same as each other or different from each other. Z⁵², Z⁵³, and Z⁵⁴ represent the same definition as Z⁵¹ and Z⁵² of General Formula (II-b), and these may be respectively the same as each other or different from each other.

As the compounds represented by General Formulae (II-2-3-1) to (II-2-3-5), compounds represented by General Formula (II-2-3-1-1) to General Formula (II-2-3-1-6) are used, but there is no limitation thereto.

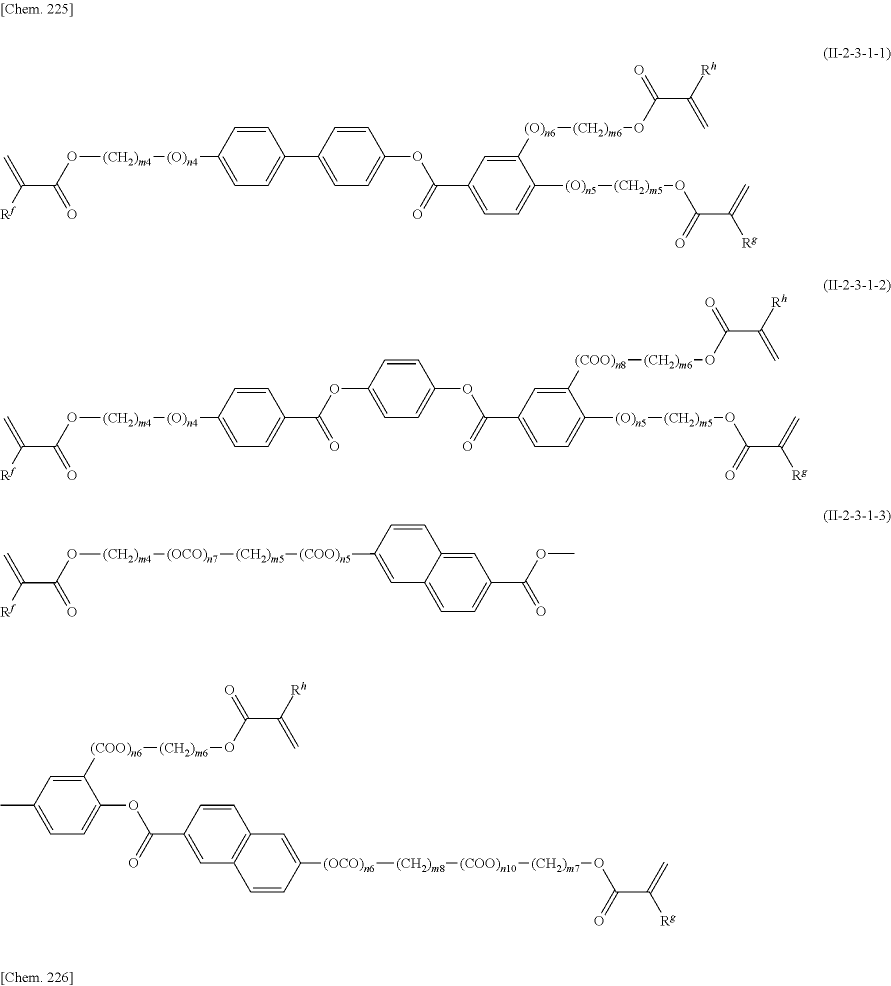

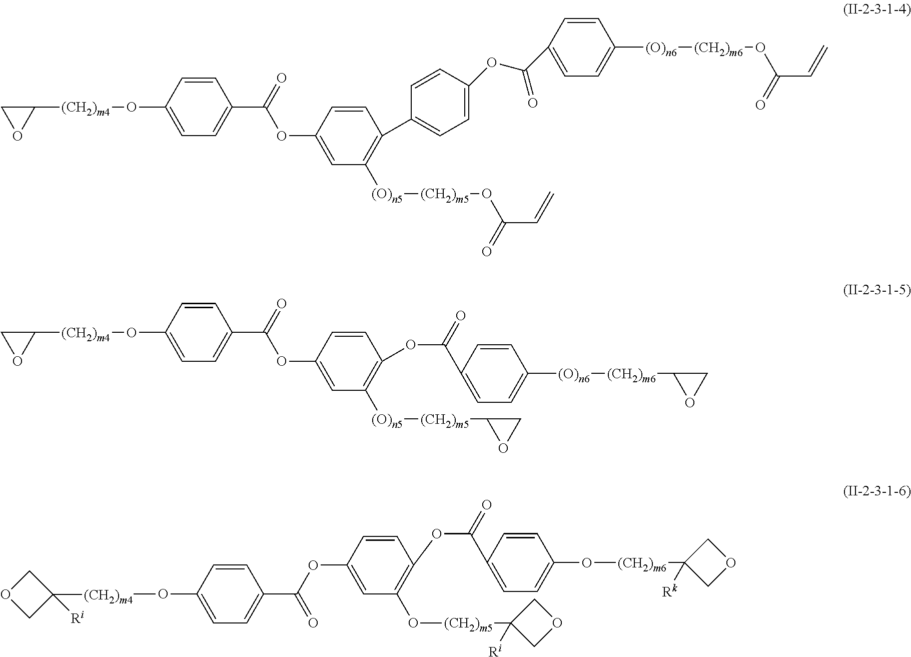

In the formulae, R^{f}, R^{g}, and R^{h} each independently represent a hydrogen atom or a methyl group, Rⁱ, R^{j}, and R^{k} each independently represent a hydrogen atom, a halogen atom, an alkyl group having 1 to 6 carbon atoms, an alkoxy group having 1 to 6 carbon atoms, or a cyano group. In a case where these groups are an alkyl group having 1 to 6 carbon atoms or an alkoxy group having 1 to 6 carbon atoms, all of the groups may be unsubstituted or substituted with one halogen atom or two or more of halogen atoms, and the cyclic group may include one or more of F, Cl, CF₃, OCF₃, a CN group, an alkyl group having 1 to 8 carbon atoms, an alkoxy group having 1 to 8 carbon atoms, an alkanoyl group having 1 to 8 carbon atoms, an alkanoyloxy group having 1 to 8 carbon atoms, an alkoxycarbonyl group having 1 to 8 carbon atoms, an alkenyl group having 2 to 8 carbon atoms, an alkenyloxy group having 2 to 8 carbon atoms, an alkenoyl group having 2 to 8 carbon atoms, or an alkenoyloxy group having 2 to 8 carbon atoms, as a substituent.

m4 to m9 each independently represent an integer of 0 to 18, and n4 to n9 each independently represent 0 or 1.

One kind or two or more kinds of the multifunctional polymerizable liquid crystal compound including three or more of polymerizable functional groups can be used.

The total content of the multifunctional polymerizable liquid crystal compound including three or more of polymerizable functional groups in a molecule is preferably 0% to 80% by mass, more preferably 0% to 60% by mass, and particularly preferably 0% to 40% by mass, with respect to total amount of the compound represented by General Formula (II) used. In a case of significantly considering rigidity of an optically anisotropic body, the lower limit value is preferably equal to or greater than 10% by mass, more preferably equal to or greater than 20% by mass, and particularly preferably equal to or greater than 30% by mass. Meanwhile, in a case of significantly considering low curing shrinkage, the upper limit value is preferably equal to or smaller than 50% by mass, more preferably equal to or smaller than 35% by mass, and particularly preferably equal to or smaller than 20% by mass.

(Use of Plurality of Kinds of Polymerizable Liquid Crystal Compounds)

In the polymerizable liquid crystal composition of the present invention, a plurality of kinds of the polymerizable liquid crystal compounds are preferably mixed with each other and used. It is preferable that at least one kind or more of monofunctional polymerizable liquid crystal compound, at least one kind or more of bifunctional polymerizable liquid crystal compound, and/or multifunctional polymerizable liquid crystal compound are used in combination, because hardenability of an optically anisotropic body to be obtained is improved and excellent adhesiveness with a base material is obtained. It is more preferable that at least one kind or more of monofunctional polymerizable liquid crystal compound and at least one kind or more of bifunctional polymerizable liquid crystal compound are used in combination. Among these, when an optically anisotropic body is obtained by using the polymerizable liquid crystal composition of the present invention, in a case of further improving hardenability, as the bifunctional polymerizable liquid crystal compound, it is preferable to obtain a mixture of the polymerizable liquid crystal compounds by using the compound selected from (II-2-2-1) to (II-2-2-2) including two or three ring structures in the compound, and it is particularly preferable to obtain a mixture in which the compound represented by (II-2-1-1) and (II-2-2-1) including two ring structures are used in the compound in combination.

The total amount of the monofunctional polymerizable liquid crystal compound and the bifunctional polymerizable liquid crystal compound is preferably 70% by mass to 100% by mass and particularly preferably 80% by mass to 100% by mass, with respect to the total amount of the compound represented by General Formula (II) used.

The total content of the compound represented by General Formula (II) is preferably 5% to 90% by mass, more preferably 5% to 70% by mass, and particularly preferably 5% to 40% by mass, with respect to total amount of the polymerizable compound used in the polymerizable composition (that is, the total content of the reverse dispersible compound represented by General Formula (I) and the total content of the compound represented by General Formula (II)).

(Other Liquid Crystal Compounds)

In addition, a compound including a mesogenic group not including a polymerizable group may be added to the liquid crystal composition of the present invention, and compounds used in typical liquid crystal devices, for example, supertwisted nematic (STN) liquid crystal, twisted nematic (TN) liquid crystal, or thin film transistor (TFT) liquid crystal, are used.

Specifically, the compound including a mesogenic group not including a polymerizable functional group is preferably a compound represented by General Formula (5).

[Chem. 227]

R⁵¹-MG3-R⁵² (5)

A mesogenic group represented by MG3 or mesogenic support group is a compound represented by General Formula (5-b).

[Chem. 228]

—Z0^{d}-(A1^{d}-Z1^{d})ₙₑ-A2^{d}-Z2^{d}-A3^{d}-Z3^{d}- (5-b)

(In the formula, A1^{d}, A2^{d}, and A3^{d} each independently represent a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo (2,2,2) octylene group, a decahydronaphthalene-2,6-diyl group, a pyridine-2,5-diyl group, a pyrimidine-2,5-diyl group, a pyrazine-2,5-diyl group, a thiophene-2,5-diyl group-, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [I]benzothieno[3,2-b]thiophene-2,7-diyl group, a [1]benzoselenopheno[3,2-b] selenophene-2,7-diyl group, or a fluorene-2,7-diyl group. As a substituent, one or more of F, Cl, CF₃, OCF₃, a CN group, an alkyl group, an alkoxy group, an alkanoyl group, or an alkanoyloxy group having 1 to 8 carbon atoms, an alkenyl group, an alkenyloxy group, an alkenoyl group, or an alkenoyloxy group having 2 to 8 carbon atoms. Z0^{d}, Z1^{d}, Z2^{d}, and Z3^{d} each independently represent —COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, an alkylene group having 2 to 10 carbon atoms which may include a halogen atoms, or a single bond. n^{e} represents 0, 1, or 2, R⁵¹ and R⁵² each independently represent a hydrogen atom, a halogen atom, a cyano group, or an alkyl group having 1 to 18 carbon atoms, the alkyl group may be substituted with one or more of halogen atoms or CN, and one CH₂ group or two or more of (—CH₂—)'s that are not adjacent to each other present in this group may be each mutually independently substituted with —O—, —S—, —NH—, —N(CH₃)—, —CO—, —COO—, —OCO—, —OCOO—, —SCO—, —COS—, or —C≡C—, in a state where oxygen atoms are not directly bonded to each other.)

Specifically, the following examples are shown, but there is no limitation.

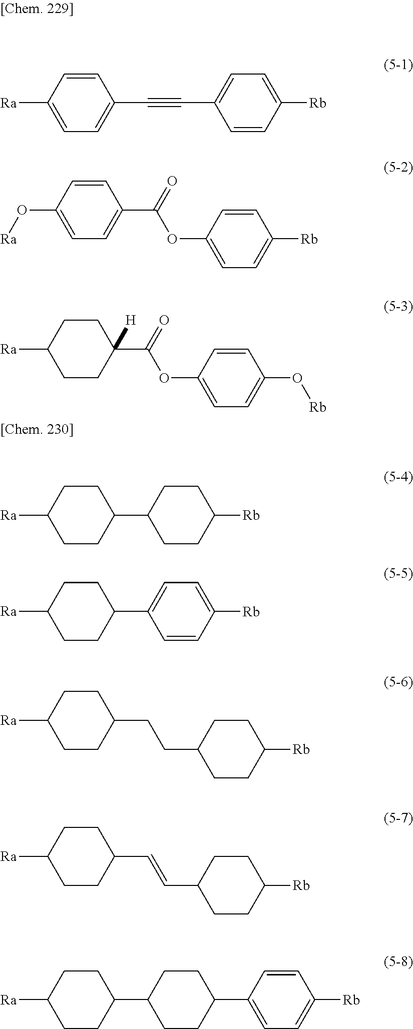

Ra and Rb each independently represent a hydrogen atom, an alkyl group having 1 to 6 carbon atoms, an alkoxy group having 1 to 6 carbon atoms, an alkenyl group having 1 to 6 carbon atoms, a cyano group. In a case where these groups are an alkyl group having 1 to 6 carbon atoms or an alkoxy group having 1 to 6 carbon atoms, all of the groups may be unsubstituted or substituted with one halogen atom or two or more of halogen atoms.

The total content of the compound including a mesogenic group is preferably 0% by mass to 20% by mass, with respect to the total amount of the total content of the reverse dispersible compound represented by General Formula (I) and the total content of the compound represented by General Formula (II). In a case of use, the total content is preferably equal to or greater than 1% by mass, preferably equal to or greater than 2% by mass, and preferably equal to or greater than 5% by mass, and preferably equal to or smaller than 15% by mass, and preferably equal to or smaller than 10% by mass.

(Other Components)

(Chiral Compound)

The polymerizable liquid crystal composition of the present invention can also include a polymerizable chiral compound which may exhibit liquid crystal properties or may be amorphous, in addition to the polymerizable compound represented by General Formula (II).

The polymerizable chiral compound used in the present invention preferably includes one or more of polymerizable functional groups. Examples of such a compound include a polymerizable chiral compound including chiral saccharide such as isosorbide, isomannit, or glucoside, a rigid part such as 1,4-phenylene group or 1,4-cyclohexylene group, and a polymerizable functional group such as a vinyl group, an acryloyl group, a (meth)acryloyl group, or a maleimide group, disclosed in JP-A-H11-193287, JP-A-2001-158788, JP-T-2006-52669, JP-A-2007-269639, JP-A-2007-269640, and JP-A-2009-84178, a polymerizable chiral compound formed of a terpenoid derivative, disclosed in JP-A-H8-239666, a polymerizable chiral compound formed of a mesogenic group and a spacer including a chiral part, disclosed in NATURE Vol. 35, pp. 467-469 (published 30, November 1995), and NATURE Vol. 392, pp. 476-479 (published 2, April, 1998), or a polymerizable chiral compound including a binaphthyl group disclosed in JP-T-2004-504285 and JP-A-2007-248945. Among these, a chiral compound having a great helical twisting power (HTP) is preferably used in the polymerizable liquid crystal composition of the present invention.

It is necessary that a blending amount of the polymerizable chiral compound is suitably adjusted in accordance with a helical induction power of the compound, and the blending amount is preferably 0% to 25% by mass, more preferably 0% to 20% by mass, and particularly preferably 0% to 15% by mass, with respect to the total amount of the total content of the reverse dispersible compound represented by General Formula (I) and the total content of the compound represented by General Formula (II).

As one example of General Formula of the polymerizable chiral compound, General Formulae (3-1) to (3-4) can be used, but there is no limitation to the general formulae.

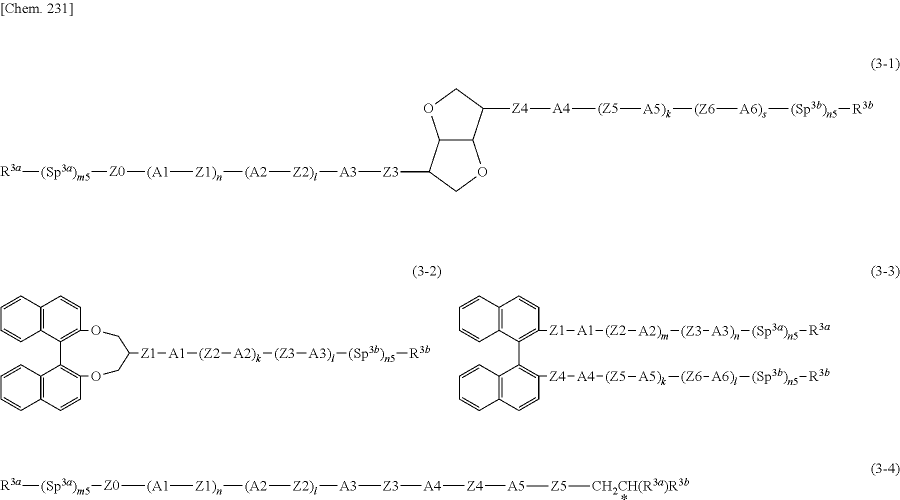

In the formulae, SP^{3a} and SP^{3b} each independently represent an alkylene group having 0 to 18 carbon atoms, the alkylene group may be substituted with one or more of halogen atoms, a CN group, or an alkyl group having 1 to 8 carbon atoms including a polymerizable functional group, and one CH₂ group or two or more of (—CH₂—)'s CH₂ groups that are not adjacent to each other present in this group may be each mutually independently substituted with —O—, —S—, —NH—, —N(CH₃)—, —CO—, —COO—, —OCO—, —OCOO—, —SCO—, —COS—, or —C≡C—, in a state where oxygen atoms are not directly bonded to each other. A1, A2, A3, A4, and A5 each independently represent a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo (2,2,2) octylene group, a decahydronaphthalene-2,6-diyl group, a pyridine-2,5-diyl group, a pyrimidine-2,5-diyl group, a pyrazine-2,5-diyl group, a thiophene-2,5-diyl group-, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2, 7-diyl group. n, 1, k each independently represent 0 or 1, a relationship of 0<n+1+k<3 is satisfied. Z0, Z1, Z2, Z3, Z4, Z5, and Z6 each independently represent —COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, an alkyl group having 2 to 10 carbon atoms which may include a halogen atom, or a single bond. n5 and m5 each independently represent 0 or 1, R^{3a} and R^{3b} represent a hydrogen atom, a halogen atom, a cyano group, or an alkyl group having 1 to 18 carbon atoms, the alkyl group may be substituted with one or more of halogen atoms or CN, and one CH₂ group or two or more of (—CH₂—)'s that are not adjacent to each other present in this group may be each mutually independently substituted with —O—, —S—, —NH—, —N(CH₃)—, —CO—, —COO—, —OCO—, —OCOO—, —SCO—, —COS—, or —C≡C—, in a state where oxygen atoms are not directly bonded to each other. Alternatively, R^{3a} and R^{3b} preferably represent General Formula (3-a).

[Chem. 232]

—P^{3a} (3-a)

(In the formula, R^{3a} represents a polymerizable functional group and SP^{3a} represents the same meaning as SP¹.)

P^{3a} preferably represents a substituent selected from a polymerizable group represented by Formula (P-1) to Formula (P-20).

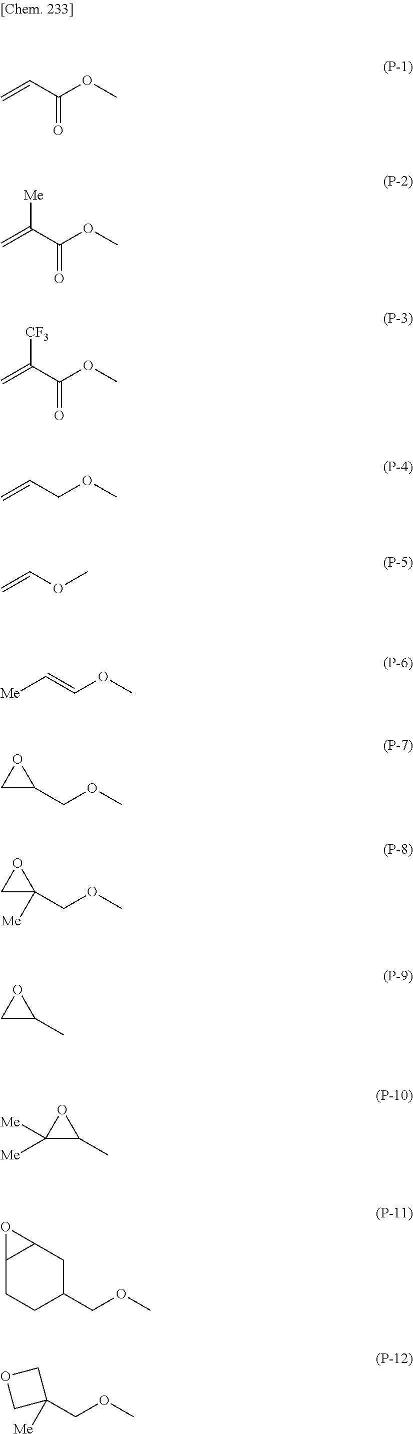

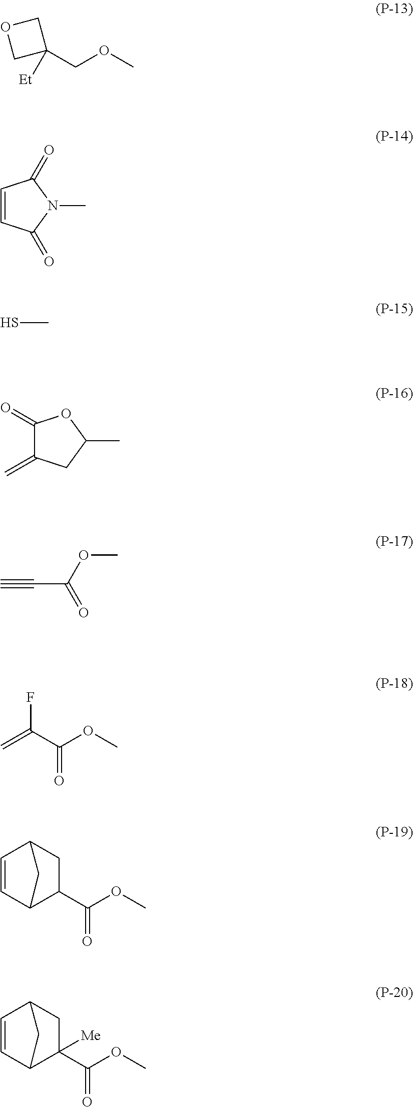

Among these polymerizable functional groups, from a viewpoint of increasing polymerizability and storage stability, Formula (P-1), (P-2), (P-7), (P-12), or (P-13) is preferable, and Formula (P-1), (P-7), or (P-12) is more preferable.

As specific examples of the polymerizable chiral compound, compounds of Compounds (3-5) to (3-25) can be used, but there is no limitation to the following compounds.

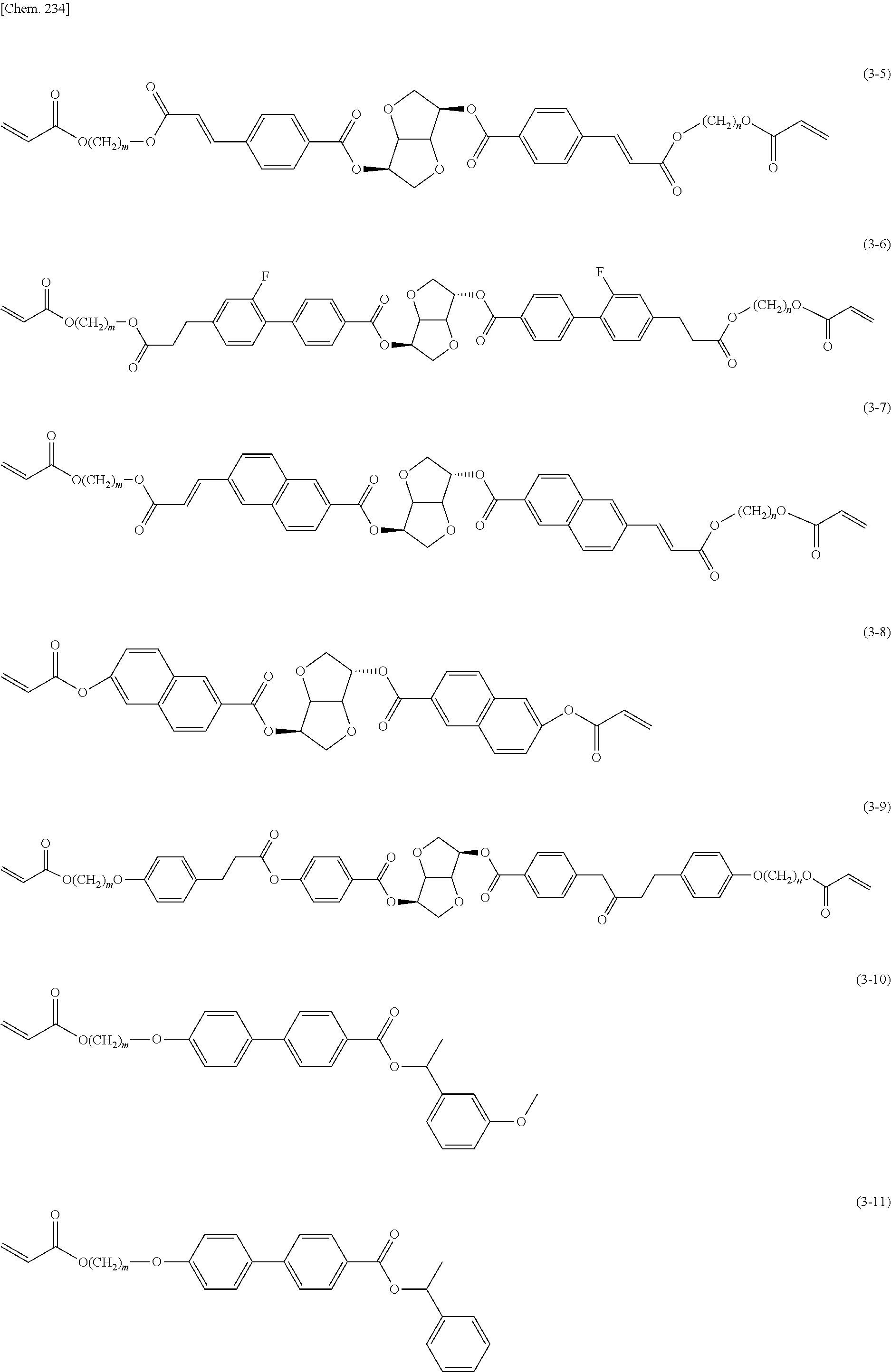

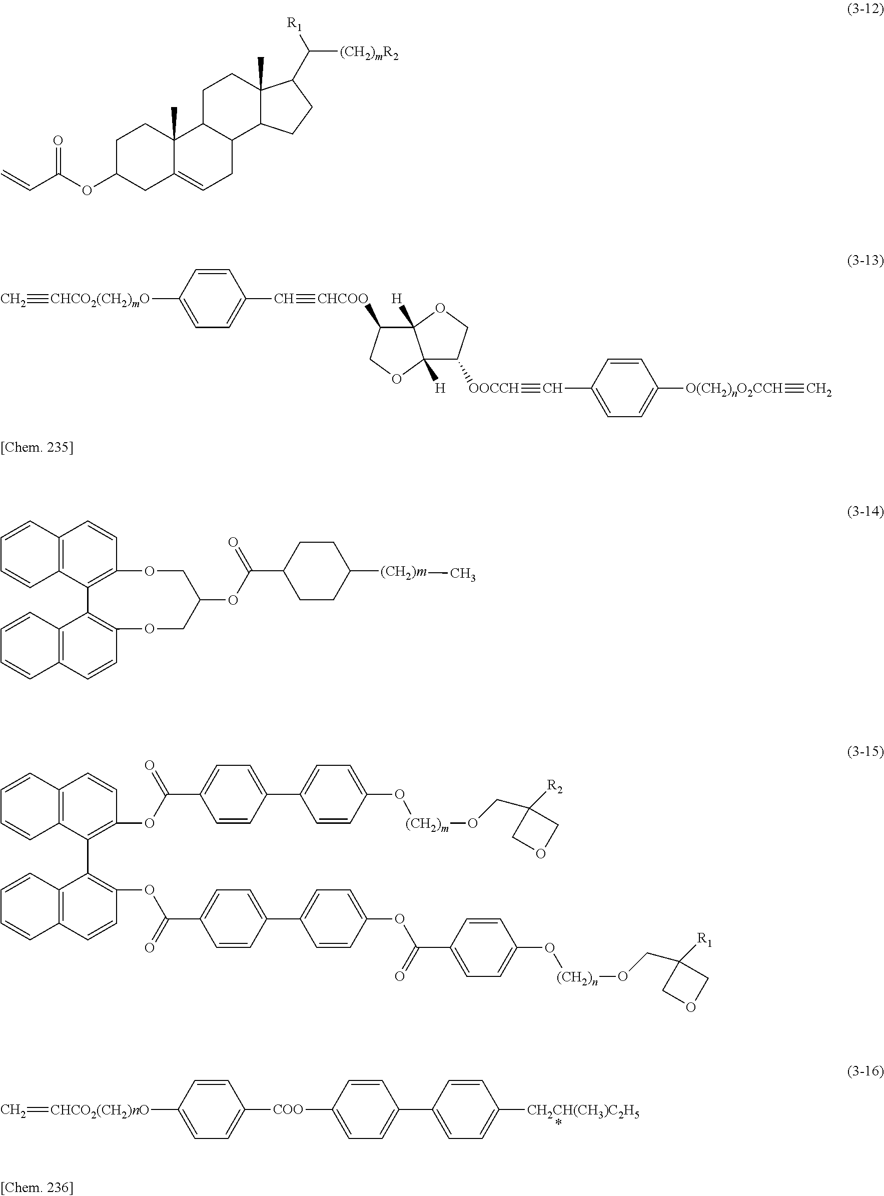

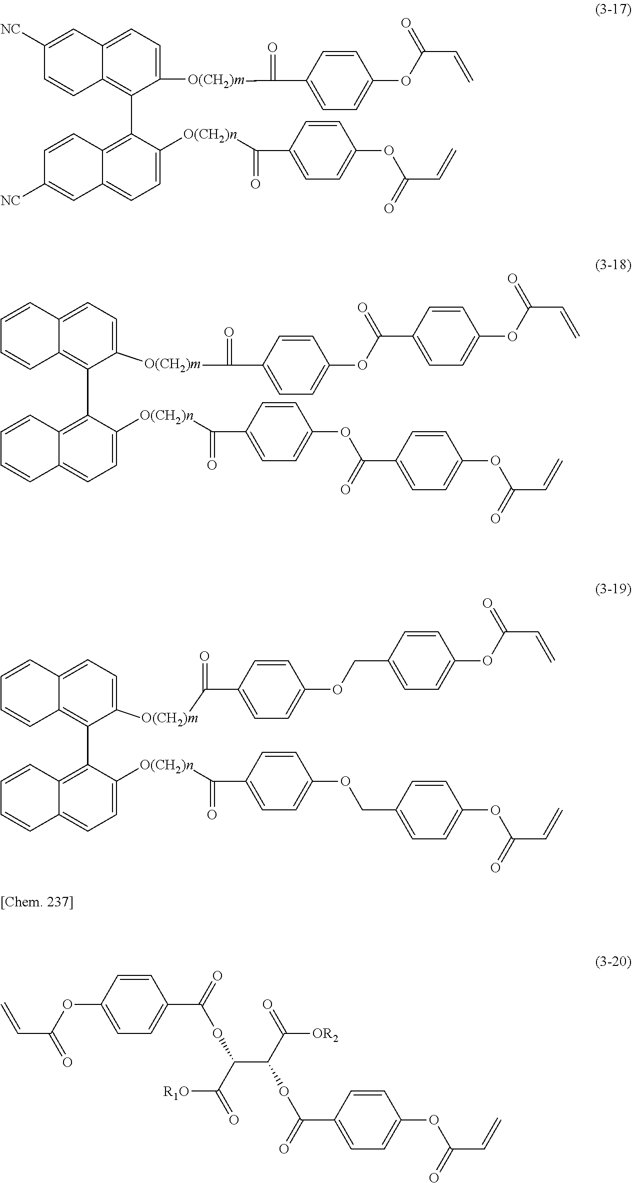

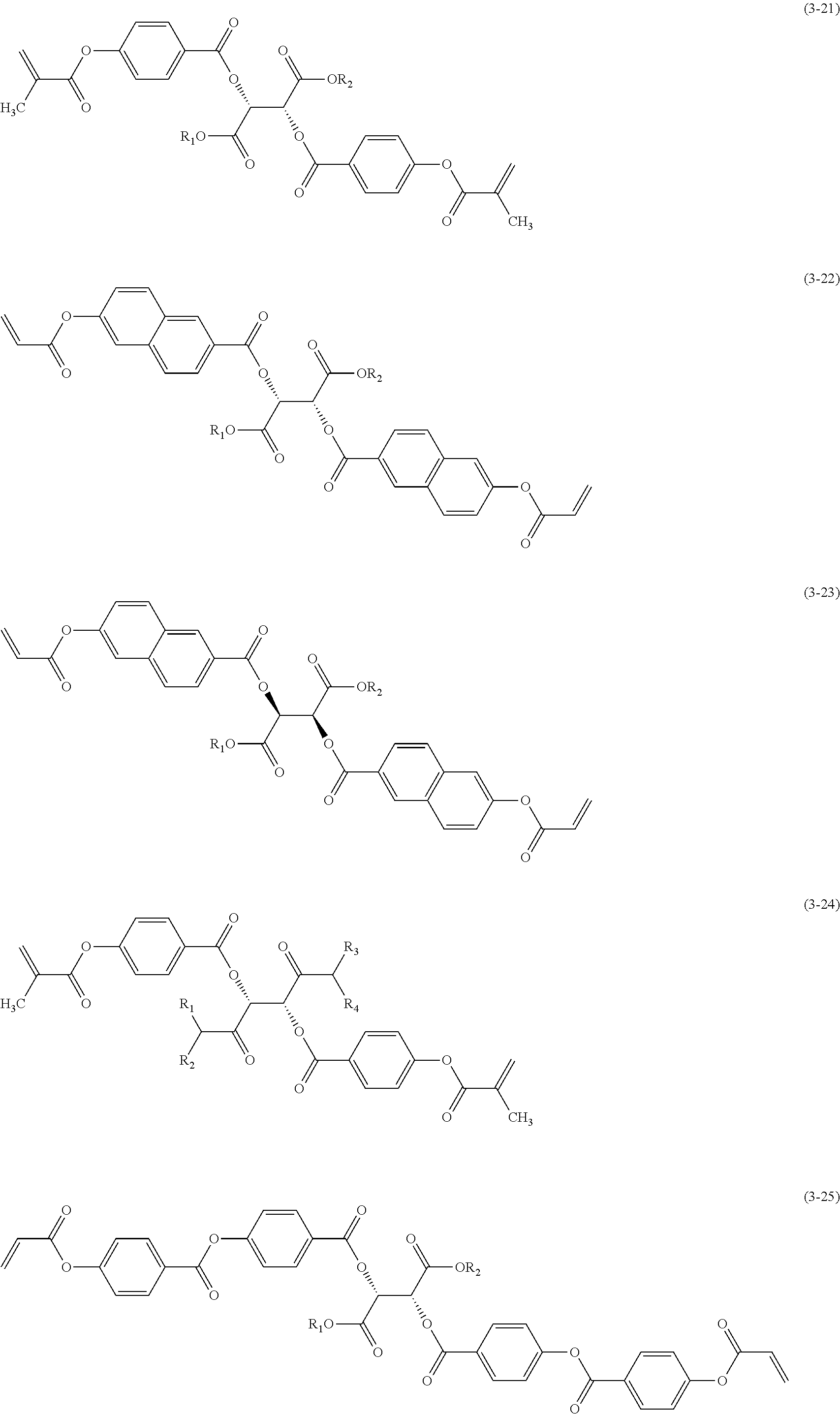

In the formulae, m, n, k, and l each independently represent an integer of 1 to 18, and R₁ to R₄ each independently represent a hydrogen atom, an alkyl group having 1 to 6 carbon atoms, an alkoxy group having 1 to 6 carbon atoms, a carboxyl group, or a cyano group. In a case where these groups are an alkyl group having 1 to 6 carbon atoms or an alkoxy group having 1 to 6 carbon atoms, all of the groups may be unsubstituted or substituted with one halogen atom or two or more of halogen atoms.

(Polymerizable Discotic Compound)

The polymerizable liquid crystal composition of the present invention can also include a polymerizable discotic compound which may exhibit liquid crystal properties or may be amorphous, in addition to the polymerizable compound represented by General Formula (II).

The polymerizable discotic compound used in the present invention preferably includes one or more of polymerizable functional groups. Examples of such a compound include a polymerizable compound disclosed in JP-A-H7-281028, JP-A-H7-287120, JP-A-H7-333431, and JP-A-H8-27284.

It is necessary that a blending amount of the polymerizable discotic compound is suitably adjusted in accordance with the compound, and the blending amount is preferably 0% to 10% by mass in the polymerizable liquid crystal composition.

As one example of General Formula of the polymerizable discotic compound, General Formulae (4-1) to (4-3) can be used, but there is no limitation to the general formulae.

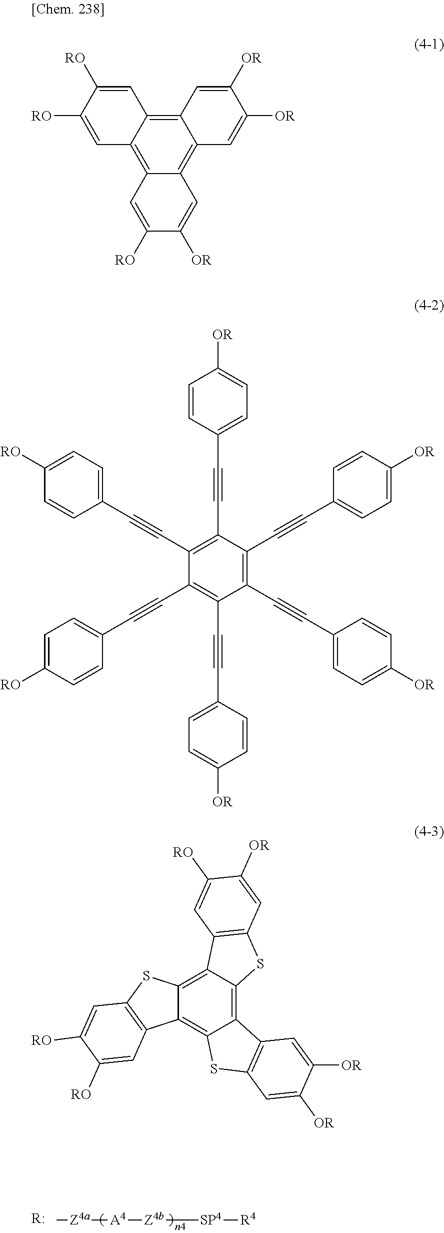

In the formulae, SP⁴ represents an alkylene group having 0 to 18 carbon atoms, the alkylene group may be substituted with one or more of halogen atoms, a CN group, or an alkyl group having 1 to 8 carbon atoms including a polymerizable functional group, and one CH₂ group or two or more of (—CH₂—)'s that are not adjacent to each other present in this group may be each mutually independently substituted with —O—, —S—, —NH—, —N(CH₃)—, —CO—, —COO—, —OCO—, —OCOO—, —SCO—, —COS—, or —C≡C—, in a state where oxygen atoms are not directly bonded to each other. A⁴ represents a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo (2,2,2) octylene group, a decahydronaphthalene-2,6-diyl group, a pyridine-2,5-diyl group, a pyrimidine-2,5-diyl group, a pyrazine-2,5-diyl group, a thiophene-2,5-diyl group, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group. n5 represents 0 or 1, Z⁴a represents —CO—, —CH₂CH₂—, —CH₂O—, —CH═CH—, —CH═CHCOO—, —CH₂CH₂COO—, —CH₂CH₂OCO—, —COCH₂CH₂—, an alkyl group having 2 to 10 carbon atoms which may include a halogen atom, or a single bond. Z^{4b} represents —COO—, —OCO—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, —OCOO—, an alkyl group having 2 to 10 carbon atoms which may include a halogen atom, or a single bond. R⁴ represents a hydrogen atom, a halogen atom, a cyano group, or an alkyl group having 1 to 18 carbon atoms, the alkyl group may be substituted with one or more of halogen atoms or CN, and one CH₂ group or two or more of (—CH₂—)'s that are not adjacent to each other present in this group may be each mutually independently substituted with —O—, —S—, —NH—, —N(CH₃)—, —CO—, —COO—, —OCO—, —OCOO—, —SCO—, —COS—, or —C≡C—, in a state where oxygen atoms are not directly bonded to each other. Alternatively, R⁴ preferably represents General Formula (4-a).

[Chem. 239]

—P^{4a} (4-a)

(In the formula, P^{4a} represents a polymerizable functional group and SP^{3a} represents the same meaning as Sp¹.)

P^{4a} preferably represents a substituent selected from a polymerizable group represented by Formula (P-1) to Formula (P-20).

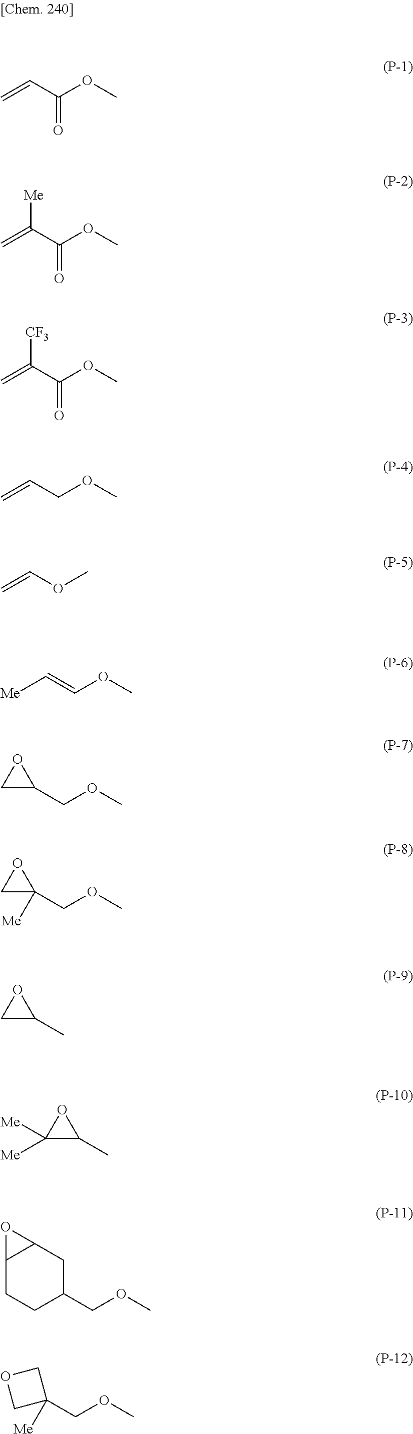

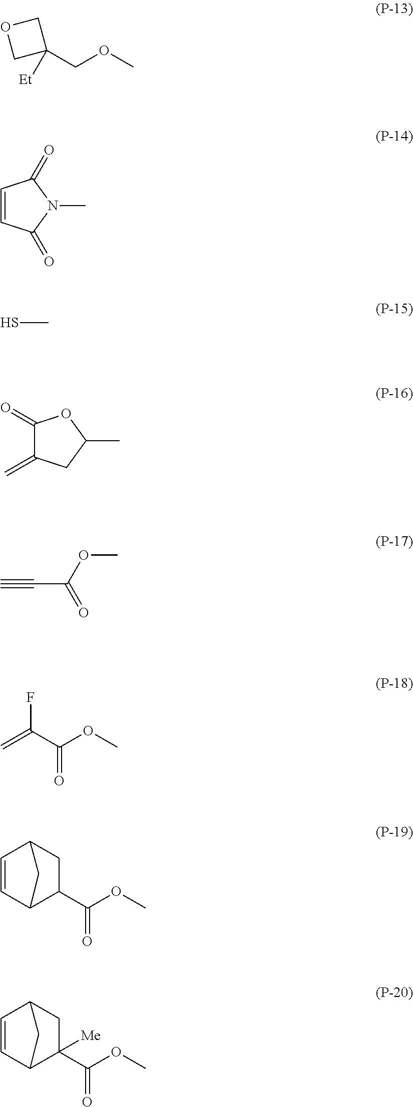

Among these polymerizable functional groups, from a viewpoint of increasing polymerizability and storage stability, Formula (P-1), (P-2), (P-7), (P-12), or (P-13) is preferable, and Formula (P-1), (P-7), or (P-12) is more preferable.

As specific examples of the polymerizable discotic compound, compounds of Compounds (4-4) to (4-8) can be used, but there is no limitation to the following compounds.

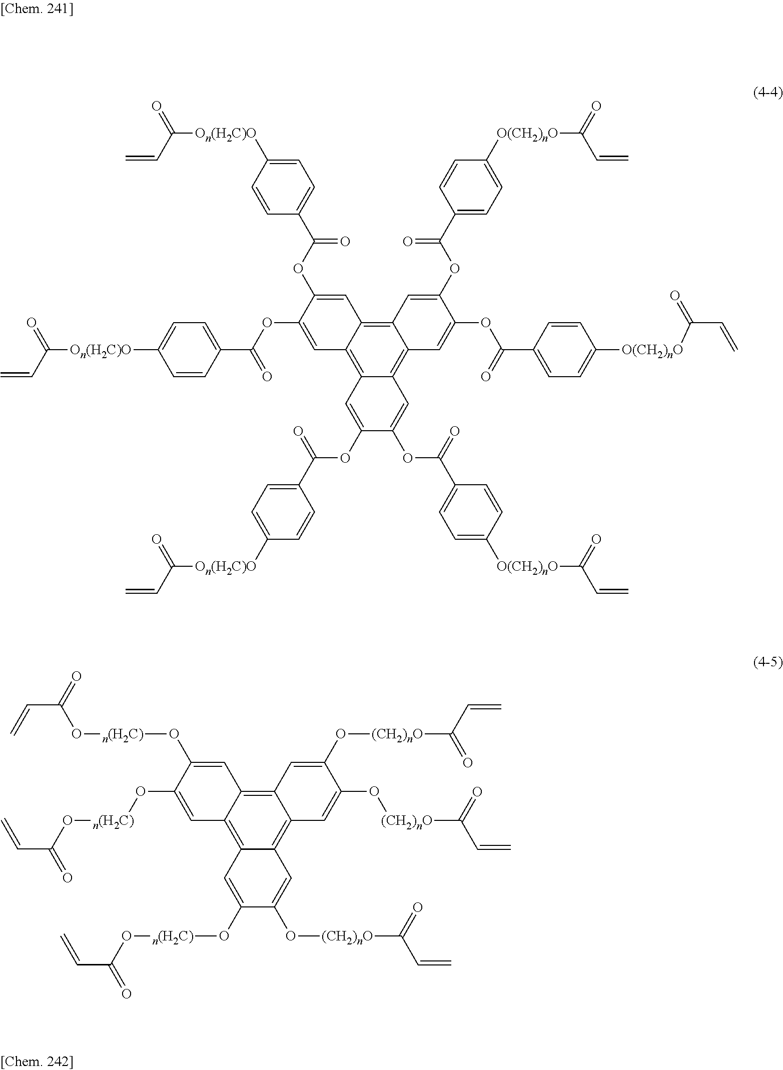

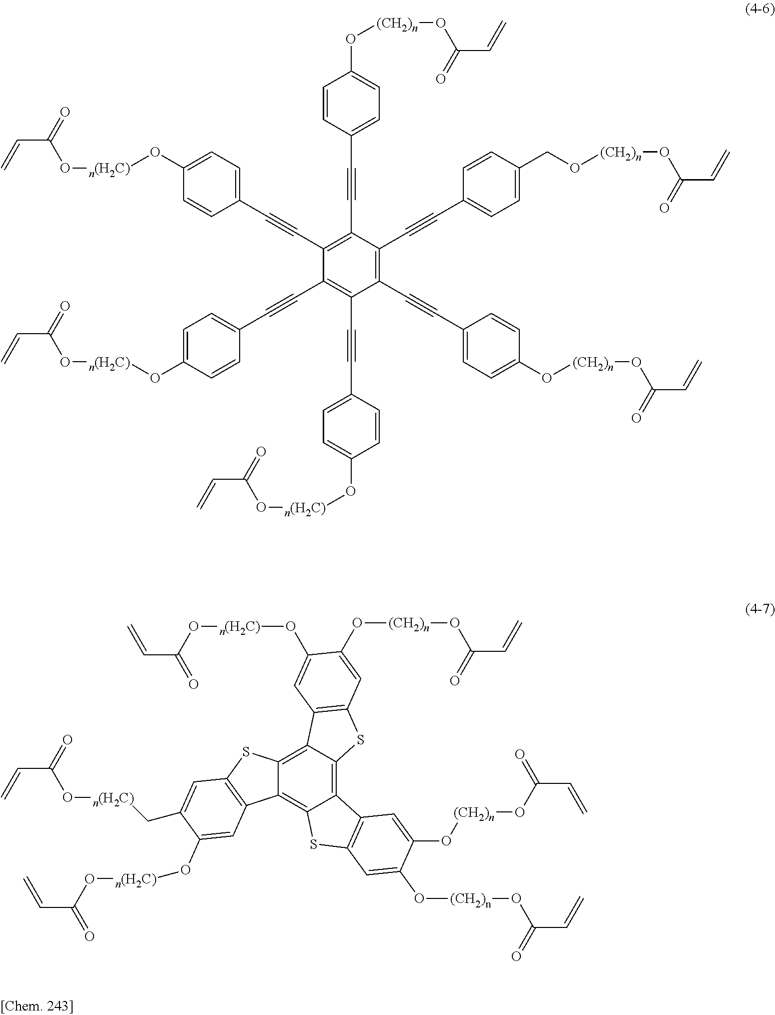

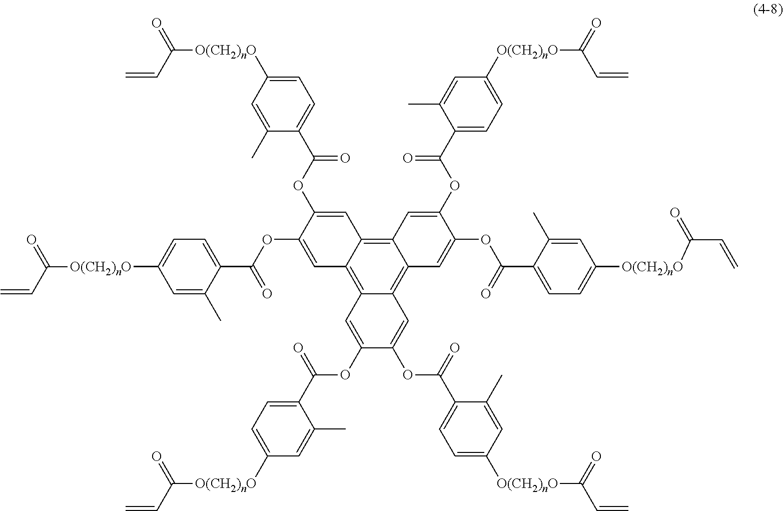

In the formulae, n represents an integer of 1 to 18.

(Organic Solvent)

An organic solvent may be added to the polymerizable liquid crystal composition of the present invention. The organic solvent used is not particularly limited, and is preferably an organic solvent in which the polymerizable liquid crystal compound exhibits excellent solubility, and preferably an organic solvent which can be dried at a temperature equal to or lower than 100° C. Examples of such a solvent include aromatic hydrocarbon such as toluene, xylene, cumene, or mesitylene, an ester-based solvent such as methyl acetate, ethyl acetate, propyl acetate, or butyl acetate, a ketone-based solvent such as methyl ethyl ketone, methyl isobutyl ketone, cyclohexanone, or cyclopentanone, an ether-based solvent such as tetrahydrofuran, 1,2-dimethoxy ethane, or anisole, an amide-based solvent such as N,N-dimethylformamide or N-methyl-2-pyrrolidone, propylene glycol monomethyl ether acetate, diethylene glycol monomethyl ether acetate, γ-butyrolactone, and chlorobenzene. These can be used alone or in combination of two or more kinds thereof, and it is preferable to use any one or more kinds from a ketone-based solvent, an ether-based solvent, an ester-based solvent, and an aromatic hydrocarbon-based solvent from a viewpoint of solution stability.

When the organic solvent is used as a solution, the composition used in the present invention can be applied to a substrate. A percentage of the organic solvent used in the polymerizable liquid crystal composition is not particularly limited, as long as it does not significantly damage the coated state, and the total amount of the organic solvent included in the polymerizable liquid crystal composition is preferably 10% to 95% by mass, more preferably 12% to 90% by mass, and particularly preferably 15% to 85% by mass.

When dissolving the polymerizable liquid crystal composition in the organic solvent, it is preferable to perform heating and stirring, in order to evenly dissolve the polymerizable liquid crystal composition. A heating temperature at the time of the heating and stirring may be suitably adjusted, by considering solubility of the composition used in the organic solvent, and is preferably 15° C. to 110C, more preferably 15° C. to 105° C., even more preferably 15° C. to 100° C., and particularly preferably 20° C. to 90° C., from a viewpoint of productivity.

In addition, when adding a solvent, it is preferable that stirring and mixing are performed by a dispersing stirrer. Specifically, as the dispersing stirrer, a disper, a propeller, a dispersing device including a stirring blade such as turbine blade, a paint shaker, a planetary stirring device, a shaker, or a rotary evaporator can be used. In addition, an ultrasonic irradiation device can be used.

A stirring rotation rate when adding a solvent is preferably suitably adjusted by a stirring device used, and the stirring rotation rate is preferably 10 rpm to 1,000 rpm, more preferably 50 rpm to 800 rpm, and particularly preferably 150 rpm to 600 rpm, in order to obtain an even polymerizable liquid crystal composition solvent.

(Polymerization Inhibitor)

A polymerization inhibitor is preferably added to the polymerizable liquid crystal composition of the present invention. Examples of the polymerization inhibitor include a phenol-based compound, a quinone-based compound, an amine-based compound, a thioether-based compound, and a nitroso compound.

Examples of the phenol-based compound include p-methoxyphenol, cresol, t-butylcatechol, 3.5-di-t-butyl-4-hydroxytoluene, 2.2′-methylene bis(4-methyl-6-t-butylphenol), 2.2′-methylene bis(4-ethyl-6-t-butylphenol), 4.4′-thio bis(3-methyl-6-t-butylphenol), 4-methoxy-1-naphthol, and 4,4′-dialkoxy-2,2′-bi-1-naphthol.

Examples of quinone-based compound include hydroquinone, methylhydroquinone, tert-butylhydroquinone, p-benzoquinone, methyl-p-benzoquinone, tert-butyl-p-benzoquinone, 2,5-diphenylbenzoquinone, 2-hydroxy-1,4-naphthoquinone, 1,4-naphthoquinone, 2,3-dichloro-1,4-naphthoquinone, anthraquinone, and diphenoquinone.

Examples of the amine-based compound include p-phenylenediamine, 4-aminodiphenylamine, N.N′-diphenyl-p-phenylenediamine, N-i-propyl-N′-phenyl-p-phenylenediamine, N-(1.3-dimethylbutyl)-N′-phenyl-p-phenylenediamine, N.N′-di-2-naphthyl-p-phenylenediamine, diphenylamine, N-phenyl-β-naphthylamine, 4.4′-dicumyl-diphenylamine, and 4.4′-dioctyl-diphenylamine.

Examples of the thioether-based compound include phenothiazine and distearyl thiodipropionate.

Examples of the nitroso compound include N-nitrosodiphenylamine, N-nitrosophenylnaphthylamine, N-nitrosodinaphthylamine, p-nitrosophenol, nitrosobenzene, p-nitrosodiphenylamine, α-nitroso-β-naphthols, N,N-dimethyl p-nitrosoaniline, p-nitrosodiphenylamine, p-nitrone dimethylamine, p-nitrone-N, N-diethylamine, N-nitrosoethanolamine, N-nitrosodi-n-butylamine, N-nitroso-N-n-butyl-4-butanolamine, N-nitroso-diisopropanolamine, N-nitroso-N-ethyl-4-butanolamine, 5-nitroso-8-hydroxyquinoline, N-nitrosomorpholine, N-nitroso N-phenylhydroxylamine ammonium salt, nitrosobenzene, 2,4,6-tri-tert-butylnitrone benzene, N-nitroso-N-methyl-p-toluenesulfonamide, N-nitroso-N-ethylurethane, N-nitroso-N-n-propylurethane, 1-nitroso-2-naphthol, 2-nitroso-l-naphthol, sodium 1-nitroso-2-naphthol-3,6-sulfonate, sodium 2-nitroso-l-naphthol-4-sulfonate, 2-nitroso-5-methylaminophenol hydrochloride, and 2-nitroso-5-methylaminophenol hydrochloride.

The amount of the polymerization inhibitor added is preferably 0.01% to 1.0% by mass and more preferably 0.05% to 0.5% by mass with respect to the polymerizable liquid crystal composition.

(Antioxidant)

In order to increase stability of the polymerizable liquid crystal composition of the present invention, it is preferable to add an antioxidant. Examples of such compounds include a hydroquinone derivative, a nitrosamine-based polymerization inhibitor, and a hindered phenol-based antioxidant, and more specific examples thereof include tert-butylhydroquinone, methylhydroquinone, “Q-1300” and “Q-1301” manufactured by Wako Pure Chemical Industries, Ltd., “IRGANOX1010”, “IRGANOX1035”, “IRGANOX1076”, “IRGANOX1098”, “IRGANOX1135”, “IRGANOX1330”, “IRGANOX1425”, “IRGANOX1520”, “IRGANOX1726”, “IRGANOX245”, “IRGANOX259”, “IRGANOX3114”, “IRGANOX3790”, “IRGANOX5057”, or “IRGANOX565” manufactured by BASF.

The amount of the antioxidant added is preferably 0.01% to 2.0% by mass and more preferably 0.05% to 1.0% by mass with respect to the polymerizable liquid crystal composition.

(Photopolymerization Initiator)

The polymerizable liquid crystal composition of the present invention preferably includes a photopolymerization initiator. It is preferable that at least one or more kinds of the photopolymerization initiator are included. Specific examples thereof include “Irgacure 651”, “Irgacure 184”, “Irgacure 907”, “Irgacure 127”, “Irgacure 369”, “Irgacure 379”, “Irgacure 819”, “Irgacure 2959”, “Irgacure 1800”, “Irgacure 250”, “Irgacure 754”, “Irgacure 784”, “Irgacure OXE01”, “Irgacure OXE02”, “Lucirin TPO”, “Darocur 1173”, “Darocur MBF” manufactured by BASF, “Esacure 1001M”, “Esacure KIP150”, “Speedcure BEM”, “Speedcure BMS”, “Speedcure MBP”, “Speedcure PBZ”, “Speedcure ITX”, “Speedcure DETX”, “Speedcure EBD”, “Speedcure MBB”, “Speedcure BP” manufactured by LAMBSON, “KAYACURE DMBI” by Nippon Kayaku Co., Ltd., “TAZ-A” manufactured by DKSH, “ADEKA OPTOMER SP-152”, “ADEKA OPTOMER SP-170”, “ADEKA OPTOMER N-1414”, “ADEKA OPTOMER N-1606”, “ADEKA OPTOMER N-1717”, and “ADEKA OPTOMER N-1919” manufactured by ADEKA Corporation.

The amount of the photopolymerization initiator used is preferably 0.1% to 10% by mass and particularly preferably 0.5% to 7% by mass with respect to the polymerizable liquid crystal composition. These can be used alone or in combination of two or more kinds thereof, and a sensitizer or the like may be added thereto.

(Thermal Polymerization Initiator)

In the polymerizable liquid crystal composition of the present invention, a thermal polymerization initiator may be used in combination with the photopolymerization initiator. Specific examples thereof include “V-40” and “VF-096” manufactured by Wako Pure Chemical Industries, Ltd., and “PERHEXYL D” and “PERHEXYL I” manufactured by NOF Corporation.

The amount of thermal polymerization initiator used is preferably 0.1% to 10% by mass and particularly preferably 0.5% to 5% by mass with respect to the polymerizable liquid crystal composition. These can be used alone or in combination of two or more kinds thereof.

(Surfactant)

The polymerizable liquid crystal composition of the present invention may include at least one or more kinds of surfactants, in order to decrease unevenness of film thickness, in a case where an optically anisotropic body is prepared. Examples of surfactant which can be included include alkyl carboxylate, alkyl phosphate, alkyl sulfonate, fluoroalkyl carboxylate, fluoroalkyl phosphate, fluoroalkyl sulfonate, a polyoxyethylene derivative, a fluoroalkyl ethylene oxide derivative, a polyethylene glycol derivative, an alkyl ammonium salt, and a fluoroalkyl ammonium salt, and a fluorosurfactant is particularly preferable.

Specific examples thereof include “MEGAFACE F-251”, MEGAFACE F-444”, “MEGAFACE F-477”, “MEGAFACE F-510”, “MEGAFACE F-552”, “MEGAFACE F-553”, “MEGAFACE F-554”, “MEGAFACE F-555”, “MEGAFACE F-556”, “MEGAFACE F-557” “MEGAFACE F-558”, “MEGAFACE F-559”, “MEGAFACE F-560”, “MEGAFACE F-561”, “MEGAFACE F-562”, “MEGAFACE F-563”, “MEGAFACE F-565”, “MEGAFACE F-567”, “MEGAFACE F-568”, “MEGAFACE F-569”, “MEGAFACE F-570”, “MEGAFACE F-571”, “MEGAFACE R-40”, “MEGAFACE R-41”, “MEGAFACE R43”, “MEGAFACE R94”, “MEGAFACE RS-72-K”, “MEGAFACE RS-75”, “MEGAFACE RS-76-E”, “MEGAFACE RS-90” (all manufactured by DIC Corporation), “FTERGENT 100”, “FTERGENT 100C”, “FTERGENT 110”, “FTERGENT 150”, “FTERGENT 150CH”, “FTERGENT A”, “FTERGENT 100A-K”, “FTERGENT 501”, “FTERGENT 300”, “FTERGENT 310”, “FTERGENT 320”, “FTERGENT 400SW”, “FTX-400P”, “FTERGENT 251”, “FTERGENT 215M”, “FTERGENT 212MH”, “FTERGENT 250”, “FTERGENT 222F”, “FTERGENT 212D”, “FTX-218”, “FTX-209F”, “FTX-213F”, “FTX-233F”, “FTERGENT 245F”, “FTX-208G”, “FTX-240G”, “FTX-206D”, “FTX-220D”, “FTX-230D”, “FTX-240D”, “FTX-207S”, “FTX-211S”, “FTX-220S”, “FTX-230S”, “FTX-750FM”, “FTX-730FM”, “FTX-730FL”, “FTX-710FS”, “FTX-710FM”, “FTX-710FL”, “FTX-750LL”, “FTX-730LS”, “FTX-730LM”, “FTX-730LL”, “FTX-710LL” (all manufactured by Neos Company Limited), “BYK-300”, “BYK-302”, “BYK-306”, “BYK-307”, “BYK-310”, “BYK-315”, “BYK-320”, “BYK-322”, “BYK-323”, “BYK-325”, “BYK-330”, “BYK-331”, “BYK-333”, “BYK-337”, “BYK-340”, “BYK-344”, “BYK-3440”, “BYK-370”, “BYK-375”, “BYK-377”, “BYK-350”, “BYK-352”, “BYK-354”, “BYK-355”, “BYK-356”, “BYK-358N”, “BYK-361N”, “BYK-357”, “BYK-390”, “BYK-392”, “BYK-UV3500”, “BYK-UV3510”, “BYK-UV3570”, “BYK-Silclean3700” (all manufactured by BYK), “TEGO Rad2100”, “TEGO Rad2200N”, “TEGO Rad2250”, “TEGO Rad2300”, “TEGO Rad2500”, “TEGO Rad2600”, “TEGO Rad2700” (all manufactured by TOMOE Engineering Co., Ltd.), “N215”, “N535”, “N605K”, and “N935” (all manufactured by Solvay).

The amount of surfactant used is preferably 0.01% to 2% by mass and particularly preferably 0.05% to 0.5% by mass with respect to the polymerizable liquid crystal composition.

In addition, by using the surfactant, in a case where an optically anisotropic body is obtained by using the polymerizable liquid crystal composition of the invention, it is possible to effectively decrease the tilt angle of the air interface and by suitably selecting the surfactant, it is also possible to control the tilt angle.

In the polymerizable liquid crystal composition of the present invention, a compound including a repeating unit represented by General Formula (7) and having a weight average molecular weight equal to or greater than 100 is used, as a compound other than the surfactant exhibiting an effect of effectively decreasing the tilt angle of the air interface, in a case where an optically anisotropic body is obtained.

[Chem. 244]

CR¹¹R¹²—CR¹³R¹⁴ (7)

In the formula, R¹¹, R¹², R¹³, and R¹⁴ each independently represent a hydrogen atom, a halogen atom, or a hydrocarbon group having 1 to 20 carbon atoms, and hydrogen atoms in the hydrocarbon group may be substituted with one or more of halogen atoms.

Examples of a suitable compound represented by General Formula (7) include polyethylene, polypropylene, polyisobutylene, paraffin, liquid paraffin, chlorinated polypropylene, chlorinated paraffin, and chlorinated liquid paraffin.

The amount of the compound represented by General Formula (7) added is preferably 0.01% to 1% by mass and more preferably 0.05% to 0.5% by mass with respect to the polymerizable liquid crystal composition.

(Curing Agent)

In the polymerizable liquid crystal composition of the present invention, a curing agent may be used. Specific examples thereof include aliphatic polyamine such as diethylenetriamine or triethylenetetramine, EH-235R-2 manufactured by ADEKA Corporation, and a ketimine compound such as jERCURE H3, H30 manufactured by Mitsubishi Chemical Corporation.

The amount of curing agent used is preferably 0.01% to 20% by mass, more preferably 0.05% to 15% by mass, and particularly preferably 0.1% to 10% by mass, with respect to the polymerizable liquid crystal composition. These can be used alone or in combination of two or more kinds thereof.

(Other Additives)

In addition, for adjusting physical properties, if necessary, additives such as amorphous polymerizable compound, a thixotropic agent, an ultraviolet absorber, an infrared absorber, an antioxidant, or a surface treatment agent can be added to some extent that alignment of liquid crystals is not significantly decreased.

(Manufacturing Method of Optically Anisotropic Body)

(Optically Anisotropic Body)

The optically anisotropic body of the present invention prepared by using the polymerizable liquid crystal composition of the present invention is a component obtained by laminating a base material, an alignment film, if necessary, and a polymer of the polymerizable liquid crystal composition, in this order.

(Base Material)

The base material used in the optically anisotropic body of the present invention is a base material which is generally used in a liquid crystal device, a display, an optical component, or an optical film, and is not particularly limited, as long as it is a material having heat resistance so as to withstand the heating at the time of drying after applying the polymerizable liquid crystal composition of the present invention. As the base material, an organic material such as a glass base material, a metal base material, a ceramic base material, or a plastic base material is used. Particularly, in a case where the base material is an organic material, examples thereof include a cellulose derivative, polyolefin, polyester, polycarbonate, polyacrylate (acrylic resin), polyarylate, polyether sulfone, polyimide, polyphenylene sulfide, polyphenylene ether, nylon, and polystyrene. Among these, a plastic base material such as polyester, polystyrene, polyacrylate, polyolefin, a cellulose derivative, polyarylate, or polycarbonate is preferable, and a base material such as polyacrylate, polyolefin, or a cellulose derivative is more preferable. It is particularly preferable that a cycloolefin polymer (COP) is used as polyolefin, triacetyl cellulose (TAC) is used as a cellulose derivative, and polymethyl methacrylate (PMMA) is used as polyacrylate. The shape of the base material may have a curved surface, in addition to a flat plate. These base materials may include an electrode layer and has an antireflection function or reflection function, if necessary.

The surface treatment of these base materials may be performed, in order to improve coating properties or adhesiveness of the polymerizable liquid crystal composition of the present invention. As the surface treatment, ozone treatment, plasma treatment, corona treatment, silane coupling treatment, and the like are used. In addition, in order to adjust transmittance or reflectance of light, an organic thin film, an inorganic oxide thin film, or a metal thin film may be provided on the surface of the base material by vapor deposition, or in order to provide an optically added value, the base material may be a pickup lens, a rod lens, an optical disk, a retardation film, a light diffusing film, or a color filter. Among these, a pickup lens, a retardation film, a light diffusing film, and a color filter are preferable so as to further increase the added value.

(Alignment Treatment)

The base material is generally subjected to alignment treatment or an aligned film may be provided thereon, in order to allow the polymerizable liquid crystal composition to be aligned when the polymerizable liquid crystal composition of the present invention is applied and dried. Examples of the alignment treatment include stretching treatment, rubbing treatment, polarized light ultraviolet-visible light irradiation treatment, and ion beam treatment. In a case of using an aligned film, a commonly used well-known aligned film is used. Examples of such an aligned film include compounds such as polyimide, polysiloxane, polyamide, polyvinyl alcohol, polycarbonate, polystyrene, polyphenylene ether, polyarylate, polyethylene terephthalate, polyether sulfone, an epoxy resin, an epoxyacrylate resin, an acrylic resin, a coumarin compound, a chalcone compound, a cinnamate compound, a fulgide compound, an anthraquinone compound, an azo compound, and an arylethene compound. As a compound to be subjected to the alignment treatment by rubbing, it is preferable to use a compound in which crystallization of the material is promoted by the alignment treatment or by adding a heating step after the alignment treatment. Among compounds to be subjected to the alignment treatment other than the rubbing, it is preferable to use a photo-alignment material.

(Coating)

Examples of the coating method for obtaining the optically anisotropic body of the present invention include well-known commonly used methods such as an applicator method, a bar coating method, a spin-coating method, a roll coating method, a direct gravure coating method, a reverse gravure coating method, a flexographic coating method, an ink jet method, a die coating method, a cap coating method, a dip coating method, and a slit coating method. The polymerizable liquid crystal composition is coated and then dried, if necessary.

(Polymerization Step)

The polymerization treatment of the polymerizable liquid crystal composition of the present invention, is generally performed by light irradiation such as ultraviolet light or heating in a state where the liquid crystal compounds in the polymerizable liquid crystal composition are subjected to horizontal alignment, vertical alignment, or hybrid alignment, or cholesteric alignment (plane alignment) with respect to the base material. In a case of performing the polymerization by light irradiation, specifically, it is preferable to emit ultraviolet light having a wavelength equal to or smaller than 390 nm and it is most preferable to emit light having a wavelength of 250 to 370 nm. However, in a case where the polymerizable liquid crystal composition causes decomposition or the like due to the ultraviolet light having a wavelength equal to or smaller than 390 nm, the polymerizable treatment may be preferably performed with ultraviolet light having a wavelength equal to or greater than 390 nm. This light is preferably diffuse light and unpolarized light.

(Polymerization Method)

A method of emitting active energy rays or a thermal polymerization method is used as a method of polymerizing the polymerizable liquid crystal composition of the present invention, but the method of emitting active energy rays is preferable, because the reaction proceeds at room temperature without the necessities of the heating, and among the methods, a method of emitting light such as ultraviolet rays is preferable, from a viewpoint of a simple operation.

It is preferable that a temperature at the time of emission is set as a temperature at which the polymerizable liquid crystal composition of the present invention can maintain the liquid crystal phase and is equal to or lower than 30° C. as possible, in order to avoid evocation of the thermal polymerization of the polymerizable liquid crystal composition. The liquid crystal composition generally shows liquid crystal phases at a C(solid phase)-N(nematic) transition temperature (hereinafter, abbreviated as a C—N transition temperature) to the N—I transition temperature in the heating process. Meanwhile, in the cooling process, the liquid crystal state may be maintained even at a temperature equal to or lower than the C—N transition temperature, without performing solidification, in order to acquire a thermodynamically nonequilibrium state. This state is called a supercooled state. In the present invention, the liquid crystal composition in the supercooled state is also included as the liquid crystal composition maintaining the liquid crystal phase. Specifically, it is preferable to emit ultraviolet light having a wavelength equal to or smaller than 390 nm and it is most preferable to emit light having a wavelength of 250 to 370 nm. However, in a case where the polymerizable composition causes decomposition or the like due to the ultraviolet light having a wavelength equal to or smaller than 390 nm, the polymerizable treatment may be preferably performed with ultraviolet light having a wavelength equal to or greater than 390 nm. This light is preferably diffuse light and unpolarized light. Ultraviolet light irradiation intensity is preferably 0.05 kW/m² to 10 kW/m². The ultraviolet light irradiation intensity is particularly preferably 0.2 kW/m² to 2 kW/m². When the ultraviolet light intensity is less than 0.05 kW/m², a considerable time is taken for completing the polymerization. Meanwhile, in a case of the intensity exceeding 2 kW/m², photolysis of the liquid crystal molecules in the polymerizable liquid crystal composition tends to occur, or the temperature during the polymerization may be increased due to generation of a considerable amount of heat of polymerization, an order parameter of the polymerizable liquid crystals may change, and the disorder may occur in the retardation of the polymerized film.

When a specific portion is only polymerized by the ultraviolet light irradiation using a mask, then, the alignment state of the unpolymerized portion is changed by applying an electric filed, a magnetic field, or a temperature, and then, the unpolymerized portion is polymerized, it is possible to obtain an optically anisotropic body having a plurality of regions having different alignment directions.

In addition, it is also possible to obtain an optically anisotropic body having a plurality of regions having different alignment directions, by regulating the alignment by applying an electric filed, a magnetic field, or a temperature to the polymerizable liquid crystal composition in the unpolymerized state in advance, when polymerizing only the specific portion by the ultraviolet light irradiation using a mask, and then, performing the polymerization by emitting light to the mask while maintaining the state described above.

The optically anisotropic body obtained by polymerizing the polymerizable liquid crystal composition of the present invention can be used as a single body of the optically anisotropic body by being separated from the substrate or can be used as the optically anisotropic body as it is without being peeled from the substrate. Particularly, it is useful to use the optically anisotropic body as a laminated substrate or use the optically anisotropic body by bonding the optically anisotropic body to another substrate, because the optically anisotropic body hardly contaminates other members.

(Retardation Film)

The retardation film of the present invention is manufactured in the same manner as in a case of the optically anisotropic body of the present invention. In a case where the polymerizable compound represented by General Formula (1) in the polymerizable composition is polymerized in a planar aligned state, a retardation film having birefringence in the plane with respect to the base material is obtained. The retardation film can be used as a homogeneous liquid crystal film. In a case where the polymerizable compound represented by General Formula (1) in the polymerizable composition and the polymerizable chiral compound are polymerized in a planar aligned state, a retardation film having birefringence to the outside of the plane with respect to the base material is obtained. In a case where the polymerizable compound represented by General Formula (1) in the polymerizable composition including the polymerizable discotic compound is polymerized in a planar aligned state, a retardation film having birefringence in the plane and to the outside of the plane with respect to the base material is obtained.

In addition, in a case where the base material includes the retardation film, a retardation film having birefringence obtained by adding the birefringence of the base material and the birefringence of the retardation of the film of the present invention is obtained. In the retardation film, the birefringence of the base material and the birefringence of the retardation of the film may be in the same direction or different directions in the plane of the base material. This is applied in a suitable state for the usage, in accordance with the usage of a liquid crystal device, a display, an optical element, an optical part, a colorant, a security marking, a member for laser emission, an optical film, and a compensation film.

(Phase Difference Patterning Film)

A phase difference patterning film of the present invention is a component obtained by laminating a base material, an alignment film, and a polymer of the polymerizable composition solution, in this order, in the same manner as in a case of the optically anisotropic body of the present invention. In the polymerization step, patterning is performed so as to have partially different phase difference. The patterning may be applied in different directions by linear patterning, lattice patterning, circular patterning, or polygonal patterning. This is applied, in accordance with the usage of a liquid crystal device, a display, an optical element, an optical part, a colorant, a security marking, a member for laser emission, an optical film, and a compensation film.

In a method of obtaining partially different phase difference, an alignment film is provided on a base material, and the alignment treatment is performed so that the polymerizable composition is subjected to patterning alignment, when the polymerizable composition solution of the present invention is applied and dried. As such alignment treatment, fine rubbing treatment, polarized ultraviolet visible light irradiation treatment through a photomask, or fine shape machining treatment is used. As the alignment film, a commonly used well-known oriented film is used. Examples of such an oriented film include compounds such as polyimide, polysiloxane, polyamide, polyvinyl alcohol, polycarbonate, polystyrene, polyphenylene ether, polyarylate, polyethylene terephthalate, polyether sulfone, an epoxy resin, an epoxyacrylate resin, an acrylic resin, a coumarin compound, a chalcone compound, a cinnamate compound, a fulgide compound, an anthraquinone compound, an azo compound, and an arylethene compound. As a compound to be subjected to the alignment treatment by fine rubbing, it is preferable to use a compound in which crystallization of the material is promoted by the alignment treatment or by adding a heating step after the alignment treatment. Among compounds to be subjected to the alignment treatment other than the rubbing, it is preferable to use a photo-alignment material.

### EXAMPLES

Hereinafter, the present invention will be described with reference to synthesis examples, examples, and comparative example, but the present invention is not limited thereto. Unless otherwise noted, “part” and “%” are based on mass.

(Preparation of Polymerizable Composition and Manufacturing of Film)

The compound represented by General Formula (I), the compound represented by General Formula (II), Irgacure 907 (manufactured by BASF) as the photopolymerization initiator, methylhydroquinone (MEHQ) as the polymerization inhibitor, liquid paraffin (manufactured by Kanto Kagaku), or R-08 (manufactured by DIC Corporation) as the surfactant, and cyclopentanone (manufactured by Zeon Corporation) or toluene (manufactured by Kanto Kagaku) as the solvent, shown in Tables 1 to 4, were mixed at a ratio shown in the tables, and heated to 80° C. and stirred, and accordingly, uniform polymerizable compositions (coating solutions) used in Example 1 to Example 94 and Comparative Example 1 to Comparative Example 4 were obtained. The coating solution was applied onto a polyimide-attached glass substrate subjected to the rubbing treatment, so that a phase difference at 550 nm becomes 138±5 nm by using a spin coater or an applicator, and dried at 80° C. to 120° C. for 5 minutes. Then, ultraviolet light was irradiated in a nitrogen atmosphere or in the air so that UVA is 600 mJ/cm², and a λ/4 retardation plate having reverse dispersibility was obtained (Example 1 to Example 94). The λ/4 retardation plate and a polarizing plate were bonded to each other so that an angle formed by a slow axis of the retardation plate and an absorption axis of the polarizing plate is 45 degrees, and a wide-band circularly polarizing plate was obtained (Example 1 to Example 94 and Comparative Example 1 to Comparative Example 4).

In addition, in the examples and the comparative examples, compounds used as the compound represented by General Formula (I) and the compound represented by General Formula (II) are the following compounds.

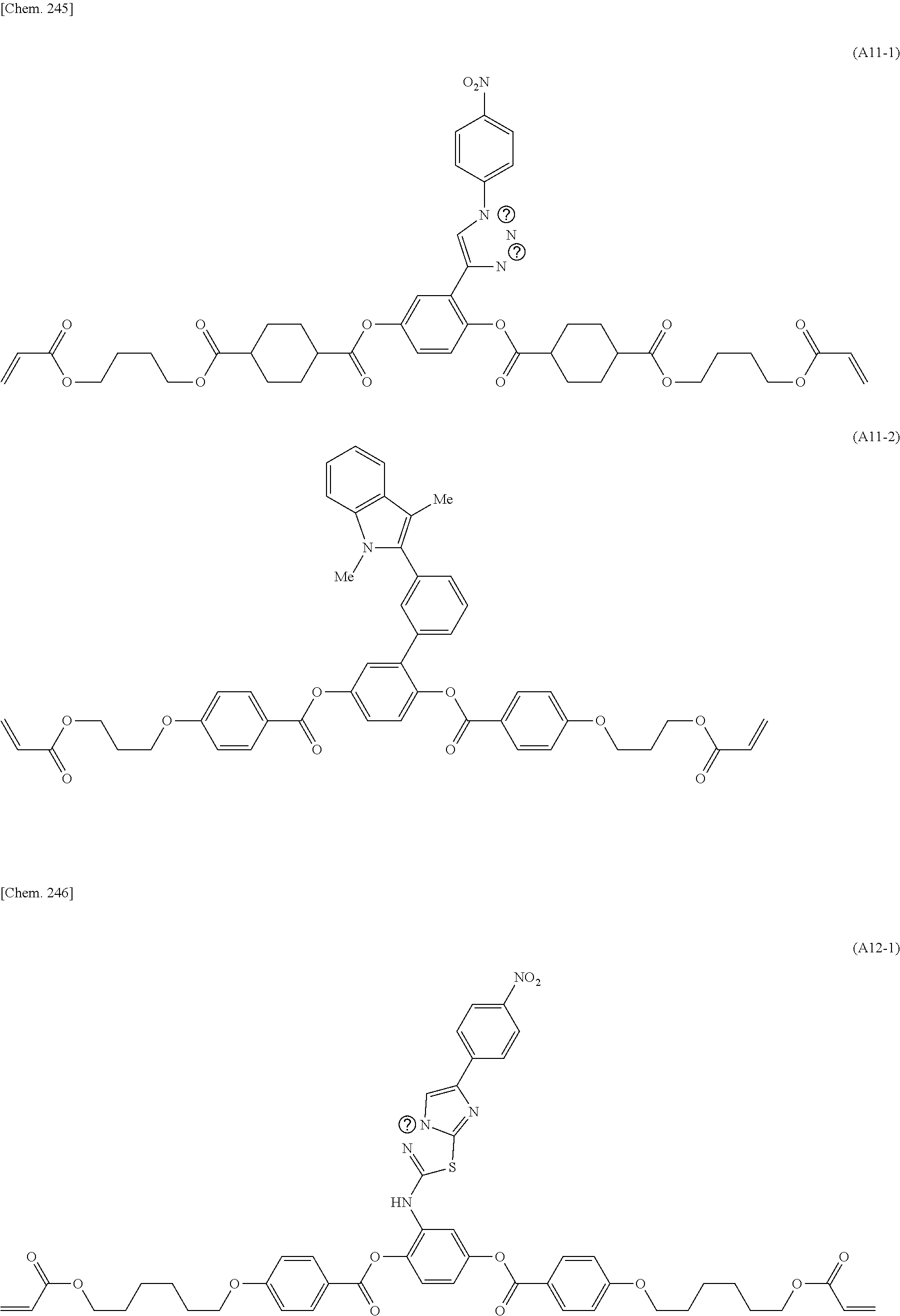

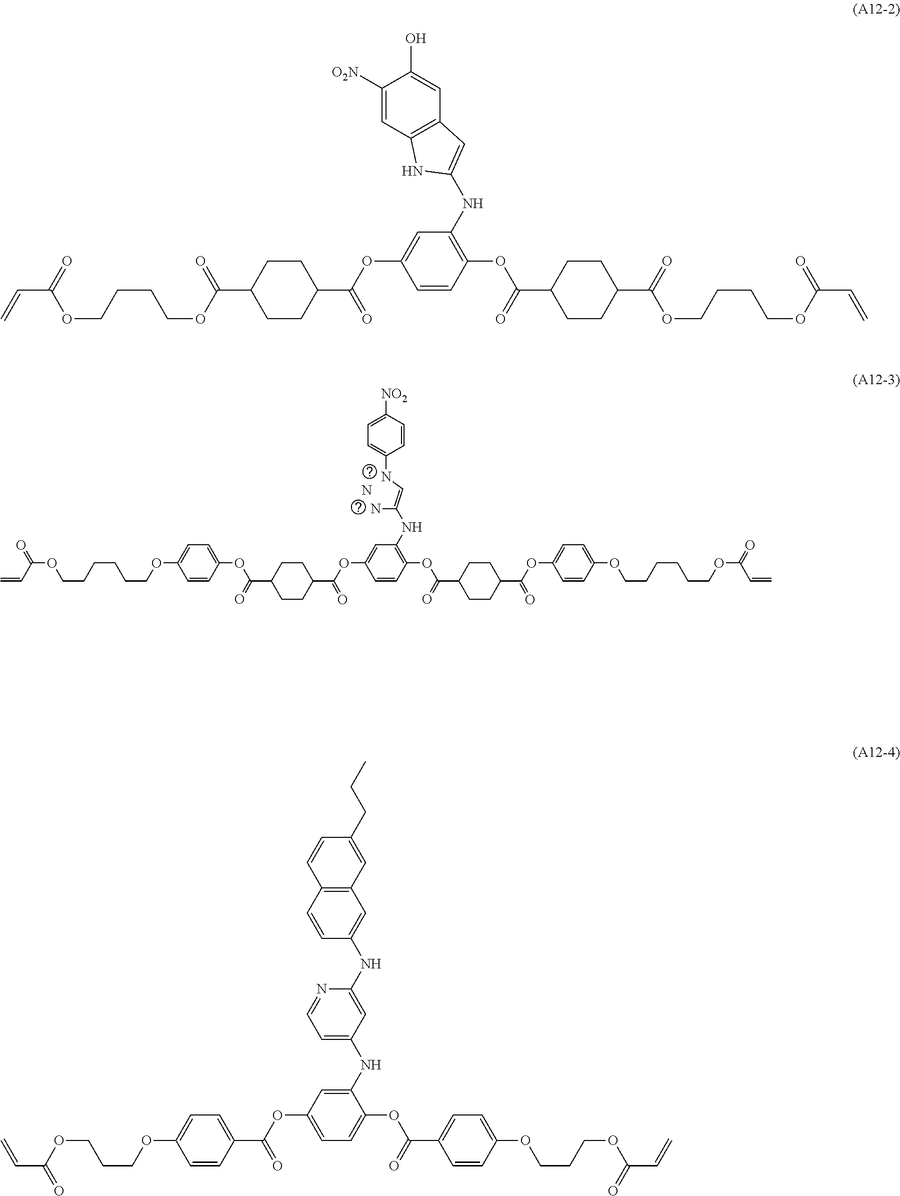

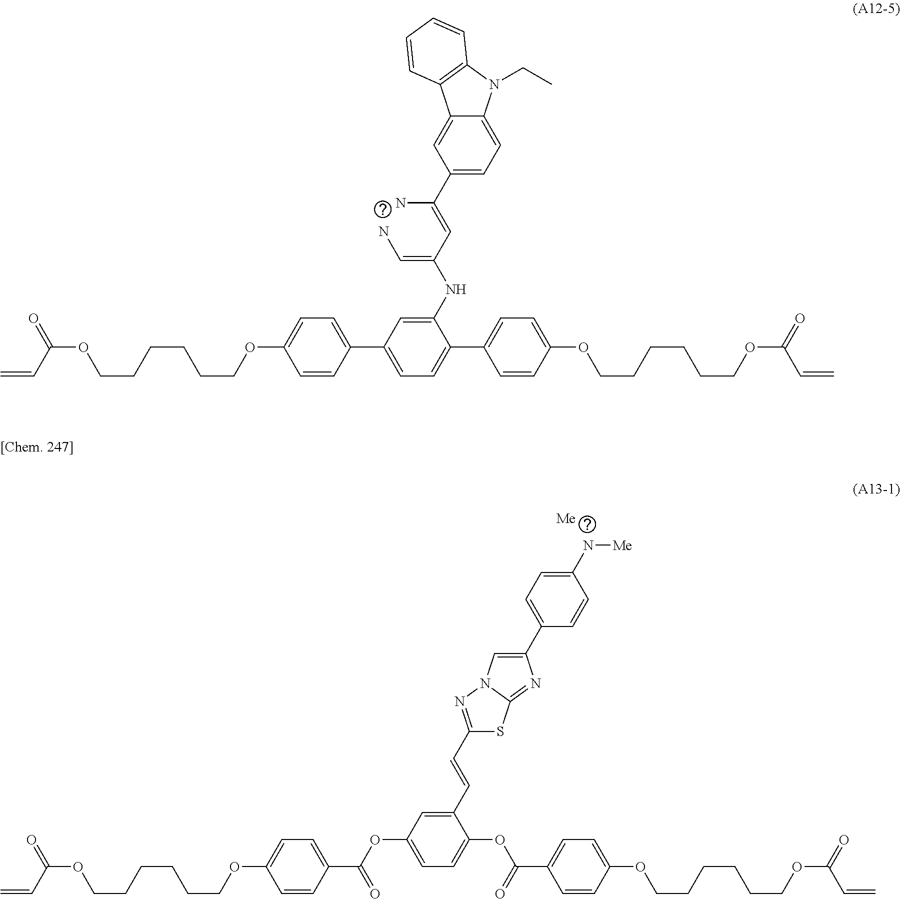

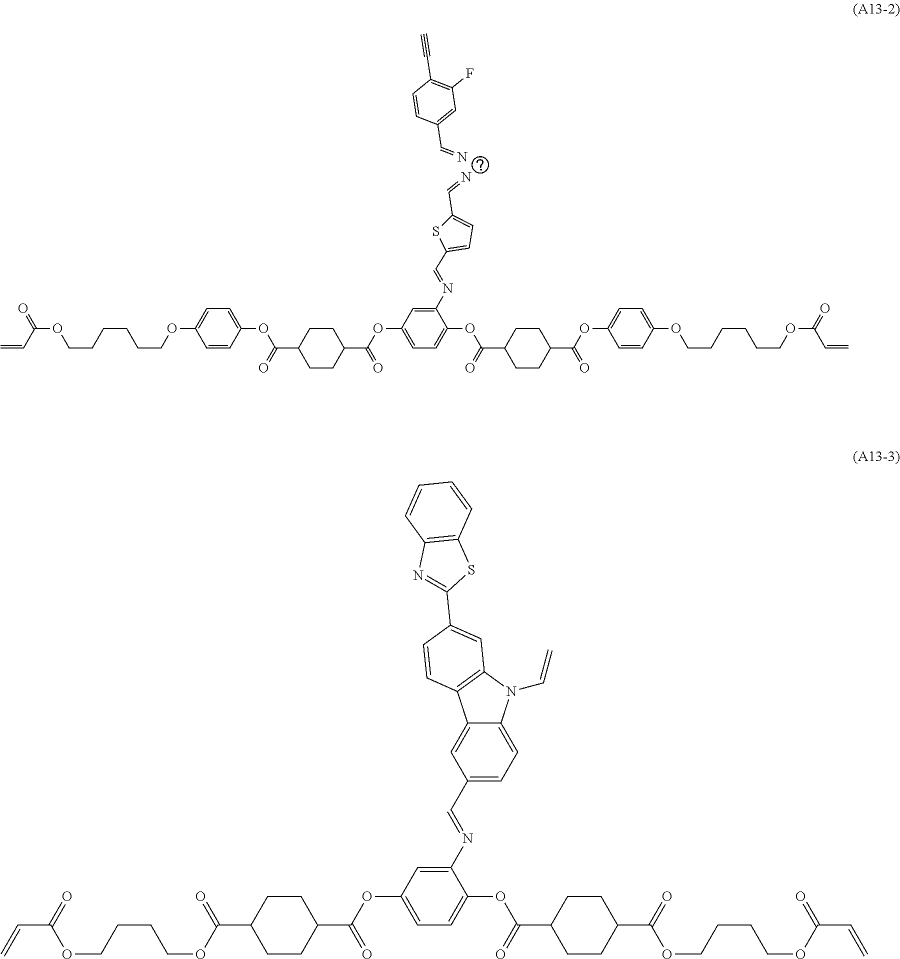

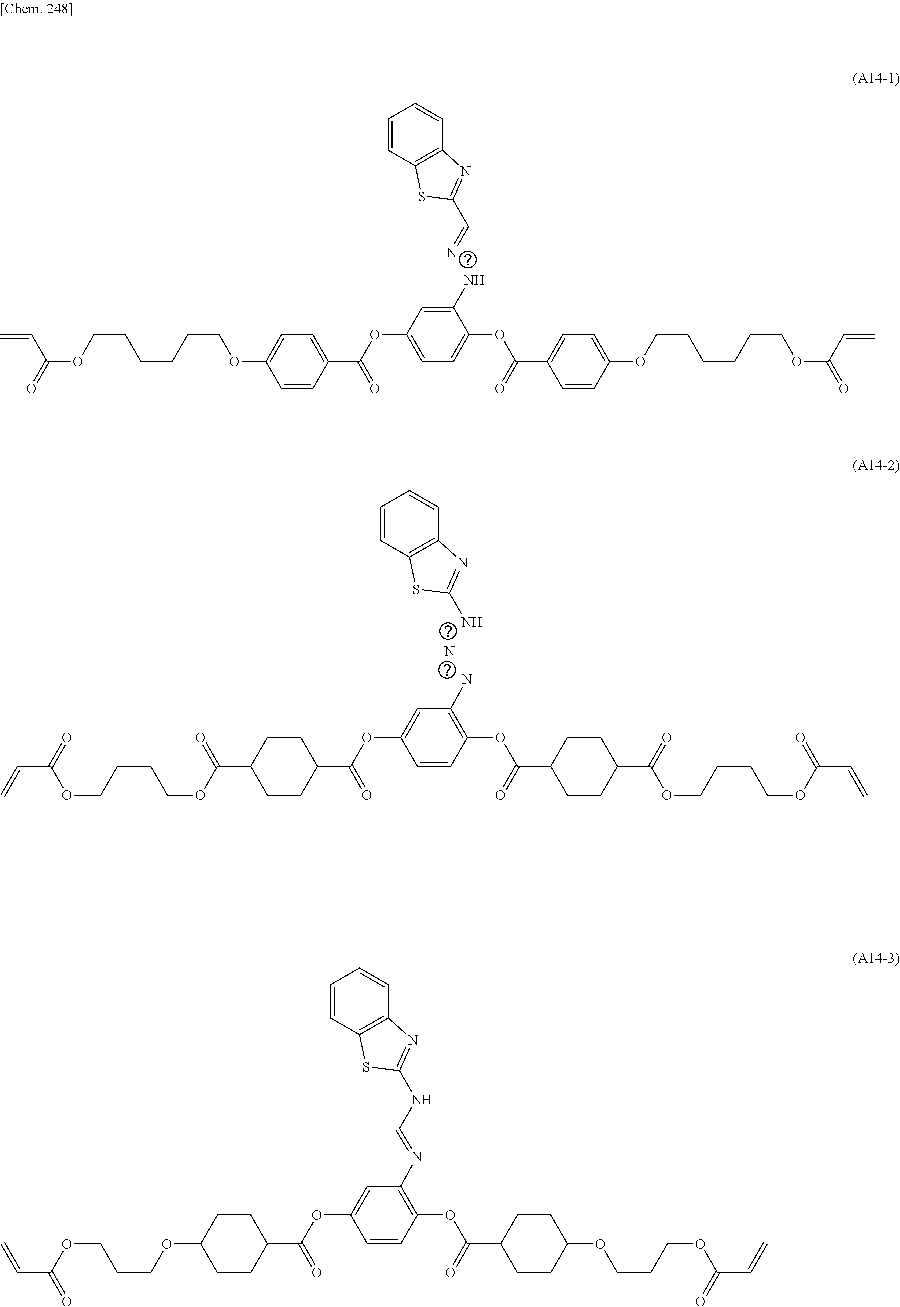

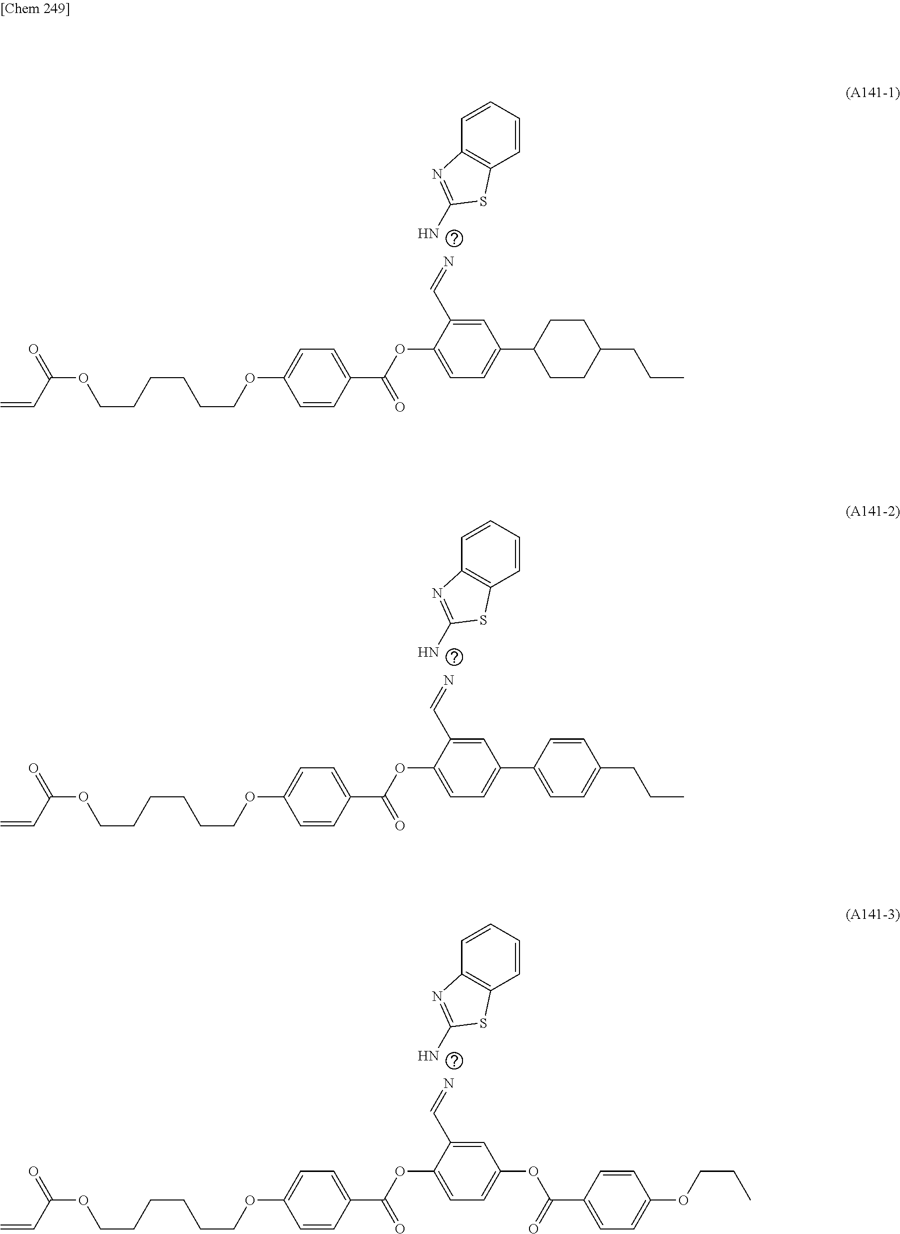

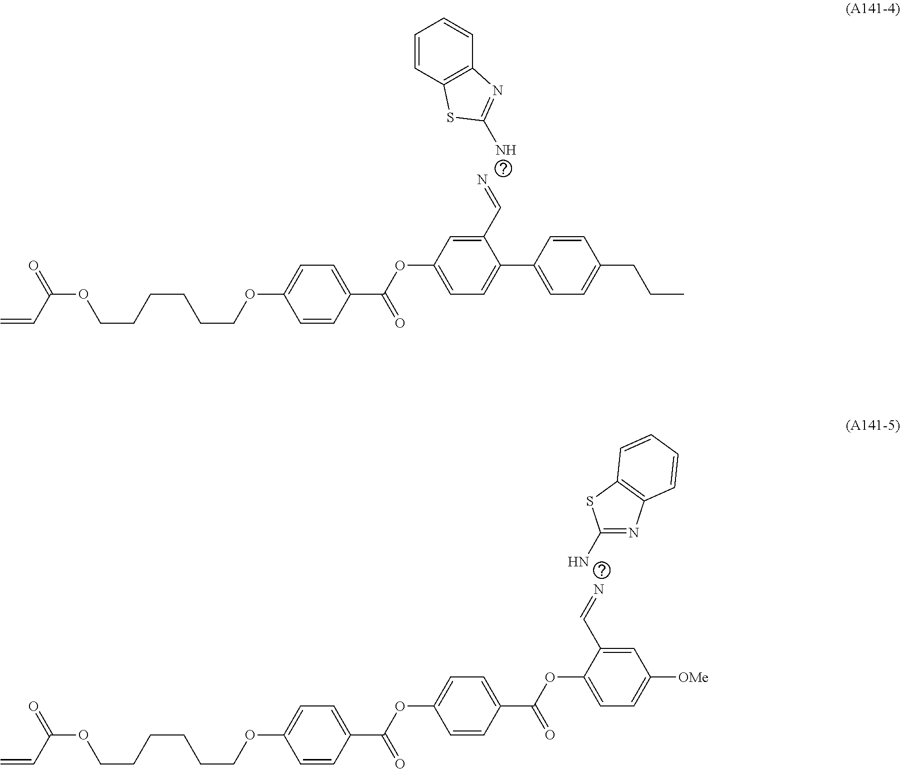

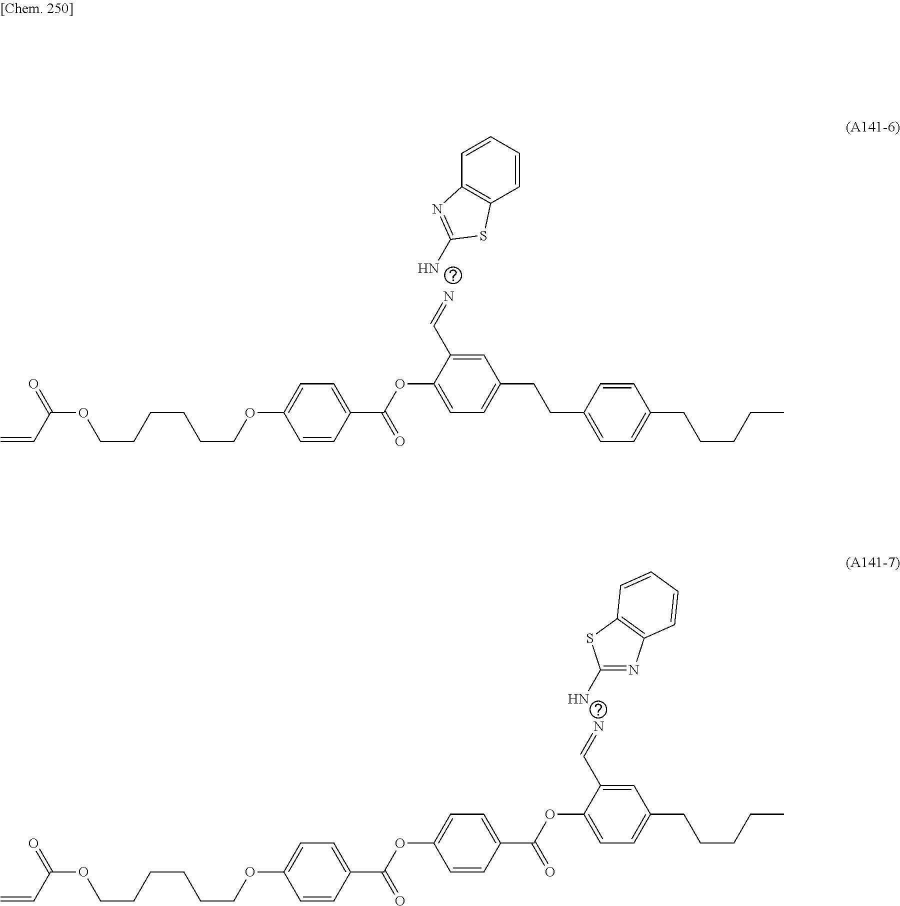

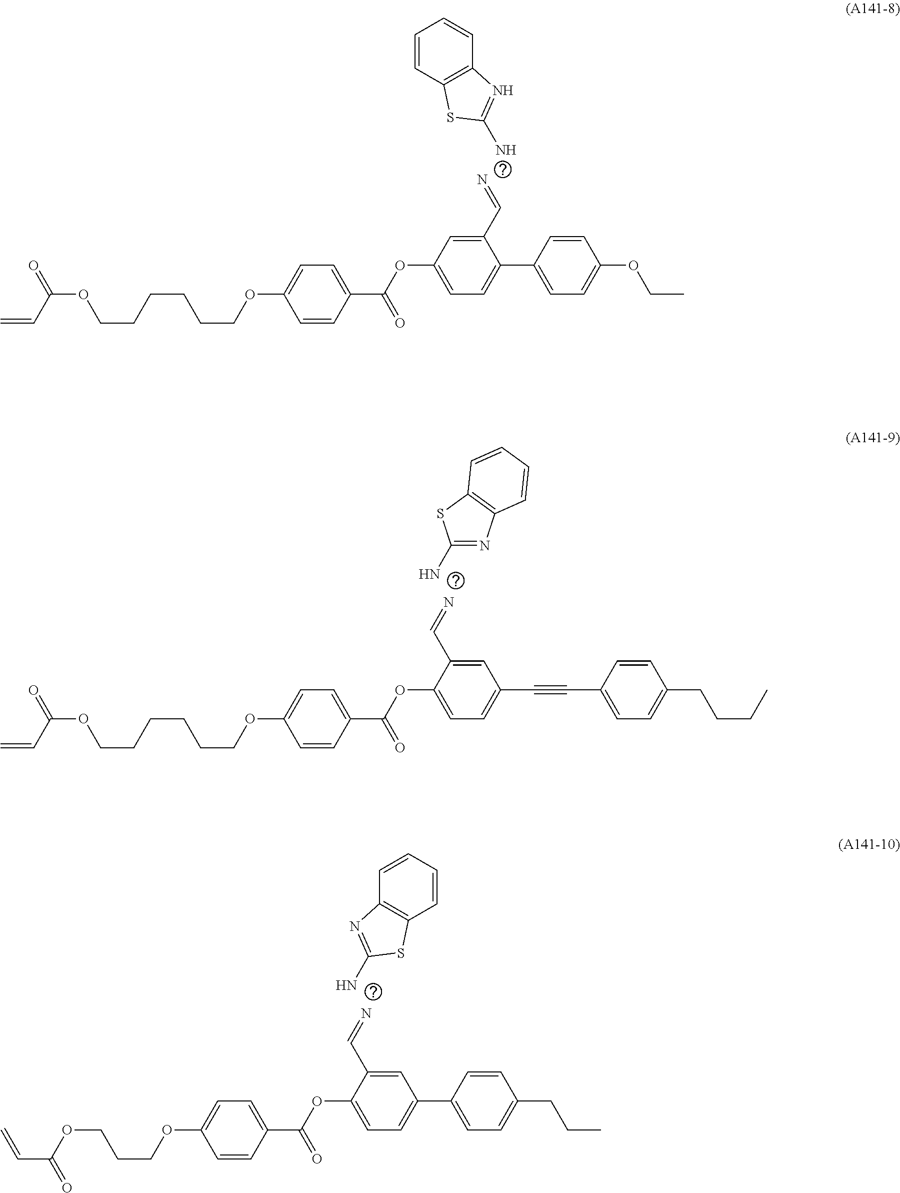

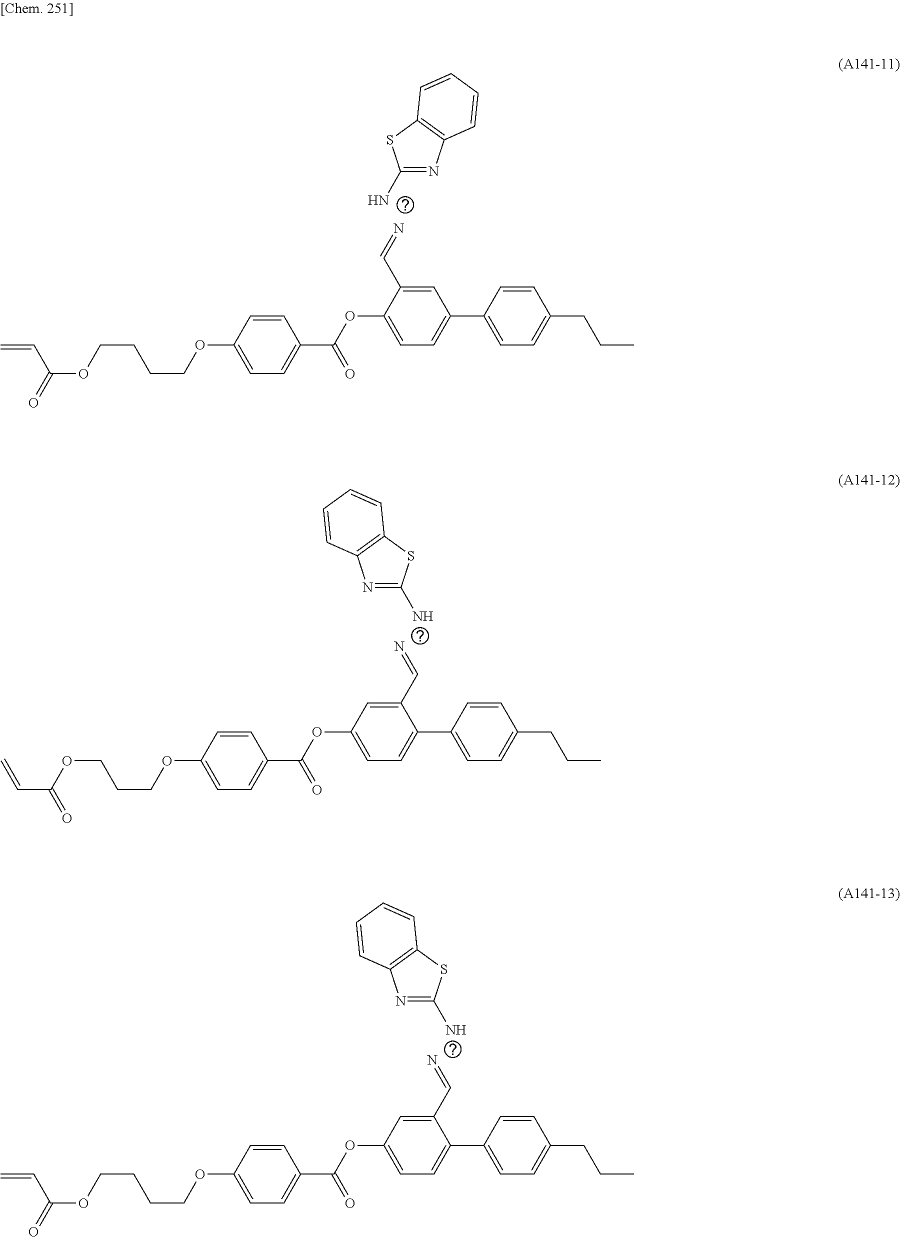

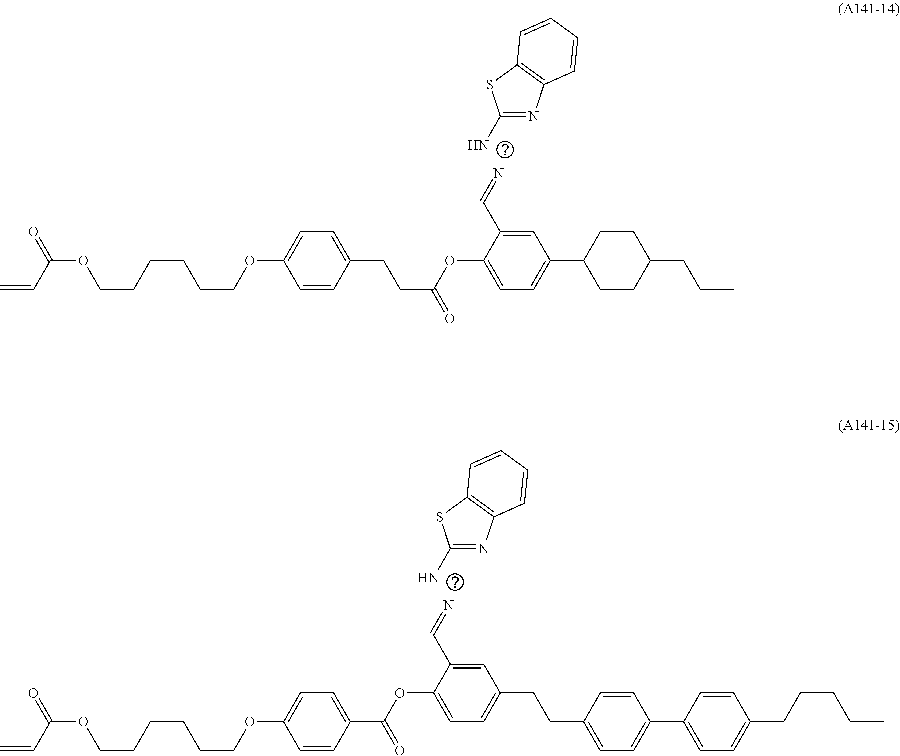

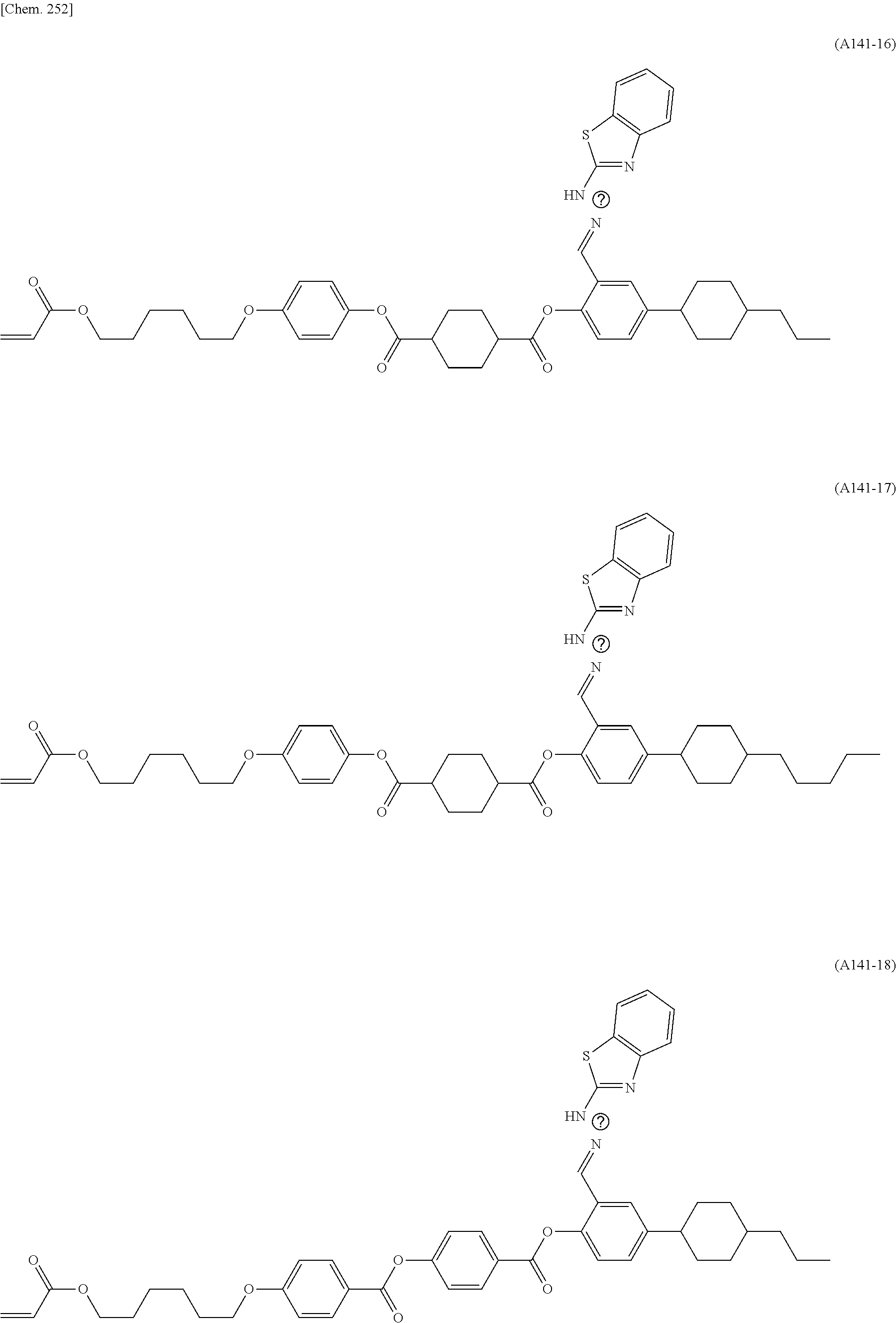

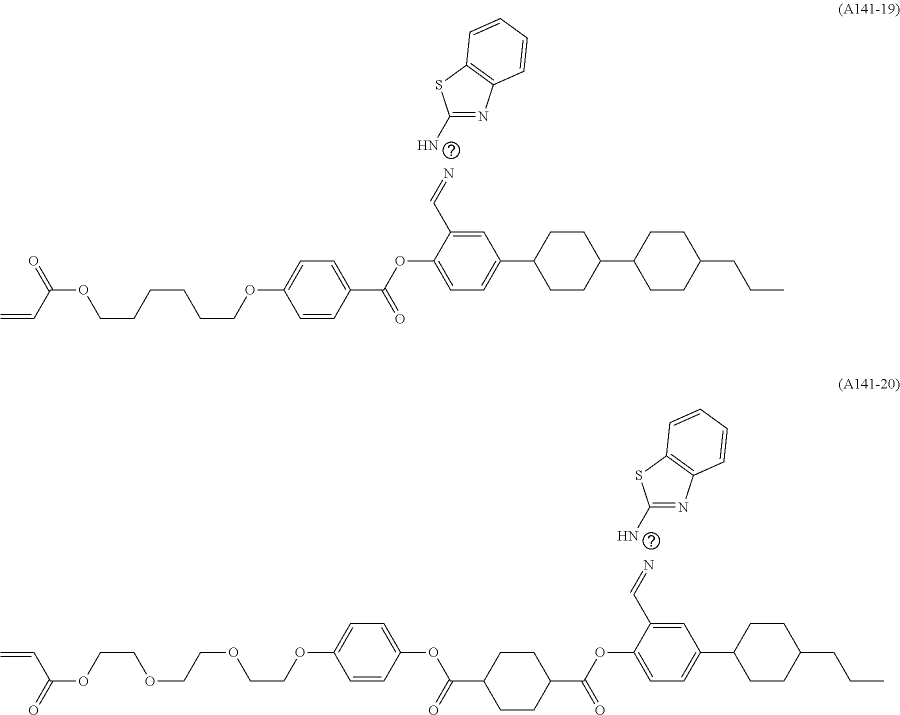

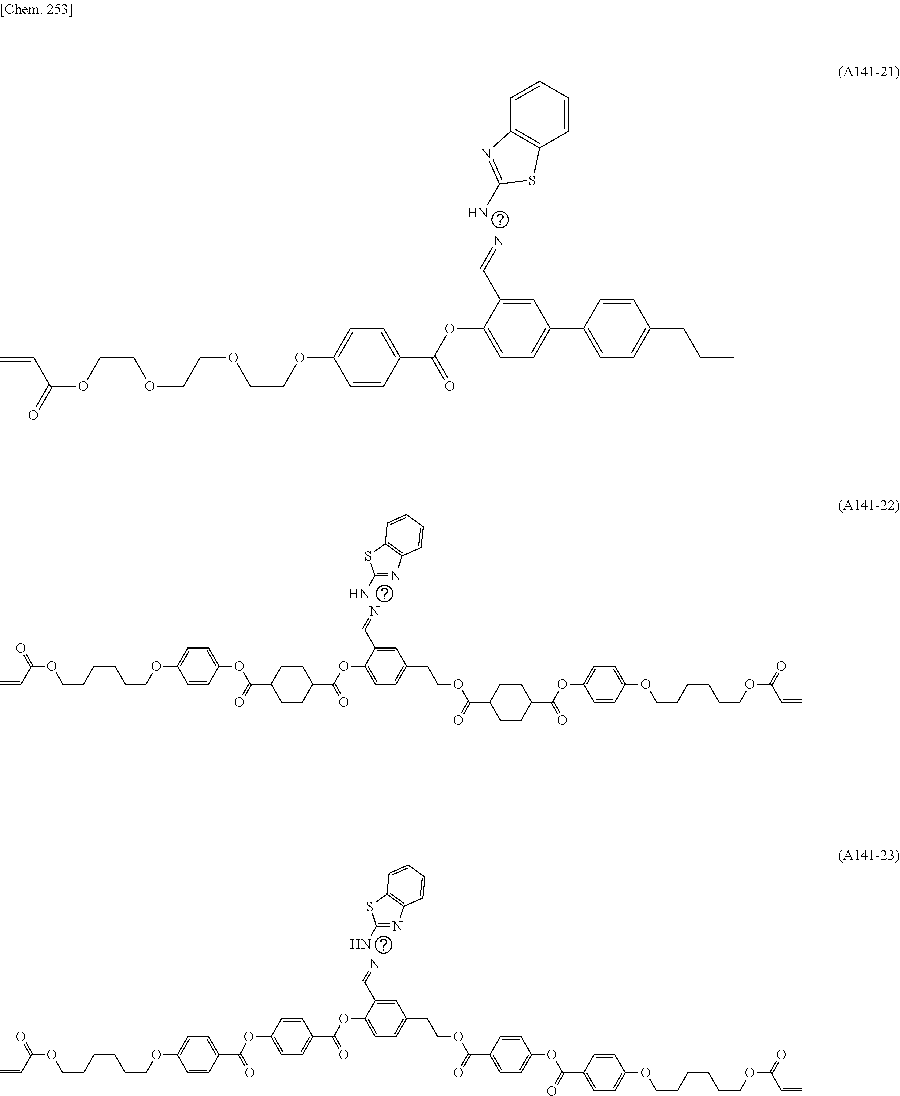

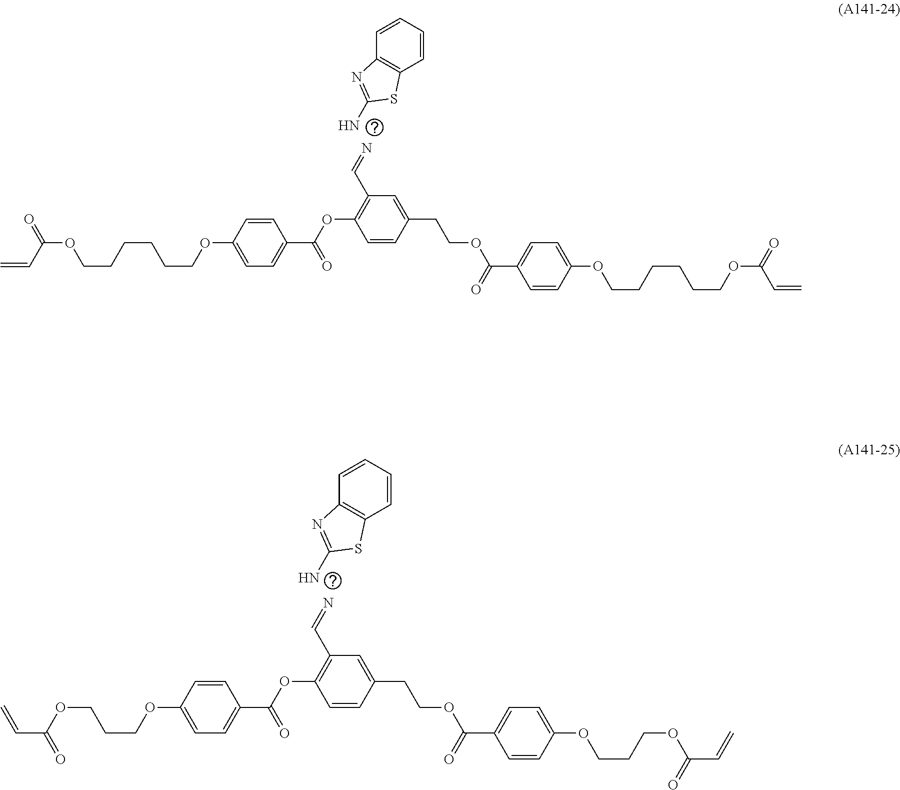

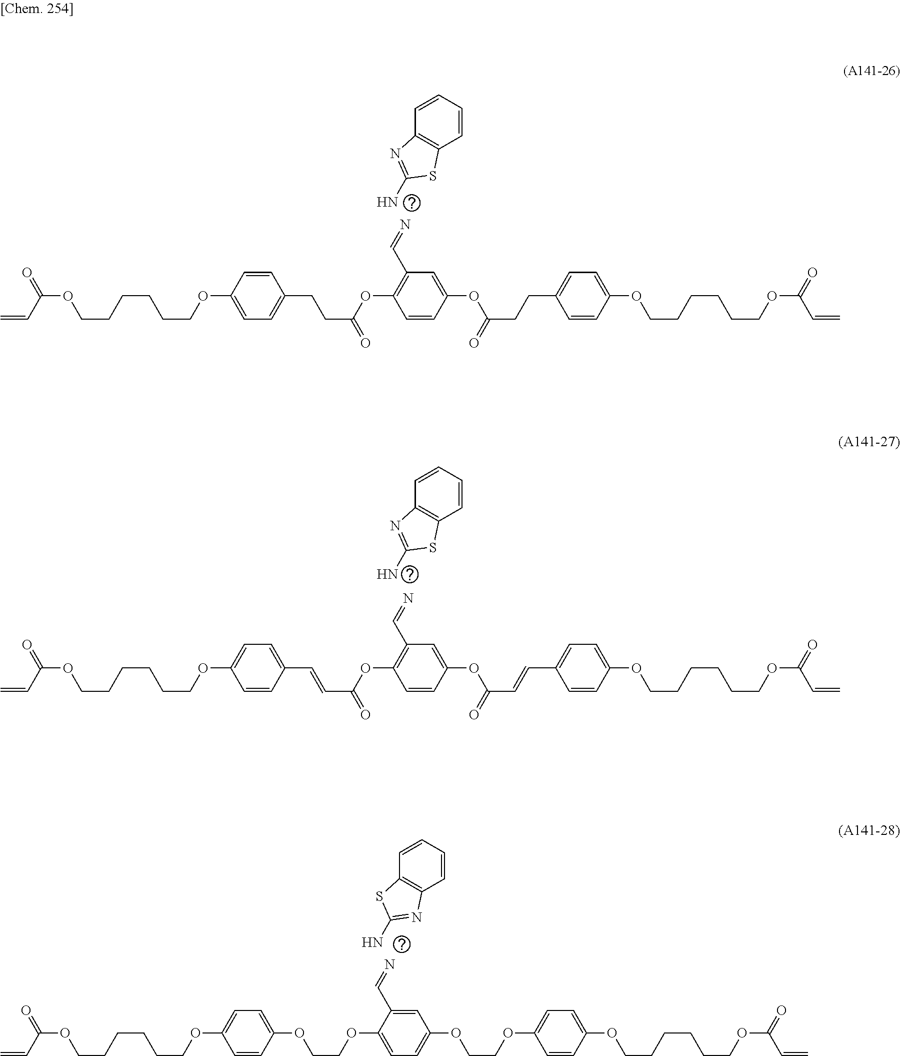

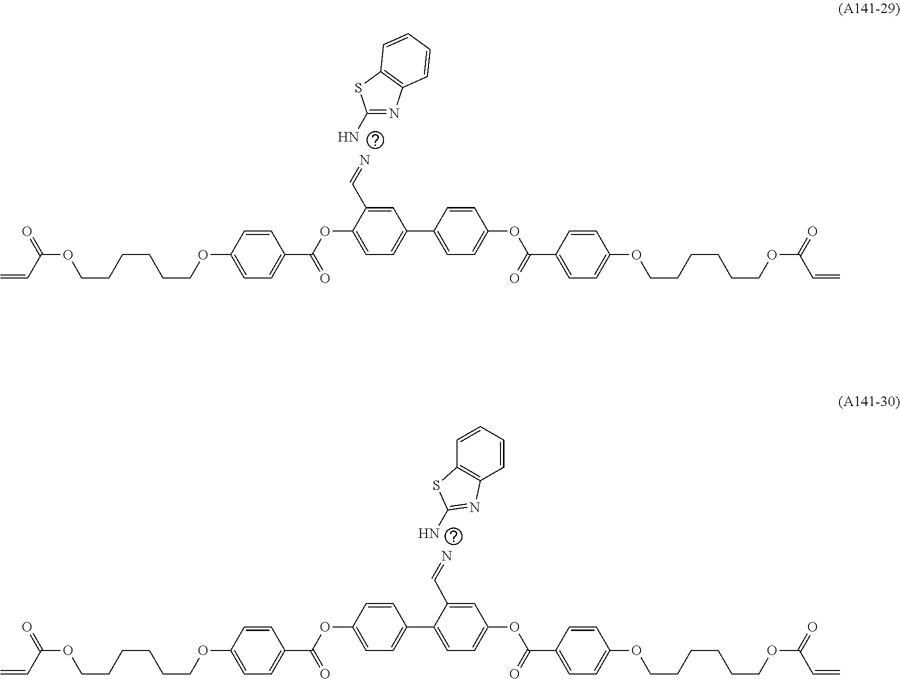

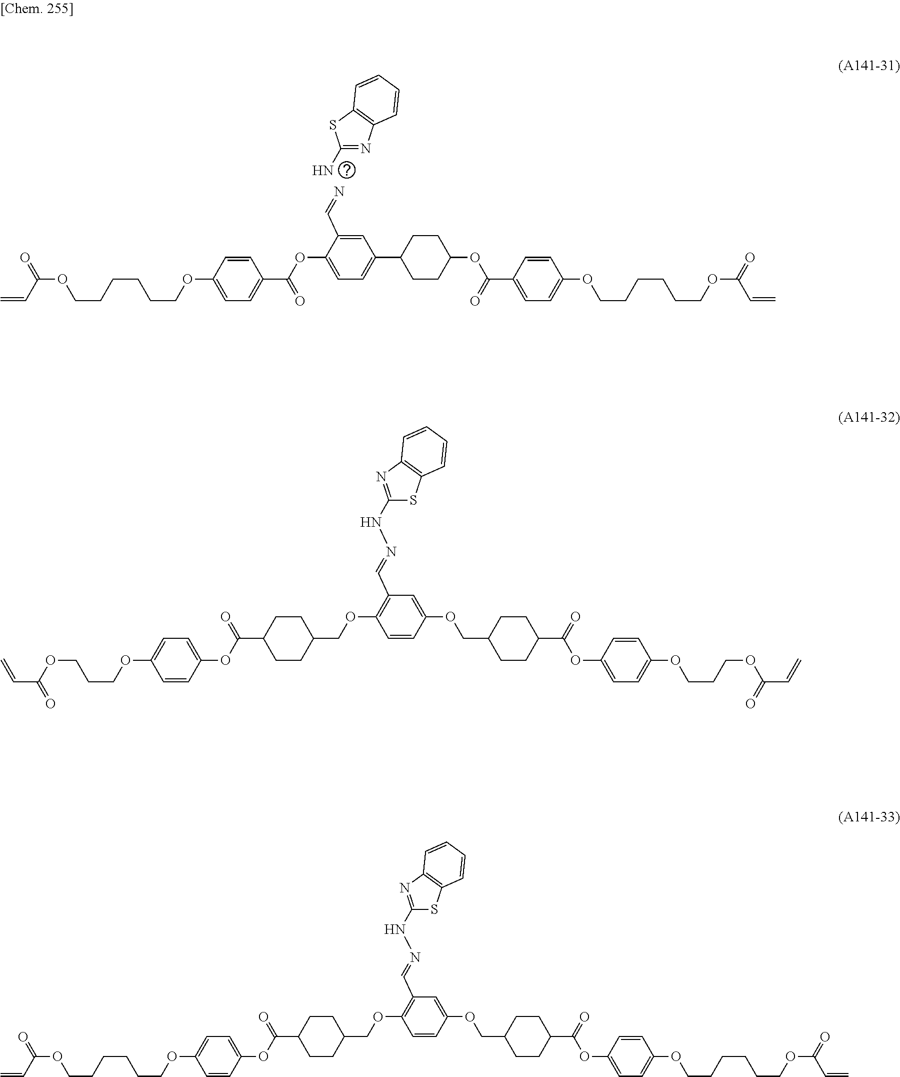

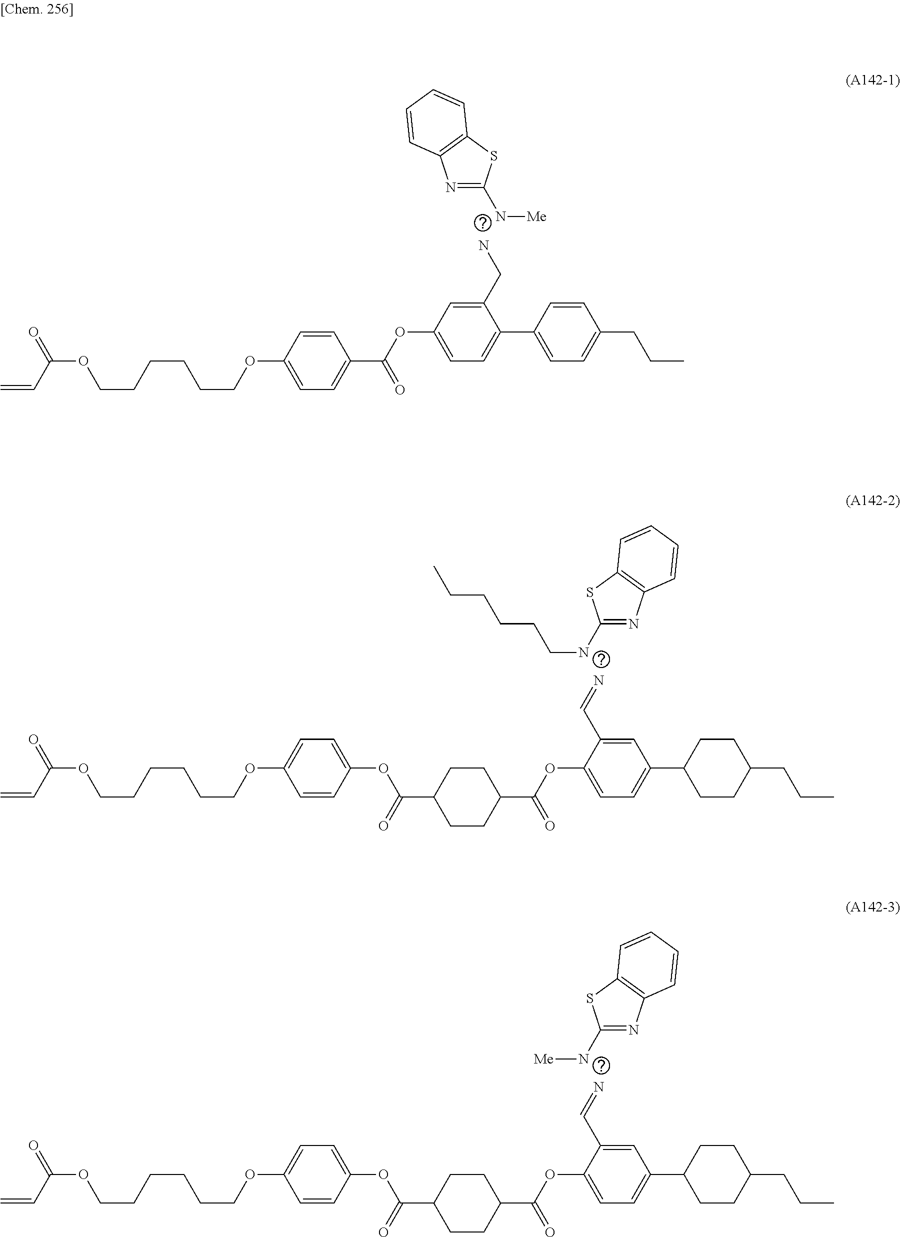

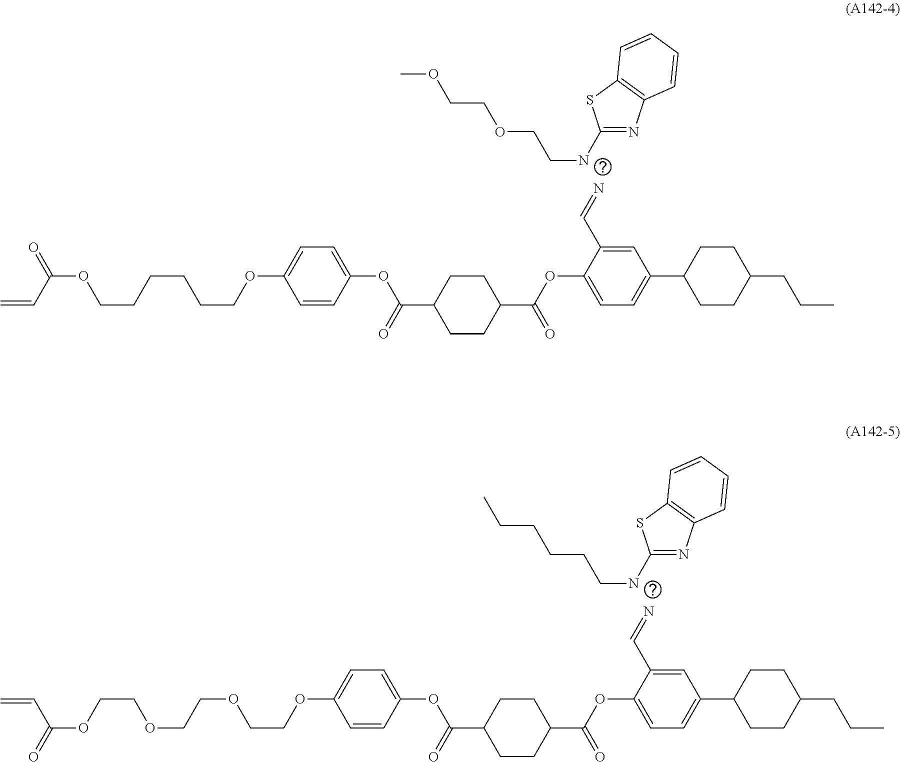

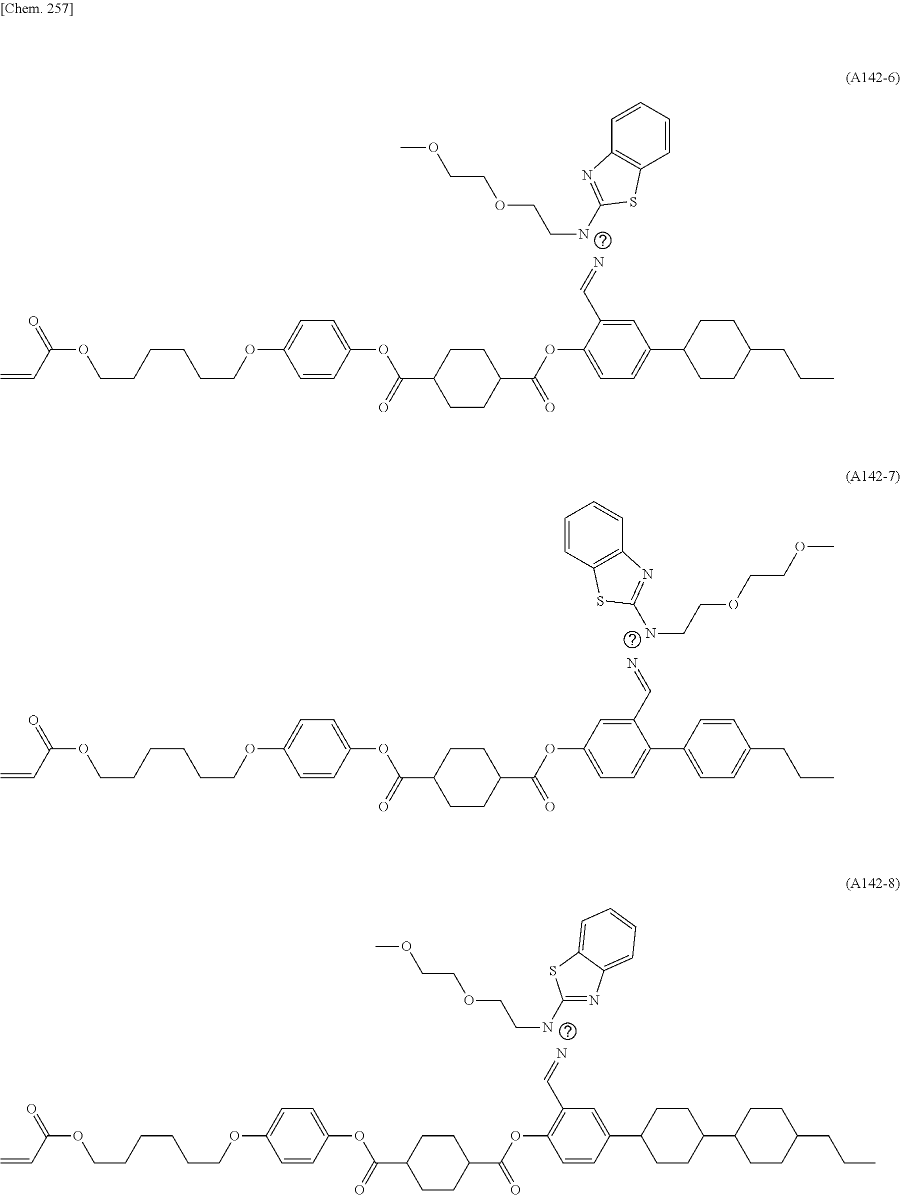

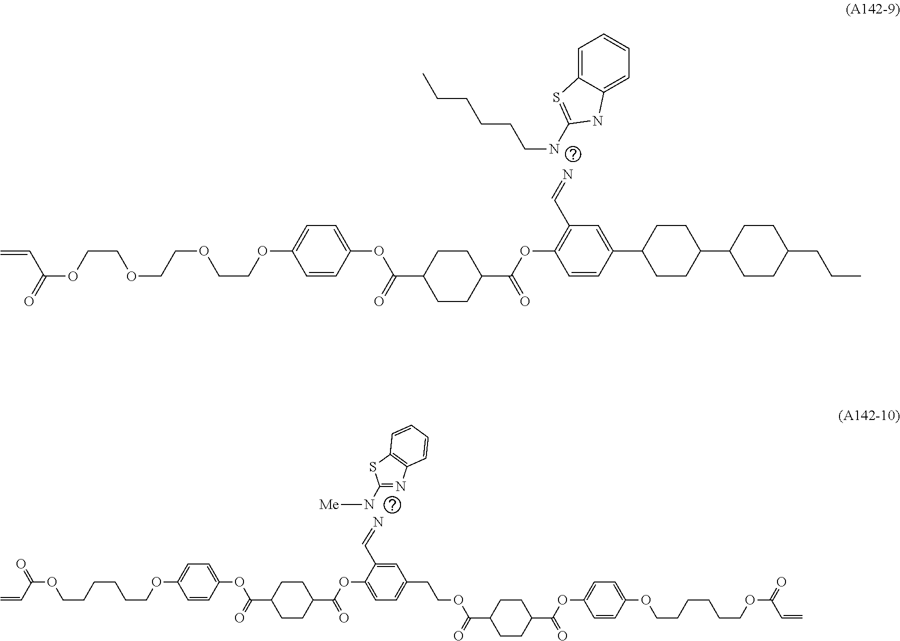

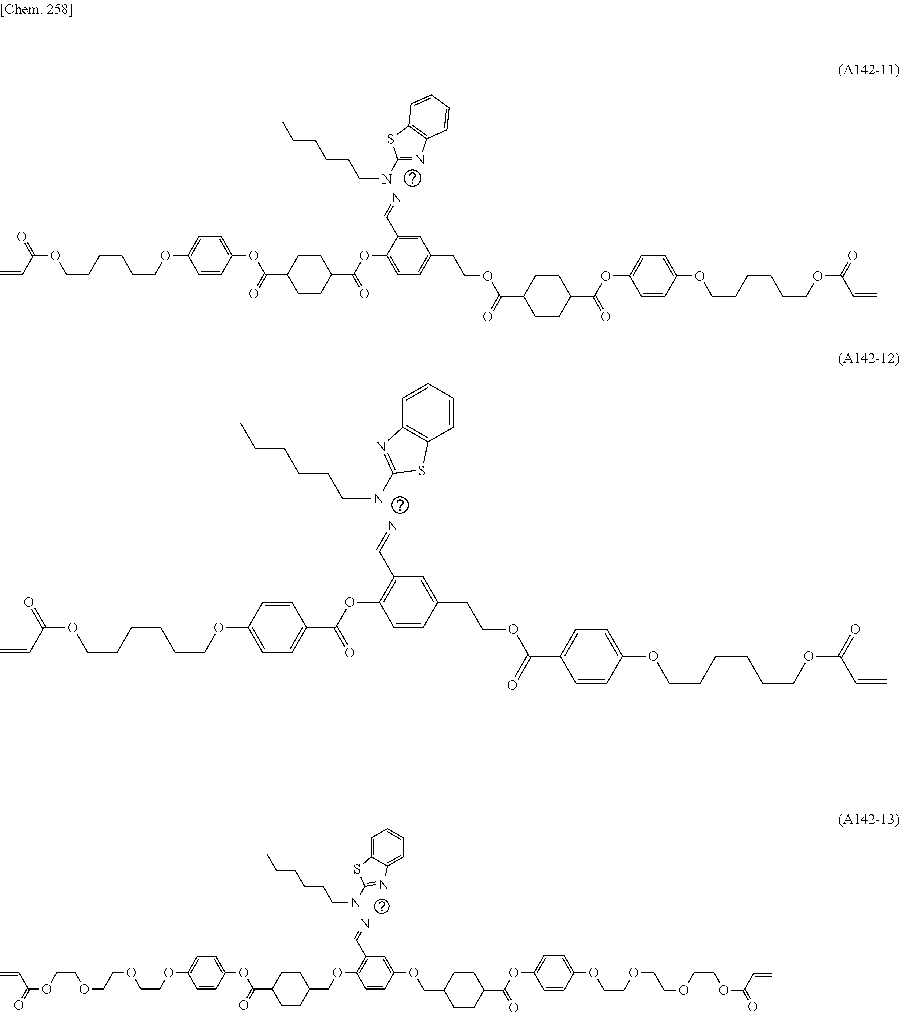

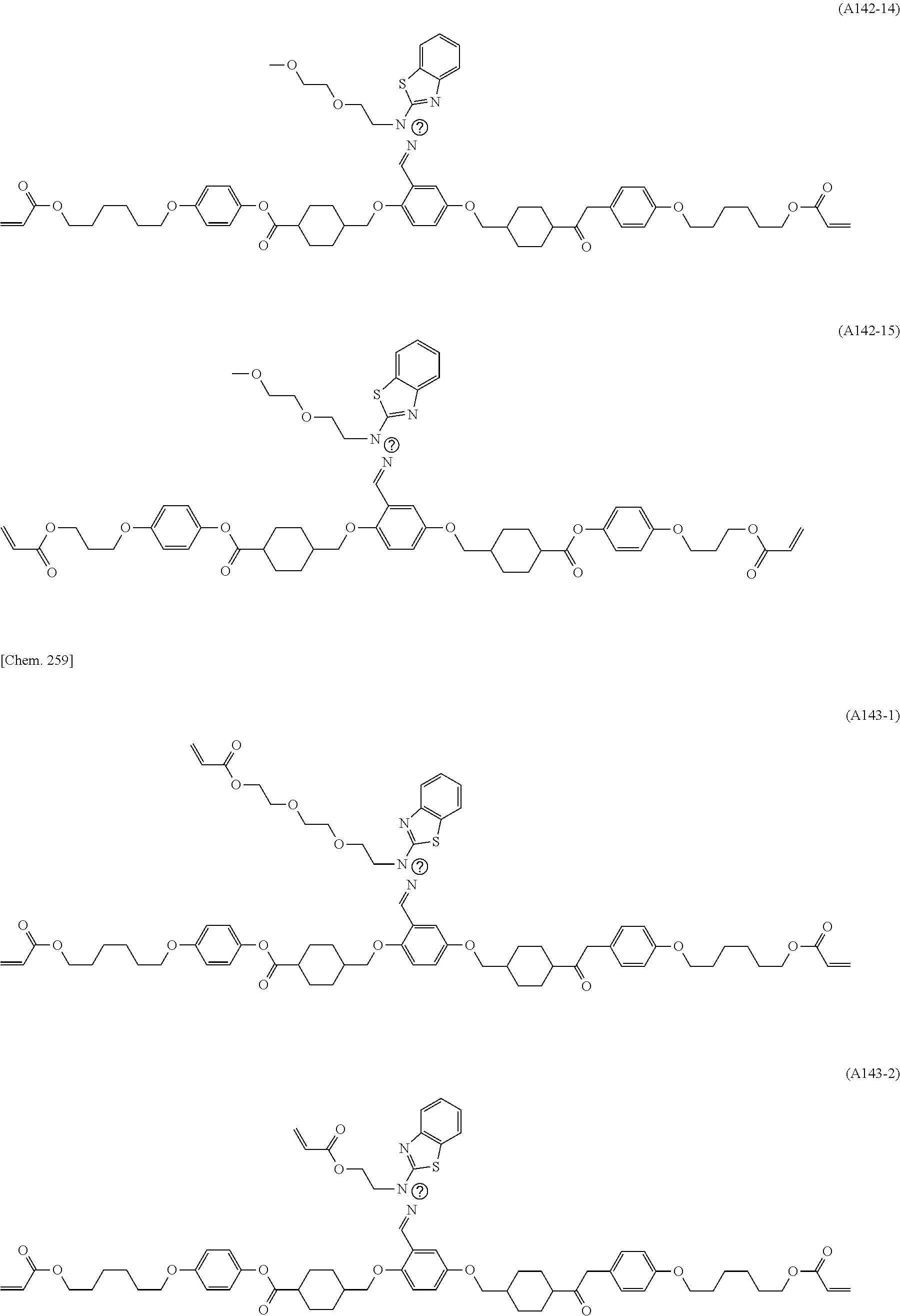

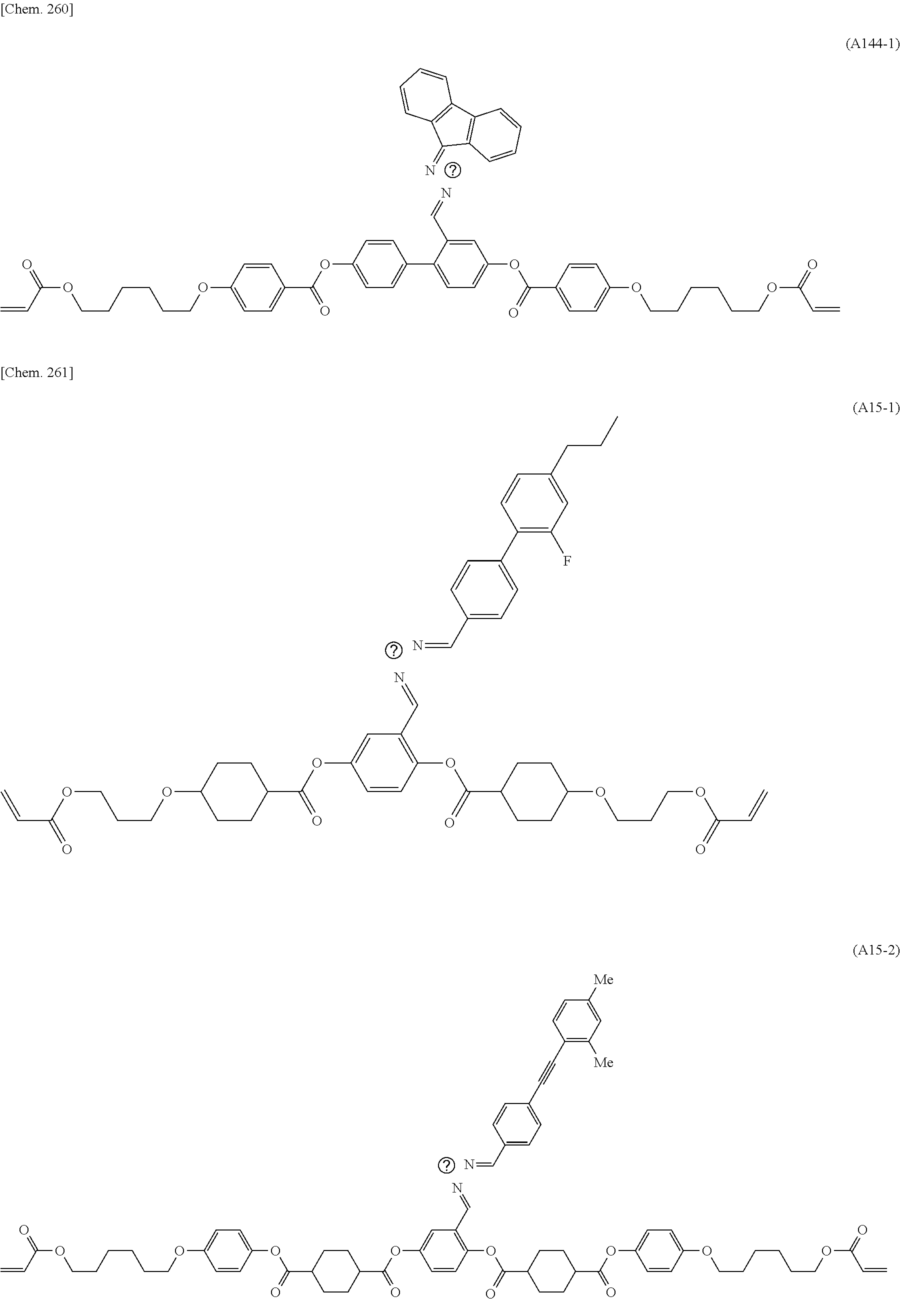

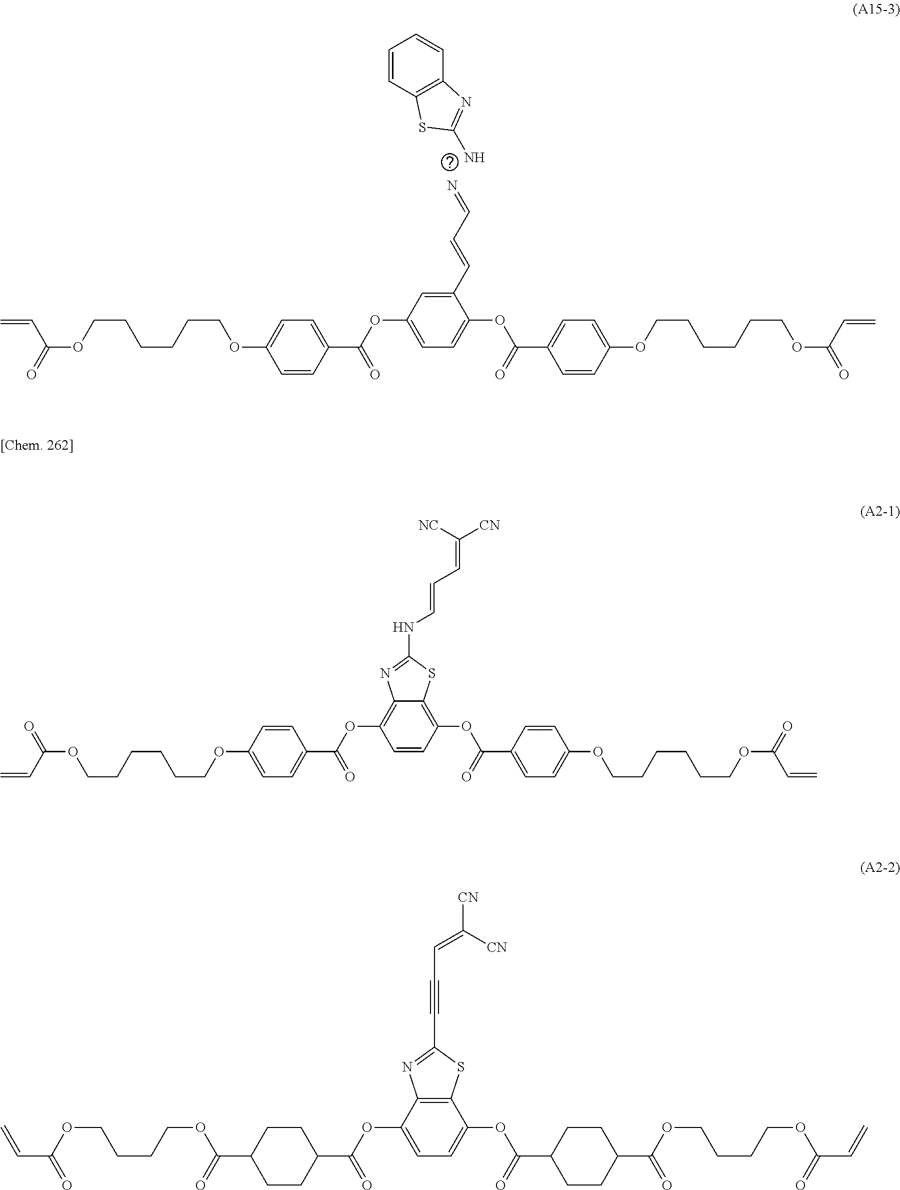

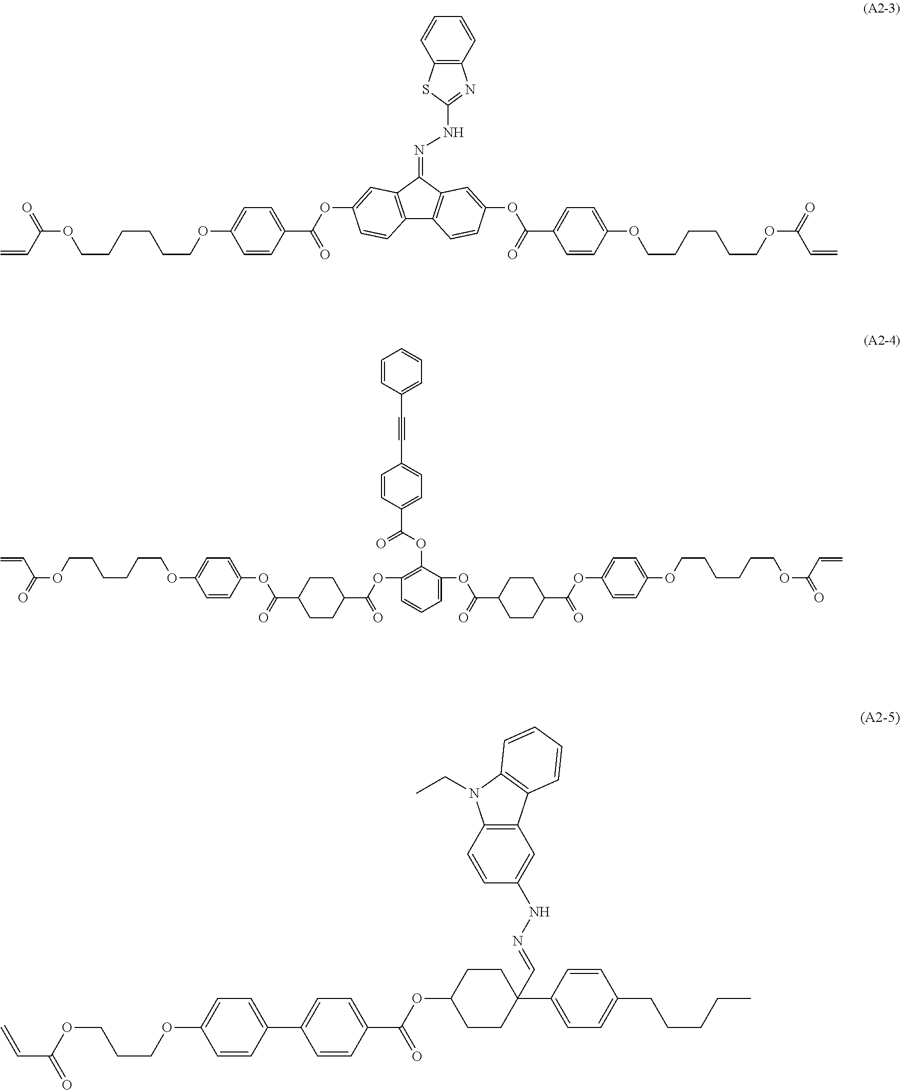

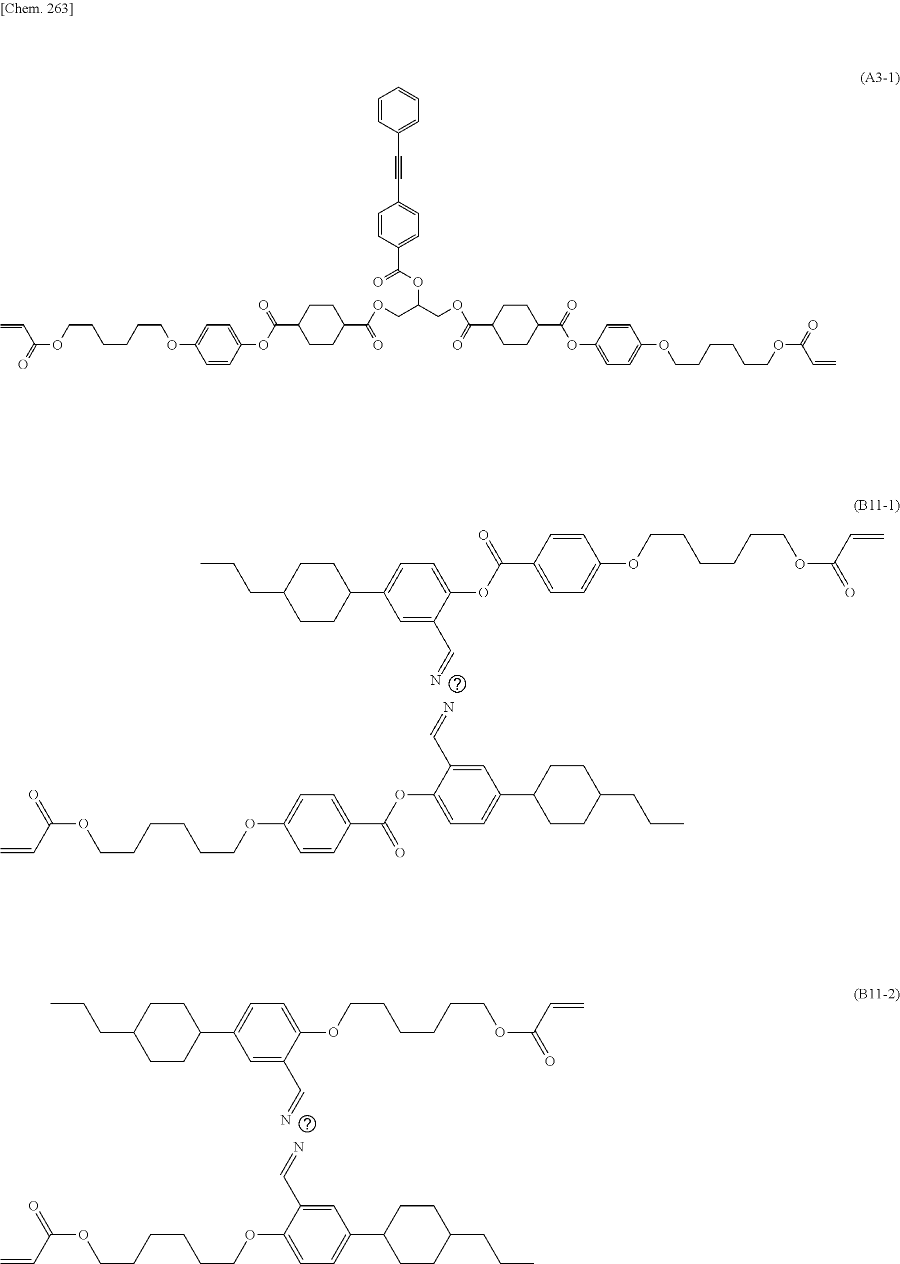

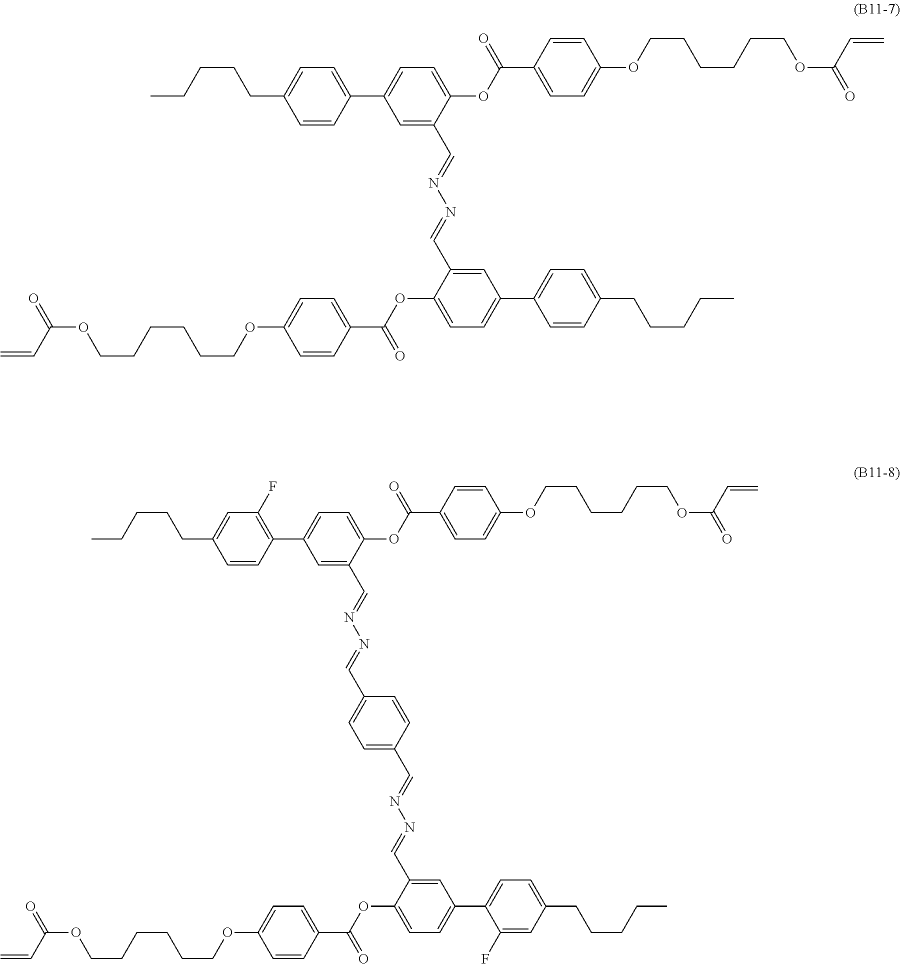

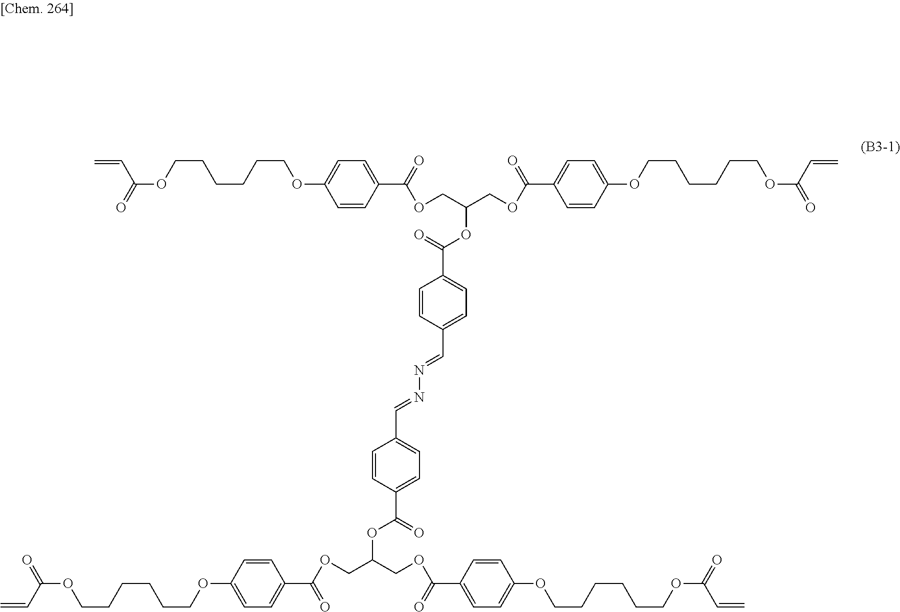

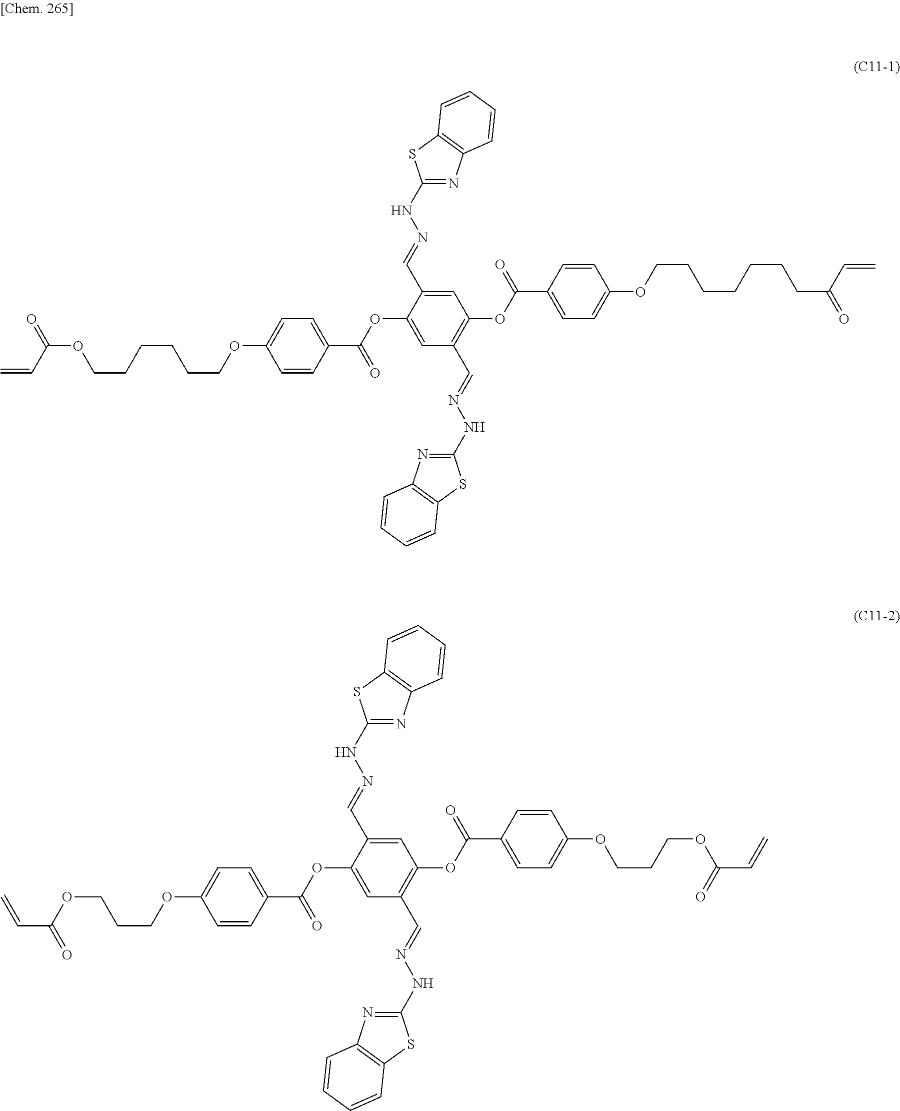

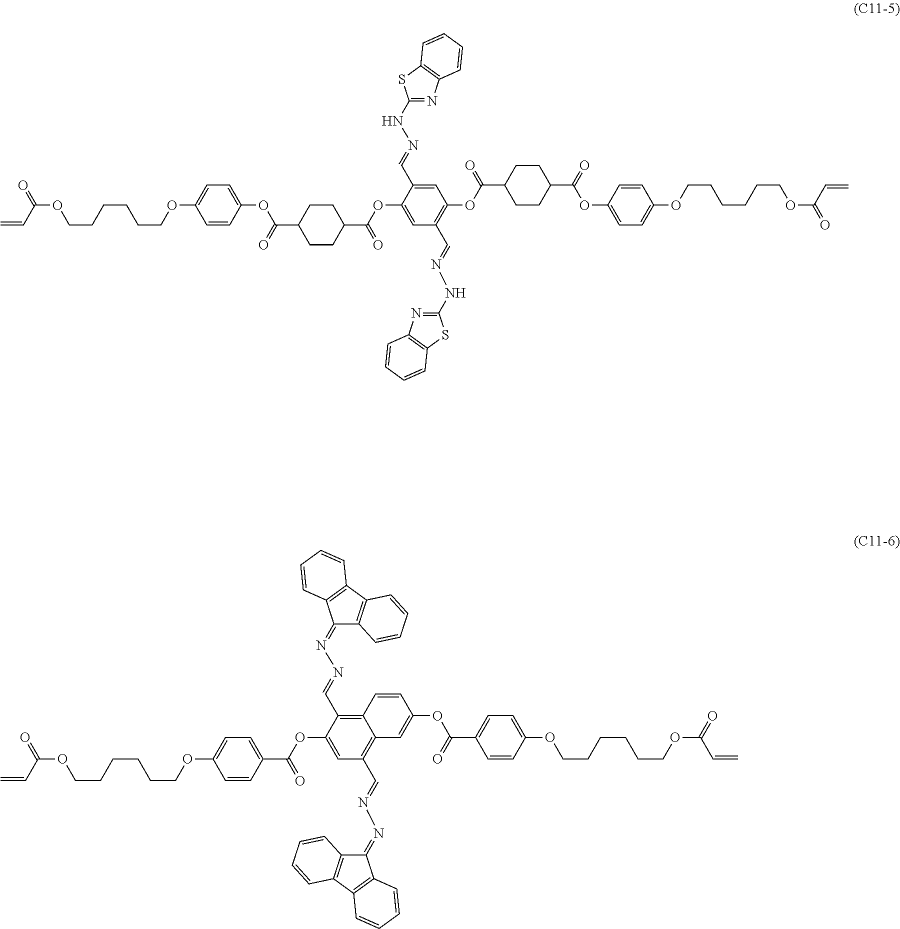

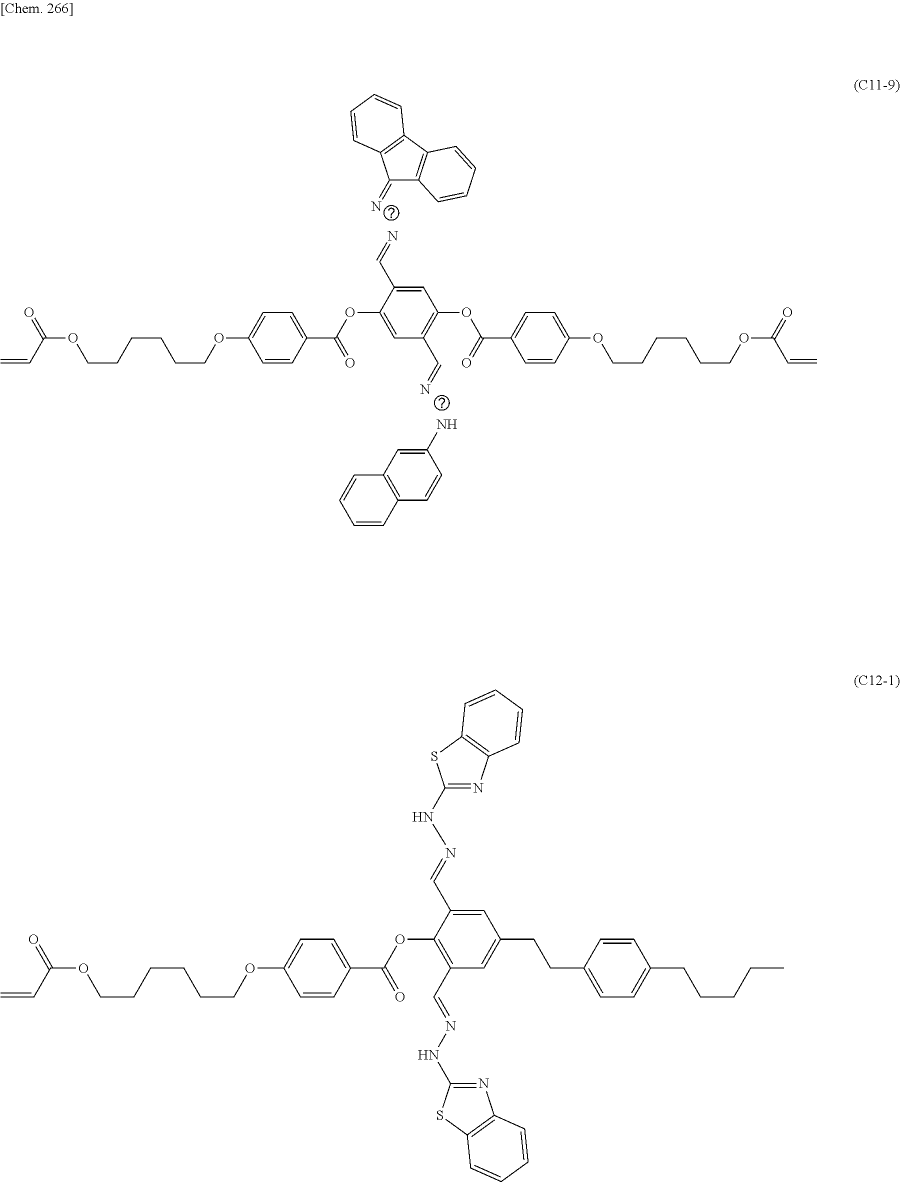

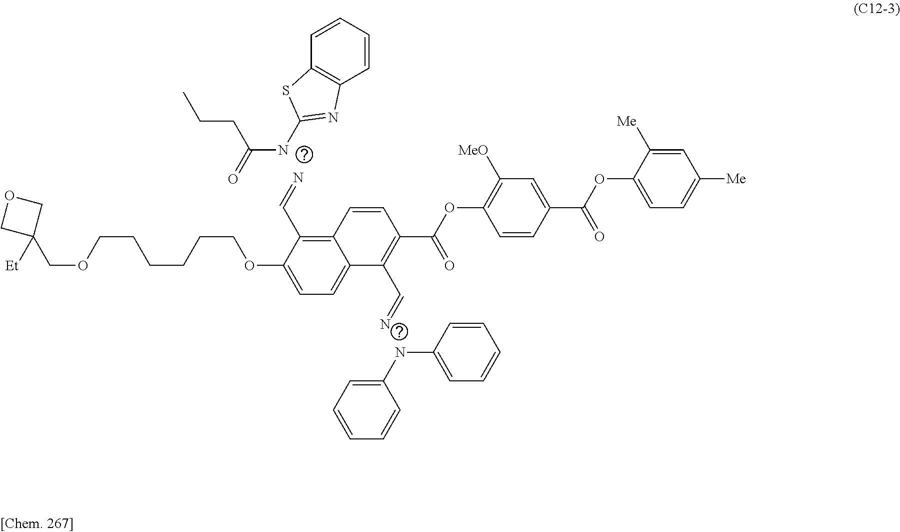

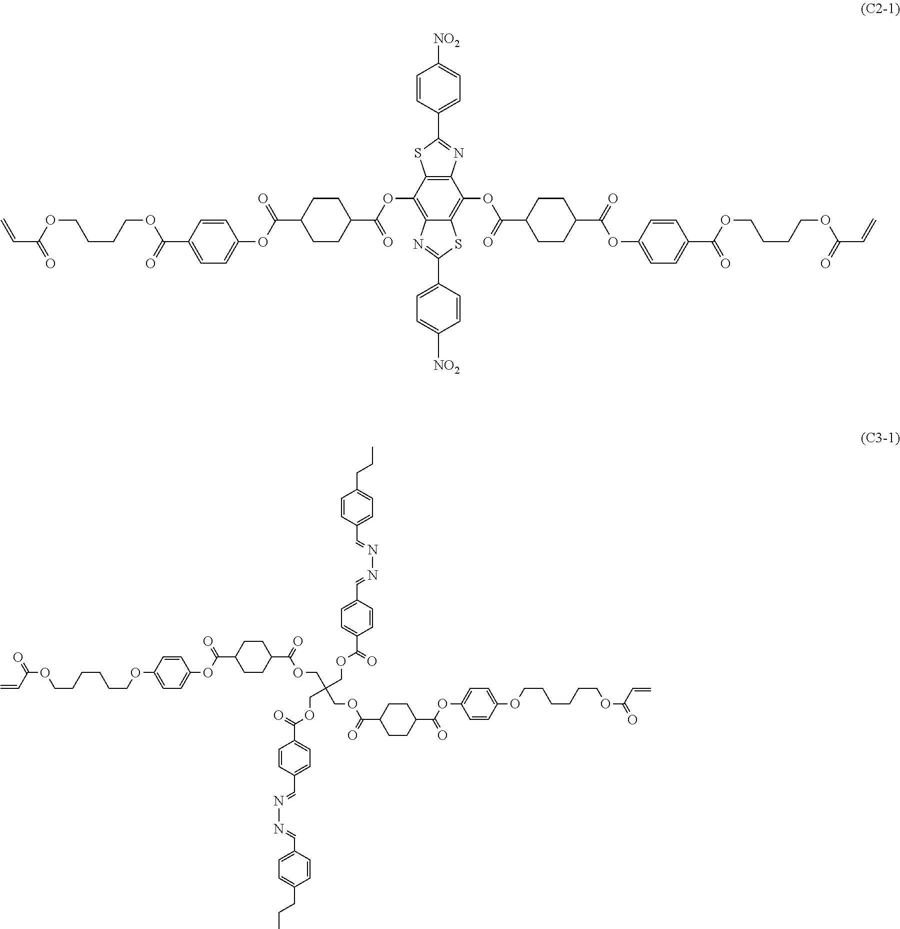

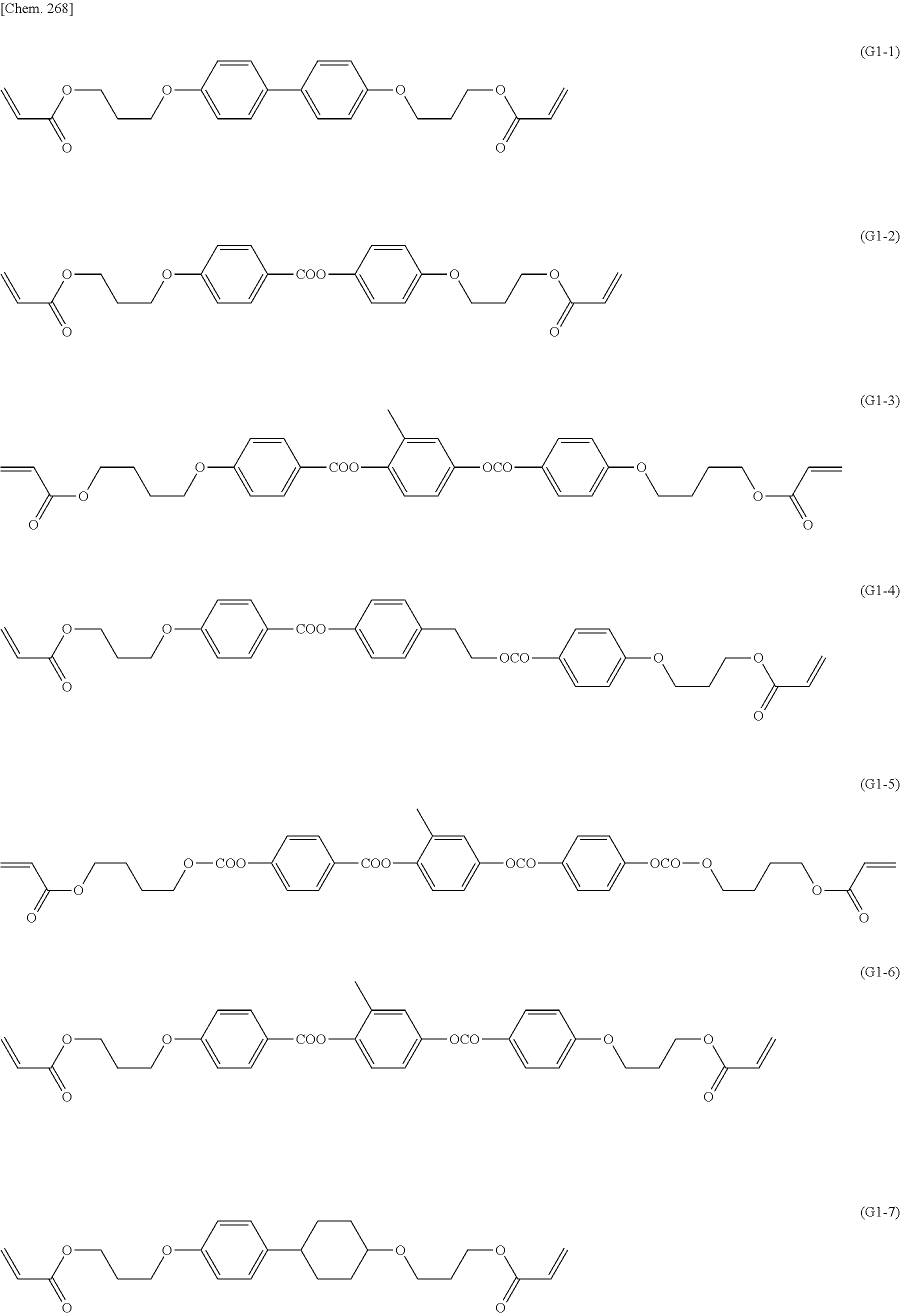

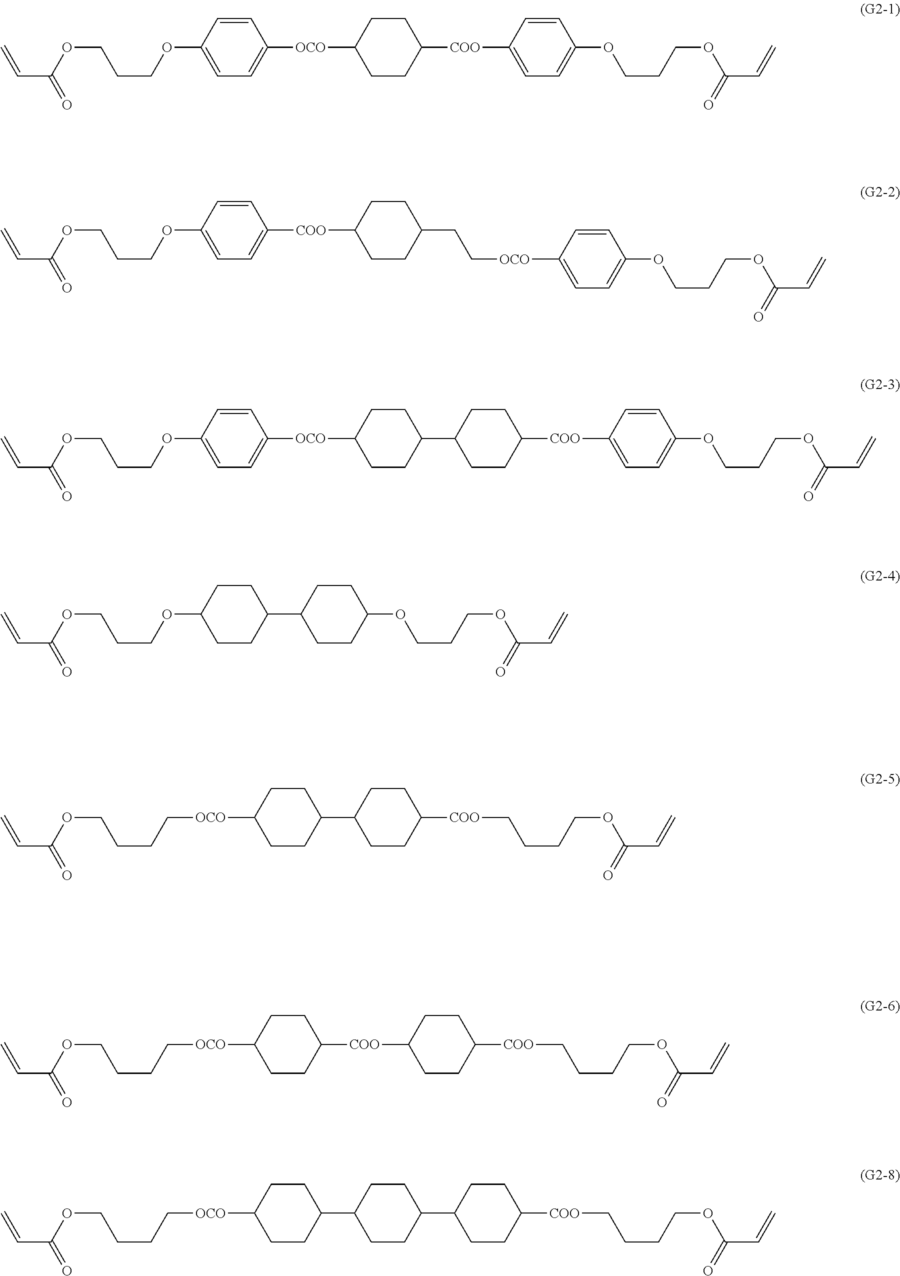

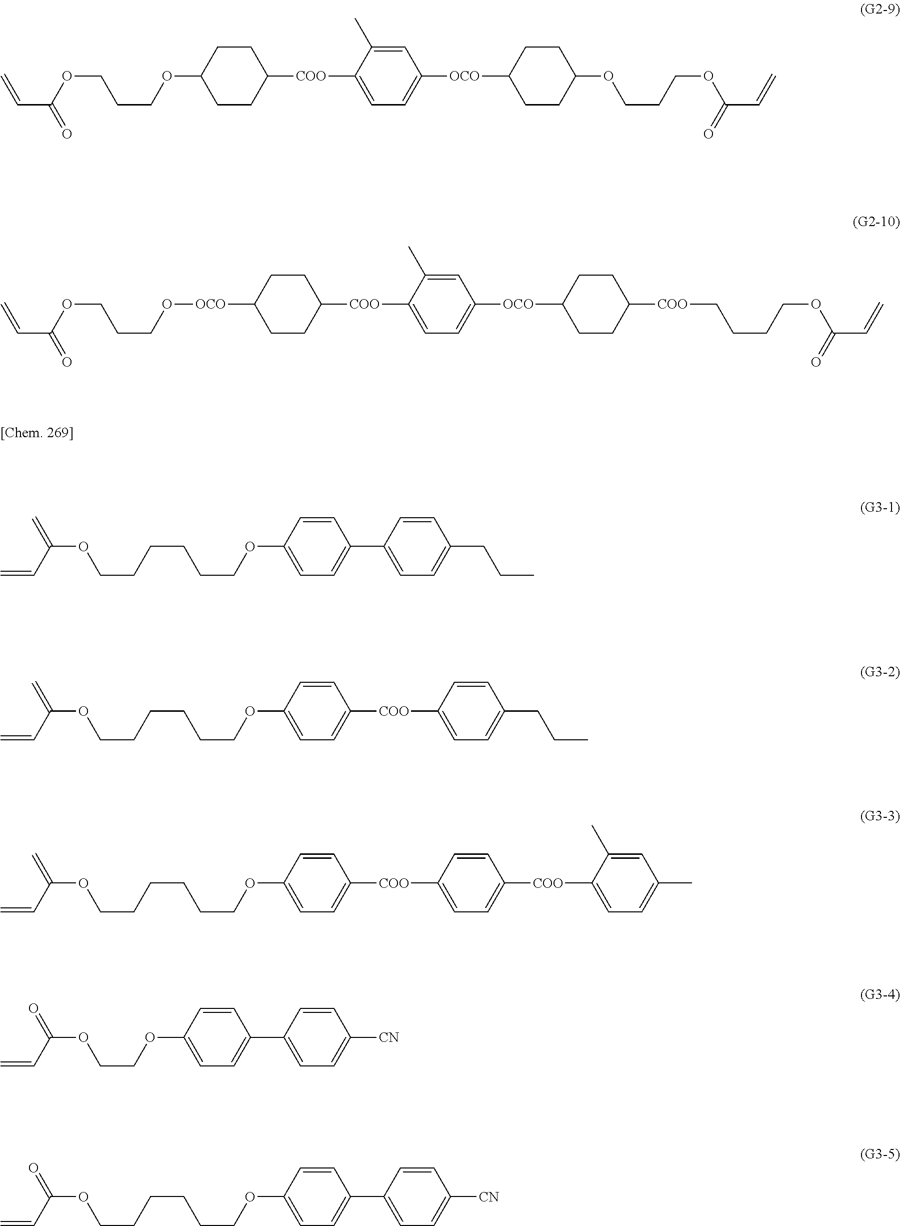

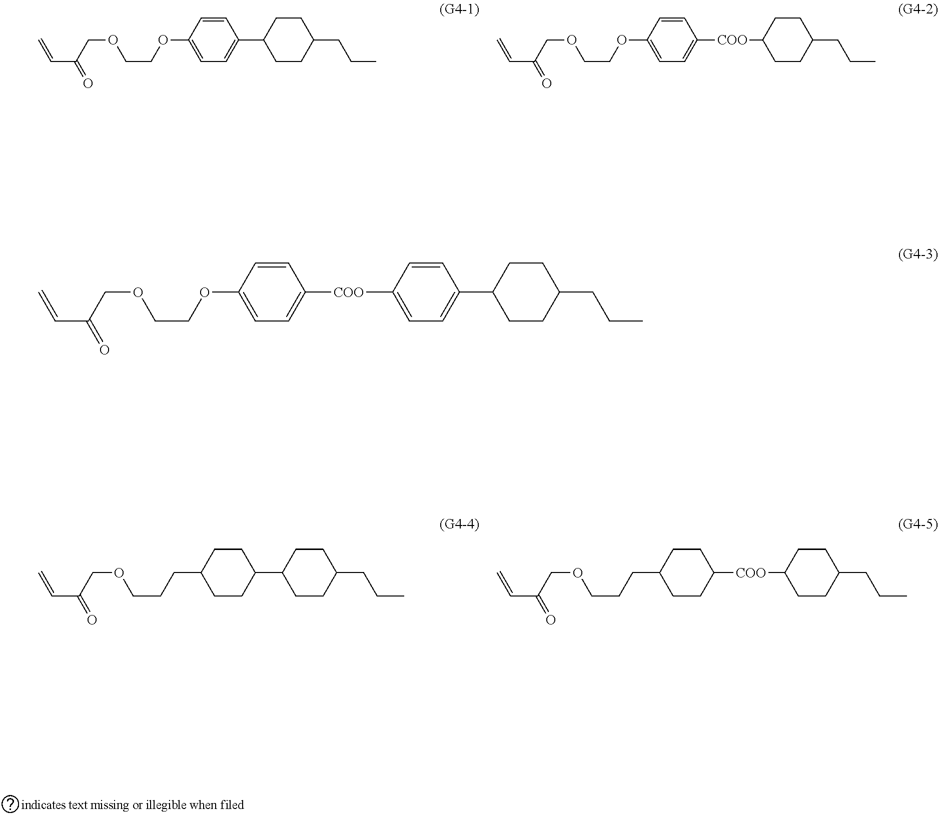

(Evaluation)

(Storage Stability)

Regarding the storage stability, the coating solution obtained as described above was left for 24 hours by observing the coating solution at every 5° C. from 30° C., and the lowest temperature at which crystal was not precipitated was recorded.

(Tilt Angle)

Regarding the tilt angle of the air interface, incident angle dependence of the phase difference of the obtained retardation plate was measured by using a phase difference measurement device RET-100 (manufactured by Otsuka Electronics Co., Ltd.), and the obtained measurement result was analyzed by using computer simulation software LCD-Master (manufactured by Shintech, Inc.).

(Glance)

Regarding glance, GALAXY SII mounted with an organic EL panel manufactured by SAMSUNG was disassembled, a circularly polarizing plate was peeled off and the wide-band circularly polarizing plate described above was bonded thereto, and black coloring observed from the front or an angle of 450 diagonally was evaluated based on the following criteria.

A: Coloring of reflected light is not substantially recognized. (Allowed)

B: Coloring of reflected light is extremely slightly recognized, but there are no practical problems (Allowed)

C: Coloring of reflected light is slightly recognized, but there are no practical problems (Allowed)

D: Coloring of reflected light is recognized and can be allowed according to the purpose (Allowed)

E: Coloring of reflected light is strongly recognized and cannot be allowed.

TABLE 1

| | | | | | Others | | | | Evaluation | | |
|---|---|---|---|---|---|---|---|---|---|---|---|
| | General Formula (I) | | General Formula (II) | | MEHQ | Irgacure | Liquid | Cyclopentanone | Storage | Tilt | |
| | Compound | (%) | Compound | (%) | (%) | 907 (%) | paraffin (%) | (%) | stability (° C) | (degree) | Glance |
| Example 1 | A11-1 | 15.2 | G1-3 | 3.7 | 0.05 | 1 | 0.05 | 80 | 20 | 0 | B |
| Example 2 | A11-1 | 15.2 | G1-4 | 3.7 | 0.05 | 1 | 0.05 | 80 | 20 | 1 | B |
| Example 3 | A11-1 | 15.2 | G1-5 | 3.7 | 0.05 | 1 | 0.05 | 80 | 20 | 4 | D |
| Example 4 | A11-1 | 15.2 | G3-2 | 3.7 | 0.05 | 1 | 0.05 | 80 | 20 | 2 | A |
| Example 5 | A11-1 | 15.2 | G3-3 | 3.7 | 0.05 | 1 | 0.05 | 80 | 20 | 3 | A |
| Example 6 | A11-2 | 15.2 | G1-2 | 3.7 | 0.05 | 1 | 0.05 | 80 | 20 | 2 | A |
| Example 7 | A11-2 | 15.2 | G1-5 | 3.7 | 0.05 | 1 | 0.05 | 80 | 20 | 4 | D |
| Example 8 | A11-2 | 15.2 | G2-1 | 3.7 | 0.05 | 1 | 0.05 | 80 | 20 | 0 | B |
| Example 9 | A11-2 | 15.2 | G4-1 | 3.7 | 0.05 | 1 | 0.05 | 80 | 20 | 3 | A |
| Example 10 | A12-1 | 15.2 | G1-5 | 3.7 | 0.05 | 1 | 0.05 | 80 | 20 | 4 | C |
| Example 11 | A12-1 | 15.2 | G2-3 | 3.7 | 0.05 | 1 | 0.05 | 80 | 20 | 0 | A |
| Example 12 | A12-1 | 15.2 | G2-4 | 3.7 | 0.05 | 1 | 0.05 | 80 | 20 | 1 | A |
| Example 13 | A12-1 | 15.2 | G4-3 | 3.7 | 0.05 | 1 | 0.05 | 80 | 20 | 1 | A |
| Example 14 | A12-2 | 15.2 | G1-1 | 3.7 | 0.05 | 1 | 0.05 | 80 | 20 | 1 | A |
| Example 15 | A12-2 | 15.2 | G1-3 | 3.7 | 0.05 | 1 | 0.05 | 80 | 20 | 0 | B |
| Example 16 | A12-2 | 15.2 | G2-4 | 3.7 | 0.05 | 1 | 0.05 | 80 | 20 | 1 | A |
| Example 17 | A12-2 | 15.2 | G3-2 | 3.7 | 0.05 | 1 | 0.05 | 80 | 20 | 3 | B |
| Example 18 | A12-2 | 15.2 | G4-3 | 3.7 | 0.05 | 1 | 0.05 | 80 | 20 | 1 | B |
| Example 19 | A12-3 | 15.2 | G1-4 | 3.7 | 0.05 | 1 | 0.05 | 80 | 20 | 2 | B |
| Example 20 | A12-3 | 15.2 | G4-2 | 3.7 | 0.05 | 1 | 0.05 | 80 | 20 | 3 | A |
| Example 21 | A12-4 | 15.2 | G1-3 | 3.7 | 0.05 | 1 | 0.05 | 80 | 15 | 0 | B |
| Example 22 | A12-4 | 15.2 | G1-5 | 3.7 | 0.05 | 1 | 0.05 | 80 | 15 | 4 | D |
| Example 23 | A12-4 | 15.2 | G2-2 | 3.7 | 0.05 | 1 | 0.05 | 80 | 15 | 0 | A |
| Example 24 | A12-4 | 15.2 | G2-5 | 3.7 | 0.05 | 1 | 0.05 | 80 | 15 | 1 | A |
| Example 25 | A12-4 | 15.2 | G4-4 | 3.7 | 0.05 | 1 | 0.05 | 80 | 15 | 3 | B |
| Example 26 | A12-5 | 15.2 | G1-4 | 3.7 | 0.05 | 1 | 0.05 | 80 | 20 | 2 | C |

TABLE 2

| | | | | | Others | | | | Evaluation | | |
|---|---|---|---|---|---|---|---|---|---|---|---|
| | General Formula (I) | | General Formula (II) | | MEHQ | Irgacure | Liquid | Cyclopentanone | Storage | Tilt | |
| | Compound | (%) | Compound | (%) | (%) | 907 (%) | paraffin (%) | (%) | stability (° C) | (degree) | Glance |
| Example 27 | A12-5 | 15.2 | G2-8 | 3.7 | 0.05 | 1 | 0.05 | 80 | 20 | 3 | A |
| Example 28 | A12-5 | 15.2 | G3-1 | 3.7 | 0.05 | 1 | 0.05 | 80 | 20 | 3 | B |
| Example 29 | A12-5 | 15.2 | G3-4 | 3.7 | 0.05 | 1 | 0.05 | 80 | 20 | 9 | D |
| Example 30 | A13-1 | 15.2 | G1-1 | 3.7 | 0.05 | 1 | 0.05 | 80 | 15 | 1 | A |
| Example 31 | A13-1 | 15.2 | G1-3 | 3.7 | 0.05 | 1 | 0.05 | 80 | 15 | 0 | B |
| Example 32 | A13-1 | 15.2 | G2-6 | 3.7 | 0.05 | 1 | 0.05 | 80 | 15 | 1 | A |
| Example 33 | A13-1 | 15.2 | G4-2 | 3.7 | 0.05 | 1 | 0.05 | 80 | 15 | 3 | A |
| Example 34 | A13-1 | 15.2 | G4-3 | 3.7 | 0.05 | 1 | 0.05 | 80 | 15 | 3 | A |
| Example 35 | A13-2 | 15.2 | G1-2 | 3.7 | 0.05 | 1 | 0.05 | 80 | 20 | 1 | A |
| Example 36 | A13-2 | 15.2 | G2-9 | 3.7 | 0.05 | 1 | 0.05 | 80 | 20 | 0 | A |
| Example 37 | A13-2 | 15.2 | G3-3 | 3.7 | 0.05 | 1 | 0.05 | 80 | 20 | 1 | B |
| Example 38 | A13-3 | 15.2 | G1-3 | 3.7 | 0.05 | 1 | 0.05 | 80 | 10 | 0 | B |
| Example 39 | A13-3 | 15.2 | G1-4 | 3.7 | 0.05 | 1 | 0.05 | 80 | 10 | 2 | B |
| Example 40 | A13-3 | 15.2 | G3-1 | 3.7 | 0.05 | 1 | 0.05 | 80 | 10 | 3 | A |
| Example 41 | A13-3 | 15.2 | G4-5 | 3.7 | 0.05 | 1 | 0.05 | 80 | 10 | 3 | A |
| Example 42 | A14-1 | 15.2 | G1-1 | 3.7 | 0.05 | 1 | 0.05 | 80 | 10 | 1 | A |
| Example 43 | A14-1 | 15.2 | G1-3 | 3.7 | 0.05 | 1 | 0.05 | 80 | 10 | 0 | B |
| Example 44 | A14-1 | 15.2 | G1-5 | 3.7 | 0.05 | 1 | 0.05 | 80 | 10 | 4 | D |
| Example 45 | A14-1 | 15.2 | G2-9 | 3.7 | 0.05 | 1 | 0.05 | 80 | 10 | 0 | A |
| Example 46 | A14-1 | 15.2 | G3-3 | 3.7 | 0.05 | 1 | 0.05 | 80 | 10 | 1 | A |
| Example 47 | A14-1 | 15.2 | G4-1 | 3.7 | 0.05 | 1 | 0.05 | 80 | 10 | 3 | A |
| Example 48 | A14-1 | 15.2 | G4-3 | 3.7 | 0.05 | 1 | 0.05 | 80 | 10 | 1 | A |
| Example 49 | A14-2 | 15.2 | G1-3 | 3.7 | 0.05 | 1 | 0.05 | 80 | 15 | 0 | B |
| Example 50 | A14-2 | 15.2 | G2-2 | 3.7 | 0.05 | 1 | 0.05 | 80 | 15 | 0 | A |
| Example 51 | A14-2 | 15.2 | G2-10 | 3.7 | 0.05 | 1 | 0.05 | 80 | 15 | 0 | A |
| Example 52 | A14-2 | 15.2 | G3-2 | 3.7 | 0.05 | 1 | 0.05 | 80 | 15 | 3 | A |

TABLE 3

| | | | | | Others | | | | Evaluation | | |
|---|---|---|---|---|---|---|---|---|---|---|---|
| | General Formula (I) | | General Formula (II) | | MEHQ | Irgacure | Liquid | Cyclopentanone | Storage | Tilt | |
| | Compound | (%) | Compound | (%) | (%) | 907 (%) | paraffin (%) | (%) | stability (° C) | (degree) | Glance |
| Example 53 | A14-2 | 15.2 | G4-5 | 3.7 | 0.05 | 1 | 0.05 | 80 | 15 | 3 | A |
| Example 54 | A14-3 | 15.2 | G1-4 | 3.7 | 0.05 | 1 | 0.05 | 80 | 15 | 2 | B |
| Example 55 | A14-3 | 15.2 | G1-5 | 3.7 | 0.05 | 1 | 0.05 | 80 | 15 | 4 | D |
| Example 56 | A14-3 | 15.2 | G2-8 | 3.7 | 0.05 | 1 | 0.05 | 80 | 15 | 3 | A |
| Example 57 | A14-3 | 15.2 | G3-3 | 3.7 | 0.05 | 1 | 0.05 | 80 | 15 | 1 | A |
| Example 58 | A14-3 | 15.2 | G4-2 | 3.7 | 0.05 | 1 | 0.05 | 80 | 15 | 3 | A |
| Example 59 | A15-1 | 15.2 | G1-2 | 3.7 | 0.05 | 1 | 0.05 | 80 | 20 | 1 | A |
| Example 60 | A15-1 | 15.2 | G1-3 | 3.7 | 0.05 | 1 | 0.05 | 80 | 20 | 0 | B |
| Example 61 | A15-1 | 15.2 | G3-3 | 3.7 | 0.05 | 1 | 0.05 | 80 | 20 | 1 | A |
| Example 62 | A15-2 | 15.2 | G1-1 | 3.7 | 0.05 | 1 | 0.05 | 80 | 20 | 1 | A |
| Example 63 | A15-2 | 15.2 | G3-3 | 3.7 | 0.05 | 1 | 0.05 | 80 | 20 | 1 | A |
| Example 64 | A15-2 | 15.2 | G4-4 | 3.7 | 0.05 | 1 | 0.05 | 80 | 20 | 3 | A |
| Example 65 | A15-3 | 15.2 | G2-1 | 3.7 | 0.05 | 1 | 0.05 | 80 | 20 | 0 | A |
| Example 66 | A15-3 | 15.2 | G3-4 | 3.7 | 0.05 | 1 | 0.05 | 80 | 20 | 8 | D |
| Example 67 | A15-3 | 15.2 | G4-3 | 3.7 | 0.05 | 1 | 0.05 | 80 | 20 | 0 | A |
| Example 68 | A2-1 | 15.2 | G1-1 | 3.7 | 0.05 | 1 | 0.05 | 80 | 25 | 1 | B |
| Example 69 | A2-1 | 15.2 | G3-4 | 3.7 | 0.05 | 1 | 0.05 | 80 | 25 | 9 | D |
| Example 70 | A2-1 | 15.2 | G4-3 | 3.7 | 0.05 | 1 | 0.05 | 80 | 25 | 1 | A |
| Example 71 | A2-2 | 15.2 | G1-3 | 3.7 | 0.05 | 1 | 0.05 | 80 | 25 | 0 | C |
| Example 72 | A2-2 | 15.2 | G4-3 | 3.7 | 0.05 | 1 | 0.05 | 80 | 25 | 0 | A |
| Example 73 | A2-3 | 15.2 | G1-2 | 3.7 | 0.05 | 1 | 0.05 | 80 | 25 | 1 | A |
| Example 74 | A2-4 | 15.2 | G1-2 | 3.7 | 0.05 | 1 | 0.05 | 80 | 25 | 0 | A |
| Example 75 | A2-5 | 15.2 | G1-2 | 3.7 | 0.05 | 1 | 0.05 | 80 | 15 | 1 | A |
| Example 76 | A3-1 | 15.2 | G1-5 | 3.7 | 0.05 | 1 | 0.05 | 80 | 25 | 4 | D |
| Example 77 | A3-1 | 15.2 | G4-3 | 3.7 | 0.05 | 1 | 0.05 | 80 | 25 | 0 | A |
| Example 78 | B11-1 | 15.2 | G1-3 | 3.7 | 0.05 | 1 | 0.05 | 80 | 15 | 6 | C |

TABLE 4

| | | | | | Others | | | | Evaluation | | |
|---|---|---|---|---|---|---|---|---|---|---|---|
| | General Formula (I) | | General Formula (II) | | MEHQ | Irgacure | Liquid | Cyclopentanone | Storage | Tilt | |
| | Compound | (%) | Compound | (%) | (%) | 907 (%) | paraffin (%) | (%) | stability (° C) | (degree) | Glance |
| Example 79 | B11-1 | 15.2 | G1-5 | 3.7 | 0.05 | 1 | 0.05 | 80 | 15 | 3 | C |
| Example 80 | B11-1 | 15.2 | G4-3 | 3.7 | 0.05 | 1 | 0.05 | 80 | 15 | 1 | A |
| Example 81 | B11-2 | 15.2 | G4-3 | 3.7 | 0.05 | 1 | 0.05 | 80 | 10 | 1 | A |
| Example 82 | B11-7 | 15.2 | G1-1 | 3.7 | 0.05 | 1 | 0.05 | 80 | 10 | 0 | A |
| Example 83 | B11-7 | 15.2 | G1-5 | 3.7 | 0.05 | 1 | 0.05 | 80 | 10 | 3 | C |
| Example 84 | B11-8 | 15.2 | G2-4 | 3.7 | 0.05 | 1 | 0.05 | 80 | 15 | 0 | A |
| Example 85 | B3-1 | 15.2 | G4-3 | 3.7 | 0.05 | 1 | 0.05 | 80 | 15 | 1 | A |
| Example 86 | C11-1 | 15.2 | G1-3 | 3.7 | 0.05 | 1 | 0.05 | 80 | 15 | 2 | B |
| Example 87 | C11-2 | 15.2 | G1-3 | 3.7 | 0.05 | 1 | 0.05 | 80 | 15 | 1 | B |
| Example 88 | C11-5 | 15.2 | G1-3 | 3.7 | 0.05 | 1 | 0.05 | 80 | 20 | 2 | B |
| Example 89 | C11-6 | 15.2 | G1-3 | 3.7 | 0.05 | 1 | 0.05 | 80 | 15 | 2 | B |
| Example 90 | C11-9 | 15.2 | G1-3 | 3.7 | 0.05 | 1 | 0.05 | 80 | 20 | 1 | C |
| Example 91 | C12-1 | 15.2 | G4-3 | 3.7 | 0.05 | 1 | 0.05 | 80 | 15 | 1 | A |
| Example 92 | C12-3 | 15.2 | G4-3 | 3.7 | 0.05 | 1 | 0.05 | 80 | 15 | 1 | A |
| Example 93 | C2-1 | 15.2 | G1-3 | 3.7 | 0.05 | 1 | 0.05 | 80 | 20 | 1 | B |
| Example 94 | C3-1 | 15.2 | G1-3 | 3.7 | 0.05 | 1 | 0.05 | 80 | 20 | 2 | B |
| Comparative | G1-3 | 9.4 | G1-6 | 9.5 | 0.05 | 1 | 0.05 | 80 | 15 | 2 | E |
| Example 1 | | | | | | | | | | | |
| Comparative | G1-5 | 15 | G1-6 | 3.9 | 0.05 | 1 | 0.05 | 80 | 15 | 3 | E |
| Example 2 | | | | | | | | | | | |
| Comparative | G1-5 | 15.2 | G3-4 | 3.7 | 0.05 | 1 | 0.05 | 80 | 10 | 13 | E |
| Example 3 | | | | | | | | | | | |
| Comparative | G2-2 | 15.2 | G2-8 | 3.7 | 0.05 | 1 | 0.05 | 80 | 30 | 1 | E |
| Example 4 | | | | | | | | | | | |

TABLE 5

| | | | | | Others | | | | Evaluation | | |
|---|---|---|---|---|---|---|---|---|---|---|---|
| | General Formula (I) | | General Formula (II) | | MEHQ | Irgacure | Liquid | Cyclopentanone | Storage | Tilt | Glance |
| | Compound | (%) | Compound | (%) | (%) | 907 (%) | paraffin (%) | (%) | stability (° C) | (degree) | Front |
| Example 95 | A12-16 | 15.2 | G1-3 | 3.7 | 0.05 | 1 | 0.05 | 80 | 5 | 0 | A |
| Example 96 | A12-17 | 15.2 | G1-3 | 3.7 | 0.05 | 1 | 0.05 | 80 | 5 | 0 | A |
| Example 97 | A12-18 | 15.2 | G1-3 | 3.7 | 0.05 | 1 | 0.05 | 80 | 0 | 0 | A |
| Example 98 | A141-1 | 15.2 | G1-3 | 3.7 | 0.05 | 1 | 0.05 | 80 | 0 | 2 | A |
| Example 99 | A141-2 | 15.2 | G1-3 | 3.7 | 0.05 | 1 | 0.05 | 80 | 0 | 1 | A |
| Example 100 | A141-3 | 15.2 | G1-3 | 3.7 | 0.05 | 1 | 0.05 | 80 | 0 | 1 | A |
| Example 101 | A141-4 | 15.2 | G1-3 | 3.7 | 0.05 | 1 | 0.05 | 80 | 0 | 1 | A |
| Example 102 | A141-5 | 15.2 | G1-3 | 3.7 | 0.05 | 1 | 0.05 | 80 | 0 | 1 | A |
| Example 103 | A141-6 | 15.2 | G1-3 | 3.7 | 0.05 | 1 | 0.05 | 80 | 0 | 2 | A |
| Example 104 | A141-7 | 15.2 | G1-3 | 3.7 | 0.05 | 1 | 0.05 | 80 | 0 | 2 | A |
| Example 105 | A141-8 | 15.2 | G1-3 | 3.7 | 0.05 | 1 | 0.05 | 80 | 0 | 1 | A |
| Example 106 | A141-9 | 15.2 | G1-3 | 3.7 | 0.05 | 1 | 0.05 | 80 | 0 | 2 | A |
| Example 107 | A141-10 | 15.2 | G1-3 | 3.7 | 0.05 | 1 | 0.05 | 80 | 0 | 1 | A |
| Example 108 | A141-11 | 15.2 | G1-3 | 3.7 | 0.05 | 1 | 0.05 | 80 | 0 | 1 | A |
| Example 109 | A141-12 | 15.2 | G1-3 | 3.7 | 0.05 | 1 | 0.05 | 80 | 0 | 1 | A |
| Example 110 | A141-13 | 15.2 | G1-3 | 3.7 | 0.05 | 1 | 0.05 | 80 | 0 | 1 | A |
| Example 111 | A141-14 | 15.2 | G1-3 | 3.7 | 0.05 | 1 | 0.05 | 80 | 0 | 2 | A |
| Example 112 | A141-15 | 15.2 | G1-3 | 3.7 | 0.05 | 1 | 0.05 | 80 | 0 | 2 | A |
| Example 113 | A141-16 | 15.2 | G1-3 | 3.7 | 0.05 | 1 | 0.05 | 80 | 0 | 2 | A |
| Example 114 | A141-17 | 15.2 | G1-3 | 3.7 | 0.05 | 1 | 0.05 | 80 | 0 | 2 | A |

TABLE 6

| | | | | | Others | | | | Evaluation | | |
|---|---|---|---|---|---|---|---|---|---|---|---|
| | General Formula (I) | | General Formula (II) | | MEHQ | Irgacure | Liquid | Cyclopentanone | Storage | Tilt | Glance |
| | Compound | (%) | Compound | (%) | (%) | 907 (%) | paraffin (%) | (%) | stability (° C) | (degree) | Front |
| Example 115 | A141-18 | 15.2 | G1-3 | 3.7 | 0.05 | 1 | 0.05 | 80 | 0 | 2 | A |
| Example 116 | A141-19 | 15.2 | G1-3 | 3.7 | 0.05 | 1 | 0.05 | 80 | 0 | 2 | A |
| Example 117 | A141-20 | 15.2 | G1-3 | 3.7 | 0.05 | 1 | 0.05 | 80 | 0 | 2 | A |
| Example 118 | A141-21 | 15.2 | G1-3 | 3.7 | 0.05 | 1 | 0.05 | 80 | 0 | 1 | A |
| Example 119 | A141-22 | 15.2 | G1-3 | 3.7 | 0.05 | 1 | 0.05 | 80 | 0 | 0 | A |
| Example 120 | A141-23 | 15.2 | G1-3 | 3.7 | 0.05 | 1 | 0.05 | 80 | 0 | 0 | A |
| Example 121 | A141-24 | 15.2 | G1-3 | 3.7 | 0.05 | 1 | 0.05 | 80 | 0 | 0 | A |
| Example 122 | A141-25 | 15.2 | G1-3 | 3.7 | 0.05 | 1 | 0.05 | 80 | 0 | 0 | A |
| Example 123 | A141-26 | 15.2 | G1-3 | 3.7 | 0.05 | 1 | 0.05 | 80 | 0 | 0 | A |
| Example 124 | A141-27 | 15.2 | G1-3 | 3.7 | 0.05 | 1 | 0.05 | 80 | 0 | 0 | A |
| Example 125 | A141-28 | 15.2 | G1-3 | 3.7 | 0.05 | 1 | 0.05 | 80 | 0 | 0 | A |
| Example 126 | A141-29 | 15.2 | G1-3 | 3.7 | 0.05 | 1 | 0.05 | 80 | 0 | 0 | A |
| Example 127 | A141-30 | 15.2 | G1-3 | 3.7 | 0.05 | 1 | 0.05 | 80 | 0 | 0 | A |
| Example 128 | A141-31 | 15.2 | G1-3 | 3.7 | 0.05 | 1 | 0.05 | 80 | 0 | 0 | A |
| Example 129 | A141-32 | 15.2 | G1-3 | 3.7 | 0.05 | 1 | 0.05 | 80 | 0 | 0 | A |
| Example 130 | A141-33 | 15.2 | G1-3 | 3.7 | 0.05 | 1 | 0.05 | 80 | 0 | 0 | A |
| Example 131 | A142-1 | 15.2 | G1-3 | 3.7 | 0.05 | 1 | 0.05 | 80 | 0 | 1 | A |
| Example 132 | A142-2 | 15.2 | G1-3 | 3.7 | 0.05 | 1 | 0.05 | 80 | −5 | 1 | A |
| Example 133 | A142-3 | 15.2 | G1-3 | 3.7 | 0.05 | 1 | 0.05 | 80 | −5 | 1 | A |
| Example 134 | A142-4 | 15.2 | G1-3 | 3.7 | 0.05 | 1 | 0.05 | 80 | −5 | 1 | A |

TABLE 7

| | | | | | Others | | | | Evaluation | | |
|---|---|---|---|---|---|---|---|---|---|---|---|
| | General Formula (I) | | General Formula (II) | | MEHQ | Irgacure | Liquid | Cyclopentanone | Storage | Tilt | Glance |
| | Compound | (%) | Compound | (%) | (%) | 907 (%) | paraffin (%) | (%) | stability (° C) | (degree) | Front |
| Example 135 | A142-5 | 15.2 | G1-3 | 3.7 | 0.05 | 1 | 0.05 | 80 | −5 | 1 | A |
| Example 136 | A142-6 | 15.2 | G1-3 | 3.7 | 0.05 | 1 | 0.05 | 80 | −5 | 1 | A |
| Example 137 | A142-7 | 15.2 | G1-3 | 3.7 | 0.05 | 1 | 0.05 | 80 | −5 | 1 | A |
| Example 138 | A142-8 | 15.2 | G1-3 | 3.7 | 0.05 | 1 | 0.05 | 80 | −5 | 1 | A |
| Example 139 | A142-9 | 15.2 | G1-3 | 3.7 | 0.05 | 1 | 0.05 | 80 | −5 | 1 | A |
| Example 140 | A142-10 | 15.2 | G1-3 | 3.7 | 0.05 | 1 | 0.05 | 80 | −5 | 0 | A |
| Example 141 | A142-11 | 15.2 | G1-3 | 3.7 | 0.05 | 1 | 0.05 | 80 | −5 | 0 | A |
| Example 142 | A142-12 | 15.2 | G1-3 | 3.7 | 0.05 | 1 | 0.05 | 80 | −5 | 0 | A |
| Example 143 | A142-13 | 15.2 | G1-3 | 3.7 | 0.05 | 1 | 0.05 | 80 | −5 | 0 | A |
| Example 144 | A142-14 | 15.2 | G1-3 | 3.7 | 0.05 | 1 | 0.05 | 80 | −5 | 0 | A |
| Example 145 | A142-15 | 15.2 | G1-3 | 3.7 | 0.05 | 1 | 0.05 | 80 | −5 | 0 | A |
| Example 146 | A143-1 | 15.2 | G1-3 | 3.7 | 0.05 | 1 | 0.05 | 80 | −5 | 0 | A |
| Example 147 | A143-2 | 15.2 | G1-3 | 3.7 | 0.05 | 1 | 0.05 | 80 | −5 | 0 | A |
| Example 148 | A144-1 | 15.2 | G1-3 | 3.7 | 0.05 | 1 | 0.05 | 80 | 0 | 0 | A |

TABLE 8

| | | | | | Others | | | | | | | |
|---|---|---|---|---|---|---|---|---|---|---|---|---|
| | | | | | | | | Cyclo- | Evaluation | | | |
| | General Formula (I) | | General Formula (II) | | MEHQ | Irgacure | Liquid | pentanone | Storage | Tilt | Glance | Glance |
| | Compound | (%) | Compound | (%) | (%) | 907 (%) | paraffin (%) | (%) | stability (° C) | (degree) | Front | 45° |
| Example 149 | A11-1 | 15.2 | G3-5 | 3.7 | 0.05 | 1 | 0.02 | 80 | 30 | 65 | A | B |
| Example 150 | A11-1 | 15.2 | G4-3 | 3.7 | 0.05 | 1 | 0.02 | 80 | 30 | 60 | A | B |
| Example 151 | A11-1 | 15.2 | G1-6 | 3.7 | 0.05 | 1 | 0.02 | 80 | 30 | 3 | B | D |
| Example 152 | A11-1 | 15.2 | G3-4 | 3.7 | 0.05 | 1 | 0.02 | 80 | 30 | 9 | C | D |
| Example 153 | A11-2 | 15.2 | G3-5 | 3.7 | 0.05 | 1 | 0.02 | 80 | 30 | 60 | A | B |
| Example 154 | A11-2 | 15.2 | G3-2 | 3.7 | 0.05 | 1 | 0.02 | 80 | 30 | 55 | A | B |
| Example 155 | A11-2 | 15.2 | G1-2 | 3.7 | 0.05 | 1 | 0.02 | 80 | 30 | 3 | A | C |
| Example 156 | A11-3 | 15.2 | G4-3 | 3.7 | 0.05 | 1 | 0.02 | 80 | 30 | 65 | A | B |
| Example 157 | A11-3 | 15.2 | G1-6 | 3.7 | 0.05 | 1 | 0.02 | 80 | 30 | 4 | B | D |
| Example 158 | A11-3 | 15.2 | G3-4 | 3.7 | 0.05 | 1 | 0.02 | 80 | 30 | 8 | C | D |
| Example 159 | A12-1 | 15.2 | G3-5 | 3.7 | 0.05 | 1 | 0.02 | 80 | 30 | 60 | A | B |
| Example 160 | A12-1 | 15.2 | G4-3 | 3.7 | 0.05 | 1 | 0.02 | 80 | 30 | 60 | A | B |
| Example 161 | A12-1 | 15.2 | G1-6 | 3.7 | 0.05 | 1 | 0.02 | 80 | 30 | 2 | A | C |
| Example 162 | A12-1 | 15.2 | G3-4 | 3.7 | 0.05 | 1 | 0.02 | 80 | 30 | 9 | C | D |
| Example 163 | A12-2 | 15.2 | G3-5 | 3.7 | 0.05 | 1 | 0.02 | 80 | 30 | 60 | A | B |
| Example 164 | A12-2 | 15.2 | G1-2 | 3.7 | 0.05 | 1 | 0.02 | 80 | 30 | 2 | A | C |
| Example 165 | A12-3 | 15.2 | G3-5 | 3.7 | 0.05 | 1 | 0.02 | 80 | 30 | 65 | A | B |
| Example 166 | A12-3 | 15.2 | G4-3 | 3.7 | 0.05 | 1 | 0.02 | 80 | 30 | 60 | A | B |
| Example 167 | A12-3 | 15.2 | G1-6 | 3.7 | 0.05 | 1 | 0.02 | 80 | 30 | 2 | A | C |
| Example 168 | A12-16 | 15.2 | G3-5 | 3.7 | 0.05 | 1 | 0.02 | 80 | 20 | 60 | A | B |

TABLE 9

| | | | | | Others | | | | | | | |
|---|---|---|---|---|---|---|---|---|---|---|---|---|
| | | | | | | | | Cyclo- | Evaluation | | | |
| | General Formula (I) | | General Formula (II) | | MEHQ | Irgacure | Liquid | pentanone | Storage | Tilt | Glance | Glance |
| | Compound | (%) | Compound | (%) | (%) | 907 (%) | paraffin (%) | (%) | stability (° C) | (degree) | Front | 45° |
| Example 169 | A12-16 | 15.2 | G4-3 | 3.7 | 0.05 | 1 | 0.02 | 80 | 20 | 55 | A | B |
| Example 170 | A12-16 | 15.2 | G1-6 | 3.7 | 0.05 | 1 | 0.02 | 80 | 20 | 4 | A | C |
| Example 171 | A12-16 | 15.2 | G3-4 | 3.7 | 0.05 | 1 | 0.02 | 80 | 20 | 8 | C | D |
| Example 172 | A12-17 | 15.2 | G3-5 | 3.7 | 0.05 | 1 | 0.02 | 80 | 20 | 65 | A | B |
| Example 173 | A12-17 | 15.2 | G3-2 | 3.7 | 0.05 | 1 | 0.02 | 80 | 20 | 60 | A | B |
| Example 174 | A12-17 | 15.2 | G1-2 | 3.7 | 0.05 | 1 | 0.02 | 80 | 20 | 2 | A | C |
| Example 175 | A12-18 | 15.2 | G3-5 | 3.7 | 0.05 | 1 | 0.02 | 80 | 10 | 65 | A | B |
| Example 176 | A12-18 | 15.2 | G4-3 | 3.7 | 0.05 | 1 | 0.02 | 80 | 10 | 60 | A | B |
| Example 177 | A12-18 | 15.2 | G1-6 | 3.7 | 0.05 | 1 | 0.02 | 80 | 10 | 3 | A | C |
| Example 178 | A13-1 | 15.2 | G3-5 | 3.7 | 0.05 | 1 | 0.02 | 80 | 25 | 60 | A | B |
| Example 179 | A13-1 | 15.2 | G1-6 | 3.7 | 0.05 | 1 | 0.02 | 80 | 25 | 1 | A | C |
| Example 180 | A13-1 | 15.2 | G3-4 | 3.7 | 0.05 | 1 | 0.02 | 80 | 25 | 8 | C | D |
| Example 181 | A13-2 | 15.2 | G3-5 | 3.7 | 0.05 | 1 | 0.02 | 80 | 25 | 60 | A | B |
| Example 182 | A13-2 | 15.2 | G4-3 | 3.7 | 0.05 | 1 | 0.02 | 80 | 25 | 55 | A | B |
| Example 183 | A13-2 | 15.2 | G1-2 | 3.7 | 0.05 | 1 | 0.02 | 80 | 25 | 2 | A | C |
| Example 184 | A13-3 | 15.2 | G3-5 | 3.7 | 0.05 | 1 | 0.02 | 80 | 25 | 60 | A | B |
| Example 185 | A13-3 | 15.2 | G1-6 | 3.7 | 0.05 | 1 | 0.02 | 80 | 25 | 1 | B | D |
| Example 186 | A141-22 | 15.2 | G3-5 | 3.7 | 0.05 | 1 | 0.02 | 80 | 10 | 70 | A | A |
| Example 187 | A141-22 | 15.2 | G4-3 | 3.7 | 0.05 | 1 | 0.02 | 80 | 10 | 65 | A | A |
| Example 188 | A141-22 | 15.2 | G1-6 | 3.7 | 0.05 | 1 | 0.02 | 80 | 10 | 1 | A | C |

TABLE 10

| | | | | | Others | | | | | | | |
|---|---|---|---|---|---|---|---|---|---|---|---|---|
| | | | | | | | | Cyclo- | Evaluation | | | |
| | General Formula (I) | | General Formula (II) | | MEHQ | Irgacure | Liquid | pentanone | Storage | Tilt | Glance | Glance |
| | Compound | (%) | Compound | (%) | (%) | 907 (%) | paraffin (%) | (%) | stability (° C) | (degree) | Front | 45° |
| Example 189 | A141-22 | 15.2 | G3-4 | 3.7 | 0.05 | 1 | 0.02 | 80 | 10 | 5 | C | D |
| Example 190 | A141-23 | 15.2 | G3-5 | 3.7 | 0.05 | 1 | 0.02 | 80 | 10 | 70 | A | A |
| Example 191 | A141-23 | 15.2 | G3-2 | 3.7 | 0.05 | 1 | 0.02 | 80 | 10 | 65 | A | A |
| Example 192 | A141-23 | 15.2 | G1-6 | 3.7 | 0.05 | 1 | 0.02 | 80 | 10 | 2 | A | C |
| Example 193 | A141-24 | 15.2 | G3-5 | 3.7 | 0.05 | 1 | 0.02 | 80 | 10 | 65 | A | A |
| Example 194 | A141-24 | 15.2 | G4-3 | 3.7 | 0.05 | 1 | 0.02 | 80 | 10 | 65 | A | A |
| Example 195 | A141-24 | 15.2 | G1-2 | 3.7 | 0.05 | 1 | 0.02 | 80 | 10 | 3 | A | C |
| Example 196 | A141-24 | 15.2 | G3-4 | 3.7 | 0.05 | 1 | 0.02 | 80 | 10 | 5 | C | D |
| Example 197 | A141-25 | 15.2 | G3-5 | 3.7 | 0.05 | 1 | 0.02 | 80 | 10 | 65 | A | A |
| Example 198 | A141-25 | 15.2 | G3-2 | 3.7 | 0.05 | 1 | 0.02 | 80 | 10 | 65 | A | A |
| Example 199 | A141-25 | 15.2 | G1-6 | 3.7 | 0.05 | 1 | 0.02 | 80 | 10 | 1 | A | C |
| Example 200 | A141-26 | 15.2 | G3-5 | 3.7 | 0.05 | 1 | 0.02 | 80 | 10 | 65 | A | A |
| Example 201 | A141-26 | 15.2 | G4-3 | 3.7 | 0.05 | 1 | 0.02 | 80 | 10 | 65 | A | A |
| Example 202 | A141-26 | 15.2 | G1-6 | 3.7 | 0.05 | 1 | 0.02 | 80 | 10 | 4 | A | C |
| Example 203 | A141-27 | 15.2 | G3-5 | 3.7 | 0.05 | 1 | 0.02 | 80 | 10 | 65 | A | A |
| Example 204 | A141-27 | 15.2 | G3-2 | 3.7 | 0.05 | 1 | 0.02 | 80 | 10 | 65 | A | A |
| Example 205 | A141-27 | 15.2 | G1-2 | 3.7 | 0.05 | 1 | 0.02 | 80 | 10 | 2 | A | C |
| Example 206 | A141-28 | 15.2 | G3-5 | 3.7 | 0.05 | 1 | 0.02 | 80 | 10 | 65 | A | A |
| Example 207 | A141-28 | 15.2 | G4-3 | 3.7 | 0.05 | 1 | 0.02 | 80 | 10 | 65 | A | A |
| Example 208 | A141-28 | 15.2 | G1-6 | 3.7 | 0.05 | 1 | 0.02 | 80 | 10 | 3 | A | C |

TABLE 11

| | | | | | Others | | | | | | | |
|---|---|---|---|---|---|---|---|---|---|---|---|---|
| | | | | | | | | Cyclo- | Evaluation | | | |
| | General Formula (I) | | General Formula (II) | | MEHQ | Irgacure | Liquid | pentanone | Storage | Tilt | Glance | Glance |
| | Compound | (%) | Compound | (%) | (%) | 907 (%) | paraffin (%) | (%) | stability (° C) | (degree) | Front | 45° |
| Example 209 | A141-29 | 15.2 | G3-5 | 3.7 | 0.05 | 1 | 0.02 | 80 | 10 | 70 | A | A |
| Example 210 | A141-29 | 15.2 | G4-3 | 3.7 | 0.05 | 1 | 0.02 | 80 | 10 | 70 | A | A |
| Example 211 | A141-29 | 15.2 | G1-6 | 3.7 | 0.05 | 1 | 0.02 | 80 | 10 | 1 | A | C |
| Example 212 | A141-30 | 15.2 | G3-5 | 3.7 | 0.05 | 1 | 0.02 | 80 | 10 | 70 | A | A |
| Example 213 | A141-30 | 15.2 | G3-2 | 3.7 | 0.05 | 1 | 0.02 | 80 | 10 | 65 | A | A |
| Example 214 | A141-30 | 15.2 | G1-2 | 3.7 | 0.05 | 1 | 0.02 | 80 | 10 | 2 | A | C |
| Example 215 | A141-31 | 15.2 | G3-5 | 3.7 | 0.05 | 1 | 0.02 | 80 | 10 | 70 | A | A |
| Example 216 | A141-31 | 15.2 | G4-3 | 3.7 | 0.05 | 1 | 0.02 | 80 | 10 | 65 | A | A |
| Example 217 | A141-31 | 15.2 | G1-6 | 3.7 | 0.05 | 1 | 0.02 | 80 | 10 | 1 | A | C |
| Example 218 | A141-32 | 15.2 | G3-5 | 3.7 | 0.05 | 1 | 0.02 | 80 | 10 | 70 | A | A |
| Example 219 | A141-32 | 15.2 | G4-3 | 3.7 | 0.05 | 1 | 0.02 | 80 | 10 | 70 | A | A |
| Example 220 | A141-32 | 15.2 | G1-2 | 3.7 | 0.05 | 1 | 0.02 | 80 | 10 | 2 | A | C |
| Example 221 | A141-33 | 15.2 | G3-5 | 3.7 | 0.05 | 1 | 0.02 | 80 | 10 | 70 | A | A |
| Example 222 | A141-33 | 15.2 | G3-2 | 3.7 | 0.05 | 1 | 0.02 | 80 | 10 | 65 | A | A |
| Example 223 | A141-33 | 15.2 | G1-6 | 3.7 | 0.05 | 1 | 0.02 | 80 | 10 | 1 | A | C |
| Example 224 | A141-33 | 15.2 | G3-4 | 3.7 | 0.05 | 1 | 0.02 | 80 | 10 | 4 | C | D |
| Example 225 | A142-10 | 15.2 | G3-5 | 3.7 | 0.05 | 1 | 0.02 | 80 | 5 | 70 | A | A |
| Example 226 | A142-10 | 15.2 | G3-2 | 3.7 | 0.05 | 1 | 0.02 | 80 | 5 | 65 | A | A |
| Example 227 | A142-10 | 15.2 | G1-2 | 3.7 | 0.05 | 1 | 0.02 | 80 | 5 | 3 | A | C |
| Example 228 | A142-10 | 15.2 | G3-4 | 3.7 | 0.05 | 1 | 0.02 | 80 | 5 | 6 | C | D |

TABLE 12

| | | | | | Others | | | | | | | |
|---|---|---|---|---|---|---|---|---|---|---|---|---|
| | | | | | | | | Cyclo- | Evaluation | | | |
| | General Formula (I) | | General Formula (II) | | MEHQ | Irgacure | Liquid | pentanone | Storage | Tilt | Glance | Glance |
| | Compound | (%) | Compound | (%) | (%) | 907 (%) | paraffin (%) | (%) | stability (° C) | (degree) | Front | 45° |
| Example 229 | A142-11 | 15.2 | G3-5 | 3.7 | 0.05 | 1 | 0.02 | 80 | 5 | 70 | A | A |
| Example 230 | A142-11 | 15.2 | G4-3 | 3.7 | 0.05 | 1 | 0.02 | 80 | 5 | 65 | A | A |
| Example 231 | A142-11 | 15.2 | G1-6 | 3.7 | 0.05 | 1 | 0.02 | 80 | 5 | 1 | A | C |
| Example 232 | A142-12 | 15.2 | G3-5 | 3.7 | 0.05 | 1 | 0.02 | 80 | 5 | 65 | A | A |
| Example 233 | A142-12 | 15.2 | G4-3 | 3.7 | 0.05 | 1 | 0.02 | 80 | 5 | 65 | A | A |
| Example 234 | A142-12 | 15.2 | G1-2 | 3.7 | 0.05 | 1 | 0.02 | 80 | 5 | 1 | A | C |
| Example 235 | A142-13 | 15.2 | G3-5 | 3.7 | 0.05 | 1 | 0.02 | 80 | 5 | 70 | A | A |
| Example 236 | A142-13 | 15.2 | G3-2 | 3.7 | 0.05 | 1 | 0.02 | 80 | 5 | 65 | A | A |
| Example 237 | A142-13 | 15.2 | G1-6 | 3.7 | 0.05 | 1 | 0.02 | 80 | 5 | 2 | A | C |
| Example 238 | A142-13 | 15.2 | G3-4 | 3.7 | 0.05 | 1 | 0.02 | 80 | 5 | 6 | C | D |
| Example 239 | A142-14 | 15.2 | G3-5 | 3.7 | 0.05 | 1 | 0.02 | 80 | 0 | 70 | A | A |
| Example 240 | A142-14 | 15.2 | G4-3 | 3.7 | 0.05 | 1 | 0.02 | 80 | 0 | 70 | A | A |
| Example 241 | A142-14 | 15.2 | G1-6 | 3.7 | 0.05 | 1 | 0.02 | 80 | 0 | 2 | A | C |
| Example 242 | A142-14 | 15.2 | G3-4 | 3.7 | 0.05 | 1 | 0.02 | 80 | 0 | 5 | C | D |
| Example 243 | A142-15 | 15.2 | G3-5 | 3.7 | 0.05 | 1 | 0.02 | 80 | 0 | 70 | A | A |
| Example 244 | A142-15 | 15.2 | G3-2 | 3.7 | 0.05 | 1 | 0.02 | 80 | 0 | 65 | A | A |
| Example 245 | A142-15 | 15.2 | G1-2 | 3.7 | 0.05 | 1 | 0.02 | 80 | 0 | 1 | A | C |
| Example 246 | A143-1 | 15.2 | G3-5 | 3.7 | 0.05 | 1 | 0.02 | 80 | 0 | 70 | A | A |
| Example 247 | A143-1 | 15.2 | G4-3 | 3.7 | 0.05 | 1 | 0.02 | 80 | 0 | 70 | A | A |
| Example 248 | A143-1 | 15.2 | G1-6 | 3.7 | 0.05 | 1 | 0.02 | 80 | 0 | 2 | A | C |

TABLE 13

| | | | | | Others | | | | | | | |
|---|---|---|---|---|---|---|---|---|---|---|---|---|
| | | | | | | | | Cyclo- | Evaluation | | | |
| | General Formula (I) | | General Formula (II) | | MEHQ | Irgacure | Liquid | pentanone | Storage | Tilt | Glance | Glance |
| | Compound | (%) | Compound | (%) | (%) | 907 (%) | paraffin (%) | (%) | stability (° C) | (degree) | Front | 45° |
| Example 249 | A143-1 | 15.2 | G3-4 | 3.7 | 0.05 | 1 | 0.02 | 80 | 0 | 5 | C | D |
| Example 250 | A143-2 | 15.2 | G3-5 | 3.7 | 0.05 | 1 | 0.02 | 80 | 0 | 70 | A | A |
| Example 251 | A143-2 | 15.2 | G3-2 | 3.7 | 0.05 | 1 | 0.02 | 80 | 0 | 65 | A | A |
| Example 252 | A143-2 | 15.2 | G1-2 | 3.7 | 0.05 | 1 | 0.02 | 80 | 0 | 1 | A | C |
| Example 253 | A143-2 | 15.2 | G3-4 | 3.7 | 0.05 | 1 | 0.02 | 80 | 0 | 5 | C | D |
| Comparative | G1-3 | 9.4 | G2-1 | 9.5 | 0.05 | 1 | 0.02 | 80 | 25 | 2 | E | E |
| Example 5 | | | | | | | | | | | | |
| Comparative | G1-5 | 15 | G2-1 | 3.9 | 0.05 | 1 | 0.02 | 80 | 20 | 2 | E | E |
| Example 6 | | | | | | | | | | | | |
| Comparative | G1-6 | 15.2 | G3-5 | 3.7 | 0.05 | 1 | 0.02 | 80 | 0 | 70 | E | E |
| Example 7 | | | | | | | | | | | | |
| Comparative | G2-3 | 15.2 | G4-3 | 3.7 | 0.05 | 1 | 0.02 | 80 | 15 | 60 | E | E |
| Example 8 | | | | | | | | | | | | |

From the results described above, it is found that the compositions of the examples have excellent glance, compared to the compositions of the comparative examples.

1. A polymerizable composition comprising:
(a) a reverse dispersible compound represented by General Formula (I): 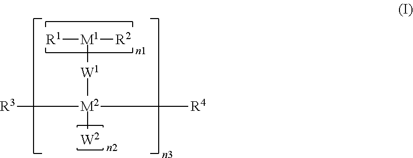
wherein R¹, R², R³, and R⁴ each independently represent a hydrogen atom or a hydrocarbon group having 1 to 80 carbon atoms, which may have a substituent, one or more of arbitrary carbon atoms may be substituted with a hetero atom,
W¹ and W² each independently represent a single bond or a group including a conjugated system including 2 to 100 n electrons,
M¹ and M² each independently represent a group including a mesogenic group,
n1 and n2 each independently represent 0 or 1, provided that when n1 or n2 is 0, the corresponding group a hydrogen atom is present, n3 represents an integer of 1 to 1,000,
W¹, W², M¹, and M² may each independently include a substituent L,
L represents a fluorine atom, a chlorine atom, a bromine atom, an iodine atom, a pentafluorosulfuranyl group, a nitro group, a cyano group, an isocyano group, an amino group, a hydroxyl group, a mercapto group, a methylamino group, a dimethylamino group, a diethylamino group, a diisopropylamino group, a trimethylsilyl group, a dimethylsilyl group, a thioisocyano group, or a linear or branched alkyl group having 1 to 20 carbon atoms in which one —CH₂— or two or more of (—CH₂—)'s that are not adjacent to each other may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, and one or more of arbitrary hydrogen atoms in the alkyl group may be substituted with a fluorine atom, or
L may represent a group represented by P^{L}—(S^{L}—X^{L})_{kL}— where P^{L} represents a polymerizable group, S^{L} represents a spacer group or a single bond, in a case where a plurality of S^{L} is present, these may be the same as each other or different from each other, X^{L} represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, in a case where a plurality of X^{L} is present, these may be the same as each other or different from each other, provided that P^{L}—(S^{L}—X^{L})_{kL}— does not include a —O—O— bond, in a case where a plurality of L is present in the compound, these may be the same as each other or different from each other, kL represents an integer of 0 to 10,
M¹-W¹, W¹-M², and/or M²-W² may each independently form a conjugated system;
(b) a compound represented by General Formula (II): 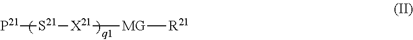
wherein P²¹ represents a polymerizable functional group, S²¹ represents an alkylene group having 0 to 18 carbon atoms (one or more of hydrogen atoms in the alkylene group may be substituted with one or more of halogen atoms or CN, and one CH₂ group or two or more of (—CH₂—)'s that are not adjacent to each other present in this group may be each mutually independently substituted with —O—, —COO—, —OCO—, or —OCO—O—), X²¹ represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond (provided that P²¹—S²¹ and S²¹—X²¹ do not include a —O—O—, —O—NH—, or —O—S— group), q¹ represents 0 or 1, MG represents a mesogenic group, and R²¹ represents a hydrogen atom, a halogen atom, a cyano group, or a linear or a branched alkyl group having 1 to 12 carbon atoms, in which one —CH₂— or two or more of (—CH₂—)'s that are not adjacent to each other may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, or a General Formula (II-a):
—(X²²—S²²)_{q2}—P²³ (II-a)
wherein P²³ represents a reactive functional group, S²² represents a component which is the same as that defined in the description regarding S²¹, X²² represents a component which is the same as that defined in the description regarding X²¹ (provided that P²—S²² and S²²—X²² do not include a —O—O—, —O—NH—, or —O—S— group), and q² represents 0 or 1);
(c) an initiator, if necessary- and
(d) a solvent, if necessary.

2. The polymerizable composition according to claim 1,
wherein, in General Formula (I), R¹ being present and at least one of R², R³, and R⁴ being present represent a group including a polymerizable group.

3. The polymerizable composition according to claim 1,
wherein, in General Formula (I), R¹ being present and at least one of R², R³, and R⁴ being present represent a group represented by General Formula (I-R): 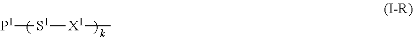
wherein P¹ represents a polymerizable group, S¹ represents a spacer group or a single bond, in a case where a plurality of S¹ is present, these may be the same as each other or different from each other, X¹ represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, in a case where a plurality of X¹ is present in the compound, these may be the same as each other or different from each other, (provided that P¹—(S¹—X¹)ₖ— does not include a —O—O— bond, and k represents an integer of 0 to 10.

4. The polymerizable composition according to claim 3,
wherein, in Formula (I-R), P¹ represents a group selected from Formula (P-1) to Formula (P-20):

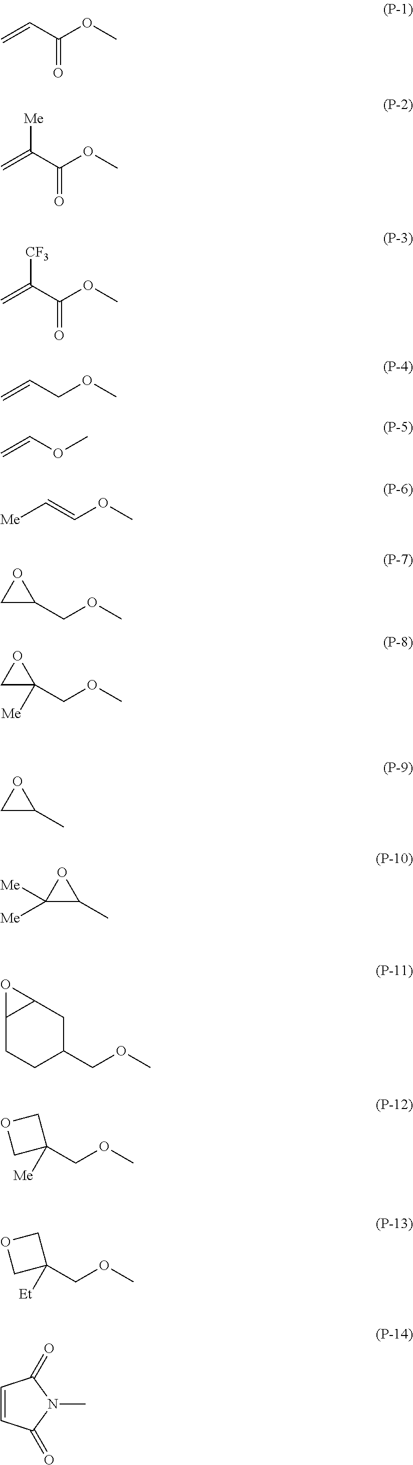

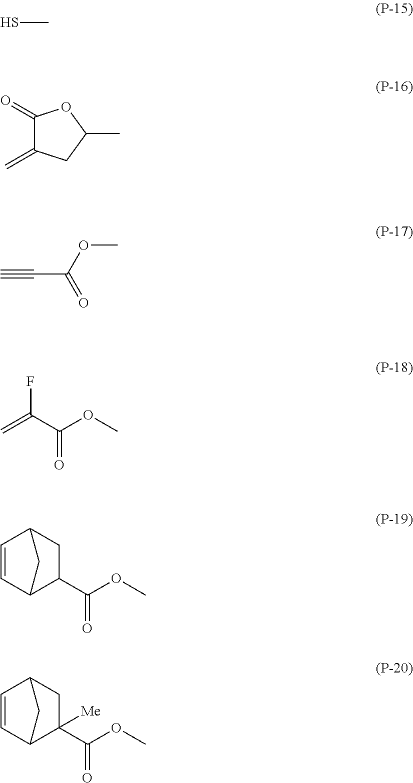

5. The polymerizable composition according to claim 3,
wherein, in Formula (I-R), S¹'s each independently represent an alkylene group having 1 to 20 carbon atoms in which one —CH₂— or two or more of (—CH₂—)'s that are not adjacent to each other may be each independently substituted with —O—, —COO—, —OCO—, —OCO—O—, —CO—NH—, —NH—CO—, —CH═CH—, or —C≡C—.

6. The polymerizable composition according to claim 1,
wherein, in General Formula (I), W¹ represents General Formula (I-W1) and W² represents General Formula (I-W2): 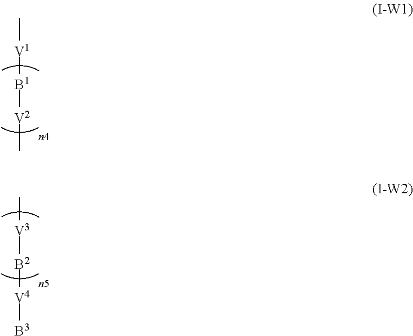
wherein V¹, V², V³, and V⁴ each independently represent a single bond or a divalent linking group, B¹, B², and B³ each independently represent a single bond or an aromatic and/or nonaromatic hydrocarbon ring having 5 to 80 carbon atoms which may be substituted, one or more of arbitrary carbon atoms of the carbon ring or the hydrocarbon ring may be substituted with a hetero atom, these groups may be unsubstituted or substituted with one or more of L, in a case where B³ represents a single bond, a hydrogen atom or a group represented by the substituent L is bonded thereto, n4 and n5 each are an integer of 0 to 10, and a linking group linking M¹-V¹, V¹—B¹, B¹—V², V²-M², M²-V³, V³—B², B²—V⁴, and V⁴—B³ being present may be each independently a single bond or a double bond, provided that at least one of the linking group forms a conjugated system.

7. The polymerizable composition according to claim 6,
wherein, B¹ being present and B² and B³ being present each independently represent a group selected from Formula (B-1) to Formula (B-21) or a single bond: 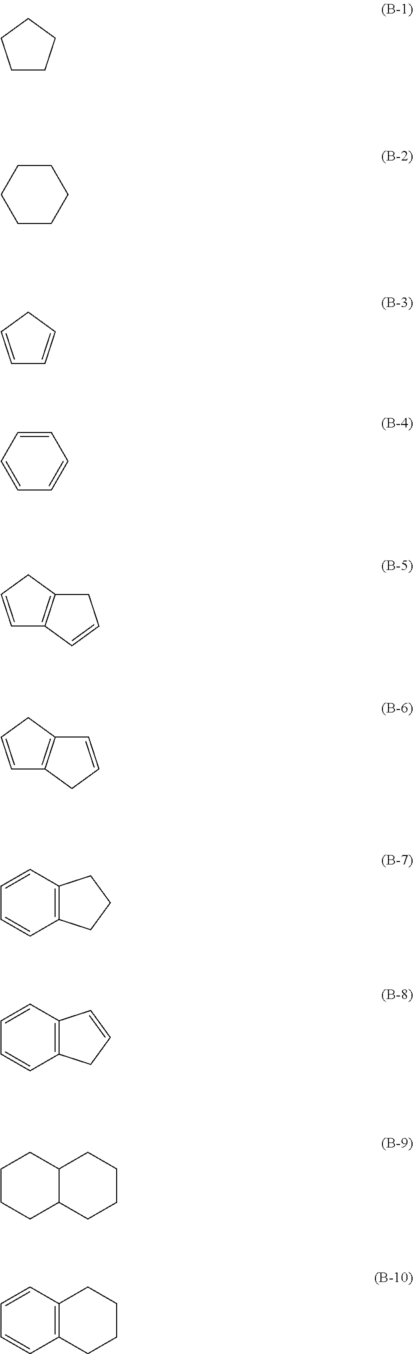 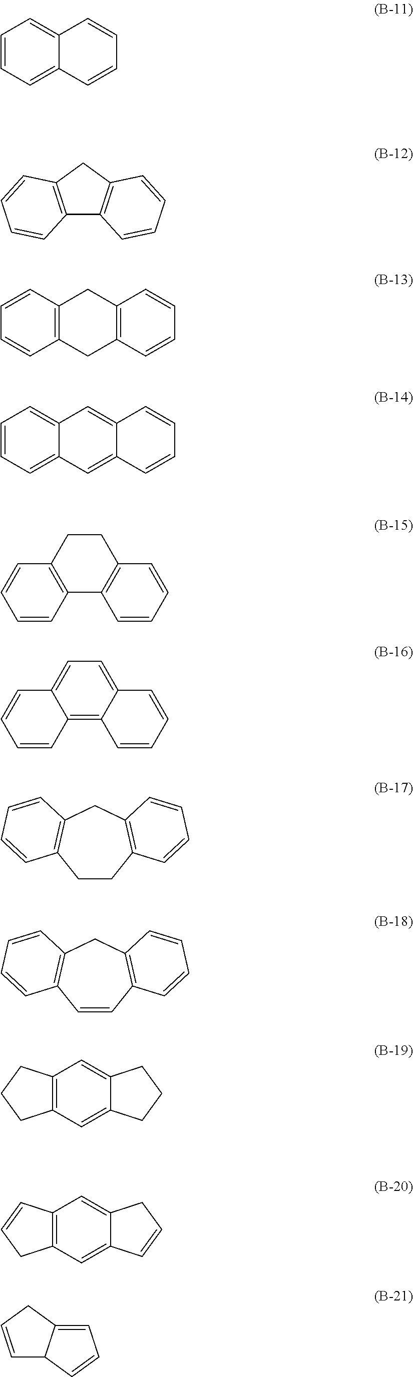
wherein a bonding site may be at an arbitrary position, arbitrary —CH═ may be each independently substituted with —N═, —CH₂— may be each independently substituted with —O—, —S—, —NR⁰— (where R⁰ represents a hydrogen atom or an alkyl group having 1 to 20 carbon atoms), —CS— or —CO—, provided that a —O—O— bond is not included, these groups may be unsubstituted or substituted with one or more of substituents L, and in a case where B³ represents a single bond, a hydrogen atom or a group represented by the substituent L is bonded thereto.

8. The polymerizable composition according to claim 6,
wherein, V¹, V², V³, and V⁴ each independently represent a group selected from Formula (V-1) to Formula (V-15), a single bond, a double bond, —O—, —S—, —OCH₂—, —CH₂O—, —CO—, —CH₂—, —COO—, —OCO—, —CO—S—, —S—CO—, —O—CO—O—, —CO—NH—, —NH—CO—, —CS—NH—, —NH—CS—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —CH₂CH₂—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, and —CH₂—OCO—, and at least one of M¹-V¹, V¹—B¹, B¹—V², V²-M², M²-V³, V³—B², B²—V⁴, and V⁴—B³ present in Formula (I-W1) and Formula (I-W2) forms a conjugated system: 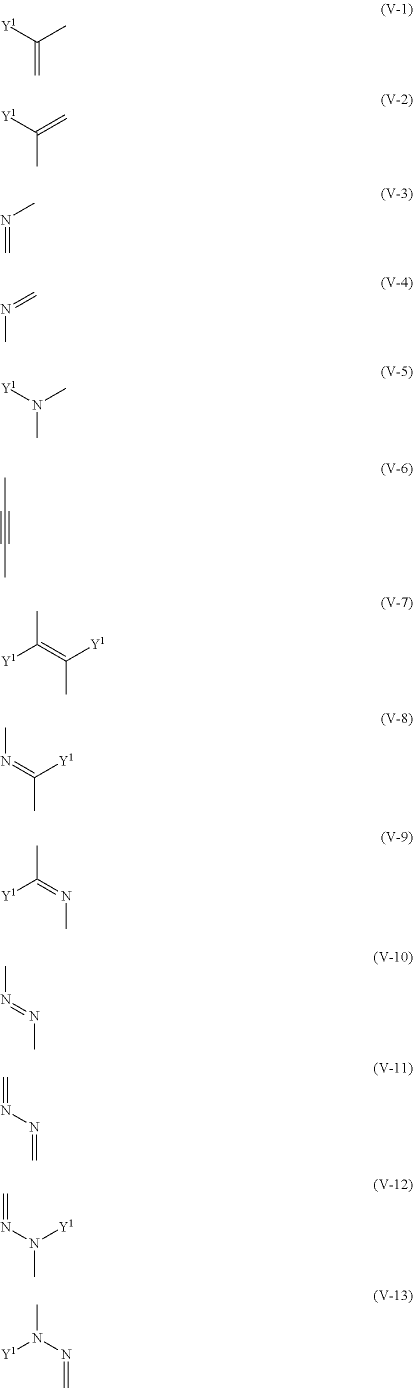 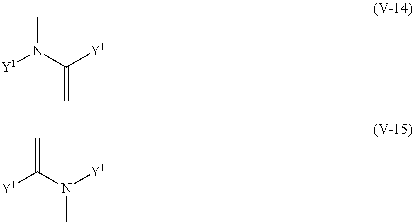
wherein Y¹ represents a hydrogen atom, a fluorine atom, a chlorine atom, a bromine atom, an iodine atom, a pentafluorosulfuranyl group, a nitro group, a cyano group, an isocyano group, an amino group, a hydroxyl group, a mercapto group, a methylamino group, a dimethylamino group, a diethylamino group, a diisopropylamino group, a trimethylsilyl group, a dimethylsilyl group, a thioisocyano group, or a linear or branched alkyl group having 1 to 20 carbon atoms in which one —CH₂— or two or more of (—CH₂—)'s that are not adjacent to each other may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, one or more of arbitrary hydrogen atoms in the alkyl group may be substituted with a fluorine atom, in a case where a plurality of Y¹ is present, these may be the same as each other or different from each other, Y¹ may represent a group represented by P^{Y}—(S^{Y}—X^{Y})— where P^{Y} represents a polymerizable group, S^{Y} represents a spacer group or a single bond, and in a case where a plurality of S^{Y} is present, these may be the same as each other or different from each other, X^{Y} represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, and in a case where a plurality of X is present, these may be the same as each other or different from each other, provided that P^{Y}—(S^{Y}—X^{Y})ⱼ— does not include a —O—O— bond, and j represents an integer of 0 to 10.

9. The polymerizable composition according to claim 1,
wherein, in General Formula (I), M¹ represents a group represented by (I-M1) and M² represents a group represented by (I-M2): 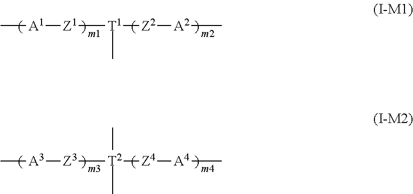
wherein A¹, A², A³, and A⁴ each independently represent a 1,4-phenylene group, a 1,4-cyclohexylene group, a pyridine-2,5-diyl group, a pyrimidine-2,5-diyl group, a naphthalene-2,6-diyl group, a naphthalene-1,4-diyl group, a tetrahydronaphthalene-2,6-diyl group, a decahydronaphthalene-2,6-diyl group, or a 1,3-dioxane-2,5-diyl group, which may be unsubstituted or substituted with one or more of substituents L, and, in a case where a plurality of each of A¹, A², A³, and A⁴ is present, these may be the same as each other or different from each other, Z¹, Z², Z³, and Z⁴ each independently represent —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —OCO—NH—, —NH—COO—, —NH—CO—NH—, —NH—O—, —O—NH—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—, —N═CH—, —CH═N—N═CH—, —CF═CF—, —C≡C—, or a single bond, in a case where a plurality of each of Z¹, Z², Z³, and Z⁴ is present, these may be the same as each other or different from each other. T¹ represents a trivalent group which may be substituted, in a case where n2 is 0, T² represents a trivalent group which may be substituted, in a case where n2 is 1, T² represents a tetravalent group which may be substituted, and m1, m2, m3, and m4 each independently represent an integer of 0 to 5.

10. The polymerizable composition according to claim 9,
wherein, T¹ and T² each independently represent a group selected from Formula (T-1) to Formula (T-22): 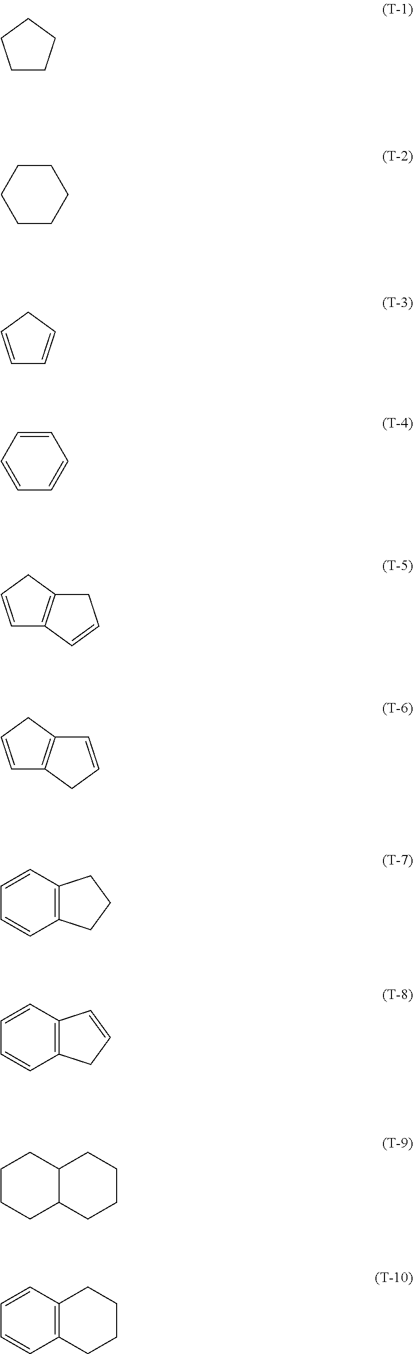 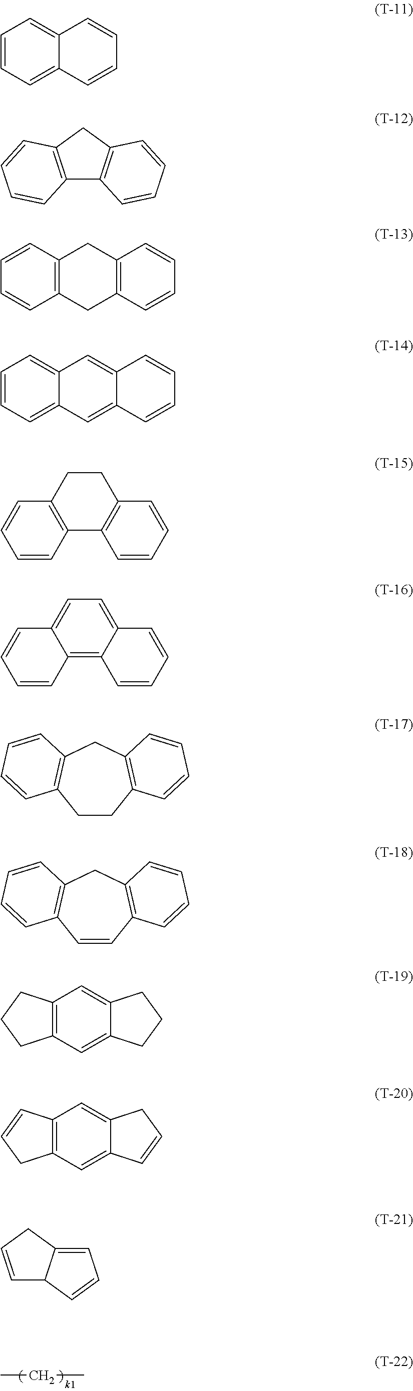
wherein a bonding site may be at an arbitrary position, arbitrary —CH═ may be each independently substituted with —N═, —CH₂— may be each independently substituted with —O—, —S—, —NR⁰— (where R⁰ represents a hydrogen atom or an alkyl group having 1 to 20 carbon atoms), —CS— or —CO—, provided that a —O—O— bond is not included, the above groups may be unsubstituted or substituted with one or more of substituents L, and k1 represents an integer of 1 to 20.

11. The polymerizable composition according to claim 1,
wherein, in General Formula (I), n1 and n2 represent 0 and n3 represents 1.

12. The polymerizable composition according to claim 1,
wherein, in General Formula (I), n1 and n2 represent 0; n3 represents 1; R³ represents a group represented by Formula (I-R): 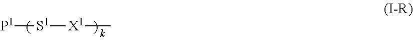
wherein P¹ represents a polymerizable group, S¹ represents a spacer group or a single bond, in a case where a plurality of S¹ is present, these may be the same as each other or different from each other, X¹ represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, in a case where a plurality of X¹ is present, these may be the same as each other or different from each other, provided that P¹—(S¹—X¹)ₖ— does not include a —O—O— bond, k represents an integer of 0 to 10; and R⁴ represents a group selected from the group represented by Formula (I-R) and R⁵ (R⁵ represents a hydrogen atom, a fluorine atom, a chlorine atom, a bromine atom, an iodine atom, a pentafluorosulfuranyl group, a nitro group, a cyano group, an isocyano group, an amino group, a hydroxyl group, a mercapto group, a methylamino group, a dimethylamino group, a diethylamino group, a diisopropylamino group, a trimethylsilyl group, a dimethylsilyl group, a thioisocyano group, or a linear or branched alkyl group having 1 to 20 carbon atoms in which one —CH₂— or two or more of (—CH₂—)'s that are not adjacent to each other may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—S—OCO—CH═CH—, —CH═CH—, —CF═CF—, or —C≡C—, and one or more of arbitrary hydrogen atoms in the alkyl group may be substituted with a fluorine atom).

13. The polymerizable composition according to claim 1,
wherein, in General Formula (I), W¹ represents Formula (I-W11): 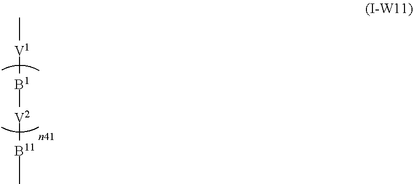
wherein V² and V² each independently represent a single bond or a divalent linking group, B¹ and B¹¹ each independently represent a group selected from Formula (B-1) to Formula (B-21) or a single bond, and n41 represents an integer of 0 to 5: 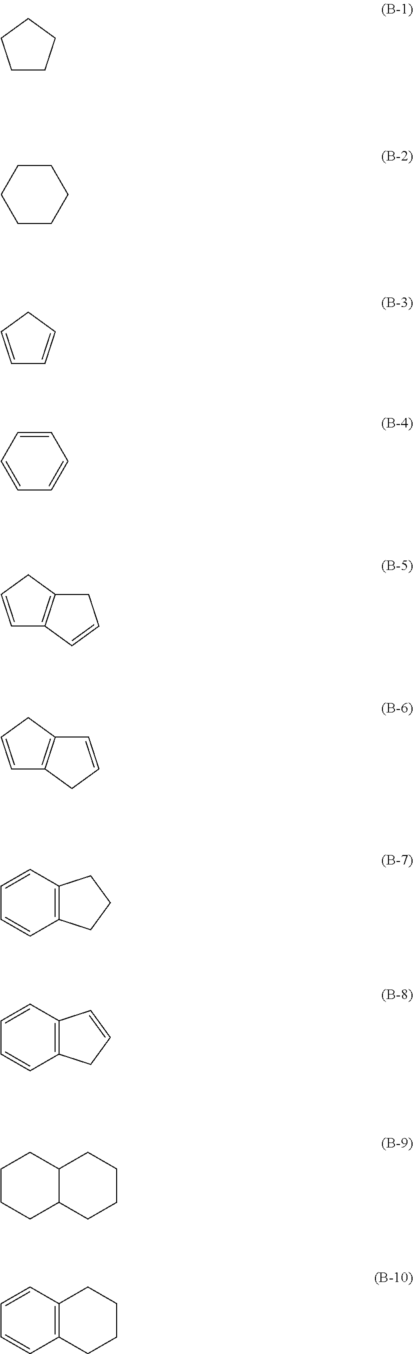 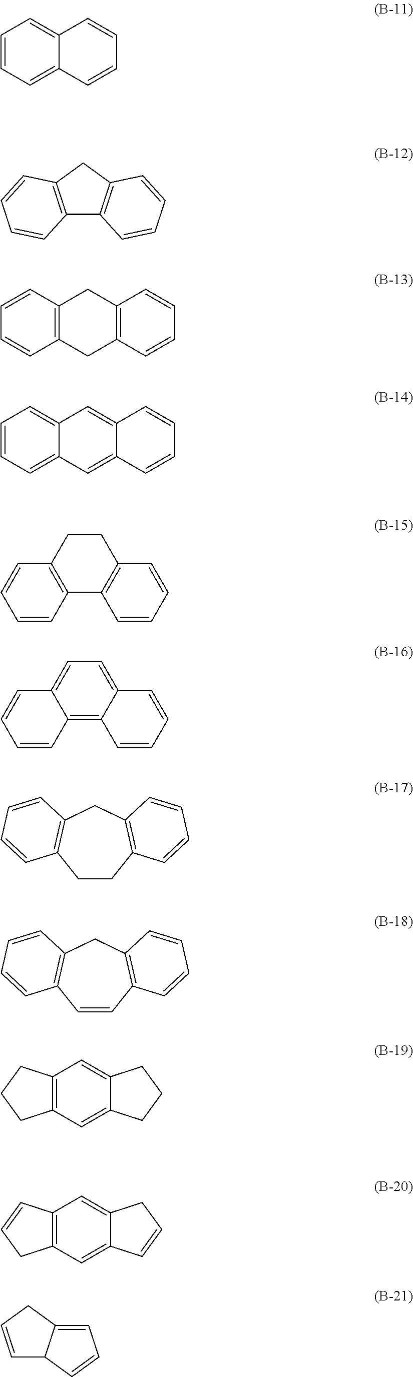
wherein a bonding site may be at an arbitrary position, arbitrary —CH═ may be each independently substituted with —N═, —CH₂— may be each independently substituted with —O—, —S—, —NR⁰— (where R⁰ represents a hydrogen atom or an alkyl group having 1 to 20 carbon atoms), —CS— or —CO—, provided that a —O—O— bond is not included, the above groups may be unsubstituted or substituted with one or more of substituents L.

14. The polymerizable composition according to claim 1,
wherein, in General Formula (I), W¹ represents Formula (I-W12). 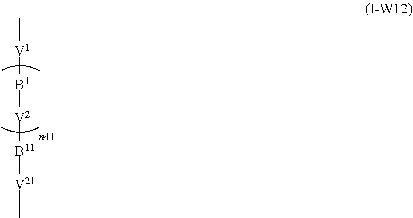
wherein V¹ and V² each independently represent a single bond or a divalent linking group, V²¹ represents —NR⁰—, —CR⁰═, ═CR⁰—, —N═, or ═N— (where R⁰'s each independently represent a hydrogen atom or an alkyl group having 1 to 8 carbon atoms), B¹ and B¹¹ each independently a group selected from Formula (B-1) to Formula (B-21) oe a single bond, and n41 represents an integer of 0 to 5: 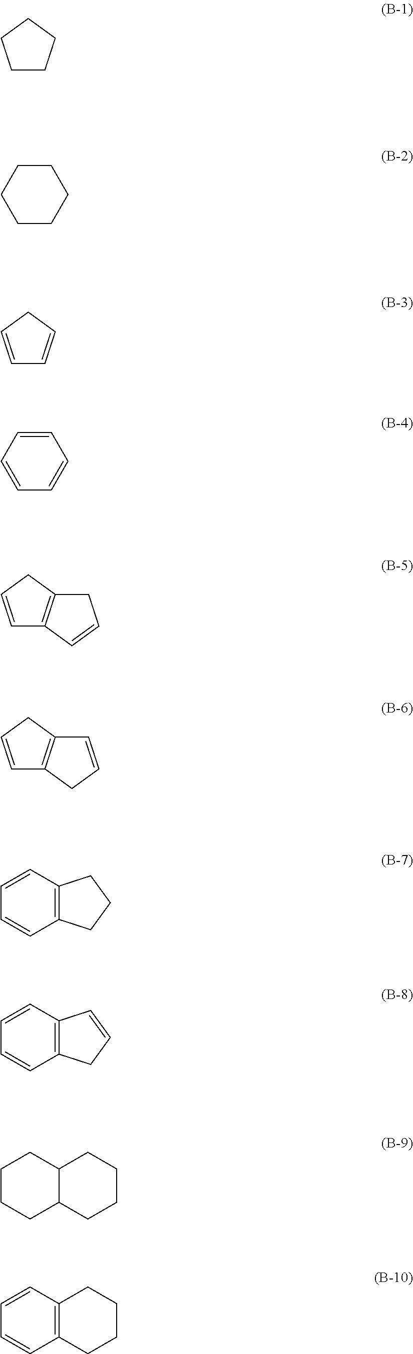 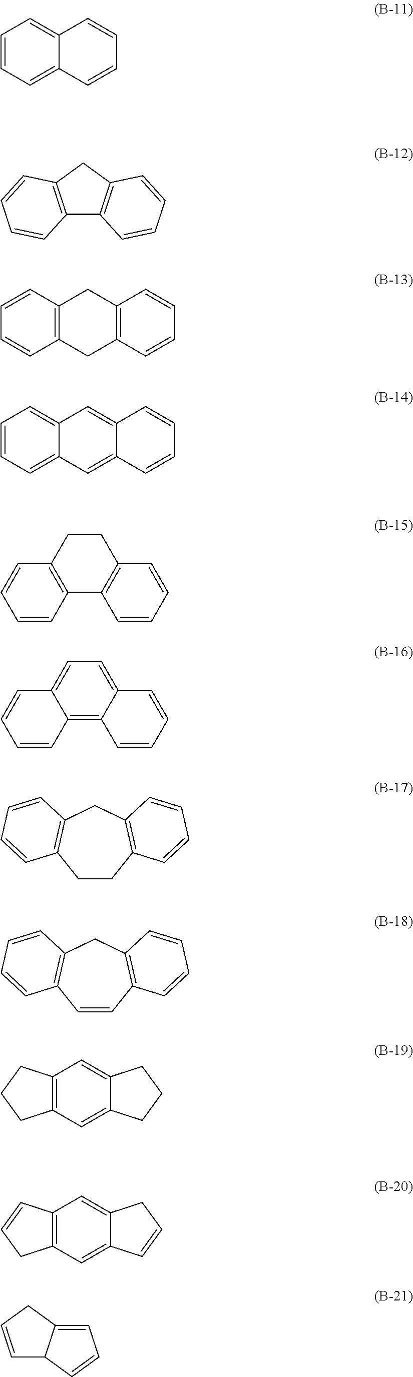
wherein a bonding site may be at an arbitrary position, arbitrary —CH═ may be each independently substituted with —N═, —CH₂— may be each independently substituted with —O—, —S—, —NR⁰— (where R⁰ represents a hydrogen atom or an alkyl group having 1 to 20 carbon atoms), —CS— or —CO—, provided that a —O—O— bond is not included, the above groups may be unsubstituted or substituted with one or more of substituents L.

15. The polymerizable composition according to claim 1,
wherein, in General Formula (I), W¹ represents Formula (I-W13): 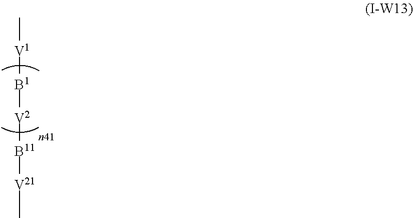
wherein V¹ and V² each independently represent a single bond or a divalent linking group, V²¹ represents —CR⁰═CR⁰—, —C≡C—, —CR⁰═N—, —N═CR⁰—, —NR⁰—CR⁰═, —CR⁰—NR⁰—, —NR⁰—N═, ═N—NR⁰—, —N═N—, or ═N—N═ (in the formulae, R⁰'s each independently represent a hydrogen atom or an alkyl group having 1 to 8 carbon atoms), B¹ and B¹¹ each independently a group selected from Formula (B-1) to Formula (B-21) or a single bond, and n41 represents an integer of 0 to 5: 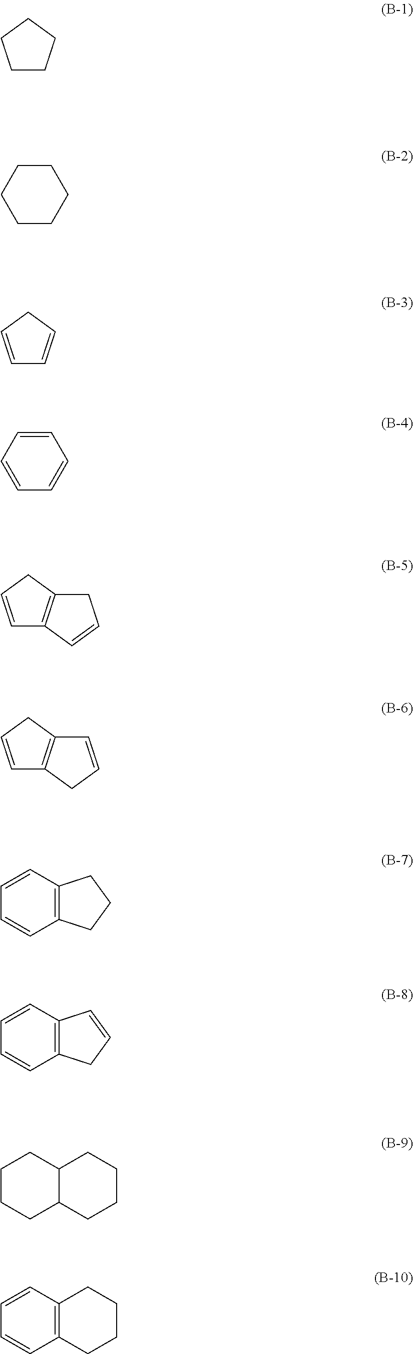 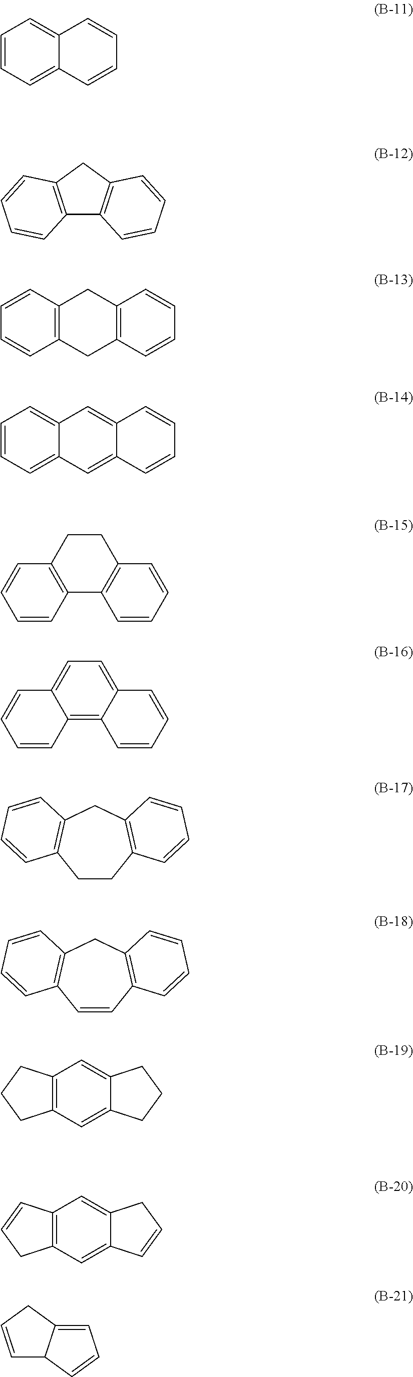
wherein a bonding site may be at an arbitrary position, arbitrary —CH═ may be each independently substituted with —N═, —CH₂— may be each independently substituted with —O—, —S—, —NR⁰— (in the formulae, R⁰ represents a hydrogen atom or an alkyl group having 1 to 20 carbon atoms), —CS— or —CO—, provided that a —O—O— bond is not included, and the above groups may be unsubstituted or substituted with one or more of substituents L.

16. The polymerizable composition according to claim 1,
wherein, in General Formula (I), W¹ represents Formula (I-W14): 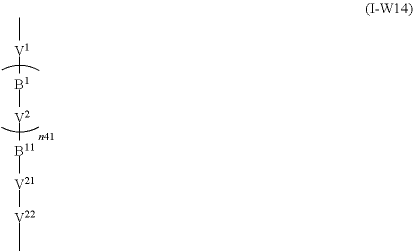
wherein V¹ and V² each independently represent a single bond or a divalent linking group, V²¹ represents —CR⁰═CR⁰—, —C≡C—, —CR⁰═N—, —N═CR⁰—, —NR⁰—CR⁰═, ═CR^{O}—NR⁰—, —NR—N═, ═N—NR⁰—, —N═N—, or ═N—N═, V²² represents —NR⁰—, —CR⁰═, ═CR⁰—, —N═, or ═N— (where R⁰'s each independently represent a hydrogen atom or an alkyl group having 1 to 8 carbon atoms), and B¹ and B¹¹ each independently a group selected from Formula (B-1) to Formula (B-21) or a single bond, and n41 represents an integer of 0 to 5: 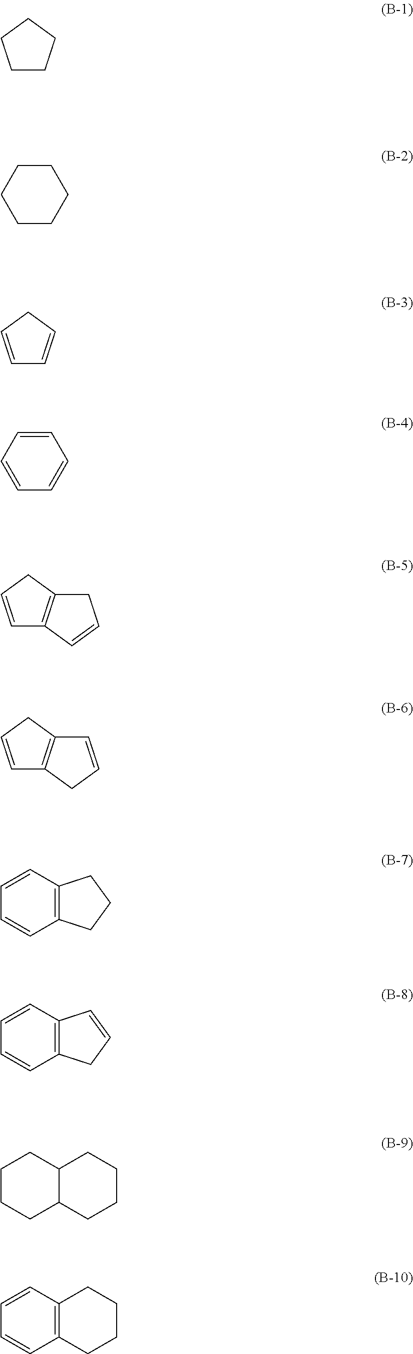 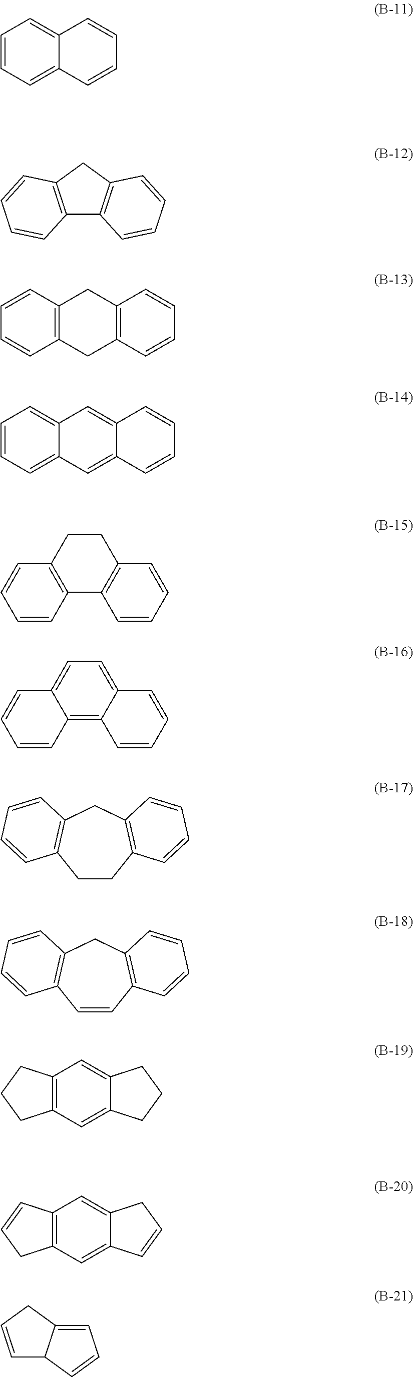
wherein a bonding site may be at an arbitrary position, arbitrary —CH═ may be each independently substituted with —N═, —CH₂— may be each independently substituted with —O—, —S—, —NR⁰— (where R⁰ represents a hydrogen atom or an alkyl group having 1 to 20 carbon atoms), —CS— or —CO—, provided that a —O—O— bond is not included, and the above groups may be unsubstituted or substituted with one or more of substituents L.

17. The polymerizable composition according to claim 1,
wherein, in General Formula (I), n1 and n2 represent 0, n3 represents 1, M² represents a group represented by Formula (I-M21): 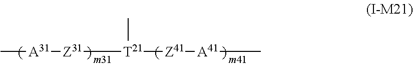
wherein A³¹ and A⁴¹ each independently represent a 1,4-phenylene group, a 1,4-cyclohexylene group, a pyridine-2,5-diyl group, a pyrimidine-2,5-diyl group, a naphthalene-2,6-diyl group, a naphthalene-1,4-diyl group, a tetrahydronaphthalene-2,6-diyl group, a decahydronaphthalene-2,6-diyl group, or a 1,3-dioxane-2,5-diyl group, these groups may be unsubstituted or substituted with one or more of substituents L, and, in a case where a plurality of each of A³¹ and A⁴¹ is present, these may be the same as each other or different from each other, Z³¹ and Z⁴¹ each independently represent —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —OCO—NH—, —NH—COO—, —NH—CO—NH—, —NH—O—, —O—NH—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—, —N═CH—, —CH═N—N═CH—, —CF═CF—, —C≡C—, or a single bond, in a case where a plurality of each of Z³¹ and Z⁴¹ is present, these may be the same as each other or different from each other, m31 and m41 each independently represent an integer of 0 to 5, T²¹ represents a group selected from Formula (T2-1) to Formula (T2-10): 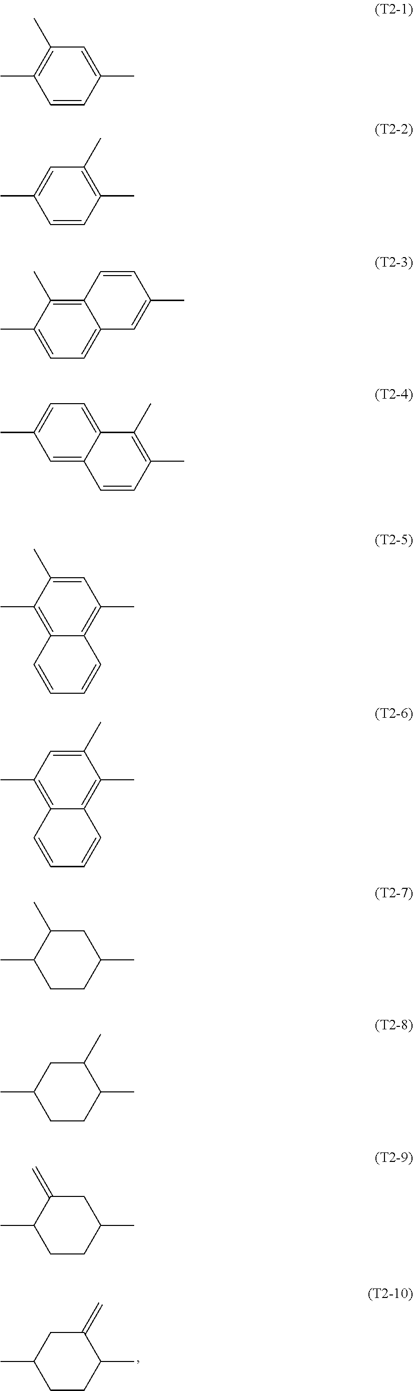
thee above groups may be unsubstituted or substituted with one or more of substituents L, and m31+m41 represents 1 to 6.

18. The compound according to claim 1,
wherein, in General Formula (I), n1 and n2 represent 0, n3 represents 1, M² represents a group represented by Formula (I-M22): 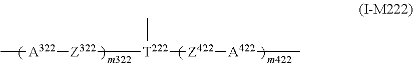
wherein A³² and A⁴² each independently represent a 1,4-phenylene group, a 1,4-cyclohexylene group, a pyridine-2,5-diyl group, a pyrimidine-2,5-diyl group, a naphthalene-2,6-diyl group, a naphthalene-1,4-diyl group, a tetrahydronaphthalene-2,6-diyl group, a decahydronaphthalene-2,6-diyl group, or a 1,3-dioxane-2,5-diyl group, which may be unsubstituted or substituted with one or more of substituents L, in a case where a plurality of each of A³² and A⁴² is present, these may be the same as each other or different from each other, Z³² and Z42 each independently represent —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —OCO—NH—, —NH—COO—, —NH—CO—NH—, —NH—O—, —O—NH—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—, —N═CH—, —CH═N—N═CH—, —CF═CF—, —C≡C—, or a single bond, in a case where a plurality of each of Z³² and Z⁴² is present, these may be the same as each other or different from each other, T²² represents a trivalent group which may be substituted, m32 and m42 each independently represent an integer of 0 to 5.), in Formula (I-M2), T²² represents a group selected from Formula (T2-l 1) to Formula (T2-27), Formula (T2-28) to Formula (T2-31), Formula (T2-32), Formula (T2-33) and Formula (T2-34): 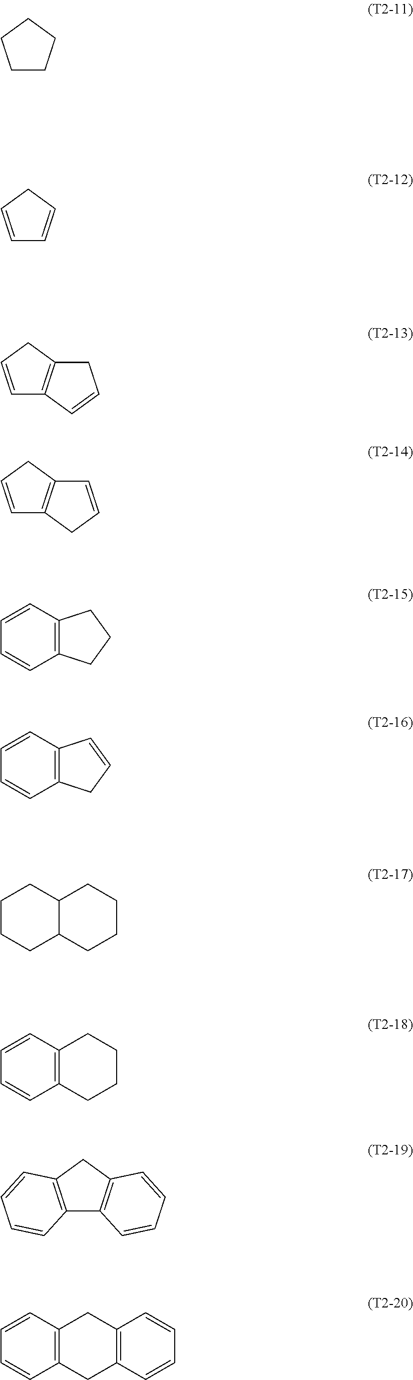 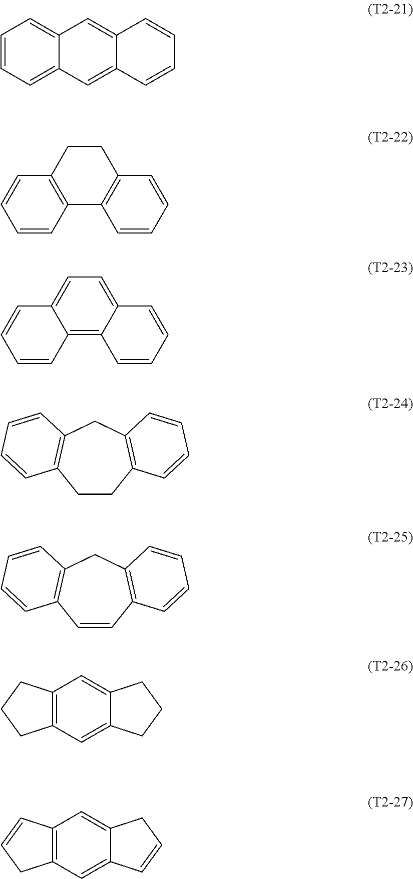
wherein a bonding site may be at an arbitrary position, arbitrary —CH═ may be each independently substituted with —N═, arbitrary —CH₂— may be each independently substituted with —O—, —S—, —NR⁰— (where R⁰ represents a hydrogen atom or an alkyl group having 1 to 20 carbon atoms), —CS— or —CO—, provided that a —O—O— bond is not included, the above groups may be unsubstituted or substituted with one or more of substituents L: 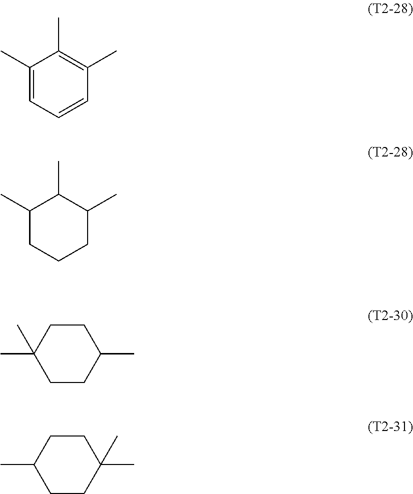
wherein arbitrary —CH═ may be each independently substituted with —N═, arbitrary —CH₂— may be each independently substituted with —O—, —S—, —NR⁰— (where R⁰ represents a hydrogen atom or an alkyl group having 1 to 20 carbon atoms), —CS— or —CO—, provided that a —O—O— bond is not included, the above groups may be unsubstituted or substituted with one or more of substituents L: 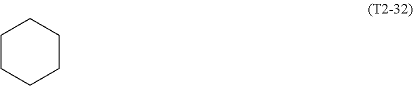
wherein a bonding site may be at an arbitrary position, at least one —CH₂— is each independently substituted with —O—, —S—, —NR⁰— (where R⁰ represents a hydrogen atom or an alkyl group having 1 to 20 carbon atoms), —CS— or —CO—, provided that a —O—O— bond is not included, these groups may be unsubstituted or substituted with one or more of substituents L: 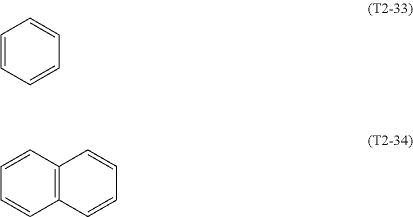 [SMILES: c1ccccc1 ; c1ccc2ccccc2c1]
wherein a bonding site may be at an arbitrary position, at least one —CH═ is each independently substituted with —N═, the above groups may be unsubstituted or substituted with one or more of substituents L, and m32+m42 represents an integer of 1 to 6.

19. The polymerizable composition according to claim 1,
wherein, in General Formula (I), n1 and n2 represent 0, n3 represents 1, M² represents a group represented by Formula (I-M222): 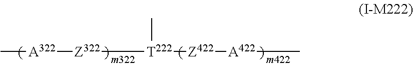
wherein A³²² and A⁴²² each independently represent a 1,4-phenylene group, a 1,4-cyclohexylene group, a pyridine-2,5-diyl group, a pyrimidine-2,5-diyl group, a naphthalene-2,6-diyl group, a naphthalene-1,4-diyl group, a tetrahydronaphthalene-2,6-diyl group, a decahydronaphthalene-2,6-diyl group, or a 1,3-dioxane-2,5-diyl group, which may be unsubstituted or substituted with one or more of substituents L, in a case where a plurality of each of A³²² and A⁴²² is present, these may be the same as each other or different from each other, Z³²² and Z⁴²² each independently represent —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —OCO—NH—, —NH—COO—, —NH—CO—NH—, —NH—O—, —O—NH—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—, —N═CH—, —CH═N—N═CH—, —CF═CF—, —C≡C—, or a single bond, in a case where a plurality of each of Z³²² and Z⁴²² is present, these may be the same as each other or different from each other, T²²² represents a trivalent group which may be substituted, in Formula (I-M222), T²²² represents a group selected from Formula (T2-35) to Formula (T2-41), and m322 and m422 each independently represent 1 or 2: 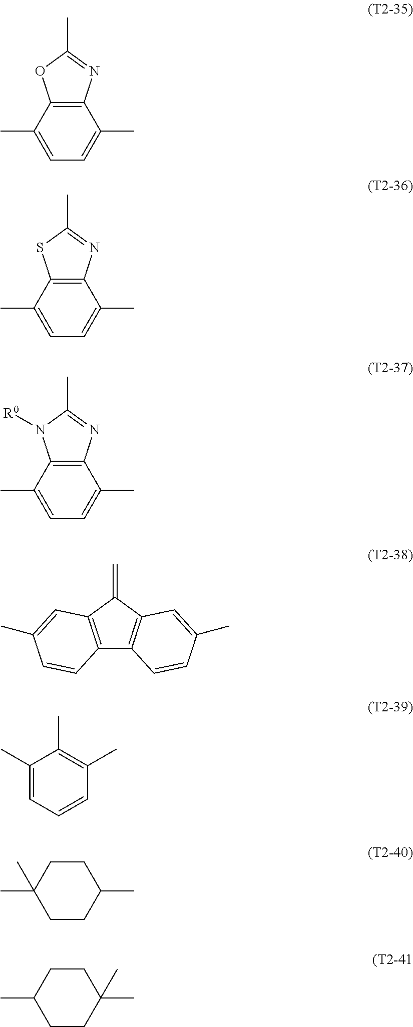
wherein R⁰ represents a hydrogen atom or an alkyl group having 1 to 20 carbon atoms.

20. The polymerizable composition according to claim 1,
wherein, in General Formula (I), n1 and n2 represent 0, n3 represents 1, M² represents a group represented by Formula (I-M23): 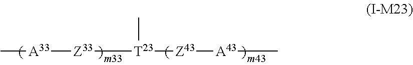
wherein A³³ and A⁴³ each independently represent a 1,4-phenylene group, a 1,4-cyclohexylene group, a pyridine-2,5-diyl group, a pyrimidine-2,5-diyl group, a naphthalene-2,6-diyl group, a naphthalene-1.4-diyl group, a tetrahydronaphthalene-2,6-diyl group, a decahydronaphthalene-2,6-diyl group, or a 1,3-dioxane-2,5-diyl group, which may be unsubstituted or substituted with one or more of substituents L. and, in a case where a plurality of each of A³³ and A⁴³ is present, these may be the same as each other or different from each other, Z³ and Z³ each independently represent —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —OCO—NH—, —NH—COO—, —NH—CO—NH—, —NH—O—, —O—NH—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—, —N═CH—, —CH═N—N═CH—, —CF═CF—, —C≡C—, or a single bond, in a case where a plurality of each of Z³³ and Z⁴³ is present, these may be the same as each other or different from each other, T²³ represents a trivalent group which may be substituted, m33 and m43 each independently represent an integer of 0 to 5. in Formula (I-M23), T²³ represents an acyclic group having 1 to 80 carbon atoms which may be substituted, arbitrary carbon atoms of the acyclic group may be substituted with hetero atoms, and m33+m43 represent an integer of 1 to 6.

21. The polymerizable composition according to claim 1,
wherein, in General Formula (I), n1 and n2 represent 0, n3 represents 1, M² represents a group represented by Formula (I-M232): 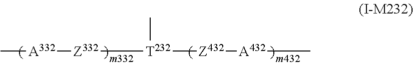
wherein A³³² and A⁴³² each independently represent a 1,4-phenylene group, a 1,4-cyclohexylene group, a pyridine-2,5-diyl group, a pyrimidine-2,5-diyl group, a naphthalene-2,6-diyl group, a naphthalene-1,4-diyl group, a tetrahydronaphthalene-2,6-diyl group, a decahydronaphthalene-2,6-diyl group, or a 1,3-dioxane-2,5-diyl group, which may be unsubstituted or substituted with one or more of substituents L, in a case where a plurality of each of A³³² and A⁴³² is present, these may be the same as each other or different from each other, Z³³² and Z⁴³² each independently represent —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —OCO—NH—, —NH—COO—, —NH—CO—NH—, —NH—O—, —O—NH—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—, —N═CH—, —CH═N—N═CH—, —CF═CF—, —C≡C—, or a single bond, in a case where a plurality of each of Z³³² and Z⁴³² is present, these may be the same as each other or different from each other, T²³² represents a trivalent group which may be substituted, m332 and m432 each independently represent an integer of 0 to 5, and in Formula (I-M232), T² may be replaced with a group represented by Formula (T-22): 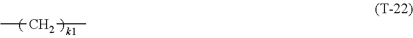
wherein a bonding site may be at an arbitrary position, one or more of arbitrary —CH₂—'s may be each independently substituted with —O—, —S—, —NR⁰— (where R⁰ represents a hydrogen atom or an alkyl group having 1 to 20 carbon atoms), —CS— or —CO—, provided that a —O—O— bond is not included, the group may be unsubstituted or substituted with one or more of substituents L, and k1 represents an integer of 1 to 20), and m332+m432 represents an integer of 1 to 6.

22. The polymerizable composition according to claim 1,
wherein, in General Formula (I), n1 and n3 represent 1 and n2 represents 0.

23. The polymerizable composition according to claim 1,
wherein, in General Formula (I), n1 and n3 represent 1, n2 represents 0, and R² and R³ each represent a group represented by Formula (I-R): 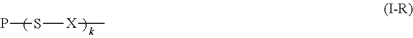
wherein P represents a polymerizable group, S represents a spacer group or a single bond, in a case where a plurality of S is present, these may be the same as each other or different from each other, X represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, in a case where a plurality of X is present, these may be the same as each other or different from each other, provided that P—(S—X)ₖ— does not include a —O—O— bond, k represents an integer of 0 to 10.), and R¹ and R⁴ represent a group selected from the group represented by Formula (I-R) and R⁵ (in the formula, R⁵ represents a hydrogen atom, a fluorine atom, a chlorine atom, a bromine atom, an iodine atom, a pentafluorosulfuranyl group, a nitro group, a cyano group, an isocyano group, an amino group, a hydroxyl group, a mercapto group, a methylamino group, a dimethylamino group, a diethylamino group, a diisopropylamino group, a trimethylsilyl group, a dimethylsilyl group, a thioisocyano group, or a linear or branched alkyl group having 1 to 20 carbon atoms in which one —CH₂— or two or more of (—CH₂—)'s that are not adjacent to each other may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, and arbitrary hydrogen atoms in the alkyl group may be substituted with a fluorine atom.

24. The polymerizable composition according to claim 1,
wherein, in General Formula (1), n1 and n3 represent 1, n2 represents 0, M¹ represents a group represented by Formula (I-M1), and M² represents a group represented by Formula (I-M2): 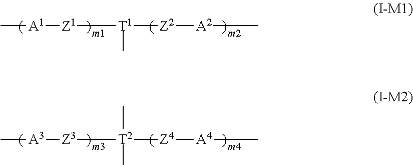
wherein A¹, A², A³, and A⁴ each independently represent a 1,4-phenylene group, a 1,4-cyclohexylene group, a pyridine-2,5-diyl group, a pyrimidine-2,5-diyl group, a naphthalene-2,6-diyl group, a naphthalene-1,4-diyl group, a tetrahydronaphthalene-2,6-diyl group, a decahydronaphthalene-2,6-diyl group, or a 1,3-dioxane-2,5-diyl group, which may be unsubstituted or substituted with one or more of substituents L, and, in a case where a plurality of each of A¹, A², A³, and A⁴ is present, these may be the same as each other or different from each other, Z¹, Z², Z³, and Z⁴ each independently represent —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —OCO—NH—, —NH—COO—, —NH—CO—NH—, —NH—O—, —O—NH—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—, —N═CH—, —CH═N—N═CH—, —CF═CF—, —C≡C—, or a single bond, in a case where a plurality of each of Z¹, Z², Z³, and Z⁴ is present, these may be the same as each other or different from each other, m1, m2, m3, and m4 each independently represent an integer of 0 to 5, in Formula (I-M1), T¹ represents a group selected from Formula (T1-1) to Formula (T1-10): 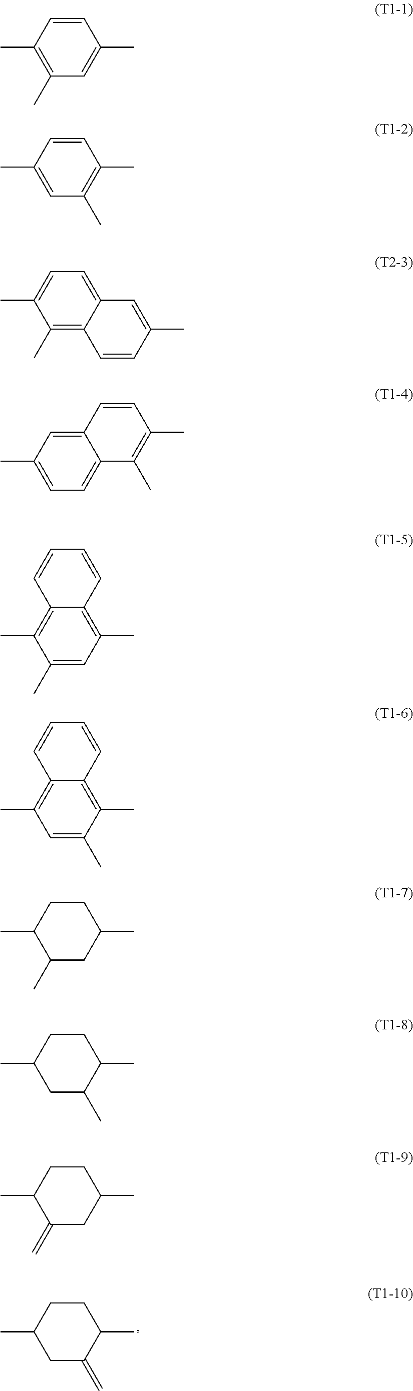
these groups may be unsubstituted or substituted with one or more of substituents L, T² represents a group selected from Formula (T2-1) to Formula (T2-10): 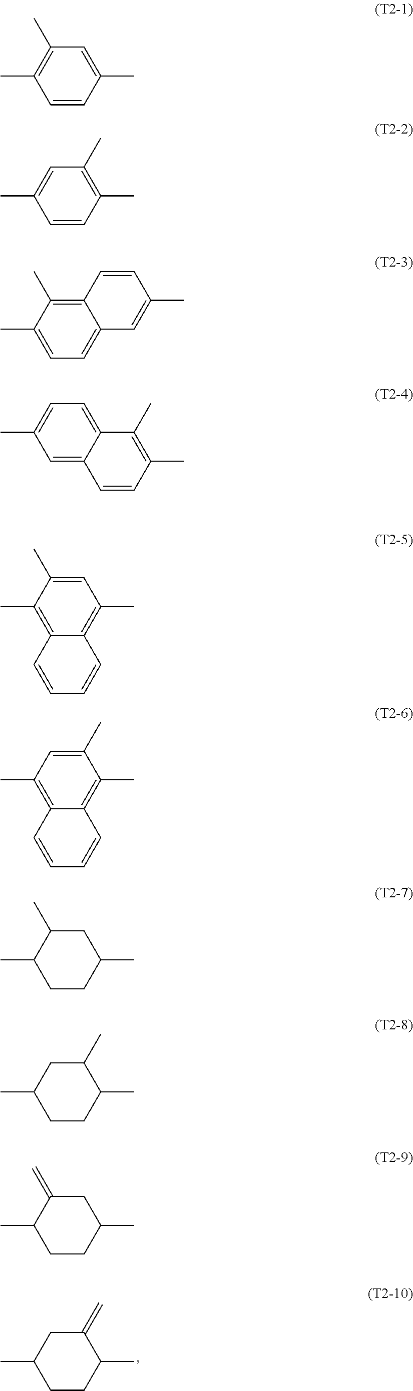
and these groups may be unsubstituted or substituted with one or more of substituents L.

25. The polymerizable composition according to claim 1,
wherein, in General Formula (1), n1 and n3 represent 1, n2 represents 0, W¹ represents a group represented by the following Formula (I-W15): 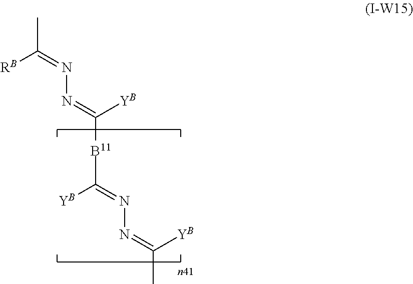
wherein Y^{B} represents a hydrogen atom, a fluorine atom, a chlorine atom, a bromine atom, an iodine atom, a pentafluorosufiranyl group, a nitro group, a cyano group, an isocyano group, an amino group, a hydroxyl group, a mercapto group, a methylamino group, a dimethylamino group, a diethylamino group, a diisopropylamino group, a trimethylsilyl group, a dimethylsilyl group, a thioisocyano group, or a linear or branched alkyl group having 1 to 20 carbon atoms in which one —CH₂— or two or more of (—CH₂—)'s that are not adjacent to each other may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, arbitrary hydrogen atoms in the alkyl group may be substituted with a fluorine atom, and in a case where a plurality of Y^{B} is present, these may be the same as each other or different from each other. Alternatively, Y^{B} may represent a group represented by P—(S—X)ⱼ—, P represents a polymerizable group, S represents a spacer group or a single bond, in a case where a plurality of S is present, these may be the same as each other or different from each other, X represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, in a case where a plurality of X is present, these may be the same as each other or different from each other, provided that P—(S—X)ⱼ— does not include a —O—O— bond, j represents an integer of 0 to 10, B¹¹ represents a group selected from Formula (B-1) to Formula (B-21) or a single bond: 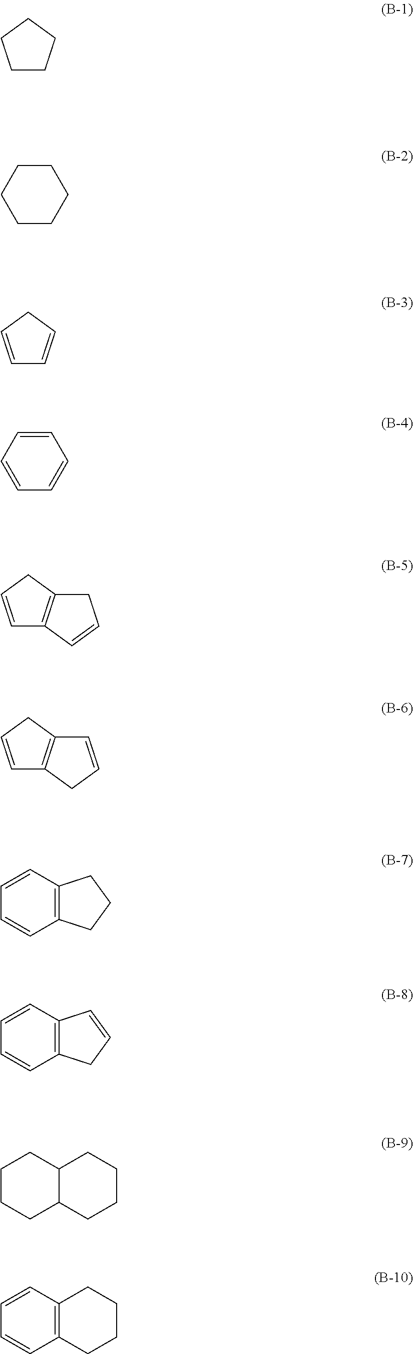 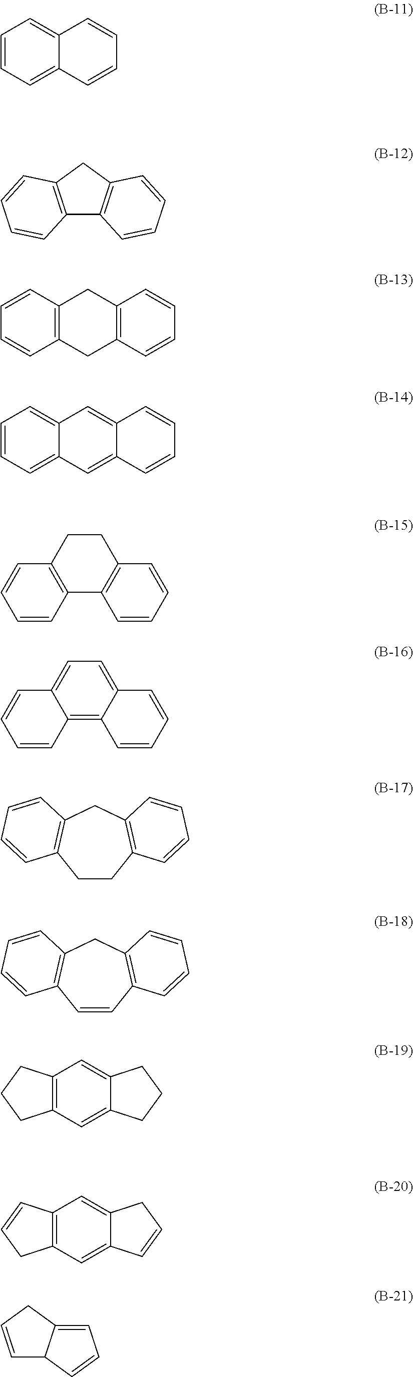
wherein a bonding site may be at an arbitrary position, arbitrary —CH═ may be each independently substituted with —N═, arbitrary —CH₂— may be each independently substituted with —O—, —S—, —NR⁰— (where R⁰ represents a hydrogen atom or an alkyl group having 1 to 20 carbon atoms), —CS— or —CO—, provided that a —O—O— bond is not included, the above groups may be unsubstituted or substituted with one or more of substituents L, and n41 represents an integer of 0 to 5.

26. The polymerizable composition according to claim 1,
wherein, in General Formula (I), n1 represents 0 and n2 and n3 represent 1.

27. The polymerizable composition according to claim 1,
wherein, in General Formula (I), n1 represents 0, n2 and n3 represent 1, and R³ represents a group represented by Formula (I-R): 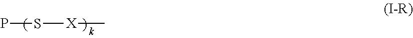
wherein P represents a polymerizable group, S represents a spacer group or a single bond, in a case where a plurality of S is present, these may be the same as each other or different from each other, X represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, in a case where a plurality of X is present, these may be the same as each other or different from each other, provided that P—(S—X)ₖ— does not include a —O—O— bond, k represents an integer of 0 to 10, R⁴ represents a group selected from the group represented by Formula (I-R) and R⁵ (in the formula, R⁵ represents a hydrogen atom, a fluorine atom, a chlorine atom, a bromine atom, an iodine atom, a pentafluorosulfuranyl group, a nitro group, a cyano group, an isocyano group, an amino group, a hydroxyl group, a mercapto group, a methylamino group, a dimethylamino group, a diethylamino group, a diisopropylamino group, a trimethylsilyl group, a dimethylsilyl group, a thioisocyano group, or a linear or branched alkyl group having 1 to 20 carbon atoms in which one —CH₂— or two or more of (—CH₂—)'s that are not adjacent to each other may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, and one or more of arbitrary hydrogen atoms in the alkyl group may be substituted with a fluorine atom.

28. The polymerizable composition according to claim 1,
wherein, in General Formula (I), n1 represents 0, n2 and n3 represent 1, M² represents a group represented by (I-M2): 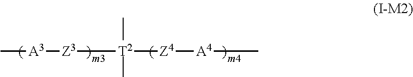
wherein A³ and A⁴ each independently represent a 1,4-phenylene group, a 1,4-cyclohexylene group, a pyridine-2,5-diyl group, a pyrimidine-2,5-diyl group, a naphthalene-2,6-diyl group, a naphthalene-1,4-diyl group, a tetrahydronaphthalene-2,6-diyl group, a decahydronaphthalene-2,6-diyl group, or a 1,3-dioxane-2,5-diyl group, these groups may be unsubstituted or substituted with one or more of substituents L, and, in a case where a plurality of each of A³ and A⁴ is present, these may be the same as each other or different from each other, Z³ and Z⁴ each independently represent —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —OCO—NH—, —NH—COO—, —NH—CO—NH—, —NH—O—, —O—NH—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—, —N═CH—, —CH═N—N═CH—, —CF═CF—, —C≡C—, or a single bond, in a case where a plurality of each of Z³ and Z⁴ is present, these may be the same as each other or different from each other, and m3 and m4 each independently represent an integer of 0 to 5, in Formula (I-M2), T² represents a group selected from Formula (T2-1) to Formula (T2-10): 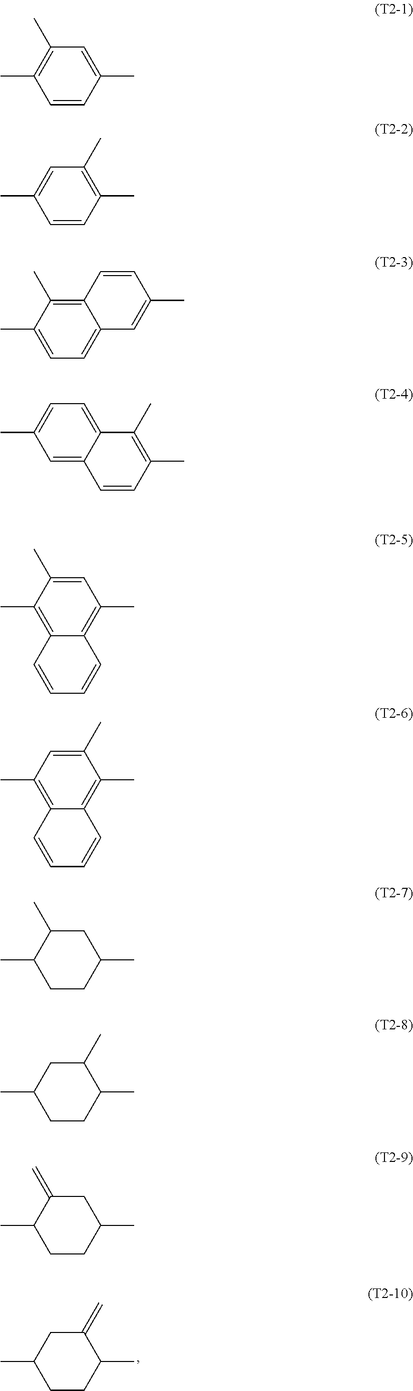
and these groups may be unsubstituted or substituted with one or more of substituents L.

29. The polymerizable composition according to claim 1,
wherein, in General Formula (I), R³ and R⁴ represent a group represented by (I-R), 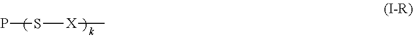
(in the formula, P represents a polymerizable group, S represents a spacer group or a single bond, in a case where a plurality of S is present, these may be the same as each other or different from each other, X represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, in a case where a plurality of X is present in the compound, these may be the same as each other or different from each other (provided that P—(S—X)ₖ— does not include a —O—O— bond), k represents an integer of 0 to 10.), a group represented by W¹-M²-W² provided that M² is linked to R³ and R⁴ at arbitrary positions) represents a group selected from Formula (I-W16-1) or Formula (I-W16-2): 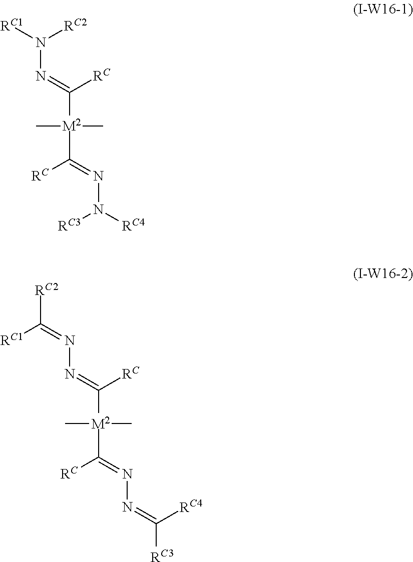
wherein Y^{C1} and Y^{C4} each independently represent a group including aromatic and/or nonaromatic carbon ring or heterocyclic ring having 1 to 80 carbon atoms which may be substituted, and arbitrary carbon atoms of the carbon ring or the heterocyclic ring may be substituted with hetero atoms (provided that oxygen atoms are not directly bonded to each other, Y^{C2} and Y^{C3} each independently represent a hydrogen atom or a linear or branched alkyl group having 1 to 20 carbon atoms in which one —CH₂— or two or more of (—CH₂—)'s that are not adjacent to each other may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, one or more of arbitrary hydrogen atoms in the alkyl group may be substituted with a fluorine atom, Y^{C2} and Y^{C3} may represent a group having 5 to 30 carbon atoms including at least one aromatic group, which may be unsubstituted or substituted with one or more of substituents L, Y^{C} represents a hydrogen atom, a fluorine atom, a chlorine atom, a bromine atom, an iodine atom, a pentafluorosulfuranyl group, a nitro group, a cyano group, an isocyano group, an amino group, a hydroxyl group, a mercapto group, a methylamino group, a dimethylamino group, a diethylamino group, a diisopropylamino group, a trimethylsilyl group, a dimethylsilyl group, a thioisocyano group, or a linear or branched alkyl group having 1 to 20 carbon atoms in which one —CH₂— or two or more of (—CH₂—)'s that are not adjacent to each other may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, one or more of arbitrary hydrogen atoms in the alkyl group may be substituted with a fluorine atom, and in a case where a plurality of Y^{C} is present, these may be the same as each other or different from each other, Y^{C} may represent a group represented by P—(S—X)ⱼ—, P represents a polymerizable group, S represents a spacer group or a single bond, in a case where a plurality of S is present, these may be the same as each other or different from each other, X represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, in a case where a plurality of X is present, these may be the same as each other or different from each other (provided that P—(S—X)ⱼ— does not include a —O—O— bond), j represents an integer of 0 to 10, Y^{C1} and Y^{C2} may be integrated to form a ring structure, and Y^{C3} and Y^{C4} may be integrated to form a ring structure.

30. The polymerizable composition according to claim 1,
wherein, in General Formula (I), n1 and n2 represent 0 and n3 represents 2 to 1,000.

31. The polymerizable composition according to claim 1,
wherein, in General Formula (I), n1 and n2 represent 0. n3 represents 2 to 1,000, and R³ represents a group represented by Formula (I-R): 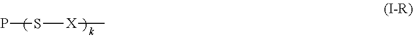
wherein P represents a polymerizable group, S represents a spacer group or a single bond, in a case where a plurality of S is present, these may be the same as each other or different from each other, X represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH—, —CH₂—COO—, —CH₂—OCO—, —CH═CH—, —N═N—, —CH═N—N═CH—, —CF═CF—, —C≡C—, or a single bond, in a case where a plurality of X is present in the compound, these may be the same as each other or different from each other (provided that P—(S—X)ₖ— does not include a —O—O— bond), k represents an integer of 0 to 10.), R⁴ represents a group selected from the group represented by Formula (I-R) and R⁵ (in the formula, R⁵ represents a hydrogen atom, a fluorine atom, a chlorine atom, a bromine atom, an iodine atom, a pentafluorosulfuranyl group, a nitro group, a cyano group, an isocyano group, an amino group, a hydroxyl group, a mercapto group, a methylamino group, a dimethylamino group, a diethylamino group, a diisopropylamino group, a trimethylsilyl group, a dimethylsilyl group, a thioisocyano group, or a linear or branched alkyl group having 1 to 20 carbon atoms, in which one —CH₂— or two or more of (—CH₂—)'s that are not adjacent to each other may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, and arbitrary hydrogen atoms in the alkyl group may be substituted with a fluorine atom.

32. The polymerizable composition according to claim 1,
wherein, in General Formula (I), -(M²)ₙ₃- represents Formula (I-M3): 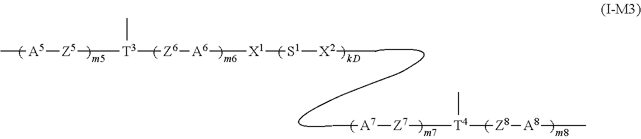
wherein A⁵, A⁶, A⁷, and A⁸ each independently represent a 1,4-phenylene group, a 1,4-cyclohexylene group, a pyridine-2,5-diyl group, a pyrimidine-2,5-diyl group, a naphthalene-2,6-diyl group, a naphthalene-1,4-diyl group, a tetrahydronaphthalene-2,6-diyl group, a decahydronaphthalene-2,6-diyl group, or a 1,3-dioxane-2,5-diyl group, these groups may be unsubstituted or substituted with one or more of substituents L, and, in a case where a plurality of each of A⁵, A⁶, A⁷, and A⁸ is present, these may be the same as each other or different from each other. Z⁵, Z⁶, Z⁷, and Z⁸ each independently represent —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —OCO—NH—, —NH—COO—, —NH—CO—NH—, —NH—O—, —O—NH—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—, —N═CH—, —CH═N—N═CH—, —CF═CF—, —C≡C—, or a single bond, in a case where a plurality of each of Z⁵, Z⁶, Z⁷, and Z⁸ is present, these may be the same as each other or different from each other, and T³ and T⁴ each independently represent a group selected from Formula (T2-1) to Formula (T2-10): 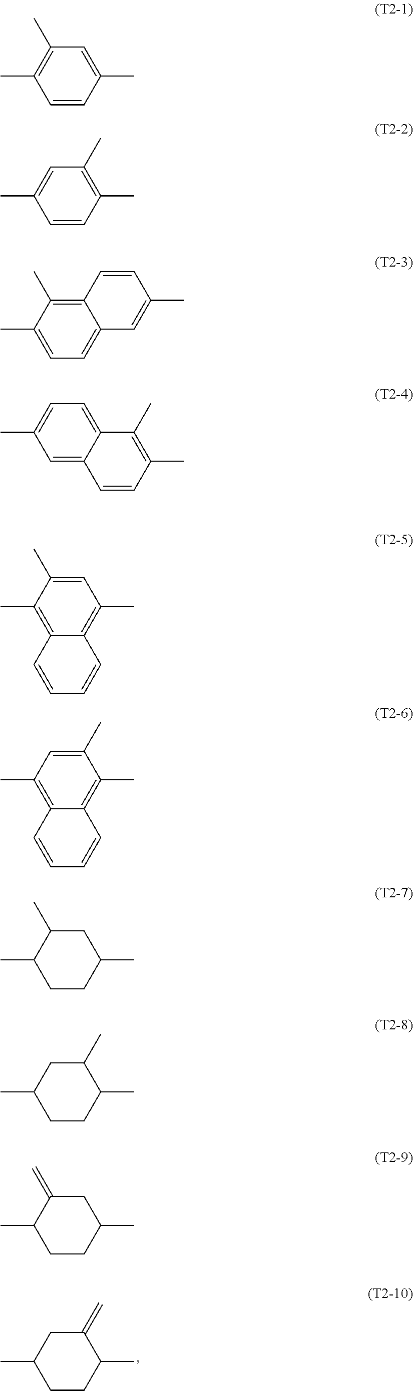
these groups represent a group which may be unsubstituted or substituted with one or more of substituents L, and X¹ and X² represent —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, in a case where a plurality of X² is present, these may be the same as each other or different from each other, S¹ represents a single bond or a linear or branched alkylene group having 1 to 20 carbon atoms in which one —CH₂— or two or more of (—CH₂—)'s that are not adjacent to each other may be each independently substituted with —O—, —COO—, —OCO—, —OCO—O—, —CO—NH—, —NH—CO—, —CH═CH—, or —C≡C—, in a case where a plurality of S¹ is present, these may be the same as each other or different from each other (provided that X¹—S¹ and S¹—X² do not include a —O—O— bond.), kD represents an integer of 0 to 8, m5S, m6, m7, and m8 each independently represent an integer of 0 to 5, and the total of m5, m6, m7, and m8 represents 0 to 6.

33. The polymerizable composition according to claim 1,
wherein, in General Formula (I), R³ and R⁴ represent a group selected from by (I-R): 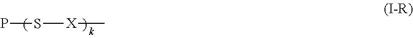
wherein P represents a polymerizable group, S represents a spacer group or a single bond, in a case where a plurality of S is present, these may be the same as each other or different from each other, X represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, in a case where a plurality of X is present, these may be the same as each other or different from each other (provided that P—(S—X)ₖ— does not include a —O—O— bond), k represents an integer of 0 to 10.), W¹ represents a group represented by Formula (I-W17-1) or Formula (I-W17-2): 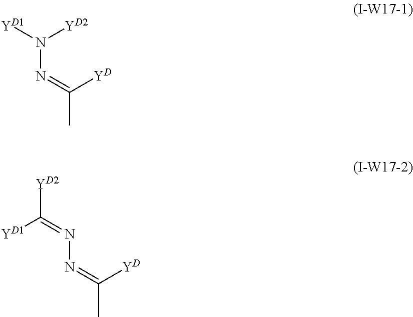
wherein Y^{D1} represents a group including aromatic and/or nonaromatic carbon ring or heterocyclic ring having 1 to 80 carbon atoms which may be substituted, arbitrary carbon atoms of the carbon ring or the heterocyclic ring may be substituted with hetero atoms (provided that oxygen atoms are not directly bonded to each other). Y^{D2} represents a hydrogen atom or a linear or branched alkyl group having 1 to 20 carbon atoms, in which one —CH-Hr or two or more of (—CH₂—)'s that are not adjacent to each other may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, arbitrary hydrogen atoms in the alkyl group may be substituted with a fluorine atom, Y^{D2} may represent a group having 2 to 30 carbon atoms including at least one aromatic group, which may be unsubstituted or substituted with one or more of substituents L, Y^{D} represents a hydrogen atom, a fluorine atom, a chlorine atom, a bromine atom, an iodine atom, a pentafluorosulfuranyl group, a nitro group, a cyano group, an isocyano group, an amino group, a hydroxyl group, a mercapto group, a methylamino group, a dimethylamino group, a diethylamino group, a diisopropylamino group, a trimethylsilyl group, a dimethylsilyl group, a thioisocyano group, or a linear or branched alkyl group having 1 to 20 carbon atoms in which one —CH₂— or two or more of (—CH₂—)'s that are not adjacent to each other may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, arbitrary hydrogen atoms in the alkyl group may be substituted with a fluorine atom, and in a case where a plurality of Y^{D} is present, these may be the same as each other or different from each other, Y^{D} may represent a group represented by P—(S^{Y}—X^{Y})ⱼ—, P represents a polymerizable group, S represents a spacer group or a single bond, in a case where a plurality of S is present, these may be the same as each other or different from each other, X represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, in a case where a plurality of X is present, these may be the same as each other or different from each other (provided that P—(S—X)ⱼ— does not include a —O—O— bond), j represents an integer of 0 to 10, Y^{D1} and Y^{D2} may be integrated to form a ring structure.)

34. The polymerizable composition according to claim 1,
wherein, MG of General Formula (II) is represented by General Formula (II-b):
—(B1-Z1)ᵣ₁-B2-Z2-B3- (II-b)
wherein B1, B2, and B3 each independently represent a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo (2,2,2) octylene group, a decahydronaphthalene-2,6-diyl group, a pyridine-2,5-diyl group, a pyrimidine-2,5-diyl group, a pyrazine-2,5-diyl group, a thiophene-2,5-diyl group-, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10α-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2, 7-diyl group, a [1]benzoselenopheno[3,2-b]selenophene-2,7-diyl group, or a fluorene-2,7-diyl group, which may have, as a substituent, one or more of F, C1, CF₃, OCF₃, CN group, an alkyl group, an alkoxy group, an alkanoyl group, or an alkanoyloxy group having 1 to 8 carbon atoms, an alkenyl group, an alkenyloxy group, an alkenoyl group, or an alkenoyloxy group having 2 to 8 carbon atoms, and/or General Formula (II-c):
—(X²³)_{q4}—(S²³)_{q3}—P²⁴ (II-c)
wherein P²⁴ represents a reactive functional group, S²³ represents an alkylene group having 1 to 18 carbon atoms, X²³ represents —O—, —COO—, —OCO—, —OCH₂—, —CH₂O—, —CH₂CH₂OCO—, or —CH₂CH₂COO—, q³ represents 0 or 1, and q⁴ represents 0 or 1,
Z1 and Z2 each independently represent —COO—, —OCO—, —CH₂CH₂—, —OCH₂—, —CH₂O—, —CH═CH—, —C≡C—, —CH═CHCOO—, —OCOCH═CH₂—, —CH₂CH₂COO—, —CH₂CH₂OCO—, —COOCH₂CH₂—, —OCOCH₂CH₂—, —CONH—, —NHCO—, an alkyl group having 2 to 10 carbon atoms which may include a halogen atom, or a single bond,
r1 represents 0, 1, or 2, and
in a case where a plurality of each of B²¹ and Z⁵¹ is present, these may be the same as or different from each other.

35. The polymerizable composition according to claim 34,
wherein any one or more of B1, B2, and B3 of General Formula (II-b) is a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo (2,2,2) octylene group, or a decahydronaphthalene-2,6-diyl group.

36. The polymerizable composition according to claim 34,
wherein r1 in General Formula (I-b) is 0.

37. A polymer obtained by polymerizing the polymerizable composition according to claim 1.

38. An optically anisotropic body using the polymer according to claim 37.

39. A resin, a resin additive, oil, a filter, an adhesive, a pressure-sensitive adhesive, fat, ink, a medicine, cosmetics, a detergent, a building material, a packaging material, a liquid crystal material, an organic EL material, an organic semiconductor material, an electronic material, a display element, an electronic device, communication equipment, an automobile part, an aircraft part, a machine part, an agricultural chemical, and a food each using the polymerizable composition according to claim 1, and a product using at least one of them.
